(19) United States
(12) Patent Application Publication
(10) Pub. No.: US 2026/0223955 A1
(43) Pub. Date: Aug. 6, 2026

(54) VAPORIZING DEVICE

(71) Applicant: Noah Mark MINSKOFF, Boise, ID (US)

(72) Inventor: Noah Mark MINSKOFF, Boise, ID (US)

(21) Appl. No.: 19/576,667

(22) Filed: Mar. 24, 2026

Related U.S. Application Data
(63) Continuation-in-part of application No. 19/411,104, filed on Dec. 5, 2025.
Application No. 19/411,104 is a continuation-in-part of application No. 18/727,923, filed on Jul. 10, 2024.
Application No. 18/727,923 is a continuation-in-part of application No. PCT/US25/20185, filed on Mar. 17, 2025.
(60) Provisional application No. 63/298,935, filed on Jan. 12, 2022.
(60) Provisional application No. 63/308,942, filed on Feb. 10, 2022.
(60) Provisional application No. 63/566,372, filed on Mar. 17, 2024.

(51) Int. Cl. A24F 40/70; A24F 40/10; A24F 40/46; A24F 40/465; A24F 40/485; H05B 3/06

(52) U.S. Cl. CPC A24F 40/70; A24F 40/10; A24F 40/46; A24F 40/465; A24F 40/485; H05B 3/06

(57) ABSTRACT

A vaporizing device including a reservoir to store a liquid precursor, a dispenser to regulate the flow of the liquid precursor, a chamber to receive the liquid precursor and generate vapor, and a heater to supply heat to vaporize at least a portion of the liquid precursor, an inlet to admit air, and an outlet that includes a tortuous flow path geometry configured to condition vapor or aerosol prior to delivery to a user. The chamber may include geometries that enhance thin film vaporization or induce rotational flow. A controller may be provided to regulate power delivered to the heater, estimate heater temperature, compare detected inhalation parameters to stored inhalation profiles, and responsively adapt operation. In some embodiments, the controller may operate in an idle or standby mode to maintain a minimum temperature. The device may also include valves to inhibit leakage of the liquid precursor when not in use.

### RELATED APPLICATIONS

This application claims the benefit of, and is a continuation-in-part of U.S. patent application Ser. No. 19/411,104, titled “PERSONAL VAPORIZING UNIT”, filed Dec. 5, 2025, and said Ser. No. 19/411,104 claims the benefit of, and is a continuation-in-part of U.S. patent application Ser. No. 18/727,923, titled “PERSONAL VAPORIZING UNIT”, filed Jul. 10, 2024, and said Ser. No. 18/727,923 is a 371 national stage of international application number PCT/US23/10238, titled “PERSONAL VAPORIZING UNIT”, filed Jan. 5, 2023, which claims the benefit of U.S. provisional application Ser. No. 63/308,942, titled “PERSONAL VAPORIZING UNIT”, filed Feb. 10, 2022, and also claims the benefit of U.S. provisional application Ser. No. 63/298,935, titled “PERSONAL VAPORIZING UNIT”, filed Jan. 12, 2022, said Ser. No. 19/411,104 also claims the benefit of, and is a continuation-in-part of, international application number PCT/US25/20185, titled “VAPORIZING DEVICE”, filed Mar. 17, 2025, which claims the benefit of U.S. Provisional application Ser. No. 63/566,372, titled “VAPORIZING DEVICE”, filed Mar. 17, 2024, which are all hereby incorporated by reference herein for all purposes.

### BRIEF DESCRIPTION OF THE DRAWINGS

Many aspects of the disclosure can be better understood with reference to the following drawings. While several implementations are described in connection with these drawings, the disclosure may be not limited to the implementations disclosed herein. On the contrary, the intent may be to cover all alternatives, modifications, and equivalents.

FIG. 1 illustrates a vaporizing device.

FIG. 2 illustrates a vaporizing device.

FIG. 3 illustrates a vaporizing device.

FIG. 4 illustrates a vaporizing device.

FIG. 5 illustrates a vaporizing device.

FIG. 6 illustrates a vaporizing device.

FIG. 7 illustrates a vaporizing device.

FIG. 8A illustrates a vaporizing device having a detachable cartridge.

FIG. 8B illustrates a cross-section of a vaporizing device.

FIG. 9 illustrates a cartridge for a vaporizing device.

FIG. 10 illustrates an exploded view of a vaporizer.

FIG. 11A illustrates a cross-section of a vaporizer including a dispenser for a vaporizing device.

FIG. 11B illustrates an isometric view of a dispenser disk.

FIG. 12 illustrates a graph showing the viscosity of propylene glycol versus temperature.

FIG. 13A illustrates a cross section of a vaporizing device including a dispenser.

FIG. 13B illustrates a cross section of a vaporizing device including a dispenser.

FIG. 13C illustrates an isometric view of heater assembly for a vaporizing device.

FIG. 14A illustrates a cross section of a dispenser for a vaporizing device.

FIG. 14B illustrates a top view of a dispenser for a vaporizing device.

FIG. 14C illustrates a cross section of a chamber assembly.

FIG. 14D illustrates an isometric view of the bottom of an upper chamber including portions of a dispenser for a vaporizing device.

FIG. 15A illustrates a detailed isometric view of a dispenser.

FIG. 15B illustrates a top view of a dispenser.

FIG. 15C illustrates a cross section of a dispenser.

FIG. 16 illustrates a vaporizing device including a valve mechanism for a detachable cartridge.

FIG. 17A illustrates an isometric view of a chamber assembly.

FIG. 17B illustrates an exploded view of a chamber assembly.

FIG. 17C illustrates a top view of a chamber assembly.

FIG. 17D illustrates a cross section of a chamber assembly.

FIG. 18A illustrates an isometric view of a chamber assembly.

FIG. 18B illustrates an exploded view of a chamber assembly.

FIG. 18C illustrates an isometric view of the bottom of a flow director.

FIG. 18D illustrates a top view of a chamber assembly.

FIG. 18E illustrates a cross section of a chamber assembly.

FIG. 19A illustrates an isometric view of a chamber assembly.

FIG. 19B illustrates an exploded view of a chamber assembly.

FIG. 19C illustrates a top view of a chamber assembly.

FIG. 19D illustrates a cross section of a chamber assembly.

FIG. 20A illustrates an exploded isometric view of a chamber assembly.

FIG. 20B illustrates an isometric view of a chamber assembly.

FIG. 21A illustrates an exploded isometric view of a chamber assembly.

FIG. 21B illustrates a cross section of a chamber assembly.

FIG. 21C illustrates an isometric cross-sectional view of a chamber assembly.

FIG. 22 illustrates an exploded view of a chamber assembly.

FIG. 23A illustrates an exploded view of a chamber assembly.

FIG. 23B illustrates an isometric view of a chamber assembly.

FIG. 24A illustrates an exploded view of a vaporizer assembly.

FIG. 24B illustrates an isometric view of the bottom of a lower chassis.

FIG. 24C illustrates an isometric view of an upper gasket.

FIG. 24D illustrates an isometric view of a reservoir.

FIG. 24E illustrates an isometric view of a vaporizer assembly.

FIG. 24F illustrates a cross section of a vaporizer assembly.

FIG. 25A illustrates an exploded view of a vaporizer assembly.

FIG. 25B illustrates a cross section of a lower chassis.

FIG. 25C illustrates an isometric view of a mid seal.

FIG. 25D illustrates an isometric view of the top of a precursor inlet seal.

FIG. 25E illustrates an isometric view of the bottom of a precursor inlet seal.

FIG. 25F illustrates an air inlet flow path within a vaporizer assembly.

FIG. 25G illustrates a vapor flow path extending from a chamber assembly.

FIG. 25H illustrates an aerosol outlet flow path associated with a vaporizer assembly.

FIG. 26A illustrates an exploded view of a vaporizer assembly.

FIG. 26B illustrates a top view of a vaporizer assembly.

FIG. 26C illustrates an isometric view of precursor inlet seal.

FIG. 26D illustrates a top view of a vaporizer assembly.

FIG. 26E illustrates a cross section of a vaporizer assembly.

FIG. 26F illustrates a cross section of a vaporizer assembly.

FIG. 27A illustrates an exploded view of a vaporizer assembly.

FIG. 27B illustrates an isometric view of the bottom side of an upper seal.

FIG. 27C illustrates a top view of a vaporizer assembly.

FIG. 27D illustrates an isometric view of the bottom side of a flow director.

FIG. 27E illustrates an isometric view of an inlet flow path.

FIG. 27F illustrates a cross section of a vaporizer assembly.

FIG. 27G illustrates an isometric view an outlet flow path.

FIG. 28A illustrates an exploded view of a vaporizer assembly.

FIG. 28B illustrates an isometric view of the top of a mid seal.

FIG. 28C illustrates an isometric view of the bottom of a mid seal.

FIG. 28D illustrates an isometric view of a valve assembly.

FIG. 28E illustrates an isometric view of a precursor inlet seal.

FIG. 28F illustrates a vapor flow path extending from a chamber assembly.

FIG. 28G illustrates flap valves in a vapor flow.

FIG. 28H illustrates a vapor flow path after flap valves.

FIG. 29A illustrates an exploded view of a vaporizer assembly.

FIG. 29B illustrates an isometric view of the top of a mid seal.

FIG. 29C illustrates an isometric view of the bottom of a mid seal.

FIG. 29D illustrates an isometric view of the top of a precursor inlet seal.

FIG. 29E illustrates am isometric view of the bottom of a precursor inlet seal.

FIG. 29F illustrates a vapor flow path extending from a chamber assembly.

FIG. 29G illustrates poppet valves in a vapor flow path.

FIG. 29H illustrates a vapor flow path after a poppet valve.

FIG. 30A illustrates an exploded view of a vaporizer assembly.

FIG. 30B illustrates a cross section of a lower chassis.

FIG. 30C illustrates an isometric view of the bottom of a lower seal.

FIG. 30D illustrates a chamber housing.

FIG. 30E illustrates an isometric view of the bottom of a flow director.

FIG. 30F illustrates an isometric view of an inlet flow path for a vaporizer.

FIG. 30G illustrates an isometric view of an outlet flow path for a vaporizer.

FIG. 30H illustrates an isometric view of the top of a flow director.

FIG. 30I illustrates an isometric view of the top of a vortical flow director.

FIG. 30J illustrates an isometric view of the bottom of a vortical flow director.

FIG. 30K illustrates an aerosol flow path from a chamber.

FIG. 30L illustrates an aerosol outlet flow path associated with a vaporizer assembly.

FIG. 31A illustrates an exploded view of a vaporizer assembly.

FIG. 31B illustrates a bottom isometric view of a lower seal.

FIG. 31C illustrates a chamber housing.

FIG. 31D illustrates an isometric view of valve assembly.

FIG. 31E illustrates a bottom isometric view of flow director.

FIG. 31F illustrates an air intake flow path.

FIG. 31G illustrates the mixing of vapor and air, aerosol generation, and the subsequent exit flow path.

FIG. 32A illustrates an exploded view of a vaporizer assembly.

FIG. 32B illustrates an isometric view of the bottom side of a lower chassis.

FIG. 32C illustrates an isometric view of a flow director.

FIG. 32D illustrates a top view of a vaporizer assembly.

FIG. 32E illustrates an isometric view of a vaporizer assembly.

FIG. 32F illustrates a cross section of a vaporizer assembly.

FIG. 33A illustrates a cross section of a vaporizer device.

FIG. 33B illustrates an exploded view of a vaporizer assembly.

FIG. 33C illustrates an isometric view of an inlet path of a vaporizer device.

FIG. 33D illustrates an isometric view of an outlet path of a vaporizer device.

FIG. 34A illustrates an isometric view of a vaporizing device.

FIG. 34B illustrates a cross section of a vaporizing device.

FIG. 35A illustrates an isometric view of a vaporizing device.

FIG. 35B illustrates an isometric view of a base unit with the housing removed.

FIG. 35C illustrates a cross section of a vaporizing device.

FIG. 35D illustrates a detail view of a chamber assembly.

FIG. 36A illustrates an isometric view of a vaporizing device.

FIG. 36B illustrates an isometric view of a vaporizing device with the housing removed.

FIG. 37A illustrates an actuator with a cartridge.

FIG. 37B illustrates an isometric view of the underside of a cartridge.

FIG. 37C illustrates an isometric view of slide plates.

FIG. 38 illustrates actuators with a cartridge.

FIG. 39 illustrates a cross section of a vaporizing device.

FIG. 40A illustrates a cross section of a vaporizing device.

FIG. 40B illustrates a cross section of a vaporizing device with the housing removed.

FIG. 41A illustrates an exploded view of a spectrophotometer.

FIG. 41B illustrates an exploded view of a sample chamber.

FIG. 42 is a block diagram illustrating a vaporizer.

FIG. 43 is a block diagram illustrating a vaporizing chamber heater control system.

FIG. 44 illustrates example airflow versus time measurements for three successive puffs.

FIG. 45 illustrates example airflow and heater control system output vs time measurements.

FIG. 46 illustrates another example airflow and heater control system output vs time measurements.

FIG. 47 is a block diagram illustrating an optical analysis subsystem.

FIG. 48 is a block diagram illustrating a dual-cell optical analysis subsystem.

FIG. 49 is a flowchart illustrating an exemplary process for optimizing precursor liquid and/or precursor compound formulations using machine learning.

FIG. 50 is a flowchart illustrating an exemplary process for determining mappings from sensor signals to control parameters of a vaporizing device using machine learning.

FIG. 51 is a flowchart illustrating an exemplary process for detecting properties of a precursor and/or vapor using machine learning and analytical measurements.

FIG. 52 is a flowchart illustrating an exemplary process for adapting heater control parameters of a vaporizing device using machine learning based on environmental conditions, device state, and/or user profile.

FIG. 53 illustrates a block diagram of a computer system.

### DETAILED DESCRIPTION

Vaporizers or e-cigarettes offer a smokeless alternative to traditional smoking methods, potentially reducing harmful byproducts, offering controllable substance delivery, and diversifying flavor possibilities. Nevertheless, certain persistent challenges in their implementation, including uneven heat distribution, the generation of harmful by-products present in the aerosol secondary to the thermal degradation of the aerosol precursor by overheating, the presence of metals from the heating element in the aerosol, leakage of liquid precursor, residue buildup, and inhalation discomfort, necessitate further advancements in their design and operation.

Some current issues with vaporizers relate to effective heat delivery and liquid management. The relationship between the amount of liquid dispensed and the heat delivered by the heating element is important. When excessive liquid is dispensed, it may exceed the heating element's capacity to vaporize the liquid, which can lead to unvaporized liquid passing through the heating chamber. This can result in users inadvertently inhaling liquid precursor, creating an unpleasant experience. Conversely, if insufficient liquid is supplied relative to the heat produced, it may cause uneven heating. Uneven heating could affect the flavor profile and cause harmful by-products. Additionally, some vaporizers experience residue buildup on the heating elements, which compromises efficiency and contributes to uneven heating and inconsistent aerosol production, increased production of thermal degradation products from heating and reheating the buildup, ultimately affecting the overall quality and taste. Additionally, many vaporizers have metallic heating elements in direct contact with the liquid precursor, and/or in contact with the airflow path. This results in undesirable and often toxic components of the metal heating element being released into the aerosol and subsequently inhaled by the user. Furthermore, these devices may be prone to leakage under certain conditions, such as being left in a hot car or during high-altitude use, which can lead to device failure, and is an inconvenience and mess.

In various embodiments, vaporizer designs isolate heating elements, incorporate valve systems, and/or utilize responsive control systems. In an embodiment, a chamber design may be located in a reusable portion of a vaporizing device to reduce waste, or in a disposable cartridge or cartomizer for compatibility with other designs. The chamber design may include a heating element isolated from direct contact with the liquid, which helps eliminate the contribution of metals and/or compounds present in metallic heaters to the aerosol, helps prevent residue accumulation on the heater, mitigates hot spots to reduce thermal degradation, and maintains the temperature coefficient of the heating element for accurate temperature measurement. The chamber may also provide a more even heating surface for the precursor composition, ensuring consistent heating and enhancing flavor and user experience. Furthermore, in an embodiment, one or more valve systems help to prevent leakage when not in use. In an embodiment, an airflow system that entrains the aerosol generated by the heater and utilizes tortuous flow geometry including pressure and velocity differentials, impaction surfaces and directional changes to enable the selective removal of particles based on their size. The airflow system may be constructed to not be in direct contact with the heater to prevent any metallic components of the heater being present in the formed aerosol. Additionally, the vaporizer may incorporate a control system configured to dynamically adjust the power supplied to the heating element based on inhalation topography. This functionality may enable the device to measure pressure changes and corresponding user inhalation patterns, allowing for responsive adjustments in power; for instance, a strong inhalation may trigger an increase in power delivered to the heater, whereas a gentler inhale may result in reduced power output. Such features may enhance the overall efficiency and user satisfaction of the vaporizer.

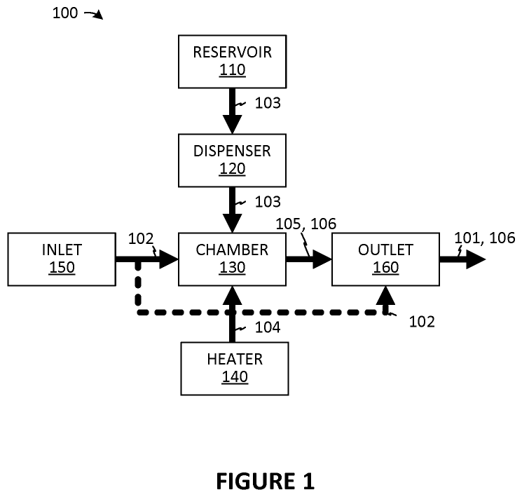

FIG. 1 illustrates a vaporizing device. Vaporizing device 100 may comprise reservoir 110, dispenser 120, chamber 130, heater 140, outlet 160, and inlet 150. The elements comprising vaporizing device 100 could be assembled to form a detachable cartridge for a vaporizing device, a vaporizing device having a detachable cartridge and a base module, or a fully integrated device.

Typical precursor compositions may exist in a liquid state within ambient temperature ranges or may transition to a liquid state within operating temperature ranges of vaporizing device 100. Propylene glycol (PG) and vegetable glycerin (VG) are commonly used as base liquids to create e-liquids sold on the market. Nicotine, cannabis extracts, and flavorings may be added to these base liquids to create the final product. Some precursors may exist in a solid or near solid state at typical ambient temperature ranges and must be heated in order to become a flowable liquid.

Reservoir 110 may be configured to store liquid precursor 103 for subsequent delivery to other elements of vaporizing device 100, such as chamber 130. Structurally, reservoir 110 may comprise an enclosure defined by walls, a base, and, in some embodiments, a closable opening or port to facilitate filling or refilling. Reservoir 110 may be coupled to dispenser 120, which can regulate a flow of liquid precursor 103 from reservoir 110 to chamber 130. In some embodiments, reservoir 110 could be permanently sealed following manufacturing to prevent tampering or contamination, while in other cases a refillable design may be preferred, possibly including a resealable cap or an access port designed for end-user convenience.

Construction materials for reservoir 110 may be selected based on chemical compatibility, mechanical durability, and user safety. For example, borosilicate glass may offer suitable chemical resistance and visibility, while food-grade polycarbonate, polycyclohexylene dimethylene terephthalate glycol-modified (PCTG), polyether ether ketone (PEEK), polypropylene (PP), polyethylene (PE), or stainless steel could also be considered. In an embodiment, reservoir 110 may be constructed of a Bisphenol A (BPA) free copolyester plastic. In an embodiment, the BPA-free copolyester plastic may be a polymer comprised of dimethyl terephthalate (DMT), cyclohexanedimethanol (CHDM), and 2,2,4,4-tetramethyl-1,3-cyclobutanediol (CBDO). These materials may be chosen for their resistance to liquid absorption, their resistance to leaching into the precursor contained in the reservoir, ability to withstand the thermal environment of the device, and compliance with relevant health and safety standards. In some embodiments, reservoir 110 may be fabricated to be transparent or semi-transparent, enabling the user to conveniently monitor liquid precursor 103 levels. The precise geometry and means for integrating reservoir 110 with other elements of vaporizing device 100 may vary depending on the intended method of assembly, refill-ability requirements, and device form factor.

Dispenser 120 may be configured to regulate a flow of a liquid precursor 103. Dispenser 120 may utilize capillary tubes or various styles of valves may be suitable for this role. Capillary tubes or capillary channels may take advantage of the flow characteristics of viscous fluids through small diameter tube(s) or channel(s) to regulate a flow of liquid precursor 103 to chamber 130, performing a similar function to a throttle valve. Capillary tubes or channels may be thermally controlled and/or thermally valved to take advantage of the temperature dependent viscosity of precursor liquid. In an embodiment, the flow tube(s) and/or channel(s) configured to regulate flow of the liquid precursor may not allow for flow of the precursor liquid at ambient temperature due to the viscous nature of the precursor and the diameter of the tube(s), and/or size and shape of the channel(s) which may be constructed to prevent the flow of the precursor liquid due to the ambient temperature viscosity of the precursor being too viscous to flow through the tube(s) and/or channel(s). In such embodiments, the capillary tube(s) or channel(s) may be heated, either directly by the primary heater, or directly from a secondary thermal source intended to heat the tube(s) and/or channel(s) such that the precursor present in the tube(s) or channel(s) may also be heated in order to reduce the viscosity of the precursor fluid such that flow through the tube(s) and/or channel(s) is achieved. Multiple valves may be combined to achieve a desired result. An on/off valve may be used to either completely stop or allow a flow, while a throttle valve may be used to control a flow rate. Some embodiments may utilize a mechanical valve. Some embodiments may utilize a thermal valve. Some embodiments may utilize a combination of valves.

In an embodiment, dispenser 120 may be combined with reservoir 110 to form a detachable cartridge for vaporizing device 100. One or more on/off valves could be used to prevent liquid precursor 103 from escaping reservoir 110 when it's detached from other components of vaporizing device 100. Dispenser 120 could include one or more on/off valves combined with one or more flow-regulating elements such that liquid precursor 103 is prevented from escaping the assembly until it is mated with a base unit, at which point the flow-regulating elements control the flow of liquid precursor 103 to other parts of vaporizing device 100.

Chamber 130 may generally be configured to contain a volume of liquid precursor 103 suitable for vapor 105 or aerosol 106 generation, and may include features to optimize both heat transfer and isolate heater 140 from liquid precursor 103. In various embodiments, chamber 130 may comprise a heating surface and a geometry intended to induce a vortical or rotational flow within it to maximize efficiency of vaporization and aerosol formation. In some embodiments, said heating surface may be configured to heat liquid precursor 103 using conduction. In some embodiments, the heating surface may be transparent to infrared radiation and/or ultraviolet radiation allowing liquid precursor 103 to be heated using radiation (or a combination of conductive and radiative heating). Some embodiments may utilize inductive heating. Chamber 130 may be constructed to promote rapid thermal equilibration, facilitate vapor 105 and/or aerosol 106 formation, and provide controlled exposure of liquid precursor 103 to a heated surface. It should be understood that alternative chamber 130 designs, shapes, or configurations, beyond the specific embodiments described herein, could be employed.

In some embodiments, chamber 130 may be configured to take advantage of unique thin film behaviors in viscous liquids, including increased shear resistance and enhanced surface effects such as surface tension and disjoining pressure, which can influence both the evaporation rate and aerosol characteristics. In such embodiment, chamber 130 may be characterized by a large surface area to height ratio, with dimensions such as 9.4 mm² by 0.75 mm, which can be considered a high surface area-to-height ratio. This arrangement may enable liquid precursor 103 to be heated more rapidly and uniformly to its vaporization temperature, providing enhanced heat transfer efficiency relative embodiments of chamber 130 with greater volume or lower surface area. The presence of a thin liquid precursor 103 layer may also permit the formation of vapor cells at the solid-liquid interface, contributing to efficient boiling and vaporization for a given temperature.

In an alternative embodiment, chamber 130 may be configured such that the volume of the chamber exceeds the liquid precursor 103 volume during normal operation. In this configuration, only a portion of chamber 130 is occupied by liquid precursor 103, while the remaining volume defines an airspace above liquid precursor 103, which may be used to facilitate vapor 105 or aerosol 106 formation and mixing. The heating surface may include geometry such as raised features, protrusions, or patterned elements, configured to increase the effective heating surface area relative to a flat surface.

Chamber 130 may include one or more intake port(s) configured to receive liquid precursor 103 from an external source, such as reservoir 110. In one embodiment, the intake port(s) may be positioned at the edge or edges, depending on the geometry, of chamber 130. In some embodiments, it may be desirable to include multiple intake ports to allow chamber 130 to fill more quickly and evenly. In an embodiment, the intake port(s) may be positioned in proximity and/or in conjunction to the air intake port(s) such that the inflow of air through the air intake port(s) may entrain the liquid precursor flowing through the liquid intake port(s) such that the entrainment may cause a correlation in the flow of the precursor liquid where the increased flow of the intake air through the port(s) may cause an increased flow in the intake of the liquid precursor flow rate through the port(s), and conversely a decreased flow of intake airflow may cause a decreased flow of the intake rate of the precursor liquid. In an embodiment the median flow rate of the precursor liquid intake may be 2 μL per second correlated to a median air intake flow rate of 10 mL per second.

Chamber 130 may include one or more exit ports to permit vapor 105 generated within to escape. In FIG. 1, certain flow paths are labeled as “105, 106” to indicate that, depending on the specific embodiment, either vapor 105 or aerosol 106 may be present at a given location (or both). This reflects the fact that mixing of air 102 and vapor 105 to form aerosol 106 may occur within chamber 130 in some embodiments, or alternatively, may take place at a downstream location, such as within outlet 160. As such, only vapor 105 or aerosol 106 may be present in particular sections of the device, with the precise composition varying according to the selected configuration. In some cases, aerosol 106 could be delivered directly from the exit ports to a user; however, it may be advantageous to further condition the aerosol by passing it through outlet 160, which could selectively remove particles based on their size prior to user delivery. In an embodiment, the generated aerosol and/or vapor may have a particle size of 2.5-5 microns and the exit path geometry and features may trap aerosol and/or vapor particles larger than 5 microns. In an embodiment, the aerosol and/or vapor particles that are larger than 5 microns may be trapped and prevented from exiting to the user and may be returned to the chamber to be present as precursor liquid to be aerosolized and/or vaporized in the subsequent activation cycle. Additionally, one or more valves may be coupled to the exit ports to prevent liquid precursor 103 from escaping chamber 130 when vapor or aerosol generation is not occurring.

Liquid precursors are commonly made from propylene glycol, vegetable glycerin or a combination of the two. Propylene glycol has a boiling point around 188° C. (370° F.) and vegetable glycerin has a boiling point around 290° C. (554° F.). Heating propylene glycol or vegetable glycerin below 188° C. (370° F.) may result in incomplete vaporization and heating above 300° C. (572° F.) may cause thermal decomposition of the ingredients and potentially produce toxic, or other undesirable, byproducts. For these reasons, optimal vaporization may occur between 188° C. (370° F.) and 250° C. (482° F.). In an embodiment, the temperature required for optimal vaporization may be decreased by the application of vacuum to chamber 130 from the passage of airflow into chamber 130 and the exit of aerosol and/or vapor from chamber 130. In an embodiment, the vacuum may be generated by the inhalation of the user when using the device. When constructing chamber 130, it may be desirable to select materials capable of exposure to these temperature ranges. Resistive heating elements manufactured from nichrome (NiCr), Kanthal® (FeCrAl), stainless steel(s), and titanium(s), may be heated to about 200° C. to 300° C. (392° F. to 572° F.) in normal operation and are capable of reaching temperatures exceeding 1,000° C. (2,192° F.). Therefore, it may be desirable to manufacture chamber 130 from a material or materials capable of withstanding these temperatures. In an embodiment, the resistive heating element(s) may have a temperature dependent electrical resistance such that measuring the resistance of the element during operation can be used to determine the temperature of the resistive heating element during operation. In an embodiment, the resistive heating element(s) may have a temperature dependent electrical resistance such that the resistance of the heating element can be used to measure the temperature of the element prior to operation.

Chamber 130 may be fabricated from a range of materials and by employing various manufacturing techniques, depending on the specific design goals of the vaporizing device 100. For instance, in cases where an infrared (IR) heating method is utilized, at least a portion of chamber 130 may be constructed from an IR-transparent material to facilitate efficient heat transfer to the precursor. In an embodiment, chamber 130 may be constructed from an IR-absorptive material to facilitate efficient heat transfer to chamber 130 in order to subsequently heat a precursor. In cases where an ultraviolet (UV) heating method is utilized, at least a portion of chamber 130 may be constructed from an UV-transparent material to facilitate efficient radiating of the precursor. In an embodiment utilizing UV radiation, chamber 130 may include selected regions configured to be transparent to UV radiation thereby allowing a precursor to be irradiated, while other regions of chamber 130 may be configured to block UV radiation in order to prevent its escape from chamber 130. In an embodiment that utilizes IR and/or UV radiation, chamber 130 may include IR and/or UV reflective surfaces in order to trap the IR and/or UV energy within chamber 130. In an embodiment utilizing IR and/or UV radiation to heat the precursor, chamber 130 may be constructed where a region of the chamber configured to allow the transmission of IR and/or UV radiation may be a lens configured to focus the IR and/or UV energy onto the precursor, where the focal length of the lens may be optimally configured to heat the precursor. In an embodiment utilizing IR and/or UV radiation to heat the precursor, chamber 130 may be constructed such that a region allowing transmission of the IR and/or UV radiation may include a diffusor. The diffusor may serve to distribute IR and/or UV energy onto the precursor, and the diffusor length may be optimally configured to evenly heat the precursor. Alternatively, if an inductive heating approach is preferred, it may be advantageous to select a conductive material, such as a ferritic stainless steel. Chamber 130 may be designed as a monolithic component, or it may comprise multiple assembled parts, which may provide greater flexibility in the selection of materials or manufacturing methods. In some embodiments, materials compatible with certain manufacturing techniques, such as injection molding, machining, or additive manufacturing, may be chosen to meet durability, cost, or performance requirements. Additionally, it is possible that many of the same materials contemplated for reservoir 110 could also be suitable for use in chamber 130, offering options for material standardization or compatibility within the device. In an embodiment, chamber 130 may be constructed from amorphous fused silica (SiO₂). In an embodiment, chamber 130 may be constructed using a crystalline fused silica (SiO₂), also called fused quartz, and quartz glass. In an embodiment, the fused silica (SiO₂) may be intentionally manufactured to include trapped air bubbles and/or inclusions to fabricate a diffusor. In an embodiment, chamber 130 may be constructed of fused silica (SiO₂) fabricated to exhibit high optical homogeneity, thereby optimizing transmission of IR and UV radiation. For embodiments utilizing high IR transmittance, chamber 130 may be constructed of a fused silica (SiO₂) having a low content of hydroxyl (OH), such that the hydroxyl (OH) content is below 10 ppm in the fused silica (SiO₂). In an embodiment, chamber 130 may be constructed using a water vapor-free plasma flame process so that the resulting fused silica (SiO₂) chamber 130 may have a hydroxyl (OH) content below 10 ppm. Embodiments of chamber 130 having low IR transmittance and high IR absorption may be constructed of a fused silica (SiO₂) including a relatively high content of hydroxyl (OH). For example, a high hydroxyl (OH) content may be greater than 10 ppm and as high as 1000 ppm. Ordinary flame processing of fused silica (SiO₂), also called flame fusion, may be used to construct chamber 130 having hydroxyl (OH) content in the range of 10-1000 ppm.

Chamber 130 may be configured to include a high degree of UV transmissibility. In such embodiments, chamber 130 may comprise fused silica (SiO₂) having low levels of metallic impurities (e.g., 1 ppm or less). Fused silica (SiO₂) may be selected, in part, because it is not substantially degraded by UV irradiation, exhibits favorable solarization resistance, and demonstrates low radiation-induced absorption attributable to color centers. Additionally, the material may be fabricated to possess minimal UV-induced fluorescence and phosphorescence, further supporting its suitability for such applications. In an embodiment optimized for UV transmission, the fused silica (SiO₂) chamber 130 may be constructed using flame hydrolyzation of silicon tetrachloride (SiCl₄) (also known as tetrachlorosilane) to lower the content of metallic impurities and improve UV transmission. In an embodiment where chamber 130 is constructed for UV absorption, metals can be used in the fused silica (SiO₂) at a ratio of 1-50 ppm. Metals that can be used to absorb UV radiation in fused silica (SiO₂) include, but are not limited to, Iron (Fe), Copper (Cu), Lead (Pb), Nickel (Ni), Cerium (Ce), Calcium (Ca), and Potassium (K). In an embodiment, ferric iron (Fe³⁺) and or copper (II) ion, also called cupric ion (Cu²⁺), are used as the metals present in the fused silica (SiO₂) to absorb UV radiation at a ratio of 1-50 ppm. In an embodiment different grades of fused silica (SiO₂) can be utilized to optimize IR and or UV transmission and or IR and UV absorption in chamber 130. For example, an embodiment comprising a fused silica (SiO₂) chamber 130 may be constructed to be absorptive to both IR and/or UV. In such embodiments, fused silica (SiO₂) may include metallic impurities present at a ratio of 1-50 ppm to help absorb UV radiation and may have high hydroxyl (OH) content (e.g., greater than 10 ppm and as high as 1000 ppm) to help absorb IR radiation for the purpose of heating chamber 130.

In an embodiment, chamber 130 may comprise a fused silica (SiO₂) having favorable transmission properties for IR and UV radiation, while also maintaining a low hydroxyl (OH) content (e.g., less than 10 ppm) and low levels of metallic impurities (e.g., 1 ppm or less). In an embodiment, chamber 130 may be configured to have favorable IR transmission with a hydroxyl (OH) content less than 10 ppm, while metallic impurities may be present at higher concentrations, such as greater than 1 ppm and up to 50 ppm or higher, to facilitate greater UV absorption. In yet another embodiment, chamber 130 may be configured to exhibit good IR absorption by utilizing fused silica with a hydroxyl (OH) content greater than 10 ppm and up to 1000 ppm, while maintaining good UV transmission with metallic impurity less than 1 ppm. Chamber 130 may be manufactured from a variety of types fused silica (SiO₂) and/or fused quartz (SiO₂), depending on the specific embodiment. For example, Herasil®, Homosil®, Optosil® and Vitreosil® are fabricated with flame fusion, have high OH content (usually 150 to 400 ppm) and are transmissive to visible light and UV radiation, and are absorptive to IR radiation. Suprasil® and Spectrosil® are a type of fused silica (SiO₂) made with flame hydrolyzation of SiCl₄, having a much lower content of metallic impurities, but also having a high OH content, making these types of fused silica (SiO₂) transmissive of UV radiation while being absorptive of IR radiation. Very low OH content (below 1 ppm) is achieved for materials like Infrasil®, Suprasil W® and Spectrosil WF®, made with a water vapor-free plasma flame which allows for transmission of IR radiation.

In an embodiment, chamber 130 may comprise fused silica (SiO₂) with one or more of the following properties: (1) no metallic impurities (or no deliberate metallic impurities) and color (E′) centers below 260 nm, (2) UV transmission at 200 nm: 84% or greater, (3) visible light transmission at 300-1000 nm 92% or greater (4) a low amount of hydroxyl groups, comparable to commercial fused quartz, (5) IR transmission at 1000-3400 nm 90% or greater, (6) bending strength 115 Mpa or greater, (7) Vickers hardness of 980 HV or greater, (8) thermal expansion 0.52×10⁻⁶ or less (9) static contact angle with water of 36° or approximately 36°, and/or (10) surface energy of 60 mN/m or approximately 60 mN/m.

Heater 140 may be coupled to chamber 130 in order to heat liquid precursor 103 delivered from reservoir 110 without coming into direct contact with it. A variety of heating element types may be suitable for this application, and the selection may be influenced by the desired operational characteristics or manufacturing constraints of vaporizing device 100. In some embodiments, heater 140 may take the form of a resistive heater, which may utilize an electrical current to generate heat 104 through resistance. Manufacturing heater 140 from a material having a known temperature coefficient may allow a sensing mechanism to determine the temperature of heater 140 by measuring the resistance. Materials such as nichrome, Kanthal®, titanium, stainless steel, tungsten or similar alloys may be considered due to their stable resistance properties and durability under repeated thermal cycling. In some embodiments, one or more glass enveloped filaments such as a halogen bulb or a xenon bulb may be used as a heating element. In such embodiments, it may be desirable to enclose the bulb in quartz to protect from thermal shock. Heater 140 may comprise an infrared heating element, in which case the element may be configured to emit radiation that is absorbed by liquid precursor 103 or by an intermediary structure. Heater 140 may be constructed of two discrete emitters; the first being an IR emitter (such as an IR diode) and the second being a UV emitter (such as a UV diode). In such an embodiment, the IR and UV diodes may be constructed in a single emitter structure, or may be constructed as distinct separate emitters. Heater 140 may be constructed of coherent IR and/or UV emitters. Heater 140 may be constructed of non-coherent IR and/or UV emitters. Heater 140 may be constructed of non-coherent IR and/or UV emitters coupled with a focusing element such as a lens to increase the coherence of the emission. Heater 140 may be constructed of non-coherent IR and/or UV emitters coupled with a focusing element such as a lens to focus the emission at a determined focal point determined by the focal length of the lens.

Heater 140 may be manufactured using a range of fabrication methods. In some examples, a resistive material may be deposited onto a substrate, such as fused silica, ceramic, glass, or metal, using processes like direct writing, sputtering, screen printing, or chemical vapor deposition. The deposited layer may then be patterned, for example etched, to achieve a defined heating geometry tailored to the application. In other embodiments, wire-wound or mesh-style resistive elements may be incorporated. Heater 140 may be cut, stamped or punched out of a sheet of resistive metal such as nichrome. IR and/or UV diodes or lasers may be used to generate infrared and/or UV radiation. In an embodiment, heater 140 may be constructed using photochemical etching of a resistance metal substrate such as nichrome. In an embodiment, heater 140 may be constructed by using a process of photochemical machining of a resistive metal substrate such as nichrome. In an embodiment, a process of acid etching a resistive metal such as nichrome may be used to form heater 140. In an embodiment, a process such as photochemical etching and/or photochemical machining may be used to form a resistive element where the cross-section profile is non-round such that heater 140 has flat section in cross-section to improve surface area to contact the chamber. In an embodiment, the cross-section profile of a photochemically etched and or photochemically machined heater 140 may be polygonal with one of the sides of the polygon intended to contact a flat surface of the chamber. In an embodiment, heater 140 may be fabricated using a process such as photochemical etching and or photochemical machining from a thin ribbon or sheet of a resistive metal, for example, nichrome. Heater 140 may be retained within the metallic ribbon or sheet by one or more small tab features, enabling the heater to be handled as part of a reel or spool for high-speed or automated assembly processes, such as pick-and-place methods. The tabs may then be cut or otherwise removed at the point of assembly. In an embodiment, heater 140 may have a first resistive region intended to reach temperatures required to effect the generation of an aerosol and/or vapor from a precursor in the chamber, a second region intended to establish electrical contact such that the heater can be activated by a controller, and a third region intended to heat the precursor flow tube(s) and or flow channel(s) comprising a dispenser to facilitate flow of the precursor fluid that has a temperature dependent viscosity such that the viscosity decreases as the precursor temperature increases. The specific choice of construction and fabrication methods for heater 140 may be based on considerations such as desired resistance range, heating efficiency, manufacturability, and compatibility with other components of the vaporizing device 100.

Inlet 150 may introduce air 102 into vaporizing device 100 at one or more locations, depending on the specific embodiment, to entrain vapor generated by chamber 130 to form aerosol 106. In certain embodiments, inlet 150 may be coupled to chamber 130 to deliver air 102 directly into chamber 130. In alternative configurations, inlet 150 may couple to other elements comprising vaporizing device 100, such as outlet 160, to combine air 102 with vapor 105 at or near outlet 160. In an embodiment, the precursor inlet port(s) may be positioned in proximity and/or in conjunction to inlet 150 such that the inflow of air through inlet 150 entrains the liquid precursor flowing through the liquid intake ports such that the entrainment causes a correlation in the flow of the precursor liquid where the increased flow of the intake air through the inlet 150 causes an increased flow in the intake of the liquid precursor flow rate through the port(s), and conversely a decreased flow of intake airflow through inlet 150 causes a decreased flow of the intake rate of the precursor liquid. In an embodiment, the median flow rate of precursor liquid intake is 2 μL per second correlated to a median air intake flow rate of 10 ml per second.

In some embodiments, inlet may be configured to deliver air 102 into chamber 130 and to outlet 160, either individually or in combination, thereby enabling flexible operation and air management within vaporizing device 100.

Inlet 150 may comprise tortuous flow geometry configured to condition an incoming stream of air 102 by imposing changes in velocity and pressure, as well as introducing directional changes and impaction surfaces to increase the transit time of air 102. In certain embodiments, the tortuous flow geometry may further comprise a sequence of expansions, contractions, or baffles, in proximity to a chamber that houses heater 140. Moving air 102 over chamber 130 structure may allow for heat exchange between air 102 and chamber 130, which facilitates heating of air 102, thereby optimizing the temperature of air 102 delivered toward the chamber regions of the device. In an embodiment, inlet 150 may be in proximity to chamber 130 and may be heated due to the proximity. Air 102 passes through inlet 150 and absorbs heat from inlet 150 serving to remove excess heat from the body of chamber 130 and pre-heating air 102 prior to entering chamber 150. Pre-heating air 102 may increase the efficiency of the vapor and/or aerosol generation by reducing the amount of cooling effect air 102 has on liquid precursor 103, and/or chamber 130.

Outlet 160 may be coupled to one or more exit ports of chamber 130 and may be configured to deliver aerosol 106 to a user. In some embodiments, outlet 160 may be further configured to condition vapor 105 or aerosol 106 prior to delivery to a user. Vapor 105 or aerosol 106 may be conditioned by subjecting it to a tortuous flow geometry, which could include a series of impaction surfaces and directional changes as well as pressure and velocity changes. Such features may be designed to selectively remove particles from a stream of vapor 105 and/or aerosol 106, for example by causing larger droplets or particles to deviate from the main flow. In some cases, outlet 160 may include a flow path designed to establish changes in velocity or pressure along the route, further enhancing the selective removal of particles based on their size or inertia. In an embodiment, the generated aerosol and/or vapor has a particle size of 2.5-5 micron and outlet 160 geometry and features trap aerosol and/or vapor particles larger than 5 microns. In an embodiment, the aerosol and/or vapor particles that are larger than 5 micron may be trapped and prevented from exiting outlet 160 to the user and returned to the chamber 130 to be present as precursor liquid volume to be aerosolized and/or vaporized in chamber 130 during the subsequent activation cycle.

Selection of materials for inlet 150 and outlet 160 may be primarily guided by performance requirements and desirable physical or chemical characteristics. Materials exhibiting inertness, non-reactivity with the liquid precursor or aerosol components, and resistance to degradation under the anticipated thermal and operational conditions may be particularly advantageous. Additionally, surfaces may be textured or treated to influence flow characteristics, such as optimizing droplet deposition, minimizing unwanted condensation, or promoting specific aerosol particle behaviors. In certain embodiments, inlet 150 and outlet 160 may be integrated into other components of vaporizing device 100, such as a chassis, housing, or control system. In such cases, material selection for the supporting component may become the principal consideration. Surface finish, wall thickness, and geometric complexity may be adapted according to the chosen manufacturing method and intended aerosol delivery performance.

In operation, a user may apply suction 101 to outlet 160, which may induce a flow of air 102 into vaporizing device 100 through inlet 150. In certain embodiments, inlet 150 may incorporate conditioning features, such as tortuous flow geometry comprising impaction surfaces or pathways inducing directional changes, to selectively remove entrained particles from air 102 prior to its combination with vapor 105 generated by chamber 130. This pre-conditioning may facilitate formation of an aerosol 106 optimized for deep lung delivery and/or deposition by reducing particle load prior to mixing. Inlet 150 may be configured to deliver air 102 to chamber 130 or to outlet 160, or a combination thereof, depending upon the specific embodiment implemented.

Chamber 130 may be supplied with liquid precursor 103 from reservoir 110. The delivery of liquid precursor 103 to chamber 130 may be regulated by dispenser 120, which could include thermal and/or mechanical valves, capillary tubes and/or channels, or other flow control elements.

Heater 140 may be configured to activate in response to various triggers, such as a change in pressure, detection of an intake air flow rate, detection of an airflow sound, or manual actuation of a switch. Upon activation, heater 140 may supply heat 104 to liquid precursor 103 within chamber 130, such that at least a portion of liquid precursor 103 is vaporized. In some embodiments, liquid precursor 103 within chamber 130 may act as a hydrostatic plug, potentially restricting replenishment from reservoir 110 until the existing liquid precursor 103 is substantially vaporized and exits chamber 130. As the vaporization process reduces the volume of liquid precursor 103 contained in chamber 130, reservoir 110 may provide additional liquid precursor 103, which can be regulated or throttled by dispenser 120. In an embodiment the hydrostatic plug is also a viscosity dependent capillary plug where dispenser 120 must be heated in order to reduce the viscosity of the precursor which is comprised primarily of compounds that have viscosities that are temperature dependent, such as propylene glycol, glycerol, or cannabinoid extracts. Dispenser 120 may be heated during activation which allows for dispensing of precursor during the activation cycle, and may not be heated in between activation cycles which may prevent dispensing of precursor when the device is inactive. The heating of dispenser 120 can be performed by the primary heater 140, or by a secondary heater that is dedicated to only heating dispenser 120.

Vapor 105 generated by chamber 130 may be entrained in a stream of air 102 at chamber 130 or at outlet 106, or both, thereby forming aerosol 106. Aerosol 106 may be drawn into outlet 160 by suction 101. Outlet 160 may include geometric features-such as impaction surfaces, bends, or varying cross-sectional areas-configured to selectively separate particles from aerosol 106 based on size, mass, inertia, or other physical properties. In some embodiments, outlet 160 may further induce changes in velocity, pressure, or establish vortical and eddy formations that encourage further selection or deposition of unwanted particles prior to final aerosol 106 delivery to the user.

FIG. 1 may have presented the basic components comprising a vaporizing device but additional features may be added. For example, components may be included to prevent a liquid precursor from leaking from the device.

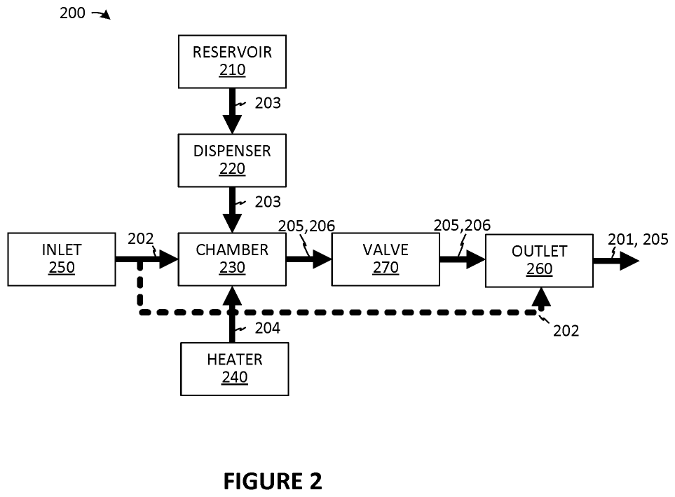

FIG. 2 illustrates a vaporizing device. Vaporizing device 200 may comprise reservoir 210, dispenser 220, chamber 230, heater 240, inlet 250, outlet 260, and valve 270. The elements comprising vaporizing device 200 could be assembled to form a detachable cartridge for a vaporizing device, a vaporizing device having a detachable cartridge and a base module, or a fully integrated device.

Vaporizing device 200 may be an embodiment of vaporizing device 100 while introducing valve 270 disposed between chamber 230 and outlet 260 to inhibit leaking of liquid precursor 203 from chamber 230 when not in use. Valve 270 may be actuated by a variety of mechanisms, including but not limited to vapor pressure buildup within chamber 230, user-applied suction 201 at outlet 260, or by mechanical or electromechanical means, depending on the specific implementation. Actuation of valve 270 may facilitate the controlled transfer of vapor 205 and/or aerosol 206 from chamber 230 to outlet 260, enabling delivery to a user while maintaining containment of liquid precursor 203 under non-operational conditions. The selection of actuation method for valve 270 may be guided by desired user experience, safety considerations, or compatibility with other system components.

In some embodiments, valve 270 may function as a one-way valve, opening in response to vapor pressure generated from applying heat 204 to chamber 230, user suction 201, or other detectable activation events. A variety of one-way, or check valve designs may be suitable for this role, including but not limited to flap valves, poppet valves, lift check valves, ball check valves, diaphragm valves, or duckbill valves. The particular choice of valve type may be guided by factors such as desired flow characteristics, ease of manufacture, or compatibility with other components comprising vaporizing device 200. Some embodiments may incorporate multiple instances of valve 270.

The operation of vaporizing device 200 may be similar to the operation of vaporizing device 100 with the addition of valve 270. Valve 270 may be configured to default to a closed position when vaporizing device 200 is not in use, thereby preventing leakage of liquid precursor 203 from the device. During operation, application of suction 201 to outlet 260 by a user may induce a flow of air 202 through inlet 250, and may also actuate valve 270 to allow aerosol formation and delivery. In alternative embodiments, valve 270 may be actuated in response to vapor pressure buildup within chamber 230 as a result of aerosol formation from precursor, mechanical actuation, electromechanical control, or another appropriate triggering event, depending on the specific system configuration. Valve 270 may be configured as a variable pressure valve where the pressure exerted against the valve due to changes in atmospheric conditions (e.g., such as when increased temperature, and/or decreased atmospheric pressure act upon the air volume present in the reservoir causing it to expand and exert pressure on the precursor present in the dispenser 220, and chamber 230) would not be of sufficient pressure to cause valve 270 to open to outlet 260. In an embodiment, vaporizing device 200 may be leak resistant and/or leak proof at a range of ambient temperatures and/or atmospheric pressures. The actuation mechanism and default state of valve 270 may be tailored to optimize user experience and to ensure secure containment of the liquid precursor under non-operational conditions when the device is not being activated.

Vaporizing device 200 included a valve disposed between chamber 230 and outlet 260 to prevent a liquid precursor from leaking through outlet 260 when the device is not in use. Some embodiments may present another avenue for leakage between a chamber and an inlet.

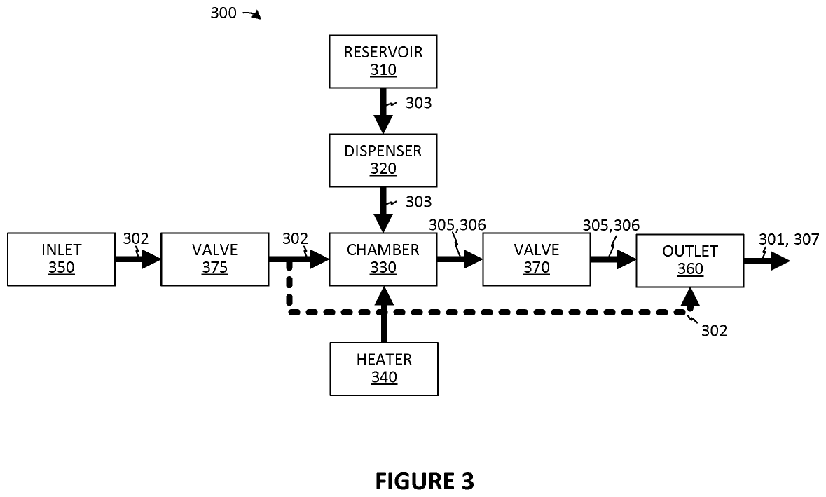

FIG. 3 illustrates a vaporizing device. Vaporizing device 300 may comprise reservoir 310, dispenser 320, chamber 330, heater 340, inlet 350, outlet 360, valve 370, and valve 375. The elements comprising vaporizing device 300 could be assembled to form a cartomizer, a detachable cartridge for a vaporizing device, a vaporizing device having a detachable cartridge and a base module, or a fully integrated device.

Vaporizing device 300 may be an embodiment of vaporizing device 100, 200, operating in a generally similar fashion but incorporating valve 375 between chamber 330 and inlet 350. Vaporizing device 300 may include valve 370 in some embodiments but not in others.

Valve 375 may be a one-way valve with an upstream port coupled to inlet 350 and a downstream port coupled to chamber 330 to prevent liquid precursor 303 leaking from chamber 330. Valve 375 may be actuated by suction 301, pressure changes, or some other detectable event. Various types of one-way, or check, valve designs may be suitable for this role, including but not limited to flap valves, poppet valves, lift check valves, ball check valves, diaphragm valves, or duckbill valves. The choice of valve type may be guided by factors such as desired flow characteristics, ease of manufacture, or compatibility with other components comprising vaporizing device 300. In an embodiment, valve 375 may be actuated to the open position by the inhalation of the user and may be in the closed position when the user is not inhaling and or vaporizing device 300 is in an inactive state. Some embodiments may include multiple instances of valve 375.

Valve 375 may be configured to default to a closed state and to open only when vaporizing device 300 is in use. For example, valve 375 may default to a closed position when vaporizing device is transported or stored to prevent liquid precursor 303 from escaping chamber 330 and may open in response to suction 301 to permit a flow of air 302 into chamber 330. Alternative embodiments may include other methods of valve actuation. For example, valve 375 may be a poppet valve including a stem that allows for remote actuation. In this case, valve 375 may be actuated in response to a sensor input or some other detectable event. In an embodiment, valve 375 may be a direction valve such that it is resistant to flow and or pressure exerted from chamber 330 toward inlet 350, and that flow and/or pressure in the direction of inlet 350 causes the valve to increase the sealing force of the valve with the increase in flow or pressure in the direction of the chamber 330 towards inlet 330, and that only flow in the direction of the inlet 350 towards the chamber 330 allows for the valve 375 to open.

The operation of vaporizing device 300 may generally correspond to that of vaporizing device 100 or 200, distinguished here by the addition of valve 375. Valve 375 may be disposed between inlet 350 and chamber 330 and is configured to default to a closed position when the device is not in use. In operation, application of suction 301 to outlet 360 by a user may result in valve 375 opening to permit a flow of air 302 into vaporizing device 300. In certain embodiments, opening of valve 375 may alternatively be triggered by a pressure differential, mechanical actuation, or a detectable operational event, depending on the implementation. This valve arrangement may function to inhibit unintended leakage of liquid precursor 303 from chamber 330 through inlet 350 during storage or transport, or due to changes in environmental conditions such as increased temperature or decreased atmospheric pressure, improving precursor containment and device integrity under non-operational conditions when the device is in an inactive state.

Operation of the remaining components may be consistent with previously described embodiments. Chamber 330 may receive liquid precursor 303 from reservoir 310 via dispenser 320 which may comprise flow control features such as valves or capillary tube(s) and/or channel(s). Heater 340 may be configured for actuation in response to user input, sensed airflow, a threshold of detected flow rate of intake air 302, or pressure changes, and upon activation may supply heat to chamber 330 to vaporize at least a portion of the received liquid precursor 303. Generated vapor 305 may be entrained in air 302 stream to form aerosol 306, which is drawn toward outlet 360. Outlet 360 may include features such as impaction surfaces, bends, or variable-area regions designed to facilitate selective removal of particles due to size and/or mass characteristics. In some embodiments, additional valves, such as valve 370, may further regulate flow or containment by opening in response to operational triggers, thus enhancing control over aerosol 306 delivery and leakage prevention.

The previously described embodiments of vaporizing devices have been particularly suitable for constructing detachable cartridges or cartomizers. In these embodiments, the heater may be configured to receive power external to the device. Vaporizing devices may include control systems to regulate delivery of power to the heating elements.

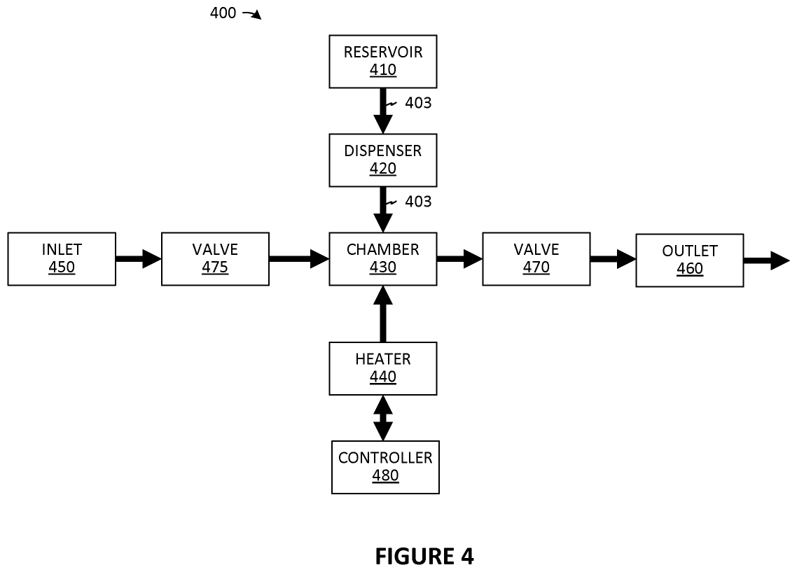

FIG. 4 illustrates a vaporizing device. Vaporizing device 400 may comprise reservoir 410, dispenser 420, chamber 430, heater 440, inlet 450, outlet 460, valve 470, valve 475, and controller 480. The elements comprising vaporizing device 400 could be assembled to form a cartomizer, a detachable cartridge for a vaporizing device, a vaporizing device having a detachable cartridge and a base module, or a fully integrated device.

Vaporizing device 400 may be an example of previously described vaporizing devices, operating in a generally similar fashion but incorporating controller 480. Controller 480 may be configured to control power delivery to heater 440 and collect data, such as air flow rate into inlet 450, inactive and active state temperature of heater 440, and pressure, which may be calculated based on the measured flow rate through inlet 450, about vaporizing device 400. Data collection may enable fine-tuning of the heating rate and ultimately the aerosol production. In an embodiment, the data collection may enable predictive control of the heating rate and ultimately the aerosol production. Data collection may enable the determination of the user's unique inhalation profile(s) and characteristics of the inhalation profile such as flow rate(s), duration, and frequency to use the unique inhalation profile of the user as the triggering event for activation.

Controller 480 may be coupled to heater 440 and configured to supply power to heater 440. Controller 480 may utilize a variety of control methods such as real time resistance measurement and/or monitoring of heater 440, real time temperature measurement and/or monitoring of heater 440, pulse-width modulation (PWM), bang-bang, voltage, or current control to regulate power delivered to heater 440. Controller 480 is assumed to include a power source for the sake of discussion.

Controller 480 may be configured to operate in either an open-loop or a closed-loop mode. In an open-loop system, the control logic may supply a fixed signal, such as a fixed PWM signal, to heater 440, without any feedback from temperature or environmental sensors. While such a system can be simple and cost-effective, it generally lacks the ability to adapt to variations in fluid properties, battery voltage, or user behavior, which can result in inconsistent vapor production, reduction in fraction of aerosol suitable for delivery and/or deposition to the deep lung, and reduced user satisfaction. By contrast, a closed-loop system may incorporate real-time feedback, such as the resistance of heater 440 for temperature estimation or data from other sensors such as flow rate of intake air flow, as well as pressure data which may be used to determine real-time boiling point temperature of the liquid precursor 403 to dynamically adjust the power delivered to heater 440 and maintain consistent performance and optimal vapor and/or aerosol formation.

One key advantage of closed-loop control is the ability to compensate for changing conditions during use. For example, if vaporizing device 400 is used in different ambient temperatures or at different altitudes, the system can automatically adjust the power supplied to heater 440 to account for these changes. This kind of adaptability may help maintain a preferred vaporization temperature, minimize the risk of overheating or burning the fluid, and ensure a reliable and repeatable user experience. Monitoring real-time parameters such as resistance of heater 440 and pressure, may allow vaporizing device 400 to optimize aerosol production dynamically. Monitoring real-time pressure values in the inlet 450 and chamber 430 allows for adjusting the real-time temperature of heater 440 and/or modulating the real-time power delivered to heater 440 to target the real-time boiling point of liquid precursor 403.

In some embodiments, controller 480 may also utilize sensors, including flow-rate through inlet 450, pressure in inlet 450 and/or chamber 430, and/or controller 480, and temperature of heater 440 and/or chamber 430, to characterize inhalation topography. For example, a sharp and heavy inhalation may be detected as a large and rapid pressure change and, possibly, a decrease in the temperature of heater 440, prompting the control system to increase the duty cycle or the power applied to heater 440 to keep up with the increased airflow and vapor demand. Conversely, a gentle inhale may require less power to achieve the desired vapor density. By mapping sensor signals to control strategies, the device may be able to deliver a more tailored and satisfying experience for a range of inhalation styles, accommodating both light and deep draws with consistent aerosol output.

In some embodiments, controller 480 may be configured to monitor sensors, such as flow rate sensor, temperature sensors and/or pressure sensors, while operating in an inactive or sleep state and may activate heater 440 to maintain liquid precursor 403 at predetermined temperature. Liquids commonly used in vaporizing devices or e-cigarettes tend to exhibit predictable thermoviscous behavior, meaning their viscosities at different temperatures and pressures can be predicted. In general, liquids tend to be more viscous at lower temperatures. Therefore, if a user is outside in the winter, liquid precursor 403 may be too viscous to reliably supply chamber 430. This problem may be solved by monitoring environmental conditions, such as temperature and/or pressure, of reservoir 410 or chamber 430 when the device is not in use and periodically activating heater 440 to heat liquid precursor 403 to a temperature that maintains an optimal viscosity. Heater 440 may serve as a resistance temperature detector and/or sensor such that heater 440 may be used to measure ambient temperature when vaporizing device 400 is otherwise in an inactive state and/or at the initiation of an activation cycle. In an embodiment, heater 440 may be used to heat liquid precursor 403, dispenser 420, and reservoir 410 in such a manner that the heating of those components causes the air present in reservoir 410 to also be heated and the expansion of the air exerts a positive pressure on the liquid precursor 403 in the reservoir 410 and the dispenser 420 causing a flow of precursor liquid 403 from the reservoir 410 though the dispenser 420 and into the chamber 430.

In an embodiment, controller 480 may utilize machine learning, based on user feedback, or user training data, to determine mappings from sensor signals to control parameters. For example, users of vaporizer 400 may provide an indication (e.g., via a button, microphone, gyroscopic sensor, puff sequence, etc.) of a satisfaction level (e.g., thumbs up, thumbs down) for inhalation cycles that is used to train a machine learning model to control, based on the sensor inputs, etc., the various parameters (e.g., heater 440 power etc.) that controller 480 can control during an inhalation cycle. In an embodiment the controller 480 may utilize machine learning without direct feedback from the user where the data input is resultant from the use of the device, where unique characteristics of the users activation of the device such as inhalation flow rate, inhalation flow rate variability during use, inhalation duration, inhalation frequency, duration of time between inhalations, relation of inhalation to time of day, inhalation characteristics related to ambient and/or environmental conditions, and other related data may be used to train the machine learning model to optimize activation cycles based on the user's unique activation characteristic(s) and/or inhalation profile(s). This method may be used to recognize a user specific inhalation profile(s) that is characteristic of the specific user such that the device recognizes a characteristic inhalation to a specific user and optimizes the specific activation cycle to match that specific inhalation profile(s).

Various components comprising vaporizing devices have been described. These components may be combined in different ways to produce alternative embodiments of vaporizing devices having similar features and functionality. Existing vaporizing devices are often comprised of a disposable cartridge, or cartomizer, and a reusable base unit. The disposable cartridge typically contains the liquid precursor along with one or more elements required for vaporization and is discarded once the liquid precursor is depleted. In practice, any of the described components, including the reservoir, chamber, dispenser, heater, or valve, may be incorporated into either the detachable portion or the reusable portion of the device. The allocation of components between these portions may be determined by factors such as manufacturing efficiency, intended device longevity, regulatory compliance, and user convenience. As a result, a variety of modular and integrated system architectures may be achieved.

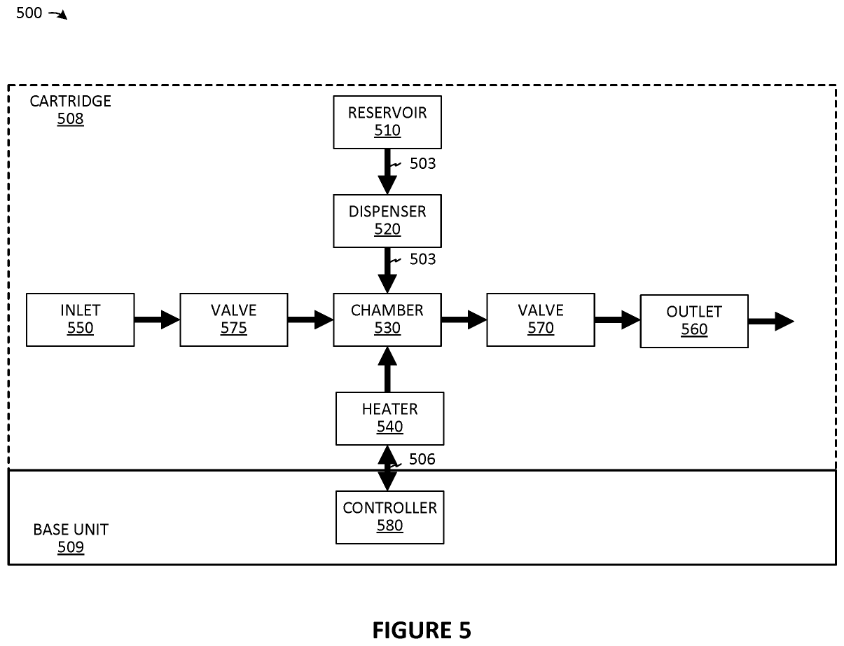

FIGS. 5 through 7 illustrate various embodiments of vaporizing devices characterized by different allocations of functional components between a disposable cartridge and a reusable base unit. Each embodiment may serve as an alternative implementation of the vaporizing devices previously described with reference to FIGS. 1-4, such as vaporizing devices 100, 200, 300, and 400. It should be appreciated that the configurations depicted in FIGS. 5-7 may be construed as exemplary and not limiting, and that further arrangements are contemplated. For example, vaporizing device 500 might be realized without valve 570 or valve 575, or with flow path variations allowing air, vapor, or aerosol to traverse a different sequence of elements, consistent with earlier descriptions.

FIG. 5 illustrates vaporizing device 500, which may be segregated into two cooperating subassemblies: cartridge 508 and base unit 509. In certain embodiments, cartridge 508 may incorporate reservoir 510 to contain a liquid precursor 503, dispenser 520 for controlled dosing, chamber 530 for vaporization, a heating element 540, inlet 550 and outlet 560 for fluid transfer, and valves 570 and 575 that may function to regulate flow or mitigate leakage risk under selected conditions. Base unit 509 could house controller 580, which may be responsible for delivering electrical power and managing operational parameters; potentially including power regulation and responsiveness to user and/or sensor input. While the configuration of cartridge 508 may resemble previously described cartridges, it could also embody one or more novel attributes intended to advance performance, reusability, or modularity.

Given that cartridge 508 may be designed for detachment from base unit 509, the establishment of electrical connections 506 with minimal user intervention may be advantageous. Such connections might include pogo pins, leaf spring contacts, blade connectors, or conductive magnets, each of which could be adapted to facilitate communication between controller 580 and heater 540. Alternatively, embodiments may centralize all electrical components within base unit 509, thereby eliminating the interconnection between cartridge 508 and base unit 509.

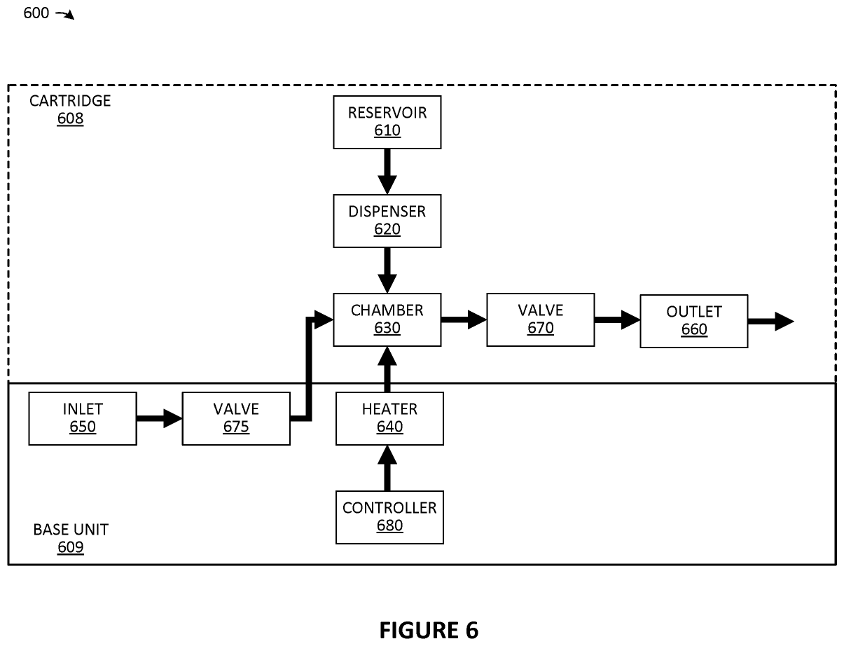

FIG. 6 depicts vaporizing device 600, which may similarly be divided into cartridge 608 and base unit 609. In one arrangement, cartridge 608 may comprise reservoir 610, dispenser 620, chamber 630, outlet 660, and a single valve 670, whereas base unit 609 may include heater 640, inlet 650, valve 675, and controller 680. The shifting of the heating element and inlet components into base unit 609 distinguishes this embodiment from that shown in FIG. 5.

In some embodiments of vaporizing device 600, all electrical elements such as heater 640 and controller 680 may reside within base unit 609, which may obviate the need for electrical contacts between cartridge 608 and base unit 609. Relocation of inlet 650 and valve 675 to base unit 609 may further consolidate critical components, potentially reducing disposable waste and enhancing consistency of operation through repeated use of the base unit subassembly.

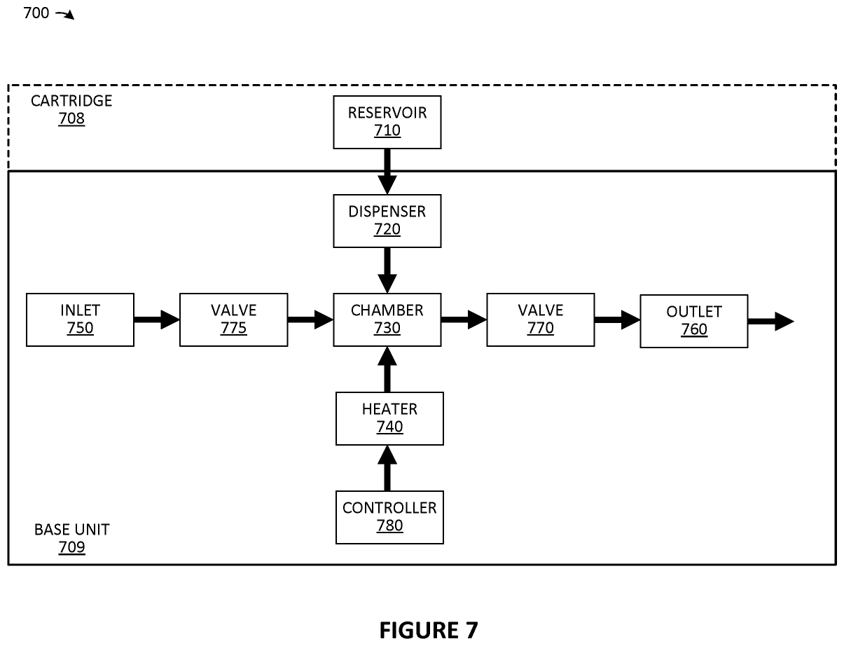

FIG. 7 presents vaporizing device 700, organized into cartridge 708 and base unit 709. Here, cartridge 708 may be limited to reservoir 710 alone, while base unit 709 could accommodate dispenser 720, chamber 730, heater 740, inlet 750, outlet 760, valves 770 and 775, and controller 780.

This embodiment may represent a minimalistic configuration wherein cartridge 708 consists solely of reservoir 710. To reduce leakage risks when the cartridge is separated from the base unit, reservoir 710 may be provided with a one-way valve, self-sealing membrane, or functionally equivalent closure. This arrangement may allow for maximal reuse of device components, as the majority of functional elements are retained within the base unit and not discarded upon depletion of the liquid precursor. In an embodiment the reservoir 710 is user refillable such that no components of the device are disposed of, and the entire system is designed to be reusable. In an embodiment the reservoir 710 is refillable by the user by detaching the reservoir 710 and filling through the provided one-way valve, self-sealing membrane, or functionally equivalent closure. In an embodiment the reservoir 710 is refillable by the incorporation of a dedicated refilling port, in such an embodiment the dedicated refilling port may be configured to accept a generic filling nozzle or a specific filling nozzle that is constructed to only fluidically couple with the filling port on reservoir 710. In an embodiment the reservoir is not refillable by the user directly, but is refillable by the supplier and/or retailer using dedicated filling equipment that is not available directly to the user.

Vaporizing devices may employ modular architecture featuring detachable fluid storage elements and electronically controlled base units. Such systems may be configured to deliver a controlled flow of a liquid precursor to a vaporization chamber to generate vapor or aerosol and monitor operational parameters in real-time. Integration of sensing, power regulation, and user interface mechanisms may facilitate efficient vapor production, safety, and adaptability to particular consumption patterns.

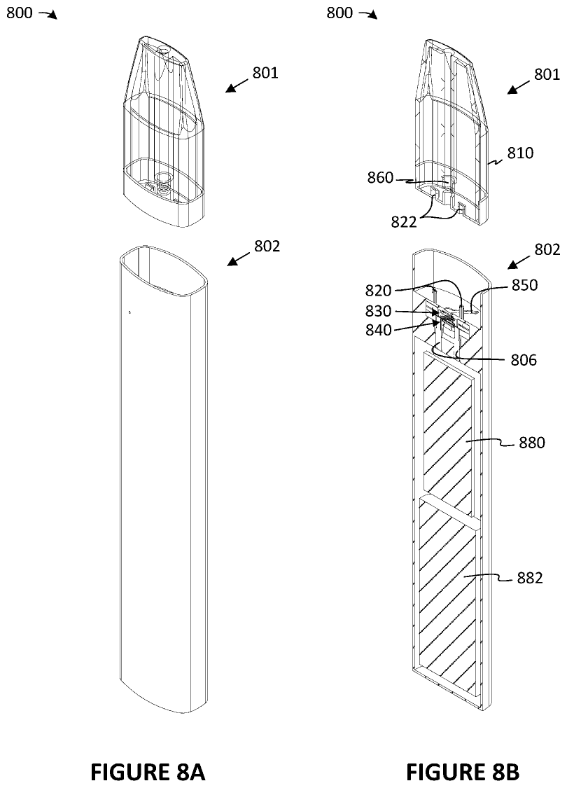

FIG. 8A illustrates a vaporizing device having a detachable cartridge. FIG. 8B illustrates a cross-section of a vaporizing device having a detachable cartridge. For the sake of discussion, vaporizing device 800 may be an example of vaporizing device 700; however, it should be understood, vaporizing device 800 could be an example of any vaporizing device discussed herein. Vaporizing device 800 may comprise cartridge 801 and base unit 802.

Cartridge 801 may, in various embodiments, comprise reservoir 810, valve 822, and outlet 860. Reservoir 810 may be adapted to contain a liquid precursor. Valve 822 may be configured to prevent a liquid precursor from escaping reservoir 810 when cartridge 801 is not attached to base unit 802. Although shown as a duckbill valve in FIG. 8B, it is contemplated that a variety of one-way valve types, including but not limited to a check valve, ball-and-spring valve, or flap valve, may fulfill a comparable function, with valve selection potentially influenced by the viscosity of the precursor or cartridge coupling dynamics.

The use of valves in a disposable embodiment of cartridge 801 may be economically inefficient. Some alternatives may include: capillary or surface tension-based sealing, foil or membrane seals, breakable internal seal or blister, mechanical seal, or burst seals. For example, in one embodiment, valves 822 may comprise a narrow channel or outlet through which the liquid is retained by surface tension until cartridge 801 is connected to base unit 802, whereupon capillary disruption permits flow. In another embodiment, a foil or polymer membrane may be provided over the liquid outlet, the membrane being punctured or pierced by dispenser 820 of base unit 802 upon installation. Alternatively, a frangible internal blister or compartment may contain the liquid and may be ruptured mechanically when cartridge 802 is engaged with base unit 802, thereby releasing the contents into dispenser 820. A mechanical seal, such as a deformable plug, elastomeric gasket, or collapsible nozzle, may also be used to prevent fluid leakage prior to insertion. In yet another embodiment, a burst seal or pressure-sensitive membrane may retain the liquid until sufficient pressure or deformation is applied by components of base unit 802, at which point the seal ruptures and allows fluid communication. In an embodiment, the seal may be thermally mediated flow channel(s), such that the precursor liquid, being a thermoviscous fluid, cannot flow through the channel(s) at ambient temperature due to the viscosity of the precursor liquid at ambient temperature, and only when the dispenser 820 is heated by heater 840, and/or a secondary heater, is the viscosity of the precursor liquid reduced sufficiently to allow for flow through the channels which function as the dispenser 820. These alternative sealing methods may eliminate the need for valves while maintaining adequate containment and operational reliability in disposable cartridges.

Outlet 860 may define at least a portion of tortuous flow geometry adapted for particle size selection and exclusion of an entrained aerosol such that particles of a particle size and mass are the primary component of the entrained aerosol. In an embodiment, particles having a diameter greater than 5 microns and/or a mass greater than 8.24×10⁻¹⁴ kg do not remain entrained in the aerosol and/or vapor and are trapped within the outlet 860 tortuous flow geometry. In this embodiment, outlet 860 may be partially comprised of geometry included in cartridge 801, with the remaining components comprising outlet 860 integrated into base unit 802. It should be appreciated, however, that incorporation of a portion of outlet 860 within cartridge 801 is primarily a stylistic and practical choice that may facilitate assembly, replacement, or manufacturing. In alternative embodiments, the entirety of outlet 860 could be located within base unit 802, or, conversely, outlet 860 might be fully integrated into cartridge 801, depending on design preferences or functional requirements. The present arrangement is intended to illustrate one example and does not preclude other suitable configurations.

Base unit 802 may comprise inlet 850, dispenser 820, chamber assembly 830, heater 840, electrical connections 806, controller 880, and battery 882.

Vaporizers where the inlet airflow passes directly over a metal heater may result in unwanted and potentially harmful compounds and or constituents of the metallic heater being present in the formed aerosol and/or vapor. Inlet 850 does not direct the intake airflow directly over the heater and therefore helps prevent any contamination of the intake airflow with compounds and or constituents of the metallic heater. Inlet 850 may be adapted to direct ambient air from outside base unit 802 to one or more internal locations, which may vary depending on the specific configuration, to entrain vapor generated within chamber assembly 830. Inlet 850 may be in proximity to chamber assembly 850 and heater 840 and may include tortuous flow geometry incorporating regions of expansion, contraction, or directional change, for the purpose of pre-heating the air flow passing through inlet 850 during activation. In an embodiment, heater 840 may be in proximity to inlet 850 but is not in fluid communication with inlet 850 such that the inlet geometry is heated without the air flow in inlet 850 passing directly over the heater.

Dispenser 820 may comprise one or more tubes, channels, protrusions, or alternatively, deformable actuators or capillary structures, configured to engage valve 822 and regulate transfer of a liquid precursor from reservoir 810 to chamber assembly 830 upon coupling of cartridge 801 with base unit 802. In certain configurations, dispenser 820 may exploit fluidic resistance or surface tension of a liquid precursor to control a flow rate. In other configurations, dispenser 820 may exploit a thermoviscous precursor liquid and the resistance of flow through aforementioned structures at ambient temperatures due to the viscosity of the precursor liquid at ambient temperatures. Mechanical coupling of cartridge 801 to base unit 802 may be achieved by magnets, snap-fits, threaded engagements, friction interfaces, or other coupling mechanisms suitable for repeated attachment and detachment cycles.

Outlet 860 may be configured to mix vapor and air to form an aerosol, subsequently conditioning the aerosol, and routing the resultant flow to a user. In this embodiment, outlet 860 may be divided between cartridge 801 and base unit 802. Outlet 860 may include tortuous flow geometry incorporating regions of expansion, contraction, or directional change, for the selective removal of particles by size and/or mass from an aerosol entrained in a stream of air.

Chamber assembly 830 may be configured to vaporize a liquid precursor received from reservoir 810, utilizing heat provided by heater 840. Chamber assembly 830 may comprise various embodiments that will be described herein. Chamber assembly 830 may be configured to transfer heat from heater 840 to a volume of liquid precursor contained by chamber assembly 830.

Heater 840 may be configured as a resistive element, such as nichrome, mesh, or printed thick-film conductor, although other types of heaters may be contemplated including ceramic or inductive heating elements. In an embodiment, heater 840 may be a photochemically machined and or photochemically etched resistive element that is polygonal when viewed cross-sectionally, allowing for increased contact area between the surface of heater 840 and chamber assembly 830. Heater 840 may receive electrical energy from electrical connections 806, which may be specified to accommodate the appropriate current and thermal operating profiles. Heater 840 may include a first region adapted to reach temperatures sufficient to heat chamber assembly 830 and thereby thermally mobilize the precursor liquid into an aerosol and/or vapor. A second region of heater 840 may be configured to establish electrical connection with connector 106. A third region may be positioned to provide heat to dispenser 820 and/or reservoir 810, supporting delivery and pre-heating of the precursor liquid to facilitate vaporization of the precursor liquid and subsequent aerosol formation.

Electrical connections 806 may supply power to heater 840 and, in certain embodiments, may further enable measurement of heater resistance, facilitating indirect estimation of temperature during operation. Electrical connections 806 may be implemented as pogo pins, leaf springs, blade connectors, magnetic contacts, or alternative solutions, selected according to durability and compliance with relevant electrical and mechanical requirements.

Controller 880 may govern activation of heater 840 based on user input, which may be registered via manual actuation (such as push-buttons), acoustic sensors, pressure transducers, capacitive touch, or other user interfaces. Controller 880 may modulate power delivery to heater 840 responsively, possibly to ensure safety, optimize aerosol generation, and/or extend device longevity.

Controller 880 may optionally collect and process operational data, which could include temperature, pressure, flow rate, inhalation patterns, or device usage statistics. Temperature data collected may include both the operating temperature of heater 840 when the device is activated, and/or the pressure within inlet 850 during activation, and/or flow rate of the flow through the inlet 850 during activation. Collected data may also include ambient temperature of the device when inactive, and ambient pressure of the device when inactive. Such information may serve to adaptively tune device parameters to align with a user's preferences and/or characteristic inhalation profile(s) to optimize vapor density and/or aerosol characteristics to optimize formed vapor and/or aerosol for delivery and/or deposition into the deep lung. In additional embodiments, controller 880 may also manage battery 882, facilitating safe recharging, thermal protection, or compatibility with a range of rechargeable chemistries.

Battery 882 may represent any suitable rechargeable or disposable power source, such as but not limited to lithium-ion, nickel-metal hydride (NiMH), nickel-cadmium (NiCd), or lithium polymer cells. Charging of battery 882 may be managed directly by controller 880, or via an external charging circuit integrated into base unit 802.

In operation, cartridge 801 may be coupled to base unit 802 through one or more mechanical or magnetic coupling mechanisms. Upon coupling, dispenser 820 may actuate valve 822 to enable a controlled flow of liquid precursor from reservoir 810 into chamber assembly 830. Activation of heater 840, by suction at outlet 860, manual input, or other means, may prompt controller 880 to meter electrical power from battery 882 to heater 840, thereby vaporizing the precursor. Air, drawn via inlet 850, may be entrained with vapor within chamber assembly 830 to form an aerosol, which is then directed through outlet 860 for user inhalation. In certain embodiments, the resultant airflow path may be dynamically altered by features within the device to select for particle size and/or mass, optimize aerosol quality, minimize condensation, reduce aerosol temperature, or otherwise tailor user experience.

Vaporizing device 800 may have included many of the active components comprising a chamber assembly or vaporizer for a vaporizing device integrated into a base unit but these same components could be adapted for assembly into a cartridge, such as cartridge 801.

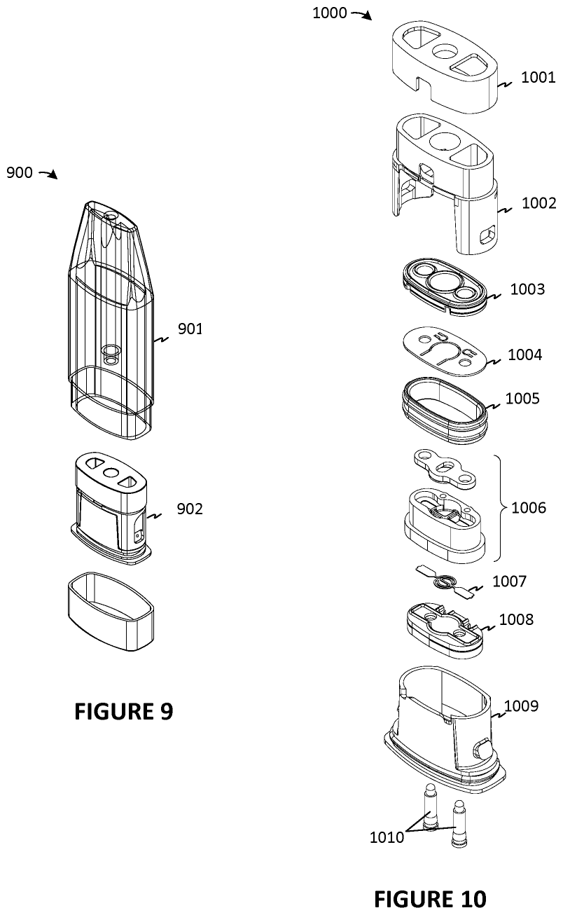

FIG. 9 illustrates a cartridge for a vaporizing device. Cartridge 900 may represent a specific embodiment of cartridge 801, but with the addition of vaporizer 902 disposed therein. Cartridge 900 may generally comprise reservoir 901 adapted to retain a liquid precursor and vaporizer 902 configured to convert at least a portion of the liquid precursor into vapor. Various forms, dimensional characteristics, and interfacial elements may be implemented in order to optimize compatibility with different vaporizing devices or platforms, as will be described in further detail below.

The geometry or external form factor of reservoir 901 may be selected or adapted to address aesthetic requirements, ergonomic considerations for user handling, constraints imposed by manufacturing, or limitations arising from integration with other device components. In some embodiments, the volume, cross-sectional shape, or wall material of reservoir 901 may be adjusted to account for desired precursor capacity, refillability, or transparency, while alternative configurations may prioritize compactness, robustness, or cost-effective fabrication.

Cartridge 900 may incorporate a vaporizer assembly, such as vaporizer 902. While FIG. 9 depicts one possible arrangement of vaporizer 902, it is contemplated that a range of alternative constructions may be utilized, incorporating variations in vaporizer location, mounting method, or functional features. Such alternatives may encompass different heater types (including photochemically etched resistive metal, photochemically machined resistive metal, resistive wire, ceramic, film heaters, quartz or glass enveloped filament heaters with or without noble gas surrounding the filament and with or without the filament being under vacuum, and UV and/or infrared emitter(s) and/or diode(s)), valve mechanisms (such as duckbill, check, or rotary valves), fluid dispensing means (for example, via thermally mediated flow tube(s) and/or channels, spring-loaded, gravity-fed, pressure-driven, or capillary-driven dispensers), and differing inlet or outlet geometries (including tortuous flow geometry for aerosol conditioning and/or particle size and/or particle mass selection), either alone or in combination.

FIG. 10 illustrates an exploded view of a vaporizer. Vaporizer 1000 represents only one embodiment of a vaporizer and it should be appreciated that vaporizer 1000 may take on a variety of different embodiments. FIG. 10 is provided to familiarize the reader with the general construction of a vaporizer assembly, such as vaporizer 1000, which may be adapted for use in either a base unit (e.g., base unit 802) or a cartridge (e.g., cartridge 900), depending upon the specific embodiment. It should be understood that the same vaporizer configuration could be implemented in various device formats, and additional configurations are contemplated.

Vaporizer 1000 may include upper seal 1001, upper chassis 1002, precursor inlet seal 1003, valves 1004, outer seal 1005, chamber assembly 1006, heater 1007, lower seal 1008, lower chassis 1009, and electrical contacts 1010.

Vaporizer 1000 may include one or more seals to prevent a liquid precursor from leaking and to seal air, vapor and aerosol flow paths. This embodiment may include upper seal 1001, precursor inlet seal 1003, airflow inlet and chamber exit seal 1004, outer seal 1005, and lower seal 1008. Other embodiments may include different seals or combinations thereof.

Upper seal 1001 may be configured to form a fluid tight seal between a reservoir (e.g., reservoir 901) and a vaporizer (e.g., vaporizer 902) interface. In some embodiments, upper seal 1001 could help to create a friction-fit assembly to structurally secure reservoir 901 to vaporizer 902 thereby eliminating the need for dedicated fasteners.

In its most basic embodiment, precursor inlet seal 1003 may be configured to direct a flow of liquid precursor between different components comprising vaporizer 1000. Other embodiments of precursor inlet seal 1003 may be additionally configured to direct and isolate air, vapor or aerosol. Valves 1004 have three valve features depicted in FIG. 10: two small flap style valves that valve the intake airflow path, and a larger central flap style valve that controls the exit of aerosol and/or vapor from chamber 1006. The two smaller air intake flap valves of valves 1004 are, in an embodiment, configured to allow the directional flow of intake airflow into the chamber assembly 1006 as a result of the suction generated by the inhalation through vaporizer 1000 by the user; where, for example, valves 1004 have features that are opened during inhalation by the user are in a closed or sealed state when the device is inactive. Additionally valves 1004 are resistant to flow or pressure in the opposite direction of the direction of flow generated by the user inhalation, such that if pressure and/or flow is applied in the opposing direction the valve 1004 is closed more tightly because of the pressure and or flow serving to further seat the air intake valves 1004 against the sealing surface of chamber 1006 that the air intake valves of valves 1004 rest against. The central larger flap style valve depicted in FIG. 10 of valves 1004 serves to seal the region of chamber assembly 1006 where aerosol and/or vapor generation occurs via heating of the precursor liquid and is in a closed position when the vaporizer 1000 is in the inactive state. In the active state of vaporizer 1000 the generation of aerosol and or vapor causes the pressure to increase inside the region of chamber assembly 1006 where aerosol and/or vapor production occurs. The increase in pressure causes the central chamber flap valve of valves 1004 to displace to an open position allowing for the generated vapor and/or aerosol to escape the chamber assembly 1006 for delivery to the user. In an embodiment, valves 1004 may be constructed of a silicone material where the compliance and/or thickness of the material that the valve part is comprised of allows for the valves 1004 to be in the closed position when the vaporizer 1000 is not in use. The compliance of the silicone material may be used to construct valves 1004 such that: (1) valves 1004 are sufficiently stiff due to the thickness of the silicone material and/or durometer of the silicone material that valves 1004 are only opened when the user is generating sufficient suction through the device 1000 by inhaling, (2) and valves 1004 valve the air intake path, such that sufficient pressure inside of chamber assembly 1006 is required from the generation of aerosol and/or vapor from the precursor liquid to displace and render open the flap valve that seals the chamber 1006.

Outer seal 1005 may be configured to form a fluid tight seal between chamber assembly 1006, upper chassis 1002, and lower chassis 1009. Lower seal 1008 may be configured to form a fluid tight seal between chamber assembly 1006 and lower chassis 1009. Lower seal 1008 may include clearance for the passage of electrical contacts 1010 or valve steams. Lower seal 1008 could also include features to direct incoming air. In some embodiments, lower seal 1008 may provide structural support for heater 1007. In an embodiment, outer seal 1005, lower seal 1008, valves 1004, and precursor inlet seal 1003 may function to completely isolate the intake airflow, the precursor liquid, and the generated aerosol and/or vapor from being in direct contact with the heater 1007.

These seals may be exposed to liquid precursor, air, vapor, or aerosol, and may be fabricated from materials exhibiting a combination of chemical resistance, thermal stability, mechanical flexibility, and compatibility with health and safety standards. Materials that are non-reactive with the contained fluids, capable of maintaining their sealing properties over a range of operating temperatures, and compliant with relevant regulatory requirements may be particularly suitable. For example, silicone may be employed due to its chemical inertness, thermal stability, and compliance with safety guidelines. Alternative materials may include fluoroelastomers, thermoplastic elastomers (TPE), or food-grade rubbers, each offering varying balances of durability, manufacturability, and resistance to fluid absorption. The selection of sealing materials may be further guided by considerations such as fabrication method, expected device lifespan, and compatibility with adjacent components.

Upper chassis 1002 and lower chassis 1009 may collectively function as a frame or structural support for the various components comprising vaporizer 1000. In addition to providing mechanical integrity, upper chassis 1002 and lower chassis 1009 may further include features or internal pathways adapted to direct streams of air, vapor, or aerosol for the purpose of conditioning, in a manner analogous to that described for various inlet and outlet configurations disclosed herein or subsequently described. In certain embodiments, the internal geometries of upper chassis 1002 and/or lower chassis 1009 may be designed to introduce tortuous flow geometry, impingement surfaces, impaction surfaces, vortices, or eddy currents to promote particle deposition or droplet removal, thereby tailoring the physical properties of the delivered aerosol, such properties may include optimization of the particle size and/or particle mass for inhalation into the deep lung and/or deposition of the particles in the deep lung, and reduction of aerosol and/or vapor temperature to facilitate inhalation without irritation due to aerosol and/or vapor temperature. In an embodiment, particles having a diameter greater than 5 microns and or a mass greater than 8.24×10⁻¹⁴ kg do not remain entrained in the aerosol and/or vapor and are trapped within the upper chassis 1002 and or lower chassis 1009 flow geometry. In an embodiment, flow through upper chassis 1002 and/or lower chassis 1009 flow geometry and the flow channel present in reservoir 901 may result in a vapor and/or aerosol temperature that is close to the physiological temperature of the human airway.

Moreover, upper chassis 1002 may include all or a portion of a dispenser structure, such as those described in prior and/or subsequent embodiments, or may alternatively be configured to accommodate equivalent or functionally similar dispensing mechanisms. Such dispenser features may include, by way of example, spring-loaded valves, capillary channels, thermally mediated flow channels, deformable membranes, or other structures capable of regulating the transfer of a liquid and/or vapor precursor. The specific selection and integration of these features may be guided by considerations including, but not limited to, ease of assembly, compatibility with the intended fluids and/or precursors, replacement intervals, and applicable regulatory requirements.

The overall geometry of upper chassis 1002 and lower chassis 1009 may be tailored to suit specific embodiments and stylistic choices. Some embodiments may be configured to be assembled within a reservoir, while others may be configured to be assembled into a base unit.

Upper chassis 1002 and lower chassis 1009 may be manufactured from a variety of materials, depending on the specific embodiment. Materials that are non-reactive with liquid precursors, thermally stable, resistant to liquid absorption, capable of withstanding operating environments of the device, and compliant with relevant health and safety standards may be desirable. Material selection may be guided by desired mechanical properties, compatibility with the liquid precursor, regulatory requirements, and cost considerations. In certain embodiments, copolyesters such as Tritan® may be well-suited for manufacturing upper chassis 1002 and lower chassis 1009. Alternatively, materials such as polycarbonate, polycyclohexylene dimethylene terephthalate glycol modified (PCTG), polyethylene terephthalate glycol-modified (PETG), polymethyl methacrylate (PMMA), polypropylene (PP), or polysulfone (PSU) may also be suitable, depending upon the embodiment and manufacturing process.

Valves 1004 may be used to prevent fluids from leaking from vaporizer 1000 when not in use, though vaporizer 1000 could function without them. Different types of valves may be used. Flap valves may be desirable due to their thin profile and simple construction but other but other types of valves may be used. For example, poppet valves could be used to provide the ability to remotely actuate them. Material selection may be dependent upon the type of valve chosen.

Chamber assembly 1006 may be configured to generate a vapor or aerosol from a liquid precursor. Chamber assembly 1006 may include one or more intake ports configured to receive a liquid precursor, as well as one or more outlet ports to deliver the resulting vapor and/or aerosol. In some embodiments, these ports may be configured to direct a flow of air, vapor and/or aerosol. For example, an intake port could direct air into chamber assembly 1006 to promote a vortical flow that may allow for more efficient vaporization and controlled aerosol generation. Chamber assembly 1006 may further be configured to interface with heater 1007, such that heat is applied to the liquid precursor contained within the chamber, facilitating its conversion to a vapor phase. The geometric arrangement and positioning of intake and outlet ports may be selected to optimize fluid dynamics, maximize heat transfer efficiency, and support consistent aerosol formation. In an embodiment, chamber assembly 1006 may be constructed such that the heater is isolated from the precursor liquid and the flow of air, vapor, or aerosol, such that the heater transfers heat to the precursor liquid without having direct contact with the precursor liquid, and such that the heater transfers heat to the intake air without having direct contact with the intake air.

Chamber assembly 1006 may be manufactured from materials that are non-reactive and thermally stable at the expected vaporization temperatures, ensuring compatibility with the liquid precursor and maintaining structural integrity throughout repeated heating cycles. Material selection may be guided by several considerations, including manufacturing techniques, cost constraints, compatibility with the type of heater employed, and regulatory or safety requirements. For example, some embodiments may utilize fused silica, which is valued for its chemical inertness, strength, and thermal stability. Other embodiments may employ Macor®, a machinable ceramic, chosen for its durability, resistance to high temperatures, and ease of fabrication using machining processes. Additional suitable materials could include borosilicate glass, quartz glass, high-performance ceramics, or metallic alloys, depending on desired thermal conductivity, mechanical robustness, and manufacturability. The specific choice of material may also be influenced by the need to prevent contamination of the vapor or aerosol and to comply with applicable health and safety standards. In an embodiment, chamber assembly 1006 may be constructed of fused silica as described herein.

Heater 1007 may be configured to supply heat to chamber assembly 1006 to convert a liquid precursor to a vapor. In some embodiments, heater 1007 may comprise a resistive element; however, alternative types of heaters, such as infrared emitters, UV emitters, combination UV and IR emitters, ceramic elements, lasers, or inductive heaters, may also be utilized, depending on the specific requirements of the device. One advantage of using a resistive heater is that materials that are commonly used in their construction, such as nichrome or Kanthal®, an iron-chromium-aluminum alloy, may have a known temperature coefficient. This may allow the temperature of heater 1007 to be estimated by measuring changes in electrical resistance of the heater 1007. Selection of heater type and material may be guided by considerations such as thermal response time, durability, and energy efficiency. In an embodiment, heater 1007 may not be directly in contact with the precursor liquid, aerosol, vapor, and/or intake air. Heater 1007 may be separated from the precursor, aerosol, vapor, and/or intake air by an inert material such as glass. In an embodiment, heater 1007 may be constructed from the photochemical etching and or photochemical machining of nichrome sheet(s).

Electrical contacts 1010 may be used to supply electrical energy to heater 1007. In addition, depending upon the type of heater that is used, electrical contacts 1010 may be configured to measure electrical resistance of heater 1007 to estimate the temperature. Electrical contacts 1010 may be used to heat sink the non-resistive region(s) of heater 1007.

Vaporizer 1000, as illustrated in FIG. 10, represents a single embodiment of a vaporizer device. It should be understood that numerous alternative configurations may be employed, utilizing various combinations of seals, chassis, heaters, valves, and chambers. The elements illustrated and described herein may be arranged, omitted, or substituted in different ways to achieve desired performance, manufacturing, or user requirements. Additional embodiments, including modifications to the geometry, materials, or integration of individual components, may likewise be contemplated within the scope of the present disclosure.

It may be desirable to supply a controlled and uniform flow of a liquid precursor to a vaporization chamber in order to promote efficient and consistent vapor generation. Some embodiments may seek to deliver a liquid precursor to a vaporization chamber at a rate of approximately 2 mg/second and/or 2 μL/second in order to sustain the vaporization of 2 mg/second and/or 2 μL/second of precursor. A variety of methods may be employed to regulate the flow characteristics of the precursor liquid, with the choice of method potentially influenced by the physical properties of the liquid, desired device performance, and operational constraints. In some embodiments, flow regulation may be accomplished by exploiting the effect of fluid viscosity on movement through a channel of relatively small diameter, wherein the combination of channel length and diameter may be selected to yield a predictable flow rate. In some embodiments, flow regulation may be accomplished by exploiting the effect of fluid viscosity on movement through a channel of relatively small diameter, wherein the combination of channel length and diameter may be selected to yield a predictable flow rate under applied pressure, such as the pressure generated from the expansion of the air present in the reservoir when reservoir is heated above ambient either indirectly by heater 1007 or by a secondary heater. In some embodiments, the precursor may be a thermoviscous solid or semi-solid at ambient temperature and require the application of heat to become a liquid. In an embodiment, the inlet channels conveying the precursor from the reservoir to the chamber may be heated by the proximity of the inlet channels to heater 1007 to allow for the flow of a thermoviscous precursor when the device is activated. In an embodiment a secondary heater may be used to heat the inlet channels. In an embodiment a secondary heater serves to heat both the inlet channels and/or the reservoir.

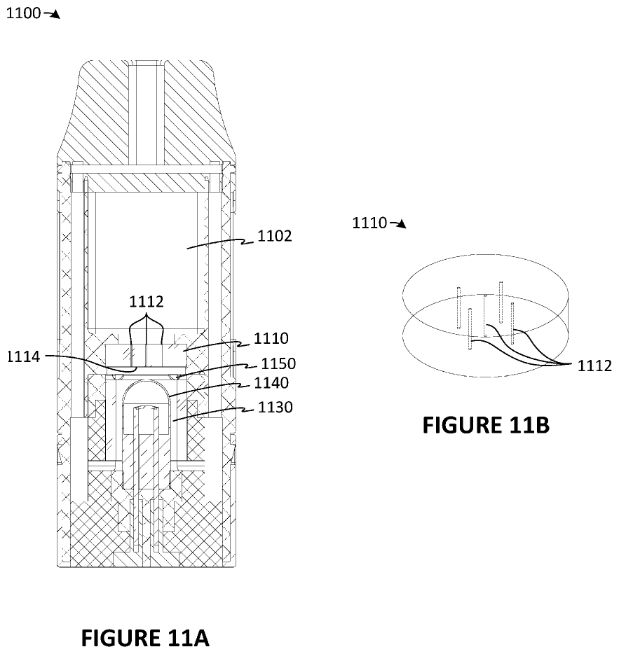

FIG. 11A illustrates a cross-section of a vaporizer including a dispenser for a vaporizing device. FIG. 11B illustrates an isometric view of a dispenser disk. In this embodiment, vaporizing device 1100 may include dispenser disk 1110 positioned between reservoir 1102 and chamber 1130 to regulate a flow of a liquid precursor from reservoir 1102 to chamber 1130 for vaporization. In some embodiments, dispenser disk 1110 may be configured to work with a heater, such as heater 1140, to operate as a thermally mediated valve.

Dispenser disk 1110 may comprise a body including one or more orifices 1112 configured to regulate a flow of a liquid precursor. While dispenser disk 1110 may be illustrated as a cylindrical body in FIG. 11B, its overall shape may be chosen to suit particular embodiments of vaporizing device 1100.

Orifices 1112 may be one or more small-diameter tubes passing through dispenser disk 1110. In some embodiments, orifices 11112 may be configured to take advantage of capillary action by interacting with the surface tension and wetting angle properties of a liquid precursor and the materials (e.g., borosilicate glass, fused quartz, etc.) from which capillary tubes 1112 are made. Capillary action is the process of a liquid flowing in a narrow space without the assistance of external forces like gravity. Capillary tubes are often thought of as tubes that cause liquids to act against gravity, drawing a liquid upward and creating a force balance. However, as illustrated in FIG. 11A, dispenser disk 1110 is disposed below reservoir 1102 and orifices 1112 may be configured to permit a downward flow of a liquid precursor while still resisting gravity. Capillary action may be sustained within the internal surfaces of orifices 1112, such that the cohesive and adhesive forces responsible for liquid transport are confined to the structure of the orifice itself. Upon reaching bottom 1114 of orifices 1112, the capillary effect may cease altogether, thereby restricting further precursor movement beyond this boundary.

The volumetric flow rate of a liquid precursor through a single orifice 1112 may be mathematically modeled using the Hagen-Poiseuille equation:

$$Q = \frac{π {r}^{4} Δ P}{8 μ L}$$

where Q is the volumetric flow rate, r is the radius of the orifice, L is the length of the orifice, ΔP is the pressure drop across that length, and μ is the dynamic viscosity of the liquid precursor. This equation applies to both capillary and non-capillary flow of a liquid precursor through an orifice, for laminar flow of Newtonian fluids.

The Hagen-Poiseuille equation shows that the dynamic viscosity of a liquid precursor affects the volumetric flow rate of the liquid through an orifice. Propylene glycol, vegetable glycerin, or combinations thereof are commonly used as precursors for vaporizers and have known temperature dependent viscosities. Therefore, for a given radius and length of an orifice, the volumetric flow rate of a liquid precursor through it may be changed by changing the temperature of the liquid precursor.

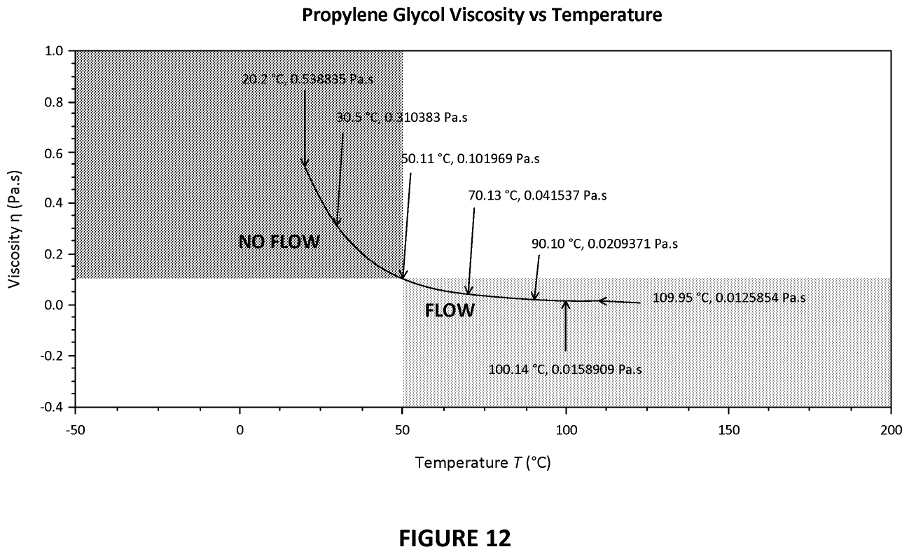

FIG. 12 presents a graph showing how the viscosity of a propylene glycol sample may change depending upon temperature. This may be used to design orifices 1112 to permit a liquid precursor to flow when its viscosity is below a certain threshold. For example, orifices 1112 may be constructed having radii that blocks the flow of a liquid precursor when its viscosity is greater than 0.101969 Pa·s, which correlates to temperatures above about 50.11° C. Changing the temperature of a liquid precursor may change its flowrate through orifices 1112.

It may be desirable to control the flow speed of a liquid precursor in addition to the volumetric flow rate. The following equation may be used calculate a flow speed of a liquid precursor through one or more orifices 1112:

$${v}_{a v g} = \frac{Q}{N A}$$

where v_{avg} is the flow speed, h Q is the volumetric flow rate, N is the number of orifices, and A is the cross-sectional area of each orifice.

A thermally mediated valve may be constructed by selecting one or more orifices having an appropriate length and radius at a given pressure differential and controlling the viscosity of a liquid precursor by adjusting its temperature. Such a valve may be constructed such that a liquid precursor is blocked from passage through orifices 1112 until heat is added to the system to decrease the viscosity of the liquid precursor. The liquid precursor may flow when heat is applied and then cease to flow a short time after heat is removed.

Looking back to FIG. 11A, we can imagine a volume of liquid precursor contained in reservoir 1102. Dispenser disk 1112 may have one or more orifices 1112 configured to block the flow of the liquid precursor until a predetermined temperature has been reached. In operation, heater 1140 may be activated transferring heat to dispenser disk 1112 and a liquid precursor contained within reservoir 1102. When the application of heat has sufficiently changed the viscosity of a liquid precursor it may begin to flow through orifices 1112 into chamber 1130. Liquid precursor may drip from bottom 1114 of dispenser disk 1110 onto heater 1140 to be vaporized. At some viscosities, a volume of liquid precursor may form a droplet clinging to the bottom 1114 of dispenser disk 1110. Inlets 1150 may be positioned in proximity to bottom 1114 of dispenser disk 1110 to deliver air flow near bottom 1114 to help dislodge a formed droplet. In an embodiment the inlets 1150 direct a high velocity flow across the dispenser disc that generates a region of high pressure that functions to entrain the liquid and/or droplets from the surface of the dispenser disc in a stream of air that passes over and/or impacts with the heater 1140.

The previous embodiment illustrated a dispenser for a vaporizing device comprised of an independent component. However, a dispenser may comprise multiple components or may be integrated into other elements comprising a vaporizing device.

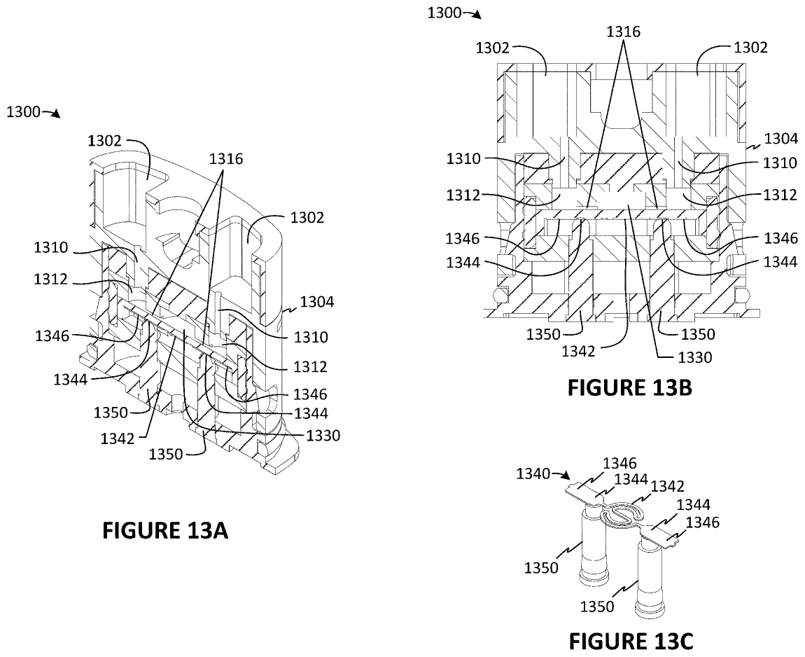

FIGS. 13A and 13B illustrate cross sections of a vaporizing device including a dispenser. Dispenser 1300 may comprise upper channels 1310, secondary reservoirs 1312, lower channels 1316, and heater 1340 and be configured to regulate the delivery of a liquid precursor from reservoir 1302 to chamber 1330. While certain embodiments may include a plurality of elements such as multiple upper channels 1310, secondary reservoirs 1312, and lower channels 1316, dispenser 1300 may alternatively be constructed with only a single upper channel 1310, secondary reservoir 1312, or lower channel 1316. Dispenser 1300 may be connected to a larger reservoir such as reservoir 901 as described previously for vaporizer 902 and illustrated in FIG. 9, and may incorporate an upper seal such as upper seal 1001 to create a liquid tight seal between dispenser 1300 and a reservoir such as reservoir 901.

In this embodiment, upper channels 1310 may be integral to upper chassis 1304 and disposed between reservoir 1302 and secondary reservoirs 1312. Upper channels 1310 may or may not be configured to take advantage of capillary action depending upon the particular embodiment. In any event, upper channels 1310 may each include an inner diameter and a length configured to regulate a flow of a liquid precursor. In an embodiment, upper channels 1310 may each include an inner diameter and length configured to block a flow of a liquid precursor while the device is idle and to permit a flow of liquid precursor after heater 1340 is activated, while alternative embodiments may configure upper channels 1310 to supply a regulated flow without additional heat input. Upper channels 1310 may supply a liquid precursor from reservoir 1302 to secondary reservoirs 1312.

In an embodiment, upper channels 1310 may be configured to be thermally conductive to facilitate the flow of a thermoviscous precursor during device activation. In an embodiment, upper channels 1310 may be thermally non-conductive. In an embodiment the secondary reservoirs 1312 are heated by the proximity to the heater 1340 to such a degree as the viscosity of a thermoviscous precursor liquid is lowered sufficiently to facilitate flow through the lower channels 1316. In an embodiment, the lower channels 1316 function as a thermally mediated valve, such that when the device is inactive the area of the channels 1316 is too small and functions to prevent the flow of a thermoviscous precursor liquid, and when the device is activated the lower channels 1316 are heated by their proximity to the heater 1340 such that the viscosity of a thermoviscous precursor liquid is reduced sufficiently to allow for a flow through the lower channels 1316. In an embodiment, the flow through lower channels 1316 when the device is active is a metered flow of 2 uL and/or 2 mg per second. In an embodiment, the flow of precursor liquid through the lower channels 1316 is mediated at least in part by the proximity of the lower channels 1316 to the air inlets such that the flow rate and velocity of the intake airflow in the chamber 1330 entrains at least partially the flow of liquid precursor from lower channels 1316 such that a higher intake airflow results in a higher flow rate of precursor liquid into chamber 1330.

Secondary reservoirs 1312 may be positioned between upper channels 1310 and lower channels 1316 and be configured to contain a volume of a liquid precursor. Secondary reservoirs 1312 may supply liquid precursor to chamber 1330 via lower channels 1316. In some embodiments, secondary reservoirs 1312 may be configured to function as a hydrostatic plug to prevent a continuous flow of a liquid precursor from reservoir 1302 to chamber 1330. When secondary reservoirs 1312 are filled, they may prevent a continuous flow of precursor into chamber 1330 until a volume within chamber 1330 is reduced through vaporization.

In operation, upper channels 1310, secondary reservoirs 1312, lower channels 1316, and chamber 1330 may contain a precursor having a relatively high viscosity at ambient temperatures. This high viscosity may assist in establishing a hydrostatic barrier that prevents unintended overflow of precursor into the chamber. Upon activation of heater 1340, a portion of precursor within chamber 1330 may be vaporized, thereby reducing the total volume of precursor present and lowering the viscosity of precursor retained in lower channels 1316 and secondary reservoirs 1312. This reduction in viscosity and volume may facilitate the controlled flow of precursor into chamber 1330. In addition, chamber 1330 may be placed under a vacuum pressure during activation that functions in conjunction with the displacement of precursor liquid volume due to vaporization and/or aerosol formation that serves to facilitate the flow of precursor liquid from reservoirs 1302 to upper channels 1310 to the secondary reservoirs 1312 and lower channels 1316. In an embodiment the vacuum pressure exerted on the chamber during activation by the inhalation of the user is 300-600 pascals.

In an embodiment, secondary reservoirs 1312 may include sufficient volume to support several activation cycles, or inhalations, or “puffs” worth of liquid precursor. Secondary reservoirs 1312 may help vaporizers achieve orientation independence by ensuring that a reserve of liquid precursor remains available for delivery to chamber 1330 regardless of the device's spatial orientation. For instance, the device may be carried or stored upside down and still be ready for use.

FIG. 13C is an isometric view of heater assembly for a vaporizing device. Heater 1340 may be in communication with electrical contacts 1350. Electrical contacts 1350 may serve as a visual reference to divide heater 1340 into different regions. Resistive region 1342 may be located in the center of heater 1340 in this embodiment and be configured to convert electrical current into heat to vaporize a liquid precursor contained within chamber 1330. Heat may transfer via conduction from resistive region 1342 through contact regions 1344 to residual regions 1346 at either end of heater 1340. Contact regions 1344 may be coupled to electrical contacts 1350 so that they may supply electrical energy to be converted to heat by resistive region 1342. Electrical contacts 1350 may be constructed of a thermally conductive material and act as heat sinks for heater 1340 and some thermal energy generated by resistive region 1342 may be absorbed and drawn away from heater 1340 by electrical contacts 1350 which may function to decrease the amount of time it takes for the resistive region 1342 to cool down after activation. Electrical contacts 1350 may couple to a printed circuit board, wiring, or some form of electronic controller, thereby increasing the effective thermal mass that may enable additional heat transfer to the associated components. The use of electrical contacts 1350 as heat sinks may be particularly advantageous in cartridge or cartomizer style embodiments, where on-board thermal mass may be relatively limited and may be supplemented when the cartridge is mated with a base unit. Remaining thermal energy may transfer past conductive regions 1344 to residual regions 1346.

Heater 1340 may be located such that resistive region 1342 is in close proximity to chamber 1330 to supply heat for vaporization, conductive regions 1344 are in close proximity to lower channels 1316, and residual regions 1346 are in close proximity to secondary reservoirs 1312. In operation, the viscosity of a liquid contained by secondary reservoirs 1312 may be adjusted by the application of heat from residual regions 1346. The liquid precursor may be brought closer to its vaporization temperature in preparation for vaporization as the liquid passes through lower channels 1316. Finally, vaporization of the precursor within chamber 1330 may mobilize mass out of the system and allow more precursor liquid to flow into chamber 1330.

The ability to heat various components comprising dispenser 1300, such as upper channels 1310, secondary reservoirs 1312, and lower channels 1316, may be particularly advantageous for use with precursors containing cannabinoids. Cannabinoid precursors may have relatively high viscosities, sometimes appearing solid at room temperatures.

The previous embodiment described a dispenser system for a vaporizing device including secondary reservoirs and channels to regulate a flow of liquid precursor into a vaporization chamber. The precursor held by the secondary reservoirs may facilitate continuous delivery to the chamber regardless of the orientation of the device. Some embodiments may include secondary reservoirs and channels having alternative geometries.

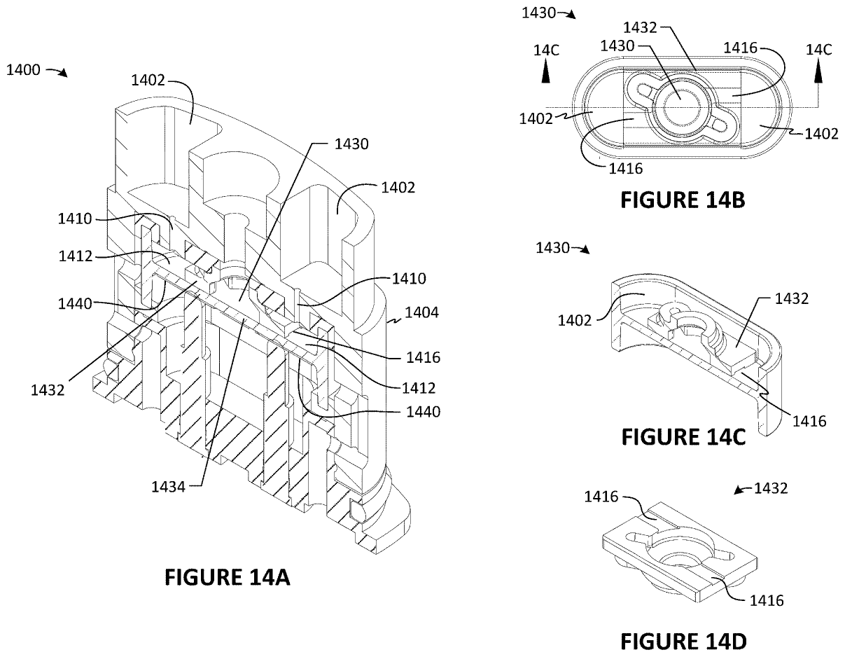

FIG. 14A illustrates a cross section of a dispenser for a vaporizing device. FIG. 14B is a top view of a dispenser for a vaporizing device. FIG. 14C is a cross section of a chamber assembly and FIG. 14D is a bottom isometric view of an upper chamber including portions of a dispenser for a vaporizing device. Dispenser 1400 may be connected to a larger reservoir such as reservoir 901 as described previously for vaporizer 902 and illustrated in FIG. 9, and may incorporate an upper seal such as upper seal 1001 to create a liquid tight seal between dispenser 1400 and a reservoir such as reservoir 901.

Upper chassis 1404 may be configured similarly to upper chassis 1304 and may include the integration of upper channels 1410; however, alternative features or operational methods may also be incorporated. Depending on the embodiment, upper channels 1410 may or may not utilize capillary action. Upper channels 1410 may be positioned between reservoir 1402 and secondary reservoir 1412 and configured to regulate a flow of liquid precursor.

Secondary reservoir 1412 may comprise a volume at least partially surrounding chamber 1430. Secondary reservoir 1412 may have a greater volume than the previously described secondary reservoirs. This increased volume may provide added thermal mass, which could allow for more precise control over heating and reduce the likelihood of the precursor overheating. Overheating a precursor composition may reduce the viscosity beyond optimal levels, leading to accelerated flow into chamber 1430. Ideally, viscosity is temporarily reduced during heater 1440 activation and rapidly returned to ambient levels, with the thermal mass of secondary reservoir 1412 assisting the transition. The larger reservoir volume may allow for multiple activation cycles, inhalations, or “puffs”, to be supplied from reserve volume present in secondary reservoir 1412.

Secondary reservoir 1412 may surround chamber 1430. In addition to being an efficient means for storing a volume of fluid, configuring secondary reservoir 1412 to surround chamber 1430 may enhance the orientation independence of a vaporizing device. Such a configuration may maintain consistent precursor supply to chamber 1430 across a broad range of device orientations, which may be advantageous as users frequently operate vaporizers at non-vertical angles.

Dispenser 1400 may incorporate multiple lower channels 1416 to supply precursor to chamber 1430. In this embodiment, lower channels 1416 may be integrated into chamber top 1432 and offset from one another. By distributing these channels at different positions, the device may facilitate the supply of liquid precursor to chamber 1430 irrespective of the vaporizer's orientation. For instance, when the device is rotated or tilted, at least one of the offset lower channels 1416 is likely to remain in contact with the liquid precursor within secondary reservoir 1412, thereby sustaining precursor delivery to chamber 1430. Additionally, the relatively short height of lower channels 1416 may help limit the total volume of precursor within the channels, thus enabling rapid viscosity changes and further controlling the flow of precursor into chamber 1430. In an embodiment, the chamber 1430 and the chamber top 1432 are constructed from fused silica.

Surrounding a vaporization chamber with a liquid precursor may be one method to help achieve orientation independence of a vaporizing device; however, there are other configurations that may help to achieve orientation independence. For example, precursor supply channels and secondary reservoirs may be reoriented to help maintain orientation independence.

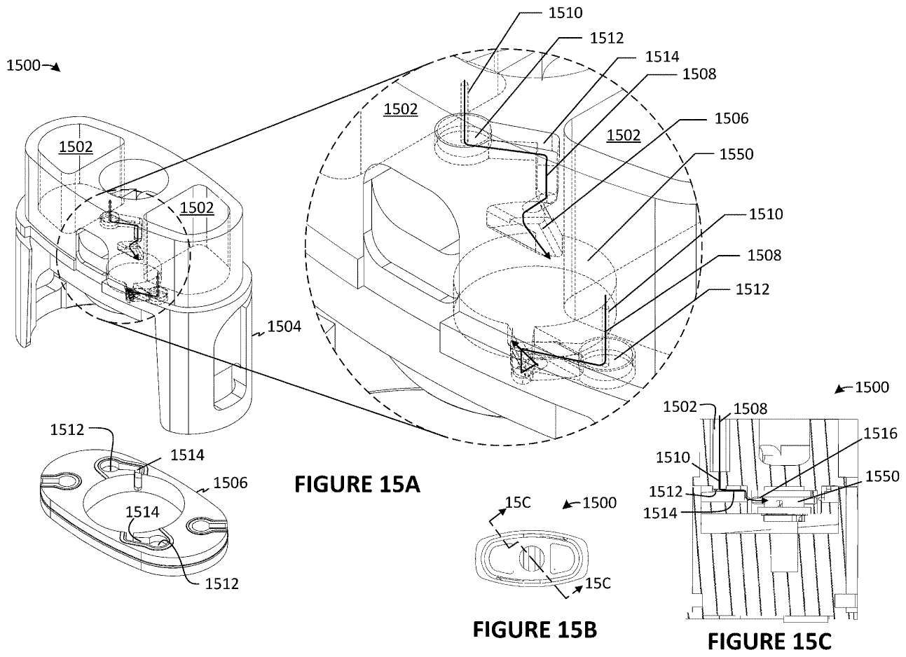

FIGS. 15A though 15C illustrate a dispenser for a vaporizing device. FIG. 15A provides a detailed isometric view of dispenser 1500. FIG. 15B presents a top view of dispenser 1500. FIG. 15C shows a cross-section of dispenser 1500. Dispenser 1500 may be configured to regulate a flow of precursor 1508 from reservoir 1502 to chamber 1550. Dispenser 1500 may be integrated into, or comprised of, other parts or subassemblies of a vaporizing device. In this example, portions of dispenser 1500 are integrated into upper chassis 1504, precursor inlet seal 1506, and chamber 1550. Additional examples of embodiments containing dispenser 1500 can be used in the embodiments described herein.

Dispenser 1500 may comprise one or more orifices 1510 configured to transfer precursor 1508 from reservoir 1502 to chamber 1550. The internal diameter of orifices 1510 may be sufficiently small to regulate liquid flow, though the precise number, size, and arrangement of orifices 1510 could be governed by the desired delivery rate.

Dispenser 1500 may or may not utilize capillary action to regulate a flow of precursor 1508 from reservoir 1502. Capillary action is often thought of as the ability of a liquid to flow through narrow spaces, like thin tubes or porous materials, without the assistance of external forces (like gravity) due to the interplay of cohesion, adhesion, and surface tension, but these same principles can also act as resistance forces in certain configurations, effectively slowing the flow of a fluid. In very narrow tubes, the surfaced-to-volume ratio may be high, and cohesive forces may dominate. This means that the viscous drag from the tube walls becomes significant and the fluid must “pull itself” through, which takes energy. The net effect is that fluids may have a slower flow rate through narrower tubes than in wider tubes, even under the same pressure.

In some embodiments, dispenser 1500 may not rely on capillary action. When the radius of orifices 1510 becomes large enough capillary effects (i.e., surface tension and adhesion) become negligible and gravitational or pressure forces dominate. Pressures higher than atmospheric levels may exist within reservoir 1502. This pressure, acting in conjunction with gravity, may draw precursor 1508 through orifices 1510. Precursor 1508 may stop advancing when it reaches the end of orifices 1510 in embodiments configured to take advantage of the capillary effect but when the radius becomes large enough and the capillary effect gives way to pressure and gravity, precursor 1508 may continuously flow from orifices 1510. In some embodiments, the pressure inside reservoir 1502 may be intentionally increased by heating reservoir 1502, where the air present in reservoir 1502 expands in response to the increase in temperature, and the pressure exerted on the liquid precursor present in the reservoir 1502 causes the flow of the precursor 1508 through orifices 1510. The volume of precursor 1508 contained in the volumetric space defined by the secondary reservoir 1512, upper channel 1514, and lower channel 1516 allows for a reserve of precursor 1508 to be available to transfer to the chamber 1550 that is resistant to orientation of the device during activation, for example the precursor 1508 is effectively contained in this region(s) due to the tortuous nature of the structure it will not readily flow back to reservoir 1502.

In some embodiments, secondary reservoir 1512 may be configured to act as a hydrostatic plug to prevent a continuous flow of precursor 1508 from reservoir 1502. When secondary reservoirs 1512 are filled with precursor 1508, it may prevent the continuous flow of the precursor until a volume contained by secondary reservoirs 1512 is reduced through vaporization within chamber 1550. Some examples of vaporizing devices presented herein may utilize residual heat from a heater to reduce the viscosity of precursor 1508 contained by secondary reservoirs 1512 to enhance flow.

Liquid precursor 1508, upon exiting orifices 1510, may collect within secondary reservoirs 1512 before passing sequentially through upper channels 1514 and lower channels 1516, which may direct, meter, or precondition the fluid, for example by preheating the fluid, as it advances into chamber 1550 for vaporization. The integration of precursor inlet seal 1506 may further serve to inhibit leakage or cross-contamination and/or fluidic communication between adjacent regions.

Dispenser 1500 thus provides flexibility in fluid delivery, allowing for both capillary-driven and non-capillary-driven embodiments. This may ensure compatibility with various liquid precursors, precursors that may be solid or semi-solid at ambient temperatures, and operational requirements, while enabling further optimization of device reliability, efficiency, and user experience.

It may be desirable for some examples of detachable cartridges to include one or more valves to prevent a liquid precursor from leaking from a reservoir when it is not coupled to a base unit.

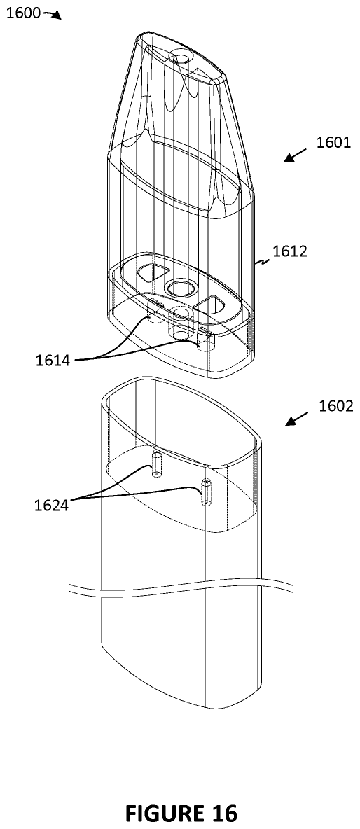

FIG. 16 illustrates a vaporizing device including a valve mechanism for a detachable cartridge. Vaporizing device 1600 may comprise cartridge 1601 and base unit 1602. Cartridge 1601 may include one or more valves 1614 configured to prevent a liquid precursor from escaping reservoir 1612 when cartridge 1601 is not coupled to base unit 1602. In FIG. 16, valves 1614 may comprise duck bill valves; however, many different types of valves or seals may be employed to prevent a liquid precursor from escaping reservoir 1612 when it is not coupled to base unit 1602.

Base unit 1602 may include one or more valve actuators 1624 to actuate valves 1614 when cartridge 1601 is coupled to base unit 1602. In this example, valve actuators 1624 may comprise one or more tubes configured to open and mate with one or more valves 1614. Valve actuators 1624 may each include an inner diameter configured to take advantage of capillary action or the viscosity of a liquid precursor to control the flow rate from reservoir 1612 to base unit 1602. Valve actuators 1624 may be heated either directly or indirectly to facilitate the flow of a thermoviscous precursor.

Vaporizing devices may utilize a variety of chamber designs to convert a liquid precursor into a vapor or aerosol. Chamber assemblies may be configured to receive a liquid precursor and convert the liquid precursor to a vapor using heat. Vapor may be mixed with air to form an aerosol prior to delivery to a user. Vapor may be mixed with air either inside or outside of a chamber assembly to generate an aerosol. A variety of chamber assemblies will be discussed herein.

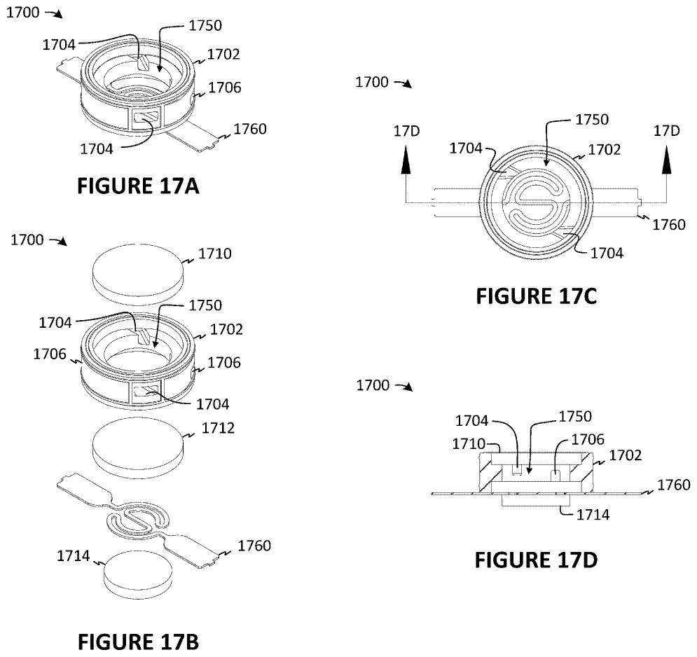

FIGS. 17A through 17D illustrate a chamber assembly for a vaporizing device. FIG. 17A is an isometric view of chamber assembly 1700. FIG. 17B is an exploded view of chamber assembly 1700. FIG. 17C is a top view of chamber assembly 1700. FIG. 17D is a cross-section of chamber assembly 1700. Chamber assembly 1700 may comprise chamber seal 1702, chamber top 1710, chamber bottom 1712, heater 1760, and support 1714. The combination of chamber seal 1702, chamber top 1710, and chamber bottom 1712 may define a volume referred to as chamber 1750.

Chamber seal 1702 may define an outer perimeter of chamber 1750. In certain embodiments, chamber seal 1702 may also define the depth of chamber 1750, facilitate the transfer of a liquid precursor to chamber 1750 via lower channels 1704, and deliver vapor generated within chamber 1750 via vapor port 1706. In some embodiments, chamber seal 1702 may provide a seal against a frame or chassis of a vaporizing device, such as upper chassis 1002, 1404. Chamber seal 1702 may be manufactured from a compliant material in order to create an effective seal under varying conditions. Because chamber seal 1702, and the components comprising it, may be subjected to temperature variations and exposure to liquid precursors, materials such as silicone or functionally equivalent materials may be desirable.

Chamber top 1710 and chamber bottom 1712 may define the upper and lower boundaries of chamber 1750. In some embodiments, chamber top 1710 and chamber bottom 1712 may be essentially identical. Chamber 1750 may take on a variety of geometric shapes to suit different design considerations, and chamber top 1710 and chamber bottom 1712 may be adapted accordingly. Cylindrical shapes for chamber top 1710 and chamber bottom 1712, as illustrated, may be efficiently manufactured.

Several factors may be considered when designing chamber bottom 1712. If a resistive heating element is used to heat chamber 1750, chamber bottom 1712 may be in direct contact with heater 1760 for efficient conductive heat transfer. Inorganic nonmetallic materials such as ceramics and/or glass can be used to construct chamber bottom 1712. Examples of appropriate ceramics include but are not limited to Macor®, Shapal™ alumina, aluminum nitride, boron carbide, carbon/graphite, magnesia, polycrystalline YAG, silicon, silicon carbide, silicon nitride, titanate, tungsten carbide, yttria, and zirconia, the ceramics and inorganic non-metallic material may be used individually or in combination to construct chamber bottom 1712. Examples of appropriate types of glass for the construction of chamber bottom 1712 include, but are not limited to, borosilicate glass and the borosilicate family of glasses, with common types including borosilicate 3.3 (like Duran® and Corning® 3.3), Corning® 51-V (clear), Corning® 51-L (amber), and Borofloat®. Other examples of borosilicate types include Pyrex®, Simax®, Suprax®, and Kimax®, often sold under various brand names. Another family of glass that would be appropriate for the construction of chamber bottom 1712 are silica-based glasses, commonly referred to as fused silica, including but not limited to, basic fused silica, also known as fused quartz, made from silicon dioxide (SiO₂). Fused silica is available in various types, each with slightly different properties, including Corning® HPFS grades, Heraeus SUPRASIL® grades, and Ohara SK grades. These can be further categorized based on production method and purity levels, such as Type I, II, III, and IV fused quartz. The ceramic or glass material used in the construction may be chosen for the material's resistance to thermal shock and or having a low coefficient of thermal expansion, and or for the thermal conductivity of the material.

In an embodiment, a glass or ceramic material with high thermal conductivity may be used to construct chamber bottom 1712 so that chamber bottom 1712 is heated rapidly by being in direct contact with heater 1760. In another embodiment, a glass or ceramic material with low thermal conductivity may be used to construct chamber bottom 1712 in order to isolate the transfer heat from heater 1760 to chamber bottom 1712 and mitigate radiant heat transfer from chamber bottom 1712 to the other components of chamber assembly 1700.

While metals are good thermal conductors, their electrical conductivity may introduce the risk of short-circuiting a resistive heating element such that if a bare metal is used to construct chamber bottom 1712 the heater 1760 must be positioned in proximity to the metallic chamber bottom 1712 but not in direct contact with chamber bottom 1712, in such embodiments, the metallic chamber bottom 1712 is heated by heater 1760 by radiative heating rather than conductive heating. If metal is used to construct chamber bottom 1712 with the metal surface in direct contact with the heater, the surface of the metal chamber bottom 1712 in contact with heater 1760 may be constructed or treated with an additional material or process such that it is not electrically conductive.

Examples of how the surface of the metallic chamber bottom 1712 may be constructed, and/or treated to result in the surface of the chamber bottom 1712 being no longer electrically conductive include but are not limited to the use of ceramic coatings like aluminum oxide (alumina), zirconium oxide (zirconia), or chromium oxide. These materials offer excellent thermal resistance and electrical insulation, making them suitable for high-temperature applications. Other examples may include the combination of a thin layer of a metal or inorganic non-metallic material such as those described previously and subsequently with a specialized high-temperature polymers such as silicones, fluoropolymers (like PTFE), polyimides, and polybenzimidazoles (PBI), or inorganic ceramic coatings. Such ceramic coatings are inherently electrically non-conductive and can withstand very high temperatures and may be chosen for specific properties in addition to being electrically non-conductive. For example, zirconia offers superior thermal and mechanical properties, while alumina is known for its wear resistance and ability to prevent corrosion. Chromium oxide coatings are chemically inert and offer high mechanical strength and microhardness. Ceramic coatings may be applied to heater 1760 facing side of chamber bottom 1712 by various methods including, but not limited to, thermal spraying or plasma spraying. Another method that may be used to construct chamber bottom 1712 such that the heater 1760 facing side of the chamber bottom 1712 is electrically non-conducting is the formation of a non-electrically conductive and or dielectric oxide layer bound to the metal surface of chamber bottom 1712.

Various methods can be employed to create an electrically non-conductive oxide surface on metal, including, but not limited to, anodization processes where the chamber bottom 1712 is constructed by: using aluminum, titanium, or magnesium for the chamber bottom 1712 component, and then immersing the metal in an acidic electrolyte bath and applying an electric current, causing oxygen ions to combine with metal atoms at the surface, thereby creating a protective oxide layer. Anodization of the chamber bottom 1712 may also have additional benefits such as enhancing the corrosion resistance, and wear resistance, in addition to the electrical insulation. Various types of anodization may be used to construct chamber bottom 1712, including but not limited to chromic acid anodizing (Type 1) in order to produce a thin, non-conductive layer with good corrosion resistance on the surface of a chamber bottom 1712. Sulfuric acid anodizing (Type 2), could be used if a thicker layer oxide is desired. Hard anodizing (Type 3) may be used which yields a very hard, abrasion-resistant, and non-conductive coating which may be desirable for improving the durability and life-cycle of chamber bottom 1712.

Another method for constructing a chamber bottom 1712 with an oxide layer that is non-conductive is chemical vapor deposition (CVD). This process uses gaseous precursors that are introduced into a heated chamber, where they react and deposit a thin, durable oxide layer on the metal surface of chamber bottom 1712. CVD may be chosen as the method for constructing chamber bottom 1712 as CVD enables precise control over coating thickness and properties, and is suitable for a wider range of metals than traditional anodization process previously described.

Another method for constructing the oxide layer on chamber bottom 1712 is the plasma electrolytic oxidation (PEO) process. PEO is similar to anodizing, and could be used on a chamber bottom 1712 comprising aluminum, magnesium, and/or titanium, but uses higher potentials, generating plasma discharges that modify the oxide layer, creating a thick, dense, and hard ceramic-like coating. PEO may be chosen to construct chamber bottom 1712 for the enhanced wear resistance, corrosion resistance, thermal stability, and dielectric properties when compared to traditional anodization.

The surface of chamber bottom 1712 constructed from metal may also be constructed to be non-conductive using a sol-gel method. This process involves applying a solution (sol) containing metal alkoxide precursors to the metal surface, which then undergoes gelation, drying, and heat treatment to form a metal oxide film. The sol-gel process may be chosen for the construction of a metal chamber bottom 1712 that has at least the surface in contact with heater 1760 being non-conductive to electricity as the sol-gel process is more environmentally friendly, requires comparatively low processing temperatures, and has the ability to coat complex shapes.

Another method that can be used to construct chamber bottom 1712 that does not require additional compounds or chemicals to form at least one non-conductive surface of chamber bottom 1712 is thermal oxidation, where simply subjecting the metal chamber bottom 1712 to high temperatures in the presence of oxygen to form a natural oxide layer on at least the surface of chamber bottom 1712 in contact with heater 1760. Another option for the formation of a non-conductive oxide layer on at least one surface of heater 1760 bottom is conversion coating, where the oxide layer is where the process is one of chemically forming a protective layer on the metal surface of chamber bottom 1712 through a reaction with specific chemical solutions. The surface of a metal chamber bottom 1712 may be oxidized using electrolytic deposition, where the chamber bottom 1712 is subjected to an electric current in order to induce the reduction of metal ions, forming a metal oxide coating. Another method of applying an oxide layer to chamber bottom 1712 is physical vapor deposition (PVD), where the vaporizing of metal oxides and depositing them as thin films on at least one surface of chamber bottom 1712 which functions as the substrate.

It may be desirable to construct the chamber bottom 1712 using one or more of the aforementioned methods such that the chamber bottom has a different surface as it relates to the coating and or oxide layer that is on the surface or face of chamber bottom 1712 that is in direct contact with the heater 1760 when compared to the surface of the chamber bottom 1712 that is in direct contact with the chamber 1750. The specific form and functionality of the method and process chosen to construct the chamber bottom 1712 out of metal and to have at least one surface of the chamber bottom 1712 non-conductive such that it may be in direct physical contact with the heater 1760 without shorting out heater 1760 while allowing the chamber bottom 1712 be heated by being in direct contact with heater 1760 may be determined by a variety of factors, including but not limited to design requirements, material selection, manufacturing methods, and economic considerations.

Resistive heating elements manufactured from nichrome (NiCr) or Kanthal® (FeCrAl) may be heated to approximately 200° C. to 300° C. (392° F. to 572° F.) during normal operation, and are capable of reaching temperatures exceeding 1,000° C. (2,192° F.). Therefore, it may be desirable to manufacture chamber bottom 1712 from a material that possesses good thermal conductivity, is not electrically conductive, and can withstand temperatures exceeding 300° C. (572° F.).

In some embodiments, heater 1760 may comprise a diode laser or a bulb (e.g., halogen or xenon) to heat chamber 1750 using radiation. In such cases, chamber bottom 1712 may be manufactured from a material that is transparent to the frequency band of the radiation utilized. In other embodiments where heater 1760 may comprise an induction heater, it may be desirable to manufacture chamber bottom 1712 from thermally conductive materials that are also inductive and/or ferritic materials.

Some examples of heater 1760 may expand and sag as they heat. Chamber assembly 1700 may include support 1714 to help maintain contact between heater 1760 and chamber bottom 1712. Support 1714 may include geometry configured to accommodate different shapes and styles of heater 1760, in addition to different variants of chamber assembly 1700. Because support 1714 may be subjected to high temperatures due to proximity to or contact with heater 1760, it may be desirable to manufacture support 1714 form a material that is not electrically conductive, particularly if heater 1760 is a resistive heating element. Support 1714 may be constructed in a similar fashion as the chamber bottom 1712 in regards to material selection and surface preparations. The material options and methods and processes described as being applicable to the construction of chamber bottom 1712 are also applicable to support 1714. Support 1714 may be constructed to such that the material used is not absorptive or transmissive to infrared (IR) radiation and functions to reflect infrared radiation being emitted from the heater 1760. Support 1714 may be constructed such that the material used is not absorptive or transmissive to ultraviolet radiation and functions to reflect ultraviolet radiation being emitted from the heater 1760. In an embodiment where support 1714 serves as a mechanical support for heater 1760 and also as a reflector to IR and/or UV radiation, the support may be constructed of a glass such as borosilicate or fused silica (SiO₂) such that the surface of the support 1714 in direct contact with heater 1760 is transmissive to IR and/or UV radiation and the surface of support 1714 that is not in direct contact with heater 1760 is constructed to be reflective to IR and/or UV radiation. In such embodiments, various methods could be employed to construct support 1714 such that the surface is not in direct contact with heater 1760 is reflective to IR and/or UV, for example, by coating and/or bonding and/or depositing on to the surface that is to function as a reflector a layer of metal that is reflective of IR and/or UV radiation. Suitable metals for this application include, but are not limited to, aluminum, gold, silver, rhodium, and platinum.

Another method for constructing a support 1714 that is reflective to IR and/or UV radiation is by applying a reflective oxide layer to one or more surfaces of support 1714. Suitable oxides that exhibit IR reflect-ability include, but are not limited to, IR reflective oxide layers of TiO₂ and SiO₂ multilayers, where quarter-wave stacks of crystalline anatase-phase titanium dioxide (TiO₂) and amorphous silicon dioxide (SiO₂) are used to reflect near-IR wavelengths. Indium tin oxide (ITO), where ITO films with high carrier concentration can strongly absorb IR-B (1400-3000 nm) radiation. When ITO is combined with silver (Ag), as in ITO/Ag/ITO (IAI) coatings, they achieve high reflection for near-IR radiation. Nanocrystalline metal oxides, where nanocrystalline cerium oxide (CeO₂) and titanium dioxide (TiO₂) show higher NIR reflectance compared to their macrocrystalline counterparts, especially in the 750-1300 nm range, making them suitable for use as NIR reflective pigments. Tantalum Oxide (Ta₂O₅₋ₓ), where an oxygen-deficient tantalum oxide can be used in multilayers with silicon dioxide (SiO₂) as IR-shielding coatings, particularly for IR-A (760-1400 nm) radiation. Suitable oxides that exhibit IR reflect-ability include but are not limited to, UV reflective oxide layers of magnesium oxide (MgO). This material has high UV reflectance and is even used as a UV reflectance standard. Barium Sulfate (BaSO₄) has high intrinsic reflectance in both UV and visible wavelengths, making it a frequently used pigment in UV-reflective coatings. Zinc oxide (ZnO) and titanium dioxide (TiO₂) could also be utilized at wavelengths above their semiconductor band gap absorption energy levels (long UVA and visible wavelengths). They act predominantly as reflectors. Zinc tin oxide (ZTO): Zn₂SnO₄ (ZTO) ternary metal oxide nanoparticles can exhibit higher reflectance in the UV, visible, and near-infrared (NIR) ranges compared to TiO₂ and ZnO nanoparticles. ZTO CANP (cubic aggregated nanoparticles) have high reflectance due to the faceted nature of its cubic structure.

For constructing support 1714 with reflectivity of both IR and UV, a multilayer structure of oxides may be used whereby different oxide layers, together with or without other metals, may be combined in multilayer structures to create a coating(s) that are highly reflective to both UV and IR. Such multi-layer oxide structures may be constructed to be transparent in the visible range. Transparency in the visible range may be of importance if it is desirable that the emissions from heater 1760 in the visible spectrum are used to indicate the activation state of the device to the user, such that the user can see a visible emission of light from heater 1760 when activated. Oxide layers either in mono-layer or multilayer structures can be further optimized to improve IR and/or UV reflectance by constructing the oxide layer or layers with specific particle size and morphology. Many oxide materials, particularly in nanoparticle form, reflectance properties may be significantly influenced by adjusting the particle size, shape, and aggregation, and these factors can be used in the formation and/or construction of the desired oxide layer or layers in order to achieve the desired performance of the layer or layers applied to support 1714.

Furthermore, the oxide layer or layers may be doped, where the process of doping introduces dopants into metal oxides to modulate their reflectivity in specific regions, such as near-infrared. A type of dopant that may be used to construct an oxide layer on support 1714 to improve the IR reflectance include, but are not limited to, aliovalent dopants that increase free carrier concentration, where doping with ions of different valence than the host material introduces free charge carriers, such as electrons or holes, into the oxide lattice. These free carriers interact with IR radiation, leading to an increase in reflectivity, particularly in the near-infrared (NIR) range. Examples of aliovalent dopants include, but are not limited to, cerium oxide (CeO₂) doped with terbium (Tb) as terbium doping enhances the band gap of cerium oxide, improving its reflective properties and achieving high near-infrared reflectance. Hafnium nitride (HfN) doped with Silver (Ag) can also be used as silver doping increases the plasma energy of HfN films, shifting the reflective cutoff wavelength and expanding the high-reflectivity region towards lower wavelengths. Zinc oxide (ZnO) doped with Al³⁺ (AZO) is another option as aluminum doping increase in IR reflection. Yttria-stabilized zirconia (YSZ) doped with magnesium (MgO) is yet another method for increasing IR reflectance as magnesium doping in YSZ promotes oxygen vacancy formation, enhancing ionic conductivity and reducing infrared emissivity, thereby increasing reflectivity. Another oxide that can be doped to improve IR reflectance is cadmium oxide (CdO), which can be doped with various ions, for example, a dysprosium ion in its trivalent state (Dy³⁺), or an indium ion in its trivalent state (In³⁺), or an yttrium ion in its trivalent state (Y³⁺), or a fluoride anion (F⁻), these dopants may be incorporated substitutionally, increasing carrier density and leading to broad spectral tunability and low optical losses in the IR range.

In an embodiment the support 1714 may be used as an IR detector and/or sensor where the doping of the surface oxide layer and/or layers present on the support 1714 may be constructed to serve as an IR detector or sensor by choosing specific dopants including, but not limited to, localized Surface plasmon resonance (LSPR) type semiconductor nanocrystals that exhibit tunable LSPR in the IR region by controlling the size and doping content. Such that support 1714 functions as an IR photodetector and or IR sensor. Another method to dope the oxide such that support 1714 can also function as an IR detector or sensor are cation exchange reactions in the oxide layer, this approach allows for the introduction of p-type dopants, including, but not limited to, copper (I) ion (Cu⁺), or a silver ion (Ag⁺), into n-type metal-oxide nanocrystals, causing programmed LSPR redshifts due to dopant compensation.

In some embodiments, support 1714 may also function to insulate other components comprising a vaporizing device from heater 1760. Support 1714 may function as an insulator by reflecting heat towards chamber 1750 as described herein. Support 1714 may serve as an insulator by being constructed of a thermally insulative material which may include, but is not limited to, fibrous or porous material such as mineral wool, ceramic fiber, aerogel, and glass fibers/fiber glass. It may be desirable if heater 1760 is a resistive element to construct support 1714 from materials that are both non-thermally and non-electrically conductive. Such materials include, but are not limited to, alumina (Al₂O₃), boron nitride (BN), zirconium phosphate, and silica (SiO₂) ceramics.

Another option for the construction of a non-thermally and non-electrically conductive support 1714 is to use a ceramic matrix composites (CMCs) that combine ceramic fibers, for example silicon carbide, with a ceramic matrix such as silicon carbide in SiC/SiC. Types of CMCs that may be used to construct support 1714 include, but are not limited to, oxide/oxide, carbon/carbon, and non-oxide/non-oxide CMCs. Specific examples include Carbon/Silicon Carbide (C/SiC) and Silicon Carbide/Silicon Carbide (SiC/SiC). The oxide/oxide CMCs are composed of oxide ceramic fibers embedded in an oxide ceramic matrix. Examples of oxide-based CMCs include materials such as alumina and mullite, where both the fibers and matrix are composed of oxide ceramics. In contrast, carbon/carbon CMCs are constructed using carbon fibers embedded within a carbon matrix. Non-oxide/non-oxide CMCs are composed of non-oxide ceramic fibers and matrix materials, such as silicon carbide. C/SiC are carbon fibers reinforced with silicon carbide matrix.

In some embodiments, support 1714 may be constructed to be partially or completely thermally conductive such that heater 1760 must heat both the chamber bottom 1712 and, and to some degree the support 1714 when activated. This may be desirable to improve the uniformity of the heating of the chamber bottom 1712. The specific form and functionality of the method and process chosen to construct the support 1714 to function as either a thermal insulator, or electrical insulator, or both a thermal and electrical insulator that may be in direct contact with heater 1760 may be determined by a variety of factors, including, but not limited to, design requirements, material selection, manufacturing methods, and economic considerations.

In an embodiment, heater 1760 may be isolated from the precursor, aerosol, vapor, and/or intake air by chamber bottom. Thus, the precursor, aerosol, vapor, and/or intake air are not allowed to contact the compositions that make up heater 1760 (e.g., metals). This may serve to improve the user experience by not contaminating the precursor, aerosol, vapor, and/or intake air with the constituents (e.g., metals) that make up heater 1760. This configuration may serve to reduce the thermal degradation of the precursor fluid that results from the precursor liquid being in direct contact with the heater as is a common configuration in some vaporizers. Furthermore, the separation of the heater 1760 from the chamber 1750 by chamber bottom 1712 allows for more even and uniform heating of the precursor liquid in order to generate an aerosol and/or vapor that has a more uniform particle size and a lower number of constituents in the aerosol and/or vapor that are product of thermal degradation that result from uneven heating of the precursor liquid.

In an embodiment, one or more of chamber top 1710 and chamber bottom 1712 may be comprised of, or consist of, an inert and non-reactive material. One or more of chamber top 1710 and chamber bottom 1712 may be comprise, or consist of an inert and non-reactive material to help prevent reactions with the components of chamber assembly 1700 and the precursor, aerosol, vapor, and/or intake air from occurring at the high operating temperatures of chamber assembly 1700. For example, one or more of chamber top 1710 and chamber bottom 1712 may be glass, fused silica, borosilicate glass, and the like. Chamber top 1710 may be constructed using the same materials and methods as used to construct chamber bottom 1712 as have been described previously. Furthermore, chamber top may be constructed using any of the materials and methods used to construct support 1714 that have been described herein. For example, it may be desirable for chamber top 1710 to be reflective to IR radiation and/or UV radiation such that chamber top 1710 reflects thermal radiation and/or IR radiation and/or UV radiation emitted from heater 1760 back into chamber 1750. In some embodiments, chamber top 1710 may be constructed to be a partial reflector such that some of the thermal energy emitted from heater 1760 is absorbed such that chamber top 1710 is heated above ambient temperature to thermally modulate the flow of a thermoviscous precursor liquid through lower channels 1704. In such an embodiment, chamber top 1710 may be constructed such that when heater 1760 is activated, some of the thermal energy emitted passes through the chamber 1750 and through the precursor liquid contained therein and is partially reflected and partially absorbed by chamber top 1710, where the heating of chamber top 1710 to above ambient temperature may facilitate the flow of a thermoviscous precursor through lower channels 1704. In another embodiment, chamber top 1710 may be constructed of a material that can be manufactured to absorb specific types of radiation. For example, and as previously described, fused silica may be used to construct chamber top 1710 and be able to absorb IR radiation and or UV radiation. In an embodiment, chamber top 1710 may be constructed of fused silica that contains a sufficient amount of hydroxyl groups (OH), greater than 10 ppm, to be at least partially absorptive of infrared radiation emitted from heater 1760 during activation, to allow for heating of chamber top to temperatures sufficient to facilitate the flow of a thermoviscous precursor through lower channels 1704. In such an embodiment, the surface of chamber top 1710 that is not facing the chamber 1750 may be constructed to be reflective of thermal radiation, including IR radiation and/or UV radiation, by coating, depositing, or otherwise forming a layer of aluminum onto the fused silica chamber top 1710. In such an embodiment, a layer, and/or film, and/or coating that is reflective to thermal radiation, and/or infrared radiation, and/or UV radiation may be constructed using the methods and processes described herein for the construction of support 1714 and/or chamber bottom 1712.

The specific form and functionality of the method and process chosen to construct chamber top 1710 to function as either a thermal reflector, or be absorptive or partially absorptive to thermal radiation or both a reflector of IR radiation and/or UV radiation, and/or an absorber of IR and/or UV radiation, or a mixed absorber and reflector of IR radiation and/or UV radiation emitted from heater 1760 may be determined by a variety of factors, including, but not limited to, design requirements, material selection, manufacturing methods, and economic considerations.

Chamber assembly 1700 may serve as an illustrative example of a chamber assembly suitable for use in a vaporizing device. It should be appreciated, however, that numerous alternative embodiments could be conceived, and not all possible configurations are disclosed herein. The specific form and functionality of chamber assemblies may be determined by a variety of factors, including but not limited to design requirements, material selection, manufacturing methods, and economic considerations. Variations in materials and fabrication techniques may enable the inclusion of different features or adaptations within a chamber assembly. For instance, a chamber assembly might incorporate a flow director to induce rotational flow within the chamber, which could promote more efficient vaporization of a liquid precursor and yield a more consistent aerosol output. Other features may be introduced or omitted as dictated by the particular needs of a given application or manufacturing process.

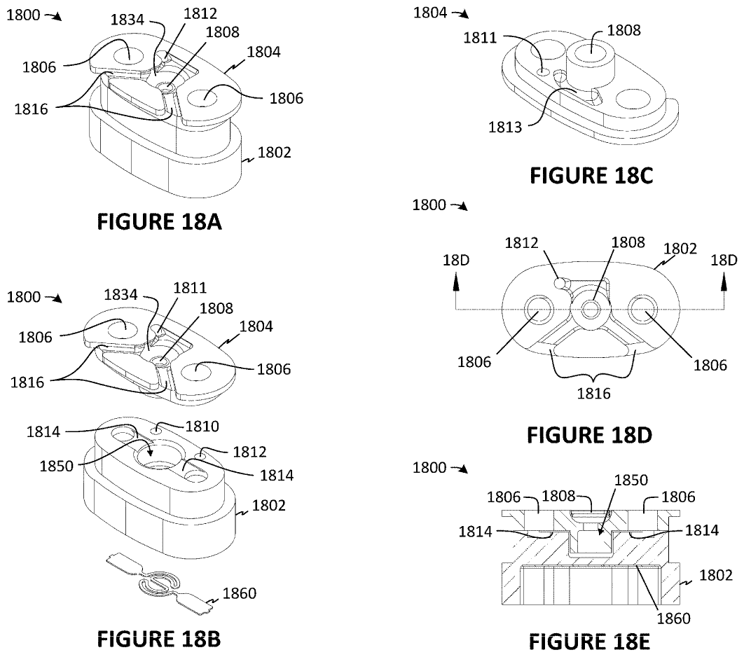

FIGS. 18A through 18E illustrate a chamber assembly for a vaporizing device. FIG. 18A is an isometric view of chamber assembly 1800. FIG. 18B is an exploded view of chamber assembly 1800. FIG. 18C is an isometric view of the bottom of flow directors 1804. FIG. 18D is a top view of chamber assembly 1800. FIG. 18E is a cross-section of chamber assembly 1800. Chamber assembly 1800 may comprise housing 1802, flow directors 1804, and heater 1860.

Flow directors 1804 may be configured to direct flow paths of air, vapor, and aerosol. In some embodiments, flow directors 1804 may comprise a top surface of chamber 1850. Flow directors 1804 may include dispenser ports 1806 to allow for the transfer fluid into chamber assembly 1800. Aerosol port 1808 may be configured to transfer aerosol generated within chamber 1850 to depression 1834 to be combined with air before leaving chamber assembly 1800 via exit ports 1816. Flow directors 1804 may include flow path 1813 to induce a rotational flow to a stream of incoming air.

Housing 1802 may include passageway 1810. Passageway 1810 may be coupled to passageway 1811 of flow directors 1804 to transfer air from below chamber assembly 1800 to depression 1834, where the air may mix with an aerosol exiting chamber 1850 at aerosol port 1808. Passageway 1810 passes through the housing 1802 in such a way passageway 1810 is isolated from heater 1860 by a thin wall, where the exposure of the thin wall of passageway 1810 to heater 1860 located in housing 1802 allows for the airflow in passageway 1810 to be heated by the proximity to heater 1860 while not directly being in contact with heater 1860. The heating of the intake airflow traveling through the passageway 1810 may improve the efficiency of the aerosol and/or vapor being generated as the airflow does not cool down aerosol port 1808 and depression 1834 as much as it would if the airflow was at ambient temperature—thus reducing the amount of heat that would have to be provided by heater 1860 to overcome the cooling of aerosol port 1808 and depression 1834 from the intake airflow being at ambient temperature.

Increasing the temperature of the depression 1834 and aerosol port 1808 above the ambient temperature affects how quickly the precursor liquid reaches its boiling point by influencing the rate of vapor pressure increase. Additionally, heating of the intake airflow may serve to reduce the condensation and agglomeration of the small aerosol particles exiting the aerosol port 1808 into depression 1834 into larger particles that may occur when the aerosol is exposed to cooler air such as if the intake airflow was at ambient temperature. Additionally, the air flow from passageway 1810 to passageway 1811 and then to depression 1834 may serve to exert a vacuum pressure on the chamber 1850 via aerosol port 1808, where the vacuum pressure serves to reduce the boiling point temperature of the precursor liquid by lowering the vapor pressure of the precursor liquid in chamber 1850. The reduction of the vapor pressure in chamber 1850 serves to reduce the boiling point temperature of the precursor liquid by the application of a vacuum pressure on chamber 1850 may allow for the reduction in thermal energy and or heat required from heater 1860 to effect generating an aerosol and/or vapor from the precursor fluid. In an embodiment, the vacuum pressure exerted on the aerosol port 1808, passageway 1810, passageway 1811, passageway 1812, flow path 11, chamber 1850 and exit ports 1816 is 200-800 pascals.

Reducing the amount of thermal energy and/or heat required to transition the liquid precursor to an aerosol and/or vapor may allow for the aerosol and/or vapor to be generated at a lower temperature and may reduce the chances of overheating of the precursor, and subsequently reduce and/or mitigate the potential thermal degradation of the precursor liquid. In an embodiment, the vacuum pressure generated during inhalation and subsequent airflow through passageway 1810 to passageway 1811 and then to depression 1834 may exert a vacuum pressure on chamber 1850 via aerosol port 1808, for example in the range of 200-800 pascals. The relationship between the applied vacuum and the reduction in boiling point of the precursor liquid may be modeled using the Clausius-Clapeyron equation, which relates the vapor pressure and temperature at phase transition by:

$$ln ln ( \frac{{P}_{2}}{{P}_{1}} ) = - \frac{Δ {H}_{v a p}}{R} ( \frac{1}{{T}_{2}} - \frac{1}{{T}_{1}} ) .$$

where P₁ and T₁ represent a reference vapor pressure and temperature pair, such as standard atmospheric pressure and the corresponding boiling point, and P₂ and T₂ represent the reduced vapor pressure in chamber 1850 and the corresponding new boiling point. By equipping the device to measure real-time airflow and thus infer vacuum conditions, the system may dynamically estimate the local boiling point of a precursor liquid. In certain embodiments, a control unit may utilize this inferred boiling point to adjust the heater 1860 output, modulating power to achieve sufficient vaporization while mitigating the risk of thermal degradation due to excessive temperatures. Depression 1834 may be a cutout in the top surface of flow directors 1804 configured to provide space for the mixing of air and aerosol and to accommodate a valve, which will be discussed in greater detail herein.

Housing 1802 may further include passageway 1812. Passageway 1812 may be coupled to flow path 1813 of flow directors 1804 to deliver a stream of air into chamber 1850. The architecture of flow path 1813 may be configured to impart a vortical rotational flow of air within chamber 1850. Passageway 1812 may be constructed in a similar fashion to the construction of passageway 1810 and the airflow transiting though passageway 1812 may be heated by the same process described for passageway 1810. The heating of the airflow transiting passageway 1812 may improve the efficiency of the aerosol and/or vapor being generated as the airflow does not cool down channels 1814 and chamber 1850 as much as it would if the airflow was at ambient temperature, thus reducing the amount of heat that would have to be provided by heater 1860 to overcome the cooling of the chamber 1850 by the intake of airflow at ambient temperature. The heating of the intake airflow transiting passageway 1812 may be important as the flow path 1813 directs the flow past channels 1814 and chamber 1850 where the precursor liquid is present. If the airflow was not heated it may serve to cool the precursor liquid and increase the viscosity of a thermoviscous precursor fluid which may reduce the desired flow and/or movement of the precursor, and by reducing the temperature of the precursor which would require additional thermal energy from heater 1860 to sufficiently heat the precursor liquid such that an aerosol and/or vapor was generated. The presence of a vortical or rotational flow path may enhance the mixing of air and vapor in chamber 1850, increase the dwell time of air and vapor, and facilitate selective removal of large particles (e.g., >5 microns) from the generated aerosol. In addition, a vortical or rotational flow within chamber 1850 may help thin or spread a liquid precursor over the heated base of chamber 1850 potentially leading to more efficient vaporization.

Flow path 1813 may be constructed such that the velocity of the airflow is increased as the airflow exits the flow path 1813 and enters into the radial space that is formed from the outer surface of the body that forms aerosol port 1808 and the wall of chamber 1850. Furthermore, the airflow from flow path 1813 sweeps across the channels at the point where precursor liquid exits channels 1814 and enters into the radial space that is formed from the outer surface of the body that forms the aerosol port 1808 and the wall of chamber 1850. This airflow from flow path 1813 may serve to modulate the flow rate of the precursor liquid exiting channels 1814 by at least partially entraining the flow of precursor liquid from channels 1814 such that there is a relationship where more airflow through flow path 1813 results in more flow of precursor liquid exiting channels 1814 into the chamber 1850. The interaction between air velocity and fluid entrainment may be characterized mathematically using Bernoulli's equation for incompressible flow:

$${P}_{1} + \frac{1}{2} ρ {v}_{1}^{2} = {P}_{2} + \frac{1}{2} ρ {v}_{2}^{2}$$

where P₁ and v₁ denote the static pressure and velocity within flow path 1813, and P₂, v₂ represent those in the radial space. As the cross-sectional area decreases, the continuity equation,

$${A}_{1} {ν}_{1} = {A}_{2} {v}_{2}$$

indicates that a reduction in area results in increased velocity (v₂>v₁), which according to Bernoulli's principle yields a pressure drop (P₂<P₁) in proximity to the opening of precursor channels 1814. This localized low-pressure region may draw precursor liquid into chamber 1850 at a rate that increases with airflow velocity. In some embodiments, monitoring or controlling the geometry of flow path 1813 and the magnitude of inlet airflow may provide a mechanism for dynamic adjustment of precursor liquid delivery, thereby enhancing atomization or vapor production as required.

In an embodiment, the inlet airflow through flow path 1813 may increase in velocity as it enters into the radial space that is formed from the outer surface of the body that forms aerosol port 1808 and the wall of chamber 1850. This increase in velocity creates a low-pressure region in proximity to the precursor liquid channels 1814 where the channel opens to the radial space that is formed from the outer surface of the body that forms the aerosol port 1808 and the wall of chamber 1850. The low-pressure air flow draws in the surrounding precursor liquid, increasing its mass flow rate and or its volume of flow into chamber 1850.

A vortical flow may exhibit higher flow velocities at larger radial distances within chamber 1850, as described by

$$v = r ω$$

where the linear (tangential) velocity may be directly proportional to the radial distance. Thus, lower velocities occur closer to the axis, while higher velocities occur farther out toward the circumference. This vortical flow may act as a particle size selector, since particles in rotational motion are subjected to centrifugal forces given by

$$F = \frac{m {ν}^{2}}{r}$$

where the force is directly proportional to the particle mass. Consequently, larger particles experience greater outward forces, which may increase their residence time within the rotational flow. The increase in transit time for the larger particles increases the larger particles' exposure to heater 1860 and allows for the larger particles to be thermally modulated to smaller particles that may be more ideal for a deposition aerosol intended for inhalation into the deep lung. Smaller particles may escape the rotational radial flow by moving to the axial center of the flow to be entrained in a flow of aerosol exiting chamber 1850 at aerosol port 1808.

In addition, a vortical flow established within chamber 1850 may promote spreading and thinning of a liquid precursor over the bottom surface of chamber 1850, thereby facilitating more uniform exposure of the precursor to the heating surface and potentially resulting in more consistent vaporization. Additionally, the vortical flow established within chamber 1850 may result in more even heat distribution to the precursor liquid as the precursor liquid is getting rotated or stirred within the chamber 1850 which may promote a more uniform heating that subsequently reduces the thermal degradation of the precursor liquid.

Housing 1802 may be configured to receive a liquid precursor and deliver it into chamber 1850 via channels 1814. Channels 1814 may be located above an end of heater 1860. Heater 1860 may be a resistive heating element. While the greatest concentration of heat generation occurs at the center of heater 1860 where current flow is the highest, the ends of heater 1860 may also warm due to thermal conduction. This residual heat may elevate the temperature of channels 1814 and a liquid precursor contained therein. By increasing the precursor temperature, the system may reduce the viscosity of the liquid precursor, thereby facilitating more efficient flow into chamber 1850. In an embodiment channels 1814 function as a thermally mediated valve(s) where flow of a thermoviscous precursor through channels 1814 does not occur at ambient temperatures due to the viscosity of the precursor and small cross-sectional area of the channels 1814, and that only with activation of heater 1860 and subsequent heating of channels 1814 is there flow of the precursor through the channels 1814 into the chamber 1850 due to the reduction in viscosity of the precursor when heated.

Some embodiments of chamber assembly 1800 may take advantage of the temperature-dependent viscosity of a liquid precursor to enhance device performance. For example, vaporizers may, in colder conditions, require a series of priming puffs to increase the temperature of a liquid precursor and sufficiently reduce its viscosity for reliable delivery to the chamber. The temperature of chamber assembly 1800 and a liquid precursor contained within it may be estimated by monitoring the resistance of heater 1860, even while the device is idle. A control system may be configured to periodically sample the chamber temperature and briefly activate heater 1860 to maintain an optimum chamber temperature. This approach may reduce or eliminate the need for priming puffs in cold weather, leading to improved consistency in aerosol formation, delivery, and user experience.

Housing 1802 may be configured to couple with heater 1860. Heater 1860 may comprise a resistive heating element positioned in thermal communication with housing 1802. The electrical and thermal characteristics of heater 1860 may be modulated by altering the geometry of the resistive element. For example, the electrical resistance of heater 1860 may be influenced by parameters such as the length, width, thickness, and patterning of the resistive material. Increasing the effective internal surface area of the heating element may decrease electrical resistance by providing multiple current paths or reducing the net path length for current flow. Conversely, increasing the length or reducing the cross-sectional area of the resistive path may increase electrical resistance, thereby affecting the rate of heat generation for a given applied voltage.

In addition, the physical arrangement, a spiral shape for example, of the resistive element may impact both the spatial distribution of heat and the response time of heater 1860. Different geometries may be selected to tailor heating performance to specific operational requirements, such as achieving rapid thermal equilibration, maintaining temperature uniformity, or localizing heat to targeted regions within housing 1802. The overall design of the resistive heating element may therefore be guided by considerations including desired resistance range, power requirements, efficiency of thermal transfer to adjacent components, and compatibility with the selected precursor and device architecture.

Alternative embodiments may employ other heating technologies, such as ceramic-based elements, inductive heating, or InfraRed (IR) and/or Ultraviolet (UV) heaters depending on the desired operational characteristics of the chamber assembly. Although this embodiment illustrates a resistive element it should be understood that any of the heating methods described herein may be applied to this embodiment.

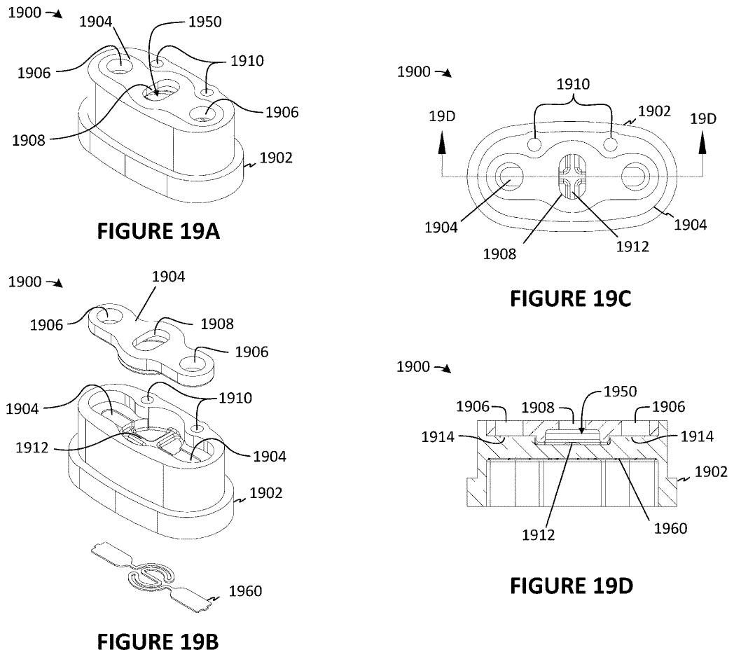

FIGS. 19A through 19D illustrate a chamber assembly for a vaporizing device. FIG. 19A provides an isometric view of chamber assembly 1900, FIG. 19B presents an exploded view, FIG. 19C shows a top view, and FIG. 19D depicts a cross-sectional view. Chamber assembly 1900 may comprise housing 1902, flow director 1904, and heater 1960. In the illustrated embodiment, housing 1902 and flow director 1904 together define a volume referred to as chamber 1950.

Flow director 1904 may be configured to couple with housing 1902, thereby forming an upper enclosure for chamber 1950. Flow director 1904 may include dispenser ports 1906 permitting the transfer of a liquid precursor into chamber 1950, as well as a vapor port 1908 configured to direct vapor generated within chamber 1950 toward an outlet. In some embodiments, flow director 1904 may further incorporate specific geometric features to modify the internal flow path of vapor or aerosol, for example by inducing rotational flow, promoting mixing, or facilitating the separation of larger aerosol particles from smaller aerosol particles, as well as features that may trap and/or return the larger aerosol particles back into chamber 1950.

Chamber housing 1902 may include passageways 1910 to allow intake air to be transferred from below chamber housing 1902 to above it. Passageways 1910 may be constructed to be in close proximity at one or more points to the region of housing 1902 that house heater 1960 such that passageways 1910 are heated and the intake airflow is heated in such a manner as described herein, for example, for passageways 1810 and 1812. However, in vaporizing devices configured to draw intake air from above chamber assembly 1900, or where air is delivered from lateral regions, passageways 1910 may be omitted as they are not required by those configurations.

Chamber housing 1902 may be configured to receive a liquid precursor and deliver it into chamber 1950 via channels 1914. These channels may be positioned to receive fluid that has passed through dispenser ports 1906. Channels 1914 may be located above the ends of heater 1960 to take advantage of residual heat, potentially reducing the viscosity of the precursor fluid and facilitating more efficient flow into chamber 1950. By leveraging temperature-dependent viscosity changes, chamber assembly 1900 may enhance precursor delivery and vaporization performance, in a manner similar to that previously described for channels 1814.

The bottom of chamber 1950 may further include ridges 1912 designed to increase the total surface area available for heat transfer to a liquid precursor. Such an arrangement may improve the efficiency of vaporization by maximizing the interface between the heated surface and the precursor fluid. While this may be the only embodiment of a chamber including ridges 1912, it should be understood that any embodiment of a chamber may include ridges 1912 or other such features that serve to increase the surface area of the heated region of chamber 1950. Although ridges 1912 are illustrated as being directly visible features it should be understood that microscopic features such as ridges or prominences in plurality and/or altering the surface characteristics of the material, for example, increasing the roughness of the surface, may be used to increase total effective surface area of the heated region of chamber 1950.

Heater 1960 may be implemented as a resistive heating element in thermal communication with the bottom of housing 1902. Alternative embodiments may employ other heating technologies, such as ceramic-based elements, inductive heating, or infrared (IR) and/or ultraviolet (UV) heaters depending on the desired operational characteristics of the chamber assembly. Although this embodiment illustrates a resistive element it should be understood that any of the heating methods described herein may be applied to this embodiment.

It may be undesirable for heat used to generate vapor within a vaporization chamber, or to mobilize precursor in a dispenser, to transfer to other parts of a vaporizing device. Chamber designs may be implemented that mitigate unwanted heat transfer. In some embodiments, residual heat may be used to pre-condition air before it is mixed with vapor to form an aerosol. In such embodiments, the intake air serves to absorb excess heat generated by the heater and to as a result cool the chamber during activation.

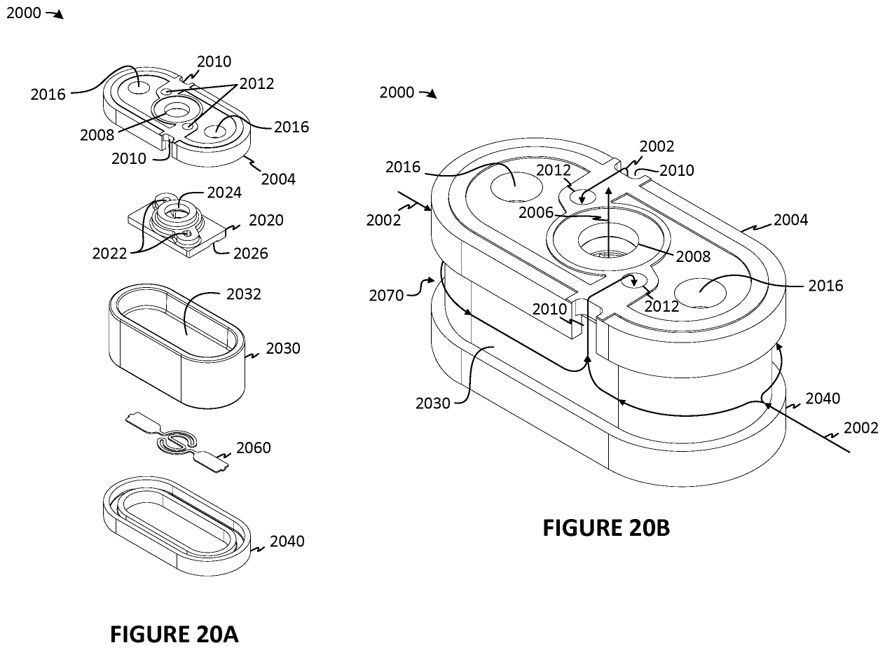

FIG. 20A presents an exploded isometric view, and FIG. 20B a collapsed isometric view, of a chamber assembly. Chamber assembly 2000 may comprise flow director 2004, chamber top 2020, chamber bottom 2030, heater 2060, and lower seal 2040.

Flow director 2004 may be configured both to direct incoming air 2002 into a vaporization chamber and to serve as an upper lid for secondary reservoir 2032. Flow director 2004 may be configured to couple to the top surface of chamber bottom 2030. Flow director 2004 may serve as the upper seal for the chamber assembly 2000. Flow director 2004 in this embodiment serves to provide multiple sealing functions to isolate various ports and channels in its function as flow director 2004 such that it serves as the primary upper seal for the chamber assembly 2000, and seals the aerosol port 2008, and seals passageways 2010, and seals ports 2012, and seals dispenser ports 2016, and seals air ports 2022, and seals aerosol port 2024. Flow director 2004 also functions to position the chamber top 2020 inside the chamber bottom 2030 and to seat the chamber top 2020 firmly against the chamber bottom 2030 to form channel(s) 2026, which are formed by channels in chamber top 2020 and the surface chamber top 2020 is seated upon in chamber bottom 2030. In an embodiment flow director 2004 is constructed from a durable high temperature polymer such as silicone where the compliance of the silicone serves to exert a pre-load or force upon chamber top 2020 to insure it is properly positioned and seated in chamber bottom 2030. In this embodiment, flow director 2004 may include a perimeter extending beyond that of chamber bottom 2030. Lower seal 2040 may include an outer profile generally matching the outer profile of flow director 2004 and may couple to the bottom of chamber bottom 2030. In an assembled state, flow director 2004 may define an upper boundary, lower seal 2040 a lower boundary, and chamber bottom 2030 an interior boundary of surrounding cavity 2070. In a vaporizing device, chamber assembly 2000 may be assembled into a housing (not illustrated) that defines an exterior boundary of surrounding cavity 2070; this housing is omitted for clarity in the figures.

When a user applies suction, air 2002 may be drawn into the surrounding cavity 2070. While traversing the surrounding cavity 2070, air 2002 may absorb residual heat escaping from the vaporization chamber, thereby preconditioning air 2002 by increasing its temperature. This preconditioning may enhance vaporization efficiency, as air 2002 arriving at an elevated temperature is likely to draw less heat away from the vaporization process. Furthermore, surrounding cavity 2070 may serve as an insulating barrier, as the flow of air 2002 through this region during heater 2060 activation may transfer escaping heat back into the chamber, rather than to adjacent device components.

After moving through the surrounding cavity 2070, air 2002 may be directed through passageways 2010 in flow director 2004. In an assembled device, an additional component (not illustrated) may couple to flow director 2004 to form a channel that directs air from passageways 2010 to ports 2012. Ports 2012 within flow director 2004 may couple to air ports 2022 of chamber top 2020, ultimately guiding air 2002 into the chamber where it can be combined with vapor to generate aerosol 2006.

Flow director 2004 may also include one or more dispenser ports 2016, which may enable a precursor or portions of a precursor dispenser to pass into secondary reservoir 2032. Additionally, flow director 2004 may include aerosol port 2008, through which aerosol 2006 may exit chamber assembly 2000. In some embodiments, passageways 2012, and/or ports 2012, and/or aerosol port 2024 may be valved by any of the valving methods and/or valve types, and/or valve mechanisms previously and subsequently described herein.

Chamber top 2020 may define the main interior volume of a vaporization chamber, with chamber bottom 2030 forming the opposing lower surface. Chamber top 2020 may include one or more air ports 2022 distributed around the perimeter, which are configured to direct air 2002 into the vaporization chamber. In an embodiment, air ports 2022 may be configured to promote a vortical and/or rotational flow of air 2002. It may also include one or more precursor channels 2026 to supply precursor to the chamber. In an embodiment, precursor channels 2026 function as a thermally mediated valve to regulate the flow of precursor liquid, where the channels 2026 are positioned to be heated by the non-resistive region of heater 2060 such that a thermoviscous precursor has a reduction in viscosity secondary to heating to facilitate the flow through channels 2026. In an embodiment flow through channels 2026 during activation has a median flow rate of 2 uL and/or 2 mg per second. In an embodiment the air ports 2022 are positioned such that where they terminate is in proximity to where channels 2026 terminate such that flow rate and/or volume of precursor flowing through channels 2026 is at least partially mediated by the rate of air 2002 flow through air ports 2022 and the stream of air 2002 functions to at least partially entrain precursor flow exiting channels 2026.

Chamber bottom 2030 may be configured to form at least a portion of secondary reservoir 2032 and serve as a lower surface of a vaporization chamber. The secondary reservoir 2032 may serve functions such as those previously described such as facilitating consistent flow of precursor liquid to the vaporization chamber, and providing consistent flow of precursor liquid in different orientations of the device when is use, and to provide a heat sink for excess heat that may be generated by the heater 2060 where the secondary reservoir volume is heated to a degree that its viscosity is reduced sufficiently to be able to readily flow through channels 2026. Heater 2060 may be thermally coupled with chamber bottom 2030 to provide heat necessary to vaporization within the chamber.

Heater 2060 may be implemented as a resistive heating element in thermal communication with chamber bottom 2030. Alternative embodiments may employ other heating technologies, such as ceramic-based elements, inductive heating, or infrared (IR) and/or ultraviolet (UV) heaters depending on the desired operational characteristics of the chamber assembly. Although this embodiment illustrates a resistive element it should be understood that any of the heating methods described herein may be applied to this embodiment.

The previously discussed embodiments of chamber assemblies primarily utilize resistive heating elements for the bulk heating of precursor compositions. While resistive heating may be considered relatively nonselective, in that it concurrently heats all constituents present in the precursor, other types of heaters may possess the capacity to selectively heat one or more constituents comprising a precursor.

In various embodiments, different sources of radiation may be employed to vaporize a precursor. For example, lasers or diodes may be used, with some sources emitting radiation in the infrared (IR) spectrum, while others emit in the ultraviolet (UV) spectrum. Although IR or UV radiation may each be used individually, the combined use of IR and UV may yield advantageous properties that could be exploited in vaporizer applications. Where a heater or plurality of heaters comprising UV and IR emitters, or a plurality of UV and IR emitters may be used as the heater (such as heater 140, 240, 340, 440, 540, 640, 740, 840, 1007, 1140, 1340, 1440, 1760, 1860, 1960, 2060, 2160, 2350, 2550, and other heaters described herein).

Certain precursor formulations, such as those containing nicotine combined with vegetable glycerol and/or propylene glycol, and/or cannabis extracts, may be vaporized through mechanisms involving both electron excitation (via UV radiation) and vibrational excitation (via IR radiation). Molecular species such as nicotine and cannabinoids contain conjugated π-systems, which may undergo electronic excitation when exposed to UV radiation and vibrational excitation when exposed to IR radiation. When UV excitation occurs, energy is rapidly redistributed through electron redistribution to higher orbitals, and the concurrent or sequential application of IR energy may enhance absorption or facilitate selective heating of specific molecular bonds through vibration. This mechanism may potentially enable resonance-enhanced multiphoton absorption or targeted thermal mobilization of selected precursor constituents.

There are important advantages to the heating of the precursor utilizing the combination of IR and UV radiation such as the precursor is not in contact with the emitter of the radiation, and the emitted radiation may be calibrated to emit wavelengths of IR and/or UV radiation that are absorbed by the precursor. Many vaporization methods require a heating element, often a metal wire or coil, or metal trace that is heated along with the substrate, and subsequently heats a wick or porous material substrate that contains the precursor in order to effect a thermally mediated phase change of the precursor into a vapor to be combined with air to form an inhalable aerosol. These methods have been shown to introduce undesirable constituents into the aerosol such as metals from the heater element and thermal degradation products from the precursor compound(s). These undesirable constituents reduce the safety and efficacy of the inhalation aerosol and reduce user satisfaction by negatively impacting the flavor and purity of the inhaled aerosol. There are several reasons why the method of direct heating of the precursor using combined IR and UV radiation is preferable to the methods of existing systems such as the heating of the precursor liquid and/or precursor compound directly allows for the removal of the metal heating element, or metal trace, along with the associated substrate that is heated by the metal element or trace from these systems entirely. This removes the presence of metals in the systems that may contribute metal or components of the metal to the aerosol. Additionally, as a combined IR and UV radiation heating system is a contactless system, meaning that the liquid precursor and/or precursor compound is not in direct contact with the IR and UV source such as an emitter and/or diode, and is only contacted by the emitted radiation, the thermal degradation of the precursor liquid and/or compound is mitigated, and the buildup of thermal degradation products onto the heater is also mitigated, as a result the amount of thermal degradation products present in the vapor and subsequently formed aerosol is greatly reduced or completely mitigated.

The method of heating using the emission of electromagnetic radiation such as infrared (IR) radiation and/or ultraviolet (UV) radiation described herein utilizes UV radiation and IR radiation to directly thermally modulate the precursor liquid without the need for a resistive heater element or other type of joule heater, and without the need of heating a wick, or otherwise heating a porous substrate, or other substrate containing the precursor. This method uses electromagnetic IR and UV radiation to directly heat the precursor at a molecular level. Utilizing electromagnetic emissions that directly target the chemical structure of the precursor compound(s) which has a characteristic absorption to UV radiation and to IR radiation. This method of irradiating the precursor allows for the precursor to be heated and thermally mobilized without being in direct contact with a heater, wick, or heater substrate such as a porous or non-porous ceramic. UV radiation targeted at pi electrons causes the pi electrons to enter a higher energy orbital which effectively allows for more space for the molecule to vibrate, and IR radiation (also referred to as thermal radiation) excites molecular vibrations of the precursor molecules, increasing the kinetic energy of the molecules, which causes an increase in temperature that facilitates thermal mobilization of the precursor liquid and/or precursor compound. This method uses the UV radiation to excite pi (also denoted as π) electrons present in the active compound present in the precursor liquid and/or precursor compound(s) and/or the inactive constituents of the precursor liquid such as propylene glycol (PG) and/or vegetable glycerin (VG) and/or combinations/mixtures of PG and VG, which may also contain water, and may also contain an acid or acids. Molecules with conjugated pi systems (double bonds and triple bonds) absorb UV radiation at specific wavelengths. The UV energy absorbed promotes electrons from bonding pi orbitals to antibonding pi* orbitals. Moving a pi electron to a higher antibonding orbital (also denoted as π*) weakens the pi bond, increasing the possibility of molecular vibrations by destabilizing the bond and allowing for greater atomic movement. In a pi bond, p-orbitals on adjacent atoms overlap sideways, creating two regions of high electron density above and below the internuclear axis. This overlap results in two molecular orbitals: a bonding pi orbital (lower energy) and an antibonding pi* orbital (higher energy). When a pi electron is excited to the π* orbital, it moves into a region where the electron density is reduced between the nuclei, leading to repulsion and weakening of the bond. The weakened bond allows for greater atomic movement and increased vibrational energy. The molecule can now vibrate more easily, as the bond is less strong and the atoms have more freedom to move. When the molecules are then also simultaneously or subsequently heated using IR radiation, the molecules have more room to vibrate and are resultantly able to be heated more efficiently by IR radiation.

The heating method utilizes the emission of UV radiation in order to excite the pi electrons to a higher energy antibonding pi* orbitals as described previously in conjunction with resonate and non-resonate IR radiation to increase the vibrational energy level of the precursor liquid and/or compound. IR radiation heats precursor molecules by causing them to vibrate more vigorously, effectively increasing their kinetic energy, which translates as heat. This process occurs when the energy of the infrared photons matches the energy of a specific molecular vibration within the precursor, causing the precursor molecules to absorb the radiation and start oscillating. IR radiation (also known as thermal radiation) at specific emitted wavelength(s) has the wavelength(s) of energy required to excite precursor molecules into higher vibrational energy levels. When a precursor molecule absorbs an infrared photon, it is excited to a higher vibrational state, causing its atoms to vibrate with greater amplitude and/or higher frequency (i.e., increasing oscillation). The increased vibrational energy translates to a higher kinetic energy for the precursor molecules, meaning the precursor molecules move faster and with more force. The increased kinetic energy of the precursor molecules leads to a rise in the temperature of the precursor liquid and/or precursor compound. Effectively IR radiation heats the precursor molecules by irradiating the molecules with the energy required to increase their vibrational state, which in turn increases their kinetic energy and the temperature of the precursor liquid and/or precursor compound to effect the phase transition of the precursor liquid and/or precursor compound to a vapor for subsequent mixing with air to form an inhalable aerosol for delivery and/or deposition into the deep lung.

The precursor liquid may be comprised of carrier fluid and/or carrier fluids that facilitate the generation of an inhalation aerosol and/or vapor where the active compound of the precursor is Nicotine. Nicotine (also known as 3-(1-methyl-2-pyrrolidinyl)pyridine)) being present as the active agent in the precursor. Nicotine's structure is characterized by two nitrogen-containing rings: a pyridine ring and a pyrrolidine ring. It is a chiral molecule, meaning it exists in two mirror-image forms, (S)-nicotine and (R)-nicotine. (S)-nicotine is the predominant form found naturally in tobacco and is responsible for nicotine's effects. A nicotine molecule (C₁₀H₁₄N₂) has 3 double bonds, contributing 6 pi electrons. Additionally, the pyridine ring within nicotine contributes to a 6 pi-electron system. Protonated nicotine may also be utilized as the active compound present in the precursor liquid. Both non-protonated and protonated nicotine molecules contain pi electrons within double bonds and within the aromatic ring structure. In protonated nicotine, the pi electrons in the pyridine ring remain largely intact, while the pi electrons in the pyrrolidine ring can be influenced by the protonation. Protonation typically occurs at the pyrrolidine nitrogen, and the electron configuration of the pi electrons in the pyridine ring is not significantly altered. Nicotine has two nitrogen atoms, one in a pyridine ring and one in a pyrrolidine ring. Protonation typically occurs at the pyrrolidine nitrogen, which is more basic. The pi electrons in the pyridine ring are still involved in resonance and delocalization, and their configuration doesn't change significantly upon protonation. The protonation of the pyrrolidine nitrogen alters the electron environment of the ring, potentially affecting the distribution of pi electrons. Nicotine can be mono-protonated or di-protinated, in either form the pyridine ring and pyrrolidine ring remain intact with the protonation site being the nitrogen molecule present in the respective ring structure.

Nicotine pi bonds occur at the double bond which is composed of one sigma bond and one pi bond. Since nicotine has three double bonds, it has 3 pi bonds, and each pi bond contributes two pi electrons, resulting in a total of 6 pi electrons from the double bonds. Furthermore, nicotine contains an aromatic ring, the pyridine ring in nicotine is a six-membered ring with alternating single and double bonds. This structure contributes to a 6 pi-electron system where the pi electrons are delocalized throughout the ring, making it aromatic. In total, a nicotine molecule has 6 pi electrons from the double bonds and 6 pi electrons from the aromatic ring, for a total of 12 pi electrons. This makes nicotine a pi electron rich molecule in which the pi electrons can absorb UV energy and be excited into a higher energy level orbital. In an embodiment intended to be used with a precursor liquid containing nicotine that may either protonated and/or non-protonated, the UV emitter present as part of a combined IR and UV heating system has a UV emitter with an emission range of 210-360 nm, with primary emission in the 250-260 nm range and peak emission at 254 nm. In an embodiment intended to be used with a precursor liquid containing nicotine that may either be protonated and/or non-protonated, the UV emitter present as part of a combined heater system where the UV heating system has a UV emitter with an emission range of 210-360 nm, with primary emission in the 250-260 nm range and peak emission at 254 nm. In an embodiment intended to be used with a precursor liquid containing nicotine that may either be protonated and/or non-protonated the UV emitter present has an emission range of 210-360 nm, with primary emission in the 250-260 nm range and peak emission at 254 nm.

Precursor liquids and/or precursor compounds where nicotine that may be protonated or non-protonated or a combination of protonated and non-protonated is the active compound are often composed of a mixture of propylene glycol (PG), vegetable glycerol (VG), water, and in some instances an acid. IR emission in the combined IR and UV heating system targets the covalent bonds in these compounds with IR radiation, and the pi electrons in these compounds with UV radiation. IR and UV emissions can be tuned to match the unique absorption characteristic of different precursor formulations and/or precursor compound formulations and/or mixtures that have differing ratios of aforementioned constituents.

Some precursor liquids, in some embodiments, may contain an acid, such as but not limited to, benzoic acid, levulinic acid, or lactic acid, where the addition of an acid in a precursor liquid containing nicotine functions to protonate the nicotine forming a nicotine salt. Furthermore, the presence of an acid, such as for example, benzoic acid functions to lower the pH of the precursor solution.

In some embodiments lowering the pH of the precursor liquid functions to increase absorption of IR and/or UV radiation. For example, protonation of nicotine alters the UV absorption characteristic of the nicotine present in a precursor fluid as nicotine undergoes significant conformational changes at lower pH due to protonation. Nicotine is a weak base with two nitrogen atoms, each of which can accept a proton. This protonation significantly alters the molecule's charge and shape, affecting its electronic properties and the wavelengths of UV radiation that it absorbs. Nicotine's conformational changes when protonated are due to nicotine having two ionizable nitrogens, one in a pyridine ring and one in a pyrrolidine ring, with two distinct pKa values. The protonation state of these nitrogens changes as the pH is lowered, causing conformational shifts increasing the UV absorption. At neutral to slightly acidic pH, with pKa values around 8.0 (pyrrolidine) and 3.0 (pyridine), the pyrrolidine nitrogen is the first to be protonated as the pH decreases. This process converts the uncharged, neutral nicotine into a single positively charged, or monoprotonated, form (NicH₊). At lower pH (highly acidic conditions), the pyridine nitrogen, having a lower pKa, becomes protonated as the pH drops further. This results in a dicationic form (NicH₂₂₊) where both nitrogen atoms are positively charged. This also affects the stereoisomerism of nicotine as the addition of protons significantly alters nicotine's energy landscape, causing different molecular shapes (stereoisomers) to become dominant as protonation affects the rotation around the carbon-carbon bond linking the two rings. It also alters the stereochemistry of the N-methyl group on the pyrrolidine ring, which becomes a chiral center upon protonation.

Protonated nicotine has different UV absorption properties than non-protonated nicotine (also called free-base nicotine), with the absorption band associated with a n-π* transition on the pyridyl ring disappearing upon protonation. Conversely, the π-π* transition of the protonated pyridyl moiety increases significantly, similar to the UV absorption of pyridine itself. Protonated nicotine's UV absorption is also affected by its two possible protonation sites, the more basic pyrrolidine nitrogen or the less basic pyridine nitrogen, with the former being dominant at physiological pH. Key characteristics of protonated nicotine's UV absorption disappearance of n-π* transition: the positive Cotton effect associated with the n-π* transition, which results in UV absorption at 235-243 nm in neutral nicotine, vanishes when the pyridyl moiety is protonated. Increased π-π* transition absorption: the absorption of the π-π* transition on the pyridyl ring increases substantially upon protonation, a characteristic shared with pyridine itself. Protonation of the pyrrolidine ring causes a significant increase in the intensity of the π-π* transition associated with the pyridine ring, which absorbs UV radiation around 260 nm. The primary absorption region shifts to a longer wavelength (a bathochromic shift). The protonation site, and thus the UV absorption, depends on the pH of the precursor liquid. A precursor liquid with a physiological pH (~7.4), nicotine exists primarily as the protonated form on the pyrrolidine ring (Pyrro-NIC-H+), while at acidic pH, the pyridine ring also becomes protonated.

Protonating the nicotine results in enhanced UV absorption at the resulting lower pH. The increased UV absorption is associated with the π-π* transition which increases at acidic pH when the pyridyl moiety is protonated, resembling the UV absorption of pyridine. These electronic transitions in protonated nicotine alter the UV absorption wavelength to a range of 180-300 nm. In an embodiment, the precursor liquid contains a protonated nicotine, either in a mono-protonated or diprotonated or a mixture of mono-protonated and di-protonated nicotine and the UV emitter or emitters either solely or as a part of a combined heating system (e.g. in conjunction with an IR emitter or emitters) has an emission range of 180-300 nm and peak emissions at 260 nm. It should be understood that although the protonation of nicotine is described in detail that the addition of an acid to a precursor liquid may also be utilized in precursor liquid and/or precursor compound formulations that do not contain nicotine, such as precursor formulations that contain cannabinoids, or precursor liquid and/or precursor compound formulations that contain an active agent and/or active agents other than nicotine.

Precursor liquids can commonly be comprised of a mixture where the main component by volume is propylene glycol (PG, also known as propane-1,2-diol). PG chemical structure facilitates heating by IR radiation as it is a chain of three carbon atoms, with two hydroxyl (—OH) groups attached. These bonds between carbon, hydrogen, and oxygen atoms are all covalent. PG exhibits distinct IR absorption bands primarily in the regions around 3700-3000 cm⁻¹ and 1700-700 cm⁻¹. The band around 3700-3000 cm⁻¹ is due to O—H stretching vibrations, while bands in the 3000-2800 cm⁻¹ region are attributed to C—H stretching vibrations. The wide band at 3700-3000 cm⁻¹ corresponds to the vibration of hydroxyl (O—H) groups, including those involved in free, intermolecular, and intramolecular hydrogen bonding. The absorption between 3000 and 2800 cm⁻¹ are associated with the stretching of carbon-hydrogen (C—H) bonds within the propylene glycol molecule. In an embodiment the IR emitter targets the IR absorption of the hydroxyl groups and carbon-hydrogen bonding and uses an IR emitter with broad emission in the 3700-2800 cm⁻¹ range for the heating of PG sufficiently to cause a phase change from a liquid to a vapor. In an embodiment the IR emitter targets the IR absorption of the hydroxyl region and carbon-hydrogen region and uses an IR emitter with broad emission in the 3700-2800 cm⁻¹ range and a secondary band of emission in the 1700-700 cm⁻¹ range for the heating of PG sufficiently to cause a phase change from a liquid to a vapor.

Precursor liquids can commonly be comprised of a mixture where the main component by volume is vegetable glycerol (VG, also known as glycerol, and propane-1,2,3-triol, also referred to commonly as glycerin), which exhibits several characteristic IR absorption bands, primarily due to the C—H bonds and C—O bonds within its structure. Key IR abortion wavelengths include those associated with C—H stretching vibrations, around 2900 cm⁻¹, and C—O stretching vibrations, around 1000-1200 cm⁻¹. IR heating of VG occurs because of the effects on the C—H bonds in VG's methylene (—CH₂—) and methyl (—CH₃) groups that exhibit absorption bands in the region around 2900 cm⁻¹. Specifically, the asymmetric and symmetric C—H stretching vibrations contribute to these bands. Furthermore, the C—O bonds in VG's alcohol groups (CH₂OH and CHOH) contribute to absorption bands in the region around 1000-1200 cm⁻¹. These bands can be further distinguished by the specific C—O bonds involved (C—O in CH₂OH vs. C—O in CHOH). There is also absorption related to the CH₂ group that exhibits bending vibrations, which can appear as a shoulder on the C—H stretching band or in the lower wavenumber region. In an embodiment, the IR emitter targets the IR absorption of the carbon-hydrogen bonds and uses is an IR emitter with broad emission in the 2500-3000 cm⁻¹ range with peak emission in the 2900 cm⁻¹ range for the heating of VG sufficiently to cause a phase change from a liquid to a vapor. In an embodiment the IR emitter targets the IR absorption of the hydroxyl and carbon-hydrogen uses is an IR emitter with broad emission in the 2500-3000 cm⁻¹ range with peak emission in the 2900 cm⁻¹ range and a second band of emission in the 1000-1200 cm⁻¹ range for the heating of VG sufficiently to cause a phase change from a liquid to a vapor.

Prior examples of embodiments containing IR emitters constructed to emit specific emission ranges relevant to the heating of PG or VG are relevant if the carrier fluid is composed of either PG or VG, however it should be recognized that the carrier fluid may be a mix of PG and VG, and the carrier fluids that contain PG or VG or PG and VG may also contain water. When the carrier fluid contains both PG and VG it is desirable to have an IR emitter that is constructed to emit the relevant wavelengths of IR radiation to target the relevant IR absorption regions of both PG and VG. In an embodiment, an IR emitter has emission ranges of 700-1700 cm⁻¹, and 2500-3700 cm⁻¹ with a peak emission at 2900 cm⁻¹ for the heating of a mixture of PG and VG present in a precursor liquid. In an embodiment with a combined IR and UV heating system, the IR emitter may have emission ranges of 700-1700 cm⁻¹, and 2500-3700 cm⁻¹ with a peak emission at 2900 cm⁻¹, and a UV emitter with an emission range of 210-360 nm, with primary emission in the 250-260 nm range and peak emission at 254 nm.

Precursor liquids composed of PG or VG, and PG and VG mixtures can commonly contain water as a part of the formulation. Water's IR absorption is dominated by the intense O—H stretching and bending vibrations, resulting in broad absorption bands due to the extensive hydrogen bonding network in liquid form. This absorption occurs over a wide range of the electromagnetic spectrum including near-infrared (near-IR), mid-infrared (mid-IR), and far-infrared (far-IR), thus the addition of water to precursor fluids facilitates the IR heating of such precursor mixtures as water is highly absorptive of IR over a broad range of wavelengths. Water's IR absorption is primarily driven by hydrogen bonding: where the strong absorption of IR radiation is due to the dynamic nature of the hydrogen bond network in water, which constantly breaks and reforms, affecting the O—H bonds. Far-IR Absorption is due to rotational transitions and intermolecular vibrations. Mid-IR: the fundamental O—H stretching and bending vibrations cause IR absorption particularly around 3450 cm⁻¹, 3615 cm⁻¹, and 1640 cm⁻¹. Near-IR, R absorption occurs from overtones of the O—H stretching and combinations of stretching and bending modes, with absorption around wavelengths of 1450 nm and 1940 nm. Increasing water temperature during heating of the precursor liquid can affect the intensity and position of these absorption bands, shifting them to slightly shorter wavelengths. PG and VG are both non-ionic kosmotropes that form strong hydrogen bonds with water molecules, competing with water-water hydrogen bonds. Water and PG, or water and VG, or water and a mixture of PG and VG form an extensive hydrogen-bonding network. VG with three hydroxyl groups, and PG with two hydroxyl groups can form multiple hydrogen bonds with water molecules, leading to distinct absorption features. IR absorption of water is also temperature dependent, as temperature increases during heating, the absorption peak of water shifts to shorter wavelengths (also called a blue-shift). As the water is heated to a vapor the IR absorption characteristic changes as water vapor has strong infrared absorption in several different wavelength ranges, with prominent absorption at 2500 cm⁻¹, 1300 cm⁻¹, and 400 cm⁻¹. The change in IR absorption in such mixtures is concentration dependence as the ratio of PG or VG, or PG and VG to water influences the overall absorption spectrum. At different PG or VG, or PG and VG concentrations, the resulting absorption coefficients and vibrational dynamics differ.

As liquid precursor may be comprised of various ratios of PG or VG to water, or PG and VG to water, it should be understood that in some embodiments the IR emitter or plurality of IR emitters used to heat the precursor liquid may be adjusted to emit frequencies of IR radiation matched to the specific IR absorbance ranges of a specific mixture of PG or VG and water, or PG and VG and water. In an embodiment, where water is present in the precursor liquid and PG and VG are not present an IR emitter or plurality of emitters functioning as heaters in order to effect a phase change from water from a liquid phase to a vapor phase for the formation of an inhalation vapor and/or aerosol the IR emitter may have broad emission of mid-IR radiation from 1600-3650 cm⁻¹ and additional emissions in near-IR of 1400-2000 nm. In an embodiment where water is present in the precursor liquid and PG and VG are not present, an IR emitter or plurality of emitters functioning as heaters in order to effect a phase change from water from a liquid phase to a vapor phase for the formation of an inhalation vapor and/or aerosol the IR emitter may have emission of mid-IR radiation with peak emissions at 3450 cm⁻¹, 3615 cm⁻¹, and 1640 cm⁻¹, and additional emissions in near-IR with peak emissions at 1450 nm and 1940 nm.

In an embodiment where water is present in the precursor liquid, the IR emitter or plurality of emitters may alter the emissions of IR from longer wavelengths to shorter wavelengths of IR radiation during an activation cycle to match the IR absorbance of water as it phase transitions from a liquid to a vapor, such that, for example, at the beginning of a activation cycle the emitter has emissions at 3450 cm⁻¹, 3615 cm⁻¹, and 1640 cm⁻¹ and then as the precursor liquid containing water transitions to a vapor phase the emitter has emissions of 2500 cm⁻¹, 1300 cm⁻¹, and 400 cm⁻¹. In some embodiments, the IR emitter or a plurality of IR emitters is combined with a UV emitter or plurality of UV emitters, where the UV emitter has one or more emission ranges and the range of emission may be targeted at the heating of water through the absorption of UV radiation by the water present in the precursor. For example, the UV emitter or plurality of emitters may have an emission range of 10-180 nm. It should be understood that the description of IR and UV emissions is intended to serve as examples of emissions that may be used in some embodiments and that there are additional ranges of emission of both IR and UV that may be used depending on the specific formulation and/or composition of the precursor liquid being used.

The precursor liquid may or may not be comprised of carrier fluid and/or carrier fluids that facilitate the generation of an inhalation aerosol and/or vapor where the active compound of the precursor is a cannabinoid or cannabinoids. Where cannabinoids have pi (π) electrons because their structures contain double bonds and aromatic rings. A double bond is made of a sigma (σ) bond and a pi (π) bond, where the pi bond involves the sideways overlap of p-orbitals. Cannabinoids are a group of closely related compounds which include the active constituents of cannabis, examples of cannabinoids containing pi electrons that may be heated using pi electron excitation in isolation, or in combination with IR radiation, or UV radiation and another source of thermal energy such as a joule heater, include but are not limited to: Tetrahydrocannabinol (THC), the most prominent isomer being delta-9-THC (Δ9-THC), which has one double bond on a carbon ring. This double bond is formed by a pi (π) bond on top of a sigma (σ) bond, and the two electrons that make up the pi bond are pi electrons. Other isomers, such as delta-8-THC (Δ8-THC), have the double bond in a different position, but they still contain pi electrons. THC's molecular structure includes an aromatic benzene ring, which is a stable, six-carbon ring with delocalized pi electrons, where instead of being confined to specific double bonds, the pi electrons in this ring are spread out in a “donut” shape above and below the plane of the carbon atoms, making the ring highly stable. This structure of THC is a conjugated system where the double bond on the non-aromatic ring of THC is in conjugation with the delocalized pi system of the adjacent aromatic ring. This conjugated system allows the electrons to spread out further through resonance, influencing the molecule's overall stability and reactivity. Another relevant cannabinoid is cannabidiol (CBD) that also has pi (π) electrons. These are found in its two distinct pi bond systems, the aromatic benzene ring and the carbon-carbon double bond in its cyclohexene ring. The benzene-like phenolic ring in CBD is aromatic, meaning it has a delocalized system of pi electrons. The ring has three double bonds that share six pi electrons among the six carbon atoms. This delocalized pi system contributes to the molecule's stability. In addition to the aromatic ring, CBD also has a cyclohexene ring, which contains one localized carbon-carbon double bond. This single double bond contributes an additional two pi electrons to the overall molecule. A final example of a cannabinoid with pi electrons is cannabinol (CBN). CBN has a fully aromatic structure, which is an example of a conjugated system with delocalized pi electrons. The structure of CBN includes two fused benzene-like rings. Each of these aromatic rings contains a conjugated system of six carbon atoms and three double bonds. There are also delocalized electrons, where the pi electrons in these rings are not confined to a specific atom or bond, instead, they are delocalized across the entire ring structure, making the rings highly stable.

THC, in both the delta-9-THC and delta-9-THC absorbs UV radiation most strongly at wavelengths around 209 nm and 279 nm. As well as significant absorption across a broad range of UV radiation, from approximately 200 to 350 nm. Cannabidiol (CBD) shows two primary UV radiation absorption regions, with one peak at 207-220 nm and another at 275-280 nm. Cannabinol (CBN) absorbs UV radiation at two primary regions, 218 nm and 283 nm. In an embodiment intended to be used with a THC precursor liquid and/or precursor compound, the UV emitter present as part of a combined IR and UV heating system may have a UV emitter with an emission range of 200-350 nm and peak emissions at 205-215 nm and 275-285 nm. In an embodiment intended to be used with a precursor liquid and/or precursor compound containing CBD, the UV emitter present as part of a combined heater system where the UV heating system may have a UV emitter with emission ranges of 200-220 nm, with secondary emission in the 270-290 nm range. In an embodiment intended to be used with a CBN precursor liquid and/or compound, the UV emitter present may have two emission ranges with the first being 215-220 nm and the second emission being at 280-285 nm. In an embodiment intended to be used with aTHC and/or CBD and/or CBN precursor liquid and/or compound, the UV emitter present may have first a broad emission range of 200-350 nm, and peak emissions at 200-220 nm, and 270-285 nm. In an embodiment, the UV emitter may be used as a stand-alone heater for use with precursor liquids and/or compounds containing THC, and/or CBD, and/or CBN where the emission ranges of UV radiation are the same as those referenced herein as they relate to the specific constituents of the precursor liquid and/or precursor compound (e.g. THC, CBD, and CBN or mixtures thereof).

Other factors such as molecular conformation may change the absorption range of THC as the spatial arrangement of THC's structure can influence the UV absorption. Different conformers, especially those stabilized by hydrogen bonds, produce distinct UV absorption ranges. Therefore the description of the absorption ranges of cannabinoids including those described for THC, CBD, and CBN to UV radiation contained herein are intended to describe some of the relevant UV wavelengths that may be utilized to heat cannabinoids utilizing targeted wavelength UV radiation but should not be considered an exhaustive description and other wavelengths of UV radiation may be used depending on the actual UV absorption characteristic of the cannabinoid(s) present in a precursor liquid and/or precursor compound. This is relevant to constructing a heater comprised of a UV emitter or plurality of UV emitters as in some embodiments the precursor liquid and/or compound containing cannabinoids the cannabinoids may be an isolated cannabinoid, or a combination of cannabinoids, with or without the presence of additional components of the precursor liquid, such as PG, VG, or a mixture of PG and VG, as well as additional components such as water, and/or constituents used for the protonation of a the precursor liquid such as an acid, for example benzoic acid.

Conformational changes in cannabinoids resulting from hydrogen bonding can affect their UV absorption. Hydrogen bonding modifies the molecule's electronic structure, which, in turn, changes the energy gap between its electronic orbitals and shifts the wavelength of UV radiation it absorbs. Hydrogen bonding affects UV absorption by altering the electronic environment as the formation of a hydrogen bond redistributes the electron density within a molecule. This changes the energy levels of the molecular orbitals, particularly the Highest Occupied Molecular Orbital (HOMO) and the Lowest Unoccupied Molecular Orbital (LUMO). Influences the HOMO-LUMO energy gap effect UV absorption as UV absorption occurs when a molecule absorbs a photon and an electron is promoted from the HOMO to the LUMO. The exact energy difference between these orbitals determines the specific wavelength of UV radiation absorbed. Such conformational changes cause a spectral shift of the UV wavelength absorption as the hydrogen bonding changes the HOMO-LUMO energy gap which causes a shift in the UV absorption spectrum. These shifts can be defined as a red shift (bathochromic shift), where the shift is to a longer wavelength (lower energy) that occurs if the hydrogen bond stabilizes the excited state more than the ground state, thereby decreasing the HOMO-LUMO energy gap. Where blue shift (hypsochromic shift) is a shift to a shorter wavelength (higher energy) that occurs if the hydrogen bond destabilizes the excited state, increasing the HOMO-LUMO energy gap. Either a red shift or a blue shift affects UV absorption intensity as the hydrogen bonding can also change the intensity of absorption, depending on how it affects the molecular structure and electronic transitions. This applies to cannabinoids, such as CBD for example, as cannabinoids such as CBD are highly susceptible to these types of conformational changes as they possess hydroxyl (—OH) groups that can form hydrogen bonds. These hydrogen bonds can be intramolecular hydrogen bonds which form within the same molecule, locking it into a specific, more rigid conformation. These hydroxyl groups can also interact with pi (π) electrons such that there is also a intramolecular O—H·π electron interaction, which influences the molecule's spatial arrangement and rigidity and can affect its UV absorption characteristics.

Intermolecular hydrogen bonds may form between two or more cannabinoid molecules or between a cannabinoid and a solvent molecule such as may be present in a liquid precursor. This type of intermolecular hydrogen bonding can significantly alter spectral properties. For example, if the precursor liquid contains an acid as a component, and/or water it may function as protic solvent (which can form hydrogen bonds) with the cannabinoid(s) present in the precursor liquid, which can alter the UV absorption of the cannabinoid and/or precursor liquid compared to a precursor liquid that does not contain an acid, and/or water which would function as a non-protic solvent. It should be understood that the precursor liquid and/or compound may contain additional constituents that affect the UV absorption of the precursor liquid and that the emission ranges may be adjusted to match the absorbance characteristics of a specific precursor formulation and/or mixture. It should be understood that the HOMO-LUMO energy gap described herein as it relates to the heating of CBN by UV radiation, and may influence the selection of particular wavelengths of UV radiation used to heat precursor liquids and/or precursor compounds, also applies to the heating of other compounds by UV energy, such as other cannabinoids, nicotine, and other constituents of precursor liquids such as propylene glycol, vegetable glycerol, water, and acids such as benzoic acid, levulinic acid, and lactic acid. It should also be understood that red-shifting and blue-shifting that was described herein as it relates to the HOMO-LUMO energy gap is also relevant for the absorption of IR radiation and determination of IR radiation wavelengths to be used to heat precursor liquids and/or compounds, and is not solely related to the use of UV radiation for heating.

The UV emitter or plurality of emitters used to construct a UV heater either as an individual heater or as part of a combined heater system may be constructed from a single type of UV emitter, or from different types of UV emitters in order to achieve the desired output of UV radiation in terms of emitted wavelength and/or emission discharge intensity. The emitter or plurality of emitters may be non-coherent emitters, and/or coherent emitters. The UV emitter and/or emitters may be constructed into a heater system that incorporates a UV filter or filters in order to isolate the desired wavelengths of emitted UV. The UV emitter and/or emitters may be constructed into a heater system that incorporates a lens or lenses to focus the UV emissions. The UV emitter and/or emitters may be constructed into a heater system that incorporates both a UV filter or UV filters and a lens or lenses in a combined system intended to both filter out undesirable wavelengths of UV radiation and focus the remaining desirable UV radiation. The UV emitter and/or emitters may be constructed into a heater system that incorporates a combined UV filter and lens system, where a single component functions as a lens and a UV filter.

Multiple types of UV emitters may be used for the embodiments disclosed herein, including but not limited to, miniature UV light emitting diodes (LEDs), which are compact, energy-efficient, and long-lasting solid-state UV radiation sources that come in a variety of package styles that can be used individually or combined in a plurality of emitters or emitter array depending on the desired emission wavelength and/or emission intensity. Examples include, but are not limited to, UV-A LEDs that have emission wavelengths from 315-400 nm, UV-B, and UV-C LEDs, where UV-B LEDs emit wavelengths from 280-315 nm, and UV-C LEDs emit wavelengths from 100-280 nm. These types of emitters are available in various forms that are suitable for the construction of a UV emitter or UV emitter array heater as disclosed herein, including, but not limited to, through-hole, surface-mount (SMD), and chip-on-board (COB) packages. Another suitable type of UV LED is the deep-UV LEDs for deep UV light (e.g., 100-300 nm) and are a compact and low-cost alternative to lasers. Non-LED options include, but are not limited to, miniature UV gas-discharge lamps that produce UV radiation through a gas-discharge process, offering different spectral characteristics than LEDs. Additionally, there are miniature mercury lamps that can produce both shortwave (254 nm) and longwave (365 nm) UV, and also have dual-wavelength models that allow switching between longwave and shortwave UV. There are also small-scale deuterium arc lamps, and xenon lamps that can provide broad-spectrum UV in extremely compact emitters. There are also miniature excimer lamps which are high efficiency and high intensity and operate at different UV wavelength bands, including into the vacuum ultraviolet range. Additionally, the extreme UV (EUV) sources such as the electrodeless Z-Pinch, which is a type of plasma device that uses an inductively coupled magnetic field to create a Z-pinch, where a plasma is compressed and heated to generate ultrashort-wavelength UV (10-50 nm).

Additional options for suitable UV emitters include UV lasers-particularly miniature UV lasers that primarily use solid-state technology. The two most common types being diode-pumped solid-state (DPSS) lasers and microchip lasers. Their compactness is achieved through the use of solid gain mediums and frequency conversion to reach UV wavelengths. One type being the Diode-pumped solid-state (DPSS) UV lasers, DPSS lasers use laser diodes to pump a solid crystal, which creates a near-infrared (IR) laser beam. This beam then passes through a series of nonlinear crystals to convert it into UV light. The two most common types of frequency conversion are the second-harmonic generation (SHG) where a single nonlinear crystal is used to cut the wavelength in half, turning a laser from green to UV. The other common type is a third-harmonic generation (THG), where a beam is passed through two crystals to reduce its wavelength by a factor of three, often converting a standard 1064 nm beam into a 355 nm UV beam. These types of UV lasers use diodes instead of traditional lamps which allows for a smaller, more integrated system that has high efficiency and reliability that is suitable for incorporation into a hand-held portable device. Another advantage is that DPSS lasers have a longer lifespan and require less maintenance compared to gas-based UV lasers, and DPSS technology provides excellent beam quality and stability for sensitive applications such as a wavelength specific UV heater.

Another option that may be used for constructing a suitable UV emitter is a microchip UV laser which is a particularly miniature type of DPSS laser where all components are integrated into a single unit. This technology uses a tiny, passively Q-switched solid-state laser crystal with the mirrors directly coated onto the crystal's end faces. This design results in an extremely compact, rugged, and low-cost. The all-in-one design makes them ideal for portable, handheld, devices such as a personal vaporization device intended for use in forming an inhalation aerosol. The microchip UV lasers generate high peak power in short pulses by producing very short, sub-nanosecond pulses with high peak power, which is advantageous for use as a UV emitter functioning as a heater. Furthermore, the integrated monolithic structure is resistant to alignment issues and suitable for use in harsh environments such as those that a personal portable electronic device may be exposed to. It should be understood that these examples provided of UV radiation emitters may be used individually or in combination to achieve the desired UV emissions in terms of wavelength and intensity. Additionally, it should be understood that these examples do not represent an exhaustive list of possible emitter types and/or technologies that may be used to construct a UV emitter or UV emitter array for the embodiments described herein. The specific type of UV emitter or emitters selected to construct a UV heater either as a standalone heat source or combined with another heater type may be determined by a variety of factors, including, but not limited to, design requirements, precursor liquid and/or precursor compound formulation and/or precursor constituents, material selection, manufacturing methods, and economic considerations.

A heater comprised of a UV emitter, either as an individual UV emitter or a plurality of UV emitters, that is constructed to radiate a specific wavelength or wavelengths of UV radiation may be constructed or controlled such that the UV emitter or emitters is tuned to specific precursor liquid UV absorptance characteristics, where such UV absorbance characteristics are validated by direct measurement. For example, the precursor liquid could be analytically quantified for the precursor liquid's UV absorption characteristic using a method such as UV-Visible (UV-Vis) spectroscopy. This analytical technique measures how much ultraviolet (UV) and visible light, and which is absorbed by precursor liquid samples, and what wavelength or wavelengths of UV radiation are absorbed by the precursor liquid. Furthermore, the precursor liquid could be analytically quantified for the precursor liquid's UV absorption characteristic over a range of temperatures using a method such as UV-Visible (UV-Vis) spectroscopy such that the absorbance characteristics of the precursor liquid and/or precursor compound when heated from ambient to temperature required to phase change the precursor into a vapor are quantified. In an embodiment, the UV emitter or plurality of UV emitters functioning as a heater or as part of a combined heater system is tuned to emit UV radiation at a wavelength or wavelengths that match the UV absorption characteristics of a precursor liquid that has been measured by UV-Vis spectroscopy. In an embodiment the UV emitter or plurality of UV emitters functioning as a heater or as part of a combined heater system is tuned to emit UV radiation at a wavelength or wavelengths that match or approximate the UV absorption characteristics of a precursor liquid over a range of temperatures used to heat the precursor liquid in order to effect a phase change from a liquid to a vapor, that has been measured by UV-Vis spectroscopy.

In some embodiments, a miniature UV detector may be incorporated into the reservoir system of the device, or into a controller and/or control unit coupled to the reservoir, such that the UV emitter or emitters may radiate the precursor liquid and a UV sensor and/or detector may be radiated by the UV emissions once the emission have passed through the precursor liquid, in order to measure the UV absorbance characteristics of the precursor liquid. There are several types of UV detectors and/or sensors that may be incorporated into such an embodiment, including but not limited to, solid state type detectors, and miniaturized optical type detectors.

Miniature UV detectors generally fall into two main categories: solid-state semiconductor devices and compact versions of larger optical instruments. Solid-state detectors, particularly those using wide-bandgap semiconductors, are the most common and versatile for miniaturization. Solid-state semiconductor detectors use a semiconductor material that generates an electrical signal when struck by a UV photon with higher energy than the material's bandgap. These detectors are routinely constructed to have compact size, low power consumption, and robustness.

Another type of UV detector that may be used are photoconductive detectors (photoconductors) where, when exposed to UV radiation, the detector material's electrical conductivity increases generating a measurable signal for determining the wavelength or wavelengths of the UV radiation. Photoconductive detectors can be manufactured to be small, simple, and can be made from various wide-bandgap materials like zinc oxide (ZnO) nanowires, making them simple to manufacture with high internal gain. Additionally, photovoltaic detectors (photodiodes) may be utilized, these detectors operate in photovoltaic mode, generating a current at zero bias when illuminated, or can be operated with a reverse bias.

There are also suitable diode type UV detectors, such as p-n junction photodiodes, which are a simple diode structure where electron-hole pairs are created in the depletion region and swept to the terminals by the built-in electric field. Similarly, there are also suitable p-i-n photodiode UV detectors, which are an improved version with an intrinsic layer (“i”) between the p- and n-type layers. The wider depletion region of the intrinsic layer improves response speed and quantum efficiency. Other diode type UV detectors may also be utilized such as Schottky barrier photodiodes, which are constructed such that a metal-semiconductor junction forms a rectifying barrier. The UV radiation must pass through a semi-transparent metal layer to reach the semiconductor. This is similar to another type of UV diode detector, the metal-semiconductor-metal (MSM) photodiodes, where there are two back-to-back Schottky barriers are formed by interdigitated electrodes on a single layer of semiconductor material, which results is this type of diode detector having low capacitance and fast response times. Additionally, there are avalanche photodiodes (APD) UV detectors which operate under high reverse bias, causing a cascade effect of internal electron multiplication, resulting in very high sensitivity. These types of diode-based UV detectors and/or solid state detectors may be constructed using common UV-sensitive materials. Materials suitable for the construction of these types of UV detectors include, but are not limited to, silicon carbide (SiC) for robust, high-temperature applications, and aluminum gallium nitride (AlGaN) for tunable deep-UV detection.

Another general class of UV detectors that could be used are compact spectroscopic detectors, which are miniature versions of laboratory-grade instruments and are used for an embodiment or embodiments requiring more detailed spectral analysis rather than just intensity measurement. In such embodiments, a miniature spectrometer may be incorporated. These devices use a diffraction grating to split incoming UV radiation into its constituent wavelengths and use a miniature diode array, like a CMOS or CCD sensor to measure the intensity of each wavelength. This type of spectrometer may be preferable and advances in optics and electronics have led to highly compact, handheld, and even on-chip versions suitable for portable applications such as a handheld vaporization device and/or handheld aerosol generator for the purpose of delivering compounds to the deep lung through inhalation. These types of spectrometers provide high spectral resolution, enabling precise analysis of a liquid precursor's UV absorption properties. These have the additional benefit that some versions offer broad spectral coverage from UV to near IR (NIR) wavelengths, which would be suitable for use in an embodiment that has a combined heater and/or emitter system that utilized both UV and IR radiation.

There are also suitable diode-based detectors that offer good spectral resolution in the UV emission range that may be desirable to incorporate such as diode array detectors (DAD) and photodiode array (PDA) detectors. When using these detectors, the liquid precursor may be illuminated with the UV emitter, which may be a broad-spectrum emitter, and an array of photodiodes simultaneously measures the absorption across a range of wavelengths. Having a photodiode array makes these diode-based detectors well-suited for smaller, more integrated systems, such as miniature detectors suitable for the applications described herein of measuring a liquid precursor sample, as these detector types are excellent for high-speed analysis and provide the entire UV spectrum simultaneously—a major advantage over older variable wavelength detectors.

There are other types of novel and integrated detectors that may be suitable for the embodiments described herein as ongoing research is developing new formats and materials to create even smaller, more versatile UV detectors-such as the development of wearable UV sensors, that may be purposed for use in a small portable handheld device as these detectors are extremely small, battery-free electronic sensors that have been designed to be worn on skin, clothing, or a fingernail. In an embodiment, this type of detector may be incorporated into a reservoir containing a precursor liquid which may be a disposable type reservoir or a reusable type reservoir, as had been previously described. In another embodiment, this type of detector may be incorporated into a pod type system and/or cartomizer type system as has been described previously herein. These detectors use semiconductor photodetectors combined with a communication chip for wireless data transfer, such data could be communicated to a controller, such as the controller(s) described herein, or alternatively to a smart phone for integration into an application that communicated with the device and/or device controller.

There are also suitable very small scale detectors such as nanowire-based detectors which use high-surface-area nanowires made from materials like ZnO or GaN to create highly sensitive and responsive UV sensors with high gain. Furthermore, there are now on-chip spectral imagers, which is an emerging technology that integrates a cascade of photodiodes with varying bandgaps directly onto a single chip which allows for real-time, high-resolution spectral imaging in a minuscule form factor. Similarly, there are also SMD package sensors, where UV sensors are available in surface-mount device (SMD) packages, with some as small as 1 mm×1 mm, for integration into smaller circuit boards and devices, such as a handheld portable device.

There are also additional types of detector and/or UV sensor systems that may be used such as those constructed from nanoscale band structure engineering using epitaxial techniques, such as molecular-beam epitaxy (MBE) as well as atomic layer deposition (ALD). Combined with the use of 2D doping (delta-doping and superlattice-doping) MBE techniques, these sensors can achieve 100% internal quantum efficiency (QE). These methods may be combined with antireflection coatings and detector-integrated filters, using ALD, to construct silicon detectors with tailorable response and high QE in the UV/Optical/NIR spectral range which exhibit reliable and repeatable performance with a small sensor/detector footprint and low power consumption requirements.

In some embodiments, a single type of UV detector and/or sensor may be utilized for the direct measurement of a precursor liquid and determination of the UV radiation absorption characteristic of the precursor liquid such as the UV absorption wavelength(s) and intensity and/or percentage of UV absorption of the precursor liquid. In some embodiments, a plurality of UV detectors and/or sensors of the same type or of different types of UV detectors and/or sensor may be utilized for the direct measurement of a precursor liquid and determination of the UV radiation absorption characteristic of the precursor liquid such as UV absorption wavelength(s) and intensity and/or percentage of UV absorption of the precursor liquid.

In an embodiment with a disposable reservoir, pod system, and/or cartomizer type configuration, a simpler UV detector may be incorporated into the reservoir, pod, and/or cartomizer assembly such as those described previously in this section, such as those UV detectors that are extremely small, battery-free electronic sensors. In an embodiment with a disposable reservoir, or pod system and/or cartomizer type configuration a simpler UV detector may be incorporated into the reservoir, pod, and/or cartomizer assembly such as those described previously in this section, such as those UV detectors that are extremely small, battery-free electronic sensors, and additional UV detector and/or sensor or plurality of sensors may be incorporated into a control unit and/or controller such as those described previously and subsequently herein. The specific type of UV detector(s) and/or sensor(s) configuration may be determined by a variety of factors, including, but not limited to, design requirements, material selection, manufacturing methods, and economic considerations.

The IR emitter or plurality of emitters used to construct an IR heater either as an individual heater or as part of a combined heater system may be constructed from a single type of IR emitter, or from different types of IR emitters in order to achieve the desired output of IR radiation in terms of emitted wavelength and/or emission discharge intensity. The emitter or plurality of emitters may be non-coherent emitters, and/or coherent emitters. The IR emitter and/or emitters may be constructed into a heater system that incorporates an IR filter or filters in order to isolate the desired wavelengths of emitted IR radiation. The IR radiation emitter and/or emitters may be constructed into a heater system that incorporates a lens or lenses to focus the IR emissions. The IR emitter and/or emitters may be constructed into a heater system that incorporates both an IR filter or IR filters and a lens or lenses in a combined system intended to both filter out certain wavelengths of IR radiation, and focus the remaining IR radiation.

The IR emitter and/or emitters may be constructed into a heater system that incorporates a combined IR filter and lens system, where a single component functions as a lens and an IR filter. Multiple types of UV emitters may be used, including but not limited to, miniature IR light emitting diodes (LEDs), which are compact, energy-efficient, and long-lasting solid-state IR radiation sources that come in a variety of package styles that can be used individually or combined in a plurality of emitters or emitter array depending on the desired emission wavelength and/or emission intensity. Types of IR emitters that may be used in construction of an IR emitter based heater, as a single emitter or as a plurality of emitters for use as a standalone heater, or as part of a combined heating system come in a variety of different technologies and formats—which may be utilized based on the desired emitted wavelength(s) and intensity or intensities of IR radiation emission(s).

Suitable IR emitters may be stratified into three basic emission ranges based on wavelength: (a) Short-Wave Infrared (SWIR), which is a high-intensity emitter with short wavelengths and deep penetration, often produced by tungsten and halogen emitters; (b) Medium-Wave Infrared (MWIR), rapidly heats surfaces and thin layers, with high absorption by water films, and high absorption by precursor liquid constituents such as PG and VG, and/or other precursor liquid constituents such as and acid; and (c) Long-Wave Infrared (LWIR) which emit lower-frequency waves, further from visible light, and are typically used for general heating.

Suitable semiconductor emitters include compact, solid-state devices that emit specific wavelengths of infrared light. They can be designed for near-infrared (NIR), mid-infrared (MIR), or far-infrared (FIR) radiation, depending on the semiconductor material and doping. Examples of suitable semiconductor emitters include but are not limited to, Quantum-Dot emitters. Quantum-Dot emitters are semiconductor nanocrystals that can be tailored to emit a broad spectrum of near- and mid-infrared IR radiation by manipulating their size and composition, offering versatility for the emission of specific wavelengths of IR radiation. Another type of suitable semiconductor-based IR emitters are heating element based IR heating emitters. These types of IR emitters utilize semiconductor properties to generate infrared radiation for IR heating. They often feature high reflectivity and fast response times, with types of emitters including, but not limited to quartz twin-tube emitters which use quartz tubes with gold or reflective coatings for efficient, stable heat generation.

There are also suitable ceramic based emitters that are constructed with a highly emissive ceramic body and a resistive coil. These types of emitters are robust and effective for long-wave infrared heating. An example of a ceramic type heater is the ceramic blackbody type emitter which utilizes a heated ceramic tube or element, often with a resistance coil (e.g., FeCrAl) embedded in a highly emissive ceramic body, producing long-wave (far-infrared) radiation. There are also suitable kanthal and silicon-carbide emitters, which utilize materials like kanthal and silicon carbide that, when heated electrically, produce broadband IR radiation. These types of emitters are similar to wound filament emitters, where a wire filament, often nichrome, kanthal, or tungsten, is wound into coil(s) and protected by glass (e.g. quartz, fused silica) windows. These type of IR emitters produce high power output. Suitable Quartz Cassette Emitters may have quartz tubes within a housing that operate at higher front surface temperatures, emitting medium to long-wave IR radiation.

Another category of suitable IR emitters with high efficiency that are ideally suited to be utilized as an IR radiation heater include cavity blackbodies, as these emitters provide a calibrated IR thermal radiation source. Small versions of these types of emitters are available as LED cavity blackbody infrared emitters that generate highly uniform, stable, and accurate infrared IR radiation by combining the precise emission characteristics of a cavity blackbody with the pulsable, efficient features of a modern IR emitter. This technology offers a significant advance over standard IR-emitting LEDs used in consumer electronics which typically have lower and less predictable emissivity. These types of blackbody IR emitters are constructed having an enclosed cavity with a small aperture. This structure ensures that any incoming light is absorbed by the internal surfaces, and the IR radiation that does escape through the aperture closely approximates a “perfect” blackbody. This provides a highly accurate and wavelength-independent emission profile. This type of emitter is ideally suited for applications as a IR heat source as an LED cavity blackbody infrared emitter generates highly uniform, stable, and accurate infrared IR radiation by combining the precise emission characteristics of a cavity blackbody with the pulsable, efficient features of a modern IR emitter. This technology offers a significant advance over standard IR-emitting LEDs used in consumer electronics, which typically have lower and less predictable emissivity. The solid-state nature of the device allows for rapid pulsing speeds and high efficiency compared to older thermal IR emitters.

The structure of an enclosed cavity with a small aperture ensures that any incoming light is absorbed by the internal surfaces, and the IR radiation that does escape through the aperture has a highly accurate and wavelength-independent emission profile. These emitters may use a specialized solid-state monolithic radiating element, or one-piece radiating element, often with a nanostructured surface instead of a traditional wound filament. This element design improves efficiency and stability because the emitter uses a monolithic, rather than a filament-based, design, that offers superior mechanical stability and longer operating life with long-term stability. The emitting element is placed inside a cavity, where the walls of the cavity reflect and re-emit the thermal energy multiple times before it exits through an aperture. The cavity design provides very high emissivity, ensuring the emitted infrared radiation is uniform and predictable across a wide spectrum. This multi-reflection process creates a near-perfect blackbody source with an emissivity greater than 0.9. These LED blackbody emitters are often constructed to incorporate an integrated gold-plated reflector to direct any radiation emitted from the back of the element toward the front, maximizing output efficiency. The combination of a nanostructured radiating element and a gold reflector ensures that the device is highly efficient at converting electrical power into forward-directed IR radiation. Integrated controller circuitry provides the fast pulsing and stable temperature control that is characteristic of LED technology as unlike conventional thermal blackbodies that are heated with a coil, these modern emitters can be pulsed at high frequencies, with speeds up to 180 Hz.

Another category of suitable IR heaters are incandescent thermal emitters, examples of these types of emitters include, but are not limited to, tungsten element based emitters often used in quartz tubes and can operate as short-wave, medium-wave, or fast-medium wave emitters for IR heating. There are also suitable quartz element based emitters where a heated quartz element(s) are effective for medium-wave infrared heating applications. Another type of suitable IR radiation emitter that can be used as a heater are thin-film emitters which utilize thin films of materials to generate infrared radiation and are broadly categorized by their underlying technology, such as thin film emitters, where a thin foil with low thermal capacitance which allows for rapid modulation of thermal radiation.

Another category of suitable thin film emitters well suited to the application of constructing an IR heater are Micro-Electro-Mechanical Systems (MEMS)-based devices and those with deposited thin-film filaments. These technologies are used to create precise and pulsable thermal radiation emissions. Additionally, MEMS-based thin-film emitter technology is a method for creating miniature thin-film IR emitters. These devices use semiconductor manufacturing techniques to create micro-hotplates or similar suspended structures that heat up rapidly. There are several types of MEMS based emitters, including but not limited to, nanostructured amorphous carbon emitters, these emitters feature a thin-film resistor made of nanostructured carbon. Utilizing nanostructured carbon construction allows for compact, low-mass designs that can pulse at high frequencies. Other MEMS emitters are constructed using silicon with platinum which uses a silicon or other thin-film material to form a membrane, with platinum serving as the emitting material. Similar to the elements described previously in blackbody LED emitters, some MEMS emitters utilize a monolithic nanostructured element which is a free-standing radiating element with nanostructured surfaces. These monolithic nanostructured elements offer improved efficiency, enhanced emissivity, and greater mechanical stability than most other element types.

There are also suitable deposited thin-film filaments, this type of emitter consists of a resistive thin-film material deposited onto a substrate with high thermal resistance. An example of a thin film filament is thin film on alumina that is constructed using a thin film of resistance material permanently bonded to a flat alumina substrate. This construction provides a uniform radiating source and a stable platform. Other thin film emitters are constructed using metal thin films using metals with high-melting points, often enhanced with a nanostructured surface to increase emissivity. Thin film emitters can be constructed to be selective wavelength IR emitters which thin films of polar materials, such as silicon carbide, deposited on a reflective substrate like gold. This structure creates a selective IR emissivity profile.

Other methods for constructing a suitable selective IR emitter include the use of carbon, silicon-carbide, and nanostructured emitters as these materials can also be used in various emitter designs, such as those described previously herein, for different thermal and spectral characteristics. The IR emitter utilized as a heater or as part of a heater system comprised a plurality of IR emitter and other emitter types, such an a UV emitter or plurality of UV emitters includes the use of a coherent IR radiation emitter, such as an IR laser. Several types of miniature infrared (IR) lasers may be used for IR radiation heating requiring wavelength specific thermal emissions. Examples include, but are not limited to, Quantum Cascade Lasers (QCLs), Vertical Cavity Surface Emitting Lasers (VCSELs), and miniature tunable diode IR lasers. Quantum Cascade Lasers (QCLs) QCLs are a leading technology for miniature IR applications, especially for those requiring high sensitivity and accuracy and primarily operate in the mid-infrared (MIR) and long-wave infrared (LWIR) ranges (typically 3-20 μm). This range is ideal for thermal modulation of precursor liquid and/or compounds as it covers the fundamental molecular vibrational frequencies of the constituents of the precursor liquid and/or compound. Another benefit of miniature QCLs is that they can operate at or near room temperature, eliminating the need for bulky liquid nitrogen cooling systems, this allows for QCLs to be utilized in small portable devices. These types of lasers can be “chirped,” or rapidly tuned, to adjust the wavelength of IR emissions in real-time which has benefits of adjusting or shifting the wavelength(s) of IR radiation emissions during an activation cycle by being able to adjust for blue-shifting and/or red-shifting of the precursor liquid or compound while being heated, and/or adjusting for precursor liquid and/or compound IR radiation absorption characteristics when phase changing to a vapor phase. These lasers can present thermal challenges as while QCLs are miniature, they generate a significant amount of heat and constructing a QCL based heater may also include specialized thermal management, such as micro-channel cooling structures, that may be required to maintain a stable operating temperature and prevent wavelength drift during activation. The need for specialized cooling of the QCL may be mitigated by having short activation cycles, and/or by pulsing the QCL during an activation cycle, and/or by heat-sinking the QCL chassis and/or housing to components of the assembly such as the controller and/or the vaporization assembly including the reservoir components.

Another type of suitable coherent IR radiation source is the Vertical Cavity Surface Emitting Lasers (VCSELs). VCSELs are a highly compact and efficient type of semiconductor laser that can be used for miniature IR thermal emission applications. Although VCSELs have common IR radiation emission wavelengths in the near-infrared (NIR) range (750-980 nm) they can also be constructed to emit at longer wavelengths. VCSELs are well-suited for miniaturization and can be integrated into arrays or combined with photodiodes for tailored IR radiation emission functionality in a compact package. This is useful for applications involving heating and even subsequent thermal detection as VCSEL arrays function as high-intensity IR heat sources for surface heating and can be used in conjunction with IR detectors, cameras, and/or pyrometers to precisely control and measure temperature during an activation cycle(s).

Another type of suitable coherent IR radiation emitter are miniature tunable diode lasers (TDLAS). These lasers operate in both the near-infrared and mid-infrared ranges, with high selectivity and sensitivity. TDLAS systems can be constructed from small, stable semiconductor laser diodes. In a TDLAS system, the laser can be tuned to an absorption band of a target precursor liquid and/or compound, and/or the precursor liquid and/or precursor compound in a vapor and/or gas phase.

It should be understood that the description of IR emitters that may be used is intended to illustrate a variety of technologies that may be suitable for construction of a heater system that includes an IR radiation emitter, either as a standalone heater, or as an array of emitters that is constructed using a plurality of IR emitters, and may or may not be combined with other emitter and/or heater types to construct a heater system, such a combined IR and UV heating system, is not intended to be an exhaustive description of all available IR emitter types and/or technologies and that other types and/or technologies of IR emitters, including both non-coherent and coherent IR radiation emitters may be used. It should also be understood that some of the heater types described herein, including but not limited to incandescent type emitters, as IR emitters may also emit other wavelengths of electromagnetic radiation, including but not limited to UV radiation, and that such emitters may be used individually, or in plurality to function as a combined emitter or emitter system and/or emitter array that emits IR radiation and UV radiation. The specific type of IR emitter(s) utilized for the construction of an IR radiation emitter-based heater, either as a standalone emitter, or as a plurality of emitters, may be determined by a variety of factors, including, but not limited to, design requirements, precursor liquid and/or precursor compound formulation and/or constituents, material selection, manufacturing methods, and economic considerations.

A heater comprised of an IR emitter, either as an individual IR emitter, a plurality of IR emitters, that are constructed to radiate a specific wavelength or wavelengths of IR radiation may be constructed or controlled such that the IR emitter or emitters is tuned to specific precursor liquid IR absorptance characteristics, where such IR absorbance characteristics are validated by direct measurement. For example, the precursor liquid could be analytically quantified for the precursor liquid's IR absorption characteristic using a method to determine the IR absorption characteristics of the precursor liquid and/or precursor compound. Multiple methods exist for measuring IR absorbance of a precursor liquid and/or precursor compound, including but not limited to, Fourier Transform Infrared Spectroscopy or FTIR (also called FT-IR) which is an analytical technique that uses infrared light to analyze the chemical composition of a material by measuring how it absorbs IR radiation. A preferred method for measuring infrared absorption in aqueous samples such as a precursor liquid formulation that contains water is Attenuated Total Reflectance Fourier Transform Infrared (ATR-FTIR) spectroscopy. The high absorbance of liquid water in the mid-infrared region makes standard transmission IR techniques difficult, but ATR-FTIR overcomes this challenge by using a very short path length. Furthermore, an FTIR spectrum can distinguish between pure glycerol (such as VG), pure glycol (such as PG), and water, as well as identify the distinct interactions in precursor liquid mixtures.

Methods that may be used for IR absorption measurement include, but are not limited to, attenuated total reflectance (ATR) and transmission spectroscopy. In ATR, which is the most prevalent technique for liquid analysis, the liquid sample may be positioned on the surface of an ATR crystal, allowing an incident infrared beam to interact with the sample at the crystal interface. Alternatively, in transmission spectroscopy, the liquid precursor sample may be placed in a transmission cell or sandwiched between two IR-transparent plates, such as sodium chloride (NaCl) or potassium bromide (KBr). The infrared beam then passes directly through the sample en route to the detector. Other methods, such as diffuse reflectance or specular reflectance, may also be employed depending on the sample characteristics and analytical requirements. FTIR and ATR-FTIR may also be used to determine the IR absorption characteristics of a non-liquid sample, such as a precursor compound that is thermoviscous and non-liquid at room temperature.

Alternatives to FTIR and/or ATR-FTIR suitable for measuring infrared absorbance of a precursor liquid and/or precursor compound include, but are not limited to, Dispersive IR (DIR) spectroscopy, Near-Infrared (NIR) spectroscopy, Raman Spectroscopy, Diffuse Reflectance Infrared Fourier Transform Spectroscopy (DRIFTS), ATR alone, and Laser Spectrometers. Dispersive systems use a prism or grating to separate wavelengths, while NIR focuses on a different region of the infrared spectrum with unique applications. Laser spectrometers are specialized for measuring specific components at very low concentrations, offering high sensitivity for certain applications. Raman Spectroscopy, which measures light scattering rather than absorption but provides complementary vibrational information. For nanoscale analysis, PiF-IR offers superior spatial resolution and surface sensitivity compared to FTIR. ATR used alone and DRIFTS are also alternatives, though DRIFTS may have lower resolution.

In an embodiment, the IR emitter or plurality of IR emitters functioning as a heater or as part of a combined heater system is tuned to emit IR radiation at a wavelength or wavelengths that match the IR absorption characteristics of a precursor liquid that has been measured by ATR-FTIR spectroscopy. In an embodiment, the IR emitter or plurality of IR emitters functioning as a heater or as part of a combined heater system is tuned to emit IR radiation at a wavelength or wavelengths that match the IR absorption characteristics of a precursor liquid at ambient temperature and/or over a range of temperatures matching the temperatures required to heat the precursor liquid in order to effect a phase change from a liquid to a vapor, that has been measured by ATR-FTIR spectroscopy.

In some embodiments, a miniature IR detector may be incorporated into the reservoir system of the device, or into a controller and/or control unit coupled to the reservoir such that the IR emitter or emitters may radiate the precursor liquid and a IR sensor and/or detector may be radiated by the IR emissions once the emission have passed through the precursor liquid, in order to measure the IR absorbance characteristics of the precursor liquid. There are several types of suitable miniature IR sensors that can be described as two primary categories of IR sensors, those that measure thermal radiation, and those that measure optical (photon) radiation. Thermal IR sensors include bolometers, these sensors change their electrical resistance with temperature. They are suitable for quick lower resolution measurements. Thermopiles are another type of IR sensor constructed from a series of thermocouples with an absorption layer. They utilize the Seebeck effect, where a temperature difference generates a voltage, providing a linear response to incident IR radiation. Pyroelectric sensors are another type of suitable IR sensor. These sensors are sensitive to changes in thermal radiation. An additional attribute of pyroelectric sensors is that special absorption layers allow some pyroelectric sensors to detect UV and even Terahertz (THz) radiation which is useful in a heater system that includes both IR and UV emissions.

Suitable Photon (Optical) IR sensors photodiodes may use the “inner photoelectric effect,” where IR radiation quanta generate electron-hole pairs within a semiconductor material. Microbolometers are silicon-based detectors that are typically small and used in integrated sensors for detection and measurement of mid-wave and long-wave IR applications. The choice of specific semiconductor material determines the wavelength sensitivity, for example, InGaAs (Indium Gallium Arsenide) are commonly used for short-wavelength IR (SWIR) applications. Where InSb (Indium Antimonide) is preferred for broadband mid-wave IR (MWIR) detection, and MCT (Mercury Cadmium Telluride) and SLS (Silicon-based Germanium) are used for long-wave IR (LWIR) detection. Multiple semiconductor type sensors may be combined in order to achieve broad IR spectrum measurement sensitivity.

In an embodiment, another way to achieve broad spectrum measurement of IR radiation emissions is to utilize an IR spectrometer capable of comprehensive multi-wavelength measurement. Such suitable spectrometer based sensors include an interferometer. An interferometer works similarly to a prism to separate and resolve the IR radiation into its individual wavelengths. The interferometer works in conjunction with an IR detector to measure the separated wavelengths, creating a full spectrum of the infrared radiation. Types of suitable miniature interferometers include, but are not limited to, fiber-optic Michelson interferometers, miniature lamellar grating interferometers, and small-scale configurations of general types like Fizeau and white-light interferometers. These are miniaturized versions of well-known designs, utilizing technologies such as silicon fabrication to achieve smaller sizes for increased portability or integration into devices. Many miniature interferometers are built using silicon fabrication processes, allowing for the creation of highly integrated and compact optical systems suitable for incorporation into small electronic devices. Additionally, the use of optical fibers in some miniature designs allows for increased flexibility, remote sensing, and easier integration into device sensor systems.

In some embodiments, the IR sensor and/or IR detector may function as a thermal sensor and/or detector for the measurement of thermal energy that may or may not include IR radiation. In some embodiments, a single type of IR detector and/or sensor may be utilized for the direct measurement of a precursor liquid and determination of the IR radiation absorption characteristic of the precursor liquid such as IR absorption wavelength(s) and intensity and/or percentage of IR absorption of the precursor liquid. In some embodiments, a plurality of IR detectors and/or sensors of the same type or of different types of IR detectors and/or sensor may be utilized for the direct measurement of a precursor liquid and determination of the IR radiation absorption characteristic of the precursor liquid such as IR absorption wavelength(s) and intensity and/or percentage of IR absorption of the precursor liquid.

In an embodiment with a disposable reservoir, pod system, and/or cartomizer type configuration, a simpler IR detector may be incorporated into the reservoir, pod, and/or cartomizer assembly such as those described previously in this section, such as bolometers, and/or thermopiles, and/or pyroelectric sensors. In an embodiment with a disposable reservoir, pod system and/or cartomizer type configuration, a simpler IR detector may be incorporated into the reservoir, pod, and/or cartomizer assembly such as those described previously in this section, such as bolometers, and/or thermopiles, and/or pyroelectric sensor, and additional IR detector and/or sensor or plurality of sensors may be incorporated into a control unit and/or controller such as those described previously and subsequently herein. The specific type of IR detector(s) and/or sensor(s) and the sensor and/or detector configuration may be determined by a variety of factors, including, but not limited to, design requirements, material selection, manufacturing methods, and economic considerations.

In embodiments where the heater is comprised of an emitter or plurality of emitters that emit both IR radiation and UV radiation, the system may use a sensor that has capabilities of measuring both IR radiation and UV radiation. Such a sensor may be configured and incorporated into the device as has been previously described herein for UV sensor(s) and IR sensor(s) and/or IR detector(s) and/or UV detector(s) and may serve the same series of functions as those described herein for UV and/or IR sensors and/or detectors. These configurations include, but are not limited to, including the sensor and/or sensors and/or detector and/or detectors into precursor liquid and/or precursor compound reservoir assemblies, pod assemblies, cartomizer assemblies, control unit, and/or controllers that have been described previously and subsequently herein.

An example of a suitable combined IR and UV sensor and/or detector is a dual-band photodetector, such as a semiconductor-based dual-band photodetector for multispectral imaging and/or sensing and/or detection. These dual-band sensors and/or detectors are configured based on specific materials and heterojunctions, such as gallium oxide (Ga₂O₃) and mercury telluride (HgTe) colloidal quantum dots, to detect both UV and IR wavelengths. These devices utilize the distinct photosensitivity properties of different semiconductor materials to detect radiation across a broad emission range from UV to IR. In addition to enabling simultaneous UV and IR detection, these detectors can be used for dual-wavelength optical demultiplexing, which is a process in optical communication where a demultiplexer (Demux) device separates multiple, wavelength-division multiplexed (WDM) optical signals, each carrying different data, back into their individual wavelengths and routes them to separate output fibers or receivers. This technology enables the efficient use of a single optical fiber to transmit multiple data channels by separating them at the receiving end, such that the dual-band sensor and/or detector system data transmission components can be incorporated into small portable devices.

Suitable dual-band UV and IR sensors and/or detectors can include additional features to improve reliability and usability including programmable sensor control software for customizable features and sensitivity adjustments of the sensor and/or detector system that can be incorporated into a controller and/or control unit as has been described previously and subsequently herein. Such configurable sensor and/or detector software allows for the controller and/or control unit to adjust the sensor and/or detector settings and operational configuration for use with different precursor liquids and/or precursor compounds to maximize sensor and detector sensitivity and functionality for different liquid precursor and/or precursor compound mixtures and/or formulations. Such configurable and programmable software architecture also facilitate the use of the sensor with IR and UV emitters, or plurality of emitters that have emission control programming that adjust the emissions of the emitters or plurality of emitters to match the absorption characteristics of the precursor liquid and/or precursor compound, including changes to the absorption characteristic of the precursor liquid and/or precursor compound that may occur during an activation cycle—such as IR and UV absorption changes resultant from the heating of the precursor liquid and/or precursor compound, and/or changes in IR and UV absorption that may occur when the precursor liquid and/or precursor compound undergoes a phase transition from a liquid and/or a thermoviscous compound that appears solid and/or near solid at ambient temperature into a vapor and/or gas phase as a result of being heated. It should be understood that the description of a combined IR and UV sensor and/or detector is an example of a type of such a suitable sensor, and that other sensor types and/or sensor technologies that can measure both IR and UV may also be utilized. The specific type of combined IR and UV sensor(s) and/or detector(s) and the sensor and/or detector configuration may be determined by a variety of factors, including, but not limited to, design requirements, material selection, manufacturing methods, and economic considerations.

In some embodiments a UV emitter may be combined with different heater types other than an IR emitter and/or heater, such as any of the heater types previously disclosed herein, including but not limited to resistive heaters, ceramic heaters, and inductive heaters. In some embodiments the UV emitter may emit UV radiation that is coherent (e.g. a UV laser). In some embodiments the UV emitter may emit radiation that is non-coherent (e.g. a UV diode). In some embodiments the UV emitter may be a single emitter. In some embodiments the UV heater may include a plurality and/or array of UV emitters. In some embodiments the UV emitter may be a broad UV spectrum emitter that is filtered to emit selective wavelengths of UV radiation. In some embodiments the UV emitter may be a board spectrum emitter that is controllable to emit specific wavelengths of UV radiation. In some embodiments the UV heater may be a plurality of and/or array of UV emitters where individual emitters in the array emit specific narrow ranges of UV radiation.

In some embodiments the precursor liquid and/or compound may include cannabinoids as the active compound, where the cannabinoid may be a single cannabinoid such as THC, or CBD, or CBN, and may also be a combination of cannabinoids, including but not limited to mixtures of THC, CBD, and CBN. In some embodiments the cannabinoid is the active compound in the precursor liquid and/or precursor compound where the cannabinoid may be a single cannabinoid compound such as THC, or CBD, or CBN, and may also be a combination of cannabinoids, including but not limited to mixtures of THC, CBD, and CBN, and the cannabinoid(s) is then combined with a carrier fluid such as PG and/or VG and/or water to form the precursor liquid. In such an embodiment, a UV emitter and an IR emitter may be used in combination and the IR emission range includes the ranges previously described herein for the heating of PG and VG and PG and VG mixtures including those precursor liquids in which water is present with the PG, or VG, or mixture of PG and VG. Embodiments include, but are not limited to, precursor liquids in which water is present with the PG, or VG, or mixture of PG and VG, and an acid may be present as a component of the precursor liquid, such as benzoic acid as an example.

Cannabinoids exhibit several characteristic IR absorption bands, and due to similarities of cannabinoid molecular structure they share some overlapping characteristics in relation to the absorption of IR radiation and subsequent and/or associated vibration(s) of the molecule. However, unique attributes of the structure of cannabinoids result in unique IR absorption characteristics. Key IR absorption bands of THC that can be used for the targeted heating of THC by the emission of specific wavelengths of IR radiation are generally in the mid-IR range at 400-4000 cm⁻¹. This includes prominent carbon and hydrogen bond (C—H) bending vibrations in THC typically observed at 1295 cm⁻¹. THC also has IR absorption as a result of aromatic carbon to carbon covalent bonding (C═C) stretching vibrations at 1623 cm⁻¹ where the aromatic ring in THC is responsible for this key absorption. THC also has O—H stretching from the hydroxyl (—OH) groups present with absorption typically around 3300-3500 cm⁻¹. Additional key absorption ranges for THC that differentiate it from other cannabinoids include a phenol O—H stretch typically observed around 3477 cm⁻¹ due to the phenol O—H stretch in the THC molecule. There are also additional key absorption ranges from aromatic vibrations in the range of 1620-1660 cm⁻¹. THC, in particular, shows absorption from aromatic vibrations at 1623 cm⁻¹. There are characteristic cannabinoid bands, including but not limited to several specific bands around 1624, 1581, 1510, 1462, and 1374 cm⁻¹ are characteristic of most cannabinoids including THC. The absorption in the near IR (NIR) range in THC is weak and comes from overtones of the strong mid-IR vibrations and are less meaningful for absorption targeted IR heating of THC. Other factors such as molecular conformation may change the absorption range of THC as the spatial arrangement of THC's structure can influence the IR absorption. Different conformers, especially those stabilized by hydrogen bonds, produce distinct IR absorption ranges. Therefore the description of the absorption ranges of THC to IR radiation contained herein is intended to describe some of the relevant IR wavelengths that may be utilized to heat THC utilizing targeted wavelength IR radiation but should not be considered an exhaustive description and other wavelengths of IR radiation may be used depending on the actual IR absorption characteristic of the THC present in a precursor liquid and/or precursor compound.

In an embodiment an IR emitter may have broad emissions from 400-4000 cm⁻¹ for the purpose of heating a precursor liquid and/or precursor compound containing THC sufficiently to cause a phase change of the precursor to a vapor phase. In an embodiment, an IR emitter may have emissions with peak emissions at multiple ranges including 1290-1300 cm⁻¹, 1620-1670 cm⁻¹, and 3300-3500 cm⁻¹ for the purpose of heating a precursor liquid and/or precursor compound containing THC sufficiently to cause a phase change of the precursor to a vapor phase. In an embodiment intended to be used with a THC precursor liquid and/or precursor compound, the UV emitter present as part of a combined IR and UV heating system may have a UV emitter with an emission range of 200-350 nm and peak emissions at 205-215 nm and 275-285 nm and has an IR emitter that has broad emissions from 400-4000 cm⁻¹ for the purpose of heating a precursor liquid and/or precursor compound containing THC sufficiently to cause a phase change of the precursor to a vapor phase. In an embodiment intended to be used with a THC precursor liquid and/or precursor compound, the UV emitter present as part of a combined IR and UV heating system may have a UV emitter with an emission range of, for example, 200-350 nm and peak emissions at 205-215 nm and 275-285 nm and an IR emitter with emissions with peak emissions at multiple ranges including, for example, 1290-1300 cm⁻¹, 1620-1670 cm⁻¹, and 3300-3500 cm⁻¹ for the purpose of heating a precursor liquid and/or precursor compound containing THC sufficiently to cause a phase change of the precursor to a vapor phase.

Although THC and CBD are both cannabinoids and share some similarities in their ability to absorb IR radiation, they also have distinct IR absorption ranges due to minor structural differences that affect molecular vibrations. Although both are terpenophenolic compounds with similar structures, the position of their double bonds and the arrangement of a key oxygen-containing ring create unique vibrational patterns that may be targeted by specific wavelengths of IR radiation in order to heat a precursor with CBD present as the active compound. Key IR absorption bands of CBD that can be targeted for IR radiation heating of a CBD precursor liquid and/or compound include a broad-OH stretch from 3550-3300 cm⁻¹ as CBD has two hydroxyl (—OH) groups on its phenolic ring. These groups participate in hydrogen bonding, which causes the absorption band to be broad and appear in the 3550-3300 cm⁻¹ region, however if the CBD was a component of a liquid precursor mixture where the precursor liquid was a dilute CBD solution, a sharp absorption band may also be present around 3600 cm⁻¹, indicating some free, non-hydrogen-bonded-OH groups. Aromatic C═C stretches absorb IR radiation at 1628 and 1586 cm⁻¹. Additionally, the benzene ring in CBD produces characteristic IR absorption due to the stretching of its carbon-carbon double bonds (C═C). This absorption typically occurs at 1628 cm⁻¹ and 1586 cm⁻¹. Aromatic C—H stretching causes absorption at ranges of 3085-3160 cm⁻¹ where these vibrations, which correspond to the C—H bonds on the aromatic ring, are typically observed in the region above 3000 cm⁻¹. Aliphatic C—H stretches absorb IR radiation at ranges of 3000-2850 cm⁻¹. CBD's aliphatic (non-aromatic) regions, which include the pentyl side chain and the cyclohexene ring, show strong C—H stretching IR absorption below 3000 cm⁻¹. Aliphatic C—H bends in the range of 1400-1200 cm⁻¹ where these bending vibrations of the aliphatic —CH2- and —CH3 groups absorb IR in the 1400-1200 cm⁻¹ region. The C═C stretch of the cyclohexene ring absorbs IR radiation in the range of 1650-1670 cm⁻¹, and the cyclohexene ring in CBD also has a C═C bond, which produces a characteristic stretching absorption in the 1650-1670 cm⁻¹ range.

IR absorption of CBD can be influenced by intramolecular hydrogen bonding, where the intramolecular hydrogen bonds between the hydroxyl groups and the π-electrons of the aromatic ring significantly affect the position of the —OH stretching absorption range. The strength and nature of these hydrogen bonds can cause shifts in other absorption ranges as well, such as the C═C stretch of the cyclohexene ring. Other factors such as molecular conformation can change the absorption range of CBD as the spatial arrangement of CBD's structure can influence the IR absorption. Different conformers, especially those stabilized by hydrogen bonds, produce distinct IR absorption ranges. Therefore, the description of the absorption ranges of CBD to IR radiation contained herein is intended to describe some of the relevant IR wavelengths that may be utilized to heat CBD utilizing targeted wavelength IR radiation but should not be considered an exhaustive description and other wavelengths of IR radiation may be used depending on the actual IR absorption characteristic of the CBD present in a precursor liquid and/or precursor compound. In an embodiment an IR emitter has broad emissions from 1150-3600 cm⁻¹ for the purpose of heating a precursor liquid and/or precursor compound containing CBD sufficiently to cause a phase change of the precursor to a vapor phase.

In an embodiment, an IR emitter has emissions with peak emissions at multiple ranges including 1190-1410 cm⁻¹, 1580-1630 cm⁻¹, and 2800-3050 cm⁻¹ and for the purpose of heating a precursor liquid and/or precursor compound containing CBD sufficiently to cause a phase change of the precursor to a vapor phase. In an embodiment intended to be used with a CBD precursor liquid and/or precursor compound, the UV emitter present as part of a combined IR and UV heating system may have a UV emitter with one emission range at 207-220 nm and another emission range at 275-280 nm and may have an IR emitter that has broad emissions from 1150-3600 cm⁻¹ for the purpose of heating a precursor liquid and/or precursor compound containing CBD sufficiently to cause a phase change of the precursor to a vapor phase. In an embodiment intended to be used with a CBD precursor liquid and/or precursor compound, the UV emitter present as part of a combined IR and UV heating system may have a UV emitter with an emission range of, for example, 200-300 nm and peak emissions at 207-220 nm and 275-280 nm and a IR emitter that has emissions with peak emissions at multiple ranges including, for example, 1190-1410 cm⁻¹, 1580-1630 cm⁻¹, and 2800-3050 cm⁻¹ for the purpose of heating a precursor liquid and/or precursor compound containing CBD sufficiently to cause a phase change of the precursor to a vapor phase.

Although THC, CBD, and CBN (cannabinol) are all cannabinoids and share some similarities in their ability to absorb IR radiation they also have distinct IR absorption ranges due to minor structural differences that affect molecular vibrations. For example, CBN has a stable aromatic ring system that is absent in THC. These structural variations produce distinct absorption characteristic to IR radiation. Another example is that CBN has a linear, “open-ring” structure that results from the fission of a ring in the precursor molecule. This gives CBN two distinct hydroxyl (—OH) groups, where CBN has an oxidized, fully aromatic six-membered ring, in contrast to the non-aromatic rings found in CBN. This aromatic structure affects the compound's overall electronic properties and vibrational characteristics and accounts for the differences in the IR absorption characteristic of CBN when compared to THC and CBD. CBN is also a terpenophenolic compound whose IR absorption ranges are characterized by vibrations from its unique (when compared to other cannabinoids) aromatic rings, hydroxyl group, and alkyl side chain. Specific key absorption regions for CBN are strong absorption of IR radiation at 1610 cm⁻¹ and 1624 cm⁻¹. As well as absorption associated with the aromatic ring's carbon-carbon double bonds (C═C) at 1302 cm⁻¹ and 1285 cm⁻¹. Other typical absorption regions for CBN based on its functional groups, include the aromatic C—H stretches which typically absorb IR radiation just above 3000 cm⁻¹, usually in the 3100-3050 cm⁻¹ range. Aliphatic C—H stretches, there the alkyl chain and methyl groups show strong C—H stretching vibrations when absorbing IR radiation in the 3000-2850 cm⁻¹ range. There is also the phenol O—H stretch as CBN contains a phenolic hydroxyl group (O—H), which appears as a broad, medium-intensity absorption region in the 3500-3300 cm⁻¹ range due to hydrogen bonding. There is also a phenol C—O stretch where the carbon-oxygen (C—O) stretch of the phenolic group typically absorbs IR radiation in the 1300-1000 cm⁻¹ range. Additionally, there are Alkane C—H bending that occurs when CBN absorbs IR radiation from the methyl (—CH₃) and methylene (—CH₂—) groups on the alkyl side chain show that have characteristic medium-intensity bending absorptions around 1450 cm⁻¹ and 1375 cm⁻¹.

Other factors such as molecular conformation may change the absorption range of CBN as the spatial arrangement of CBN's structure can influence the IR absorption. Different conformers, especially those stabilized by hydrogen bonds, produce distinct IR absorption ranges. Therefore the description of the absorption ranges of CBN to IR radiation contained herein is intended to describe some of the relevant IR wavelengths that may be utilized to heat CBN utilizing targeted wavelength IR radiation but should not be considered an exhaustive description and other wavelengths of IR radiation may be used depending on the actual IR absorption characteristic of the CBN present in a precursor liquid and/or precursor compound.

In an embodiment an IR emitter has broad emissions from 1000-3500 cm⁻¹ for the purpose of heating a precursor liquid and/or precursor compound containing CBN sufficiently to cause a phase change of the precursor to a vapor phase. In an embodiment, an IR emitter has emissions with peak emissions at multiple ranges including, for example, 950-1400 cm⁻¹, 1600-1630 cm⁻¹, 2800-3050 cm⁻¹, and 3150-3550 cm⁻¹ for the purpose of heating a precursor liquid and/or precursor compound containing CBN sufficiently to cause a phase change of the precursor to a vapor phase. In an embodiment intended to be used with a CBN precursor liquid and/or precursor compound, the UV emitter present as part of a combined IR and UV heating system may have a UV emitter with one emission range at 218 nm and another emission range at 283 nm and may have an IR emitter that has broad emissions from 1000-3500 cm⁻¹ for the purpose of heating a precursor liquid and/or precursor compound containing CBN sufficiently to cause a phase change of the precursor to a vapor phase. In an embodiment intended to be used with a CBN precursor liquid and/or precursor compound, the UV emitter present as part of a combined IR and UV heating system may have a UV emitter with an emission range of 210-290 nm and peak emissions at 215-220 nm and 275-285 nm and a IR emitter that has emissions with peak emissions at multiple ranges including, for example, 950-1400 cm⁻¹, 1600-1630 cm⁻¹, 2800-3050 cm⁻¹, and 3150-3550 cm⁻¹ for the purpose of heating a precursor liquid and/or precursor compound containing CBN sufficiently to cause a phase change of the precursor to a vapor phase.

In some applications of the device where the precursor liquid and/or precursor compound contains THC, and/or is comprised of cannabinoids including THC, the device may serve to selectively convert and/or interconvert cannabinoids as part of an activation cycle and/or preceding an activation cycle. As an example, THC may be converted to CBN, as THC and CBN have different physiological effects when inhaled, and a user may in certain use cases desire the physiological effects of THC (e.g. pain relief, euphoria, appetite stimulation) or the physiological effects of CBN (e.g. sleep promotion, relaxation, anti-inflammation effects) or a blended combination of the physiological effects of THC and CBN (e.g. 50% THC and 50% CBN, 75% THC and 25% CBN, 25% THC and 75% CBN). As THC can be converted to CBN a THC based precursor liquid and/or precursor compound may serve as the base precursor liquid and/or compound and then be converted to yield CBN at a desired ratio of CBN to THC or converted entirely or nearly entirely to CBN. Conversion of THC to CBN may occur preceding an activation cycle, or as part of an activation cycle, or as both preceding an activation cycle and in conjunction with an activation cycle.

In embodiments where a UV emitter or plurality of UV emitters is used as a heater or as part of a heater system, such as a combined UV and IR heater system, the UV radiation in combination with heating can be used to convert THC to CBN using UV radiation emission wavelengths within, for example, the UV-B range of 280-315 nm, to convert THC to CBN. Additionally, in some embodiments, the UV emitter may also emit UV-A wavelengths of 315-400 nm to facilitate the THC to CBN conversion process. This conversion process is known as photo-oxidation, which happens naturally when cannabis ages and is exposed to light and oxygen. For a controlled conversion, UV may be combined with heat and oxygen to speed up the conversion process. UV conversion of THC to CBN occurs when THC is oxidized into CBN. UV radiation causes the THC molecule to lose hydrogen atoms and converts to an oxidized, and more stable, CBN. UV absorption spectra of cannabinoids identify peak absorption for THC around 209 nm and 278 nm, and for CBN around 218 nm and 283 nm. Such wavelengths in the UV-B range, particularly near 280 nm, are effective for triggering the chemical conversion reaction of THC to CBN. Full spectrum UV radiation can also be utilized where the emission of UV-A, UV-B, and UV-C in the presence of heat and oxygen converts THC to CBN.

It should be noted that oxidation and heat are necessary as UV light alone is not the sole catalyst for the conversion reaction. The process of conversion of THC to CBN may convert precursor liquid and/or precursor compound present in the vaporization chamber (such as chamber 130, 230, 330, 430, 530, 630, 730, 1130, 1330, 1430, 2340, 2440, 2540, 2740, 2843, 3043, 3140 and other chambers described herein including chamber assembly 830, 1006, 1700, 1800, 1900, 2000, 2100, 2340, 2640, 3240 and other chamber assemblies described herein), and/or the secondary reservoirs (such as secondary reservoirs 1312, 1412, 1512, 2032 and other secondary reservoirs described herein), and/or the reservoir (such as reservoir 110, 210, 310, 410, 510, 610, 710, 810, 901, 1102, 1302, 1402, 1502, 1612, 2210 and other reservoirs described herein) of vaporization device (such as vaporization device 100, 200, 300, 400, 500, 600, 700, 800, 1100, 1600, 3100 and other vaporization device described herein including vaporizer(s) described herein including vaporizer 1000, and including vaporization assemblies including vaporization assembly 2300, 2400, 2500, 2600, 2700, 2800, 2900, 3000, 3100 and other vaporizer assemblies described herein).

It should be understood that conversion of THC to CBN may also occur in the channels, ports, and other regions, previously and subsequently described herein, where the precursor liquid and/or precursor compound are present in such structures that are in fluidic communication involving the reservoir, and/or secondary reservoir(s), and/or chamber, and or chamber assemblies. In an embodiment where the heater is comprised of a UV emitter or plurality of UV emitters combined with an IR emitter or plurality of IR emitters to form a combined heater system, the UV radiation may be utilized in combination with the IR thermal radiation to partially or entirely convert the THC present in a precursor liquid and/or precursor formulation to CBN. In an embodiment where the heater is comprised of a UV emitter or plurality of UV emitters combined with heat source to form a combined heater system, the UV radiation may be utilized in combination with the IR thermal radiation to partially or entirely convert the THC present in a precursor liquid and/or precursor formulation to CBN. In an embodiment where the heater is comprised of an emitter having at least some of the emissions being UV radiation, the emitted UV radiation may be utilized in combination with the heat generated from the heater to partially or entirely convert the THC present in a precursor liquid and/or precursor formulation to CBN.

In some embodiments, the conversion of THC to CBN from a precursor liquid and/or precursor compound containing THC may be initiated by user selection through a control unit and/or controller. In some embodiments, the conversion of THC to CBN from a precursor liquid and/or precursor compound containing THC may be initiated by user selection through a control unit and/or controller where the selection is based on the user input to related physiological effects (e.g. increasing antiinflammation, increased sleep promotion, increased pain relief). In some embodiments, the conversion of THC to CBN from a precursor liquid and/or precursor compound containing THC may be initiated by user selection through a control unit and/or controller where the conversion THC to CBN is scheduled to occur at various times, for example, if a user desires promotion of appetite than conversion does not occur during mealtimes, where the same user may desire sleep promotion in the evenings, and conversion of THC to CBN may be timed to begin in the evenings and/or increase throughout the evening.

In some embodiments, machine learning may be used to optimize activation cycles and THC to CBN conversion based on the user's patterns of activation and/or other user input. In some embodiments, UV sensors and/or detectors, and/or IR sensor and/or detectors, and/or thermal energy sensors and/or detectors, may be used in conjunction with emitted UV radiation combined with IR radiation and/or thermal energy to measure the conversion of THC to CBN through the changes and/or difference in absorption characteristics of UV radiation and/or IR radiation of THC and CBN. In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion. In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion and the IR sensors and/or thermal energy sensor is used to monitor the temperature of the conversion reaction. In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion, and the IR sensors and/or thermal energy sensor are used to monitor the temperature of the conversion reaction, where the data from the sensor or sensors is communicated to a controller and/or control unit that can modulate the output of UV radiation and IR radiation and/or thermal energy as necessary to effect a conversion of THC to CBN.

In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion, and the IR sensors and/or thermal energy sensor may be used to monitor the temperature of the conversion reaction, where the data from the sensor or sensors is communicated to a controller and/or control unit to confirm that a preprogrammed control algorithm is resulting in the desired conversion of THC to CBN. In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion, and the IR sensors and/or thermal energy sensor may be used to monitor the temperature of the conversion reaction, where the data from the sensor or sensors is communicated to a controller and/or control unit to confirm that a preprogrammed control algorithm is terminating when desired conversion percentage and/or fraction of THC to CBN has been reached.

In some embodiments, UV sensors and/or detectors, and/or IR sensor and/or detectors, and/or thermal energy sensors and/or detectors, may be used in conjunction with emitted UV radiation combined with IR radiation and/or thermal energy to measure and/or control the conversion of THC to CBN through the changes and/or difference in absorption characteristics of UV radiation and/or IR radiation of THC and CBN such that the spectroscopic characteristics of THC and CBN are used to determine the degree and/or percentage of conversion, and the IR sensors and/or thermal energy sensor may be used to monitor the temperature of the conversion reaction, where the data from the sensor or sensors is communicated to a controller and/or control unit to provide a machine learning based control algorithm with relevant data to optimize the THC to CBN conversion process.

Some precursor liquid and/or precursor compound formulations may contain tetrahydrocannabinolic acid (THCA). THCA does not readily cross the blood brain barrier and does not possess the same common physiological effects as THC. In such a formulation, it may be desirable to convert THCA to THC. IR radiation and/or thermal radiation can convert THCA to THC through decarboxylation. Decarboxylation involves removing a carboxyl group (—COOH) from THCA by applying heat, which transforms it into the psychoactive THC. IR radiation transfers energy directly to the THCA containing precursor liquid and/or compound, causing intense, rapid heating. Optimal decarboxylation for THCA occurs between 220° F. (104° C.) and 240° F. (115° C.), although higher temperatures can cause faster conversion but risk degrading other cannabinoids and aromatic terpenes. In some embodiments where a precursor liquid and/or precursor compound contains THCA, the precursor is heated sufficiently by IR radiation and/or thermal energy emission during activation to convert the THCA to THC.

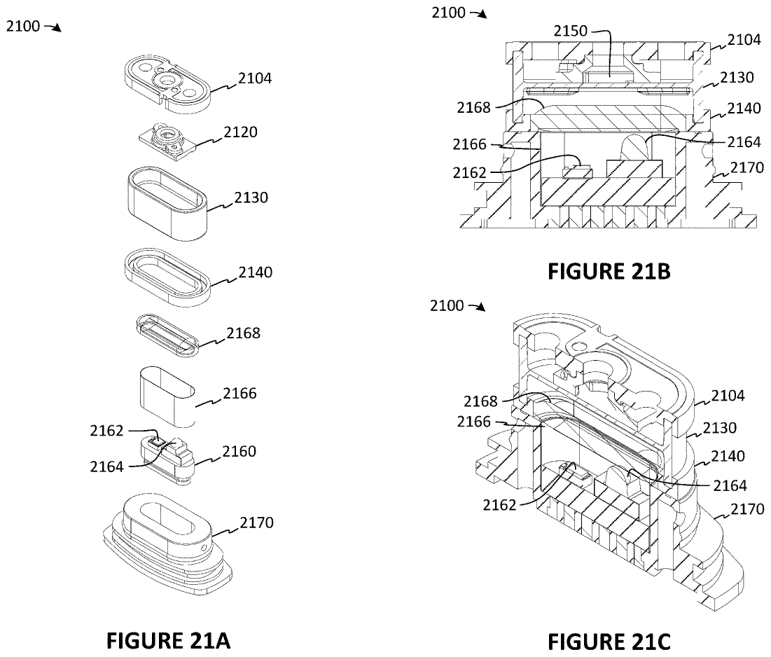

FIGS. 21A through 21C provide various views of a chamber assembly. FIG. 21A illustrates an exploded isometric view, FIG. 21B offers a cross-sectional depiction, and FIG. 21C presents an isometric cross-sectional view. Chamber assembly 2100 may comprise flow director 2104, chamber top 2120, chamber bottom 2130, lower seal 2140, lens 2168, reflector 2166, heater assembly 2160, and lower chassis 2170. With the exception of heater assembly 2160 and associated optical elements, many structural features in chamber assembly 2100 may correspond to those previously described with respect to chamber assembly 2000. For instance, flow director 2104 may be generally analogous to flow director 2004, and chamber top 2120 and lower seal 2140 may be constructed in manners substantially similar to chamber top 2020 and lower seal 2040, respectively.

Chamber top 2120 may be designed to actively participate in the regulation, reflection, or absorption of radiant energy delivered by heater assembly 2160. In certain embodiments, chamber top 2120 may be manufactured from a base material such as borosilicate glass, fused silica, or aluminosilicate, and may further comprise coatings or doped regions to modulate the transmittance, reflectance, or absorptivity at selected wavelengths. For instance, doping chamber top 2120 glass with metallic or oxide additives may alter its transmission properties. Cerium or titanium doping can affect UV absorption, while OH-group doping in fused silica may increase absorption near the IR range. In some cases, a multilayer reflective oxide or metal oxide stack (such as quarter-wave stacks of TiO₂ and SiO₂, or layers containing indium tin oxide or zinc tin oxide) may be applied to one or more surfaces to enhance reflectivity for UV and/or IR while maintaining transparency in the visible range. These features may allow chamber top 2120 to serve either as an efficient energy barrier, reflecting thermal or photonic energy back into chamber 2150, or as a partial absorber to achieve controlled self-heating for flow modulation of a precursor. Alternatively, chamber top 2120 may be constructed to be at least partially transparent at operational wavelengths to permit diagnostic light transmission or allow user-visible emission as an activation indicator.

Chamber bottom 2130 may likewise be constructed to support selective energy delivery and/or thermal isolation. In some embodiments, chamber bottom 2130 may be manufactured from high-purity fused silica or doped glass materials, specifically chosen to transmit one or both of the UV and IR wavelengths produced by heater assembly 2160, while attenuating transmission of non-essential wavelengths or vapor-phase byproducts. Incorporating dopants such as aluminum, magnesium, or fluorine into the glass matrix may permit fine-tuning of transmission spectra; alternatively, interference coatings or nano-structured oxide layers (for example, TiO₂, ZnO, or multilayer stacks combining conducting oxides with metallic silver) may be deposited to achieve high reflectivity at particular spectral bands. Chamber bottom 2130 may also function as a physical barrier, preventing direct contact between liquid precursor and heater elements, thereby avoiding chemical contamination and promoting uniform heating. In yet other configurations, selective doping or functionalization may imbue chamber bottom 2130 with additional features such as IR or UV photodetection, where plasmonic nanoparticles or aliovalent dopants (e.g., Ag in cerium oxide, or Mg in yttria-stabilized zirconia) facilitate photonic sensing or feedback control.

Heater assembly 2160 may comprise UV emitter 2162 and IR emitter 2164, each positioned such that their respective emissions are directed toward chamber bottom 2130 and, ultimately, into chamber 2150. In certain embodiments, UV emitter 2162 may be a compact ultraviolet light-emitting diode (UV LED), a semiconductor diode laser emitting in the ultraviolet spectrum, or, in some cases, a miniature halogen bulb with an envelope selected to transmit UV radiation. IR emitter 2164 may be implemented as an infrared LED, a semiconductor diode laser operating in the near- or mid-infrared spectrum, or a halogen bulb that emits both UV and IR wavelengths. Although UV emitter 2162 and IR emitter 2164 may be illustrated as discrete components, alternative configurations may combine these emitters within a single package. In some cases, the output of each emitter may be modulated independently to achieve programmatic control over the intensity and duration of both UV and IR delivery to chamber 2150. This arrangement may allow for highly targeted delivery of radiant energy, thereby supporting selective molecular excitation, tailored vaporization, and enhanced control over the resulting aerosol composition and volatility.

Reflector 2166 may be disposed around heater assembly 2160, and may be constructed to maximize the reflection of both UV and IR radiation toward chamber bottom 2130. Reflector 2166 may be manufactured from highly reflective metals such as aluminum, silver, or rhodium, or from oxide-based multilayer mirror systems comprised of materials such as TiO₂, SiO₂, MgO, or hybrid stacks incorporating indium tin oxide or zinc tin oxide. In some cases, surface morphology may be tailored to further enhance reflectivity within specified spectral bands.

Lens 2168 may be positioned between heater assembly 2160 and chamber 2150, though in certain embodiments heater assembly 2160 could function effectively without lens 2168. Lens 2168 may be configured to focus or otherwise modulate the spatial distribution of emitted radiation, thereby concentrating energy delivery within selected regions of chamber 2150. In some embodiments, lens 2168 may comprise a converging optical element, for example a plano-convex or biconvex lens, to condense and direct ultraviolet or infrared radiation toward a designated target area. The focal length of lens 2168 may be selected based on the geometrical arrangement of heater assembly 2160, chamber 2150, and the intended energy profile, and could range from short-focus elements (to produce tight focal spots) to longer-focus components designed for broad, collimated energy delivery.

Lens 2168 may be fabricated from radiation-transparent materials including, but not limited to, fused silica, sapphire, or suitably engineered optical ceramics. Additional control over the transmission characteristics of lens 2168 may be achieved through the incorporation of dopants or the application of coatings to selectively block or attenuate undesirable wavelengths while enhancing passage of target emissions. Such modifications may include metal oxide doping, interference multilayer coatings, or surface treatments engineered to reduce optical losses at ultraviolet or infrared operational bands. Optional anti-reflective or wavelength-selective coatings may further be employed to maximize efficiency or to prevent back-scattering. In some embodiments, dopants such as cerium, titanium, indium tin oxide (ITO), zinc oxide (ZnO), or magnesium oxide (MgO), as previously described with regard to chamber top 2120 and chamber bottom 2130, may be incorporated into lens 2168 to modulate the transmission or reflectivity at ultraviolet or infrared wavelengths. Selection of particular dopant species or concentrations may be guided by the desired spectral selectivity, thermal stability, and compatibility with operational wavelengths targeted by heater assembly 2160.

Ultraviolet (UV) and infrared (IR) emitters may provide a novel means of heating precursor compositions and, in some cases, may present certain advantages over traditional resistive heating elements. One potential limitation, however, is that temperature may not be inferred from changes in resistance within the emitter, as is possible with resistive heating elements. Accordingly, it may be advantageous to incorporate an additional element capable of determining the chamber temperature.

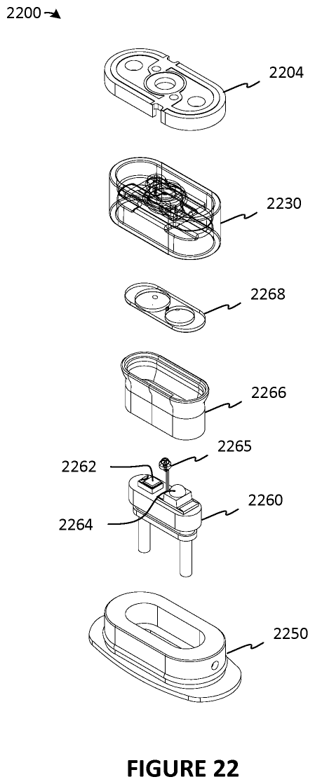

FIG. 22 illustrates an exploded view of a chamber assembly. Chamber assembly 2200 may comprise flow director 2204, chamber assembly 2230, optical assembly 2268, reflector 2266, heater assembly 2260, and lower chassis 2250. Many of the components forming chamber assembly 2200 may correspond to those in chamber assembly 2100, although, in alternative embodiments, different configurations or substitute components may be employed to achieve similar functionality.

Heater assembly 2260 may be implemented substantially similarly to heater assembly 2160, with the addition of sensor 2265. In certain embodiments, heater assembly 2260 may include UV emitter 2262, IR emitter 2264, and sensor 2265. Sensor 2265 may be adapted to monitor the temperature of the chamber or a sample contained therein. In various implementations, sensor 2265 may employ a range of temperature-sensing technologies, including, for example, a thermocouple, thermistor, resistance temperature detector (RTD), or semiconductor-based temperature sensor. Additionally, in some embodiments, sensor 2265 may comprise a miniature infrared (IR) sensor, such as a bolometer, thermopile, or pyroelectric sensor, which may be positioned to detect thermal or optical radiation within the chamber. The use of such sensors may enable contact or non-contact temperature monitoring, and in certain cases, allow for the detection of both IR and UV radiation, depending on the spectral emissions present within the chamber. Other suitable sensor types or configurations may be selected based on chamber geometry, desired measurement resolution, or compatibility with emitted radiation.

Optical assembly 2268 may be generally similar to lens 2168 while integrating additional functional features. Optical assembly 2268 may be configured to direct UV radiation, IR radiation, or a combination thereof, in order to facilitate heating of a precursor composition retained within chamber assembly 2200. In some implementations, optical assembly 2268 may include one or more convex lenses whose focal regions are designed to coincide at a common convergence point. Each lens may be selectively optimized for transmittance within either the UV or IR spectral ranges. The lenses may further be provided with distinct focal lengths to compensate for chromatic dispersion between the UV and IR spectral bands, thereby enabling simultaneous convergence of both wavelengths at a single spatial location.

As shown in FIG. 22, optical assembly 2268 may comprise two lenses laterally positioned along a common planar surface. In certain embodiments, only the lenses may function to direct radiant energy towards a precursor composition within the chamber, while the planar surface positions the lenses relative to one another. In some embodiments, this planar surface may be a reflective surface. This reflective surface may redirect unfocused energy toward reflector 2266, allowing further redirection through one or more lenses and thereby increasing overall efficiency. A reflective surface may be directly applied to optical assembly 2268 or may comprise an additional component.

In some embodiments, optical assembly 2268 may include a feature such as a cavity, boss, or other suitable geometry configured to couple with sensor 2265. It may be advantageous to position sensor 2265 as close to the common convergence point as physically possible, thereby enhancing the accuracy of temperature measurements in the region where radiant energy is concentrated.

While prior embodiments have disclosed the use of discrete ultraviolet (UV) and infrared (IR) emitters to provide energy for vaporizing a precursor, alternative embodiments may incorporate miniature light bulbs as a heating element. In particular, halogen light bulbs may be advantageous in this context, as they are capable of emitting both UV and IR radiation. Such bulbs frequently encase the filament in quartz, which may function to physically isolate the internal metallic filament from the precursor composition, as well as any generated vapor or aerosol. This configuration may reduce the risk of contaminant transfer from the heating element to the aerosol stream and may further enable a broader spectral emission profile to facilitate efficient vaporization.

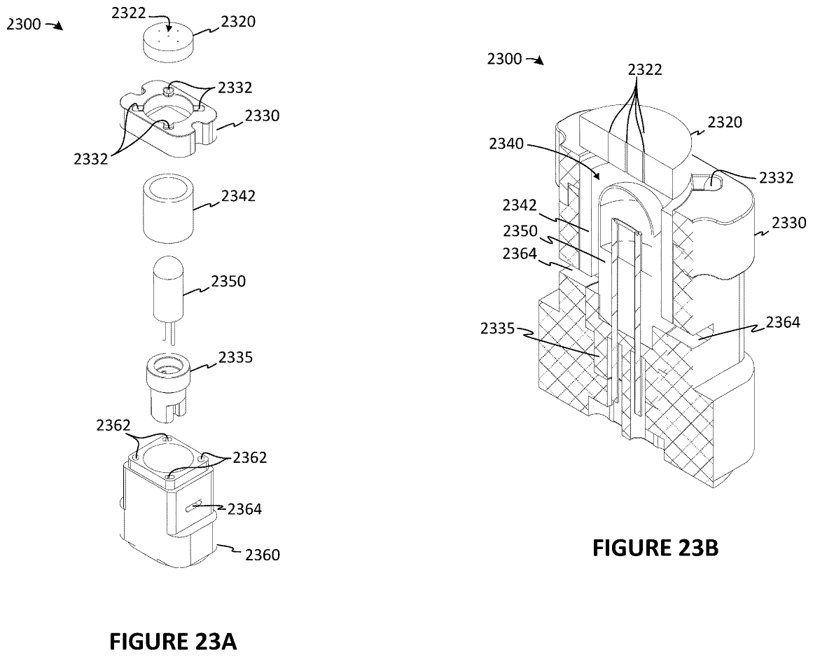

FIGS. 23A and 23B depict an exploded and a collapsed isometric view, respectively, of a chamber assembly. Chamber assembly 2300 may comprise dispenser 2320, upper gasket 2330, chamber sleeve 2342, heater 2350, base plug 2335, and lower chassis 2360.

Dispenser 2320 may be an example of dispenser 1100; however, alternative dispenser configurations may be suitable. Dispenser 2320 may include one or more channels 2322, which in some embodiments may take advantage of capillary action. In certain configurations, dispenser 2320 may function as a thermally mediated valve, regulating precursor flow by modulation of viscosity. In certain configurations, dispenser 2320 may function as a thermally mediated valve and entrainment mediated valve, regulating precursor flow by modulation of viscosity coupled to or in conjunction with the entrainment of the precursor by air flow through 2332 generating a high velocity flow in the region of dispenser 2320 that causes there to be a region of high pressure where the precursor is entrained in the air flow stream as has been previously described in detail herein. Dispenser 2320 may be positioned directly above chamber 2340, although other arrangements may be employed depending on device architecture.

Dispenser 2320 may be constructed out of similar materials and/or in a similar fashion as chamber top 1710 previously described herein. In an embodiment, dispenser 2320 may be constructed from fused silica that is absorptive to thermal energy, and/or IR and/or UV radiation. In an embodiment, dispenser 2320 may be constructed from a glass such a borosilicate or fused silica coated with a reflective metal layer such as aluminum, gold, or silver in order to be reflective to thermal energy, and/or IR and/or UV radiation. In an embodiment, dispenser 2322 may be constructed by fusing two or more layers of glass, such as borosilicate or fused silica with one or more layers of a metal that is reflective to thermal energy, and/or IR radiation, and/or UV radiation such as aluminum, silver, or gold such that the metal layer or layers or a metal coating or coatings is positioned between the layers of glass and then fused, by vacuum sintering or similar appropriate method, such that the top and bottom surface of the dispenser 2322 are glass, and the reflective layer is positioned between the top and bottom surfaces of dispenser 2322. In such an embodiment, it may be preferable to selectively coat, etch, or otherwise form the metal layer such that the channels 2322 are not in contact with the reflective metal layer and/or coating, to prevent the precursor from being exposed to the metal layer and/or coating when flowing through channels 2322.

Upper gasket 2330 may be configured to seal chamber 2340, lower chassis 2360, and other components comprising a vaporizing device. Upper gasket 2330 may include inlet channels 2332 to direct air flow, although alternative embodiments may include channels for directing vapor and/or aerosol. Inlet channels 2332 may receive air from corresponding inlet channels 2362 of lower chassis 2360 and transfer it into chamber 2340. Inlet air channels may be constructed to direct high velocity streams of flow across the surface of dispenser 2320 to entrain precursor liquid in the channels 2322 and/or present on the surface of dispenser 2320.

In an embodiment, inlet channels 2332 may be constructed to direct multiple high velocity streams of air across the surface of dispenser 2320 to entrain precursor liquid present in the channels in 2322 and/or present on the surface of dispenser 2320 such that the streams of air collide with each other in the central region of the surface of dispenser 2320 before passing over heater 2350 and through the chamber 2340, where the presence of multiple streams of air flow through inlet channels 2332 allow for higher flow velocities and enhanced entrainment of precursor liquid, and the collision of the multiple stream allows for the combining of the air flow streams and entrained precursor liquid for subsequent delivery to the heater 2350 and chamber 2340. In an embodiment, the inlet channels 2332 may be angled and/or offset such that the flow exiting inlet channels 2332 forms a rotation and/or vortical flow pattern across the surface of the dispenser 2320 and/or around the heater 2350 such that the flow through chamber 2340 is a rotation and/or vortical flow, where the distance traveled by the airflow and/or entrained liquid precursor in the air flow, and/or formed vapor, and/or formed aerosol through the chamber 2340 is increased by the rotational flow through the chamber 2340, and the transit time of the air flow, and/or entrained liquid precursor in the air flow, and/or formed vapor, and/or formed aerosol through the chamber 2340 is increased when compared to a non-rotation and/or non-vortical flow such that the exposure of the airflow and/or entrained liquid precursor in the air flow, and/or formed vapor, and/or formed aerosol to the heater 2350 is increased. In an embodiment, a rotational and/or vortical flow of the airflow and/or entrained liquid precursor in the air flow, and/or formed vapor, and/or formed aerosol through the chamber 2340 facilitates the conditioning of the aerosol to have smaller particle sizes (e.g., <5 micron) by prolonging the exposure of the flow to the heater, and through the entrainment of smaller particles within the vortical flow exiting through aerosol ports 2364. Detailed descriptions of the method(s) of particle size selection by vortical and/or rotational flow have been described herein. It may be desirable to manufacture upper gasket 2330 from materials that are compliant for forming a seal and chemically inert, such as silicone.

Chamber sleeve 2342 may define the internal wall(s) of chamber 2340. Chamber sleeve 2342 may be constructed to serve as a reflector such that chamber sleeve 2342 reflects thermal energy, and/or IR radiation, and/or UV radiation. Chamber sleeve 2342 may be constructed as a reflector by multiple approaches including but not limited to, constructing the chamber sleeve from a thermal, and/or IR, and/or UV reflective material such as aluminum, or by constructing the chamber sleeve 2342 from glass and applying a coating to the glass to form the reflector. Examples of materials that could be used to coat the glass include, but are not limited to, aluminum, gold, and silver coatings. Material selection for chamber sleeve 2342 may prioritize chemical inertness and thermal stability, with borosilicate glass serving as one example.

In an embodiment, the chamber sleeve 2342 may be comprised of a glass, such as borosilicate, that is coated on the external surface of the chamber sleeve 2342 with aluminum in order to reflect the thermal energy, and/or IR radiation, and/or UV radiation back into chamber 2340 in order to increase the efficiency of heating the chamber 2340 by the heater 2350 and preventing the escape of thermal energy, and/or IR radiation, and/or UV radiation from chamber 2340. The reflector may include micro-scale or nano-scale surface features to increase total surface area and/or internal reflectance of the reflector. Micro-scale and/or nano-scale features on the reflector may be constructed by surface preparation of the reflector surface that is coated and/or otherwise made reflective and/or by the reflective coating and/or reflective material and/or reflective layer directly.

While chamber sleeve 2342 may be illustrated as a cylinder in this example, other shapes or configurations may be used to suit particular embodiments. For example, chamber sleeve 2342 may have an external geometry that is cylindrical and an internal geometry that is parabolic to facilitate the reflection of thermal energy, and/or IR radiation, and/or UV radiation. In an embodiment, the chamber sleeve may have an external geometry that is cylindrical and internal geometry that is parabolic and reflective to thermal energy, and/or IR radiation, and/or UV radiation such that the chamber sleeve 2342 functions to reflect the thermal energy, and/or IR radiation, and/or UV radiation to the dispenser disc 2320. Material selection for chamber sleeve 2342 may prioritize chemical inertness and thermal stability, with borosilicate glass serving as one example.

Heater 2350 may be an example of heaters described herein. In an embodiment, heater 2350 may be configured to employ UV, IR, or combined UV/IR as a heating mechanism. Heater 2350 may include laser diodes, light emitting diode (LED), filament bulb, and/or other heater type and/or emitter types described previously and herein, or combinations thereof. For instance, combinations of lasers and LEDs may be arranged to generate both UV and IR radiation, intentionally exploiting interactions between electronic and vibrational molecular excitation.

Commonly available halogen bulbs may also serve as heater 2350, offering both UV and IR output. Such bulbs are typically encased in quartz, a generally chemically inert material, allowing precursor to be directly deposited and vaporized on its surface.

Base plug 2335 may function as a bottom boundary for chamber 2240 and provide a seal between heater 2350 and lower chassis 2360. It may also be used to position heater 2350 within chamber assembly 2300. Base plug 2335 may comprise geometry configured to suit a particular embodiment. Suitable materials for base plug 2335 may include chemically inert and compliant substances, such as silicone. Suitable materials for base plug 2335 may include chemically inert materials such as ceramics, and glasses such as quartz, fused quartz, and fused silica. Base plug 2335 may be functionally part of heater 2350 construction such that base plug 2335 and heater 2350 are a single component of the assembly. Base plug may be metallic component and be bonded the heater 2350. Suitable metals for forming a seal and/or bond between heater 2350 and base plug 2335 include, but are not limited to, nickel, copper, gold, silver, platinum, iron, chromium, and alloys like Kovar, and metals like zirconium, titanium, and aluminum. In such a configuration it may be desirable to have the base plug 2335 constructed from an predominantly inert metal such as stainless steel or titanium, and then sealed and/or bonded to the heater 2350 using one of the aforementioned materials, and be constructed in such a fashion as the bonding and/or sealing metal is not in the flow path and is not exposed to the airflow and/or entrained liquid precursor in the air flow, and/or formed vapor, and/or formed aerosol through the chamber 2340.

Lower chassis 2360 may be configured to provide structural support for chamber assembly 2300. In this embodiment, lower chassis 2360 may be configured to mate with base plug 2335 and upper gasket 2330, and may include air inlet channels 2362 to direct air from the underside of lower chassis 2360 into inlet channels 2332. Alternative embodiments may draw air from other locations and inlet channels 2362, 2332 may be configured appropriately. Lower chassis 2360 may also include aerosol ports 2364 near the chamber's base to allow vapor and/or aerosol to exit, although outlet positions may be modified depending on the embodiment.

In operation, dispenser 2320, when configured as a thermally mediated valve, may allow a precursor to flow to the ends of channels 2322. Upon activation, heater 2350 may transfer UV, IR, or combined UV radiation and IR radiation to the precursor, and other components comprising chamber 2340. As a precursor is heated, its viscosity may decrease to a threshold allowing it to flow through channels 2322 and onto heater 2350 for vaporization. Air may be supplied to chamber 2340 via inlet channels 2362 and 2332, where it may mix with the vaporized precursor to form an aerosol. The resulting aerosol may be directed out through aerosol ports 2364 for delivery to a user.

A stream of air, vapor, or aerosol may be conditioned by selective removal by mass and/or by size of particles present in the stream. Selective removal of particles from a stream of air, vapor, or aerosol may be accomplished by subjecting the stream to a tortuous flow path that includes impaction surfaces, regions of expansion, contraction, and directional changes, including directional changes that impart a rotation and/or vortical flow. Gasses moving between regions of expansion and contraction may experience pressure and velocity changes. As the stream enters a region of contraction, the gas velocity may increase, which can keep smaller particles suspended, while larger particles with greater inertia may deviate from the main flow or impact on surfaces due to their inability to change direction as readily. Conversely, in regions of expansion, the gas velocity may decrease, allowing particles with greater mass to settle or deposit onto surfaces as their momentum carries them out of the primary airflow. Directional changes, such as bends or impaction surfaces, may further encourage the deposition of larger or denser particles by exploiting differences in particle inertia, thereby enhancing selective removal from the gas or aerosol stream. Rotational flow and/or vortical flow facilitates targeted separation of particles by size and/or mass by imparting a centrifugal force on the particles present in the gas, as has been described in detail previously herein. This combination of pressure, velocity, and directional changes along the flow path may facilitate targeted separation of particles based on their size, mass, or inertia prior to delivery to the user.

Previously described inlets and outlets may be configured to include tortuous flow geometry, which could be designed to condition streams of air, vapor, or aerosol prior to delivery or after generation. Tortuous flow geometry may take the form of one or more channels incorporating directional changes, impaction surfaces, or constrictions, and could be implemented using a variety of structural arrangements, such as spiral channels, labyrinthine inserts, expansion regions and/or chambers, and/or baffle systems. The incorporation of tortuous flow paths within vaporizing devices may enhance the selective removal of particles, promote condensation control, or otherwise modify the characteristics of the aerosolized stream.

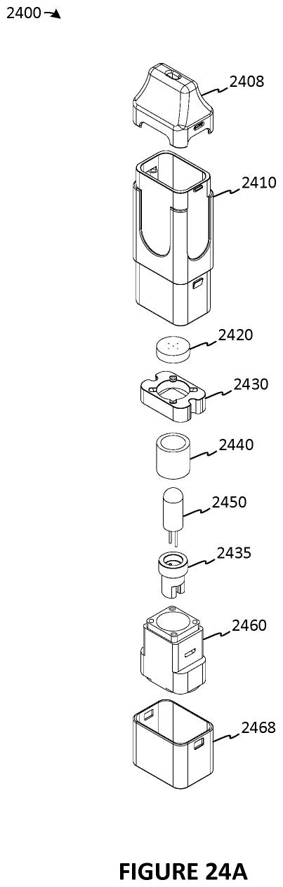

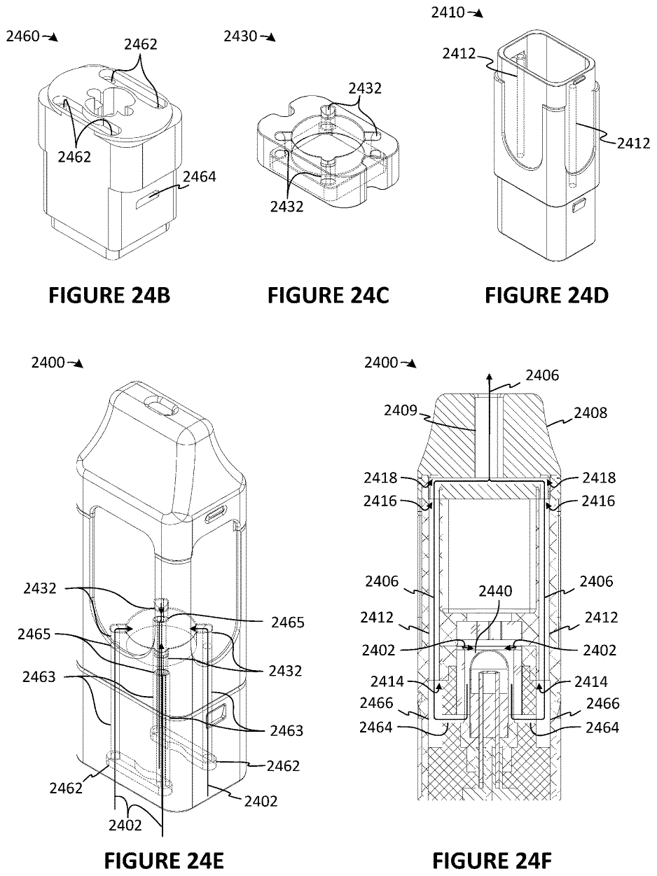

FIGS. 24A through 24F illustrate air inlet, precursor liquid inlet, and outlet flow paths for a vaporizer assembly. FIG. 24A provides an exploded view of vaporizer assembly 2400. FIG. 24B presents an isometric view of the bottom of lower chassis. FIG. 24C depicts an isometric view of upper gasket 2430. FIG. 24D is an isometric view of reservoir 2410 including aerosol channels 2412. FIG. 24E is an isometric view of vaporizer assembly 2400 featuring an air inlet flow path. FIG. 24F is a cross section of vaporizer assembly 2400 illustrating an outlet flow path. Together, these figures may illustrate examples of inlets (e.g., inlet 150, 250, 350, 450, 550, 650, 750) and outlets (e.g., outlet 160, 260, 360, 460, 660, 760) for vaporizing devices. Vaporizer assembly 2400 may comprise mouthpiece 2408, reservoir 2410, dispenser 2420, chamber 2440, heater 2450, base plug 2435, lower chassis 2460, and base cap 2468.

Inlets 2462 may be positioned on the underside of lower chassis 2460 in this embodiment; however, it should be understood that inlets 2462 may be located anywhere that is convenient. Inlets 2462 may begin with an expansion region that may reduce flow velocity and promote turbulence to increase dwell time and begin pre-heating air 2302 as it enters vaporizing assembly 2400. Preheated air 2302 may prevent condensation or agglomeration of aerosolized particles downstream and help to maintain proper aerosolization at high flow velocities. As air 2302 continues forward, the flow reaches laminar region 2463, which may have a largely uniform cross-section with a gentle taper in some embodiments. This geometry may encourage laminar flow to help align air movement and limit eddy currents, while also modulating air velocity before the flow encounters impaction surfaces 2465 located at the terminal ends of laminar regions 2463.

Impaction surfaces 2465 and sharp directional changes comprising channels 2432 may be located in proximity to chamber 2440 and may disrupt laminar flow and generate localized turbulence or swirling flow patterns to increase dwell time as air 2302 passes into channels 2432, giving air 2302 time to absorb residual heat from chamber 2440. Channels 2432 may be distributed around chamber 2440 and configured to evenly distribute air 2302 into chamber 2440 for aerosol generation.

Inside chamber 2440, air 2302 may entrain liquid precursor from dispenser 3300. Inside chamber 2440, air 2302 may entrain vapor generated by heating a liquid precursor, resulting in the formation of aerosol 2406. Aerosol 2406 may exit the chamber through aerosol ports 2464 located near the bottom of chamber 2440, after which it travels to expansion regions 2466. The abrupt increase in cross-sectional area may cause aerosol 2406 velocity to decrease, resulting in a turbulent flow regime that may promote enhanced mixing and increased residence time. As a result, temperature gradients within aerosol 2406 may be minimized, and further opportunities arise for particle agglomeration, breakup, disassociation, and selective removal based on particle size and/or particle mass.

After moving through expansion regions 2466, aerosol 2406 may impinge on impaction surfaces 2414. Larger droplets and particles, unable to follow the redirected or swirling turbulent flow, may be removed from the stream via inertial impaction and gravitational settling.

Aerosol 2406 may now enter aerosol channels 2412 of reservoir 2410. These channels may comprise generally consistent cross-sections to promote laminar flow and help ensure uniform aerosol delivery. In certain embodiments, aerosol channels 2412 may taper slightly to accelerate aerosol 2406 before it encounters downstream impaction surfaces 2416 and abrupt directional changes 2418 within mouthpiece 2408. Each successive impaction surface and directional change may contribute to aerosol 2406 conditioning by removing larger particles through impaction and/or gravitational settling. Particles that are removed by impaction and/or gravitational settling may return to chamber 2440 by flowing and/or settling through aerosol channel 2412 and aerosol ports 2464 for conversion to a vapor in a subsequent activation cycle.

Opposing streams of aerosol 2406 may recombine near exit port 2409. This may be a region of turbulence, vortices, or eddy currents that may enhance mixing and increase uniformity of the aerosol 2406 stream. Aerosol may finally pass through exit port 2409, a region promoting laminar flow, for delivery to a user.

FIGS. 24A through 24F described embodiments of inlet and outlet flow paths that may be used to condition streams of air, vapor and/or aerosol. These flow paths may be adapted to suit various embodiments of vaporizers, and/or vaporizer devices, and/or vaporizer assemblies described herein.

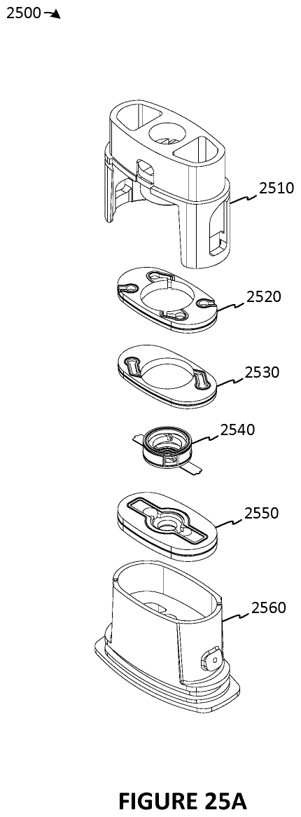

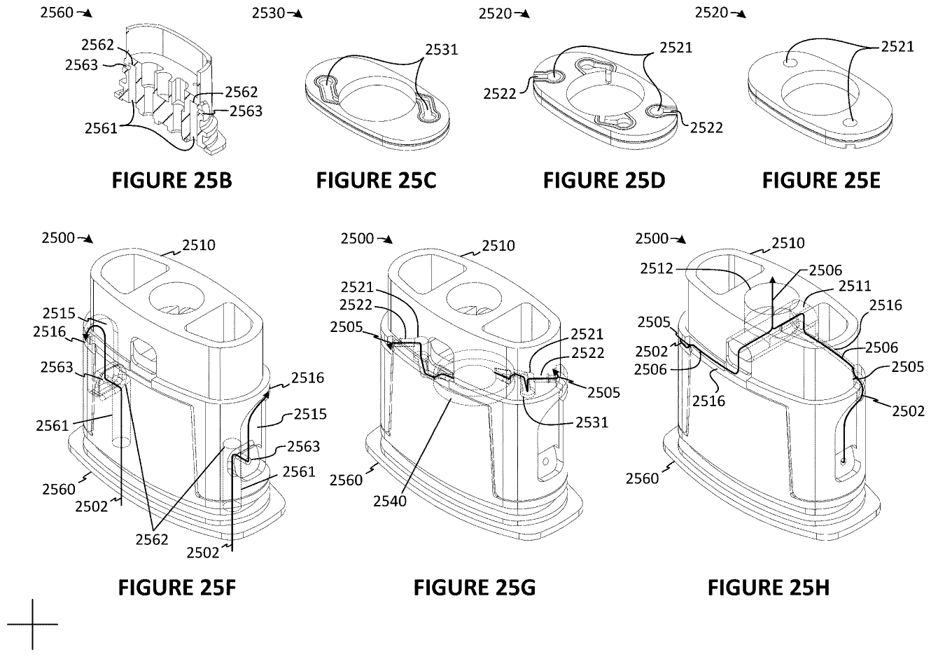

FIGS. 25A through 25H illustrate air inlet, precursor liquid inlet, and outlet flow paths of vaporizer assembly. FIG. 25A provides an exploded view of vaporizer assembly 2500. FIG. 25B presents a cross-section of lower chassis 2560. FIG. 25C depicts an isometric view of mid seal 2530. FIGS. 25D and 25E show top and bottom isometric views of precursor inlet seal 2520. FIG. 25F illustrates an air inlet flow path within vaporizer assembly 2500, FIG. 25G depicts a vapor flow path extending from chamber assembly 2540, and FIG. 25H demonstrates an aerosol outlet flow path associated with vaporizer assembly 2500. Vaporizer assembly 2500 may comprise upper chassis 2510, precursor inlet seal 2520, mid seal 2530, chamber assembly 2540, lower seal 2550, and lower chassis 2560.

FIG. 25B provides a cross-sectional view of lower chassis 2560, illustrating features such as inlets 2561, impaction surfaces 2562, and lower chassis outlets 2563. During operation, when suction is applied at outlet 2512, air 2502 may be drawn through vaporizer assembly 2500. Air 2502 may enter vaporizer assembly 2500 at inlet 2561 positioned at the bottom of lower chassis 2560. Inlet 2561 may encourage laminar air flows along a relatively straight path having a consistent cross-section until the stream approaches impaction surface 2562.

Lower chassis outlet 2563 may be positioned perpendicular to inlet 2561 near impaction surface 2562. Upon encountering a directional change, such as at the junction of impaction surface 2562 and lower chassis outlet 2563, airflow of air 2502 is transitioned from a laminar flow as is present at inlets 2561 to a turbulent airflow secondary to the impaction of the laminar air 2502 airflow on impaction surface 2562. The turbulent air 2502 airflow may serve to increase the transit time of air 2502 from inlets 2561 to lower chassis outlet 2563. The flow path from inlets 2561 to lower chassis outlet 2563 is part of lower chassis 2560 which is heated during activation. Increasing the transit time of air 2502 flowing from inlets 2561 to lower chassis outlets 2563 may serve to allow for heating of air 2502 before it exits the lower chassis outlet 2563. Heating of air 2502 may serve several functions to improve aerosol 2506 production and delivery including, but not limited to: production of an inhalable aerosol that is at a temperature that is optimized for inhalation, prevention, mitigation of the aerosol 2506 particles from condensation or agglomerating that may occur if the aerosol 2506 was exposed to an airflow that is cooler than aerosol 2506, increasing the air 2502 temperature sufficiently such that the airflow remains heated even when the flow velocity is increased when the air 2502 exits lower chassis outlet 2563 into expansion region 2515, and/or is sufficiently heated that the air 2502 remains heated when it undergoes an increase in the velocity of the airflow of air 2502 when the flow exits the expansion region 2515 to the constriction region 2516. In an embodiment air 2502 is heated along the flow path between inlets 2561 and lower chassis outlets 2563 such that the air 2502 is a heated high velocity flow when the air 2502 mixes with aerosol 2506. Heating of air 2502 may also serve to cool the lower chassis 2560 and upper chassis 2510 by transferring excess heat generated during activation into intake air 2502, and then to vapor 2505, and aerosol 2506.

Impaction surface 2562 may serve to generate eddy currents or vortical patterns in the flow path between inlets 2561 and lower chassis outlets 2563. Where eddy currents or vortical patterns in the flow path are established, such as in cavities or expansion regions, the flow path is turbulent and no longer facilitates laminar flow. The residence time of the air 2502 is increased when the flow is turbulent. The increase in the residence time of the air 2502 allows for additional time to heat the air 2502 before the flow exits lower chassis outlets 2563. Although impaction surface 2562 is shown in this embodiment, other structures and/or geometries may be used to generate a turbulent flow such as regions of expansion and/or contraction along the flow path, baffles, non-laminar flow directing features such as prominences, depressions, ridges, edge features, face features and similar.

Vaporizer assembly 2500 may be integrated into a housing, such as reservoir 901 (not illustrated). The housing, together with lower chassis 2560 and upper chassis 2510, could define expansion region 2515. Upon exiting inlets 2561 and passing through lower chassis outlet 2563, air 2502 may enter expansion regions 2515. Lower chassis outlet 2563 might constitute an area of restricted flow, thereby increasing air velocity; upon release into the comparatively larger cross-section of expansion region 2515, a rapid reduction in flow velocity and dynamic pressure may ensue. Additionally, expansion region 2515 may be constructed such that the large surface area has a thin wall that is in contact with lower chassis 2560 and the surface of expansion region 2515 is heated by proximity to the heater located in lower chassis 2560. The rapid reduction in flow velocity and dynamic pressure of air 2502 in expansion region 2515 may serve to facilitate heat transfer from expansion region 2515 to air 2502. Air 2502 then exits into constriction region 2516 where air velocity is increased and laminar flow is established such that the air 2502 is a heated high velocity laminar flow when it mixes with aerosol 2506 and vapor 2505 exiting vapor channels 2522.

Expansion region 2515 may thus act to enhance turbulent flow, encourage increased transit time of air 2502 flow through expansion region 2515, and increase the heating of air 2502 airflow from interaction with the heated surface of expansion region 2515. Additional flow direction features may be present in expansion region 2515 to increase the turbulence of flow and increase transit time of air 2502 through the expansion region 2515 such as those previously described, including impaction surfaces. Additionally, expansion region 2515 may be constructed to be highly thermally conductive to facilitate heat transfer from the expansion region 2515 to air 2502. Furthermore, the expansion region may be constructed with features that increase the total surface area of expansion region 2515, including large and/or small-scale features. Large features may include ridges and/or grooves along the primary surface of expansion region 2515 which may also serve as flow directing features. Small scale features may include constructing the surface of the expansion region 2515 such that it is a rough surface to increase the surface area. Small scale features may include micro-scale and/or nano-scale surface features.

Air 2502 may subsequently transition from expansion region 2515 to a downstream constriction region 2516. Constricted region 2516 may be formed between upper chassis 2510, lower chassis 2560, and a housing (not illustrated), or, in some embodiments, entirely within one component and may accelerate the airflow, thereby preparing air 2502 for mixing with vapor 2505 generated in chamber assembly 2540. The accelerated airflow may function to increase the entrainment of vapor 2505 by generating a region of higher pressure that draws vapor 2505 into the air 2502 airflow to form aerosol 2506. The accelerated airflow exiting constricted region 2516 may also function to entrain particles of smaller mass and/or size and thus serve as a means of particle size selection for formation of aerosol 2506. Additionally, the accelerated flow of air 2502 flowing past vapor channels 2522 may exert a vacuum pressure on chamber assembly 2540, where the vacuum pressure serves to reduce the vapor pressure of the liquid precursor and thus reduce the boiling point temperature of the liquid precursor such that less thermal energy and/or heating time is required to transition the liquid precursor to a vapor.

A liquid precursor in chamber assembly 2540 may be vaporized via applied heat, producing vapor 2505 and elevating chamber pressure. Vapor 2505 may flow from chamber assembly 2540 into vapor channels 2522 due to vapor pressure resulting from heating the precursor, suction, or both. Vapor channels 2522, which may be analogous to previously described outlets, could be configured to include tortuous flow geometry, impaction surfaces, regions of expansion, regions of contraction, and other previously described features to condition vapor 2505 and/or to select for specifically sized particles and/or particles of a particular mass present in vapor 2505 to mix with air 2502 to form aerosol 2506. In the illustrated embodiment, vapor channels 2522 are defined by features 2531 of mid seal 2530 and precursor inlet seal 2520. Alternative configurations may employ other structures.

As vapor 2505 traverses these vapor channels, it may undergo sharp directional changes, such as the transition from vapor channel 2521 to vapor channel 2522 within precursor inlet seal 2520. In one embodiment, vapor channel 2521 may be substantially cylindrical, extending from the bottom to the top of precursor inlet seal 2520, and vapor channel 2521 may provide a vertical, laminar flow region. Here, larger particles may impact the top of the vapor channel which may function as an impaction surface and/or settle under gravity, facilitating their removal from the vapor stream prior to subsequent processing or delivery to a user. Larger particles that are removed from vapor 2505 by impaction, settling, agglomeration, loss of inertia, or otherwise escaping entertainment from the flow of vapor 2505 may return to chamber 2540 by flowing in the reverse direction of the flow of vapor 2505 through vapor channel 2521 and vapor channel 2231 to be returned to the precursor liquid volume present in the chamber 2540.

A further sharp directional change may occur as vapor 2505 moves from vapor channel 2521 to vapor channel 2522. Particles of relatively high mass that do not settle within vapor channel 2521 may, due to inertia, be unable to follow altered streamlines, thereby impacting upon internal surfaces, such as those defined by the upper chassis 2510. Vapor 2505 may then pass through vapor channel 2522 for introduction into constriction region 2516. Vapor 2505, when exiting vapor channel 2522, may be entrained by an accelerated high velocity flow of air 2502 passing through constriction region 2516 where the flow of air 2502 is generating a lower pressure than the flow of vapor 2505 and the vapor 2505 is drawn into the region of lower pressure where the constriction region 2516 functions as a Venturi constriction and the vapor channel 2522 exit is constructed to exit into the center region of the constriction region 2516 that functions as a Venturi constriction. This flow can be mathematically defined by Bernoulli's principle and equations, namely the compressible fluid flow equation:

$$\frac{{v}^{2}}{2} + {\int }_{{P}_{1}}^{P} \frac{d \underline{p}}{ρ ( \underline{p} )} + ψ = constant ( along a streamline )$$

where p is the pressure, ρ is the density and ρ (p) indicates that it is a function of pressure, v is the flow speed, Ψ is the potential associated with the conservative force field, often the gravitational potential. The above equation can also be applied as it relates to the ideal gas law and becomes the following equation:

$$\frac{{v}^{2}}{2} + g z + ( \frac{γ}{γ - 1} ) \frac{p}{p} = constant ( along a streamline )$$

where, in addition to the terms listed above, γ is the ratio of the specific heats of the fluid, g is the acceleration due to gravity, z is the elevation of the point above a reference plane.

Within constriction region 2516, air 2502, traveling at increased velocity due to prior acceleration, may encounter vapor 2505 as it exits vapor channel 2522. Owing to the Venturi effect, the high-velocity air may facilitate withdrawal of vapor 2505 from chamber assembly 2540 and promote its efficient entrainment, yielding a mixed aerosol 2506 stream. In addition, the higher velocity and lower pressure flow of air 2502 through constriction region 2516 may preferentially select for vapor 2505 particles of smaller size and/or mass due to the lower inertia of these particles. The larger particle in size and/or mass may remain in the vapor channel 2522 due to having a larger inertia and resultantly being less prone to be entrained into the flow of air 2502, and undergo agglomeration, conglomeration, condensation, impaction, collection and other interaction with other non-entrained particles such that these particles may transition from the vapor 2505 phase back into the precursor liquid form and return to vapor channel 2521 and then to chamber assembly 2540 to become part of the precursor liquid volume in chamber assembly 2540. In an embodiment, the flow of air 2502 through construction region 2516 preferentially entrains vapor 2505 particles 0.01 micron to 5 microns in diameter for mixing into formed aerosol 2506.

Aerosol 2506 may then be directed through constriction region 2516 before encountering another sharp directional change at expansion region 2511. Expansion region 2511, characterized by a relatively large cross-section, may promote a low-velocity, turbulent flow environment that encourages further particle mixing, aggregation, dissociation or breakup, and increases particle-surface collisions. As before, smaller or less dense particles remain preferentially entrained, while larger particles are more likely to deposit on interior surfaces.

Finally, aerosol 2506 may exit through outlet 2512, which may be configured to promote laminar flow in the final delivery segment. In some embodiments, outlet 2512 may have a uniform or gradually narrowing cross-section to help maintain laminar flow and potentially increase aerosol velocity prior to user delivery. Outlet 2512 may be constructed to have impaction surfaces, flow directing features, and other such features described herein to condition the aerosol 2506 prior to delivery to the user through the outlet 2512. Larger remaining particles may be removed by settling under gravity, and other methods and processes described herein while smaller constituents entrained in aerosol 2506 continue toward the outlet, thereby providing a conditioned aerosol 2506 suitable for inhalation and deposition into the deep lung.

Introducing air at ambient temperature into a vaporization chamber can reduce the efficiency of a vaporizing device, since some of the energy intended to heat precursor compositions is instead consumed in warming the incoming air. Flow paths may be constructed to capture residual heat from vaporization and use it to preheat the air before it enters the chamber. In addition, the incoming air can serve as thermal insulation, shielding certain device components from the chamber's heat as well as serving as a thermal insulating layer the flow of air may remove excess heat from the assembly as has been described previously herein. Such flow paths may direct the air around the chamber's outer perimeter, simultaneously preheating it and carrying it back into the chamber while also functioning to cool the device components by removal of excess heat from the system.

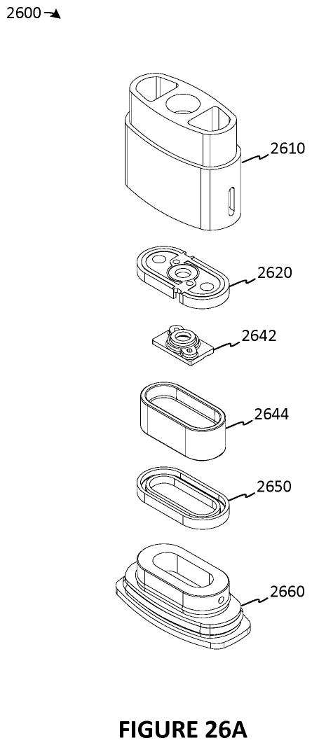

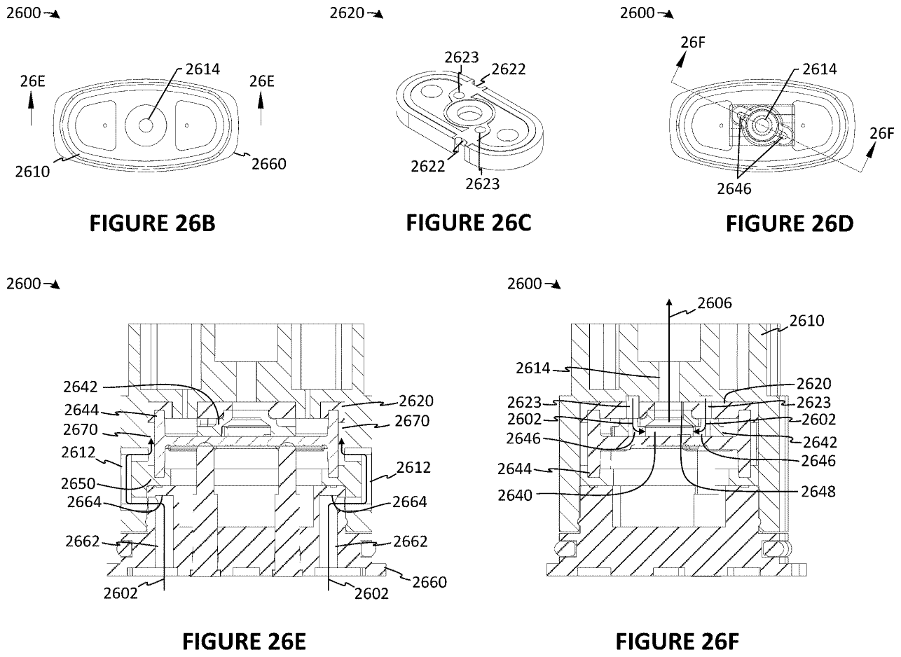

FIGS. 26A through 25F illustrate an inlet and outlet flow path for a vaporizer assembly. FIG. 26A provides an exploded view of vaporizer assembly 2600. FIGS. 26B and 26D show top views of vaporizer assembly 2600. FIG. 26C is an isometric view of precursor inlet seal 2620. FIGS. 26D and 26E present cross-sections of vaporizer assembly 2600.

Vaporizer assembly 2600 may comprise upper chassis 2610, precursor inlet seal 2620, chamber top 2642, chamber housing 2644, lower seal 2650, and lower chassis 2660. Some components comprising vaporizer assembly 2600 may be analogous to chamber assembly 2000.

Lower chassis 2660 may include one or more inlets 2662 to direct a stream of incoming air 2602 into vaporizer assembly 2600. In an embodiment, inlets 2662 may be configured to draw intake air 2602 from a bottom surface of lower chassis 2660 and transfer it to channels 2612. Inlets 2662 may include an entrance promoting turbulence. Turbulence may increase the dwell time of air 2602 to bring it into thermal equilibrium with components comprising vaporizing assembly 2600. Inlets 2662 may transition from a region promoting turbulence to a region having a relatively uniform cross section promoting laminar flow. The terminal ends of inlets 2662 may include impaction surfaces 2664 and sharp directional changes directing air 2602 to channels 2612.

Channels 2612 may be integrated into upper chassis 2610 in this embodiment. Channels 2612 may subject air 2602 to one or more directional changes as it progresses through upper chassis 2610. These directional changes may promote the transition between laminar and turbulent regimes, increasing the residence time of air 2602 and encouraging more effective heat transfer or particle conditioning. While channels 2612 may appear to be open conduits in the illustrated embodiment, in practice vaporizer assembly 2600 may be enclosed, for instance, within a reservoir analogous to reservoir 901, thereby sealing channels 2612 from the outside atmosphere. In certain configurations, channels 2612 may assume tortuous geometries to further extend flow path length, or may incorporate additional impaction surfaces for enhanced particle conditioning. Channels 2612 may ultimately direct a conditioned stream of air 2602 into surrounding cavity 2670.

Surrounding cavity 2670 may be a void defined by the contiguous boundaries of upper chassis 2610, precursor inlet seal 2620, chamber housing 2540, and lower chassis 2660, forming a void encircling chamber 2640. As air 2602 traverses surrounding cavity 2670, it may absorb residual or conducted heat from an outer surface of chamber 2640, thereby serving to preheat air 2602 prior to its introduction into chamber 2640. In some embodiments, the walls of surrounding cavity 2670 may be thermally conductive and may be augmented with surface features designed to enhance convective heat transfer by promoting turbulent flow. These features may further act to extend the residence time of air 2602, allowing for more uniform thermal conditioning, while simultaneously providing an insulating barrier to reduce heat transfer to external device components and maintain system efficiency.

Preheated air 2602 may subsequently be directed from surrounding cavity 2670 into one or more air channels 2622 disposed along a side of precursor inlet seal 2620. Each air channel 2622 may be defined as a void bounded by an upper surface of precursor inlet seal 2620 and an interior surface of upper chassis 2610, and may include one or more directional changes or flow deflectors to induce tortuosity, further conditioning the flow of air 2602. Air 2602 may be transferred into air channels 2623, which in certain embodiments may comprise through-holes in precursor inlet seal 2620. As air 2602 transits from air channels 2622 to 2623, it may experience multiple abrupt directional changes, creating a series of virtual impaction regions which may facilitate removal of larger particles or promote uniform mixing prior to downstream introduction.

Air channels 2623 may transfer air 2602 from precursor inlet seal 2620 to inlet channels 2646. Inlet channels 2646 may comprise through-holes in chamber top 2642 having a relatively consistent cross section configured to maintain laminar flow and minimize pressure drop as preheated air 2602 is directed substantially perpendicular to chamber 2640. Supplying air in this manner from the peripheral margin of chamber 2640 may facilitate the generation of shear layers or induce vortical mixing, thereby enhancing the homogenization of temperature and supporting dispersion of vapor within the chamber. In alternative configurations, inlet channel cross-sections may be tapered, or additional flow conditioning features may be incorporated to further tailor flow characteristics and promote efficient vapor-air interaction.

Upon entering chamber 2640, air 2602 may be a high velocity flow that generates a region of low pressure where the proximity of air channels 2623 exit in relation to the exit of precursor inlet channels 2646 into chamber 2640 results in at least some entrainment of precursor flowing through inlet channels 2646 into air 2602 exiting air channels 2623 such that the flow rate of precursor liquid into chamber 2640 is coupled to the flow rate of air 2602 into chamber 2640. The coupling of flow rates of both the precursor liquid and the air flow entering the chamber 2640 may facilitate a user titratable delivery of aerosol by the user, such that the users inhalation rate determines the flow rate of the intake air 2602 through inlets 2662, and then through air channels 2622, and then through air channels 2623 and the flow rate through air channels 2623 determines the flow velocity of air 2602 and the flow velocity of air 2602 directly relates to the pressure change (e.g., degree of lowered pressure) that functions to at least partially entrain precursor flowing through inlet channels 2646, such that the entrainment of precursor flowing through inlet channels 2646 at least partially controls the flow rate of precursor. The inhalation flow rate of the user may further function to at least partially control the rate of precursor flow through the entire system as inlet channels 2646 may be constructed to be the flow controlling region, and/or region of lowest precursor flow rate, such that the flow rate through inlet channels 2646 directly controls the precursor flow rate through the rest of the precursor liquid dispenser assembly.

Upon entering chamber 2640, air 2602 may mix with vapor generated within chamber 2640 to form aerosol 2606. The peripheral introduction of air 2602 may give rise to vortical or turbulent rotational flow within chamber 2640, enhancing mixing between air 2602 and vapor promoting efficient aerosolization. Chamber 2640 may comprise an upper region having a tapered or gradually constricting cross-section, which, according to the continuity equation, may act to increase the velocity of the forming aerosol 2606 as it ascends. The resulting aerosol 2606 may then encounter impaction surface 2648. Larger constituents comprising aerosol 2606, due to their greater inertia, may fail to navigate the changing streamlines and thus impact upon the surface and be returned to chamber 2640 for re-vaporization. This impaction process may preferentially select for smaller particles to remain in the aerosol 2606 stream. Finally, aerosol 2606 may pass through outlet 2614, which in some embodiments may feature a region of relatively uniform cross section to foster the reestablishment of laminar flow and ensure a consistent, conditioned aerosol 2606 stream for delivery to a user. In an embodiment, the mass of aerosol delivered to the user during activation is titratable by the user where the inhalation characteristics of user during use and activation, include but are not limited to, inhalation rate, inhalation duration, and inhalation variation. One or more of these characteristics, in an embodiment, correlate to the velocity of intake airflow into the chamber, and the intake airflow velocity at least partially controls the flow rate of precursor liquid into the chamber that is then heated to a vapor to then be mixed with intake airflow to form the aerosol for inhalation by the user.

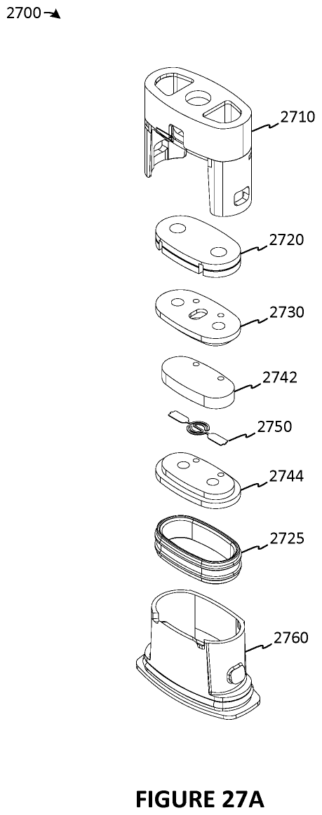

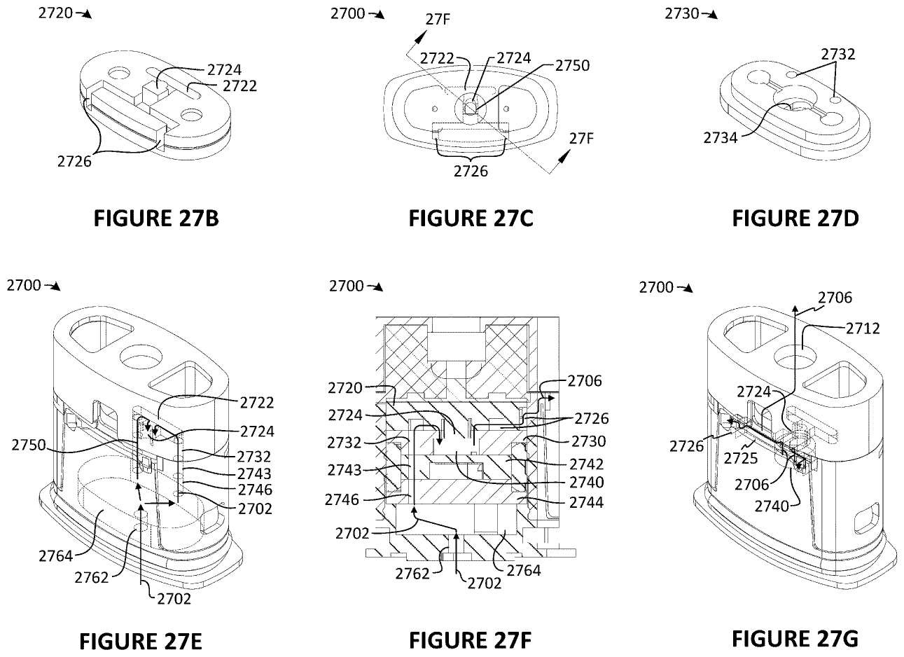

FIGS. 27A through 27G present an inlet and outlet flow path for another embodiment of a vaporizer assembly. FIG. 27A provides an exploded view of vaporizer assembly 2700. FIG. 27B is an isometric view of the bottom side of upper seal 2720. FIG. 27C illustrates a top view of vaporizer assembly 2700. FIG. 27D illustrates an isometric view of the bottom side of flow director 2730. FIGS. 27E and 27G are isometric views of an inlet and outlet flow path, respectively. FIG. 27F shows a cross section of vaporizer assembly 2700.

Vaporizer assembly 2700 may comprise upper chassis 2710, upper seal 2720, flow director 2730, upper housing 2742, heater 2750, lower housing 2744, outer seal 2725, and lower chassis 2760. Vaporizer assembly 2700 may, in a general sense, operate in accordance with other vaporizer designs disclosed herein, but may introduce alternative airflow features or methods of operation.

Lower chassis 2760 may include one or more inlets 2762, each comprising a channel of substantially uniform cross section to encourage laminar flow of air 2702 into the device. Inlet 2762 may deliver air 2702 directly into expansion chamber 2764. Expansion chamber 2764 may comprise a relatively large internal volume bounded by the interior of lower chassis 2760 and the bottom surface of lower housing 2744 and may be characterized by a significant increase in flow cross section. This transition may produce a reduction in flow velocity and a shift from laminar to turbulent flow regime. The resulting turbulence may prolong air 2702 residence time, thereby facilitating heat transfer from lower housing 2744 and lower chassis 2760. Surface features such as baffles, ridges, or non-uniform geometries may be optionally integrated to further modulate turbulence intensity or increase surface area for heating.

Lower housing 2744 may include one or more channels 2746 coupled to expansion chamber 2764. These channels 2746 may comprise consistent cross sections to promote laminar flow as air 2702 exits the turbulent expansion chamber 2764. Laminar flow in this region may reduce flow losses and particle deposition along the wall. Upstream, channels 2746 may interface with channels 2743 of upper housing 2742 and subsequently with channels 2732 of flow director 2730, preserving a controlled flow profile through each region. Channels 2732 may ultimately deliver air 2702 to intake channel 2722 within upper seal 2720. Intake channel 2722 may promote low velocity, turbulent flow patterns that may increase in velocity as the flow of air 2702 is supplied to chamber 2740 through diverter 2724.

Diverter 2724 may be configured to mate with aerosol port 2734 of flow director 2730. In this example, diverter 2724 may bifurcate aerosol port 2734 into discrete input and output pathways to chamber 2740. The input side and output side of diverter 2724 may include architecture specific to the input or output function. For example, in an embodiment, the input side of diverter 2724 may comprise a crescent-shaped channel configured to deliver a high velocity flow of air 2702 near the periphery of chamber 2740 to mix with vapor generated in chamber to form aerosol 2706, while the output side may include geometry configured to minimize flow resistance. In some embodiments, diverter 2724 may include geometry configured to produce a vortical, or swirling, flow within chamber 2740 to enhance mixing.

Aerosol 2706 generated within chamber 2740 may exit via outlet 2726, which may couple to aerosol port 2734. Outlet 2726 may initially divide a stream of aerosol 2706 exiting aerosol port 2734 into multiple streams. Downstream, each of these streams may be encouraged to achieve laminar flow before being subjected to multiple impaction surfaces and directional changes designed to induce local turbulence and selectively remove larger or higher-inertia particles from the aerosol 2706 stream.

The divided aerosol 2706 streams may then be directed through aerosol channel 2766. Aerosol channel 2766 may be constructed to recombine streams approaching from opposing directions, resulting in a region of elevated turbulence or shear where recirculating vortices may develop. This region of complex flow may facilitate enhanced re-mixing and promote uniform dispersal of any remaining particles, further conditioning the aerosol phase. Additionally, this region of complex flow may facilitate increased dwell and/or transit time of aerosol 2706 for re-mixing and promote uniform heating and dispersal of any remaining particles, enhancing the formation of smaller more uniform particles present in the aerosol 2706 phase. The combined stream may then be directed toward outlet 2712.

Outlet 2712 may comprise a channel formed within upper chassis 2710, featuring a relatively large cross-sectional area intended to support low-velocity laminar flow of aerosol 2706 prior to user delivery. Outlet 2712 may subject the aerosol 2706 stream to a directional change that may remove residual larger particles (e.g., >5 micron) and enhance mixing uniformity of smaller particles (e.g., <5 micron) before the stream exits the device via outlet 2712.

Because inlet and outlet flow paths may communicate with a vaporization chamber containing a liquid precursor, they may also serve as potential conduits for leakage. Leakage may occur during normal use from device orientation, and/or from environmental conditions such as elevated temperature and/or atmospheric pressure changes such as those that occur with increased elevation. Accordingly, some embodiments may incorporate valves at one or more locations along the flow paths to mitigate undesired leakage of the liquid precursor. These valves may take the form of, for example, flap valves, check valves, duckbill valves, poppet valves, ball-and-spring valves, or membrane-based valves; however, other types of valves may be suitable. The use of valves that are thermally mediated to control the flow of a thermoviscous precursor liquid may be used to control flow such that the flow of the precursor liquid though flow channels only occurs when the channels and liquid precursor within in the channel(s) is heated sufficiently to reduce the viscosity of the precursor liquid sufficiently to permit flow. The particular positioning and selection of such valves may be guided by the intended flow characteristics, device orientation, or liquid properties, and could be varied depending on specific use-case considerations.

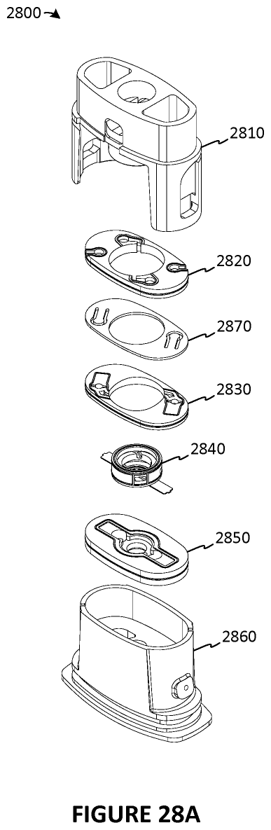

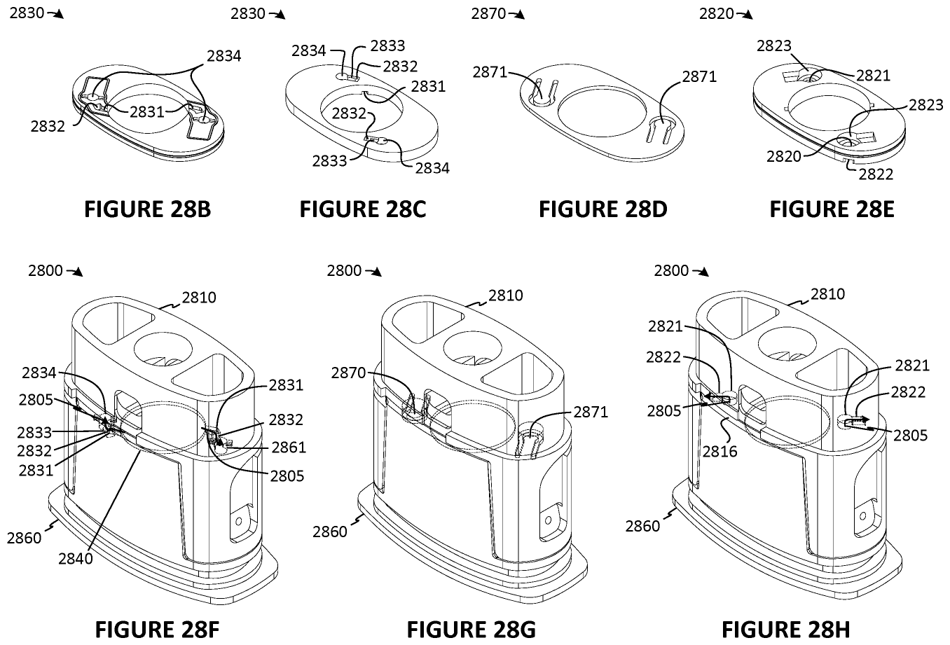

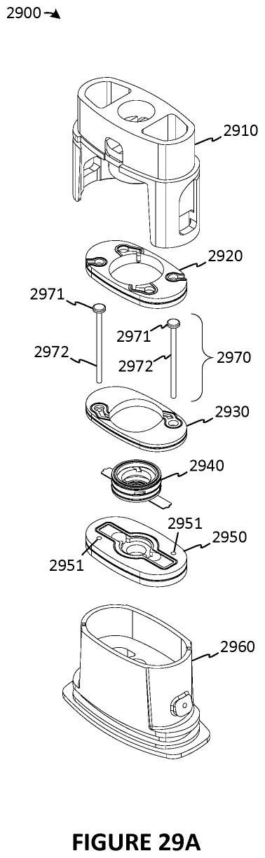

FIGS. 28A through 28H illustrate an outlet flow path including valves for a vaporizer assembly. FIG. 28A provides an exploded view of vaporizer assembly 2800. FIGS. 28B and 28C show top and bottom isometric views of mid seal 2830. FIG. 28D presents an isometric view valve assembly 2870. FIG. 28E depicts an isometric view of precursor inlet seal 2820. FIG. 28F illustrates a vapor flow path extending from chamber assembly 2840, FIG. 28G depicts flap valves 2871 in a vapor flow, and FIG. 28H shows a vapor flow path after flap valves 2871.

Vaporizer assembly 2800 may comprise upper chassis 2810, precursor inlet seal 2820, valve assembly 2870, mid seal 2830, chamber assembly 2840, lower seal 2850, and lower chassis 2860.

Vaporizer assembly 2800 may serve as a further embodiment of vaporizer assembly 2500, generally operating in a similar manner with the notable addition of valve assembly 2870. In this configuration, valve assembly 2870 may be situated between precursor inlet seal 2820 and mid seal 2830, and may occupy a position along the vapor flow path extending from chamber assembly 2840. In certain embodiments, valve assembly 2870 may include one or more flap valves 2871 to inhibit or substantially prevent leakage of a liquid precursor through the vapor pathway, particularly when the device is not in use. When in use, flap valves 2871 may further function as an additional impaction surface to prevent the escapement and/or entrainment of larger particles into the vapor 2805 passing through vapor channels present in precursor inlet seal 2820, and function to return large particles that have impacted the surface of flap valves 2871 and return the larger particles to vapor channels in in mid seal 2830 and subsequently return the particle volume back to precursor liquid chamber assembly 2840. Flap valves 2871 may be configured to open under a certain pressure threshold due to the generation of vapor 2805 in chamber assembly 2840 due to the construction of the flap valves 2871 having a resistance to deflection sufficient to resist opening until sufficient pressure is generated from the production of vapor 2805 to deflect the flap valve 2871. In some embodiments, flap valve 2871 may function as a flutter valve where the valves open and close repeatedly during an activation cycle only when pressure generated from production of vapor 2805 is sufficient to deflect flap valve 2871 and then when the pressure decreases due to the opening of the valve the flap valve 2871 closes until pressure again increases sufficiently to deflect the flap valve 2871. Although flap valves 2871 are described in this example, other valve types may be employed, depending on the desired operational characteristics.

Referring back to FIGS. 25G and 25H, valve assembly 2870 may modify the vapor flow path from chamber assembly 2540 to constriction region 2516. The inlet and outlet flow paths of vaporizer assembly 2800 may be comprised of similar components and operational principles previously described for vaporizer assembly 2500 and as illustrated in FIGS. 25F and 25H.

Valve assembly 2870 may be configured to prevent leakage of a liquid precursor from chamber assembly 2840 through flow paths defined in part by precursor inlet seal 2820 and mid seal 2830, particularly during periods of device inactivity. Flap valves 2871, in some cases constructed from flexible materials such as silicone, may be designed to default to a closed position and may offer a compact profile suitable for integration within constrained spaces. The ability of such valves to provide an effective seal may be influenced by material choice, geometry, and biasing mechanisms.

In this embodiment, precursor inlet seal 2820 and mid seal 2830 may each be adapted from counterparts in vaporizer assembly 2500 (e.g., precursor inlet seal 2520 and mid seal 2530) to accommodate valve assembly 2870. Such adaptations could include the introduction of valve clearances, modified channel geometries, or revised mounting features to ensure compatibility and reliable function of the integrated valve assembly.

With reference to FIG. 28E, precursor inlet seal 2820 may be generally analogous to precursor inlet seal 2520, exhibiting similar top surface geometry and vapor channel orientation (cf. FIG. 25D). Vapor channels 2821 may extend between the top and bottom surfaces of precursor inlet seal 2820, facilitating the passage of vapor streams to vapor channels 2822. In this embodiment, dedicated valve clearances 2823 may be incorporated to allow movement of flap valves 2871 during operation.

Correspondingly, mid seal 2830, as depicted in FIGS. 28B and 28C, may be based on mid seal 2530 but with modifications to the vapor channel arrangement to accommodate valve assembly 2870. In the illustrated configuration, vapor channels 2834 may be isolated from vapor channels 2831 on the top surface, thereby providing a continuous sealing surface against which the flap valves 2871 may close.

During use, vapor 2805 may traverse a series of vapor channels defined by mid seal 2830, progressing from vapor channels 2831 at the top surface through vapor channels 2832, 2833, and finally emerging from vapor channels 2834. Besides accommodating valve assembly 2870, this flow path may incorporate one or more directional changes, serving as a tortuous region to promote selective removal of particles by size and/or mass from the vapor stream before entrainment with carrier air. While this function may be realized in vaporizer assembly 2800, similar conditioning features may be present in vaporizer assembly 2500 employing a mid seal without an intervening valve assembly.

The functional operation of vaporizer assembly 2800 may thus largely parallel that of vaporizer assembly 2500, with the principal distinction being the addition of valve assembly 2870 in the vapor flow path. Lower chassis 2860 and chamber assembly 2840 may correspond to their respective analogues in vaporizer assembly 2500, operating according to similar methods. Air intake, vapor generation, and conditioning of the aerosol stream may proceed as previously described, with the notable difference occurring as vapor 2805 interacts with valve assembly 2870 and passes through the associated sealing and conditioning features.

In operation, air may be drawn through the assembly by application of suction at the outlet, entering via air inlets positioned at the lower chassis and progressing through successive flow conditioning regions. As air exits through lower chassis outlets and transitions into an expansion region, its velocity, temperature, and pressure characteristics may be modulated to promote optimal entrainment conditions, and/or particle size selection conditions, for subsequent interaction with vapor streams.

Vapor generated in chamber assembly 2840 may encounter flap valves 2871 in the closed state, remaining sealed until sufficient vapor pressure or user-applied suction is present to deflect the valve and permit passage. Valve clearances 2823 within precursor inlet seal 2820 may provide necessary free space for valve operation. Upon opening, vapor 2805 continues through aligned vapor channels, ultimately mixing with intake air downstream.

Following entrainment, air and vapor may converge in constriction region 2816, analogous to constriction region 2516, where the velocity differential may promote efficient mixing, thereby forming aerosol 2506. The resultant mixture may then be directed through subsequent expansion and outlet regions, with each segment of the flow path designed to encourage additional particle and/or droplet conditioning, particle selection by size, and/or mass, and ensure suitable aerosol characteristics for aerosol delivery and or aerosol deposition into the deep lung of a user.

Outlet structures, such as outlet 2512, may be tailored to facilitate laminar flow and further particle separation. The outlet cross-section may be uniform or gradually narrowing to enhance aerosol conditioning prior to user inhalation. Larger particles may be removed by gravitational settling or impaction, with the final aerosol composition determined in part by the cumulative operation of tortuous flow geometry, valve assemblies, temperature, and flow conditioning regions throughout the vaporizer assembly.

While vaporizer assembly 2800 provides an example in which flap valves may be efficiently integrated into a vaporizing device, previously described embodiments have primarily contemplated actuation by vapor pressure or suction applied by a user. In alternative configurations, it may be desirable to employ valves capable of being actuated independently of vapor pressure or suction. For instance, certain valve types may be configured to open or close in response to signals from a control system. A control system could initiate valve actuation prior to vapor generation, or alternatively, maintain the valves in a closed state to permit accumulation of vapor within a chamber before selectively opening the valves to allow controlled release. The use of remotely actuated valves, including, but not limited to, solenoid valves, magnetically actuated valves types, shape memory alloy actuators, bi-metallic valve mechanisms, or piezoelectric mechanisms, may offer enhanced flexibility and control over vapor generation and delivery. Such remotely actuated valves may be particularly well-suited for applications where precise timing or user programmability is desired.

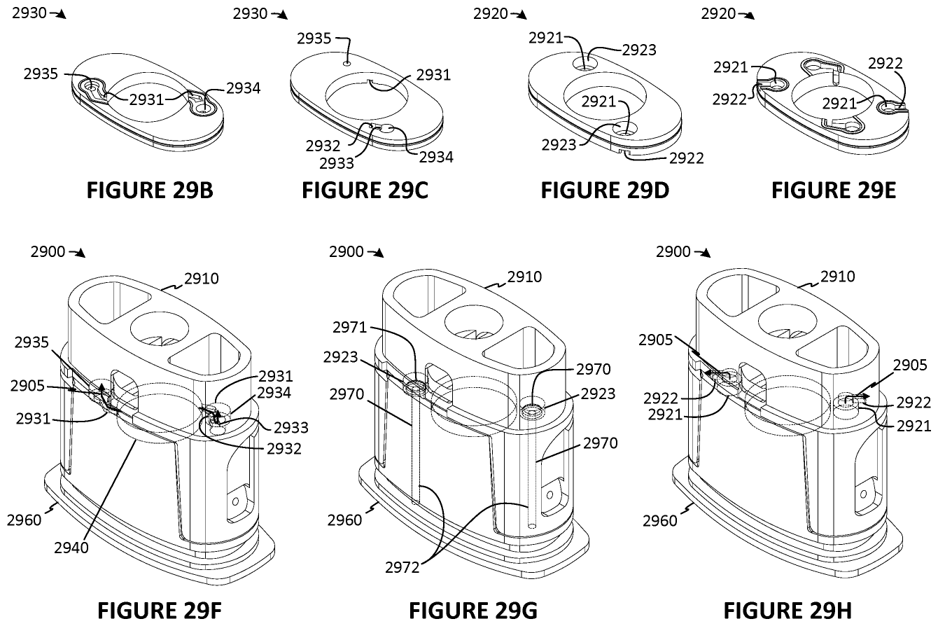

FIGS. 29A through 29H illustrate an outlet flow path including valves for a vaporizer assembly. FIG. 29A provides an exploded view of vaporizer assembly 2900. FIGS. 29B and 29C show top and bottom isometric views of mid seal 2930. FIGS. 29D and 29E show top and bottom isometric views of precursor inlet seal 2920. FIG. 29F illustrates a vapor flow path extending from chamber 2940, FIG. 29G depicts poppet valve 2970 in a vapor flow, and FIG. 29H shows a vapor flow path after poppet valve 2970. Vaporizer assembly 2900 may comprise upper chassis 2910, precursor inlet seal 2920, poppet valves 2970, mid seal 2930, chamber 2940, lower seal 2950, and lower chassis 2960.

Vaporizer assembly 2900 may represent a further iteration of the vaporizer assemblies previously described, sharing the general flow path architecture outlined for vaporizer assembly 2500 and vaporizer assembly 2800, but introducing remotely actuated valves for select embodiments. While vaporizer assembly 2800 may utilize flap valves actuated by vapor pressure or suction, vaporizer assembly 2900 may instead incorporate poppet valves 2970, which could be actuated by external mechanical or electromechanical means, thereby enabling enhanced control over vapor and liquid flow within the assembly.

Poppet valves 2970 may perform a function analogous to flap valves 2871, specifically in mitigating or preventing leakage of a liquid precursor from chamber 2940 during periods of nonuse. A notable distinction, however, is that poppet valves 2970 may be more easily controlled by external actuation. For example, poppet valves 2970 may include stems 2972 that extend through lower chassis 2960, allowing them to be opened or closed by applying or releasing force to stems 2972. Poppet valves 2970 and/or stems 2972 may be constructed of a thermally conductive material such that the valves, as part of their activation cycle, may be heated. The heating of poppet valves 2970 and/or stems 2972 may serve to help generate vapor 2905 and/or preserve the quality of the vapor 2905 already formed in relation to the vapor 2905 temperature, particle size, particle mass, and other characteristics of the vapor 2905. In certain embodiments, a base unit, such as base unit 802, may house actuation mechanisms, including solenoids, electro-magnets, motors, or other devices configured to operate poppet valves 2970 remotely.

In order to accommodate the form and function of poppet valves 2970, precursor inlet seal 2920, mid seal 2930, and lower seal 2950 may be adapted from analogous seals previously described for vaporizer assembly 2500 and vaporizer assembly 2800. Lower seal 2950, for instance, may incorporate stem seals 2951 configured to provide a close fit around stems 2972 to minimize fluid leakage along these axes. Precursor inlet seal 2920 may include valve clearances 2923 enabling movement of valve heads 2971 within the assembly.

Mid seal 2930 may be manufactured in one or more alternative configurations to support either a relatively direct or a tortuous vapor path. In a first configuration, vapor 2905 may move along a direct channel, similar to that of mid seal 2530, where stem seal 2935 offers a sealing interface for stem 2972. In a second configuration, mid seal 2930 may include tortuous geometry such that vapor 2905 passes through a progression of vapor channels (2931, 2932, 2933, and 2934). In this example, vapor channel 2934 may include an inner diameter larger than stem 2972, permitting vapor 2905 to pass between stem 2972 and the channel sidewall as it advances toward stem seal 2921 of the precursor inlet seal 2920. By altering channel geometry in this manner, mid seal 2930 may contribute to particle conditioning in addition to valve accommodation.

The operation of vaporizer assembly 2900 may parallel the methods discussed for vaporizer assembly 2500 and vaporizer assembly 2800. Air may be drawn into the device through designated inlets, passing through regions designed to condition the stream by temperature, inertial, and turbulent effects. Vapor 2905 may be formed by heating a precursor in chamber 2940, with flow thereafter modulated by the state of poppet valves 2970. Poppet valves 2970 may also be heated to modulate vapor 2905 generated in chamber 2940. Depending on seal and channel configuration, vapor 2905 may encounter a direct valve interface or traverse additional tortuous paths prior to valve engagement.

Poppet valves 2970 may be maintained in a closed state until actuation, preventing advance of vapor 2905 through the flow path. Upon actuation, whether by mechanical depression, electro-magnetic, solenoid actuation, or other means, valve heads 2971 may shift to an open position, permitting vapor flow. Actuation of poppet valves 2970 may occur after initial activation of the device, delayed activation of poppet valves after the activation of the device may serve to facilitate the generation of vapor 2905 in chamber 2940 to reach a desired density and/or pressure of vapor 2905 before being allowed to exit to the vapor channels by the activation of poppet valves 2970. Following passage along vapor channels 2922, vapor 2905 may then be combined with conditioned air in downstream regions. Subsequent flow through expansion and constriction segments of the assembly may further promote aerosolization and selective particle deposition, leading ultimately to delivery of a conditioned aerosol via outlet 2512.

Previously described vaporizer assemblies may generate vapor within a chamber, subsequently mixing the vapor with air introduced from an external source to form an aerosol for delivery to a user. In alternative embodiments, a portion of the air may be introduced directly into the vaporization chamber during vapor generation, enabling in situ mixing with vapor and promoting the formation of aerosol within the chamber itself. Such configurations may incorporate flow directors or similar features configured to induce vortical or rotational flow paths within the chamber. The resulting vortical motion may give rise to centrifugal effects that could serve to disperse a liquid precursor into a thin film or layer, potentially increasing the efficiency of vaporization while also facilitating the selective removal of particles from the aerosol stream based on particle size and/or mass. Notably, a vortical flow within the chamber may be characterized by lower axial velocities near the chamber centerline and higher circumferential velocities near the chamber periphery.

Particles suspended in such a rotational flow may experience mass-dependent separation due to centrifugal forces, with larger or denser particles tending toward the chamber walls and exhibiting increased residence times. Conversely, smaller or lighter particles may preferentially migrate toward the axial core of the flow, where they may become entrained in an aerosol stream exiting the chamber, thereby enhancing aerosol conditioning and delivery characteristics.

Another potential benefit of this design may be the ability to block inlet and outlet flow paths using a single valve. Additionally, as described herein, the introduction of some or all of the intake air into the chamber may serve to put the chamber under a vacuum pressure and thus reduce the vapor pressure of the precursor liquid and therefore reduce the boiling point temperature of the precursor liquid. The reduction in the boiling point temperature of the precursor liquid may serve to increase the efficiency of the production of vapor from the precursor liquid by reducing the amount of thermal energy required to heat the precursor liquid to transition the precursor liquid to a vapor. Reducing the thermal energy required and/or the maximal temperature required to transition the precursor liquid into vapor may also serve to reduce the generation of thermal degradation products that may result from heating the precursor. Furthermore, establishing a vacuum pressure on the chamber during activation may serve to improve vaporizer performance in different environmental conditions such as different elevations such that the vacuum pressure exerted on the chamber serves to normalize the temperature required to mobilize the precursor liquid to a vapor when the vaporizer is operated at different elevations and/or atmospheric pressures. This may improve production of the inhalation aerosol in different elevations above sea level conditions and/or different atmospheric pressures.

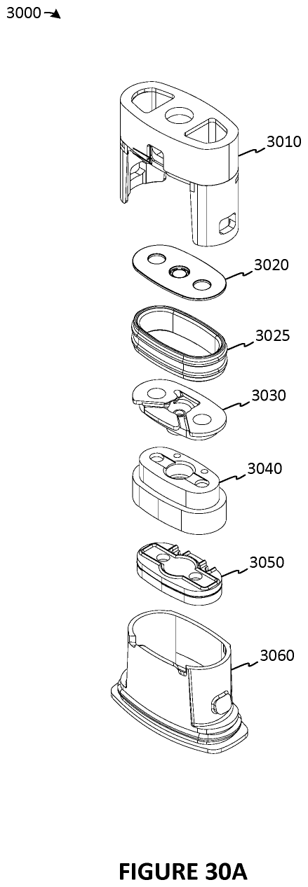

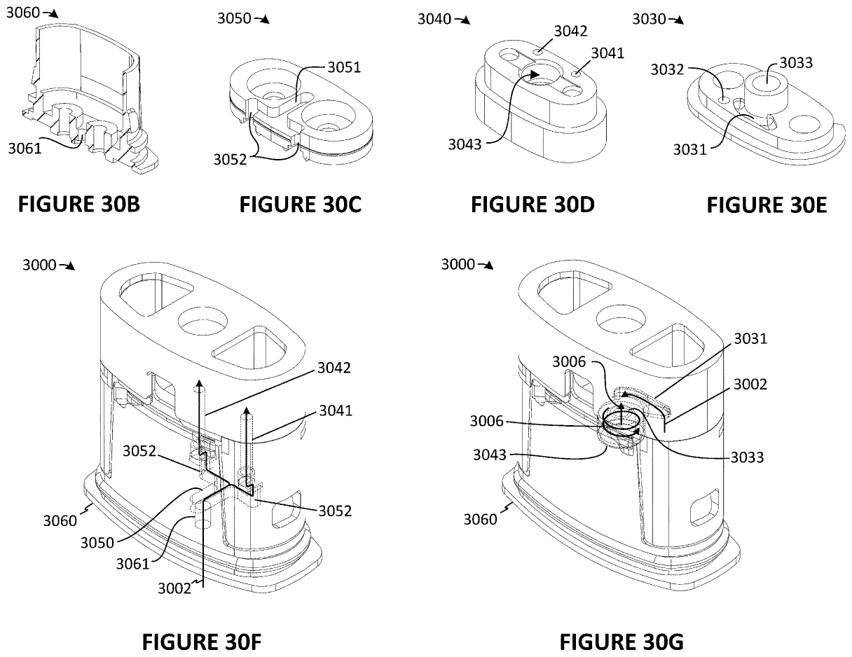

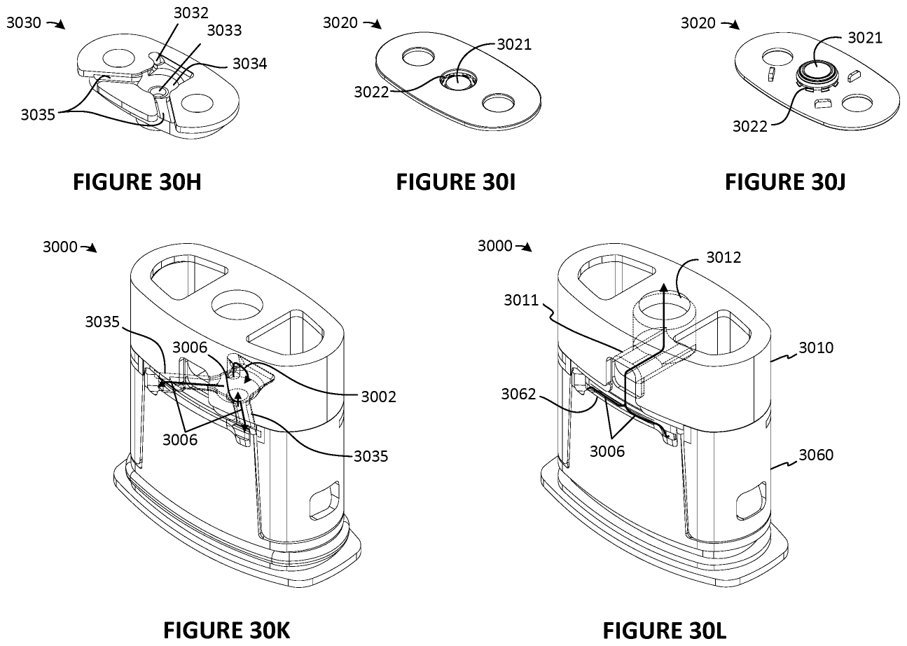

FIGS. 30A through 30L illustrate inlet and outlet flow paths including a vortical flow director and a valve for a vaporizer assembly. FIG. 30A provides an exploded view of vaporizer assembly 3000. FIG. 30B shows a cross section of lower chassis 3060. FIG. 30C illustrates a bottom isometric view of lower seal 3050. FIG. 30D illustrates chamber housing 3040. FIGS. 30E and 30H show bottom and top isometric views of flow director 3030. FIG. 30G illustrates an air inlet flow path within vaporizer assembly 3000 and FIG. 30G depicts a vapor flow path extending from chamber 3043. FIGS. 30I and 30J show top and bottom isometric views of vortical flow director 3020. FIG. 30K illustrates an aerosol flow path from chamber 3043. FIG. 30L demonstrates an aerosol outlet flow path associated with vaporizer assembly 3000.

Vaporizer assembly 3000 may comprise upper chassis 3010, vortical flow director 3020, outer seal 3025, flow director 3030, chamber housing 3040, lower seal 3050, and lower chassis 3060. Vaporizer assembly 3000 may generally resemble previously described vaporizers, vaporizing devices, and vaporizer assemblies, though it may exhibit distinctive structural and operational features.

Referring to FIG. 30B, lower chassis 3060 may include intake 3061, which may take the form of a through hole disposed within lower chassis 3060 and configured to direct incoming air 3002 into vaporizer assembly 3000. Intake 3061 may supply air to air channel 3051 formed in lower seal 3050.

FIG. 30C illustrates a bottom surface of lower seal 3050, which may be retained within lower chassis 3060 and configured both to direct incoming air 3002 and to inhibit leakage of a liquid precursor from vaporizer assembly 3000. Lower seal 3050 may include air channel 3051 to receive air 3002 and may further comprise one or more air channels 3052 to supply air 3002 to different regions or components within vaporizer assembly 3000. In the depicted embodiment, air channels 3052 direct air 3002 to lower air channel 3041 and upper air channel 3042 of chamber housing 3040.

As shown in FIG. 30D, chamber housing 3040 may define lower air channel 3041 and upper air channel 3042, which may be configured to facilitate the distribution of air 3002 from a common source to multiple locations within vaporizer assembly 3000. For example, lower air channel 3041 may deliver air 3002 to flow path 3031 of flow director 3030, while upper air channel 3042 may deliver air 3002 to air channel 3032 of flow director 3030.

Turning to FIG. 30E, flow director 3030 may be equipped with flow path 3031, which may include architecture to direct a stream of air 3002 into chamber 3043. Flow path 3031 may be contoured or angled to impart a rotational or vortical motion to air 3002 within chamber 3043, promoting enhanced mixing or dispersion.

The top surface of flow director 3030, as illustrated in FIG. 30H, may include depression 3034 configured to receive plug 3021 of vortical flow director 3020. Vortical flow director 3020 receives intake airflow from air channel 3032 and induces a vortical rotation flow through the helical flow feature of flow director 3022. As depicted in FIG. 30J, the bottom surface of vortical flow director 3020 may incorporate plug 3021, which may be adapted to engage with depression 3034. Vortical flow director 3020 may also be constructed to function as a membrane valve, potentially constructed from a flexible material such as silicone, and configured to permit vertical displacement of plug 3021 in and out of depression 3034. Due to the particular arrangement of the flow paths in this embodiment, where air 3002 may be directed both into chamber 3043 and into depression 3034, and aerosol 3006 generated within chamber 3043 may exit through outlet 3033 to depression 3034 for further mixing, vortical flow director 3020 may be alternatively configured to seal both inlet and outlet flow paths. In an embodiment, vortical flow director 3020 may function as a valve and default to a closed position, opening in response to vapor pressure produced by heating a precursor within chamber 3043, by suction applied by a user, or by a combination of both.

Vortical flow director 3020 may further include flow director 3022 formed on the outer perimeter of plug 3021, which may aid in establishing or maintaining rotational flow in aerosol 3006 as it exits from chamber 3043 at outlet 3033. Air channel 3032 may supply air 3002 from upper air channel 3042 to the interface between vortical flow director 3020 and flow director 3030. The combination of air 3002 and aerosol 3006 may occur within depression 3034, after which the resulting mixture may pass through aerosol channels 3035. Aerosol channels 3035 may be arranged to transfer aerosol 3006 from depression 3034 toward constriction region 3062.

As depicted in FIG. 30K, constriction region 3062 may be formed at the interface of upper chassis 3010 and lower chassis 3060, and, in some embodiments, may be further defined by a housing (not illustrated) similar to reservoir 901. Constriction region 3062 may comprise a channel configured to generate a relatively high-velocity, laminar flow of aerosol 3006. In this embodiment, constriction region 3062 may combine two opposing flows of aerosol 3006, generating turbulence as the combined stream proceeds toward expansion region 3011 and eventually exits through outlet 3012.

The previously described embodiment may have employed a unique flow architecture configured to induce a vortical flow of vapor and air within a chamber to promote enhanced mixing and aerosol conditioning. In addition, such architectures demonstrated how a single valve could be used to block multiple flow paths to mitigate leakage. In further embodiments, a similar chamber design may incorporate a plurality of valves, wherein individual valves selectively block various inlet and outlet flow paths. Moreover, alternatives may feature chamber architectures designed to increase the available surface area for a liquid precursor's exposure to a heated surface, thereby potentially improving vaporization efficiency.

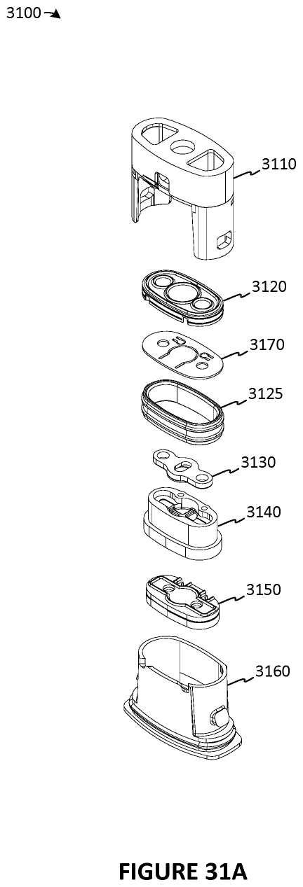

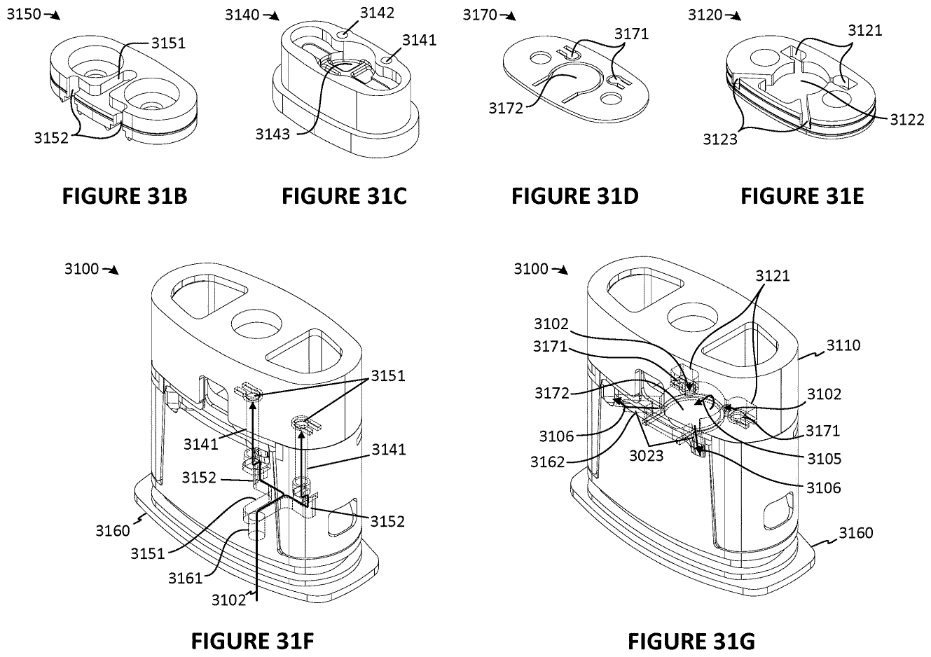

FIGS. 31A through 31G illustrate inlet and outlet flow paths, as well as associated valves, for a vaporizer assembly. FIG. 31A provides an exploded view of vaporizer assembly 3100. FIG. 31B shows a bottom isometric view of lower seal 3150. FIG. 31C depicts chamber housing 3140. FIG. 31D illustrates an isometric view of valve assembly 3170. FIG. 31E presents a bottom isometric view of flow director 3120. FIG. 31F outlines an air intake flow path, and FIG. 31G depicts the mixing of vapor and air, resulting in aerosol generation and the subsequent exit flow path.

Vaporizer assembly 3100 may comprise upper chassis 3110, flow director 3120, valve assembly 3170, outer seal 3125, chamber flow director 3130, chamber housing 3140, lower seal 3150, and lower chassis 3160. Vaporizer assembly 3100 may generally resemble previously described vaporizer assemblies, while incorporating distinctive structural and operational features.

Lower chassis 3160, which may be similar to lower chassis 2560, may include a cross-sectional profile similar to that shown in FIG. 25B. Lower chassis 3160 may comprise air intake 3161, which may be implemented as a channel positioned within the lower chassis to direct a stream of air into the device. Air intake 3161 may communicate with air channel 3151 formed within lower seal 3150.

As illustrated in FIG. 31B, the bottom surface of lower seal 3150 may be configured to direct incoming air 3102 and inhibit leakage of a liquid precursor from vaporizer assembly 3100. Lower seal 3150 may include air channel 3151 for receiving a stream of air 3102, which may then be distributed to one or more air channels 3152. Air channels 3152 may supply air 3102 to different components, including air channels 3141 and 3142 of chamber housing 3140.

FIG. 31C depicts chamber housing 3140, which may include air channels 3141 and 3142 configured to receive air 3102 from lower portions of the device and direct it to selected locations. In certain embodiments, air channels 3141 and 3142 may supply air 3102 to valve clearances 3121 of flow director 3120, where mixing with vapor 3105 may occur near outlet valve 3172. Intake valves 3171 may be positioned near terminal ends of air channels 3141 to help regulate and prevent leakage.

Valve assembly 3170, illustrated in FIG. 31D, may include one or more intake valves 3171 and at least one outlet valve 3172. Intake valves 3171 could be configured to prevent leakage of liquid precursor from chamber housing 3140 via air channels 3141, and may be actuated by suction or alternative means. Outlet valve 3172 may be configured to actuate in response to vapor pressure, suction, or both. Although flap valves are depicted, other valve types could be substituted to meet particular requirements.

Flow director 3120, as shown in FIG. 31E, may incorporate valve clearances 3121 to accommodate the movement of intake valves 3171. Flow director 3120 may be configured to receive air 3102 from air channels 3141 at valve clearances 3121 and direct it to the mixing region 3122.

Mixing region 3122 may be located proximate to chamber 3143 and may provide space for opening of outlet valve 3172, receive air 3102 via valve clearances 3121, and accept vapor 3105 generated within chamber 3143. Within mixing region 3122, air 3102 and vapor 3105 may combine to generate aerosol 3106 for downstream delivery.

Flow director 3120 may further include aerosol channels 3123 in fluid communication with mixing region 3122, configured to convey aerosol 3106 to constriction region 3162. As indicated in FIG. 31G, constriction region 3162 may be formed at the interface of upper chassis 3110 and lower chassis 3160, and may be further defined by a housing such as reservoir 901 (not shown). Constriction region 3162 may provide a channel for creating a relatively high-velocity, laminar flow of aerosol 3106. In this embodiment, constriction region 3162 may combine two opposing flows of aerosol 3106, thereby generating turbulence as the combined stream advances toward the outlet.

The flow path and operational stages may generally reflect those described for previous embodiments, such as in FIG. 30L, with modifications as noted above.

A variety of valve mechanisms suitable for use in vaporizer devices have been previously described, each providing unique structural or functional benefits. However, these examples are provided for illustrative purposes and are not intended to limit the scope of possible configuration. The following description introduces a further alternative embodiment, illustrating an additional valve system that may be incorporated into a vaporizer device, either independently or in combination with other features disclosed herein.

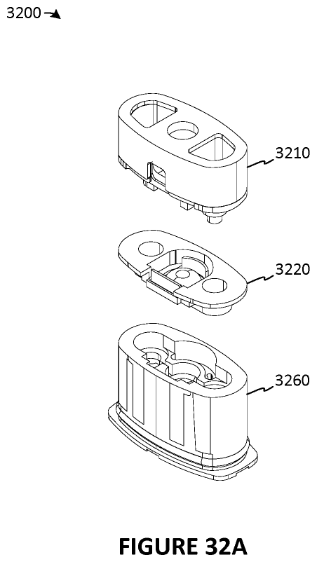

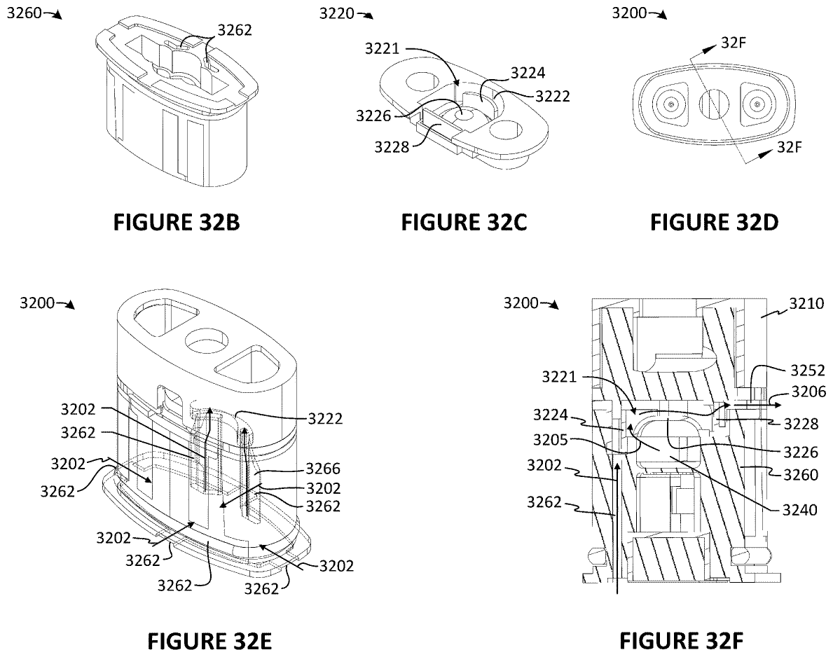

FIGS. 32A through 32B illustrate various aspects of inlet and outlet flow paths including valves for a vaporizer. FIG. 32A illustrates an exploded view of vaporizer assembly 3200. FIG. 32B presents an isometric view of the bottom side of lower chassis 3260. FIG. 32C is an isometric view of flow director 3220. FIG. 32D provides a top view of vaporizer assembly 3200. FIG. 32E is an isometric illustration of vaporizer assembly 3200. FIG. 32F is a cross section of vaporizer assembly 3200.

Vaporizer assembly 3200 may comprise upper chassis 3210, flow director 3220, and lower chassis 3260. Vaporizer assembly 3200 may generally resemble previously described vaporizer assemblies, while incorporating distinctive structural and operational features.

Lower chassis 3260 may include one or more inlets 3262, each configured to draw air 3202 into lower cavity 3264. Lower cavity 3264 may be a void within lower chassis 3260 where air 3202 streams from the one or more inlets 3262 may combine. Lower cavity 3264 may supply the combined streams to inlet channels 3266. Inlet channels 3262 may initially feature a relatively large cross-sectional area that narrows along the direction of flow. This reduction in cross section may induce an increase in the velocity of air 3202, consistent with the continuity equation. Inlet channels 3262 may be located in proximity to chamber 3240 to allow residual heat from chamber 3240 to heat intake channels 3262 and air 3202 traveling within. Preheating of air 3202 may improve efficiency of vaporization within chamber 3240. Inlet channels 3266 may supply air to intake 3222 of flow director 3220.

Flow director 3220 may include mixing region 3221, intake 3222, intake valve 3224, chamber valve 3226, and outlet valve 3228. Mixing region 3221 may be configured as a cavity in proximity to chamber 3240, wherein air 3202 may be combined with vapor 3205 generated in chamber 3240 to form aerosol 3206. Intake valve 3224, in an embodiment, may comprise a suction-actuated flap valve positioned between intake 3222 and mixing region 3221 and may be responsive to user inhalation. Intake valve 3224 may function to prevent leakage of liquid precursor inlet channels 3266 during periods of nonuse. In alternative embodiments, intake valve 3224 may employ different geometries or actuation mechanisms.

Chamber valve 3226 may comprise a flap-type valve positioned between chamber 3240 and mixing region 3221. Chamber valve 3226 may be configured to seal chamber 3240 to prevent a liquid precursor from leaking when the device is not in use. In an embodiment, chamber valve 3226 may include a dome-shaped geometry that may increase the effective volume of chamber 3240 and provide additional rigidity to the sealing edge of chamber valve 3226. Alternatively, a flat flap valve, analogous to outlet valve 3172, may be employed. Chamber valve 3226 may be actuated by increased pressure within chamber 3240, user-generated suction, or a combination of both. Upon opening, chamber valve 3226 may enable vapor 3205 to be released into mixing region 3221, where it may be mixed with incoming air 3202 to form aerosol 3206.

Outlet valve 3228 may be a flap valve positioned between mixing region 3221 and aerosol channel 3252 and configured to prevent a liquid precursor from leaking through aerosol channel 3252 when the device is not in use. Outlet valve 3228 may be actuated by pressure generated within chamber 3240, user-generated suction, or a combination of both. Upon opening, outlet valve 3228 may allow aerosol 3206 to flow from mixing region 3221 to aerosol channel 3252. Downstream of outlet valve 3228, the flow path may generally resemble that of vaporizer assembly 3100 or other embodiments described herein, although additional conditioning features, such as selective impaction surfaces or further valve elements, could be included as required.

In this embodiment, flow director 3220 may be manufactured from a single piece of non-reactive, compliant material, such as silicone; however, alternative embodiments could separate the various valves into separate parts.

The previously discussed inlet and outlet flow paths have been described in the context of a vaporizer assembly included in a disposable cartridge of a vaporizing device. However, it should be appreciated, that these vaporizer assemblies and associated inlet and outlet flow paths may be assembled into a reusable base unit.

Vaporizing device 3300 may be configured to incorporate any of the previously described vaporizer assembly embodiments, including structures and operational principles analogous to those of vaporizer assembly 2500 and vaporizer assembly 2800. The following description draws on specific features and flow path conditioning processes described for those assemblies, thereby providing a basis for understanding the technical advancements and alternative configurations possible within vaporizing device 3300.

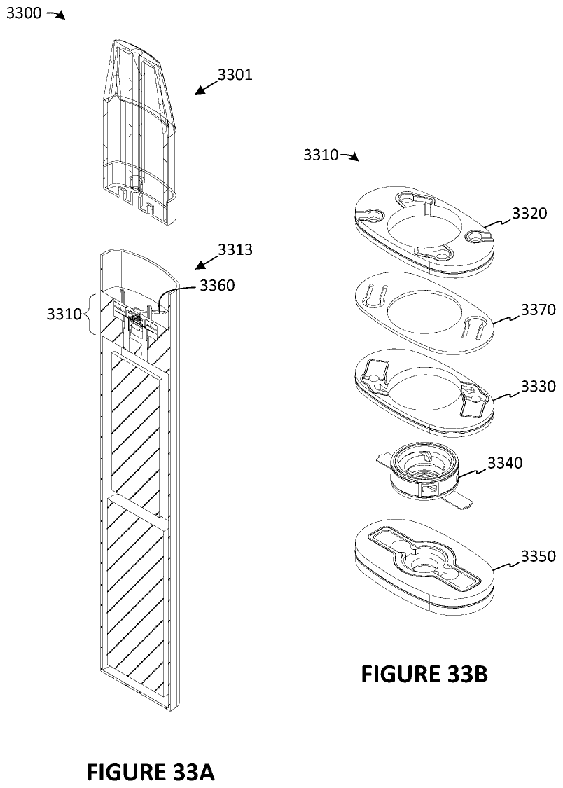

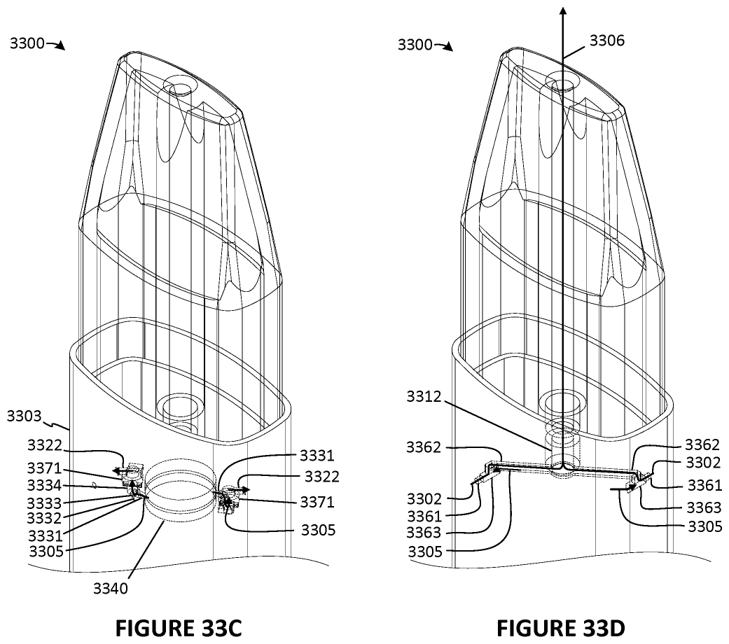

FIGS. 33A through 33D illustrate inlet and outlet flow paths, as well as the associated valves, for vaporizing device 3300. Vaporizing device 3300 may comprise detachable cartridge 3301 for use with base unit 3303. Cartridge 3301 may be configured to store and supply a liquid precursor and may include valves or other means adapted to minimize leakage when cartridge 3301 is detached from base unit 3303. The configuration and operation of these valves may be similar to vaporizer assembly 2800.

Base unit 3303 may comprise vaporizer assembly 3310 and inlets 3361. Inlets 3361 may be an example of any of the previously described inlets (e.g., inlet 150, 250) but may include alternative geometry adapted to this embodiment. In this embodiment, inlets 3361 may be configured to transfer air exterior to base unit 3303 to components comprising vaporizer assembly 3310.

FIG. 33B illustrates an exploded view of vaporizer assembly 3310. Vaporizer assembly 3310 may be analogous to vaporizer assembly 2500 but adapted for assembly into base unit 3303 rather than a detachable cartridge. It should be clear that any of the previously discussed vaporizers may be adapted for use in either a cartridge or a base unit, such as base unit 3303. Vaporizer assembly 3310 may comprise precursor inlet seal 3320, valve assembly 3370, mid seal 3330, chamber assembly 3340, and lower seal 3350.

A liquid precursor in chamber assembly 3340 may be vaporized via applied heat, producing vapor 3305 and elevating chamber pressure. As illustrated in FIG. 33C, vapor 3305 may flow from chamber assembly 3340 into vapor channels 3331 due to vapor pressure resulting from heating the precursor, suction, or both. Vapor channels 3322, 3331, 3332, 3333, and 3334 may be analogous to previously described outlets and could be configured to include tortuous flow geometry that may promote conditioning of vapor 3305. Tortuous flow geometry may comprise multiple abrupt directional changes, cross-sectional variations, and surface textures within the channels.

Vapor 3305 may be subject to a series of directional changes, which could result in separation of larger particles or droplets from the stream. For example, transitions between vapor channels 3331, 3332, 3333, and 3334 may cause higher-mass constituents to deviate from the primary flow path and deposit onto surfaces, fragment into smaller particles, or condense at phase boundaries. Vapor channel 3334 may extend vertically and have a substantially consistent cross-section that could further act as a laminar flow region where gravitational settling of large particles may occur.

Vapor 3305 may encounter valve 3371 at an end of vapor channel 3334. Valve 3371 may default to a closed position and may be configured to prevent a liquid from leaking from chamber assembly 3340 and to open due to vapor pressure, suction, or both. Valve 3371 may be illustrated as a flap valve in this embodiment but it should be understood that alternative valve designs, such as poppet valve 2970, may be used. Opening of intake valves 3371 may be triggered by user inhalation, vapor pressure, or by electromechanical actuation, according to the selected embodiment.

FIG. 33D illustrates a flow path following the passage of vapor 3305 through valve 3371. Here, vapor 3305 may encounter air 3302 entering from inlets 3361. Following passage through valve assembly 3370, vapor 3305 may enter mixing region 3363, which may be configured to promote entrainment and dispersion of vapor 3305 with air 3302 to form aerosol 3306, possibly by inducing converging counterflows, swirling vortices, or localized turbulence. Mixing region 3363 may direct a flow of aerosol 3306 to constriction region 3362. Constriction region 3362 may provide a zone of relatively high-velocity, laminar flow that could help maintain uniform aerosol particle suspension and minimize deposition of smaller particles, promoting efficient downstream delivery.

Aerosol 3306 may traverse toward outlet 3312, where the flow regime could transition from laminar to a turbulent, relatively low-velocity environment. This transition may enable additional conditioning, such as further removal of larger particles by coalescence, agglomeration, settling, or impaction on surfaces configured for droplet collection. Outlet 3312 may comprise regions of uniform cross-section or feature gradual tapering, depending on the desired flow characteristics and deposition dynamics.

Vaporizing device 3300 illustrates one possible embodiment of a vaporizing device featuring a base unit and detachable cartridge. Additional embodiments may supplement or replace certain flow path and aerosol conditioning strategies with new functionalities, such as the incorporation of a preheater element for active preconditioning of intake air and the inclusion of additional sensors distributed throughout the device. These enhancements may be directed toward further optimizing vaporization efficiency, facilitate real-time monitoring and control of operational parameters, and improving the user experience.

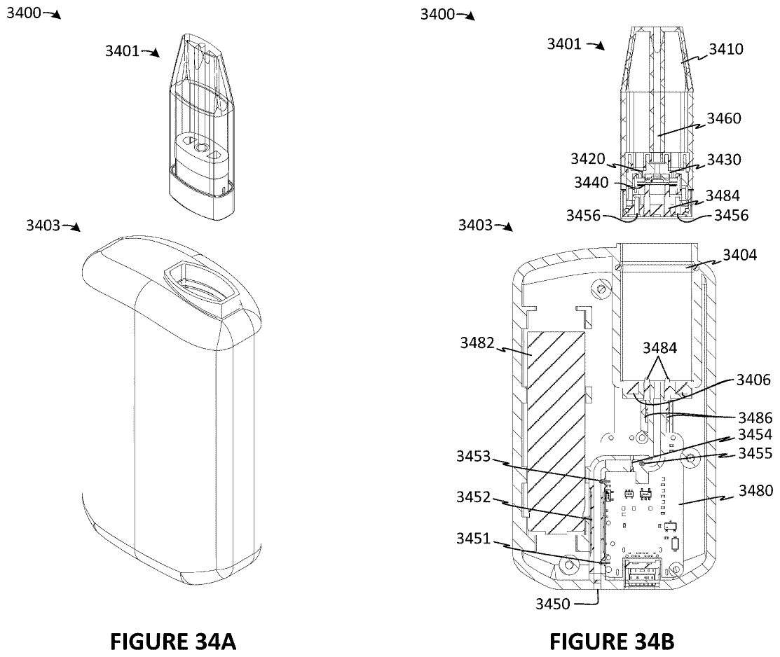

FIGS. 34A and 34B respectively provide an isometric and cross-sectional view of vaporizing device 3400. Vaporizing device 3400 may comprise cartridge 3401 and base unit 3403, wherein cartridge may represent any cartridge embodiment described herein. As illustrated, cartridge 3401 may include reservoir 3410, dispenser 3420, chamber assembly 3430, heater 3440, and cartridge inlet 3456, although, in alternative embodiments, one or more of these components may be integrated within base unit 3403. Similarly, base unit 3403 may exemplify any suitable base unit described herein and, as illustrated, may comprise O-ring 3404, magnets 3406, inlet 3450, sensor 3451, preheater 3452, sensor 3453, flow modifier 3454, sensor 3455, controller 3480, battery 3482, electrical contacts 3484, and heatsinks 3486.

Vaporizing device 3400 may be generally similar to other vaporizer embodiments disclosed herein. Vaporizing device 3400 may include controller 3480 configured to monitor various sensors, such as sensors 3451, 3453, and 3455, and regulate heat delivery to chamber assembly 3430, and battery 3482 to provide electrical power to base unit 3403 and cartridge 3401. Cartridge 3401 may be removably coupled with base unit 3403, and, in some embodiments, may be held in place by one or more magnets 3406. O-ring 3404 may establish a seal between base unit 3403 and cartridge 3401 to inhibit leakage of liquid precursor. Electrical contacts 3484 may deliver power to heater 3440 included in cartridge 3401 and, in certain embodiments, may communicate temperature or other operational data regarding chamber assembly 3430 to controller 3480. Furthermore, electrical contacts 3484 may be thermally coupled to heatsinks 3486, allowing residual thermal energy from cartridge 3401 to be dissipated.

Vaporizing device 3400 may include preheater 3452, configured to heat intake air prior to delivery to chamber assembly 3430. While preheating of intake air has been disclosed in earlier embodiments, typically by harnessing residual heat from the chamber, vaporizing device 3400 may actively heat intake air using preheater 3452. Air may be drawn into base unit 3403 through inlet 3450 when suction is applied by a user. Inlet 3450 may include sensor 3451 and sensor 3453, each configured to monitor physical properties of incoming air. Sensor 3451 and sensor 3453 may comprise thermal sensors for temperature, capacitive or resistive sensors for humidity, piezoelectric sensors for pressure, optical sensors for particulates, ultrasonic sensors for airflow, or other sensors. In the illustrated embodiment, sensor 3451 may be positioned upstream of preheater 3452 and sensor 3453 downstream enabling measurement of air temperature both before and after preheating. This arrangement may provide data to controller 3480, which may adjust power supplied to heater 3440 in real time based on feedback from sensor 3451 and sensor 3453. Preheating incoming air in this manner may enhance vaporization efficiency by reducing thermal losses associated with cold air influx.

Sensor 3455 may be configured to measure physical properties of the preconditioned intake air. Sensor 3455 may comprise one or more electronic sensors, such as those for measuring temperature, flow rate, humidity, pressure, or airflow, as previously outlined. In some embodiments, sensor 3455 may comprise a Micro-Electro-Mechanical Systems (MEMS) microphone, configured to detect changes in pressure. Sensor 3455 may communicate pressure data to controller 3480, enabling activation and regulation of heater 3440 in response to user suction or other variables. Controller 3480 may be configured to continuously monitor sensor 3455 during idle states, so that the application of suction by a user may trigger device activation without the need for pressing a button or performing other manual actions.

Inlet 3450 may include flow modifier 3454, positioned downstream of sensor 3455. Flow modifier 3454 may be configured to condition or stabilize a pressure field experienced by sensor 3455. By introducing controlled perturbations to a generally laminar flow, flow modifier 3454 may create a more uniform and steady pressure region near sensor 3455, thus improving the accuracy and repeatability of sensor measurements. Thereafter, preconditioned air may be directed to cartridge inlet 3456 by inlet 3450, from where it is directed into chamber assembly 3430 for aerosol formation and subsequent delivery to the user via outlet 3460.

The previous embodiment included a disposable cartridge incorporating many of the principal vaporization components, and in some implementations, this may result in a configuration resembling a cartomizer. These types of cartridges are typically discarded after depletion of the precursor contained within their reservoir. In the next embodiment, a greater proportion of functional elements may be relocated from the cartridge to the base unit. Such elements may include heating assemblies, sensors, and fluidic conditioning features. By retaining these elements within the base unit, waste generated upon cartridge depletion may be reduced. Furthermore, this arrangement may promote increased operational repeatability, since the same set of functional elements is used with each replacement cartridge.

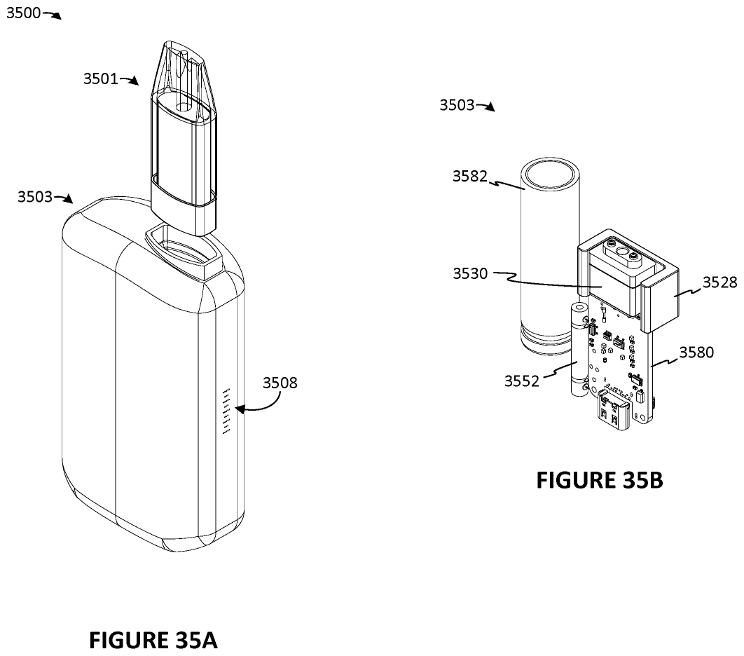

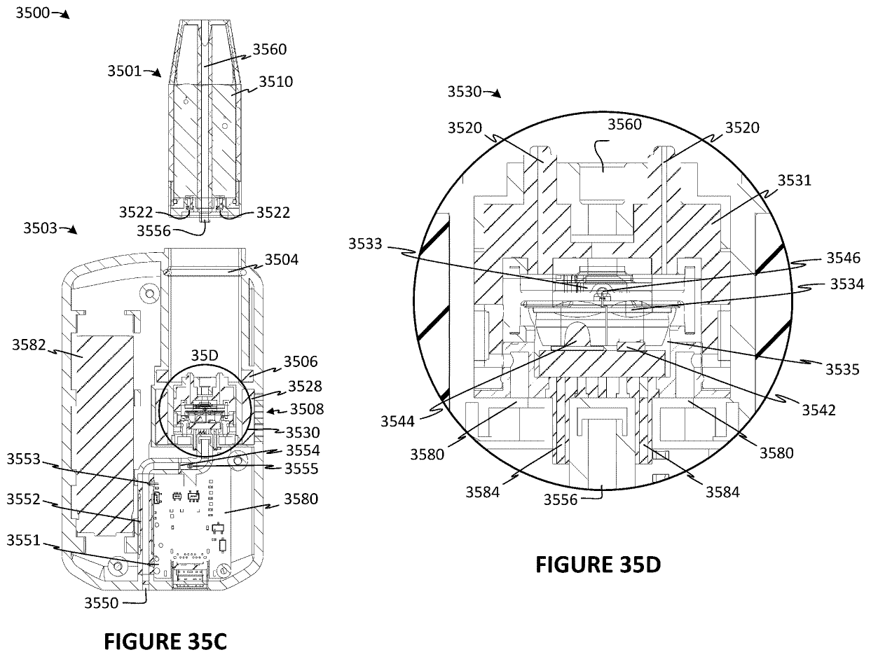

FIG. 35A illustrates an isometric view of vaporizing device 3500. FIG. 35B depicts an isometric view of base unit 3503 with the housing removed. FIG. 35C provides a cross-sectional view of vaporizing device 3500. FIG. 35D presents a detailed view of chamber assembly 3530. Vaporizing device 3500 may adopt a form factor similar to that of vaporizing device 3400, while shifting primary functional components from the cartridge to the base unit. In general, vaporizing device 3500 may include cartridge 3501 and base unit 3503.

Cartridge 3501 may comprise reservoir 3510, valve 3522, cartridge inlet 3556, and outlet 3560. Reservoir 3510 may be configured to contain a precursor composition for delivery to base unit 3503. Valve 3522 may be arranged to prevent unwanted escape of the precursor from reservoir 3510 when cartridge 3501 is detached from base unit 3503. In certain embodiments, valve 3522 may also serve to regulate the flow of precursor from reservoir 3510 to base unit 3503, and may optionally be actuated by controller 3580. Cartridge inlet 3556 may be configured to receive vapor and/or aerosol from base unit 3503, directing it to outlet 3560 for user delivery. In some instances, outlet 3560 may include geometry designed to further condition the vapor or aerosol prior to inhalation.

Base unit 3503 may include O-ring 3504, magnets 3506, vents 3508, absorbent pad 3528, chamber assembly 3530, inlet 3550, sensor 3551, preheater 3552, sensor 3553, flow modifier 3554, sensor 3555, controller 3580, and battery 3582. Many of these components have been described elsewhere herein, and various embodiments may incorporate different combinations to provide a functional vaporizing device.

Vaporizing device 3500 may further include vents 3508 and absorbent pad 3528. These elements may operate in conjunction with O-ring 3504 to limit leakage of liquid precursor when cartridge 3501 is inserted into base unit 3503. O-ring 3504 may provide a liquid-tight seal as well as friction to retain cartridge 3501 within base unit 3503, thereby reducing the potential for leakage to the exterior of the device. However, in some cases, liquid may accumulate in the interstitial space between cartridge 3501 and base unit 3503. Absorbent pad 3528 may be positioned to absorb such liquid, and may be fabricated from chemically compatible, absorbent, and thermally stable wicking materials. Examples of suitable materials include cellulosic fibers, polyolefin nonwovens, polyester (PET) or nylon nonwovens, or open-cell foams. One or more vents 3508 may also be included to promote evaporation of liquid absorbed by pad 3528.

Vaporizing device 3500 may include a chamber or chamber assembly in accordance with those previously disclosed. In this embodiment, chamber assembly 3530 may be constructed and operated similarly to chamber assembly 2300, and may include upper chassis 3531, chamber 3533, lens 3534, reflector 3535, and heater assembly 3540. Upper chassis 3531 may be further configured to include dispenser 3520 for regulating the flow of precursor from reservoir 3510 to chamber 3533.

Heater assembly 3540, in this embodiment, may be substantially similar to heater assembly 2260, though alternative heater types may be employed. Heater assembly 3540 may include UV emitter 3542, IR emitter 3544, sensor 3546, and electrical contacts 3584. Electrical contacts 3584 may facilitate communication with controller 3580, enabling the controller to supply power to heater assembly 3540 and receive temperature or other data from sensor 3546. In some embodiments, electrical contacts 3584 may also be thermally coupled to heatsinks in order to dissipate excess heat generated by heater assembly 3540.

Lens 3534 may, in some cases, may be an example of optical assembly 2268. Lens 3534 may comprise two convex lenses that are configured to direct UV radiation from UV emitter 3542 and IR radiation from IR emitter 3544 toward a common convergence point, thereby facilitating heating of the precursor composition in chamber 3533.

Sensor 3546 may be adapted to measure the temperature of chamber 3533 or the precursor contained within it. Sensor 3546 may comprise one or more electronic temperature-sensing elements, such as a thermocouple, thermistor, resistance temperature detector (RTD), semiconductor temperature sensor, or some other suitable device. In this embodiment, sensor 3546 may be disposed near the convergence point of UV emitter 3542 and IR emitter 3544 within chamber 3533 and may relay temperature data to controller 3580.

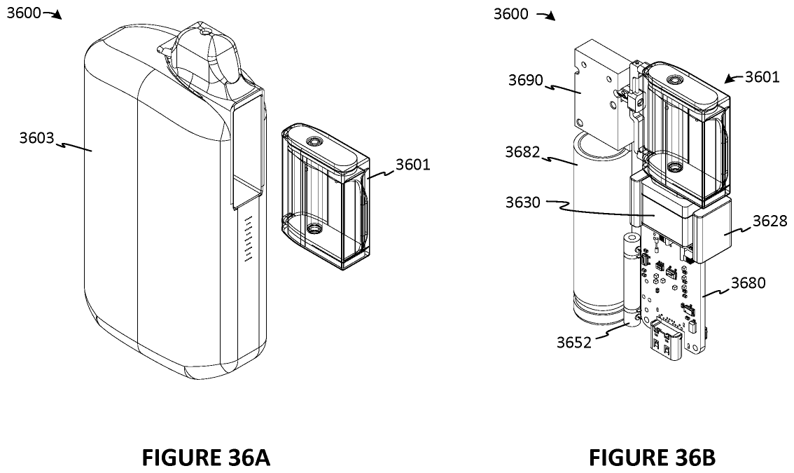

Cartridges incorporating valves to mitigate leakage have been discussed elsewhere herein. Vaporizing device 3600 may provide an example of a cartridge system featuring such valves. FIG. 36A presents an isometric view of vaporizing device 3600, and FIG. 36B illustrates the device with its housing removed. Vaporizing device 3600 may include cartridge 3601 and base unit 3603. Base unit 3603 may include absorbent pad 3628, chamber assembly 3630, preheater 3652, battery 3682, and actuator 3690.

In certain embodiments, cartridge 3601 may be inserted into the side of base unit 3603, in contrast to top-loading configurations described in earlier embodiments. This arrangement may allow cartridge 3601 to include valves positioned at both the top and bottom of the cartridge body, which may be actuated by actuator 3690 housed within base unit 3603. The top valve may be configured to block an outlet, such as outlet 160, thereby inhibiting leakage of liquid from chamber 3630 through the outlet. The bottom valve may be adapted to block precursor from leaking from the reservoir, or may serve to regulate delivery of precursor from cartridge 3601 to chamber 3630. Operation of these valves may be managed by controller 3680. In some embodiments, the valves may be actuated independently to enable greater control over aerosol and liquid handling and device operation.

Actuator 3690 may comprise an electronically controlled device configured to open or close valves within cartridge 3601. In certain embodiments, actuator 3690 may include an electric motor, servo motor, linear actuator, solenoid, or other suitable actuation mechanism. Actuator 3690 may further comprise means for coupling to one or more valves, such as magnets, snap-fit features, hook-and-loop fasteners, or other appropriate mechanical or magnetic mechanisms. In alternative embodiments, actuator 3690 may incorporate position sensors, limit switches, or feedback systems to permit precise valve control.

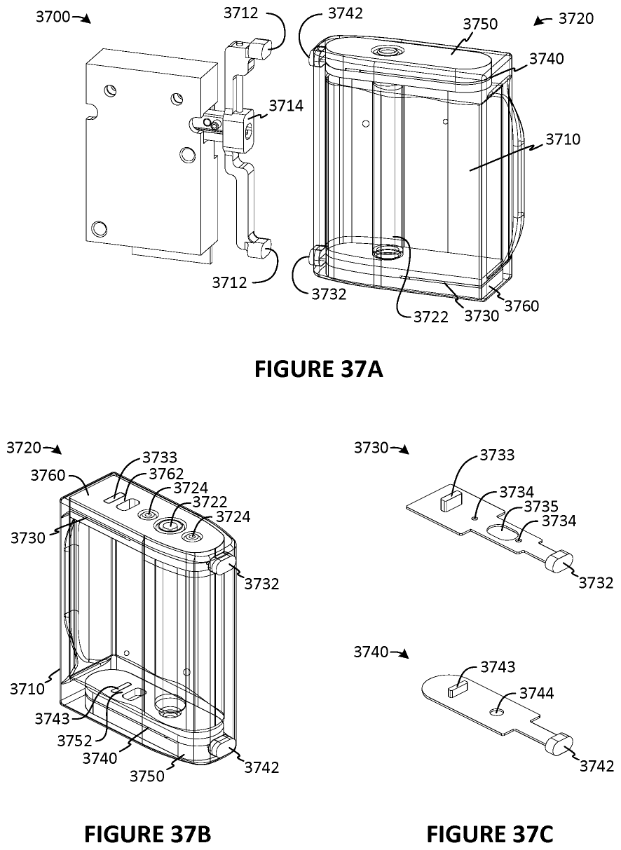

FIG. 37A illustrates actuator 3700 together with cartridge 3720. FIG. 37B presents an isometric view of the underside of cartridge 3720, while FIG. 37C depicts the positions of slide plate 3730 and slide plate 3740 relative to the orientation shown in FIG. 37B. In some embodiments, actuator 3700 may be an example of actuator 3690 and cartridge 3720 may be an example of cartridge 3601.

Cartridge 3720 may be configured to contain a precursor composition and may include one or more valve mechanisms to mitigate precursor leakage. Cartridge 3720 may comprise reservoir 3710, outlet 3722, dispenser 3724, slide plate 3730, contact 3732, slide plate 3740, contact 3742, upper seal 3750, and lower seal 3760. Outlet 3722 may serve a function analogous to outlet 130 and may be in communication with a chamber of a vaporizing device. Liquid precursor often resides in the chamber of vaporizing devices and outlet 3722 may present a potential leakage path. Dispenser 3724 may regulate delivery of a precursor from reservoir 3710 to a vaporizing device and could allow leakage in the absence of an effective flow-blocking element.

To inhibit leakage through outlet 3722, cartridge 3720 may include a valve assembly comprising slide plate 3740 and upper seal 3750. Slide plate 3740 may include contact 3742, lug 3743, and aperture 3744. Upper seal 3750 may include geometry to form compliant spring 3752 configured to engage lug 3743 of slide plate 3740 to maintain slide plate 3740 in a closed position. Compliant spring 3752 may incorporate geometrical features integral to upper seal 3750 permitting localized deformation when a force is applied by lug 3743. Compliant spring 3752 may have a tendency to return to its undeformed shape, thus acting like a spring pulling slide plate 3740 to a closed position. In this embodiment cartridge 3720 is in a default closed position unless inserted into the device (such as vaporizing device 3600) and acted upon by the actuator, such as actuator 3700. Contact 3712 of actuator 3700 may engage contact 3742 on slide plate 3740 in order to move slide plate 3740 between open and closed positions. Slide plate 3740 may further include aperture 3744 configured to align with outlet 3722 when in the open position and to block outlet 3722 when in the closed position. In an embodiment the cartridge 3720 has slide plate 3730 and slide plate 3740 that are in their default state in a closed position, thus sealing the cartridge from the ingress or egress of air or precursor liquid even when the cartridge 3720 is exposed to changing environmental conditions such as increased temperature or decreased atmospheric pressure, the cartridge 3720 also functions to prevent the intentional tampering with the cartridge as may be performed by a user attempting to refill the cartridge 3720, and/or to prevent escape of liquid precursor due to unintentional tampering as may occur if a child was playing with the cartridge 3720.

In a similar manner, cartridge 3720 may include a valve mechanism to inhibit leakage from dispenser 3724 comprising slide plate 3730 and lower seal 3760. This valve mechanism may prevent escape of liquid precursor through dispenser 3724 when cartridge 3720 is detached from a base unit, and may also regulate precursor delivery during normal operation. Slide plate 3730 may include contact 3732, lug 3733, one or more apertures 3734, and clearance slot 3735. Lug 3733 may engage with compliant spring 3762 of lower seal 3760 to retain slide plate 3730 in a closed position. Apertures 3734 may be configured to align with dispensers 3724 when slide plate 3730 is open, while blocking dispenser 3724 when in a closed position. Clearance slot 3735 may provide a passage for outlet 3722 through slide plate 3730, permitting movement of slide plate 3730 between open and closed positions. In certain embodiments, clearance slot 3735 may be omitted if not required by the arrangement of other components.

Actuator 3700 may be configured move arm 3714 to operate valves incorporated within cartridge 3720. In some embodiments, actuator 3700 may comprise a linear actuator, lead screw or ball screw mechanism, a solenoid, a shape memory alloy element, or some other suitable means for moving arm 3714. Alternative embodiments of valve mechanisms may employ other types of actuators. Solenoids or shape memory alloy elements may require a supply of energy to maintain an open or closed position. Actuator 3700 may also include a feedback mechanism, such as an optical scale, hall effect sensor, or limit switches, to communicate the positions of arm 3714 and slide plates 3730 and 3740 to a controller.

Actuator 3700 may include contacts 3712 on arm 3714 that are configured to automatically couple to contacts 3742 and 3732 of cartridge 3720 upon insertion of cartridge 3720 into a base unit, such as base unit 3603. These contacts may utilize magnets, snap-fit mechanisms, hook-and-loop fasteners, or other suitable elements to facilitate coupling and actuation of slide plates 3730 and 3740.

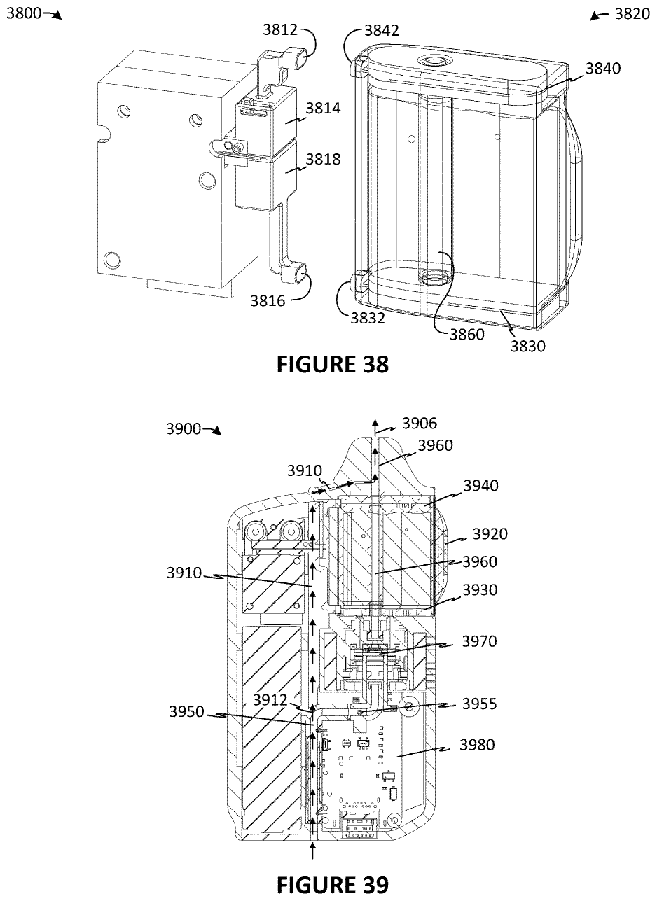

FIG. 38 illustrates actuators with a cartridge. In FIG. 38 actuator 3800 comprising a double actuator arrangement positioned in conjunction with cartridge 3820 is illustrated. In some embodiments, actuator 3800 may be configured as an example of actuator 3700, adapted to independently actuate valves 3830 and 3840. Actuator 3800 may include arm 3814, which may be provided with contact 3812 to engage contact 3842 associated with valve 3840, and arm 3818, which may be provided with contact 3816 to engage contact 3832 associated with valve 3830. Cartridge 3820 may include both valve 3840, with corresponding contact 3842, and valve 3830, with corresponding contact 3832, and outlet 3860. In this embodiment, actuator 3800 may comprise two linear actuators employing one or more rollers that contact and translate arms 3814 and 3818 along a defined path. In alternative embodiments, actuator 3800 may utilize features such as sliding blocks, lead screws, solenoids, electromagnets, or belt-driven mechanisms for linear actuation. Additionally, contacts 3812 and 3816 of actuator 3800 and contacts 3832 and 3842 of cartridge 3820 may comprise magnets, mechanical couplers, or other suitable means for engagement during cartridge insertion.

Arms 3814 and 3818 of actuator 3800 may move independently of one another, facilitating separate control of valves 3830 and 3840. Through independent actuation, a more sophisticated range of device operations may be enabled. For instance, selective closure, and/or selective variable closure of outlet 3860 may allow vapor pressure to accumulate within the chamber, which may be desirable in applications requiring pulsed or metered aerosol delivery. Selective variable closure (for example a partial closing of outlet 3860 to a percentage of the outlet 3860 total available throughput, such a 5% open, 10% open, 15% open, or any such percentage of the outlet 3860 being open between 1-99%) of outlet 3860 can be used to increase or decrease vacuum pressure is the chamber, such as chamber 3630, in order to reduce the vapor pressure exerted on the precursor liquid being heated and to as a result decrease the temperature required to generate a vapor and/or aerosol from the precursor liquid. Alternatively, dispenser valve 3830 may be selectively held open to permit precursor fluid entry into the chamber prior to initial actuation, ensuring that the heater does not activate in the absence of sufficient precursor. Control of arms 3814 and 3818 may be accomplished via independent linear actuators, dual solenoids, micro-motors, shape memory alloys, or other actuation technologies. In certain embodiments, actuation may be governed by a programmable controller, employing algorithms that coordinate valve positions with operational parameters such as temperature, sensed pressure, or inhalation detection. Alternatively, manual switches, user interface elements, or preset mechanical linkages may be used to control valve actuation sequences based on user preference or device configuration. In an embodiment the valve may be positioned in the open position and then closed automatically if environmental conditions such as increased temperature and/or decreased atmospheric pressure are detected as to prevent leakage of precursor from the reservoir due to environmental temperature changes or changes in atmospheric pressure.

In some configurations, automatic activation of the vaporizer may be desirable with no required user input beyond the application of suction. However, when a valve, such as one blocking outlet 160, is in the closed position, user inhalation may not be directly sensed by airflow detection elements situated downstream of the valve. To address this limitation, the device may be equipped with an additional flow path configured specifically for detecting inhalation attempts. This secondary flow path may include a bypass channel containing a pressure sensor, a flow sensor, or a microphone capable of detecting minute pressure differentials or acoustic signatures associated with suction. In an alternative embodiment, detection may occur via sensors integrated upstream of the primary outlet valve, relying on measurements such as diaphragm deflection, humidity changes, or even thermal flow sensing to identify inhalation events. In some cases, both electrical and mechanical detection modalities may be combined. Selection among these approaches may depend on device architecture, intended use-case, and power consumption requirements.

FIG. 39 illustrates a cross-sectional view of vaporizing device 3900. Vaporizing device 3900 may include flow path 3910, port 3912, cartridge 3920, lower valve 3930, upper valve 3940, inlet 3950, sensor 3955, outlet 3960, chamber assembly 3970, and controller 3980. Vaporizing device 3900 may serve as an example of other vaporizing devices disclosed herein, and may incorporate similar or alternative configurations as appropriate for the intended use.

Cartridge 3920 may comprise lower valve 3930, which may be configured to regulate the flow of precursor material from cartridge 3920 to chamber assembly 3970, and upper valve 3940, which may be configured to regulate the flow of vapor and/or aerosol through outlet 3960. As depicted in FIG. 39, when upper valve 3940 is open, suction 3906 may pass through outlet 3960, bypassing chamber assembly 3970, and through inlet 3950, thereby exerting a signal to sensor 3955.

Sensor 3955 may be positioned within inlet 3950 and may be configured to monitor intake pressure or another property of the intake air, providing data to controller 3980. In certain embodiments, sensor 3955 may comprise a MEMS microphone or other pressure-sensitive element adapted to measure intake air pressure changes. In certain embodiments sensor 3955 is part of a flow detection system in which flow rate is measured, in such an embodiment the pressure is calculated based on the measured flow through the system. Several methods may be used by the programming in the controller 3980 for the mathematical determination of the pressure by using the measured flow rate through inlet 3950, including but not limited to, the Darcy-Weisbach equation for turbulent flow, or the Hagen-Poiseuille equation for laminar flow, as these account for fluid properties, pipe geometry, and velocity, Bernoulli's equation can also be used, especially when comparing the pressure between two points, and can be combined with the continuity equation to solve for unknown pressures and velocities. In addition, machine learning/training methods may be used to correlate measured inputs to flow rate and/or pressure. Detection of a pressure change exceeding a predefined magnitude may indicate to controller 3980 that suction has been applied at outlet 3960, upon which controller 3980 may activate a heater contained within chamber assembly 3970. In some embodiments, controller 3980 may further modulate power delivered to the heater in response to real-time pressure signals from sensor 3955. In particular, the controller may select from a plurality of predefined heating profiles corresponding to specific pressure change patterns, allowing for customized or adaptive operation.

When upper valve 3940 is closed, it may block suction 3906 from reaching sensor 3955 if an auxiliary flow path, such as flow path 3910, were not present. In such cases, controller 3980 may not detect suction at outlet 3960 and might require user intervention, such as manual switch activation, or another means to initiate device operation. Vaporizing device 3900 may therefore include flow path 3910, which may be configured to bypass upper valve 3940 and direct a portion of suction 3906 through port 3912 to a region upstream of sensor 3955 located within or adjacent to inlet 3950. This arrangement may enable vaporizing device 3900 to be automatically activated upon detection of suction 3906, even when upper valve 3940 is closed. Additionally, this arrangement may provide the controller 3980 with greater flexibility in managing vapor or aerosol generation cycles. For example, controller 3980 may be programmed to maintain upper valve 3940 in a closed state for a specified portion of the cycle, thereby controlling the timing, concentration, or delivery characteristics of released vapor or aerosol. In an embodiment flow path 3910 is closed by the opening of upper valve 3940, and conversely flow path 3910 is opened by the closing of upper valve 3940.

Means and methods of vapor and/or aerosol generation have been disclosed herein. Some methods may be open-ended, while others incorporate some degree of feedback. Different precursor compositions may require different inputs to generate an optimum vapor and/or aerosol output. For example, precursors containing nicotine may require a different set of inputs than precursors containing cannabis compounds. Some vaporizing devices may incorporate spectroscopy, spectrophotometry, interferometry, and/or refractive index measurement to analyze a precursor composition prior to vaporization.

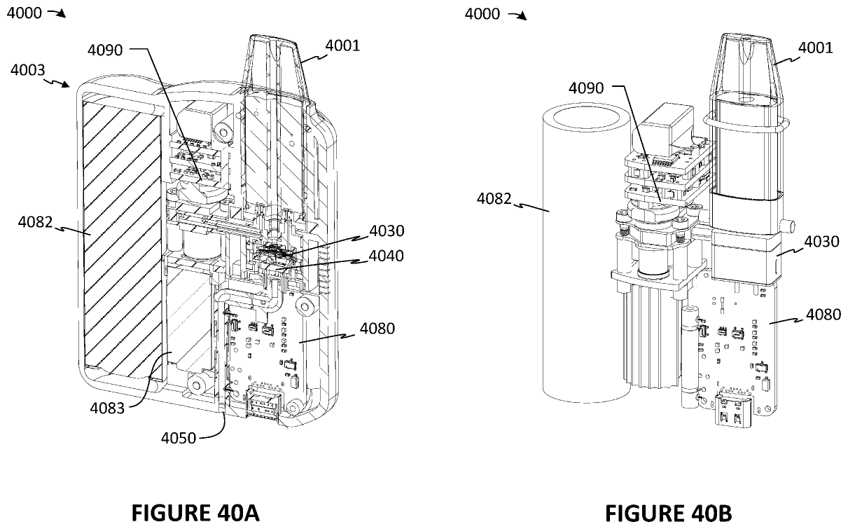

FIG. 40A presents a cross-sectional view of vaporizing device 4000, while FIG. 40B provides an isometric view of vaporizing device 4000 with its housing removed. Vaporizing device 4000 may include cartridge 4001, base unit 4003, chamber 4030, heater 4040, inlet 4050, controller 4080, battery 4082, battery 4083, and spectrometer 4090. Various embodiments of cartridge 4001, base unit 4003, chamber 4030, heater 4040, inlet 4050, controller 4080, battery 4082, and battery 4083 have been described elsewhere herein, and interchangeable or alternative configurations of these components may be employed, depending on device requirements or desired performance characteristics.

Spectrometer 4090 may be configured to broadly measure electromagnetic radiation, including but not limited to infrared (IR) and ultraviolet (UV) wavelengths, associated with a precursor composition housed in chamber 4030. In certain embodiments, spectrometer 4090 may utilize an IR spectrometer capable of multi-wavelength measurement for comprehensive spectral analysis. Suitable spectrometer configurations may include compact or miniaturized interferometers, such as fiber-optic Michelson interferometers, miniature lamellar grating interferometers, Fizeau, or white-light interferometers, which function analogously to prisms or gratings in order to separate and resolve IR or other radiation into constituent wavelengths. Such miniaturized spectrometers may be fabricated using silicon fabrication techniques to increase portability and facilitate integration into device housing. By analyzing the resultant spectra, spectrometer 4090 may determine absorbance, transmittance, or emission characteristics of the precursor composition and communicate relevant data to controller 4080. In some embodiments, controller 4080 may regulate the energy output, spectral characteristics, or timing of heater 4040 in response to spectroscopic data received from spectrometer 4090, thereby improving operational efficiency or vapor quality.

Spectrometer 4090 may also support identification or qualification of precursor compositions by comparing measured spectral data to reference profiles stored within controller 4080 or in an external database. In some instances, detailed precursor characterization may be performed in laboratory settings utilizing alternative modalities, such as Fourier-transform infrared (FTIR), attenuated total reflectance FTIR (ATR-FTIR), Dispersive IR (DIR), Raman Spectroscopy, Near-Infrared (NIR) spectroscopy, Diffuse Reflectance Infrared Fourier Transform Spectroscopy (DRIFTS), PiF-IR, or laser spectrometers, with the compiled spectral profiles later referenced by controller 4080 in device operation. Spectrometer 4090, in conjunction with controller 4080, may acquire and analyze the spectral data of the precursor, enabling heater 4040 to be controlled according to a matching predefined profile. In some cases, vaporizing device 4000 may be configured to disable heater 4040 if an unrecognized or incompatible precursor composition is detected. Alternatively, the device may continue to operate heater 4040 by dynamically adjusting output parameters based on real-time data acquired by spectrometer 4090, even without the use of stored profiles.

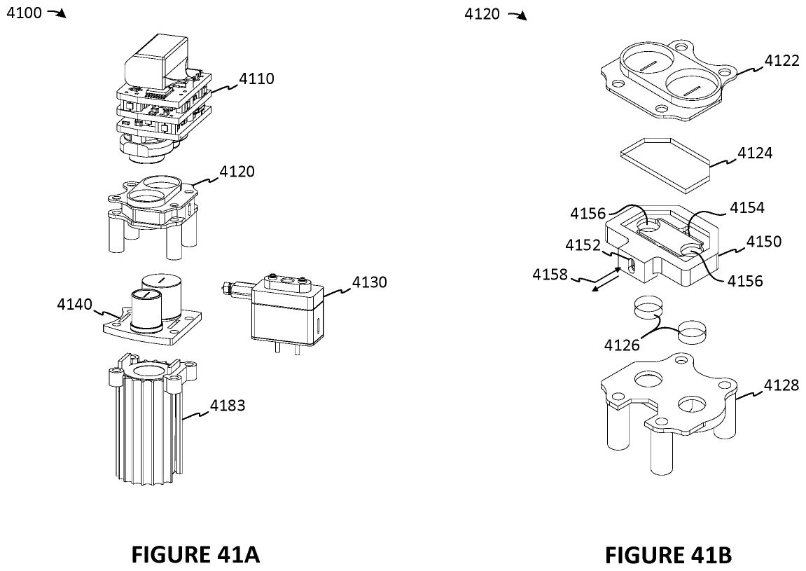

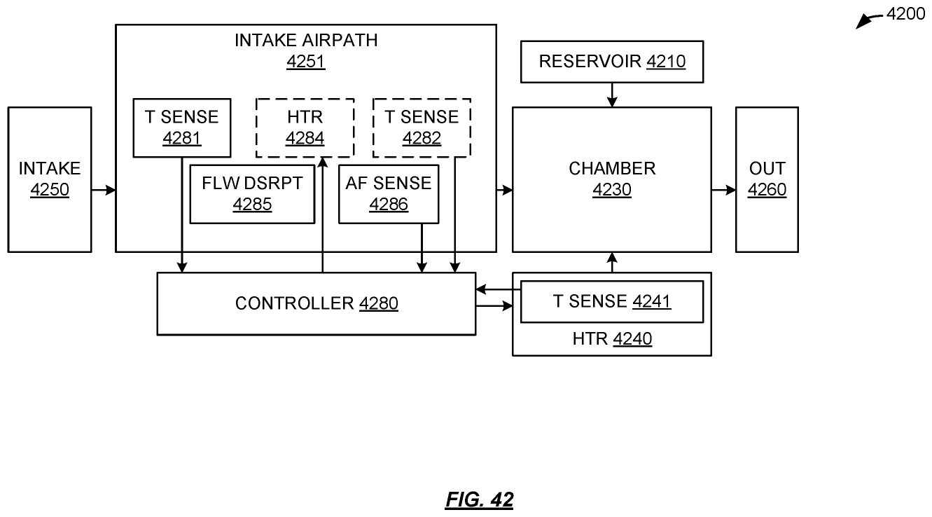

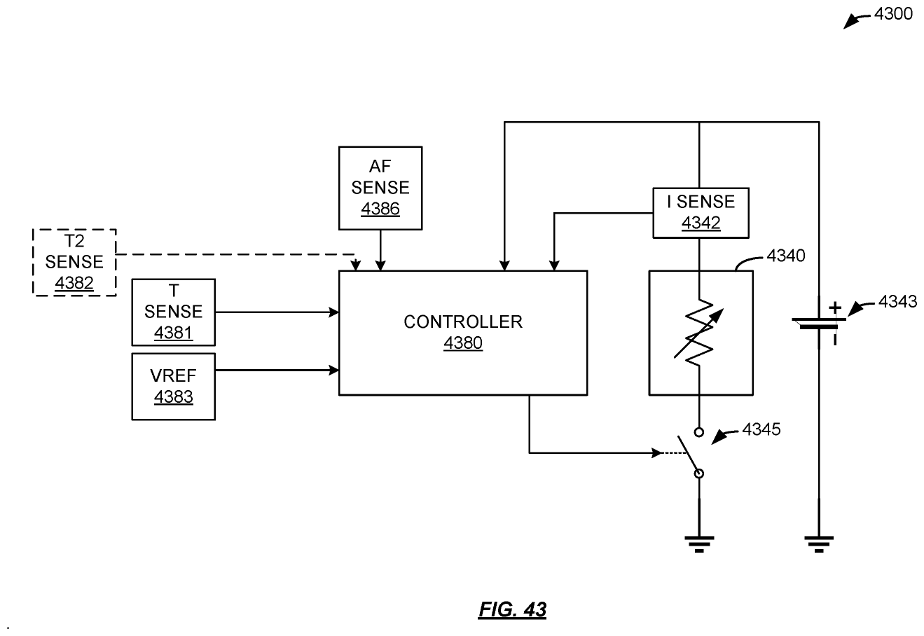

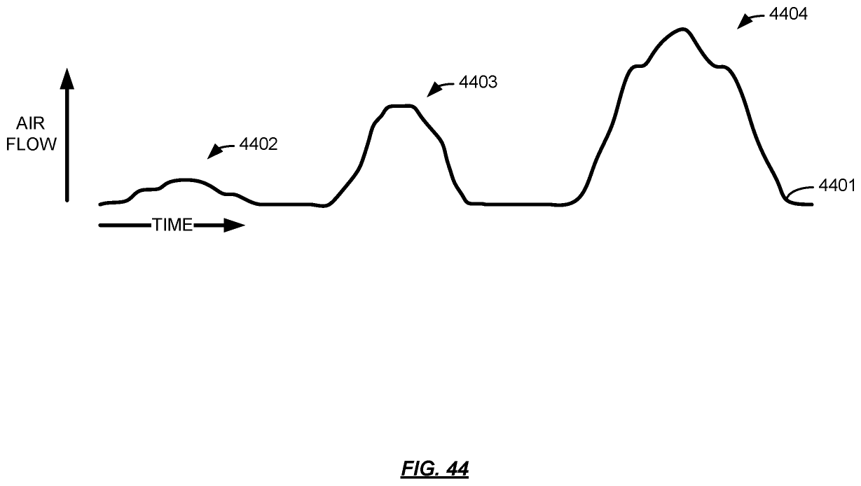

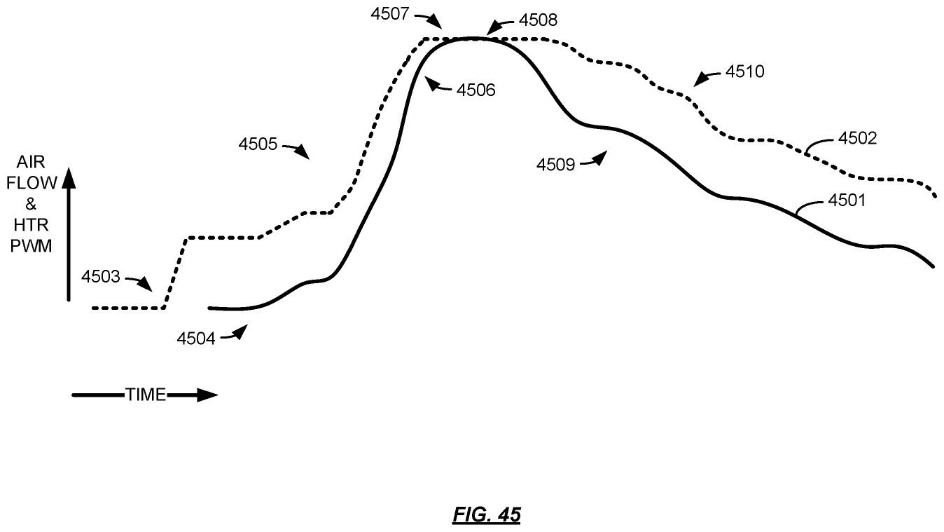

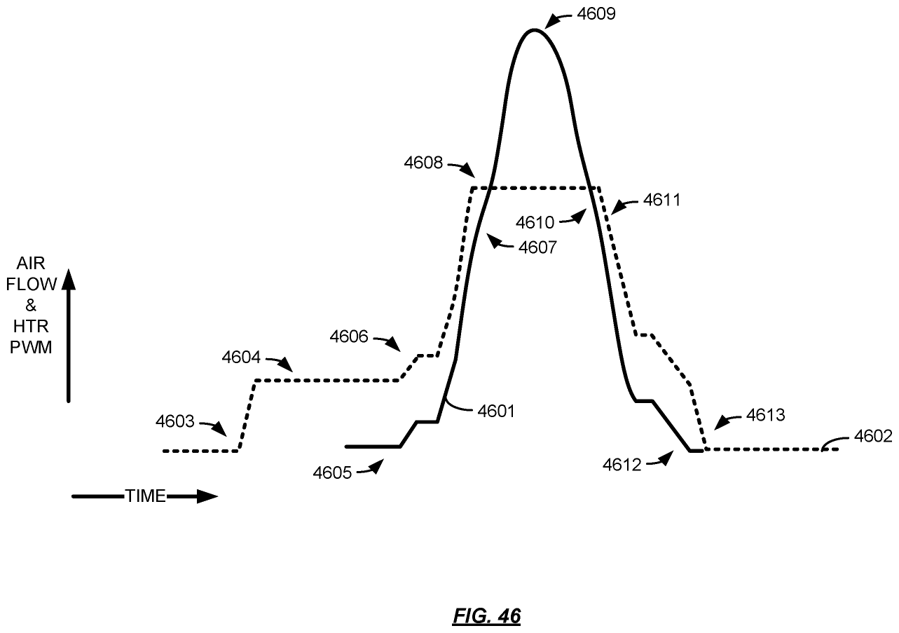

FIG. 41A illustrates an exploded view of spectrometer 4100, and FIG. 41B illustrates an exploded view of sample chamber 4120. Spectrometer 4100 may comprise detector 4110, sample chamber 4120, emitter 4140, and battery 4183. Vaporization chamber 4130 may correspond to examples provided elsewhere herein, and may, in some embodiments, be configured to supply a portion of precursor composition to sample chamber 4120 for spectral analysis prior to vaporization.

Detector 4110, as included within spectrometer 4100, may be configured to analyze the intensity of electromagnetic radiation, including UV and/or IR wavelengths, either transmitted through or reflected from a precursor sample. Detector 4110 may provide processed or raw signal data to a controller for spectral analysis. In certain embodiments, detector 4110 may include one or more photodiodes, photodiode arrays, InGaAs detectors, CCD or CMOS sensors, or similar photon detection devices capable of resolving particular spectral ranges of interest.

Sample chamber 4120 may be configured to contain a precursor sample for analysis by spectrometer 4100. Sample chamber 4120 may comprise upper retaining plate 4122, upper window 4124, sample cell body 4150, lower optical elements 4126, and lower retaining plate 4128. Sample cell body 4150 may include port 4152, channel 4154, and one or more apertures 4156. In some embodiments, sample chamber 4120 may be configured to continuously monitor the flow of the precursor liquid as it moves from a reservoir to a vaporization chamber. In some embodiments, sample chamber 4120 may be configured to to be heated to facilitate the flow of a thermoviscous precursor liquid. In some embodiments, sample chamber 4120 may be configured to to be heated to control the flow rate of a thermoviscous precursor liquid through the sample cell. Alternatively, sample chamber 4120 may be designed for batch sampling, in which a static portion of precursor is retained for analysis. Selective heating of sample chamber 4120 may be used for batch sampling, in which a static portion of a thermoviscous precursor is retained for analysis, and then selectively heated to be mobilized from the sampling chamber. In some embodiments the sample chamber may be incorporated into the cartridge, such as the cartridge 4001 or any of the cartridges described herein. In some embodiments the sample chamber may be incorporated into the reservoir, such as the reservoir 3710 or any of the reservoirs described herein.

Upper retaining plate 4122 may function as a mechanical clamp that applies pressure to seal upper window 4124 against sample cell body 4150. Upper retaining plate 4122 may be joined to lower retaining plate 4128 using screws, bolts, or other fastening means. In certain embodiments, upper retaining plate 4122 may be provided with slits or apertures to attenuate the intensity of transmitted radiation and/or light, and may include features for alignment or mating with detector 4110.

Upper window 4124 may be a transparent plate configured to permit transmission of at least UV and IR light. Upper window 4124 may mate with sample cell body 4150 to form a seal on the upper surface, thereby containing precursor liquid while providing a clear optical path for incident light and/or transmitted radiation.

Sample cell body 4150 may be designed to receive and direct a flow 4158 of precursor fluid, defining a pathway over one or more apertures 4156 for analysis. Port 4152 may be positioned to couple with vaporization chamber 4130, thus enabling reception and return of a precursor sample from a dispenser or similar element. Channel 4154 may receive flow 4158 of precursor, direct it over apertures 4156, and permit return flow via port 4152.

Sample cell body 4150 may be configured to receive and direct a flow 4158 of a precursor fluid and define a flow path of the fluid over one or more apertures 4156 for analysis. Sample cell body 4150 may include port 4152 configured to couple to vaporization chamber 4130 to receive and return a flow 4158 of a precursor from a dispenser or some other element included in vaporization chamber 4130. Port 4152 may be in fluidic communication with channel 4154. Channel 4154 may be configured to receive flow 4158 of precursor, direct flow 4158 over apertures 4156, and return flow to vaporization chamber 4130 via port 4152. Sample cell body 4150 may be manufactured from materials that are preferably non-reactive with precursor compositions and chemically inert. Sample cell body 4150 may be fabricated from materials substantially non-reactive with the precursor composition, such as stainless steel, glass, ceramics, or other chemically inert substances.

Sample cell body 4150 may be configured to mate with upper window 4124 and lower optical elements 4126. Upper retaining plate 4122 and lower retaining plate 4128 may operate as clamps, securing upper window 4124, sample cell body 4150, and lower optical elements 4126 together in a liquid-tight assembly.

Lower optical elements 4126 may comprise one or more transparent plates allowing transmission of UV and/or IR radiation, and may mate with sample cell body 4150 to form a seal on its lower surface. In some embodiments, lower optical elements 4126 may be provided as disc-shaped optical elements. Lower optical elements 4126 may serve as simple windows, lenses to focus or collimate incident light, or as diffraction gratings or filters for spectral dispersion or wavelength selection.

Lower retaining plate 4128 may serve as a mechanical clamp, applying pressure to lower optical elements 4126 to seal them against the sample cell body 4150. Lower retaining plate 4128 may be connected to upper retaining plate 4122 by screws, bolts, or other suitable fastening techniques. In some embodiments, lower retaining plate 4128 may be provided with features configured to align with or secure emitter 4140.

Emitter 4140 may be configured to generate electromagnetic radiation in a selected wavelength range appropriate for probing the precursor sample. Emitter 4140 may direct light and/or electromagnetic radiation through the sample contained within sample chamber 4120, facilitating detection by detector 4110. In some cases, emitter 4140 may produce radiation in the UV, IR, or additional wavelength regions, depending on the spectral characteristics required for analysis.

Battery 4183 may be configured to supply power to spectrometer 4100. As illustrated in FIG. 41A, battery 4183 may be positioned adjacent to or surrounded by a heatsink structure configured to dissipate thermal energy generated by emitter 4140 or other electrical components. In certain embodiments, battery 4183 may be supplemented or recharged by an auxiliary battery, such as battery 4082, to extend operational duration or provide redundancy.

FIG. 42 is a block diagram illustrating a vaporizer. In FIG. 42, vaporizer 4200 comprises reservoir 4210, vaporizing chamber 4230, chamber heater 4240, air intake 4250, intake airpath 4251, output 4260, and controller 4280. Heater 4240 includes temperature sense 4241. Intake airpath 4251 includes temperature sense 4281, flow disrupter 4285, and airflow sense 4286. Intake airpath 4251 optionally includes temperature sense 4282 and intake air heater 4284. Temperature sense 4281, temperature sense 4282 (if present), heater 4284 (if present) and airflow sense 4286 are operatively coupled with controller 4280. Controller 4280 is operatively coupled with heater 4240 and temperature sense 4241. Controller 4280 is operatively coupled with heater 4240 to control the heating of chamber 4230 to vaporize substances drawn from reservoir 4210.

During operation, air is induced by a user to flow into intake 4250, through intake airpath 4251, through chamber 4230, and output 4260 (e.g., a mouthpiece). Also during operation, the air flowing along intake airpath 4251 flows over flow disrupter 4285 that induces vortex shedding. The vortices shed by flow disrupter 4285 induce pressure and/or acoustic fluctuations during inhalation. In other words, flow disrupter 4285 may convert a substantially laminar inflow into a time-varying vortical pattern as the intake airflow passes the flow disrupter 4285.

Flow disrupter 4285 may be, for example, a wire spanning the intake airpath, a cylinder, rib, vane, tab, perforated plate, lattice, airfoil-like forms, bluff posts, integral fins, and/or other structures configured to promote vortex shedding or controlled turbulence. The geometry, placement, and surface finish may be selected, for example, to obtain a desired amplitude and frequency range for resulting fluctuations.

Airflow sensor 4286 picks up the pressure variations caused by these vortices. Airflow sensor 4286 may be or comprise a transducer (e.g., microphone, MEMS microphone, and/or pressure sensor). In an embodiment, airflow sensor 4286 may be in communication with these variations via a transducer port and thus may not be placed directly in the intake airflow. In another embodiment, airflow sensor 4286 may be placed directly in the intake airflow. Airflow sensor 4286 or the transducer port (if any) may be placed downstream of flow disrupter 4285 to observe the shedding field with a strong signal-to-noise ratio. Thus, when a user inhales, airflow sensor 4286 provides a signal to controller 4280 containing time-varying features (e.g., pulses or spectral peaks) indicative of the instantaneous flow rate. In an embodiment, controller 4280 may derive a flow rate value using time-domain pulse detection and/or frequency-domain analysis (e.g., FFT). Based on this flow rate value, controller 4280 may modulate heater 4240 power (e.g., using PWM). Based on this flow rate control 4280 may calculate real time pressure values using methods previously described herein.

In an embodiment, for time-domain pulse detection, the output of airflow sensor 4286 may be AC coupled to the input of a comparator. The output of this comparator may produce a digital pulse train that is analyzed by controller 4280 to determine the flow rate value.

For frequency-domain analysis, the output of airflow sensor 4286 may be coupled to an analog-to-digital converter which provides a time-series of digital values to controller 4280. This time-series of digital values may be analyzed by controller 4280 to determine the flow rate value. Controller 4280 may use spectral analysis to determine the flow rate value. Thus controller 4280 may compute an FFT, Goertzel, filter-bank energies, or wavelet coefficients. A passband (e.g., around ~1-5 kHz for certain flow disrupter 4285 geometries) may be used, although other bands can be selected by design.

Controller 4280 may construct a flow rate value as a monotonic function of one or more features: pulse count per window, dominant frequency, or band-limited spectral energy. A calibration mapping may be generated from known flows and stored in a non-volatile memory as a table or parametric equation. A calibration mapping of pressure values as they correlate to flow rates may be generated from known flows and stored in a non-volatile memory as a table or parametric equation. Controller 4280 may estimate the flow rate value from the time- or frequency-domain metrics to a flow-correlated value—optionally using a calibration look-up table (LUT) derived from empirical data (e.g., syringe-pump flows, flow bench, or user testing). Controller 4280 may estimate the pressure based on the flow rate value from the time- or frequency-domain metrics to a flow-correlated value—optionally using a calibration look-up table (LUT) derived from empirical data (e.g., syringe-pump flows, flow bench, or user testing). In some embodiments, regression models, adaptive filters, or machine learning (e.g., trained on spectrogram images or raw sequences) may be employed to produce the flow-correlated value. In some embodiments, regression models, adaptive filters, or machine learning (e.g., trained on spectrogram images or raw sequences) may be employed to produce pressure value correlated to the flow-correlated value. The results may include high-resolution, real-time flow sensing enabling inhalation topography capture. The results may include high-resolution, real-time pressure data based on the flow sensing enabling inhalation topography capture.

In an embodiment, temperature sensor 4281 measures incoming air, intake-air heater 4284 raises air temperature, and a temperature sensor 4282 confirms post-heat temperature. Controller 4280 may drive heater 4284 such that intake-air temperature is normalized toward a target range regardless of ambient air temperature. Airflow sensor 4286 (or port) may be upstream of the heater 4284 so flow sensing precedes heating. Spacing between airflow sensor 4286 and intake heater 4284 may be chosen such that the thermal rise coincides with airflow arrival at the chamber, considering transit time under typical puff rates. Downstream passage sections of intake airpath 4251 can be tortuous or coiled to increase residence time for heat transfer. Optionally, a relative humidity sensor upstream of the intake heater and coupled with controller 4280 may allow humidity-aware control.

Thus, in this embodiment, a temperature sensor 4281, heater 4284, and temperature sensor 4282 may implement a feedback loop that regulates intake air to a setpoint (e.g., 35-80° C. in some embodiments; other ranges may be used). Controller 4280 may apply proportional-integral-derivative controller, proportional-integral, bang-bang, model-predictive, feed-forward, or hybrid control. In some embodiments, the elements in intake airpath 4251 (not shown in FIG. 42) may cool or dehumidify intake air using different conditioning elements, e.g., thermoelectric devices or desiccants.

Heater 4240, under the control of controller 4280, heats chamber 4230 to vaporize substance received into chamber 4230 from reservoir 4210. In an embodiment (e.g., etched metallic heaters, photochemically etched foil, thick-film, ceramic, PTC, or wire-wound), heater 4240 resistance varies with temperature. Controller 4280 may incorporate a precision voltage reference and current sensing (e.g., shunt or Hall) to determine voltage, current, and hence resistance of heater 4240 within PWM cycles, while compensating for battery voltage sag. Controller 4280 may compute heater temperature from resistance using known characteristics (e.g., temperature vs. resistance, empirically derived curve, etc.). Controller 4280 may compensate for battery variation by measuring battery voltage, internal resistance, and temperature, and may normalize power to heater 4240 to maintain consistent wattage.

In some embodiments the controller 4280 may periodically sample the current, battery voltage, etc. when the PWM is in a low-impedance phase (switch on time) or may synchronously sample with respect to the PWM pulses to improve accuracy. A closed control loop implemented by controller 4280 may use flow rate, intake-air temperature(s), and heater temperature to pulse-width modulate power applied to heater 4240. In an embodiment, controller 4280 may preemptively adjust power based on a predicted inhalation profile derived from early signal portions, and detect puff end to cease heating. In an embodiment, controller 4280 may preemptively adjust power based on a predicted inhalation profile derived from early signal portions, and predict puff end to cease heating prior to actual end of puff.

Mappings from flow rate value to target heater 4240 power by controller 4280 may be linear, piecewise, non-linear, or table-driven. Controller 4280 may incorporate temperature compensation, altitude, or ambient pressure compensation, and fluid properties. In an embodiment, to reduce latency at puff onset, controller 4280 may maintain a ready temperature in chamber 4230 that is below aerosolization onset when the device is idle. The ready temperature may be a programmable offset above ambient, may increase after recent use, or may be disabled during transport. Coordination with intake-air conditioning improves first-puff consistency.

In some embodiments, controller 4280 may generate an inhalation signature from the time-varying airflow signals. A signature may be compared with a stored template to operate an enable gate, thereby applying power to heater 4240. The signature may comprise temporal, spectral, and/or statistical features. The controller 4280 may update templates over time or maintain multiple profiles (e.g., for parental controls, access control, or personalization). Other gating criteria may be used (e.g., PIN, proximity, or multi-factor combinations).

As discussed herein, in an embodiment, airflow sensor 4286 may be placed directly in the intake airflow. Airflow sensor 4286 or the transducer port (if any) may be placed downstream of flow disrupter 4285 to observe the shedding field with a strong signal-to-noise ratio. Thus, when a user inhales, airflow sensor 4286 provides a signal to controller 4280 containing time-varying features (e.g., pulses or spectral peaks) indicative of the instantaneous flow rate.

In an embodiment, the von Karman vortex street and Strouhal instability may be used to estimate the flow rate through the constricted passage of intake airpath 4251. For example, air may be sucked a constricted passageway portion of intake airpath 4251 having a diameter of Do. This portion includes a sensitive microphone (e.g., airflow sensor 4286). Air is drawn at a flow rate of Q. This is typically, for example, roughly 55 ml in 3 seconds, thus Q≈18 ml/s≈18×10⁻⁶ m³/s. The average air speed may be found by, for example, solving Q=UA for U. Thus, in the example: U≈10.3 m/s. If the passageway has a cross-sectional area A of roughly 1.75 square millimeters (mm²), thus: A=1.75×10⁻⁶ m². Assuming a circular cross section implies D₀≈1.5 mm.

In an embodiment, a wire/column of diameter Dw is mounted orthogonal to the flow direction in portion of intake airpath 4251 just upstream of the microphone/airflow sensor 4286 to act as flow disrupter 4285. In various embodiments, the wire/column flow disrupter 4285 may be oriented horizontally or vertically. Airflow past the wire/column flow disrupter 4285 causes vortex shedding at frequency f. These vortices impact microphone based airflow sensor 4286 and may be detected as audible noise. The FFT of the audio signal may be computed, and from the peak in the spectrum, the shedding frequency f may be determined. From the foregoing, the Reynolds number for the flow may be calculated from:

$$R e = \frac{U {D}_{0}}{v}$$

where ν is the kinematic viscosity of air. Using a ν=1.5×10⁻⁵ m²/s yields: Re≈1020. A Strouhal number St which may be used to estimate the vortex-shedding frequency, f. For flow around a wire:

$$S t = \frac{f {D}_{w}}{U}$$

The Strouhal number has a stable value of roughly 0.2 for a range of flows encompassing the estimated Reynolds number of 1020. This yields:

$$f \approx 0.2 U {D}_{w} \approx \frac{2}{{D}_{w}}$$

From the foregoing, it should be understood that at the typical inhalation rate, the frequency generated by the vortices and thus picked up by microphone based airflow sensor 4286 are determined by the wire diameter, D_{w}. For example, at a typical airflow rate (e.g., Q≈18 ml/s≈18×10⁻⁶ m³/s), to generate an f=5 kHz, D_{w}=400 μm; f=10 kHz, D_{w}=200 μm; and f=20 kHz, D_{w}=100 μm. Variance in the shedding frequency f from the selected ‘typical’ frequency indicate (e.g., to controller 4280) variances in the inhalation flow rate that may be used to determine a ‘measured’ inhalation flow rate.

FIG. 43 is a block diagram illustrating a vaporizing chamber heater control system. In FIG. 43, control system 4300 comprises chamber heater 4340, current sense 4342, battery 4343, controlled switching 4345, controller 4380, temperature sense 4381, optional temperature sense 4382, voltage reference 4383, and airflow sense 4386. Current sense 4342, battery 4343, temperature sense 4381, optional temperature sense 4382, voltage reference 4383, and airflow sense 4386 are all operatively coupled with controller 4380. Current sense 4342, battery 4343, temperature sense 4381, optional temperature sense 4382, voltage reference 4383, and airflow sense 4386 are all operatively coupled to controller 4380 to provide input parameters to controller 4380 to form one or more closed loop control systems. Controller 4380 operates controlled switching 4345 to cause current to flow through heater 4340. In an embodiment, based on one or more parameters received from one or more of current sense 4342, battery 4343, temperature sense 4381, optional temperature sense 4382, voltage reference 4383, and airflow sense 4386, controller 4380 modulates (e.g., PWM, PFM, etc.) the current flowing through heater 4340 by controlling switching 4345 (e.g., a field-effect transistor) to selectively close (thereby conducting current from battery 4343 though current sense 4342 and heater 4340) and open (thereby interrupting/preventing current from flowing though heater 4340).

Airflow sensor 4386 is configured to respond to pressure variations caused by non-laminar airflow. Airflow sensor 4386 may be or comprise a transducer (e.g., microphone, MEMS microphone or pressure sensor). In an embodiment, airflow sensor 4386 may be in communication with these variations via a transducer port and thus may not be placed directly in the non-laminar airflow. In another embodiment, airflow sensor 4386 may be placed directly in the non-laminar airflow. Thus, when a user of the vaporizer being controlled by system 4300 inhales, airflow sensor 4386 provides a signal to controller 4380 containing time-varying features (e.g., pulses or spectral peaks) indicative of the instantaneous flow rate. In an embodiment, controller 4380 may derive a flow rate value using time-domain pulse detection and/or frequency-domain analysis (e.g., FFT). Based on this flow rate value, controller 4380 may modulate switching 4345 (and thus the power output by heater 4340) power based on the flow rate value.

In an embodiment, for time-domain pulse detection, the output of airflow sensor 4386 may be AC coupled to the input of a comparator. The output of this comparator may produce a digital pulse train that is analyzed by controller 4380 to determine the flow rate value.

For frequency-domain analysis, the output of airflow sensor 4386 may be coupled to an analog-to-digital converter (e.g., which is part of controller 4380) to generate a time-series of digital values for use by controller 4380. This time-series of digital values may be analyzed by controller 4380 to determine the flow rate value. Controller 4380 may use spectral analysis to determine the flow rate value. Thus, controller 4380 may compute an FFT, Goertzel, filter-bank energies, and/or wavelet coefficients. A passband may be used, and/or selected by design.

Controller 4380 may construct a flow rate value as a monotonic function of one or more features: pulse count per window, dominant frequency, or band-limited spectral energy. A calibration mapping may be generated from known flows and stored in a non-volatile memory as a table or parametric equation. Controller 4380 may estimate the flow rate value from the time- or frequency-domain metrics to a flow-correlated value. Optionally using a calibration look-up table (LUT) derived from empirical data (e.g., syringe-pump flows, flow bench, or user testing). In some embodiments, regression models, adaptive filters, or machine learning (e.g., trained on spectrogram images or raw sequences) may be employed to produce the flow-correlated value. The results may include high-resolution, real-time flow sensing enabling inhalation topography capture. Capture of inhalation topography may be utilized by a machine learning program to optimize activation cycles based on cumulative inhalation topography data such that the device may develop and refine activation cycles optimized for specific inhalation topographies. Activation cycle optimization based on captured inhalation topography may be further optimized by real-time control based on predictive assessment by the machine learning program such that inhalation topography may be evaluated real time at high frequency, for example several thousand times per second, and adjustments made to the activation cycle based on real time assessment of the inhalation, including but not limited to predictive adjustments based on captured inhalation topography data.

In an embodiment, temperature sensor 4381 measures incoming air temperature. In some embodiments, sensor 4382 confirms post-heat temperature. Controller 4380 may drive a heater such that intake-air temperature is normalized toward a target range regardless of ambient air temperature. Airflow sensor 4386 (or port) may be upstream of the heater 2584 so flow sensing precedes heating. In some embodiments, a relative humidity sensor (not shown in FIG. 43) coupled with controller 4380 may allow humidity-aware control. Heating of incoming air may be optimized by machine learning where other activation data points such as inhalation duration, inhalation volume, inhalation frequency, and other inhalation topography metrics such as those captured during an inhalation cycle may be used to evaluate the overall quality of the activation cycle, these metrics, and other metrics gathered by the sensors and controller may be assimilated by a machine learning program to develop optimized intake airflow preheating parameters, such parameters may be adjusted in real time and/or on a predictive basis by the controller.

Switching 4345, under the control of controller 4380, causes heater 4340 to vaporize substance received into a chamber from a reservoir. In an embodiment (e.g., etched metallic heaters, photochemically etched foil, thick-film, ceramic, PTC, or wire-wound), the resistance of heater 4340 varies with temperature. Controller 4380 receives parameters from a precision voltage reference 4383 and current sensing 4342 (e.g., shunt or Hall) to determine voltage, current, and hence resistance of heater 4340 within PWM cycles, while compensating for battery voltage sag (e.g., by comparing voltage reference 4383 to the voltage of battery 4343). Controller 4380 may compute heater temperature from resistance using known characteristics (e.g., temperature vs. resistance, empirically derived curve or curves, etc.). Controller 4380 may compensate for battery variation by measuring (or comparing) battery voltage, internal resistance, and temperature, and may normalize power to heater 4340 to maintain consistent wattage.

In some embodiments controller 4380 may periodically sample the current, battery voltage, etc. when the switching 4345 is closed (i.e., “on”) and may sample synchronously with PWM pulses to improve accuracy. A closed control loop implemented by controller 4380 may use flow rate, intake-air temperature(s), and heater temperature to pulse-width modulate power switching 4345 and thus modulate the power generated by heater 4340. In an embodiment, controller 4380 may preemptively adjust power based on a predicted inhalation profile derived from early signal portions, and detect puff end to cease heating.

Mappings from flow rate value to target heater 4340 power by controller 4380 may be linear, piecewise, non-linear, or table-driven. Controller 4380 may incorporate temperature compensation, altitude, or ambient pressure compensation, and fluid properties. In an embodiment, to reduce latency at puff onset, controller 4380 may maintain a ready temperature in a vaporizing chamber that is below aerosolization onset when the device is idle. The ready temperature may be a programmable offset above ambient, may increase after recent use, or may be disabled during transport. Coordination with intake-air conditioning improves first-puff consistency. Machine learning may be utilized to determine when the ready temperature should be utilized, such that a predictive control of the ready temperature is effected by assimilation and analysis of prior use data by the individual user or in aggregate.

In some embodiments, controller 4380 may generate an inhalation signature from the time-varying airflow signals. A signature may be compared with a stored template to operate an enable gate, thereby applying power to heater 4340. The signature may comprise temporal, spectral, and/or statistical features. The controller 4380 may update templates over time or maintain multiple profiles (e.g., for parental controls, access control, or personalization). Other gating criteria may be used (e.g., PIN, proximity, or multi-factor combinations).

FIG. 44 illustrates example airflow versus time measurements for three successive puffs. In FIG. 44, example airflow measurement/profiles vs. time a sketched 4401 for three successive puffs are illustrated. The profiles of the puffs illustrated in FIG. 44 are a small 4402, medium 4403, and large 4404 puffs.

FIG. 45 illustrates example airflow and heater control system output vs time measurements. In FIG. 45, the airflow 4501 and heater output 4502 (e.g., PWM percentage as controlled by controller 4380) are illustrated on the same time scale. Before the puff begins, the user activates the device and the devices begins to preheat 4503 (e.g., at 25% PWM “on”). At 4504, the user begins the puff. During the increasing flow of the puff during 4505, the device increases the heat production to track the airflow. At 4506, the device (e.g., controller 4380) detects that a full inhale type puff is occurring. At 4507, the device applies full heat (e.g., 100% PWM “on”). During 4509, a steady drag inhale is occurring. During 4509, the airflow is decreasing as the puff starts to end. During 4510, the device decreases the heating to track the decreasing airflow.

FIG. 46 illustrates another example airflow and heater control system output vs time measurements. In FIG. 46, the airflow 4601 and heater output 4602 (e.g., PWM percentage as controlled by controller 4380) are illustrated on the same time scale. Before the puff begins, the user activates the device and the devices begins to preheat 4603 (e.g., at 30% PWM “on”). During a preheat phase, between the user activating the device and beginning to inhale, the device holds the heat output steady during 4604. At 4605, the user begins the puff. During the increasing flow of the puff during 4606, the device increases the heat production to track the airflow. At 4607, the device (e.g., controller 4380) detects that a full inhale type puff is occurring. At 4608, the device applies full heat (e.g., 100% PWM “on”). At 4609, peak inhale airflow occurs and the airflow begins to decrease. During 4610, the airflow is decreasing as the puff starts to end. During 4611, the device decreases the heating to track the decreasing airflow. At 4612, the puff ends. At 4613, the heating is halted (e.g., 0% PWM “on”). After the puff ends, the user may release the button (i.e., e.g., the heating may end based on the puff/airflow, not the button).

In various embodiments, a vapor delivery device comprises: a housing defining an airflow path between an intake and an outlet; a heater thermally coupled to an aerosolization chamber and electrically driven by a power stage; at least one transducer positioned to generate a transducer signal indicative of airflow through the airflow path; at least one temperature sensor positioned to generate a temperature signal indicative of a temperature associated with the device; and a controller operatively coupled to the power stage, the transducer, and the at least one temperature sensor, the controller configured to: (i) determine a flow parameter as a function of the transducer signal; and (ii) command a power delivery profile to the heater based at least on the flow parameter and the temperature signal such that heater power is increased with increasing airflow and decreased with decreasing airflow, wherein the heater is isolated from direct contact with liquid in the aerosolization chamber and from the airflow path.

The transducer may be or comprise at least one of: a MEMS microphone, an absolute pressure sensor, a differential pressure sensor, or a thermal anemometer. In embodiments using a thermal anemometer, the transducer comprises a heated element driven with a constant-current or constant-temperature circuit and the controller derives a flow parameter from variations in element resistance or bridge output versus airflow. The controller may determine the flow parameter using a time-domain pulse count obtained from the transducer signal during a sampling window. The controller may determine the flow parameter using a frequency-domain spectral-energy metric computed from an analog-to-digital converted transducer signal. A flow disrupter (or flow-disturbing) body may be disposed in the airflow path and configured to induce periodic pressure fluctuations in response to airflow. The flow disrupter body may be or comprise at least one of: a wire, rod, rib, vane, tab, bluff body, perforated plate, or lattice. The at least one temperature sensor may comprise a first temperature sensor positioned upstream of an airpath heater and a second temperature sensor positioned downstream of the airpath heater. The controller may maintain a mapping between the flow parameter and a target power value that is monotonically increasing over a defined operating range. The heater may be physically isolated from the airflow path and liquids by an isolation barrier (e.g., glass) and its temperature is inferred from electrical resistance measured during operation. The controller may compensate for battery voltage sag using a precision voltage reference and current-sense feedback. The controller may implement pulse-width modulation at frequencies between about 100 Hz and about 200 kHz.

In various embodiments, a vaporizing device comprises: a conduit forming a portion of an airflow path; a flow disrupter body disposed in the conduit and configured, during inhalation, to generate periodic pressure fluctuations in the airflow path; an acoustic or pressure transducer fluidically coupled to the conduit and configured to output a transducer signal in response to the periodic pressure fluctuations; a heater arranged to vaporize a fluid; and a controller configured to: (i) compute a flow parameter using one of: (A) counting pulses derived from the transducer signal during a sampling window, and/or (B) deriving spectral energy within a passband of the transducer signal; and (ii) modulate electrical power to the heater according to a mapping between the flow parameter and a target power value.

The flow disrupter body may comprise a cylindrical element having a diameter selected to yield a vortex-shedding frequency within a target passband for a design airflow range. The transducer signal may be AC-coupled to an amplifier and/or a comparator that produces a pulse train whose pulse count is within a sampling window and correlates with airflow. The controller may compute the spectral-energy over a passband centered between about 1 kHz and about 5 kHz. The controller may use a calibration lookup table generated from empirical flow data obtained using, for example, a syringe pump or flow bench. The conduit may have a cross-section (e.g., substantially circular) and a length selected to promote laminar flow upstream of the flow disrupter body. The controller may apply hysteresis and/or outlier rejection to the transducer signal prior to flow parameter estimation.

In various embodiments, a vapor generator comprises: an intake, an outlet, and an airflow path extending therebetween; a first temperature sensor disposed upstream in the airflow path; an airpath heater disposed downstream of the first temperature sensor and configured to heat intake air flowing along the airflow path; a second temperature sensor disposed downstream of the airpath heater; an aerosolization heater isolated from the airflow path; and a controller configured to drive the airpath heater to maintain an intake-air temperature setpoint based on feedback from the first and second temperature sensors, and further configured to independently drive the aerosolization heater according to a power profile responsive to airflow during inhalation.

The airpath heater may comprise a resistive element selected from a foil heater, thick-film heater, wire-wound heater, and/or positive temperature coefficient heater. The vapor generator may further comprise a humidity sensor coupled to the controller, the controller being configured to adjust the intake-air setpoint based at least in part on ambient humidity. The controller may implement a closed-loop control algorithm selected from proportional-integral-derivative control, model-predictive control, or a hybrid feed-forward/feedback scheme. The airpath heater may be positioned downstream of an airflow sensor and upstream of the second temperature sensor.

In various embodiments, a method of operating a vapor delivery device, comprises: receiving a transducer signal indicative of airflow through an airflow path of the device; determining a flow parameter from the transducer signal by (i) counting pulses in a time window and/or (ii) computing spectral energy within a frequency band; sensing at least one temperature associated with the device; determining a heater power command as a function of the flow parameter and the at least one temperature; and driving a heater with a pulse-width-modulated signal according to the heater power command while the heater remains isolated from direct contact with liquid and the airflow path.

Determining the flow parameter may include counting pulses exceeding a comparator threshold during a sampling window between about 10 ms and about 200 ms. Determining the flow parameter may include computing spectral energy in a predefined passband and normalizing the energy to a reference level. The method may include filtering the transducer signal using at least one of: a low-pass filter, a band-pass filter, a notch filter, and a moving average. The method may include detecting an end-of-inhalation condition based on a decrease in the flow parameter below a threshold for a minimum dwell time. The method may include adjusting the power profile using a temperature that is inferred from the resistance of the heater obtained from voltage and current measurements.

In various embodiments, one or more non-transitory computer-readable media are storing instructions which, when executed by one or more processors of an vapor delivery device, cause the device to: acquire a transducer signal indicative of airflow in an airflow path; compute a flow parameter by (i) counting pulses derived from the transducer signal and/or (ii) calculating a spectral-energy metric within a defined passband; acquire at least one temperature signal; compute a target power value for an aerosolization heater as a function of the flow parameter and the at least one temperature signal; and generate a pulse-width-modulated drive signal to deliver power to the aerosolization heater according to the target power value.

The instructions may cause the device to select between the time-domain pulse-count method and the frequency-domain spectral-energy method based on a quality metric. The computer-readable media may include a calibration table generated from empirical airflow measurements and stored in non-volatile memory. The instructions may cause the device to compensate for battery voltage variation by normalizing heater power delivery to maintain a target wattage. The instructions may cause the device to maintain a low-power standby state in which the heater is periodically sampled and/or pre-warmed below an aerosolization threshold.

In various embodiments, a flow-sensing assembly comprises: a conduit defining an airflow passage; a flow disrupter body positioned within the airflow passage and configured to produce periodic pressure fluctuations when airflow is present; a transducer having a fluidic or acoustic coupling to the airflow passage and configured to output a transducer signal responsive to the periodic pressure fluctuations; and processing circuitry configured to output a flow-correlated value based on the transducer signal by counting pulses and/or evaluating spectral energy.

The flow disrupter body may be or comprise a removable insert configured to be exchanged to alter a frequency response of the assembly. The conduit may be or comprise an injection-molded polymer or a metal tube and the transducer is coupled to the airflow passage via a micro-machined aperture. The processing circuitry may produce both a pulse-count value and a spectral-energy value and output a flow-correlated value based thereon. The assembly may comprise a gasket or seal configured to acoustically isolate the transducer from external ambient noise.

In various embodiments, a device comprises: an airflow path; a transducer configured to output a time-varying signal during an inhalation event; a heater configured to vaporize a fluid; and a controller configured to: (i) generate an inhalation signature from the time-varying signal; (ii) compare the inhalation signature to a stored template; and (iii) enable power delivery to the heater only upon the comparison satisfying a similarity criterion.

The inhalation signature may be or comprise at least one of: a temporal profile of the flow parameter, a spectral-energy distribution, or a statistical feature vector. The similarity criterion may be satisfied when a distance metric between the inhalation signature and the stored template is less than a threshold. The controller may update the stored template over time using incremental averaging or weighted adaptation. The controller may additionally require, for power delivery to the heater, a secondary factor. The secondary factor may be or comprise one or more of: a user input, a proximity condition, and a minimum battery level.

In various embodiments, an vapor delivery device comprises: a heater isolated from an airflow path and a liquid supply; a power stage configured to deliver electrical energy to the heater; measurement circuitry configured to measure voltage across the heater and current through the heater with respect to a precision voltage reference and to determine an electrical resistance of the heater during operation; and a controller configured to infer a heater temperature from the electrical resistance and to regulate the power stage based on the inferred heater temperature and a flow parameter indicative of airflow through the device.

The current may be measured using a shunt resistor. The voltage may be measured relative to the precision voltage reference. The controller may compute the heater resistance using Ohm's law. The current may be measured using a Hall-effect sensor that outputs a signal indicative of current (e.g., without a series shunt resistor). The voltage and/or current measurements may be synchronized to a designated phase of a pulse-width-modulated drive cycle to reduce measurement error. The controller may map the inferred heater temperature to a temperature-dependent power limit and reduce heater power upon exceeding the limit.

In various embodiments, a vaporization system comprises: a pod comprising a fluid reservoir and an aerosolization chamber; a power module releasably couplable to the pod and comprising: the flow passage with a flow-disrupting body and a transducer, an intake-air heater with dual temperature sensors, and a controller configured to modulate power delivered to a heater of the pod as a function of a flow rate value and conditioned-air temperature. The pod may function substantially as a fluid reservoir, with a portion of the air path located in the power module. The pod and power module may mate via a quick-connect (e.g., comprising magnetics). The power module may house the controller, sensors, and signal-conditioning electronics. Pods with different fluids may be usable with a common power module. The power module may be compatible with etched-foil heaters and bulb heaters. Insertion of a pod may trigger self-diagnostics of the sensing and heating subsystems. The flow-disrupting body may be integral with a housing of the power module. The system may comprise pod identification storage usable by the controller.

A vaporization device comprising: a bulb heater defining at least part of a vaporization chamber; and a separate temperature sensor disposed to sense temperature of the bulb heater or chamber, the device further comprising a controller configured to modulate heater power based on the sensed temperature and a flow rate value derived from a flow-sensing transducer. The separate temperature sensor may be a glass-bead thermistor. The bulb heater may comprise glass. The device may comprise a mounting that thermally couples the sensor to the bulb. The device may operate in a closed control loop using a separate temperature sensor.

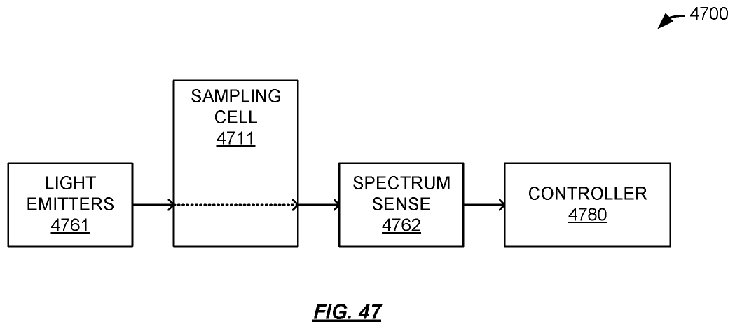

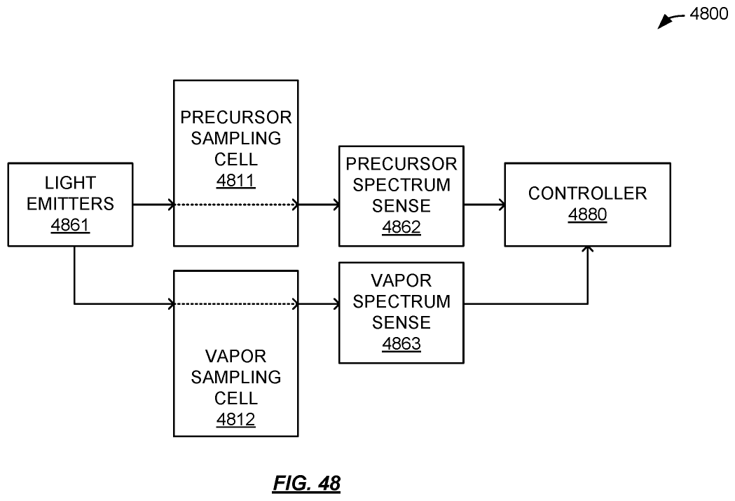

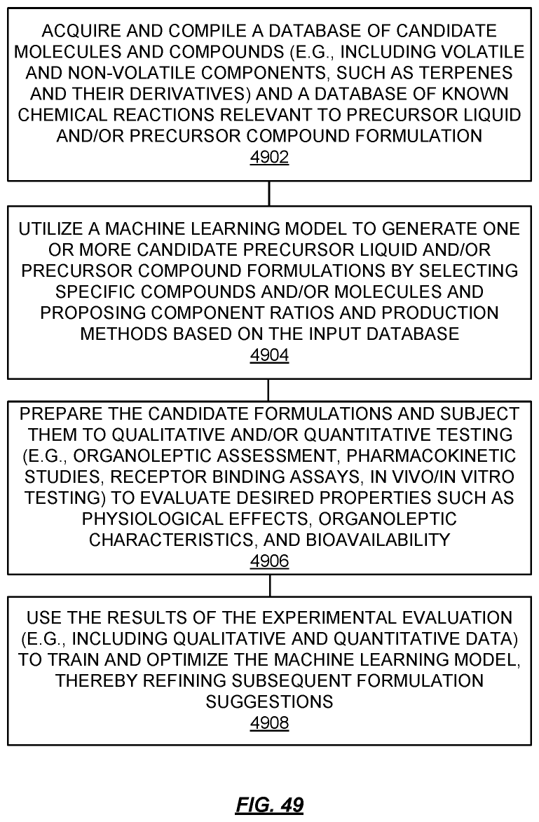

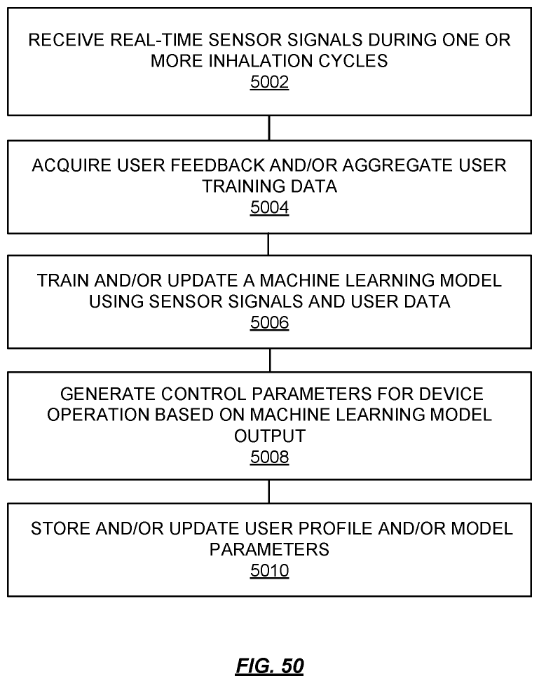

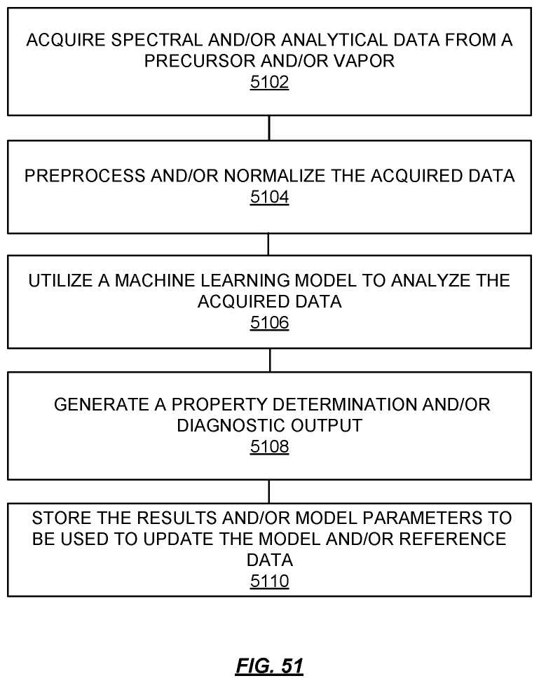

FIG. 47 is a block diagram illustrating an optical analysis subsystem. In FIG. 47, optical analysis subsystem 4700 comprises light emitters 4761, sampling cell 4711, spectrum sensor 4762, and controller 4780. In an embodiment, light emitters 4761 illuminate sampling cell 4711 which contains precursor to be analyzed before being vaporized by a personal vaporizer as described herein. The light from light emitters 4761 passes through the precursor being analyzed and, after various wavelengths are absorbed and/or amplified by the substance/liquid/precursor, is received by spectrum sensor 4762 (e.g., spectrometer, interferometer). The output of spectrum sensor 4762 is provided to controller 4780 (e.g., controller 4280, controller 4380, etc.).

In an embodiment, controller 4780 may use spectra from spectrum sensor 4762 to classify the precursor by brand, formulation, SKU family, concentration, or flavor. In an embodiment, controller 4780 may further verify pod legitimacy and detect degradation (e.g., oxidation, hydrolysis, and/or volatilization loss) by comparing the measured spectral features to stored templates and thresholds. The analysis may be performed when a pod is inserted, periodically during use, and/or upon a user-triggered diagnostic event. In some embodiments, a portion of the precursor is routed through a bypass sampling cell and returned to the reservoir or chamber; in others, the pod integrates the sampling window such that sampling can occur without additional routing.

The optical subsystem 4700 may operate across one or more spectral bands (e.g., visible, near-infrared, mid-infrared, UV, and/or white light), and may employ interferometric techniques to obtain high signal-to-noise spectra within compact packaging. Controller 4780 may store spectra, classification results, and quality metrics in non-volatile memory, and may adjust control parameters accordingly as discussed below.

In an embodiment, the precursor formulation includes at least one inert marker compound chosen to provide a strong, unique spectral signature detectable by the on-board optical subsystem 4700. The marker can improve classification accuracy, enable counterfeit detection, and facilitate verification that an approved formulation is present. In addition, the controller 4780 may utilize detected marker intensity to estimate fluid aging or dilution and to adjust power delivery, valve positions, or intake-air setpoints. The selection of such marker compounds may support separate protection of formulation compositions independent of the device embodiments. In some embodiments the inert marker or markers may be a component of the precursor that is part of a specific formulation intended to improve and/or convey attributes to the formed vapor that are desirable such as improved vapor density, and/or improved vapor flavor, and/or improved particle size formation.

Controller 4780 may adapt power delivery, preheat level, intake-air conditioning, and valve actuation as a function of the identified precursor type (e.g., nicotine strength, flavor family, cannabinoid profile). In an example, activation-cycle data (e.g., puff duration, inter-puff interval, and airflow dynamics) are collected per SKU and used to update a mapping between airflow-derived flow parameters and target heater power. The mapping may be implemented as tables, parametric equations, or machine-learning models trained on historical usage. The resulting configured/programmed controller 4700 can, for example, increase heater responsiveness for short, high-intensity puffs typical of one SKU while favoring temperature stability for longer, lower-flow puffs typical of another.

In some embodiments the architecture described herein as it relates to the construction of a sampling cell located between an emitter or emitters and a sensor and/or detector or sensors and/or detectors may be configured to analyze the refractive index of the precursor liquid. In such an embodiment the emitter may be a light source, which may be a coherent or non-coherent light source, and the sample cell may be constructed to function as a prism, and the sensor and/or detector may function to measure the angle of light refraction. The angle of light refraction is may be used to determine the precursor sample refractive index.

Several methods of determination of the refractive index of the precursor liquid sample may be utilized, including but not limited to, the use of simple internal architecture constructed with and/or in proximity to the sample cell, such as fixed pins or similar structure, and to then to use Snell's law to calculate the index of refraction from angle measurements of the light passing through the precursor liquid sample and then interacting with the fixed pins or similar structure. Additionally, a prism may be used. Using refractometers like Pulfrich refractometers can be utilized to measure the deviation of the emitted light beam as it passes through the sample cell that functions as a prism containing the precursor liquid sample. Alternatively, interferometry and the Brewster angle method may be used. Another common method that can be utilized is the critical angle method, such as is used in process refractometers, which measures the angle at which total internal reflection occurs. Another method is to utilize an interferometer, this technique uses the interference of light waves to measure small changes in the refractive index with high precision. Types of interferometers available in compact form factors that may be used include, but are not limited to, miniature versions of common interferometer types.

Examples of miniature versions of common interferometer types include, but are not limited to, the miniature Michelson interferometer which can be built on integrated platforms like low-temperature co-fired ceramics (LTCC) and designed without moving parts, as well as fiber Mach-Zehnder Interferometer (MZI) which uses optical fiber to split and recombine beams (which is often used for sensing applications). Also, the miniature Fabry-Pérot interferometer (FPI) may be used. This type is often integrated into small devices like optical microcavities and distributed Bragg reflectors.

In an embodiment, using an FPI part of the sensor and/detector array may include a Bragg reflector, or distributed Bragg reflector (DBR). This may include an optical mirror made of alternating layers of two different materials with different refractive indices. Each layer is a quarter-wavelength thick, and their precise arrangement causes reflections from each interface to interfere constructively, leading to strong reflection of light within a specific wavelength range. Another type of interferometer that may be utilized is the fiber Sagnac interferometer, which is a miniature configuration using optical fiber to create a compact setup where a beam of light is split into two paths by a beamsplitter. These two beams travel in opposite directions around a closed loop—typically a fiber optic coil or a ring interferometer (e.g., a micro ring-assisted Mach-Zehnder interferometer which uses a micro ring for enhanced performance), or a miniature Fabry-Perot interferometer. Other compact interferometers, such as miniature versions of a Fizeau and Twyman-Green interferometer, may be utilized as part of the sensor and/or detector array. Other specialized miniature designs of interferometers include the miniature lamellar grating interferometer which is designed on silicon technology that divides the incident wavefront into multiple parts for real-time spectroscopy. Additionally compact versions of white light interferometers may be used for precise measurements over short distances such as the sample cell architecture described herein. A laser diode interferometer which includes homodyne and heterodyne types that use laser diodes, and can be integrated into fiber optic configurations. Furthermore, the Brewster's Angle method may be utilized which relies on the angle at which light becomes perfectly polarized upon reflection from the liquid's surface.

Other methods that may be used include the acousto-optic method which uses the interaction of light and sound to measure the refractive index. In such an embodiment, the emitter array includes an acoustic component (such as a speaker) and the sensor and/or detector array includes an acoustic sensor (such as a microphone). Another method utilizes spectroscopic ellipsometry, where this method measures how the polarization of light changes upon reflection from a sample to determine its refractive index. In an embodiment, an inline refractometer, (also referred to as a process refractometer) may be used to determine the refractive index of the precursor liquid for continuous, real-time monitoring of liquid streams.

The specific precursor liquid formulations vary in the active component such as nicotine, or cannabinoids, or nicotine and cannabinoids, as well as having different concentrations of active components. Furthermore, the presence of additional constituents in some precursor liquid formulations such as propylene glycol (PG), vegetable glycerol (VG), acid, volatile compounds such as terpenes (monoterpenes, diterpenes, triterpenes, and/or terpenic acid or acids), water, and other compounds described herein will result in a unique refractive index for specific precursor liquid formulations.

In an embodiment, the precursor formulation has a unique detectable refractive index detectable by the on-board optical subsystem 4700. The unique refractive index can serve as a unique identifier to the specific precursor liquid formulation. The refractive index identifier may improve classification accuracy, enable counterfeit detection, and facilitate verification that an approved precursor formulation is present. In addition, controller 4780 may utilize detected refractive index values to estimate fluid aging or dilution to adjust power delivery, valve positions, or intake-air setpoints. The adjustment of power delivery, valve positions, or intake-air setpoints may be specific to optimize the activation of the vaporization device (such as any of the vaporization devices described herein) for a specific formulation, such that, for example, the activation cycle is optimized for a specific formulation as identified by the unique refractive index identifier. The refractive index identifier can support separate protection of formulation compositions independent of the device embodiments.

Methods of evaluating and/or analyzing the precursor liquid such as the use of Infra Red (IR) spectroscopy, and ultraviolet (UV) spectroscopy and the combination of IR and UV spectroscopy have been described herein. Additionally, an alternative method using the optical subsystem as a refractometer for the measurement of the refractive index of the precursor liquid has also been described herein. Another method involves constructing the optical sub-system 4700 to function as a spectrophotometer for the analysis and evaluation of the precursor liquid.

A spectrophotometer can operate over a wide spectrum of visible and non-visible light. For this method of evaluating the precursor sample the construction of the spectrophotometer may utilize a visible light source (referred to as visible spectroscopy and sometimes also referred to as white light spectroscopy—although white light spectroscopy may also include IR and UV spectrums). Visible spectroscopy is a technique that uses light in the visible range of the electromagnetic spectrum to analyze the precursor liquid by measuring the amount of light it absorbs, transmits, and/or reflects. This method can be used to identify unique characteristic of precursor liquid formulations, as each substance in the precursor formulation mixture and/or solution absorbs and transmits visible light in a unique way, thereby creating a distinct spectrum. It should be understood that it is contemplated that IR, UV and visible light spectroscopy, spectrophotometry, and refractometry can be used individually or in combination with one another, and the optical system(s) described herein may be configured to perform IR, UV and visible light spectroscopy, spectrophotometry, and refractometry or a combination thereof.

A single beam or a double beam construction may be utilized. A single beam spectrophotometer comprises of a visible light source that serves as the emitter, may have a monochromator in order to select a specific wavelength, a sample cell where the liquid precursor is present, and a detector and/or sensor to measure light intensity that passes through the sample cell. For a double-beam construction, a beam splitter is also included to direct light through both the sample and a reference beam. Dividing the light beam so it can travel through both the sample and a reference cell simultaneously or in rapid succession. This may allow for a more stable comparison.

Light sources that may be utilized to provide a beam of light include a tungsten lamp for visible light, or an LED or plurality of LEDs may be utilized. A monochromator may isolate a single, specific wavelength of light from the source. It typically contains a prism and/or diffraction grating to separate the light and a slit to control the bandpass. The emitted visible light then passes through the precursor sample chamber. The light that passes through the precursor liquid sample in the sample cell is then measured by the detector and/or sensor. The detector and/or sensor measures the intensity of light that passes through the precursor liquid sample. The detector and/or sensor converts the light energy into an electrical signal, with the signal being output often as a numerical value for absorbance or transmittance, and or generates a spectrum.

In an embodiment, the precursor formulation has a unique detectable absorbance and/or transmittance of visible light detectable by the on-board optical subsystem 4700 functioning as a spectrophotometer. The unique absorbance and/or transmittance can serve as a unique identifier to the specific precursor liquid formulation. The absorbance and/or transmittance identifier can improve classification accuracy, enable counterfeit detection, and facilitate verification that an approved precursor formulation is present. In addition, the controller 4780 may utilize detected absorbance and/or transmittance values to estimate fluid aging or dilution and to adjust power delivery, valve positions, or intake-air setpoints. The adjustment of power delivery, valve positions, or intake-air setpoints may be specific to optimize the activation of the vaporization device, such as any of the vaporization devices described herein, for a specific formulation, such that, for example, the activation cycle is optimized for a specific formulation as identified by the unique absorbance and/or transmittance identifier. The absorbance and/or transmittance identifier can support separate protection of formulation compositions independent of the device embodiments.

FIG. 48 is a block diagram illustrating a dual-cell optical analysis subsystem. In FIG. 48, optical analysis subsystem 4800 comprises light emitters 4861, precursor sampling cell 4811, vapor sampling cell 4812, precursor spectrum sensor 4862, vapor spectrum sensor 4863, and controller 4880. In an embodiment, light emitters 4861 illuminate precursor sampling cell 4811 which contains precursor to be analyzed before being vaporized by a personal vaporizer as described herein. Light emitters 4861 also illuminate vapor sampling cell 4812 which contains vaporized precursor to be analyzed after being vaporized as described herein. The light from light emitters 4861 passes through the precursor being analyzed and, after various wavelengths are absorbed and/or amplified by the substance/liquid/precursor, is received by spectrum sensor 4862 (e.g., spectrometer, interferometer). The light from light emitters 4861 passes through the vaporized precursor being analyzed and, after various wavelengths are absorbed and/or amplified by the vaporized precursor, is received by spectrum sensor 4863 (e.g., spectrometer, interferometer). The output of spectrum sensor 4862 is provided to controller 4880 (e.g., controller 4280, controller 4380, etc.). The output of spectrum sensor 4863 is provided to controller 4880 (e.g., controller 4280, controller 4380, etc.).

In an embodiment used with cannabinoid-containing fluids, controller 4880 may biases thermal conditions to promote interconversion of certain constituents over time (e.g., converting a portion and/or all, and or substantially all of Δ9-THC toward CBN). Controller 4880 may implement time-varying target temperatures, dwell profiles, or post-puff soak periods to modulate interconversion. The dual-cell optical analysis arrangement of analysis system 4800 may be used to monitor conversion. For example, precursor sampling cell 4811 and precursor spectrum sensor 4862 may provide analysis data/information about the pre-heating precursor, whereas vapor sampling cell 4812 and vapor spectrum sensor 4863 may provide analysis data/information about the post-heating (i.e., at least partially vaporized) precursor. Differences in spectral features between the cells may indicate conversion extent, enabling closed-loop adjustment of heater commands and, optionally, airflow or liquid metering to achieve a target conversion rate.

In some embodiments, a device described herein may execute a diurnal schedule in which morning usage favors a first profile (e.g., lower conversion) and evening usage progressively increases conversion to shift perceived effects, with the schedule refined over time. To enable time-aware control (e.g., diurnal interconversion schedules) and to support analytics (e.g., correlation of activation cycles to time-of-day), a device described herein may include an RTC coupled to the controller. The RTC may be maintained by a dedicated backup power source (e.g., a button cell or supercapacitor) such that correct time persists across primary-battery depletion. A controller may timestamp sensed data (e.g., airflow signals, temperature, valve states) and store records in non-volatile memory for on-device learning or later diagnostics. A machine learning program may utilize the activation data metrics as they correlate to time of day usage and generate predictive activation cycles to optimize time of day activation device performance. Machine learning may be used to estimate and predict desired pharmacokinetic delivery of precursors based on usage and optimize activation cycles to achieve predicted pharmacokinetic targets for precursor mass transfer to an inhalation aerosol and/or vapor. Pharmacokinetic data of the precursor constituents and characteristic of conversion to an inhalation aerosol and/or vapor may be utilized for predictive activation, either passively (e.g. the device is in a ready state at a predicted time), or actively (e.g. notifying the user with via a notification to a device such as a cell phone, tablet or smart watch or other type of wearable, haptic feedback such a vibration of the device, visual indicator such as a LED light signal, and/or auditory cue from the device).

Multiple autonomous time-setting embodiments are contemplated to avoid reliance on external apps: (i) GNSS/GPS time acquisition; (ii) reception of terrestrial time signals (e.g., multi-frequency time beacons); (iii) passive timezone inference from sunrise/sunset periodicity using an on-board photodetector and a date-tracking RTC; and/or (iv) time-setting via an accessory such as a charger or a dedicated cartridge. Satellite-beacon or broadcast-time reception may provide coarse time without establishing a data connection. Photodetector-based inference may operate over several day-night cycles to estimate local offset and daylight-saving transitions. The controller may select among these methods based on availability, power budget, or user privacy settings. Machine learning may utilize time of day activation cycles and associated measurable metrics and data points to develop predictive time based activation cycles to optimize device activation and performance throughout the day, such that activation cycles are modulated and improved based on the individual's use of the device throughout the day, and/or on different days of the week, and/or aggregate usage data is analyzed and assimilated in order to optimize specific time of day, and/or time and day of week activation parameters.

As described for airflow sensing, a controller may generate an inhalation signature from transducer signals (e.g., temporal and spectral features). Power delivery can be enabled only when a similarity metric between a current inhalation signature and a stored authorized template meets a criterion. The controller may maintain multiple authorized templates (e.g., primary user and a secondary) and may employ thresholds, hysteresis, and liveness checks (e.g., consistency over a minimum duration) to reduce false activations. Enrollment may occur implicitly during initial usage or via a designated training routine. Users may develop a unique activation trigger based on flow sensing through the device to unlock or otherwise activate the device, such as, for example, three short puffs to turn the device on, and two short puffs to deactivate the device. These are just examples and many types of puff or inhalation based signals may be contemplated. The device may use a machine learning program to analyze and record the user's desired activation trigger, and may have the user repeat the activation trigger several times in order to learn the unique profile. Such unique activation triggers may be utilized to prevent unwanted or unauthorized use of the device by anyone other than the user, essentially functioning as a type of biometric security system for the device.

In some embodiments described herein, intake-air restriction and/or liquid feed to the aerosolization chamber are modulated by actuators under controller command. Examples include: (i) micro linear actuators translating shutters or slides; (ii) miniature servos driving valves; and (iii) electromagnetic actuators coupled with Hall-effect sensors for position feedback. As a passive alternative, a diaphragm-driven needle valve may use user-generated vacuum to displace a needle, thereby metering liquid flow without electrical drive. The device may employ one or more of these mechanisms, with actuator selection based on response time, power consumption, and manufacturability. Valve position may be scheduled in coordination with heater power and intake-air temperature to achieve consistent aerosol output across puff profiles.

In some embodiments, learning models may execute on the embedded controller to avoid external connectivity. Feature statistics, calibration tables, and schedules can be stored locally, with optional export via a service interface for diagnostics. In some embodiments, learning operates in a privacy-preserving mode in which only anonymized metrics (e.g., histogram bins or quantized templates) are retained.

It may be desirable in some embodiments to formulate a precursor liquid to be resistant to the formation of undesirable and/or unwanted thermal degradation byproducts when heated to form an aerosol and/or vapor. In some embodiments the precursor liquid is formulated such that the boiling point temperature of the precursor liquid formulation is lowered from the temperature in which thermal degradation of the components of the precursor may occur. Formulating the precursor with specific components to reduce the temperature in which the precursor liquid undergoes a phase change from a liquid to a vapor can be used as a method for the reduction of undesirable thermal degradation products that may occur from the heating of components in the precursor liquid formulation. In other words, for example, the greater the difference in the temperature required to phase change the precursor liquid to a vapor and the temperature(s) in which thermal degradation of the precursor liquid component occurs, the greater the reduction in the presence of thermal degradation byproducts present in the aerosol and/or vapor.

In some embodiments, vaporization devices such as those described herein utilize a vacuum pressure during activation to reduce the boiling point of the precursor by reducing the vapor pressure that the precursor liquid is subjected to when heated. This method may be combined, in some embodiments, with a precursor liquid or liquid formulated to have an intrinsically lower boiling point that when heated under reduced pressure result in a larger difference in the temperature at which a phase change from a liquid to a vapor and/or aerosol occurs and the temperature at which thermal degradation of the liquid and/or a component and/or components of the precursor liquid may undergo thermal degradation. In some embodiments, a precursor formulation specifically formulated to have a lower boiling point is used in a vaporization device (such as those described herein) in which a vacuum pressure is exerted on the precursor liquid during heating in order to reduce or ameliorate the formation of thermal degradation byproducts during activation of the vaporization device. In some embodiments, the precursor liquid formulation or precursor liquid formulations is a combination of volatile and non-volatile constituents where the ratio of the volatile and non-volatile constituents are mixed to effect a reduction in the boiling point of the precursor.

Precursor liquid(s) containing nicotine and/or nicotine salts as a component of the formulation are often composed primarily of non-volatile liquids such as propylene glycol (PG) and/or glycerol, a vegetable derived glycerol (VG), and/or a mixture of PG and VG and as has been described herein. Precursor liquid(s) that contain one or more cannabinoids as a component of the formulation may also contain PG, VG, and/or a mixture of PG and VG. Heating of PG and VG to temperatures near their standard atmospheric pressure boiling point can result in the formation of undesirable byproducts as a result of the thermal degradation of the precursor liquid. For example, PG begins to degrade into formaldehyde at temperatures as low as 133° C. (271° F.) in the presence of oxygen, with significant degradation occurring between 133° C. and 175° C. (271° F. to 347° F.). The boiling point of pure propylene glycol is approximately 187° C. to 188° C. (369° F. to 370° F.) at standard atmospheric pressure. The process of PG degradation to formaldehyde is significantly accelerated by higher temperatures and the presence of oxygen. This is a key factor in e-cigarette vapor degradation. The boiling point of VG is 290° C. (554° F.). VG begins to degrade into acrolein slightly below its boiling point (at around 280° C.). The reaction is slow without a catalyst and is more efficient at higher temperatures (often around 300-320° C.), especially in gas-phase reactions.

In precursor liquids that are composed entirely of and/or include cannabinoids as a constituent of the precursor liquid it is also desirable to reduce, and/or mitigate, and/or ameliorate the formation of thermal degradation byproducts. As cannabinoids have high boiling points and are typically considered non-volatile, it is possible to have the formation of undesirable thermal degradation byproducts when heating the cannabinoids to form a vapor and/or aerosol. Cannabinoids begin to degrade at temperatures above 110° F. (43° C.), but the process accelerates significantly above 320° F. (160° C.) and becomes very rapid above 392° F. (200° C.). The thermal degradation of cannabinoids produces various byproducts including isoprene, 2-methyl-2-butene, 3-methylcrotonaldehyde, and 3-methyl-1-butene from THC. Depending on the heating conditions, other compounds like psychoactive Δ8 and Δ9 THC isomers, cannabichromene (CBC), and hexahydropyran-4-yl 1-pentylcarboxylate (CBDQ) can also form.

The formation of thermal degradation byproducts from the precursor formulation can be reduced, and/or mitigated, and/or ameliorated by the reduction of the boiling point of the precursor liquid. As the boiling point is a physical property determined primarily by the strength of intermolecular forces such as London dispersion forces, dipole-dipole forces, hydrogen bonding, ion-dipole and ion-induced dipole forces. One method to reduce the boiling point is to lower the vapor pressure by the application of a vacuum (i.e., below atmospheric and or ambient) pressure to the precursor when heated, as is described herein. Another method that can be used in conjunction with an applied vacuum pressure, or in the absence of an applied vacuum pressure, is to add a volatile molecule, compound, and/or compounds to the precursor liquid formulation or precursor liquid formations. In some embodiments, the addition of a volatile molecule, compound, compounds, volatile component, and/or volatile components changes the overall vapor pressure of the precursor liquid mixture, altering the boiling point.

This method and process for the reduction, mitigation, and/or amelioration of the production of thermal degradation byproducts and/or decomposition of the precursor liquid is achieved by way of thermal degradation (or decomposition) being a chemical process involving the breaking of intramolecular bonds (forces within molecules). This breaking of intramolecular bonds requires a specific amount of energy to break those chemical bonds. This breaking generally occurs at a characteristic temperature range for a given substance regardless of the boiling point of the mixture it is in. Thus the boiling point of the precursor liquid may be reduced to lower temperatures that are not sufficient to generate the specific amount of energy required to break the intramolecular bonds of the precursor liquid, and is also therefore insufficient to cause the formation of thermal degradation byproducts and/or thermal decomposition byproducts.

In some embodiments, the vaporization device and/or vaporization devices (such as those described herein) are constructed and/or controlled to heat the precursor liquid and/or precursor liquids to a temperature sufficient to phase change and/or mobilize the precursor liquid from a liquid phase state into an aerosol and/or vapor phase. In order to facilitate the ideal and/or optimized heating of the precursor liquid and/or liquids the precursor liquid formulation and/or formulations can be empirically and/or theoretically analyzed to determine the specific boiling point of the precursor liquid formulation and/or formulations such that the construction and/or control of the vaporization devices heating cycle is designed to apply sufficient thermal energy to heat the precursor liquid and/or precursor liquids such that the generation of a vapor and/or aerosol occurs, but less energy than would be required to cause the thermal degradation and/or thermal decomposition of the precursor liquid. One method for the determination of the boiling point of the precursor liquid formulation and/or formulations is to experimentally determine the boiling point of the precursor liquids. This determination can be achieved, for example, by an experimental set-up using a simple boiling point apparatus like a Thiele tube. Another method is to calculate the theoretical boiling point elevation using the colligative property equation, which states that the change in boiling point (ΔT_{b}) is proportional to the molality (m) of the non-volatile solute (ΔT_{b}=K_{b}·m·i) where (i) is the van't Hoff factor and the solvent's ebullioscopic constant is (K_{b}).

In some embodiments, the precursor liquid is formed from non-volatile components such as PG, VG, or a mixture of PG and VG, and also comprises nicotine and/or a nicotine salt, water, an acid (such as citric acid—although other acids or mixtures of acids may be used including, but not limited to, lactic acid, benzoic acid, levulinic acid, salicylic acid, malic acid, and tartaric acid, and/or mixtures of such acids), and a volatile molecule, component, and/or components that are included to reduce the precursor liquid's boiling point. In some embodiments, the precursor liquid is formed from non-volatile components such as PG, VG, or a mixture of PG and VG, comprising nicotine, water, and a terpenoid and/or terpenoids (also called isoprenoids), where the terpenoid and/or terpenoids function to protonate the nicotine (thereby forming a nicotine salt), and also function as a volatile component and/or components that reduce the precursor liquid's boiling point.

In some embodiments, the precursor liquid is formed from non-volatile components such as PG, VG, or a mixture of PG and VG, a cannabinoid or cannabinoids, and a volatile component or components are included to reduce the precursor liquid's boiling point. In some embodiments, the precursor contains a cannabinoid or cannabinoids, and a volatile component or components that are naturally occurring and/or are included to reduce the precursor liquid's boiling point. In some embodiments, the precursor contains a cannabinoid or cannabinoids, and a volatile component or components that are bound to the cannabinoid forming cannabinoid acids (such as tetrahydrocannabinolic acid—THCA—and/or cannabidiolic acid—CBDA) These cannabinoid acids are formed by the joining of a phenol group on the cannabinoid with a volatile compound, such as, for example, a terpene precursor. In some embodiments, the precursor comprises a cannabinoid or cannabinoids, and a volatile component or components that are bound to the cannabinoid forming cannabinoid acids (such as THCA and/or CBDA), in order to render the precursor psychoactively inactive until undergoing decarboxylation of the cannabinoid acid during heating as part of the activation cycle of the vaporization device (such as those described herein) to form the aerosol and/or vapor. In some embodiments, the precursor liquid comprises a cannabinoid or cannabinoids and a volatile compound such as a terpene and/or terpenes that is included to impart an enhanced physiological effect in conjunction with the cannabinoid or cannabinoids (sometimes referred to as an “enterouge effect”) where the non-volatile and volatile compounds work together synergistically to enhance the overall effects and benefits of the individual components producing a physiological effect that is enhanced when compared to the physiological effects of the non-volatile and volatile compounds in isolation.

In some embodiments of the precursor liquid, a cannabinoid acid or cannabinoid acids are combined with nicotine to form a nicotine salt, where the cannabinoid acid donates a hydrogen ion (proton) to the nitrogen group on the freebase nicotine molecule thereby creating a positively charged nicotinium ion which then forms an ionic bond with the deprotonated cannabinoid acid molecule (e.g., a carboxylate ion). This results in a salt, such as nicotine cannabidiolate and/or similar compounds.

In some embodiments, the use of a volatile molecule, molecules, compound, and/or mixture of volatile compounds included in the precursor formulation may also function to convey organoleptic attributes (such as flavor or flavors) to the aerosol and/or vapor formed from the precursor. In some embodiments, the use of a volatile molecule, molecules, compound, and/or mixture of volatile compounds included in the precursor formulation may also function to convey sensory attributes such as tracheal stimulation (sometimes referred to as “throat hit”) upon inhalation of the formed aerosol and/or vapor formed from the precursor. In some embodiments, the use of volatile molecule, molecules, compound, and/or mixture of volatile compounds included in the precursor formulation may also function to convey other physiological responses and/or effects associated with the inhalation of the volatile molecule, molecules, compound, and/or mixture of volatile compounds, including but not limited to, stimulation, wakefulness, sensation of increased focus, reduction in perceived anxiety, increased or improved relaxation, anti-inflammatory effects, appetite stimulation, appetite suppression, analgesic effect (pain relief), sleep induction, improved sleep duration and/or improved sleep quality that may occur as a result of inhalation of the aerosol and/or vapor formed from the precursor including the volatile molecule, molecules, compound, and/or mixture of volatile compounds. Some volatile molecule, molecules, compound, and/or mixture of volatile compounds may convey additional physiological benefits including but not limited to anti-depressant effects, anti-oncogenic and/or anti-tumorogenic effects, bronchodilation, anti-mucogenic effects, neuroprotective effects, and muscle relaxation.

In the formulation of precursor liquids that contain nicotine, cannabinoids, or nicotine in combination with cannabinoids the volatile molecule, molecules, compound, and/or mixture of volatile compounds that may be utilized to reduce the boiling point of the precursor liquid include, but are not limited to, mono-terpenes such as α-Pinene (alpha-Pinene CAS 80-56-8), β-Pinene (beta-Pinene, CAS 127-91-3), Δ3-Carene (β-carene, Delta-3-Carene, CAS 13466-78-9), Δ2-Carene (Delta-2-Carene CAS, 5146-62-10, myrcene (β-Myrcene, CAS 123-35-3), limonene (d-limonene, CAS 5989-27-5), p-Cymene (para-Cymene, CAS 99-87-6), γ-Terpinene (gamma-Terpinene, CAS 99-85-4), α-Terpinene (alpha-Terpinene CAS 99-86-5), terpinolene (CAS 586-62-9), ocimene isomers, including but not limited to, α-Ocimene, β-Ocimene, and trans-β-Ocimene (CAS (α) 58542-37-1, (β) 13877-91-3), sabinene (CAS 3387-41-5), camphene (CAS 79-92-5), thujene isomers, including but not limited to, α-Thujene (CAS 28644-06-2), phellandrene isomers, including, but not limited to, α-Phellandrene, and β-Phellandrene (CAS (α) 4096-78-2, (β) 555-10-2), terpinene, including, but not limited to, various terpinene isomers (CAS varies) such as α-Terpinolene variants listed above (terpinolene), 1,8-Cineole (eucalyptol also called 1,8-Cineole, CAS 470-82-6), and p-Mentha-1(7),8-diene (also called p-menthadienes, CAS 18320-49-3). It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid and/or may also serve to function as an acid include, but are not limited to, terpenoids and/or monoterpenoids (oxygenated monoterpenes, with the general chemical formula of C₁₀H₁₆O) such as linalool and other isoprene derivatives (CAS 78-70-6), α-Terpineol (also called Alpha-Terpineol, CAS 98-55-5), terpinen-4-ol (4-Terpineol, CAS 562-74-3), borneol (including endo-/exo-variants), CAS 1817-75-2), isoborneol (CAS 125-12-2), bornyl acetate (CAS 124-47-0), linalyl acetate (CAS 115-95-7), 1,8-Cineole (listed previously but is a also a monoterpenoid/ether), endo-fenchol (also called fenchol, CAS 499-20-1), exo-fenchol (CAS varies), nerol (also called geraniol—a monoterpenoid alcohol, CAS 106-24-1), citronellol, (CAS 106-22-9), pinocarvone (including pinocarvone derivatives, CAS 1831-14-1), terpinen-4-ol and related oxides, including those listed above, p-Cymen-8-ol (also called p-Cymenol—CAS varies), α-Terpinene oxide, and other monoterpene oxides. It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid may also serve to function as an acid include, but are not limited to, sesquiterpenes with the general chemical formula of C₁₅H₂₄ or a simple derivative of such a compound, such as β-Caryophyllene (also called beta-Caryophyllene) and the isomer cis-β-Caryophyllene (CAS 87-44-5), α-Humulene (also called α-Caryophyllene and also called Alpha-Humulene—CAS 6753-98-6, β-Pinene (listed above as a monoterpene), α-Bulnesene (also called Alpha-Bulnesene), α-Bisabolene, β-Bisabolene, trans-α-Bisabolene, and bisabolene isomer mixtures, γ-Elemene (including β/γ elemene, CAS 68381-10-6), germacrene B (CAS 481-84-1), valencene (CAS 4630-07-3), α-Guaiene, β-Guaiene, Trans-β-guaiene and guaiene isomer mixtures, selinane isomers including selina-3,7(11)-diene, selina-4(15), 7(11)-diene, γ-selinene, α-selinene, β-selinene, δ-selinene) and selina-3,7(11)-diene, γ-Cadinene and α-Cadinene, germacrene D (CAS 25277-45-0), β-Elemene (also called Beta-Elemene, CAS 51452-72-3), β-Longipinene, β-Himachalene, muurolene isomers, and aromadendrene. It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid and/or may also serve to function as an acid include, but are not limited to, sesquiterpenoids (oxygenated sesquiterpenes with the general chemical formula of C₁₅H₂₄O) such as caryophyllene oxide (CAS 1139-30-6), guaiol (CAS 489-86-1), 10-epi-γ-Eudesmol (also called 10-epi-gamma-Eudesmol), γ-Eudesmol (also called gamma-Eudesmol), α-Eudesmol (also called alpha-Eudesmol), β-Eudesmol (also called beta-Eudesmol), bulnesol, α-Bisabolol (also called Alpha-Bisabolol, CAS 23089-26-1), Epi-α-bisabolol and other bisabolol isomers, humulene epoxide I & II, nerolidol including the isomers trans-nerolidol, and cis-nerolidol (CAS 7212-44-4), selinols and selina alcohols (e.g., selin-6-en-4α-ol), caryophylla-4(12), 8(13)-dien-5-β-ol and related oxygenates, and eudesmol and eudesmol isomers. It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid include, but are not limited to, diterpenes (a group of terpenes generally categorized as unsaturated molecules with the formula C₂₀H₃₂) such as phytol (also called a diterpenoid alcohol, CAS 150-86-7), m-Camphorene and p-Camphorene (also called diterpene hydrocarbons), and other diterpene-related cannabinoids derived biosynthetically from geranyl diphosphate and olivetolic acid. It should be understood that the aforementioned molecules and/or compounds may be used individually or in combination.

In the formulation of precursor liquids that contain nicotine, cannabinoids, or nicotine in combination with cannabinoids the volatile compounds that may be utilized to reduce the boiling point of the precursor liquid and/or function as an acid include, but are not limited to diterpenic acids, such as abietic acid, acanthoic acid, agathic acid, callitrisic acid, carnosic acid, cativic acid, cleroda-7,13E-dien-15-oic acid, communic acid (and cis-communic acid, myrceocommunic acid, etc.), copalic acid, dehydroabietic acid, dihydroagathic acid (also called pinifolic acid), ent-polialtic acid, eperuic acid, hardwickiic acid, imbricataloic acid, isopimaric acid, kaurenoic acid, kolavenic acid, lambertianic acid, levopimaric acid, neoabietic acid, palustric acid, pimaric acid, pisiferic acid, sandaracopimaric acid, and thunbergol (a macrocyclic diterpenoid, not technically an acid, included here as it is often classified as a diterpenoid). It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid and/or may also serve to function as an acid, include, but are not limited to, triterpenes (a group of terpenes generally categorized as unsaturated molecules with the formula C₃₀H₄₈) and triterpenoids such as squalene (CAS 111-02-4), friedelin (CAS 563-92-2), sitostanol and sitosterol derivatives (CAS 11066-25-2). It should be understood that the aforementioned molecules and/or compounds may be used individually or in combination.

In the formulation of precursor liquids that contain nicotine, cannabinoids, or nicotine in combination with cannabinoids, the volatile compounds that may be utilized to reduce the boiling point of the precursor liquid and/or may also serve to function as an acid include, but are not limited to minor volatiles such as aromatics, esters, alcohols, aldehydes and others compounds such as 1,3-Diethylbenzene (CAS 591-50-0), aromatic volatiles such as p-Xylene (CAS 106-42-3) and o-Xylene (CAS 95-47-6), aromatic volatiles such as ethylbenzene (CAS 100-41-4) and methyl anthranilate, aromatic compounds such as ethyl maltol and the maltol precursor, aldehydes such as heptanal and nonanal, and esters such as hexyl butyrate, hexyl butanoate, and hexyl hexanoate. Additionally terpene oxides and hydrated terpenes such as pinene hydrates, pinocarveol, and trans-pinocarveol. It should be understood that the aforementioned molecules and/or compounds may be used individually or in combination.

In some embodiments, the formulation of precursor liquids and/or precursor compounds that contain cannabinoids, the volatile molecule and/or molecules and/or compounds that may be utilized to reduce the boiling point of the precursor liquid and/or precursor compound that the volatile molecule, molecules, compound, and/or compounds may include terpenes, terpenoids, diterpenes, diterpenoids, polyterpenes, polyterpenoids, aromatics, esters, alcohols, aldehydes and other compounds described herein, or a mixture of these that are found naturally in cannabis and/or derived directly from cannabis. It should be understood that the aforementioned molecules and/or compounds may be used individually or in combination.

In some embodiments the formulation of precursor liquids and/or precursor compounds that contain cannabinoids, the volatile molecule, molecules, compound, and/or compounds that are utilized to reduce the boiling point of the precursor liquid, may include terpenes, terpenoids, diterpenes, diterpenoids, polyterpenes, polyterpenoids, aromatics, esters, alcohols, aldehydes and others, molecules and/or compounds or a mixture of these volatile molecules and/or compounds where the ratios of the molecules and/or compounds, identity of the molecules and/or compounds, is formulated to be substantially identical to the identity and ratios of the volatile molecules and/or compounds found and/or identified and/or analyzed directly in a cannabis cultivar. In an embodiment, the formulation may be formulated to be substantially identical to a specific cannabis cultivar in relation to the percentages and ratios of cannabinoids and volatile molecules and/or compounds such as those described herein. In an embodiment the formulation may be formulated to be substantially identical to a specific cannabis cultivar in relation to the percentages and ratios of cannabinoids and volatile molecules and/or compounds such as those described herein where the cannabis cultivar is analyzed analytically to quantitate the specific type and ratio of cannabinoids and the identities and ratios of volatile molecules and/or compounds such as those described herein, and the result of the analysis provide the identities and ratios of the cannabinoids and the volatile components, including flavonoids, that are used in the formulation of the precursor liquid and/or precursor compound such that the precursor liquid and/or precursor compound is substantially identical, in compound composition and ratios of molecules and/or compounds, to the cannabis cultivar that has been analyzed. In some embodiments, where the precursor formulation is based on the analysis of a specific cannabis cultivar, one or more cannabinoids and/or one or more volatile molecules and/or compounds may be omitted from the formulation.

In some embodiments, the precursor liquids that contain nicotine and the volatile components of the precursor liquid may be selected to replicate the aromatic and/or flavor attributes of tobacco and to formulate the precursor liquid with variety of terpenes that are naturally present in tobacco that contribute to the aroma and/or flavor profile of tobacco. These include but are not limited to, myrcene, limonene, linalool, pinene, caryophyllene, humulene, geraniol, eucalyptol, ocimene, borneol, terpinene, valencene, bisabolol, camphene, nerolidol, and terpineol.

In some embodiments, the precursor liquids that contain nicotine include non-volatile components of the precursor liquid that may be included to replicate the functional, and/or aromatic and/or flavor attributes of tobacco, and to formulate the precursor liquid with variety of flavonoids that are naturally present in tobacco that contribute to the aroma and/or flavor profile of tobacco. These include, but are not limited to, rutin, quercetin, and apigenin, kaempferol-3-rutinoside, scopolin, esculetin, nictoflorin, and various methyl and glycoside derivatives of flavones and flavonols. These molecules and/or compounds may be synthesized and/or extracted from parts of the tobacco plant, such as the leaves, stamens, corolla, and calyxes, and can be used in precursor liquid formulations to replicate the quality, aroma, and flavor of tobacco generally, or specifically to replicate the quality, aroma, and flavor of individual tobacco cultivars or blends of tobacco cultivars such as those used in common tobacco products such as cigarettes. In some embodiments of precursor formulations, the flavonoids may also be selected, and their ratio in the precursor formulation adjusted based on desirable physiological effects.

In some embodiments, the precursor liquids that contain nicotine and the volatile components of the precursor liquid may be selected to replicate the aromatic and/or flavor attributes of tobacco and the specific concentration of these compounds can be varied depending on the tobacco variety, aging process, and growing conditions that the precursor liquid is formulated to replicate. In some embodiments the precursor liquids that contain nicotine and the volatile components of the precursor liquid may be selected to replicate the aromatic and/or flavor attributes of tobacco and the direct analysis of a tobacco cultivar to determine the specific identity ratios of volatile aromatic compounds may be used to determine the ratio and identity of the of the volatile aromatic compounds in the precursor formulation. In an embodiment, the formulation may be formulated to be substantially identical to a specific tobacco cultivar in relation to the percentages and ratios of flavonoids and volatile compounds (such as those described herein) where the tobacco cultivar is analyzed analytically to quantitate the specific type and ratio of flavonoids and the identities and ratios of volatile compounds (such as those described herein) where the result of the analysis provides the identities and ratios of the flavonoids and the volatile components (including terpenes and/or terpenoids) that are used in the formulation of the precursor liquid and/or precursor compound such that the precursor liquid and/or precursor compound is substantially identical in compound composition and ratios of compounds to the tobacco cultivar that has been analyzed. In some embodiments, where the precursor formulation is based on the analysis of a specific tobacco cultivar, one or more flavonoids and/or one or more volatile compounds may be omitted from the formulation.

In some embodiments, the precursor liquids that contain nicotine, cannabinoids, or nicotine in combination with cannabinoids, the volatile molecule, molecules, compound, and/or compounds may be utilized to reduce the boiling point of the precursor liquid may also serve to function as an acid, serve to convey a flavor, and/or serve to convey an aromatic profile of the precursor liquid when converted to an aerosol and/or vapor. In some embodiments, the precursor liquids that contain nicotine, cannabinoids, or nicotine in combination with cannabinoids, the volatile molecule, molecules, compound, and/or compounds may be utilized to impart a physiological effect and/or perceived and/or measurable physiological benefit, and/or a perceived and/or measurable psychological effect and/or benefit resultant of the constituents of the precursor liquid when converted to an aerosol and/or vapor and inhaled. For example, some of the volatile molecules and/or compounds that may be used to impart a physiological and/or psychological effect include, but are not limited to: myrcene for its sedative and muscle-relaxant effects, and anti-inflammatory and pain-relieving (analgesic) properties; limonene for mood-enhancing and stress-relieving properties such as imparting psychologically uplifting effects that can also be described as anti-anxiety and anti-depressive, as well as anti-inflammatory and antioxidant effects; pinene (alpha and beta) for promotion of alertness and memory retention and also acts as a bronchodilator (opens airways) and has anti-inflammatory properties; linalool for its calming and anti-anxiety effects, making it a potential sleep aid, and also exhibits pain-relieving and anti-inflammatory properties; caryophyllene (beta-caryophyllene) for anti-inflammatory and pain-relieving effects; humulene for anti-inflammatory properties and can function as an appetite suppressant; terpinolene for uplifting and energizing effects at low concentrations to mildly sedative at higher concentrations, and antioxidant properties. It should be understood that the aforementioned molecules and/or compounds may be used individually or in combination.

In some embodiments, the precursor includes volatile compounds selected specifically to impart a targeted physiological effect, for example the inclusion into the precursor liquid of β-caryophyllene, myrcene, α-pinene (sometimes simply called pinene), limonin, humulene, linalool, bisabolol, eucalyptol, borneol, geraniol, and nerolidol in order to optimize the anti-inflammatory effects of the precursor liquid, where such a precursor liquid formulation may include a mixture all of the aforementioned volatile compounds or a mixture of some of the aforementioned volatile compounds. Embodiments of the precursor liquid include volatile compounds selected specifically to impart a targeted physiological effect, such as can be described as anti-anxiety and/or stress relieving, including targeted receptor binding and/or receptor interaction of one or more of the volatile compounds by inclusion into the precursor liquid formulation, including but not limited to, linalool which interacts with the brain's GABA receptors to promote relaxation and calm the nervous system, myrcene, β-caryophyllene which binds directly to CB2 receptors, limonene, and α-pinene. It should be understood that these examples are intended to illustrate only some of the possible formulations, and that other formulations can be composed based on the compounds and combination of compounds described herein.

In some embodiments, the precursor liquids that contain nicotine, cannabinoids, or nicotine in combination with cannabinoids, the volatile compound or compounds may be utilized to reduce the boiling point of the precursor liquid and/or may also serve to function to impart neuroprotective benefits, where these neuroprotective effects are achieved through various mechanisms, including fighting oxidative stress, reducing inflammation, and inhibiting the clumping of proteins associated with neurodegenerative diseases. Volatile compounds that may be used in such a formulation include, but are not limited to: α-Pinene and β-Pinene, which protects against neurotoxicity from amyloid-beta proteins by inhibiting their aggregation; β-Caryophyllene that affects neuroprotective activity by acting as an antioxidant and anti-inflammatory properties; α-Bisabolol which protects against amyloid-beta toxicity and oxidative stress; limonene which has antioxidant and anti-inflammatory effects; 1,8-Cineole which protects against oxidative stress-induced cell death by scavenging reactive oxygen species (ROS) and inducing antioxidant enzymes; terpineol that inhibits inflammation by reducing the production of inflammatory cytokines like TNFα and IL-6; eugenol which has antioxidant properties and inhibits enzymes related to cognitive decline; and carvacrol that has antioxidant activity and is neuroprotective due to its anti-inflammatory and antioxidant properties. It should be understood that these examples are intended to illustrate only some of the possible formulations, and that other formulations can be composed based on the compounds and combination of compounds described herein.

In some embodiments, the precursor liquids that contain cannabinoids include non-volatile components of the precursor liquid that may be selected to replicate the aromatic and/or flavor attributes of tobacco and to formulate the precursor liquid with variety of flavonoids that are naturally present in tobacco that contribute to the aroma and flavor profile of cannabis. These include but are not limited to, compounds called cannaflavins (A, B, and C), quercetin, kaempferol, apigenin, and luteolin. These molecules and/or compounds may be synthesized or extracted from parts of the cannabis plant, and can be used in precursor liquid formulations to replicate the quality, aroma, and flavor of cannabis generally, or specifically to replicate the quality, aroma, and flavor of individual cannabis cultivars or blends of cannabis cultivars. In some embodiments of precursor formulations the flavonoids may also be selected based on desirable physiological effects such as antioxidant, anti-inflammatory, and other potential therapeutic properties.

It should be understood that in the formulation of precursor liquids that contain nicotine, cannabinoids, or nicotine in combination with cannabinoids may be formulated with volatile and non-volatile compounds, where the volatile compounds may include but are not limited to: terpenes, terpenoids, volatile sulfur compounds (VSCs) and various non-terpenoid compounds that may include, but are not limited to: esters, aldehydes, ketones. The non-volatile compounds may include, but not limited to: flavonoids, acids such as cannabinoid acids such as THCA and CBDA, other acids such as benzoic acid, levulinic acid, citric acid, malic acid, and tartaric acid, propylene glycol, vegetable glycerol, and water described herein. It should be understood that these molecules and/or compounds may be formulated and/or combined in various ways in order to formulate a precursor liquid and or precursor compound with the desired physical properties and the desired organoleptic profile, and desired physiological and/or psychological effect.

It may be desirable to use volatile molecules and/or compounds such as those described herein to facilitate the ease and/or speed of the filling of cartridges and/or reservoirs (such as any of those described herein) in order to reduce the viscosity of a precursor liquid and/or precursor compound to increase the flowability of the precursor liquid and/or precursor compound. The use of a volatile molecule and/or volatile compound that is already present as part of the formulation may be added to the precursor liquid formulation in an amount in excess of the target amount present in the formulation in order to decrease the viscosity and increase the flowability of the precursor liquid and/or precursor compound to facilitate the filling of a reservoir or cartridge, where then the excess volatile molecule and/or compound, after the reservoir or cartridge has been filled, may be allowed to volatilize and/or off gas into the air until the desired concentration of the volatile molecule and/or compound is reached in the reservoir or cartridge. Such a method may use a closed environment for the filling process such that the volatile molecule and/or compound that has been volatilized and/or off gassed into the closed environment may be captured and reused in subsequent formulations. This method and process may increase the flowability of a precursor liquid and/or precursor compound without the need to add additional constituents to the precursor formulation that are not already present within the intended formulation. This method and process also helps to make the precursor liquid or precursor compound, which may be thermoviscous, flowable without the addition of heat, thereby facilitating the filling of reservoir or cartridges at ambient or sub-ambient temperatures which may serve to reduce potential thermal or oxidative degradation of the precursor liquid and/or precursor compound that may otherwise occur if the precursor liquid or precursor compound had to be heated directly or indirectly during the reservoir or cartridge filling process.

Where the vaporizing device, and/or vaporizer, and/or vaporizer assembly (such as vaporizing device 100, 200, 300, 400, 500, 600, 700, 800, 1100, 1600, 3300, 3400, 3500, 3600, 3900, 4000, 4200, 4300, 4700, 4800, and/or any other vaporizing device described herein), and/or vaporizer (such as vaporizer 902, 1000 and any other vaporizer described herein) or vaporizer assembly (such as vaporizer assembly 2400, 2500, 2600, 2700, 2800, 2900, 3000, 3100, 3200, 3310 and/or any other vaporizer assembly described herein) works in conjunction with the controller (such as controller 480, 580, 780, 880, 3480, 3580, 3680, 3980, 4080, 4280, 4380, 4780, 4880 and/or any other controller and/or control assembly and/or control system described herein) the controller may include a screen and/or digital display, or a plurality of screens and/or displays. The screen and/or display may be located on an area of the control such that the information displayed on the screen is viewable by the user. The screen and or display may be configured to be a touch-sensitive screen and/or display. Types of screen technology and/or screen types and/or digital display types may include but is not limited to; LCD (Liquid Crystal Display) which uses liquid crystals to block or pass light from a backlight (often LED). Types of LCD that may be used include Twisted Nematic (TN), In-Plane Switching (IPS), and/or Vertical Alignment (VA). LED (Light-Emitting Diode) screen or display, including OLED (Organic Light-Emitting Diode), QLED (Quantum Dot LED), MicroLED which is similar to OLED (self-emissive) but uses inorganic LEDs. Mini-LED which uses thousands of tiny LEDs for backlighting LCDs, creating better local dimming and contrast than standard LED-backlit LCDs. AMOLED/Super AMOLED which are advanced OLEDs with faster response times and better touch sensitivity. QD-OLED which combines Quantum Dot (QD) technology with OLED for superior color and brightness. Non LED technology such as E-Paper and/or E-Ink reflective displays that mimic ink on paper, and have extremely low power may also be used. And transparent digital display and/or screen technologies may also be utilized. Selection of the type of screen and/or display technology may dependent on the need for touch capability and/or touch sensitivity, power consumption, size of screen or display, number of screens and/or displays, requirements for screen and/or display performance in relation to color, brightness, contrast, power consumption, integration into the controller, and cost may be used to determine the type of screen and/or display. The screen and/or digital display may be used in conjunction with LEDs individually or in plurality for the purpose of communicating and/or indicating information to the user.

In some embodiments a single screen and/or digital display is located on the controller (such as controller 480, 580, 780, 880, 3480, 3580, 3680, 3980, 4080, 4280, 4380, 4780, 4880 and/or any other controller and/or control assembly and/or control system described herein) and is used to display information to the user, such information may include, but is not limited to: battery or batteries charge level, battery or batteries charge status, battery or batteries charging indicator, battery or batteries fully charged indicator, battery or batteries health status, vaporizing device (such as vaporizing device 100, 200, 300, 400, 500, 600, 700, 800, 1100, 1600, 3300, 3400, 3500, 3600, 3900, 4000, 4200, 4300, 4700, 4800, and/or any other vaporizing device described herein), and/or vaporizer (such as vaporizer 902, 1000 and any other vaporizer described herein) or vaporizer assembly (such as vaporizer assembly 2400, 2500, 2600, 2700, 2800, 2900, 3000, 3100, 3200, 3310 and any other vaporizer assembly described herein) mode and/or state (e.g., being in an “Off” mode, “On” mode, “Standby” mode, “Ready” state, “Not Ready” state) and/or other indications that may relate to the indication of the mode and/or state of the vaporizing device. Information may be displayed on the screen and/or digital display that includes information about the precursor liquid, precursor compound, and/or precursor cartridge. Information displayed and/or indicated may include, but is not limited to, for example: the type of precursor liquid and/or formulation; details regarding the precursor formulation and/or compound such as, for example, flavor, strength, brand, ingredients, expiration date; installation date (for example the insertion date and/or installation date of the cartridge into the vaporizing device), number of inhalations and/or activation cycles remaining; number of inhalations and/or activation cycles taken (for example number of inhalations taken of a specific cartridge and/or reservoir and/or number of total inhalations and/or activation cycles taken over the life of the vaporizer device); information about the consumption of the precursor liquid and/or precursor compound such as, for example, milliliters/volume of precursor liquid consumed, which may be displayed on a volume per inhalation basis, and/or a total volume basis; information on the amount of active component or components (e.g., nicotine, cannabinoid, cannabinoids, pharmaceutical agent, and/or drug) that has been consumed (e.g., displayed in milligrams) which may be displayed, for example, on a mass per inhalation basis, and/or a total mass basis. Displayed information may also include the volume and/or mass of a precursor liquid and/or precursor compound that remains in a reservoir or cartridge, and/or the mass and/or volume of precursor liquid and/or compound that remains in a reservoir or cartridge. Displayed information may also include information about the status of a reservoir or cartridge including, but not limited to: the need to replace a reservoir and or cartridge that has been consumed; is expired; is not genuine; has been tampered with; and/or is malfunctioning.

In some embodiments, the digital display and/or screen may display instructions for the use of the vaporizer device. This may include general operation, insertion and removal of a reservoir or cartridge, the filling of a reservoir or cartridge, the charging of the vaporizer device, the cleaning and/or maintenance of the device, the proper storage of the device, instructions on adjusting the settings of the device such as adjusting different operating modes, turning the device on or off, locking and unlocking the device (which may, for example, include the use of a PIN code), password, or biometric signature, setting the vaporizer device into a sleep or standby mode, setting the vaporizer device into a travel mode, setting the device into an “airplane” mode to disable bluetooth and/or wifi and/or RFID, and/or GPS functions.

In some embodiments, the digital display and/or screen may display software status including software updating, software update status, software version, error messages, instructions and/or steps and/or procedures to rectify error messages, error messages that may include an error code, notification and/or messages that may be internally generated from the vaporizer device or externally generated from a device, server, computer, software program that may be either originated from the vaporizer device manufacturer, third party, or the user including notifications and/or messages originating from a an external device, such as a smart phone, tablet computer, computer, and/or wearable digital device. The screen and/or digital display may include a camera or cameras as part of the construction or coupled to a separate camera or cameras by the controller for the purpose of visual identification methods such as facial recognition for example which may be used as a biometric signature for unlocking the device or otherwise activating the device. The camera or cameras may function as a sensor, or in conjunction with other sensors, including but not limited to visible light sensors, motion sensors, proximity sensors, thermal sensors, RADAR, LIDAR, or other sensor types.

In some embodiments, the digital display and/or screen may display information that is combined with other modalities, for example auditory signals and/or haptic feedback, that may be used individually or in combination with the display to alert the user of the delivery of a metered dose, or partial delivery of a metered dose (if, for example, the activation cycle was prematurely ended). Such visual and/or auditory and/or haptic feedback (whether direct or indirect) may include: notifications that serve as a reminder and/or notification that a scheduled dose should be taken; a reminder and/or notification that a scheduled dose was missed; a reminder and/or notification that an additional dose (which may be a partial dose) needs to be taken (e.g., when a previous activation cycle did not effectively deliver the intended dose—as may be the case if the previous activation cycle was ended prematurely). In such an embodiment, the vaporizer device may use visual signals, auditory signals, and/or haptic signals to provide instruction and feedback to instruct and/or guide and/or ensure that the intended activation cycle and inhalation cycle has been undertaken, and the intended metered dose has been delivered to the user. In some embodiments, the dose is not a metered dose and for example may be a desired dose selected or indicated by the user. Or the dose may be a dose that is determined to be desirable over a dosage range.

In some embodiments, the digital display and/or screen may display information that is combined with other modalities, for example LED indicators, and/or auditory signals, and/or haptic feedback, that may be used individually or in combination with the digital display and/or screen in combination with a machine learning model for purposes including, but not limited to: learning and/or mapping the user inhalation topography; measuring and quantitating the users unique inhalation topography; establishing and/or validating the user inhalation topography (which may function as a unique biometric signature). The vaporization device digital display and/or screen in combination with a machine learning model may be used for the measurement, display, recording and/or storage of qualitative and quantitative metrics as experienced by the user when operating the device. For example, the user may provide inputs automatically including but not limited to: inputs related to the activation of the vaporizing device such as activation cycle duration, activation cycle flow rate, activation cycle flow velocity, volume of precursor liquid and/or precursor compound consumed per cycle and/or in aggregate, volume of aerosol and/or vapor generated per cycle and/or in aggregate, frequency of activation cycles, time of day of activation cycle occurrence, vaporizer device settings used in an activation cycle, adjustments to setting or vaporizing device configuration including time data related to such adjustments. The user may also provide information and/or input data to the machine learning model that may not be generated automatically where the digital display and/or screen may be used with other methods such as LED indicators, auditory signals such as sounds or verbal messages, and/or haptic signals to gather data from the user. This data may include, but is not limited to: the users perceived satisfaction and/or experience when operating the device; the users experience, enjoyment and/or satisfaction with the settings of the vaporizing device; activation cycle performance; the users experience, enjoyment and/or satisfaction with organoleptic attributes of the inhaled aerosol and/or vapor; the users perceived efficacy of the inhaled aerosol and/or vapor; the users desired usage case such as desired outcomes from the use of the device (which may include, for example, the users feedback on the performance of the vaporizer device to meet the desired outcomes of the user). User inputs may be entered on the digital display and/or touch screen by utilizing touchscreen functions of the digital display and/or screen, and/or by using separate buttons and/or switches and/or dials where the input is displayed on the digital display or screen, and/or by verbally communication with the vaporizer device. The user's verbal communications may be captured by a microphone and/or an acoustic sensor and the digital display and/or screen may display and/or acknowledge the verbal communication. Such communication may result from a query and/or question that could be an auditory signal such as verbal communication originating from the vaporizing device and/or visually displayed on the digital display and/or screen. In some embodiments, the machine learning model works in conjunction with the screen and/or digital display to communicate with the user for the purpose of gathering user inputs and/or data for the purpose optimizing the device performance for the needs of an individual user.

In some embodiments the vaporizing device (such as vaporizing device 100, 200, 300, 400, 500, 600, 700, 800, 1100, 1600, 3300, 3400, 3500, 3600, 3900, 4000, 4200, 4300, 4700, 4800 and/or any other vaporizing device described herein), and/or vaporizer (such as vaporizer 902, 1000 and any other vaporizer described herein) or vaporizer assembly (such as vaporizer assembly 2400, 2500, 2600, 2700, 2800, 2900, 3000, 3100, 3200, 3310 and any other vaporizer assembly described herein) individually or in combination is configured to function as a metered dose inhaler. Where the vaporizing device, and/or vaporizer, and/or vaporizer assembly works in conjunction with the controller (such as controller 480, 580, 780, 880, 3480, 3580, 3680, 3980, 4080, 4280, 4380, 4780, 4880 and any other controller and/or control assembly and/or control system described herein) to be activated in such a way that an activation cycle functions to deliver a metered dose of the aerosol and/or vapor generated from the precursor to the user. In an embodiment, the flow sensing assembly, such as any of the flow sensing assemblies and/or flow detection assemblies or flow detection systems and/or flow measuring assemblies or systems described herein detects the flow rate of the airflow through the system which corresponds to the flow rate of a formed aerosol and/or vapor out of the system and to the user. The detected and/or sensed and/or measured and/or calculated flow rate is communicated to the controller and/or control system, such as any of the controllers and/or control systems described herein, and the flow rate is used in conjunction with the activation cycle power delivery to meter and/or otherwise control the amount of aerosol and/or vapor that is generated over an activation cycle by modulating the power output to the heater and/or emitter and/or the time duration of the activation.

The measurement of the flow rate combined with the modulated power output to the heater and/or emitter and/or the control of the time duration of the activation cycle is used to deliver a metered dose of formed aerosol and/or vapor to the user. Such a metered dose can thus be effectively delivered even when the flow rate through the system is variable, as the power delivery to the heater and/or emitter and the time duration of activation can be variably adjusted based on the real-time flow rate to insure the desired and/or intended dosage of formed aerosol and/or vapor has been generated during the activation cycle. In such an embodiment, the device may provide direct feedback to the user such as a sound and/or noise (e.g., a beep or tone), a visual indicator (e.g., a light, and/or indication on a screen display), and/or a haptic signal. Such indicators may be used individually or in a combination of indicators to alert the user of the delivery of a metered dose or partial delivery of a metered dose (for example, if the activation cycle was prematurely ended). In such an embodiment, the device may provide indirect (e.g. to a device other than the vaporizer device) feedback to the user such as a sound that may include an audible message and/or noise (e.g., beep or tone), a visual indicator (e.g., a light, and/or indication that may include a written and or audible message on a screen display), and/or a haptic signal, to a smart device (e.g., a cellular phone, tablet computer, computer, or wearable digital device such as a smart watch or smart glasses). Feedback modalities may be used individually or in combination to alert the user of the delivery of a metered dose, or partial delivery of a metered dose (if, for example, the activation cycle was prematurely ended). Such feedback, whether direct or indirect, may include notifications that serve as a reminder and/or notification that a scheduled dose should be taken, a reminder and/or notification that a scheduled dose was missed, and/or a reminder and/or notification that an additional dose (which may be a partial dose), needs to be taken. If the previous activation cycle did not effectively deliver the intended dose (as may be the case if the previous activation cycle was ended prematurely), a reminder and/or notification that an additional dose (which also may be a partial dose), needs to be taken may be communicated.

In some embodiments, the device may provide notifications that originate from an external device, such as a smart phone, tablet computer, computer, and/or wearable digital device. Such reminders may be preset reminders based on a desired dosing schedule and/or reminders based on physiological parameters that may be measured by a digital device (e.g., a wearable digital device) that measures and/or monitors and/or records physiological metrics including, but not limited to: heart rate, breathing rate, oxygen saturation, sleep status, sleep duration, and/or sleep quality. Indication signals may be used to signal to the user that an inhalation cycle should begin. Another indication signal may indicate when the inhalation cycle should end. In some embodiments, the device may internally end the activation cycle (e.g., end generation of the vapor and/or aerosol) prior to the notification to the user that the user's inhalation should end. This may be in order to ensure that the metered dose of aerosol and/or vapor is fully inhaled before the user is signaled or otherwise notified to cease inhaling. It should be understood that the methods described, including the methods for communicating information to the user are intended to serve as examples and other methods and means of communication may be used and may be used in combination or sequence with the methods and/or processes described herein.

In some embodiments, the vaporizing device (e.g., any of the vaporization devices, vaporizers, and/or vaporizer assemblies described herein) having a controller, control assembly and/or control system described herein is calibrated such that the flow rate through the system correlates to an amount of generated aerosol and/vapor generated. Calibration methods that may be used include but are not limited to: total particulate matter testing, impaction testing, laser diffraction testing, pharmacokinetic testing, various types of “puff” testing used for quantifying e-cigarettes, and other testing methods. This testing may include, for example, testing methods that activate the vaporization device to form an aerosol and/or vapor using a pump and/or other method of generating a flow through the vaporization device and capturing the aerosol and/or vapor in a matrix, such as a cambridge pad, for further analysis. This testing may also include, for example, inhalation and/or “puff” topography analysis of how a person or persons uses the device (e.g., inhalation/puff duration, inhalation/puff volume, flow rate, and number of inhalations/puffs).

Several methods may be used for inhalation and/or “puff” topography analysis including, but not limited to, specialized electronic devices that can be attached to the vaporizing device (or vaporizers, and/or vaporizer assemblies) to measure and record inhalation/puffing behavior. Video analysis can be utilized to analyze video recordings of users inhaling from vaporizing devices (or vaporizers, and/or vaporizer assemblies) to measure inhalations/puff durations and other characteristics. Another method is particle size distribution analysis to determine the range and concentration of particles in the aerosol using methods and/or techniques such as optical transmission and laser scattering which can be used to analyze the size of aerosol particles. Mobility analysis may include electrical mobility and scanning mobility analyzers to measure particle size in real-time. It should be understood that the methods described herein for the calibration of the vaporizing devices (or vaporizers, and/or vaporizer assemblies) and/or analysis of the aerosol are intended to serve as examples of methods, processes, and/or techniques that may be used and that these methods, processes, and/or techniques may be used in combination, including in sequence, and that other methods and processes may be utilized.

Methods and processes for generating quantitative data for the purpose of calibrating and/or optimizing the vaporizer device (or vaporizers, and/or vaporizer assemblies) include but are not limited to using cascade impactors to collect and size particles based on their aerodynamic properties. Methods for the evaluation of the chemical composition of the aerosol and/or vapor including the types and amounts of chemicals present in the vapor (e.g., nicotine and other constituents) may include aerosol collection systems that are used to collect and condense the aerosol and/or vapor and then creating a liquid sample for chemical analysis, where the collected samples are then analyzed using various techniques (such as the techniques described herein) to determine their chemical makeup. In vivo measurements may also be used where biomarkers (e.g., plasma nicotine and/or plasma cotinine concentrations) can be measured in users over time.

Vaporizing devices (or vaporizers, and/or vaporizer assemblies) usage frequency can also be measured by evaluating how often and how much the vaporizing devices (or vaporizers, and/or vaporizer assemblies) is used and may be measured using methods including, but not limited to: embedded inhalation/puff counters where the vaporizing devices (or vaporizers, and/or vaporizer assemblies) has a built-in counter that automatically record the number of inhalations/puffs taken as well as additional data (e.g., inhalations/puff duration, inhalations/puff frequency, duration of time between inhalations/puffs, and/or other related metrics). Self-reporting may be utilized where users can be asked to log their usage in a diary and/or answer questions about how many times they use the device per day. Cartridge/precursor liquid consumption can be analyzed where an amount of precursor liquid and/or precursor compound used per day (e.g., number of cartridges, milliliters/volume of precursor liquid and/or precursor compound) can also be used as a measure. It should be understood that the methods described herein for the analysis of the aerosol and/or vapor and calibration of the vaporizing devices (or vaporizers, and/or vaporizer assemblies) are intended to serve as examples of methods, processes, and/or techniques that may be used and that these methods, processes, and/or techniques may be used in combination including in sequence and that other methods and processes may be utilized.

The various sensors on the vaporizer device (or vaporizers, and/or vaporizer assemblies) and/or controller (such as any of the controllers, control systems, control assemblies, and/or control systems described herein) that have been described herein may be utilized to gather and measure data such as environmental data, flow rate data, flow volume data, user inhalation/puff topography data, time of activation that may include day of week, month of year, geographical data, number of inhalations/puffs taken, inhalations/puff duration, inhalations/puff frequency, duration of time between inhalations/puffs, and data related to the formulation of the precursor being used. The vaporizing devices (or vaporizers, and/or vaporizer assemblies) may also be configured to accept, assimilate, and aggregate user input data directly to the device or indirectly through an external device, such as a smart phone, tablet computer, computer, and/or wearable digital device. It should be understood that the methods described herein for the analysis of the aerosol and/or vapor and calibration of the vaporizing devices (or vaporizers, and/or vaporizer assemblies) are intended to serve as examples of methods, processes, and/or techniques that may be used and that these methods, processes, and/or techniques may be used in combination, including in sequence, and that other methods and processes may be utilized.

Calibration methods may also include analytical testing and/or analysis including but not limited to: measuring of the mass of the aerosol and/or vapor; analysis of the components of the aerosol/and or vapor using various techniques, such as chromatography methods like gas chromatography (GC) and liquid chromatography (LC) coupled with detectors such as mass spectrometry (MS). Other methods include, but are not limited to: high-resolution, accurate-mass MS, spectroscopic techniques like NMR, and elemental analysis methods like ICP-MS for analyzing metals. Specific methods like thermal desorption (TD) can be paired with GC-MS for analyzing volatile and semi-volatile compounds. GC-FID uses a Flame Ionization Detector (FID) for analyzing major components like propylene glycol and glycerol. LC-MS/MS may be used for detecting and quantifying specific compounds (for example nitrosamines). High-performance liquid chromatography (HPLC) may be used in combination and/or sequentially with various detectors like diode-array detection (DAD) or mass spectrometry. Nuclear Magnetic Resonance (NMR) spectroscopy may be used to identify and quantify a range of constituents, including nicotine and flavor compounds. Inductively Coupled Plasma Mass Spectrometry (ICP-MS) may be specifically used to analyze the presence and concentration of heavy metals in the vapor. Thermal Desorption (TD) may be coupled with GC-MS and used to analyze volatile and semi-volatile organic compounds (VOCs and SVOCs) by first trapping them, and then desorbing them for analysis. It should be understood that the methods described herein for the analysis of the aerosol and/or vapor and calibration of the vaporizing devices (or vaporizers, and/or vaporizer assemblies) are intended to serve as examples of methods, processes, and/or techniques that may be used and that these methods, processes, and/or techniques may be used in combination, including in sequence, and that other methods and processes may be utilized.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose when the flow rate through the device is unique to the inhalation and/or puff topography of a specific user. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose when the flow rate through the device is unique to the inhalation and/or puff topography of a specific user and where the activation cycle is terminated when the metered dose is reached. In an embodiment the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose, where one or more activation cycles may deliver the intended dosage (e.g., a single inhalation may deliver a metered dose during a single activation cycle, and/or more than one activation cycles and associated inhalations and/or puffs may be required to deliver the metered dose). It should be understood that the description of embodiments delivering a metered dose of aerosol and/or vapor are examples and may be combined with other examples and/or embodiments described herein. It should be understood that the metered dose of an aerosol and or/vapor may be determined by the dose of active molecules and/or compounds present in the metered dose of aerosol and/or vapor, where the active molecules and/or compounds present in the aerosol and/or vapor may be for example nicotine and/or a nicotine salt, and/or a cannabinoid or cannabinoids, and/or terpenes and/or terpene derivatives.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose and the device is in a ready state and may be activated when a metered dose is due to be administered to the user. Conversely the device may be rendered inactive during periods of time when no metered dose should be administered. For example, when a metered dose may be indicated to be administered twice a day, in the morning and in the evening, the device may be in a ready state in the morning and once the dose is delivered the device is rendered inactive until the evening. In the evening, the device may be once again placed in a ready state and be ready to be activated to administer the evening dose. Once the evening dose is administered, the device is again placed in an inactive state and cannot be activated until the next dose is due for administration (in this example, the following morning). It should be understood that in such an embodiment there may be an indicated dosage schedule ranging from one per day to a plurality of times per day. It should also be understood that the description of embodiments delivering a metered dose of aerosol and/or vapor are examples and may be combined with other examples and/or embodiments described herein. It should be understood that the metered dose of an aerosol and or/vapor may be determined by the dose of active molecules and/or compounds present in the metered dose of aerosol and/or vapor, where the active molecules and/or compounds present in the aerosol and/or vapor may be for example nicotine and/or a nicotine salt, and/or a cannabinoid or cannabinoids, and/or terpenes and/or terpene derivatives.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose when the flow rate through the device reaches a predetermined flow rate. For example, the aerosol and/or vapor generation may not be initiated until a predetermined flow rate is reached and remains active and generating aerosol and/or vapor until the metered dose is reached as long as a sufficient flow rate through the device is being detected. If sufficient flow is not detected, then the activation cycle is ceased, and the activation cycle will only resume under the conditions of sufficient flow. In such an embodiment, the flow rate through the device may be determined to be sufficient for activation of the cycle to generate an aerosol and/or vapor if the flow rate is sufficient to deliver the aerosol and/or vapor to the deep lung. In another embodiment, the flow rate may be determined to be sufficient to initiate the activation cycle for the purpose of generating the metered dose of an aerosol and/or vapor if the flow rate is sufficient to deliver the aerosol and/or vapor to the upper airway (e.g., the oral cavity, oropharyngeal cavity, trachea, bronchus etc.). It should be understood that the description of embodiments delivering a metered dose of aerosol and/or vapor are examples and may be combined with other examples and/or embodiments described herein.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose when the flow rate through the device is used in combination with the correlated calibrated activation cycle and/or cycles. It should be understood that the description of embodiments delivering a metered dose of aerosol and/or vapor are examples and may be combined with other examples and/or embodiments described herein. It should be understood that the metered dose of an aerosol and or/vapor may be determined by the dose of active molecules and/or compounds present in the metered dose of aerosol and/or vapor, where the active molecules and/or compounds present in the aerosol and/or vapor may be for example nicotine and/or a nicotine salt, and/or a cannabinoid or cannabinoids, and/or terpenes and/or terpene derivatives.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose when the flow rate through the device is constant or variable (i.e., regardless of whether the flow rate is constant or variable) and the calibrated controller can determine the amount of the dose delivered in real time. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated at a frequency of several hundred times per second from the flow rate and the activation of the heater and/or emitter to determine the amount of aerosol and/or vapor being generated and delivered to the user. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated at a frequency of several thousand times per second from the flow rate and the activation of the heater and/or emitter to determine the amount of aerosol and/or vapor being generated and delivered to the user. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated at a frequency of equal to or greater than ten thousand times per second from the flow rate and the activation of the heater and/or emitter to determine the amount of aerosol and/or vapor being generated and delivered to the user. It should be understood that the description of embodiments delivering a metered dose of aerosol and/or vapor are examples and may be combined with other examples and/or embodiments described herein. It should be understood that the metered dose of an aerosol and or/vapor may be determined by the dose of active molecules and/or compounds present in the metered dose of aerosol and/or vapor, where the active molecules and/or compounds present in the aerosol and/or vapor may be for example nicotine and/or a nicotine salt, and/or a cannabinoid or cannabinoids, and/or terpenes and/or terpene derivatives.

In some embodiments, data relating to and generated from an activation cycle, including but not limited to high frequency sampling of flow data, environmental data, duration of activation data, power delivery data, time of day, day of week, number of activation cycles, inter-activation cycle duration, formulation data, user specific inhalation topography data, aggregate inhalation topography data, biometric data, and external data such as inputs from a user may be utilized by a machine learning model in combination with a controller (such as any of the controllers, control systems, control assemblies, and/or control systems described herein) to optimize the activation cycle on a real time or ongoing basis. Machine learning model based optimization for the activation of the vaporizer device (such as any of the vaporizer devices, vaporizers, or vaporizers assemblies described herein) may be used to increase quantitative metrics including, but not limited to, the accuracy of the metered dose, the effectiveness of the metered dose reaching the intended target tissue (such as the deep lung), predictive activation power delivery configuration based on inhalation topography for improved activation cycle efficiency, and qualitative metrics such as ease of use of the vaporizer device, and perceived efficacy of the inhalation by the user. It should be understood that the description is intended as an example and additional types and sources of data, and additional methods and processes such as those described herein may be utilized.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated from the flow rate and the activation of the heater and/or emitter to determine the amount of aerosol and/or vapor being generated and delivered to the user at a frequency determined to be sufficient to achieve a sufficient metered dose to the user, where the metered dose may be determined to be sufficient over a range of acceptable values. For example, the metered dose may be 200 mg and be determined to be sufficient if the dose delivered is within a range of 180-220 mg (e.g. +/1 10% of the intended dosage). It should be understood that the description of embodiments delivering a metered dose of aerosol and/or vapor are examples and may be combined with other examples and/or embodiments described herein. It should be understood that the metered dose of an aerosol and or/vapor may be determined by the dose of active molecules and/or compounds present in the metered dose of aerosol and/or vapor, where the active molecules and/or compounds present in the aerosol and/or vapor may be a prescription or over the count drug and/or pharmaceutical agent and/or compound.

In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated from the flow rate and the activation of the heater and/or emitter to determine the amount of aerosol and/or vapor being generated and delivered to the user where the metered dose has been prescribed by a healthcare provider and the active component in the aerosol and/or vapor is a pharmaceutical compound and/or drug having a target tissue for delivery of the active component in the human airway. In an embodiment, the vaporizer device (such as any of the vaporizer devices, vaporizers, or vaporizers assemblies described herein) and/or the controller (such as any of the controllers, control systems, control assemblies, and/or control systems described herein) may be calibrated using methods described herein such that the formed aerosol and/or vapor generated under an activation cycle can be delivered to the user in a metered dose using the data generated from the flow rate and the activation of the heater and/or emitter to determine the amount of aerosol and/or vapor being generated and delivered to the user where the metered dose has be prescribed by a healthcare provider and the active component in the aerosol and/or vapor is a pharmaceutical compound and/or drug having a target tissue for delivery of the active component or components in the human airway (e.g., inhaled prescription drugs that are primarily used to treat respiratory conditions including but not limited to asthma and Chronic Obstructive Pulmonary Disease (COPD)), where the inhaled prescription drugs work by delivering medication directly to the lungs (thereby, for example, reducing systemic side effects and improving symptom control).

The inhaled prescription drugs that may be delivered by the vaporizer device (such as any of the vaporizer devices, vaporizers, or vaporizers assemblies described herein) may fall into several main categories, including, but not limited to, for example bronchodilators, which are drugs that function to relax the muscles around the airways in order to open (also called bronchodilation) the bronchial tubes and make breathing easier. Example bronchodilating drugs include, but are not limited to: short-acting beta2-agonists (SABAs) which have a rapid onset of action and are often used to provide acute relief from sudden onset symptoms; albuterol (e.g., brand names include Ventolin, ProAir, etc.) which are long-acting beta2-agonists (LABAs) and used to provide long-lasting airway relaxation; salmeterol (one of the active components of the brand name prescription drug Advair); formoterol; and arformoterol. Another category of inhaled prescription drugs are, for example, anticholinergics (muscarinic antagonists) which also function primarily as bronchodilators. Examples of anticholinergics include, but are not limited to: ipratropium bromide (example brand name Atrovent), tiotropium bromide (example brand name Spiriva), aclidinium, and umeclidinium bromide. Another example category of inhaled prescription drugs are corticosteroids, which function to reduce inflammation in the inner lining of the airway (for example, to help to prevent asthma attacks and improve lung function). They are typically for maintenance treatment and include, but are not limited to: budesonide (example brand names include Pulmicort Respules, and Pulmicort Flexhaler), fluticasone (example brand names include Flovent, and Arnuity Ellipta), beclomethasone (example brand name Qvar RediHaler), mometasone (example brand names include Asmanex Twisthaler, and Asmanex HFA), and ciclesonide (example brand name Alvesco).

Inhaled prescription drugs may also be utilized in combination and multiple inhaled formulations that combine a corticosteroid and a bronchodilator. Examples of such combined formulations include, but are not limited to: fluticasone/salmeterol (example brand name Advair), budesonide/formoterol (example brand name Symbicort), and fluticasone furoate/vilanterol (example brand name Breo Ellipta). Other inhaled drugs and/or pharmaceutical agents include, but are not limited to: antibiotics inhaled for specific lung infections and/or chronic diseases and/or conditions (e.g., cystic fibrosis) such as inhaled solutions of tobramycin, aztreonam, and colistin. Some inhaled agents may not be classified directly as a pharmaceutical but may be inhaled for therapeutic benefit. These include, but are not limited to hypertonic saline which is inhaled to help break up mucus. There are also pharmaceutical agents and/or drugs that may be inhaled for analgesia and the purpose of treating acute or chronic pain. Examples include, but are not limited to: fentanyl which is a strong opioid used for pain management, methoxyflurane (Penthrox) which is a prescription volatile anesthetic used for acute trauma pain (for example bone fractures), morphine which can be inhaled to treat dyspnea (shortness of breath—which often accompanies pain in chronic lung diseases), and indomethacin which is an inhaled non-steroidal anti-inflammatory drug (NSAID) used for reducing sputum and potentially easing breathlessness in chronic lung conditions like COPD (not always directly used specifically for pain relief). It should be understood that the description of inhaled pharmaceutical agents are intended to be examples and other pharmaceutical agents and combinations of agents including combinations of pharmaceutical agents and non-pharmaceutical agents may be used in inhalation formulations.

In addition to prescription drugs described herein there are also therapeutic agents and specific biologics that can also be administered via inhalation such as protein-based biologics that are available as inhaled treatments. There are biological agents currently available for inhalation and ongoing research is actively being conducted on new inhaled biologic therapies. Examples of currently available inhaled biologic/protein agents include, but are not limited to: non-monoclonal antibody biologics or related protein-based drugs that are administered by inhalation such as dornase alfa (example brand name Pulmozyme®) which is a recombinant human DNase enzyme approved for managing cystic fibrosis (CF); insulin (example brand name Afrezza®) which is an inhaled form of insulin used for managing blood sugar levels in adults with diabetes; mannitol (example brand name Bronchitol®) which is a formulation used in the treatment of CF to improve lung function and reduce exacerbations; zanamivir (example brand name Relenza®) which is an antiviral agent (a neuraminidase inhibitor protein) delivered via inhalation to treat influenza infections. There are also a number of biologics in clinical development for inhalation including, but not limited to: inhaled formulations of monoclonal antibodies (mAbs) such as ecleralimab (formerly CSJ117) which is an inhaled anti-TSLP (thymic stromal lymphopoietin) antibody fragment currently in clinical trials for asthma; ALX-0171 which is a nanobody targeting the RSV (respiratory syncytial virus) fusion protein, studied as an inhaled treatment in clinical trials. Itepekimab and tozorakimab which are anti-IL-33 antibodies are currently being investigated, with potential for future inhaled applications in asthma and COPD. It should be understood that the description of inhaled pharmaceutical and/or biological agents are intended to be examples and other biological and/or protein based agents and combinations of biological and/or protein agents including combinations of biological and/or protein based agents in combination with pharmaceutical agents and/or non-pharmaceutical agents may be used in inhalation formulations.

In an embodiment, the sensed air flow is correlated to a flow volume and/or flow rate through the vaporizer device (such as any of the vaporizer devices, vaporizers, or vaporizers assemblies described herein) by the controller (such as any of the controllers, control systems, control assemblies, and/or control systems described herein) and flow volume and/or flow rate may be used to deliver a metered dose of an aerosol and/or vapor containing at least one active agent and/or molecule and/or compound such that the controller (such as any of the controllers, control systems, control assemblies, and/or control systems described herein) may prevent the activation of the device once the intended metered dose has been delivered and/or administered and such that the device is configured to only deliver the intended dose and cannot be activated to deliver more than the intended dose. Such an embodiment may be used to prevent the over dosing of certain active agents and/or molecules and/or compounds.

In an embodiment the sensed air flow is correlated to a flow volume and/or flow rate through the vaporizer device (such as any of the vaporizer devices, vaporizers, or vaporizers assemblies described herein) by the controller (such as any of the controllers, control systems, control assemblies, and/or control systems described herein) and flow volume and/or flow rate may be used to deliver a metered dose of an aerosol and/or vapor containing at least one active agent and/or molecule and/or compound the vaporizer device integrates environmental data for the purpose of optimizing the metered dose inhalation cycle including, but not limited to, for example: ambient temperature, ambient pressure, ambient humidity, and temperature of intake airflow, temporal data such time of day, and day of week. Such data may be used in conjunction with user specific data such as inhalation topography profiles including, but not limited to, factoring in user inhalation topography under specific use case, such as the use case relates to environmental conditions such as those described herein and/or temporal factors such as time of day or day of week. The vaporizer device may optimize the activation cycle based on such data from the individual or from aggregate user data, or both individual and aggregate user data. Such data may be used with a machine learning model to predictively optimize the activation cycle. For example, used to select an activation cycle with parameters optimized for a specific user's inhalation topography at a specific time of day and day of week and under specific environmental conditions in order to effect an optimal activation cycle for the metered dose delivery of an aerosol and/or vapor. The optimized activation cycle may be further refined using data relevant to the specific active compound or compounds, active agent or agents, and/or active molecule or molecules and specific formulation of precursor liquid being used. Such data may be general data such as quantitative data or specific data such as user specific behavior including but not limited to the users inhalation topography of a specific formulation. It should be understood that the description of the embodiment provided herein should serve as an example and additional data as well as additional methods and processes for the control and activation of the vaporizing device may be utilized, such as the data, methods, process described herein.

In an embodiment, the precursor liquid formulation comprises free base nicotine at 1-5% weight-to-weight (w/w) or volume-to-volume (v/v) and a terpenoid or terpenoid mixture is present at 1-7% w/w or v/v, and a volatile molecule or mix of molecules is present at 5-30% w/w or v/v, non-volatile flavonoids are present at 1-30% w/w or v/v, water is present at 0-3% w/w or v/v, and PG or VG or a mixture of PG and VG is used for the remainder of the formulation.

In an embodiment, the precursor liquid formulation comprises free base nicotine at 1-5% weight-to-weight (w/w) or volume-to-volume (v/v) and a terpenoid or terpenoid mixture is present at 1-7% w/w or v/v, and a volatile molecule or mix of molecules is present at 5-30% w/w or v/v, non-volatile flavonoids are present at 1-30% w/w or v/v, water is present at 3-30% w/w or v/v, and PG or VG or a mixture of PG and VG is used for the remainder of the formulation.

In an embodiment, the precursor liquid formulation comprises free base nicotine at 1-5% weight-to-weight (w/w) or volume-to-volume (v/v) and a terpenoid or terpenoid mixture is present at 10-30% w/w or v/v, and a volatile molecule or mix of molecules is present at 5-30% w/w or v/v, non-volatile flavonoids are present at 1-30% w/w or v/v, water is present at 3-30% w/w or v/v, and PG or VG or a mixture of PG and VG is used for the remainder of the formulation.

In an embodiment, the precursor liquid formulation comprises a cannabinoid acid or cannabinoid acids at 50-95%, free base nicotine at 1-5% weight-to-weight (w/w) or volume-to-volume (v/v) and a terpenoid or terpenoid mixture is present at 1-7% w/w or v/v, and a volatile molecule or mix of molecules is present at 5-30% w/w or v/v, and non-volatile flavonoids are present at 1-30% w/w or v/v.

In an embodiment, the precursor liquid formulation comprises a THCA at 50-95%, free base nicotine at 1-5% weight-to-weight (w/w) or volume-to-volume (v/v) and a terpenoid or terpenoid mixture is present at 1-7% w/w or v/v, and a volatile molecule or mix of molecules is present at 5-30% w/w or v/v, and non-volatile flavonoids are present at 1-30% w/w or v/v.

In an embodiment, the precursor liquid formulation comprises a CBDA at 50-95%, free base nicotine at 1-5% weight-to-weight (w/w) or volume-to-volume (v/v) and a terpenoid or terpenoid mixture is present at 1-7% w/w or v/v, and a volatile molecule or mix of molecules is present at 5-30% w/w or v/v, and non-volatile flavonoids are present at 1-30% w/w or v/v.

Volatile molecules and/or compounds that may be used in a precursor liquid formulation may also include molecules and/or compounds that can be described as monoterpene alcohols. These include, but are not limited to, for example: linalool, geraniol, borneol, citronellol, α-terpineol, and terpinen-4-ol. These monoterpene alcohols can be acyclic, monocyclic, or bicyclic. Examples of acyclic monoterpene alcohols include, but are not limited to: linalool, geraniol, β-citronellol, nerol, and perillyl alcohol. Examples of monocyclic monoterpene alcohols include, but are not limited to: 5-methyl-2-(propan-2-yl)cyclohexan-1-ol (also called 2-isopropyl-5-methylcyclohexanol, hexahydrothymol, 5-methyl-2-(propan-2-yl)cyclohexan-1-ol, 2-isopropyl-5-methylcyclohexanol, hexahydrothymol, 3-p-Menthanol), α-terpineol, terpinen-4-ol, and/or thymol (technically a phenol, but closely related). Examples of bicyclic monoterpene alcohol include but are not limited to borneol, and sobrerol. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as diterpene alcohols. Diterpene alcohols include, but are not limited to: dictyol A, dictyol B, dictyol C, pachydictyol A, isopachydiol A, sclareol, 16α-hydroxy-ent-kaurane, kaurenoic acid and acanthoic acid (considered diterpenes, although some might also be described as carboxylic acids, but their structure can include alcohol functional groups), and alcohol-containing diterpene alkaloids such as peregrine alcohol. Additionally, there are sesquiterpene alcohols (for example, farnesol, nerolidol, and bisabolol). Triterpene alcohols may also be used as a volatile component in a precursor liquid formulation. These include, but are not limited to helianol, taraxasterol, Psi-taraxasterol, α-amyrin (alpha-amyrin), β-amyrin (beta-amyrin), lupeol, taraxerol, cycloartenol, 24-methyl-enecycloartanol, tiruccalla-7,24-dienol, and dammaradienol. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpene esters. These are formed by combining terpenes with a carboxylic acid group. This reaction can be done commercially where terpene esters are produced through an esterification reaction, where an alcohol (the terpene) reacts with a carboxylic acid. This reaction adds an ester group to the terpene molecule. Terpene esters can also be derived and/or isolated from natural sources such as various plants, fruits, and flowers. Terpene esters include, but are not limited to linalyl acetate, geranyl acetate, pinyl acetate, bornyl acetate, and methyl jasmonate. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpene ketones (or ketonic terpenoids). These include, but are not limited to, for example: camphor, carvone (a monoterpene ketone that occurs in two forms (enantiomers)—the R-form and the S-form), fenchone, menthone, piperitone, pulegone, umbellulone, and verbenone. Additionally, if the ketonic terpenoid contains an acid functional group it can be described as an acidic ketonic terpene and are also are generally referred to by the chemical structure names that reflect both functional groups (ketone and carboxylic acid), most commonly as keto acids or oxoterpenoids. Examples of a keto acid and/or oxoterpenoid include, but are not limited to: camphoric acid which is an oxidation product derived from the bicyclic monoterpene camphor; boswellic acids which are comprised of a series of pentacyclic triterpenoid molecules with a carboxylic acid group; and moronic acid which is a structure comprised of a triterpenoid ketone and an acid. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpene ethers and are a class of terpenoids (oxygen-containing terpenes) that contain an ether functional group. These include, but are not limited to, for example: 1,8-Cineole (also called eucalyptol) which is a bicyclic monoterpene ether; linalool oxide which is a monoterpene ether derived from the oxidation of the terpene alcohol linalool, (it may exist in furanoid and pyranoid forms); caryophyllene oxide which is a sesquiterpene ether (unique among terpenes for its ability to bind to the CB2 receptors of the endocannabinoid system in humans); 1,4-cineole which is another cyclic monoterpene ether isomer of 1,8-cineole; and perillene which is a monoterpene ether. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpenophenols. These are compounds composed from both terpenes and phenols. Examples include, but are not limited to, for example: bakuchiol, ferruginol, carnoso, hinokitiol, auraptene, alkannin, ascofuranone, and carnosic acid. Some terpenoids, which are related to terpenes and contain oxygen, also have phenolic structures and include, but are not limited to, for example, carvacrol and thymol. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpene epoxides. Terpene epoxides are oxygen-containing derivatives (terpenoids) that occur naturally in small amounts and/or are produced synthetically from natural terpene sources. These include, but are not limited to, for example: limonene oxide (also called limonene 1,2-epoxide), limonene dioxide (also called limonene bis-epoxide), α-pinene oxide, β-pinene oxide, caryophyllene oxide, 3-carene epoxide (also called trans-3,4-epoxy-caran), car-3-ene-5,6-epoxide (naturally occurring), glycidyl geraniol ether (a synthetic derivative), myrcene monoepoxide (specifically epoxidized at the 6,7 double bond), and α-terpinene dioxide. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

Volatile molecules and/or compounds that may be used in a precursor liquid formulation may also include molecules and/or compounds that can be described as terpene aldehydes (also called aromatic aldehydes). These may be formed when a terpene, which is a hydrocarbon built from isoprene units, is modified to include an aldehyde group. Examples of terpene aldehydes include, but are not limited to, for example: citral, citronellal, vanillin, and cinnamaldehyde. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

In the formulation of a precursor liquid and/or precursor compound, that the formulation may contain one or more compounds that contain a terpene as part of the structure of the molecule and/or compound. Examples include, but are not limited to, for example: Terpenes including acyclic terpenes; monocyclic terpenes; dicyclic terpenes; polycyclic terpenes such as tetracyclic terpenes and pentacyclic terpenes; terpenoids including acyclic terpenoids, monocyclic terpenoids, dicyclic terpenoids, and polycyclic terpenoids such as tetracyclic terpenoids and pentacyclic terpenoids; Terpene alcohols; including acyclic terpene alcohols, monocyclic terpene alcohols, dicyclic terpene alcohols, and polycyclic terpene alcohols such as tetracyclic terpene alcohols and pentacyclic terpene alcohols; terpene esters including acyclic terpene esters, monocyclic terpene esters, dicyclic terpene esters, and polycyclic terpene esters such as tetracyclic terpene esters and pentacyclic terpene esters; terpene ethers including acyclic terpene ethers (a subgroup of which are called acyclic terpenyl glycidyl ethers (TGEs)), monocyclic terpene ethers, dicyclic terpene ethers, and polycyclic terpene ethers such as tetracyclic terpene ethers and pentacyclic terpene ethers; Terpene ketones (ketonic terpenes) including acyclic terpene ketones, monocyclic terpene ketones, dicyclic terpene ketones, and polycyclic terpene ketones such as tetracyclic terpene ketones and pentacyclic terpene ketones; terpenophenols including acyclic terpenophenols, monocyclic terpenophenols, dicyclic terpenophenols, and polycyclic terpenophenols such as tetracyclic terpenophenols and pentacyclic terpenophenols; terpene epoxides including acyclic terpene epoxides, monocyclic terpene epoxides, dicyclic terpene epoxides, and polycyclic terpene epoxides such as tetracyclic terpene epoxides and pentacyclic terpene epoxides; and terpene aldehydes, including acyclic terpene aldehydes, monocyclic terpene aldehydes, dicyclic terpene aldehydes, and polycyclic terpene aldehydes such as tetracyclic terpene aldehydes and pentacyclic terpene aldehydes. It should be understood that the types of molecules and/or compounds described herein are intended to serve as examples and other types of related molecules and/or compounds and/or combinations of related molecules and/or compounds may be utilized in isolation or combination for the purpose of the formation and/or formulation of precursor liquids and/or precursor compounds.

In some embodiments of the precursor liquid and/or precursor compound, the formulation of a precursor liquid and/or precursor compound the formulation may contain one or more compounds that contain a terpene as part of the structure of the molecule and/or compound. The molecule or compound may have one more functional groups including, but not limited to, for example: an alcohol functional group containing a hydroxyl (—OH) group (e.g., linalool and geraniol); an aldehydes functional group that has a carbonyl (C═O) group with a hydrogen attached (e.g., citral—a mixture of neral and geranial); a ketone functional group that has a carbonyl (C═O) group bonded to two carbon atoms (e.g., as is present in carvone); an epoxide functional group that has a three-membered ring containing one oxygen atom (e.g., as is present in myrcene monoepoxide); an ester functional group that has a carbonyl group bonded to an oxygen atom (e.g., as is present in bornyl acetate); An ether functional group that has an oxygen atom bonded to two carbon atoms (e.g., as is present in 1,8-cineole); and a phenol functional group that has a hydroxyl group directly attached to an aromatic ring (e.g., thymol and carvacrol). It should be understood that the molecule, molecules, compound, and/or compounds that are composed structurally of a terpene may have a functional group or functional groups as part of the structure, and that multiple functional groups may be present.

In the formulation of a precursor liquid and/or compound containing a volatile molecule or molecules and/or compound or compounds it should be understood that molecules and or compounds may be selected for a precursor liquid formulation that may undergo a reaction or reactions and/or interconversion or interconversions when formulated together in a precursor liquid. This method and/or process may be used to formulate the desired precursor liquid or precursor compound formulation. This method utilizes at least some of the volatile molecule, molecules, volatile compound, and/or compounds (including, but not limited to, molecules and/or compounds that have specific functional groups, and/or a plurality of functional groups such as those described herein) to function as a reactant and/or reagent in order to form the final desired product present in the precursor liquid and/or precursor compound formulation. A simple example would be the use of a terpene ether and a terpenoid as reactant or reagent such that when combined together in a formulation (combination of an ether and a carboxylic acid) the formation of a terpene ester occurs, by an esterification reaction, where the terpene ester is the desired product present in the precursor liquid and/or precursor compound formulation. It should be understood that the types of reactions described herein are intended to serve as examples and other types of reactions, and/or sequences of reactions and/or combinations of reactions and/or interconversion reactions that may be utilized in isolation or combination for the purpose of the formation and/or formulation of precursor liquids and/or precursor compounds.

In some embodiments the liquid precursor or precursor compound is formulated utilizing various types of reactions and/or interconversion reactions (also called conversion reactions), including but not limited to reactions and/or interconversion reactions that change the functional group of the base or parent molecule (such as a terpene), and/or interconvert the base or parent molecule to another species may be utilized to achieve the final desired precursor liquid and/or precursor compound formulation. Examples of the types of reactions that may be used to formulate the desired precursor liquid and/or compound include, but are not limited to: oxidation reactions, reduction reactions, combination of oxidation and reduction reactions (also called redox reactions), hydration reactions, esterification, and various addition reactions. These transformations and/or reactions may be addition reactions, elimination reactions, substitution reactions, oxidation-reduction (redox) reactions, rearrangement reaction, radical reaction, and/or pericyclic reactions or a combination of reactions which may also include but is not limited to enzymatically mediated and/or catalyzed (biosynthesis) and/or synthetic reactions including but not limited to combination reactions, decomposition combination reactions, single replacement combination reactions, double replacement combination reactions, acid-base reactions, Wittig reactions and/or Grignard reaction. It should be understood that the types of reactions described herein are intended to serve as examples and other types of reactions, and/or sequences of reactions and/or combinations of reactions and/or interconversion reactions that may be utilized in isolation or combination for the purpose of the formation and/or formulation of precursor liquids and/or precursor compounds.

The types of reactions that can be utilized can be reactions based on the functional groups present on the molecules and/or compounds being utilized. The type of functional group may influence the potential reaction types that may be used. Using terpenes as an example, examples of reaction types include, but are not limited to: terpenes with double carbon bonds (C═C double bonding, also called Alkenes—such as, for example pinene or limonene) can undergo addition reactions where atoms are added across the double bond. Examples of addition reactions include but are not limited to hydrogenation (adding H₂ to form a saturated hydrocarbon), hydration (adding water to form an alcohol), and halogenation (adding halogens like Br₂). Another example are oxidation reactions which can be performed in standard atmosphere or enzymatically. In these reactions, the double bonds react with ozone (O₃), OH radicals, and (NO₃) radicals, producing epoxides, carbonyls, alcohols, and/or carboxylic acids. Another example is cyclization reactions. These reactions, often enzyme-catalyzed, involve the formation of carbocation intermediates that rearrange to form complex cyclic terpene structures. Reactions that occur in molecules or compounds with a hydroxyl group (—OH functional group, also called alcohols) also include oxidation reactions, where the alcohols (e.g., geraniol and/or linalool) can be oxidized to form aldehydes or ketones, and further to carboxylic acids. Another hydroxyl group reaction is esterification, where the hydroxyl group reacts with carboxylic acids (often under acidic conditions) to form esters. Hydroxyl group reactions can also be used for nucleophilic substitution reactions, where the hydroxyl group can be replaced by other groups in substitution reactions. Carbonyl group reactions (C═O functional groups, also called aldehydes and ketones) include reduction reactions where aldehydes and ketones (for example citral and/or carvone) can be reduced back to primary or secondary alcohols, respectively. Carbonyl groups can also undergo nucleophilic addition reactions as the carbonyl carbon is susceptible to attack by nucleophiles, for example, they react with alcohols to form hemiacetals and acetals. Condensation Reactions: carbonyl groups also participate in various condensation reactions (for example aldol condensation) to form more complex molecules. Carboxylic acid functional groups (—COOH functional group) undergo esterification reactions, as described herein, where they react with alcohols to form esters. Carboxylic acid functional groups also undergo reduction reactions and can be reduced to aldehydes or primary alcohols. Another example of a reaction that can utilize a carboxylic acid functional group is the formation of nicotine salt(s), which is formed through a chemical reaction between a nicotine base and an acid (such as a carboxylic acid) and the acid-base reaction creates a salt and lowers the pH. It should be understood that the reactions involving functional groups and interconversion reactions described herein are intended to serve as examples and other types of reactions, and/or sequences of reactions and/or combinations of reactions and/or interconversion reactions may be utilized in isolation or combination for the purpose of the formation and/or formulation of precursor liquids and/or precursor compounds.

Additionally, interconversion reactions also include but are not limited to; functional group interconversion, including multi-step interconversion as for example where an alcohol can be oxidized to an aldehyde, which can be further oxidized to a carboxylic acid. Additionally precursor liquid and/or precursor compound formulations may be optimized to facilitate the interconversion of the phase states of the precursor liquid and/or compound where the chemical composition remains the same; it only changes state (e.g., solid to liquid to gas). It should be understood that the reactions involving functional groups and interconversion reactions described herein are intended to serve as examples and other types of reactions, and/or sequences of reactions and/or combinations of reactions and/or interconversion reactions may be utilized in isolation or combination for the purpose of the formation and/or formulation of precursor liquids and/or precursor compounds.

In some embodiments, the formation and/or formulation of a precursor liquid and/or precursor compound may utilize volatile molecule and/or volatile compounds such as terpenes and their derivatives that are synthesized in order to achieve the desired structure, purity, and/or functional attributes of the molecule and/or compound used in the precursor liquid and/or precursor compound. Chemical reaction methods and processes that may be utilized include, but is not limited to, for example, the combination of an alcohol and an acid to form an ester. This process is also known as esterification (as previously described herein) and specifically, the reaction between an alcohol and a carboxylic acid that is known as Fischer esterification. Fischer esterification is a type of condensation reaction where water is also produced. This reaction is between a carboxylic acid and an alcohol (which may require an acid catalyst). This reaction can also be described as a condensation reaction because a molecule of water is eliminated as a byproduct. In an embodiment, the water byproduct may be used as the water fraction present intentionally in a precursor liquid and/or precursor compound formulation. Another reaction that may be utilized in the formation of a precursor liquid and/or precursor compound formulation is the synthesis of an ether. Ether can be synthesized from an alcohol through reactions including, but not limited to, for example, the Williamson ether synthesis or acid-catalyzed dehydration (with water as a byproduct) where the water byproduct may be used as the water fraction present intentionally in the precursor liquid and/or precursor compound formulation. It should be understood that the reactions involving functional groups and interconversion reactions described herein are intended to serve as examples and other types of reactions, and/or sequences of reactions and/or combinations of reactions and/or interconversion reactions may be utilized in isolation or combination for the purpose of the formation and/or formulation of precursor liquids and/or precursor compounds.

Additionally reactions form hemi-ketals, ketals, and/or polyketals may be utilized to form desired volatile molecules and/or compounds for inclusion in the precursor liquid and/or precursor compound. These may be utilized as an intermediary product that may not be present in the final formulation or alternatively, may be a component of the final formulation. The hemiketal product of the reaction between an alcohol and a ketone and the reaction can proceed further with a second molecule of alcohol to form a ketal (though the term “ketal” has largely been superseded by the more general term acetal). Hemiketal formation is achieved by an initial reaction (which may be under acidic conditions) involving one molecule of an alcohol adding across the carbonyl double bond of the ketone. The resulting functional group features both a hydroxyl (—OH) group and an ether (—OR) group attached to the same carbon atom. This reaction can be used as the basis for the production of acyclic or cyclic hemiketal products (where the cyclic hemiketal is more stable than the acyclic ketal). Ketal (acetal) formation occurs by continuing the reaction with an excess of the alcohol and an acid catalyst where the hydroxyl group is replaced by a second ether group, and a molecule of water is eliminated. The resulting product is a ketal (acetal), which has two ether linkages to the original carbonyl carbon. It should be understood that the reactions described herein are intended to serve as examples and other types of reactions, and/or combinations and/or sequences of reactions and/or interconversion reactions may be utilized in isolation or combination for the purpose of the formation and/or formulation of precursor liquids and/or precursor compounds.

In some embodiments the formation and/or formulation of a precursor liquid and/or precursor compound may utilize volatile molecule and/or volatile compounds such as terpenes and their derivatives that are synthesized in order to achieve the desired structure, purity, and functional attributes of the molecule and/or compound used in the precursor liquid and/or precursor compound. Terpenes and their derivatives can be synthesized using several methods, including, but not limited to, for example: biosynthesis/fermentation, extraction from natural sources, and chemical synthesis. The chosen method utilized may depend on the desired scale, purity, and structural complexity of the target molecule and/or compound. Biosynthesis (also called fermentation) uses engineered microorganisms (like yeast or bacteria) as “cell factories” to produce specific terpenes. This method involves engineering the organism's metabolic pathways (specifically the mevalonate (MVA) or methylerythritol phosphate (MEP) pathways) to overproduce isopentenyl pyrophosphate (IPP) and dimethylallyl pyrophosphate (DMAPP) precursors. Terpene synthase enzymes are then used to convert these IPP and/or DMAPP precursors into the desired terpene skeleton, which can be further modified by other enzymes. This allows for the cost-effective production of rare or complex terpenes on a commercial scale, with high purity and consistency. It should be understood that the methods for the extraction and/or isolation, and/or synthesis of terpenes and terpene derivatives for the purpose of their inclusion into a precursor liquid and/or precursor compound formulation and/or to be used in the formation of a precursor liquid and/or precursor compound formulation are intended to serve as examples, and other methods may be used, and that the methods described herein may be used in isolation or in combination and/or sequence in order to extract, isolate, and/or synthesize the desired terpene and/or terpene derivative molecule or molecules and/or compound or compounds.

Extraction from natural sources may also be utilized where terpenes are naturally produced by plants and can be isolated through various extraction techniques including, but not limited to, for example: steam distillation/hydrodistillation where the plant material is heated with water or steam, the volatile terpenes vaporize, and the mixed vapor is condensed and separated; and vacuum distillation where the plant material containing the terpene or terpenes and/or other desired volatile compound and/or molecules is placed under a controlled vacuum pressure to remove the volatile terpenes which can then undergo further vacuum distillation for isolation of specific terpenes and terpene derivative and/or other volatile compounds present in the plant material. Another method is solvent extraction where organic solvents (e.g., ethanol, hexane, or chloroform) are used to dissolve terpenes from plant material. This can involve maceration (soaking) or Soxhlet extraction (continuous solvent recycling). Supercritical Fluid Extraction (SFE) may also be utilized. This method uses supercritical carbon dioxide as a non-toxic solvent to extract compounds. This allows for high selectivity and efficiency to extract terpenes including, for example, terpenes with complex profiles. Other methods include utilizing chemical synthesis where organic chemistry methods are used to construct terpene skeletons from simpler, often petroleum-derived, precursor chemicals. Types of chemical synthesis include total synthesis and semi-synthesis methods. Total synthesis involves building the complex terpene molecule from simple, commercially available starting materials and may utilize synthetic strategies to control the molecule's stereochemistry. Semi-synthesis uses a naturally abundant, but structurally related, terpene as a starting material and modifies it to produce the desired final product or its analogs. This approach can be more efficient than total synthesis. Enzymatic/Chemoenzymatic synthesis is another method that may be utilized where specific enzymes are used to perform complex chemical transformations and can be used in combination with traditional chemical steps. It should be understood that the methods for the extraction and/or isolation, and/or synthesis of terpenes and terpene derivatives for the purpose of their inclusion into a precursor liquid and/or precursor compound formulation and/or to be used in the formation of a precursor liquid and/or precursor compound formulation are intended to serve as examples, and other methods may be used, and that the methods described herein may be used in isolation or in combination and/or sequence in order to extract, isolate, and/or synthesize the desired terpene and/or terpene derivative molecule, molecules, compound and/or compounds.

In some embodiments the formation and/or formulation of a precursor liquid and/or precursor compound may utilize volatile molecule and/or volatile compounds such as terpenes and their derivatives that are synthesized in order to achieve the desired structure, purity, and functional attributes of the molecule and/or compound used in the precursor liquid and/or precursor compound. In some embodiments the desired volatile molecule or molecules and/or compound or compounds may be terpenes and their derivatives, such as for example a terpenoid or terpenoids that have a complex structure and/or stereochemistry and/or isomerism and/or chirality such that additional methods and processes may be utilized for their synthesis. For example, complex terpenes, terpenoids and/or their derivatives may be synthesized using Wieland-Miescher ketone and its analogs. These may be used as a synthetic building block(s) for creating more complex terpenes and terpenoids. This method uses the Wieland-Miescher ketone to synthesize terpenes by acting as a versatile chiral building block, with its bicyclic structure undergoing various chemical modifications. The Wieland-Miescher ketone functional groups (ketones and the alkene) can be utilized for a range of reactions, such as oxidation, reduction, and alkylation, to progressively build the carbon skeleton of more complex terpene structures. Enantioselective synthesis of the ketone itself is crucial for creating optically pure terpenes with specific biological activities. This method may be utilized to insure the correct isomerism and/or chirality as the Wieland-Miescher ketone can be synthesized in an optically pure form, allowing the synthesis of enantioselective synthesis of complex, and/or bioactive terpenes. It should be understood that the methods the production, modulation, and/or synthesis of terpenes and terpene derivatives for the purpose of their inclusion into a precursor liquid and/or precursor compound formulation and/or to be used in the formation of a precursor liquid and/or precursor compound formulation are intended to serve as examples, and other methods may be used, and that the methods described herein may be used in isolation or in combination and/or sequence in order to produce, modulate, and/or synthesize the desired terpene and/or terpene derivative molecule or molecules and/or compound or compounds.

It may be desirable in the formation of precursor liquid and/or precursor compound formulations to utilize machine learning for the optimization of specific formulations and/or the selection of compounds and/or molecules to be included in the formulation and/or formulations. Machine learning may serve multiple functions in the process or processes of formulating precursor liquids and/or precursor compounds, such as any of the methods and processes described herein, including, but not limited to, for example, the selection of non-volatile and/or volatile components and/or molecules in isolation and/or combination to achieve desired organoleptic properties of the precursor liquid and/or precursor compound formulations. The machine learning process may include the process of first formulating and then qualitatively testing the precursor liquid and/or precursor compound formulation and using the results of the qualitative testing to train the machine learning program in order to further optimize the subsequent precursor formulation. This process and/or a similar process may be repeated a plurality of times or on an ongoing manner in order to optimize the machine learning model.

Machine learning may be used for selection of non-volatile and/or volatile components and/or molecules in isolation and/or combination to achieve desired physiological effects of the precursor liquid and/or precursor compound formulations which may include the process of formulation, qualitatively testing and quantitatively testing (e.g. pharmacokinetic study) the formulation, and using the results of the qualitative testing and quantitative testing to train the machine learning model in order to further optimize the subsequent precursor formulation. This process and/or a similar process may be repeated a plurality of times or on an ongoing manner in order to optimize the machine learning program. It should be understood that this description is intended to provide an example of how machine learning may be used for the formation of precursor liquids and/or precursor compounds formulation or formulations and the optimization of such formulations and that additional methods and process utilizing machine learning may be used individually or in combination with the methods and processes described herein.

Machine learning may be utilized to optimize the formulation process as it relates to the formation of a precursor liquid and/or precursor compound utilizing a database of molecules and compounds (such as those described herein) and a database of known reactions such as for example, but not limited to, organic chemistry reactions and synthetic chemistry reactions. These reactions, and/or databases may be input to the machine learning model, and the machine learning model may output suggested formulation components, component ratios, production methods, and production process(es) (including but not limited to reaction processes and/or methods). Such output suggestions from the machine learning model may be tested and evaluated qualitatively and/or quantitatively with the results being used to train the machine learning model. This process may be repeated a plurality of times or in an ongoing manner in order to optimize the machine learning model. It should be understood that this description is intended to provide an example of how machine learning may be used for the formation of precursor liquids and/or precursor compounds formulation or formulations and the optimization of such formulations and that additional methods and processes utilizing machine learning may be used individually or in combination with the methods and processes described herein.

Machine learning may be used to predict desired physiological interactions and/or physiological effects of the precursor liquid and/or precursor compound formulation. Molecules and/or compounds that may be used in a formulation that have known physiological interactions and/or physiological effects (including, but not limited to, receptor binding and/or interactions) may be used to train the machine learning model. The machine learning model may then output suggested formulations to achieve a desired type of physiological interactions, physiological effects, and/or receptor binding or receptor interaction. Such output suggestions from the machine learning model may be tested and evaluated, including but not limited to in vivo and/or in vitro testing, with the results used to further train the machine learning model. This process may be repeated a plurality of times or in an ongoing manner in order to optimize the machine learning model. It should be understood that this description is intended to provide an example of how machine learning may be used for the formation of precursor liquids and/or precursor compounds formulation or formulations and the optimization of such formulations and that additional methods and processes utilizing machine learning may be used individually or in combination with the methods and processes described herein.

In any application of the machine learning model or models such as those described herein, the machine learning model or models may be taught using existing data, and/or data generated from qualitative testing, data generated from quantitative testing, and/or data generated from in vivo and/or in vitro testing. Such data may include bench-top, laboratory, test instrument generated data, data generated from computer simulation and/or computer modeling, and/or data generated from testing the product with controlled groups of individuals (e.g., blind studies or double blind studies, control group testing, pharmacokinetic studies, and/or other market testing). Training data may include taste testing, user, and/or customer experience testing. Such data may be data gathered from large groups such as consumers and/or select subsets of consumers. Such data may be individual data or aggregated data. It should be understood that this description is intended to provide an example of how machine learning may be used for the formation of precursor liquids and/or precursor compounds formulation or formulations and the optimization of such formulations and that additional methods and process utilizing machine learning may be used individually or in combination with the methods and processes described herein.

In some embodiments the formation and/or formulation of a precursor liquid and/or precursor compound may utilize volatile molecule and/or volatile compounds such as terpenes and their derivatives that are selected based on their interactions with each other and/or their interaction with other molecules and/or compounds present in the precursor liquid and/or precursor compound formulation, as for example nicotine and/or cannabinoids and/or cannabinoid derivatives. The selection of the volatile molecule and/or volatile compounds such as terpenes and their derivatives may also be determined by the interaction of the molecules and/or compound and/or mixture of molecules and/or compounds with human physiology to effect a physiological response or perceived physiological and/or psychological benefit. Terpenes and their derivatives typically react with each other and other compounds to produce a range of synergistic biological effects in the body, a phenomenon known as the entourage effect.

Unlike typical chemical reactions where they form new molecular structures, interaction of the molecules and/or compound and/or mixture of molecules and/or compounds with human physiology to effect a physiological response or perceived physiological and/or psychological benefit are primarily pharmacological interactions that modulate physiological processes. Examples of types of interactions and their outcomes include but are not limited to: Synergistic enhancement (also called the Entourage Effect), where the terpenes and/or their derivatives work together with cannabinoids (like THC and CBD) to enhance or modulate their individual effects. This may result in a more potent and/or balanced overall experience by the user. Specific examples of combinations include, but are not limited to, for example: Limonene and THC in combination which can produce a more energetic and clear-headed effect—potentially reducing the anxiety sometimes associated with high THC doses; Myrcene and THC in combination which may enhance the sedative and relaxing properties of the cannabinoid; and Pinene and THC in combination which may reduce the short-term memory impairment often linked with THC. The selection of the volatile molecule and/or volatile compounds such as terpenes and their derivatives may also be determined by the receptor interaction as specific terpenes can directly interact with the body's neurotransmitter and endocannabinoid receptors. Examples include, but are not limited to: β-caryophyllene (beta-caryophyllene) which binds directly to the CB2 cannabinoid receptor thereby producing anti-inflammatory and pain-relieving effects without psychoactivity; and linalool which binds to GABA receptors, which helps produce calming, anti-anxiety effects similar to the natural neurotransmitter GABA. It should be understood that the description provided herein is intended to serve as examples, and that other combinations of terpenes and their derivatives and/or other molecules and/or compounds and their derivatives may be used individually or in combination in the formation and/or formulation of a precursor liquid or precursor liquids and/or precursor compound or precursor compounds.

The selection of the volatile molecule and/or volatile compounds such as terpenes and their derivatives may also be determined based on increasing the efficacy of the precursor liquid and/or precursor compound by increasing the bioavailability of the active component of the precursor liquid and/or precursor compound such as for example nicotine, cannabinoids, and/or a combination of nicotine and cannabinoids. Some terpenes can increase the permeability of cell membranes, including the blood-brain barrier, allowing other compounds like cannabinoids to be absorbed more efficiently or quickly. The selection of the volatile molecule and/or volatile compounds such as terpenes and their derivatives may also be determined based on the molecule and/or compounds ability to modulate neurotransmitters. For example, terpenes and their derivatives, as an individual species or in combination with other terpenes, and their derivatives, can influence levels of neurotransmitters like serotonin and dopamine thereby affecting mood, motivation, and the perception of experiencing pleasure. For example, limonene has shown the ability to elevate serotonin and dopamine levels thereby contributing to mood enhancement. It should be understood that the description provided herein is intended to serve as examples, and that other combinations of terpenes and their derivatives, other molecules, compounds and/or their derivatives may be used individually or in combination in the formation and/or formulation of a precursor liquid or precursor liquids and/or precursor compound or precursor compounds.

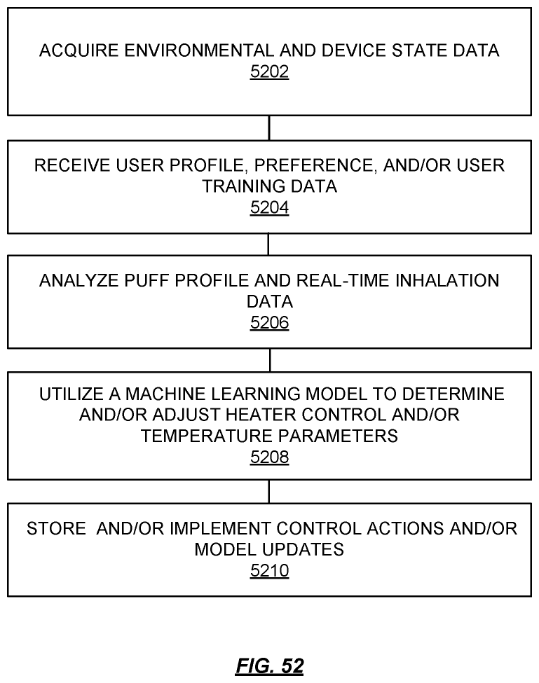

FIG. 49 is a flowchart illustrating an exemplary process for optimizing precursor liquid and/or precursor compound formulations using machine learning. One or more of the steps illustrated in FIG. 49 may use, be used by, and/or or be tailored to, for example, one or more of the vaporizing devices and/or precursor components described herein. A database of candidate molecules and compounds (e.g., including volatile and non-volatile components) and a database of known chemical reactions applicable to precursor formulation is acquired (4902). For example, a database comprising two or more of the substances discussed herein as suitable for precursor formulations for the vaporizing devices discussed herein, and known chemical and/or thermal reactions of those substances may be received, compiled, and/or otherwise obtained.

A machine learning model is utilized to generate one or more candidate precursor liquid and/or precursor compound formulations by selecting specific compounds and/or molecules and proposing component ratios and production methods based on the input databases (4904). For example, the machine learning model may select candidate compounds (e.g., linalool, geraniol, citral, etc.) and propose a formulation ratio and synthesis method based on historical reaction data and desired organoleptic properties. The candidate formulations are prepared and subjected to qualitative and/or quantitative testing to evaluate desired properties such as physiological effects, organoleptic characteristics, and bioavailability (4906). Example types of testing may include, for example, organoleptic assessment, pharmacokinetic studies, receptor binding assays, in vivo/in vitro testing, etc. The candidate formulations generated by the machine learning model may be produced and also or alternatively, for example, tested for aroma, taste, and physiological effect in a controlled laboratory setting, with results recorded for further analysis. The testing may be done, for example, with and/or without using a vaporizing device as discussed herein as part of the testing and/or evaluation process.

The results of the experimental evaluation (e.g., including qualitative and quantitative data) are used to train and optimize the machine learning model, thereby refining subsequent formulation suggestions (4908). This process may be repeated iteratively to further optimize the model and the resulting formulations. For example, the results of taste testing and pharmacokinetic studies may be input into the machine learning model to improve its predictive accuracy for future formulation cycles, thereby improving the model's ability to suggest new combinations or ratios that better meet the desired criteria.

FIG. 50 is a flowchart illustrating an exemplary process for determining mappings from sensor signals to control parameters of a vaporizing device using machine learning. One or more of the steps illustrated in FIG. 49 may use, be used by, and/or or be tailored to, for example, one or more of the vaporizing devices and/or precursor components described herein. Real-time sensor signals during one or more inhalation cycles is received (5002). For example, during some (or all) activation and/or inhalation cycles, controller 480 may collect real-time data from one or more sensors (e.g., airflow sensors, pressure sensors, and/or temperature sensors). These sensors may provide information regarding the user's inhalation profile (e.g., flow rate, duration, frequency) and the operational state of the device (e.g., heater temperature, ambient conditions).

User feedback and/or aggregate user training data is acquired (5004). For example, controller 480 may receive user feedback, which may for example, be explicit (e.g., user input via a button, touchscreen, microphone, and/or mobile application indicating satisfaction or dissatisfaction with the inhalation experience) and/or implicit (e.g., patterns of device usage, inhalation characteristics, time of day, environmental conditions, and/or other usage data). In some examples, controller 480 may aggregate user training data over multiple activation cycles to identify characteristic inhalation profiles. A machine learning model is trained and/or updated using the sensor signals and/or user data (5006). For example, controller 480 may transmit the collected sensor data and user feedback/training data to another computer/system to be utilized to train or update a machine learning model to be used by controller 480. The model may be implemented, for example, using supervised learning (where user feedback provides labels for desired outcomes), unsupervised learning (where patterns are inferred from usage data), and/or reinforcement learning (where the model is rewarded for achieving optimal device performance or user satisfaction). The machine learning model may learn to associate specific sensor signal patterns with optimal control parameters, such as heater power, preheat duration, or flow rate thresholds. The machine learning model may be trained, for example, using data from a plurality (e.g., large number) of users, vaporizing devices, and/or device embodiments, described herein.

Control parameters for device operation based on machine learning model output are generated (5008). For example, controller 480 (or another system) may generate, based on the machine learning model, static control parameters to be used by controller 480 during an inhalation and/or activation cycle. In another example, during subsequent inhalation cycles, controller 480 may apply the trained machine learning model to incoming sensor signals to determine appropriate control parameters in real time. In this example, controller 480 may dynamically adjust the power delivered to the heater based on the detected inhalation strength, duration, or environmental conditions, thereby optimizing vapor or aerosol generation to match the user's preferences or physiological needs. The machine learning model may output control parameters (e.g., heater power, preheat duration, flow thresholds) in response to received sensor signals, thereby enabling adaptive or personalized device operation. The user profile and/or model parameters are stored (5010). For example, controller 480 may store the trained model, static control parameters, and/or user profile data (e.g., user-specific data, model weights, and/or learned mappings) in non-volatile memory thereby enabling persistent personalization across sessions and device power cycles.

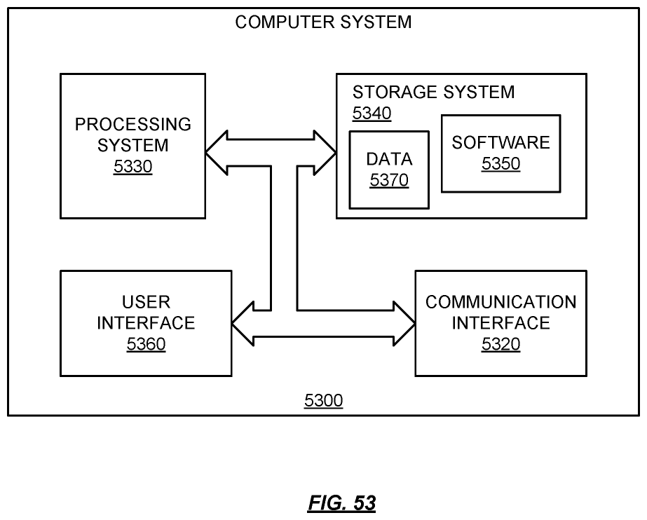

FIG. 51 is a flowchart illustrating an exemplary process for detecting properties of a precursor and/or vapor using machine learning and analytical measurements. One or more of the steps illustrated in FIG. 51 may use, be used by, and/or be tailored to, for example, one or more of the vaporizing devices and/or optical analysis subsystems described herein.

Spectral or analytical data from a precursor and/or vapor is acquired (5102). For example, an optical analysis subsystem (e.g., system 4700 or 4800) may acquire spectral data (e.g., UV, IR, visible, or refractive index measurements) from a precursor sample and/or vapor sample using one or more emitters and detectors as described herein. The subsystem may analyze the precursor prior to vaporization, the vapor after vaporization, or both.

The acquired data is preprocessed and/or normalized (5104). For example, the optical analysis subsystem may preprocess the acquired spectral data by performing baseline correction, normalization, noise reduction, or feature extraction to prepare the data for further analysis. This may include comparing the measured spectrum to a reference or applying mathematical transformations to enhance relevant features. A machine learning model is utilized to analyze the data (5106). For example, the preprocessed data may be input to a machine learning model (e.g., a classifier, regression model, or anomaly detector) that has been trained to detect properties such as precursor degradation, authentication (e.g., verifying formulation identity), or reaction completion (e.g., conversion of THC to CBN) as described herein. The model may output a classification, probability, or quantitative estimate of the property of interest.

A property determination or diagnostic output is generated (5108). For example, the system may generate an output indicating the detected property (e.g., “precursor authentic,” “precursor degraded,” “reaction complete,” or “precursor outside specification”). This output may be used to trigger device actions (e.g., enable/disable vaporization, adjust control parameters, notify the user, or log the event). The results and/or model parameters are stored and/or used to update the model or reference data (5110). For example, the system may store the results of the property determination, along with the associated spectral data, in non-volatile memory for future reference, quality assurance, or regulatory compliance. In some embodiments, the stored data may be used to further train or update the machine learning model, either locally or via transmission to a remote server.

FIG. 52 is a flowchart illustrating an exemplary process for adapting heater control parameters of a vaporizing device using machine learning based on environmental conditions, device state, and user profile. One or more of the steps illustrated in FIG. 52 may use, be used by, and/or be tailored to, for example, one or more of the vaporizing devices and/or control systems described herein. Environmental and device state data is acquired (5202). For example, environmental and device state data (e.g., ambient temperature, chamber temperature, chamber preheat temperature, battery state, and/or device usage history) is acquired by one or more sensors coupled with a controller of a vaporizing device described herein.

User profile, preference, or training data is received (5204). For example, user profile data, user preferences (e.g., selected vapor density, flavor, or temperature), and/or user training data (e.g., historical inhalation profiles, satisfaction feedback) is received and/or accessed by the vaporizing device and/or controller. This may include explicit user input or data aggregated over multiple activation cycles. Puff profile and real-time inhalation data is analyzed (5206). For example, during an inhalation cycle, real-time puff profile data (e.g., flow rate, duration, frequency) is analyzed. For example, controller 480 may monitor airflow, pressure, and/or acoustic signals to characterize the user's inhalation pattern in real time.

A machine learning model is utilized to determine or adjust heater control parameters (5208). For example, the system applies a machine learning model (e.g., trained on historical device, environmental, and user data) to determine or adjust heater control parameters (e.g., power level, preheat duration, dynamic setpoints) and or temperature parameter in response to the current environment, device state, and/or user profile. The model may output real-time adjustments to optimize vaporization performance and user experience. Control actions and/or model updates are implemented and stored (X5210). For example, the determined control parameters are implemented by the controller (e.g., adjusting heater power or preheat timing). The system may also store the resulting device state, user response, and/or updated model parameters in non-volatile memory for future adaptation and ongoing personalization.

Example methods, techniques, technologies, and/or materials that may be utilized for the production and/or formation of one or more components described herein are now described Such methods, techniques, technologies, and/or materials may be utilized, in various embodiments, for the production and/or formation of one or more vaporizing devices, vaporizers, cartridges, dispensers, assemblies, actuators, sensors, optical components, spectrometers, and/or components or subcomponents thereof, including but not limited to those illustrated and described with reference numerals 100-4183 (e.g., but not limited to, vaporizing devices/vaporizers 100, 200, 300, 400, 500, 600, 700, 800, 1000, 1100, 1600, 3300, 3400, 3500, 3600, 3900, 4000, cartridge 900, dispensers 1300, 1400, 1500, assemblies 1700, 1800, 1900, 2000, 2100, 2200, 2300, 2400, 2500, 2600, 2700, 2800, 2900, 3000, 3100, 3200, actuators 3700, 3800, and/or spectrometer 4100). For purposes of description and not limitation, reference to a particular vaporizing device, component, and/or assembly (e.g., vaporizer 100 and/or chamber 130) is intended to serve as an example representative of other vaporizing devices, components, and/or assemblies of similar structure, function, and/or scope, when contextually appropriate to a person of ordinary skill in the art. Thus, unless the context clearly requires otherwise, reference to a particular example component shall be understood to encompass corresponding components across other embodiments described herein, including structurally and/or functionally equivalent components, assemblies, and/or subassemblies.

In one or more embodiments, glass materials, and/or components comprising glass materials, may be used in the construction of one or more vaporizing devices and/or vaporizing device components described herein. Such components may include, without limitation, reservoirs, dispensers, dispenser components, chambers, chamber components and/or assemblies, cartridge components, sensors and sensor components, emitter components and/or assemblies, optical components, thermal and/or optical reflectors, focusing elements such as lenses, optical assemblies, sampling chambers, and/or elements thereof. As used herein, references to “glass” or “glass materials” include, but are not limited to, silica-based glasses, fused silica, quartz, doped and/or modified silica, glass-ceramics, and other vitreous and/or partially vitreous materials, whether transparent, translucent, and/or opaque, and whether amorphous and/or partially crystalline, unless the context clearly indicates otherwise.

The methods, processes, techniques, and/or technologies described herein for the formation, construction, and/or modification of glass parts and/or components comprising glass materials are provided as examples and may be combined with, used in conjunction with, and/or performed in sequence with other methods, processes, techniques, and/or technologies, including those described herein, otherwise known, and/or later developed. Functionally equivalent methods, processes, techniques, and/or technologies—whether differing in nomenclature, terminology, equipment, parameters, and/or implementation details—shall be understood to fall within the scope of the present disclosure.

By way of example and not limitation, methods, processes, techniques, and/or technologies that may be used for the formation and/or construction of components comprising glass include material removal processes, surface modification processes, bulk and/or internal structuring processes, and combinations thereof. Such processes may include, without limitation, glass grinding (e.g., using diamond tools), glass machining (e.g., using diamond tools, laser-based methods, or combinations thereof), water-jet cutting (e.g., used alone or in combination with other machining methods), glass etching (e.g., abrasive etching such as sandblasting, chemical etching using acids, gels, and/or creams, and/or laser-based etching), and laser-based structuring processes. Laser-based structuring processes may include, for example, laser ablation, selective laser etching (SLE), and other focused-energy techniques that enable the formation of two-dimensional and/or three-dimensional features, patterns, channels, voids, textures, and/or internal structures within and/or on glass components. Such features may be configured to provide mechanical, thermal, optical, fluidic, aerosol, and/or vapor-related functionality, including but not limited to improving adhesion, wettability, heat transfer, optical performance, and/or integration with other components, and may be used to form complex structures suitable for use in vaporizing devices and related systems, such as vaporizing device 100.

Methods, processes, techniques, and/or technologies that may be used for the formation and/or construction of components comprising glass, such as those described herein, may further include sol-gel processing and related wet-chemical glass-forming techniques. In such processes, one or more liquid precursors may be converted into a solid or semi-solid network through chemical reactions such as hydrolysis, condensation, polymerization, or combinations thereof, thereby forming a gel-based structure that may subsequently be shaped, dried, densified, and/or heat-treated to produce a glass component. Sol-gel-based processes may enable formation of glass components at temperatures lower than those typically associated with melt-based glass processing and may provide substantial control over material composition, dopant incorporation, porosity, microstructure, and resulting physical, thermal, optical, and/or chemical properties. Such processes may be used to form bulk components, coatings, layers, internal structures, and/or composite glass structures, and may be particularly suitable for producing silica-based and/or modified silica glass components, including components configured for use in vaporizing devices and related assemblies. An example sol-gel process creates glass components at low temperatures by converting liquid precursors (like metal alkoxides) into a solid gel through hydrolysis (reaction with water) and polycondensation (polymerization), forming a colloidal suspension (sol) that then solidifies into a rigid network (gel). This wet gel may be shaped, dried to remove liquids (forming a porous xerogel or aerogel), and may be heat-treated (sintered—often below conventional melting temperatures) to create dense, solid, amorphous glass with substantial control over composition and microstructure.

Methods, processes, techniques, and/or technologies that may be used to form components comprising glass described herein may further include precision glass molding (PGM) and related molding and/or replication processes. In such processes, a glass preform or intermediate glass structure may be heated to a softened or formable state and shaped using one or more molds, dies, and/or forming tools to produce a component having a desired geometry, surface quality, and dimensional precision. Precision glass molding processes may be configured to produce components having complex external and/or internal geometries, including features suitable for optical, thermal, mechanical, fluidic, aerosol, and/or vapor-related functionality, and may reduce or eliminate the need for subsequent grinding and/or polishing operations. Such processes may be particularly advantageous for high-volume and/or cost-sensitive manufacturing scenarios and may be used with a variety of glass materials, mold materials, coatings, temperatures, pressures, and processing conditions, selected based on desired performance characteristics, manufacturability, and system-level integration requirements. An example PGM process may use a high-temperature, high-pressure manufacturing method that shapes softened glass into complex shapes. PGM may be used to produce optical-quality components like aspheric lenses without grinding or polishing. This may help with cost-effective mass production, and may be especially useful for intricate designs, such as, for example, components that have been described herein. This example PGM process may involve heating glass preforms and pressing them with ultra-precise molds (often carbide) to replicate the mold's shape, thereby potentially offering advantages in speed, cost, and complexity over traditional methods, though may require careful control of temperature, pressure, and mold coatings.

Components comprising glass described herein may be formed using additive manufacturing and/or three-dimensional (3D) printing methods. Such methods may include, for example, processes in which a glass material—such as a glass powder, granulate, particulate, and/or other subdivided glass form—is combined with one or more binders, carriers, and/or matrices to enable layer-by-layer deposition and shaping of a component. The resulting feedstock may be provided in solid, semi-solid, and/or liquid form, including, for example, filament-based, paste-based, slurry-based, and/or pellet-based feedstocks.

By way of example and not limitation, additive manufacturing processes may include material-extrusion-based techniques, such as fused deposition modeling (FDM), fused filament fabrication (FFF), and/or related extrusion processes, in which a feedstock comprising glass material is deposited through a nozzle to build a component layer by layer. Following formation of the printed structure, one or more post-processing steps—such as debinding, sintering, heating, densification, infiltration, and/or other thermal or chemical treatments—may be performed to remove or modify binder materials (if present), to densify the glass, to adjust microstructure, and/or to otherwise produce a final and/or intermediate glass component. Such post-processing steps may be selected and controlled to achieve desired mechanical, thermal, optical, electrical, and/or chemical properties.

In addition to extrusion-based additive manufacturing, components comprising glass may be formed using additive manufacturing processes based on photopolymerization and/or photo-curing techniques. In such processes, a glass material—such as a powder, granulate, and/or particulate—may be suspended, dispersed, and/or otherwise incorporated within a photo-curable resin and/or liquid medium that is selectively cured using one or more light sources to form a three-dimensional structure.

By way of example and not limitation, photopolymerization-based additive manufacturing processes may include stereolithography (SLA), digital light processing (DLP), masked stereolithography (MSLA), liquid crystal display (LCD)-based processes, and/or related techniques in which electromagnetic radiation, such as ultraviolet and/or visible light, is used to selectively cure regions of the resin in a layer-by-layer manner. Following formation of the printed structure, one or more post-processing steps—such as debinding, sintering, heating, densification, and/or other treatments—may be performed to remove and/or modify the cured resin (if present) and to form a glass component having desired structural and functional characteristics. Such processes may be used to form complex external and/or internal geometries, including features suitable for integration with thermal, optical, fluidic, aerosol, vapor, and/or electrical components of vaporizing devices. An example SLA process may use a UV laser to draw each layer of the part onto the liquid resin surface, curing it layer by layer. An example DLP (Digital Light Processing) process may use a projector or projectors to cure the layer of resin thereby curing the whole layer concurrently. An example MSLA/LCD process may use an LCD screen as a mask for UV LEDs to cure the resin layer by layer thereby forming the final part or parts by using an array of UV LEDs shining through the LCD screen which acts as a mask to define the shape of each layer.

Components comprising glass described herein may additionally be formed using powder bed fusion (PBF) additive manufacturing processes and related powder-based consolidation techniques. In such processes, a powder bed comprising glass material—such as glass powder, particulate, granulate, and/or mixtures thereof, optionally combined with one or more binders, carriers, and/or secondary materials—may be selectively consolidated using an energy source to form a three-dimensional structure.

By way of example and not limitation, powder bed fusion processes may include selective laser sintering (SLS), multi jet fusion (MJF), electron beam-based processes, and related techniques in which electromagnetic radiation, electron beams, thermal energy, fusing agents, or combinations thereof are used to selectively sinter, melt, soften, and/or otherwise consolidate regions of the powder bed. In some implementations, glass material may be directly consolidated, while in other implementations glass material may be consolidated indirectly through interaction with binders, secondary materials, and/or intermediate phases. Components formed using powder bed fusion processes may undergo one or more post-processing steps, such as debinding, sintering, heating, densification, infiltration, annealing, and/or other thermal or chemical treatments, to remove and/or modify non-glass constituents (if present), to densify and/or restructure the glass, and/or to achieve desired mechanical, thermal, optical, electrical, and/or chemical properties. Such processes may be used to form components having complex external and/or internal geometries, including features suitable for integration with thermal, optical, fluidic, aerosol, vapor, and/or electrical elements of vaporizing devices. An example SLS process may fuse powder particles (e.g., nylon) with a laser where the glass is present as a powder mixed with the nylon powder being sintered by the laser. An example MJF process may fuse powder using heat and a fusing agent. Examples of electron beam-based processes may include electron beam melting (EBM) which may use an electron beam to melt powders.

Another additive manufacturing technique that may be used for the production of components comprising glass is material jetting and related droplet-based deposition processes. In such processes, discrete droplets of a build material may be selectively deposited to form a three-dimensional structure, wherein the build material comprises a glass material—such as glass powder, granulate, particulate, and/or precursor—suspended, dispersed, and/or otherwise incorporated within a carrier medium.

By way of example and not limitation, the carrier medium may include photopolymeric materials, wax-based materials, inorganic binders, sol-gel-based compositions, and/or other jettable materials that may be selectively cured, solidified, and/or otherwise stabilized, including by exposure to light, heat, and/or chemical activation. Components formed using material jetting processes may undergo one or more post-processing steps, such as debinding, sintering, heating, densification, infiltration, and/or other treatments, to remove and/or modify carrier materials (if present), to densify and/or restructure the glass, and/or to produce a component comprising glass having desired structural and functional characteristics.

Another additive manufacturing technique that may be used for the production of components comprising glass is binder jetting and related powder-binding processes. In such processes, a liquid binding agent may be selectively deposited onto a powder bed comprising glass material—such as glass powder, particulate, and/or granulate—to at least temporarily bind particles and form a three-dimensional structure. The powder bed may comprise glass material alone or in combination with one or more secondary materials, additives, and/or modifiers. Components formed using binder jetting processes may undergo one or more post-processing steps, such as debinding, sintering, heating, densification, infiltration, annealing, and/or other treatments, to remove and/or modify binding agents (if present), to densify and/or transform the glass, and/or to produce a final and/or intermediate component comprising glass with desired mechanical, thermal, optical, electrical, and/or chemical properties.

Another additive manufacturing technique that may be used for the production of components comprising glass is directed energy deposition (DED) and related energy-assisted deposition processes. In such processes, a glass material may be delivered to a deposition region and selectively heated, melted, softened, and/or otherwise consolidated using an energy source, such as a laser, electron beam, plasma, and/or other focused energy source. In some implementations, glass material may be deposited alone, while in other implementations glass material may be co-deposited or sequentially deposited with one or more other materials, such as metals and/or ceramics. Subsequent processing steps may be performed to modify, remove, and/or transform one or more deposited materials, to achieve desired structural, functional, and/or integrative characteristics. An example binder jetting process may deposit liquid binding agent onto powder (e.g., sand, metal, ceramic) to bind particles. An example DED process may melt a glass material as it is being deposited where the glass may be melted directly in isolation, or in combination with a metal. The metal may be removed, for example, by a post part formation process such as sintering.

The examples of three-dimensional (3D) printing and/or additive manufacturing methods and processes described herein are intended to be non-limiting, and it should be understood that other additive manufacturing methods, processes, and techniques—whether presently known or later developed—may be used for the formation and/or production of glass parts, components comprising glass, and multi-material components including glass. The particular additive manufacturing method or combination of methods selected may be based on factors such as desired material properties, geometry, internal features, scale of production, cost, and/or system-level integration requirements. The additive manufacturing methods and processes described herein may be combined, used in conjunction with one another, and/or performed sequentially to form components composed entirely of glass, partially of glass, and/or comprising combinations of materials. Such combinations may include, without limitation, glass combined with thermoplastics, ceramics, metals, elastomers (including silicones), carbon-based materials, and/or other materials, including functional materials such as conductive, resistive, and/or energy-responsive materials. The resulting components may comprise homogeneous, composite, graded, and/or multi-material structures, including components having embedded features, internal structures, and/or integrated functional elements.

In some embodiments employing three-dimensional (3D) printing and/or additive manufacturing processes to produce glass parts, one or more residual constituents may be intentionally retained within a glass matrix, rather than being fully removed during post-processing. Such residual constituents may include, for example, trace and/or controlled amounts of metallic material, hydroxyl groups, and/or combinations thereof, which may originate from feedstock materials, binders, additives, processing environments, and/or intermediate phases formed during manufacturing.

In certain embodiments, particularly when forming components comprising fused silica and/or silica-based glass, the presence of controlled amounts of residual metallic material within the glass matrix may be selected to modify optical transmission characteristics, such as by attenuating, absorbing, reflecting, and/or otherwise reducing transmission of electromagnetic radiation in one or more ultraviolet (UV) wavelength bands. In certain embodiments, the presence of controlled amounts of hydroxyl groups within the glass matrix may be selected to modify optical transmission characteristics in one or more infrared (IR) wavelength bands.

In some embodiments, both residual metallic material and residual hydroxyl groups may be present within a fused-silica and/or silica-based glass matrix, such that the resulting component exhibits wavelength-selective optical behavior, including reduced transmission in one or more UV and/or IR wavelength bands. The type, concentration, spatial distribution, and chemical state of such residual constituents may be selected and controlled through additive manufacturing parameters and/or post-processing conditions to achieve desired optical, thermal, and/or functional characteristics for use in vaporizing devices and related systems.

In some embodiments, particularly where a formed part comprises glass such as fused silica and/or silica-based glass, a glass powder and/or particulate may be combined with one or more organic binders and mixed with a solid carrier material (e.g., a thermoplastic filament, pellet, and/or powder) and/or with a liquid carrier material (e.g., a resin and/or slurry) to produce a substantially homogeneous mixture suitable for additive manufacturing. Such mixtures may be used in various three-dimensional (3D) printing and additive manufacturing processes, including extrusion-based, powder-based, and photopolymerization-based techniques.

In certain embodiments, the organic binder may facilitate dispersion and handling of the silica powder during printing and provide structural integrity to a green and/or intermediate part prior to post-processing. Following formation of the printed structure, one or more post-processing steps—such as debinding, heating, and/or sintering—may be performed to remove and/or decompose binder materials and other non-silica constituents (if present) and to densify and/or otherwise transform the glass component. A variety of organic binders may be used with glass powders for additive manufacturing, and the selection of a particular binder system may depend on factors such as the additive manufacturing technique employed (e.g., binder jetting, material extrusion, stereolithography), desired green strength, debinding behavior, sintering profile, and target material properties. By way of example and not limitation, suitable binder systems may include polymeric binders used in various additive manufacturing processes, polyvinylpyrrolidone (PVP)-based binders (e.g., in solvent systems—e.g., dissolved in an alcohol/water solution), and polyalkylene carbonates (e.g., QPAC®), including polypropylene carbonate (e.g., QPAC® 40) and polyethylene carbonate (e.g., QPAC® 25). Such binders may be selected for properties such as relatively low decomposition temperatures (e.g., 200-300° C.), clean burnout behavior, and reduced ash and/or residue formation, which may aid in reducing defects during debinding and sintering.

In some embodiments, the composition and processing of the binder system may be selected to influence the presence, concentration, and/or distribution of residual constituents within the resulting glass matrix, including residual carbon, hydroxyl groups, and/or trace metallic species, thereby enabling tuning of optical, thermal, and/or other functional properties of the formed glass component. In some embodiments, organic binders used in additive manufacturing of glass components may include reactive and/or preceramic polymer binders, such as silicone-based materials, which may undergo chemical transformation during post-processing. In such embodiments, a portion of the binder material may convert to a ceramic and/or glass-like residue (e.g., silica-based material) during heating and/or firing, thereby contributing to the structure and/or composition of the resulting glass and/or glass-ceramic component. Reactive binders may, in some implementations, improve mechanical integrity of intermediate and/or green parts, reduce fragility during handling and/or debinding, and/or contribute to bonding and/or densification during subsequent processing stages.

In some embodiments, photocurable binder systems may be used, particularly in photopolymerization-based additive manufacturing processes such as stereolithography. Such binder systems may include, by way of example and not limitation, acrylate-based monomers, oligomers, and/or polymers in combination with one or more photo-initiators, including radical and/or other photo-initiated curing systems. In these embodiments, glass powders and/or particulates may be dispersed within a liquid photocurable composition and selectively cured using light to form a three-dimensional structure prior to debinding and/or sintering.

In some embodiments, binder systems used in powder-based additive manufacturing processes, such as binder jetting, may include polymeric binders such as polyvinyl butyral (PVB), including embodiments in which powders are surface-treated to improve binder adhesion and/or dispersion. In other embodiments, natural, saccharide-based, and/or otherwise sacrificial binders may be used, including sugars, dextrins, maltodextrins, wheat dextrins, shellac, or combinations thereof. Such binders may be selected for one or more properties, including, without limitation, water solubility, low decomposition temperature, biodegradability, clean burnout behavior, or combinations thereof.

In certain embodiments, sacrificial and/or water-soluble binders may enable partial and/or staged debinding processes, including aqueous debinding steps performed prior to thermal debinding and/or sintering, thereby facilitating removal of non-glass constituents while maintaining structural integrity of fragile green and/or intermediate glass parts. As with other binder systems described herein, the selection and processing of such binders may be used to influence residual composition, microstructure, and functional properties of the resulting glass component.

In some embodiments, cellulose-based binders and cellulose derivatives, including ethyl cellulose and other cellulose materials, may be used as binding agents in additive manufacturing of glass components. Organic binders may facilitate formation of a green or intermediate part and subsequent debinding processes, in which binder material is removed or decomposed, for example through thermal treatment, solvent treatment, or combinations thereof, prior to or during sintering of a glass powder into a solid glass part or component. The selection of a binder system, whether organic, inorganic, or hybrid, may be based on one or more properties, including, without limitation, burnout cleanliness, decomposition temperature, gas evolution behavior, residue formation, viscosity, green strength, process compatibility, or combinations thereof. For example, in some embodiments, binders such as polyalkylene carbonates (e.g., QPAC-type materials) may be selected for their relatively complete and mild decomposition behavior, which may reduce gas formation during debinding and thereby mitigate cracking, distortion, or warpage in a formed glass part.

In certain embodiments, binder systems may be selected to leave minimal or substantially no carbon residue, for example when forming optically clear glass components. In other embodiments, a residual carbon phase may be intentionally retained or introduced within the glass matrix for one or more functional purposes, including, without limitation, electrical conductivity, electromagnetic or infrared radiation absorption, thermal management, or combinations thereof. The compatibility of binder properties with characteristics of a selected glass material and additive manufacturing process may also be considered. Such characteristics may include, by way of example and not limitation, glass particle size, particle size distribution, softening point, sintering behavior, viscosity, decomposition temperature, and interaction with the selected additive manufacturing technique. As described herein, additive manufacturing methods and binder systems may be used alone or in combination with, in conjunction with, and/or in sequence with other manufacturing methods and processes. The binder systems described herein are intended to serve as non-limiting examples, and it should be understood that other binding agents, whether presently known or later developed, may be used. Additionally, multiple binder systems may be used in combination within a single manufacturing process or across multiple processing stages to achieve desired structural, compositional, or functional characteristics of a resulting glass component.

In some embodiments, glass parts and/or components comprising glass may be formed using injection molding processes, including, without limitation, powder injection molding (PIM) processes and subsets thereof such as micro-powder injection molding (μPIM). Such processes may utilize feedstocks that combine characteristics of glass processing and polymer-assisted molding to enable formation of complex glass components with high dimensional precision. In certain embodiments, a composite feedstock material—sometimes referred to as a glass-polymer composite or “glassomer”—may be formed from a blend of glass material, such as silica or fused-silica nanoparticles, and one or more binder materials.

By way of example and not limitation, binder systems may include polymeric binders such as polyvinyl butyral, polyethylene glycol, or other suitable organic or hybrid binders. The composite feedstock may be formed into pellets or other feedstock formats compatible with injection molding equipment. During injection molding, the composite feedstock may be heated to a temperature sufficient to enable flow and molding (e.g., 130° C. or greater) without melting the glass material itself, thereby allowing the feedstock to be injected into a mold cavity to form a green or intermediate part having a desired geometry. Following molding, the formed part may undergo one or more debinding processes, including thermal treatment, solvent treatment, chemical treatment, or combinations thereof, to remove or modify binder materials. The debound part may then be subjected to sintering or other high-temperature processing temperature (e.g., 1300° C. or greater) sufficient to densify the glass material and form a fused-silica or silica-based glass component. Injection-molded glass components formed using such processes may exhibit high surface quality and may reduce or eliminate the need for subsequent polishing or finishing operations. Such processes may be used to produce components having complex external and/or internal geometries across micro-scale, meso-scale, or macro-scale dimensions. In some embodiments, injection molding processes may be used to form glass components including internal channels, cavities, or pathways, which may subsequently be metallized or otherwise processed to form embedded heater structures, conductive pathways, or other functional features.

The foregoing description of powder injection molding and related processes are intended to serve as non-limiting examples. It should be understood that injection molding processes for forming glass parts may vary in feedstock composition, processing temperatures, debinding methods, sintering profiles, and resulting material characteristics, and that such processes may be used alone or in combination with, in conjunction with, and/or in sequence with other manufacturing methods and processes described herein or otherwise known or later developed.

In the formation of composite feedstock materials comprising glass and one or more polymer binders for glass powder injection molding, the selection of binder components may include one or more polymeric, wax-based, or hybrid materials, including, without limitation, polyethylene glycol (PEG), polymethyl methacrylate (PMMA), polypropylene carbonate (PPC), paraffin wax, or combinations thereof. Such binder systems may be implemented as multi-component systems that further include one or more plasticizers, surfactants, dispersants, or other additives to achieve desired flow behavior, moldability, green strength, and dimensional stability of a molded part (sometimes referred to as a “green” part).

In certain embodiments, PEG may be selected as a component of a binder system for one or more properties, including, without limitation, water solubility, contribution to favorable rheological behavior, or facilitation of debinding through aqueous or staged debinding processes, or combinations thereof. In some embodiments, PMMA may be used alone or in combination with PEG or other binders to provide one or more properties, including, without limitation, structural integrity of the green part, dimensional stability during molding, or contribution to densification behavior during subsequent sintering, or combinations thereof.

In some embodiments, poly(alkylene carbonate) binders, including polypropylene carbonate and polyethylene carbonate (e.g., PPC- or PEC-type materials—e.g., respectively QPAC® 40 or QPAC® 25), may be used as components of binder systems for glass powder injection molding. Such materials may be selected for one or more properties, including, without limitation, relatively low decomposition temperatures (e.g., 220-340° C.), clean burnout behavior, reduced ash or residue formation, or combinations thereof, which may be advantageous in forming high-purity or optically sensitive glass components.

In some embodiments, wax-based binder components, including paraffin wax and other waxes, may be used as primary or secondary binder constituents, particularly in low-pressure injection molding (LPIM) processes. Wax-based systems may be selected to provide one or more properties, including, without limitation, thermoplastic behavior at relatively low processing temperatures, ease of molding, compatibility with specific glass powders, or facilitation of subsequent debinding and sintering processes.

In some embodiments, natural-derived or modified natural polymer binders may be used in composite feedstock materials for glass powder injection molding. Such binders may include, by way of example and not limitation, cellulose acetate butyrate (CAB), methylcellulose, or combinations thereof. In certain implementations, methylcellulose may be selected for one or more properties, including, without limitation, thermal gelation behavior that may reduce binder migration and/or or segregation during drying and/or early processing stages.

The binder materials described herein are intended to serve as non-limiting examples. It should be understood that binder systems used in glass powder injection molding may comprise mixtures of two or more of the described materials, as well as other polymers, waxes, additives, and/or compounds, whether presently known or later developed. Such materials may be selected and combined to achieve one or more desired properties or performance characteristics, or combinations thereof, in the formation, debinding, and/or sintering of glass components.

In certain embodiments, an interior surface of a fused-silica chamber body defining a vaporization chamber region may be intentionally structured to increase surface area relative to a smooth surface. Such surface structuring may be provided on one or more portions of the fused-silica chamber body that are configured to contact a liquid precursor and/or an aerosol formed therefrom, including portions of the fused-silica chamber body that oppose or are thermally coupled to a heater structure. Increasing the surface area of the interior surface may enhance heat transfer from the fused-silica chamber body to the liquid precursor, promote more uniform vaporization, increase residence time of the liquid precursor or aerosol within a heated region, and/or improve vaporization efficiency.

The surface structuring of the interior surface of the fused-silica chamber body may be formed during manufacturing of the fused-silica chamber body and/or as a post-formation process. In some embodiments, surface features are formed during shaping of a green part by providing one or more mold surfaces, mold inserts, or tooling features having a corresponding negative pattern such that, after debinding and sintering, the fused-silica chamber body comprises interior surface features defined by the mold. In other embodiments, the surface structuring is formed after densification of the fused-silica chamber body using one or more material-removal or surface-modification processes, including laser ablation, selective laser etching, laser texturing, or other localized energy-based processing techniques suitable for fused silica.

In some embodiment, the surface structuring may comprise a plurality of micro-scale or meso-scale features including, by way of example, ridges, grooves, pits, channels, protrusions, depressions, or combinations thereof, which may be arranged in regular, semi-regular, or irregular patterns. The surface features may be homogeneous across an interior surface region or heterogeneous across different regions of the fused-silica chamber body, and may be selected to influence liquid wetting behavior, capillary action, nucleation behavior, and/or thermal coupling between the fused-silica chamber body and the liquid precursor.

In some embodiments, powder injection molding may be used to form parts and/or components that are formed from multiple materials such as, for example, glass and metal, glass and metal and plastic, glass and metal and ceramic, or combinations of glass, metal, plastic, and ceramics. PIM when used for metal is also referred to as metal injection molding (MIM) (which also includes the subset of MIM sometimes referred to as micro-PIM (μPIM) or micro-MIM (μMIM)). In some embodiments, a multi-material composite part and/or component may be formed using one or more injection molding processes, including powder injection molding (PIM), to integrate a glass component with one or more heater elements and additional materials. In certain embodiments, a PIM-formed glass part, such as a fused-silica or silica-based glass component, may serve as a structural support, substrate, or housing for a heater element (e.g., heater 140) and may additionally define or partially define a chamber for vaporization or aerosol formation (e.g., chamber 130).

In some embodiments, a heater element comprising a conductive or resistive material may be formed using a second PIM process or other molding or deposition process. Such a heater element may include one or more surfaces, features, or interfaces configured to establish electrical connection, such as contact pads, terminals, or leads (e.g., electrical connections 506). The glass-heater assembly may subsequently be overmolded with one or more polymeric materials, including, without limitation, thermoplastic materials, to form additional device features such as dispensers, inlets, outlets, housings, and/or structural interfaces (e.g., using a Tritan copolymer to respectively form one or more of dispenser 120, inlet 150, and outlet 160).

In certain embodiments, the overmolded component may further be overmolded or otherwise combined with one or more elastomeric materials, including silicones or other sealing materials, to form sealing surfaces, gaskets, and/or interfaces configured to couple the composite component with other parts of a device, such as a reservoir, power module, control unit, and/or other assembly. Such multi-step molding and overmolding processes may be used to reduce part count, simplify assembly, improve alignment, improve sealing, and/or reduce manufacturing complexity of a finished vaporizing device. In some embodiments, a heating element may be formed using a powder injection molding process in conjunction with a powder injection molding process used to form a glass component, such that the heater element and the glass component are formed as an integrated or unitary structure.

By way of example and not limitation, a fused-silica or silica-based glass part may be formed using a PIM process, and a heater element comprising a metal or metal-based material may be formed using a separate and/or subsequent PIM process. In such embodiments, the heater material may be selected for one or more properties, including, without limitation, thermal stability, compatibility with sintering temperatures and atmospheres, electrical resistivity, mechanical robustness, or combinations thereof. In an example, the metal selected for the heater may have a similar melting point to that of the fused silica and/or capable of withstanding the required sintering temperature required to form the fused silica part. Suitable heater materials may include, by way of example and not limitation, nickel-chromium alloys, titanium-based materials, stainless steels, or alloys thereof.

In some embodiments, a multi-stage or multi-shot injection molding process may be employed, in which the glass component is formed in a first molding step and the heater material is subsequently molded, deposited, and/or otherwise formed onto and/or within one or more surfaces or regions of the glass component. Following molding, the integrated glass-heater structure may undergo one or more post-processing steps, such as debinding, sintering, annealing, and/or other treatments as described herein. The resulting integrated component, comprising glass and metal, may then serve as a substrate and/or core structure for subsequent overmolding with one or more thermoplastic and/or elastomeric materials using injection molding and/or other processes.

In some embodiments, the resulting component may comprise glass, metal, polymeric material, elastomeric material, or combinations thereof. The foregoing descriptions of multi-material injection molding and co-molding processes are intended to serve as non-limiting examples. It should be understood that other injection molding methods, material combinations, process sequences, and integration strategies—whether presently known or later developed—may be used, with or without one or more of the processes described herein, to form multi-material components comprising glass for use in vaporizing devices and related systems.

In embodiments in which a metallic heater is used in conjunction with a glass component that supports and/or houses the heater (e.g., heater 140), and in which one or both of the glass component and the heater are formed using powder injection molding (PIM) and/or metal injection molding (MIM) processes, a wide variety of metals and metal-based materials may be used. Such materials may be selected for one or more properties, including, without limitation, compatibility with PIM or MIM feedstocks, thermal stability during debinding, thermal stability during sintering, electrical resistivity/characteristics suitable for heating, oxidation resistance, corrosion resistance, mechanical robustness, coefficient of thermal expansion compatibility with glass materials, or combinations thereof.

By way of example and not limitation, suitable heater materials may include ferrous alloys such as stainless steels (including austenitic, martensitic, and precipitation-hardened grades), carbon steels, and tool steels; silicon-iron alloys, nickel-based materials and alloys, including nickel-chromium alloys, nickel-chromium-molybdenum alloys, nickel-copper alloys, nickel-iron alloys, nickel-cobalt alloys, and nickel-titanium alloys; titanium and titanium-based alloys; refractory metals and refractory-metal alloys, including tungsten-based materials; cobalt-based alloys; copper-based alloys; magnetic alloys; and precipitation-hardenable or superalloy materials. Examples of stainless steel include 316L, 17-4PH, and 420. Examples of tool steels include M2 and T15. Examples of nichrome alloys include nichrome 80/20 (80% nickel and 20% chromium) and nichrome 60/15 (composed of roughly 60% nickel, 15% chromium, and the remaining balance largely iron, usually around 24%). Examples of titanium alloys include Ti-6Al-4V (Grade 5) alloy, and other commercial pure (CP) titanium grades such as Grades 2, 3, 4, and specialized medical grades like Grade 23 (Ti-6A1-4V ELI). Examples of tungsten and tungsten alloys include pure tungsten as a powder, tungsten heavy alloys (WHAs) (e.g., W—Ni—Fe/Cu), tungsten-copper (W—Cu), and oxide dispersion strengthened tungsten (ODS-W). Examples of cobalt-based alloys include cobalt-chromium alloys. Examples of nickel-based superalloys include nickel-chromium (Inconel Family) alloys (e.g., Inconel 625 and Inconel 718), nickel-chromium-molybdenum (Hastelloy Family) alloys (e.g., Hastelloy C-276 and C-22), nickel-copper (Monel Family) alloys (e.g., Monel 400 and Monel K-500), nickel-iron (Incoloy/Invar Family) (e.g., Invar 36, Kovar, and Incoloy 800), nickel-cobalt alloys (e.g., Haynes 188 and Haynes 230), nickel-titanium alloys (e.g., Nitinol), wrought superalloys (e.g., Waspaloy and René 41), cast superalloys (e.g., single-crystal (SX) alloys such as CMSX-4 and René N5), precipitation-hardenable alloys (e.g., Nimonic 80A and Inconel X-750).

In some embodiments, precious metals or precious-metal-based alloys may be used, including, without limitation, platinum group metals such as platinum, palladium, rhodium, iridium, rhenium, and combinations and/or derivatives thereof, as well as gold, silver, or alloys comprising such materials. In some embodiments, heater materials may comprise wrought, cast, dispersion-strengthened, or composite metal systems, including materials configured for high-temperature operation, repeated thermal cycling, or controlled electrical resistance. Examples of precious metal alloys include Au—Rh and Pt—Rh.

The foregoing materials are intended to serve as non-limiting examples. It should be understood that other metals, alloys, or metal-based materials—whether presently known or later developed—may be used as heater materials in PIM- or MIM-formed glass-heater assemblies. Additionally, multiple metals or alloys may be used in combination within a single heater structure or across different regions of a heater to achieve one or more desired functional properties, or combinations thereof.

In some embodiments, a metal injection molding (MIM) process may be used to form a heater element (e.g., all or part of heater 140) and/or one or more electrical connections associated with the heater, such as electrical leads, terminals, or feedthroughs (e.g., all or part of electrical connections 506) configured to electrically couple the heater to a controller (e.g., controller 480) or power source. In such embodiments, MIM-formed metal components may be integrated with a glass component, such as a fused-silica or silica-based glass part, that supports, houses, or otherwise interfaces with the heater. In embodiments in which MIM processes are used to form heater elements and/or associated electrical connections, the selection of metal materials may be based on one or more properties, including, without limitation, compatibility with MIM processing, ability to bond or adhere to glass materials, coefficient of thermal expansion compatibility with glass, electrical conductivity or resistivity, thermal stability during processing and operation, oxidation behavior, or combinations thereof.

In some embodiments, metals or alloys having relatively low coefficients of thermal expansion, or coefficients of thermal expansion selected to mitigate thermal mismatch with glass materials, may be desirable for forming heater components and/or electrical connections. By way of example and not limitation, suitable materials may include metals or metal-based materials that are capable of forming interfacial bonds with glass materials through one or more mechanisms, such as oxide-mediated bonding, chemical interaction, diffusion, mechanical interlocking, or combinations thereof. In some embodiments, refractory metals such as molybdenum or tungsten, or compounds or intermetallics thereof (e.g., silicides), may be used for electrical connections, feedthroughs, or sealing regions, for example due to their thermal stability and compatibility with silica-based glasses.

In some embodiments, active metals such as titanium or zirconium, or alloys comprising such metals, may be used to promote bonding to fused silica or other glass compositions, including aluminum-silicate glasses. In an example, molybdenum (Mo) bonds well via a molybdenum oxide layer matching fused silica's thermal expansion. In another example, molybdenum intermetallic compounds such as, for example, molybdenum disilicide (MoSi₂). In another example, tungsten (W) may form oxide layers that bond well to fused silica. In another example, tungsten intermetallic compounds (e.g., tungsten disilicide—WSi₂) bond well to fused silica. In some examples, titanium (Ti) and/or zirconium (Zr) form strong seals with fused silica (and aluminum-silicate glasses) through surface treatment and heating. These may be combined with specific FeCrAl (kanthal) or NiCr (nichrome) alloys that may be used for the heating element itself.

In certain embodiments, heater structures may comprise multiple metal materials serving different functions. For example, a resistive heating element may comprise a nickel-chromium-based alloy or iron-chromium-aluminum-based alloy, while electrical leads, feedthroughs, or bonding interfaces may comprise a different metal selected to promote bonding or sealing to glass. Such configurations may employ intermediate bonding layers, brazed joints, solders, adhesives, or other attachment techniques, including active metal brazing or soldering, controlled oxidation processes, or other surface treatments, to couple heater elements to glass components without directly bonding the resistive heating material to the glass. Specialized bonding agents and/or techniques may be used for direct silica attachment such as, for example, active metal brazing/soldering for direct silica bonding, active solders with titanium or zirconium content (like S-Bond®) to react with silica, and sealing with direct sealing may involve controlled oxidation of the metal to form a glass-like layer (e.g., Mo-oxide, Zr-silicate) that matches the thermal expansion of fused silica. Such methods and processes may use a refractory metal (Mo, W) or active metal (Ti, Zr) for the electrical connections, feedthroughs, and/or sealing points of the heater, where the actual heating element is made of a kanthal and/or nichrome connected to these leads. This may involve often using an intermediate formed by brazing or specialized adhesives/solders rather than bonding the heating wire directly to the fused silica.

The foregoing materials, bonding mechanisms, and process configurations are intended to serve as non-limiting examples. It should be understood that other metals, alloys, bonding techniques, and integration strategies—whether presently known or later developed—may be used, alone or in combination, to form MIM-based heater assemblies and electrical connections integrated with glass components for use in vaporizing devices and related systems.

In some embodiments, metals or metal-based alloys having relatively low coefficients of thermal expansion may be selected for use in bonding, sealing, or interfacing with glass components, such as fused-silica or silica-based glass parts. By way of example and not limitation, nickel-iron-based alloys commonly referred to as Invar-type alloys may be used, including alloys comprising approximately 36% nickel-iron, which may be selected to mitigate thermal expansion mismatch between metal components and glass materials. In some embodiments, modified Invar-type alloys, including iron-nickel-cobalt-based alloys, may be selected to more closely match the thermal expansion behavior of specific glass compositions, such as fused silica or other low-expansion glasses. Related low-expansion alloys, including so-called Super Invar alloys and iron-nickel-cobalt alloys designed for glass sealing applications, may also be used. In some embodiments, alloys such as Kovar may be selected for applications involving borosilicate or aluminosilicate glass compositions.

In certain embodiments, metals such as silver or silver-based materials may be used in glass-metal interfaces, for example where interfacial reactions, compound formation, diffusion, or other interactions between the metal and the glass material may contribute to bonding or sealing. Such interactions may include, by way of example and not limitation, formation of metal-oxide or metal-silicate interfacial regions that promote adhesion or sealing to silica-based glass materials. Other examples that may be used are modified invars, such as inovco (Fe-33Ni-4.5Co), which are a variations of invar designed to match the expansion of fused silica more closely. In another example, silver (Ag) may be used to form the intermetallic compound silver silicate (Ag₂SiO₃) that binds to fused silica.

The foregoing metals and metal alloys are intended to serve as non-limiting examples. It should be understood that other metals, metal-based alloys, or combinations thereof—whether presently known or later developed—may be selected based on one or more properties, including, without limitation, thermal expansion compatibility, bonding behavior, processing compatibility, electrical or thermal performance, or combinations thereof, for use in glass-metal interfaces associated with heater assemblies and related components.

In some embodiments, a metal injection molding (MIM) process may be used to form a heater element (e.g., all or part of heater 140) and one or more associated electrical connections, contacts, or leads (e.g., all or part of electrical connections 506) configured to electrically couple the heater to a controller or power source (e.g., controller 480). In such embodiments, the heater element may comprise a resistive metal or metal-based material, and the electrical connections may be formed integrally with, or subsequently coupled to, the heater element.

In certain embodiments, a multi-shot or multi-stage injection molding process may be employed in which a MIM process is used to form a heater element and associated electrical connections, and a powder injection molding (PIM) process is used to form a glass component, such as a fused-silica or silica-based glass chamber, that is thermally, mechanically, and/or electrically coupled to the heater element. In such embodiments, at least one surface or region of the glass component may be formed in contact with, or subsequently brought into contact with, the heater element formed by the MIM process. The heater element, electrical connections, and glass component may be formed in separate molding steps, sequential molding steps, partially overlapping steps, or combinations thereof, depending on desired integration, material compatibility, and manufacturing considerations.

In some embodiments, a multi-shot or multi-stage injection molding process may be used in which a glass component, such as a fused-silica or silica-based glass chamber, is first formed using a powder injection molding (PIM) process, and a heater element is subsequently formed using a metal injection molding (MIM) process such that the heater element is formed on, within, or in contact with at least one surface or region of the glass component. In such embodiments, the MIM process may be used to form the heater element, associated electrical connections, and/or electrical contact features, where the heater element comprises a resistive metal or metal-based material. In certain embodiments, a composite part may be formed using a multi-shot injection molding process in which a glass-heater assembly formed using PIM and MIM processes serves as a substrate or core structure for subsequent molding operations. For example, the glass-heater assembly may be overmolded using a thermoplastic material, including, without limitation, a copolyester or other engineering thermoplastic (e.g., a Tritan copolymer), to form additional structural, fluidic, or interface features. Such overmolding processes may further be combined with elastomeric overmolding or sealing processes as described herein.

The foregoing multi-shot molding sequences and integration strategies are intended to serve as non-limiting examples. It should be understood that the order of formation, degree of integration, and specific molding sequences may be varied, combined, or rearranged, and that other manufacturing methods or process sequences—whether presently known or later developed—may be used to form integrated glass-heater components and assemblies.

In some embodiments, a composite part comprising a heater formed using a metal injection molding (MIM) process and a fused-silica or silica-based glass chamber formed using a powder injection molding (PIM) process may be used, at least in part, as a substrate for one or more subsequent injection molding operations. In certain embodiments, such subsequent injection molding operations may include overmolding with an elastomeric material, including, without limitation, silicone materials, to form sealing surfaces, gaskets, or interface features.

In some embodiments, a multi-shot injection molding process may be used in which the glass-heater composite part is first overmolded with a thermoplastic material, including, without limitation, an engineering thermoplastic, and subsequently overmolded with an elastomeric material such as silicone. Such overmolding steps may be performed to form structural features, fluidic interfaces, sealing regions, or combinations thereof, integrated with the glass-heater assembly. In some embodiments, a composite part may be constructed using a multi-shot injection molding process in which a glass-heater assembly formed using PIM and MIM processes serves as a substrate for forming a dispenser structure. For example, a thermoplastic overmolding process may be used to form a dispenser component having one or more inlets and one or more outlets, followed by overmolding with an elastomeric material, such as silicone, to seal the composite part into a vaporizer assembly. In such embodiments, elastomeric overmolding may additionally function to establish seals for the controlled flow of one or more fluids, including, without limitation, compressible fluids such as air, aerosol, or vapor, and incompressible fluids such as liquid precursor materials (e.g., precursor 103). The resulting composite component may thereby integrate heater functionality, chamber definition, fluid routing, and sealing features into a reduced number of parts.

In some embodiments, instead of using a sequence that includes powder injection molding followed by traditional injection molding, a multi-shot powder injection molding process may be employed to form a composite part comprising multiple material types. Such a composite part may comprise, by way of example and not limitation, glass, ceramic, metal, thermoplastic, elastomeric materials (including thermoplastic elastomers), or combinations thereof. In certain embodiments, a multi-shot PIM process may be used to first form a glass and/or metal component, which may then undergo one or more post-processing steps such as debinding or sintering. The resulting component may then serve as a substrate for subsequent PIM-based formation of additional material layers or regions, such as thermoplastic and elastomeric components, followed by further post-processing to produce a final composite part.

The methods and processes described herein for forming composite parts comprising one or more of a heater, heater electrical contacts, chamber, flow-directing features, and elastomeric sealing features are intended to serve as non-limiting examples. It should be understood that such methods and processes may be implemented using different combinations, variations, and sequences, and that individual functions may be combined into a single component or distributed across multiple components. Accordingly, composite components may be formed using one or more of the described processes, alone or in combination with other manufacturing techniques, to produce composite parts, subassemblies, or assemblies that integrate heating, fluid management, electrical interfacing, and sealing functions for use in vaporizing devices and related systems.

In some embodiments, it may be desirable to use powder injection molding (PIM) processes to form parts, components, and/or composite parts comprising ceramic materials. Such processes may be referred to as ceramic injection molding (CIM), and CIM is intended to include subsets thereof such as micro-ceramic injection molding (μCIM). CIM processes may utilize workflows analogous to other powder-based molding processes described herein (e.g., feedstock preparation, molding of a green and/or intermediate part, debinding, and sintering), and may be used alone or in combination with metal injection molding (MIM), glass powder injection molding, and/or other manufacturing processes described herein or otherwise known or later developed.

In some embodiments, a ceramic part, component, and/or composite part may be produced using CIM in place of a glass material (e.g., fused silica) for analogous structures, assemblies, and/or functions described herein. Ceramic materials suitable for CIM may include, by way of example and not limitation, alumina (Al₂O₃), zirconia (ZrO₂) (including yttria-stabilized zirconia such as, for example, 3Y-TZP), magnesia (MgO), silicon carbide (SiC), silicon nitride (Si₃N₄), porcelain, titania (TiO₂), chromia (Cr₂O₃), gadolinium-containing ceramics (e.g., gadolinium oxides), lanthanum-containing ceramics (e.g., lanthanum oxide La₂O₃), and other ceramic oxides, nitrides, carbides, or mixtures thereof.

The foregoing ceramic materials are intended to serve as non-limiting examples. It should be understood that other ceramic materials, ceramic compounds, composites, functionally graded ceramics, and/or mixtures of ceramics with one or more other materials (including, without limitation, metals, glasses, polymers, or combinations thereof) may be used in forming parts, components, and/or composite parts using one or more of CIM, MIM, PIM, and related processes, alone or in combination with, in conjunction with, and/or in sequence with other methods and processes described herein.

In some embodiments, binder systems used for ceramic injection molding (CIM) may comprise multi-component systems combining one or more polymers and one or more waxes, optionally together with one or more additives. Such binder systems may be selected based on one or more properties, including, without limitation, rheology and flow behavior during molding, green strength, dimensional stability, debinding behavior (e.g., thermal and/or solvent debinding), residue formation, compatibility with a selected ceramic powder, processing temperature window, or combinations thereof. By way of example and not limitation, polymeric binder components may include polyethylene (PE), polypropylene (PP), polyacetal (POM), poly(alkylene carbonates) (PAC) (e.g., polypropylene carbonate or polyethylene carbonate), thermoplastic elastomers, polyvinyl alcohol (PVA), methylcellulose (e.g., METHOCEL-type materials), and polyethylene oxide (PEO) polymers (e.g., POLYOX-type materials), or combinations thereof.

In some embodiments, wax components such as paraffin wax or other waxes may be used, for example to adjust viscosity (e.g., improve fluidity), improve mold filling, and/or influence (e.g., reduce) shrinkage behavior during debinding. In some embodiments, PAC-based binders may be selected for relatively clean burnout behavior and reduced ash or residue formation, which may be advantageous for certain ceramic materials (including, without limitation, alumina and silicon carbide). In some embodiments, PVA and methylcellulose (e.g., METHOCEL™) may provide binding and gelling for improved stability of the part pre-debinding and stability during the debinding process. In some embodiment, polyethylene oxide (PEO) polymers (e.g., POLYOX™) are example thermoplastic binders and lubricant additives that may be used in CIM processes. Multi-component systems may be used as the combination of components (e.g., wax combined with a polymer backbone combined with additional additives) may be helpful for achieving the desired flow, “green” part (i.e., the molded part prior to debinding and sintering) strength, and clean removal of the binder component(s). Example multi-component systems are available commercially as, for example, in TENAC™ binders.

In some embodiments, binder systems may further include one or more plasticizers, lubricants, surfactants, dispersants, and/or other additives, and/or may be configured as water-based systems utilizing one or more water-soluble polymers (e.g., PVA and/or methylcellulose) to enable aqueous or staged debinding. Multi-component systems may be used to achieve a desired balance of molding performance, green-part integrity, and/or debinding, and/or sintering outcomes. Commercial binder systems (e.g., TENAC-type binders) may be used in certain implementations.

The foregoing binder materials and systems are intended to serve as non-limiting examples. It should be understood that other binders, additives, mixtures, and/or multi-component systems—whether presently known or later developed—may be utilized, alone or in combination, to facilitate and optimize CIM processes for forming parts, components, and/or composite parts as described herein.

In some embodiments, a metal injection molding (MIM) process may be used to form a heater element and/or one or more associated electrical connections, contacts, terminals, leads, or feedthroughs configured to electrically couple the heater to a controller or power source. In such embodiments, the heater element may comprise a resistive metal or metal-based material. In some embodiments, a multi-shot or multi-stage process may be used to integrate MIM-formed heater structures with a ceramic chamber formed using ceramic injection molding (CIM). For example, a MIM process may be used to form a heater element and associated electrical connection features, and a CIM process may then be used to form a ceramic chamber such that at least one surface or region of the ceramic chamber is formed in contact with, or subsequently brought into contact with, the heater element. In other embodiments, a CIM process may be used to form a ceramic chamber, and a subsequent MIM process may be used to form a heater element and associated electrical connection features on, within, or in contact with at least one surface or region of the ceramic chamber. The heater element, electrical connection features, and ceramic chamber may be formed in separate molding steps, sequential molding steps, partially overlapping steps, or combinations thereof, depending on one or more factors including, without limitation, material compatibility, dimensional tolerances, bonding strategy, thermal requirements, electrical requirements, manufacturability, or combinations thereof.

In some embodiments, a composite part comprising a heater formed using a MIM process and a ceramic chamber formed using a CIM process may be used, at least in part, as a substrate for one or more subsequent molding operations. In certain embodiments, such subsequent molding operations may include overmolding with a thermoplastic material, including, without limitation, an engineering thermoplastic, to form structural features, fluidic interfaces, housings, dispensers, or combinations thereof. In some embodiments, such subsequent molding operations may additionally or alternatively include overmolding with an elastomeric material, including, without limitation, silicone materials, to form sealing surfaces, gaskets, interface features, or combinations thereof.

In some embodiments, a multi-shot overmolding process may be used in which the ceramic-heater assembly is overmolded with a thermoplastic to form a dispenser component having one or more inlets and one or more outlets and is subsequently overmolded with an elastomeric material to seal the composite part into a vaporizer assembly. In such embodiments, elastomeric sealing features may be configured to establish seals for controlled flow of one or more fluids, including, without limitation, compressible fluids such as air, aerosol, or vapor, and incompressible fluids such as liquid precursor materials.

The foregoing overmolding configurations are intended to serve as non-limiting examples. It should be understood that other materials, molding sequences, and integration strategies—whether presently known or later developed—may be used, alone or in combination, to integrate ceramic chambers, heater structures, electrical interfaces, fluid-routing features, and sealing features into composite components for use in vaporizing devices and related systems.

In some embodiments, a ceramic injection molding (CIM) process and/or other molding or forming processes may be used to produce a ceramic part having spatially variable density, composition, microstructure, or combinations thereof, such that a heater is physically and chemically isolated from all fluid flow through the device. Such a ceramic part may comprise, for example, a chamber configured for vaporization or aerosol generation, wherein a heater is thermally coupled to the chamber but cannot physically contact, chemically interact with, or be exposed to any precursor material, aerosol, vapor, or gas flowing through the chamber. In such embodiments, regions of the ceramic chamber adjacent to the heater may be formed as dense, substantially non-porous ceramic regions comprising one or more thermally conductive ceramic materials, including, without limitation, aluminum nitride (AlN), silicon carbide (SiC), or other ceramics selected for high thermal conductivity, chemical inertness, and/or impermeability to liquids and gases. These dense ceramic regions may form a continuous barrier between the heater and the chamber interior such that no portion of the heater, and no constituent or degradation product of the heater, can enter the fluid flow path under either operating conditions or inactive conditions.

In certain embodiments, the ceramic chamber may be formed using a multi-shot or multi-stage PIM, MIM, and/or CIM process such that the heater is partially or completely encapsulated within the dense ceramic material. The heater may comprise a metal or metal-based resistive element and may be formed as a discrete component that is used as an insert during ceramic molding, or may be formed in a first MIM step and subsequently overmolded, embedded, or encapsulated during a CIM step. In either case, the resulting structure forms a sealed ceramic barrier that prevents any direct or indirect interaction between the heater and fluids passing through the device. In such embodiments, the ceramic barrier is configured such that the precursor liquid, aerosol, vapor, and/or gas cannot contact the heater surface, and such that thermal degradation products associated with metal-fluid contact—including metal particulates, metal ions, and thermally generated chemical species—cannot be formed as a result of fluid exposure to the heater. In such embodiments, the metal heater component is at least partially encapsulated by the dense ceramic of the chamber part such that the metal heater components cannot interact with the fluid flow (i.e., the flows of air, aerosol, vapor, precursor liquid, and/or precursor compound) through the device and such that any elements and/or constituents of the metal heater that may be released or mobilized from the heater (whether when activated or inactive) are isolated from the fluid flow, wherein the dense ceramic component may serve to trap or otherwise capture and contain the metal heater and any constituents or elements of the metal heater that may be mobilized or otherwise disengage and/or dissociate from the metal heater component. In an embodiment, thermal energy generated by the heater may be transferred to the chamber and to the precursor via solid-state conduction across the ceramic material, rather than through direct metal-fluid contact.

In some embodiments, the ceramic chamber may include regions of differing density or porosity away from the heater interface, for example to control thermal gradients, mechanical compliance, or manufacturability, while maintaining a fully dense, impermeable ceramic barrier in regions separating the heater from the fluid flow path. The resulting structure may provide physical isolation of the heater from the precursor and vapor flow while enabling efficient heating of the chamber. In some embodiments, powder-based molding processes, including powder injection molding (PIM) and related injection molding processes, may be used to form one or more heater elements and/or heater-associated structures using carbon-containing materials, carbon-based composites, carbide-based materials, or combinations thereof. Such processes may be used to form a heater element as a discrete part and/or component, and/or to form a heater element as a portion of a composite part, for example as an insert, embedded element, or co-molded region. By way of example and not limitation, carbon-containing materials that may be used to form heater elements and/or heater-associated structures may include graphite or other carbon powders, carbon black, graphene, reduced graphene oxide, and other carbonaceous materials, alone or as fillers within a binder system or composite feedstock. In an embodiment, carbonyl iron powder may be used.

In some embodiments, carbide-based materials and/or cermet materials may be used for heater elements or heater-associated structures, including, without limitation, tungsten carbide-based materials, optionally with one or more binder phases (e.g., cobalt- or other metal-based binder phases), and other carbide or carbon-containing ceramic-metal composite systems.

In some embodiments, such materials may be processed using micro-scale powder molding processes (e.g., micro-PIM) to form small, durable heater structures. As described herein, heater elements formed using powder-based molding processes may be integrated into composite components using multi-shot or multi-stage PIM, MIM, and/or CIM processes to form composite parts comprising multiple materials, including, without limitation, glass, ceramic, metal, polymeric materials, elastomeric materials (including silicones and/or thermoplastic elastomers), or combinations thereof. In some embodiments, a powder-molded heater element or heater subassembly may subsequently serve as a substrate for additional processing steps, including overmolding using traditional injection molding processes, to form composite parts that integrate structural, electrical, thermal, fluidic, and sealing features.

In some embodiments, heater elements, heater support structures, functional portions of heater elements, and/or assemblies containing heater elements may comprise carbon-based materials, including nanostructured carbon materials, carbon films, carbon composites, or combinations thereof. Such materials may be selected for one or more properties, including, without limitation, electrical resistivity suitable for heating, thermal stability, rapid thermal response, mechanical durability, chemical stability, manufacturability at micro-scale dimensions, compatibility with a selected process flow, or combinations thereof. By way of example and not limitation, carbon-based materials may include carbon nanotubes (CNTs), including aligned or superaligned CNT films; graphene and reduced graphene oxide (rGO) films; laser-induced graphene (LIG); carbon nanofibers (CNFs), including porous CNF structures (e.g., formed by carbonization of polymer-derived precursors); carbon black (CB) (e.g., as a conductive and/or absorptive filler in composite materials); graphite and graphite nanoplatelets (e.g., as fillers to increase thermal conductivity or tailor electrical properties); and amorphous carbon or pyrolytic carbon, including carbon materials suitable for high-temperature stability or micro-scale heater fabrication. Such materials may be used alone or in composite form, including as coatings, films, patterned traces, porous heater bodies, or embedded functional regions within a larger molded or assembled component.

In some embodiments, carbon-based heater elements, carbon-filled heater regions, and/or carbon structures (e.g., conductors) may be embedded behind an impermeable glass or ceramic barrier such that the heater cannot contact or interact with fluids, aerosols, and/or vapors flowing through the device. In some embodiments, carbon-based materials and carbon-filled composite materials (including those described herein for heater elements, heater-associated structures, and/or composite parts) may be formed using one or more injection molding processes and injection molding variants. Such processes may be selected to achieve one or more desired properties, including, without limitation, electrical conductivity or resistivity suitable for heating, anisotropic conductivity, thermal conductivity, structural reinforcement, fiber or nanotube orientation, reduced residual stress, dimensional stability, electromagnetic interference (EMI) behavior, manufacturability at micro-scale dimensions, or combinations thereof. By way of example and not limitation, suitable injection molding processes and variants may include shear-controlled alignment processes (e.g., in which shear conditions during molding are controlled to promote alignment of carbonaceous fillers—e.g., multi-walled carbon nanotubes—along a flow direction of the injection into the mold creating ordered microfibrils); segregated-structure molding approaches (e.g., in which conductive networks are formed—e.g., by molding polymer feedstocks having CNT-coated pellets to from structured conductive pathways); carbon-fiber-reinforced thermoplastic (CFRTP) injection molding (e.g., using short- or long-carbon fiber reinforced feedstocks—e.g., Nylon, PEEK, PPS, ABS with carbon fibers of e.g., 4-6 mm); bulk molding compound (BMC) (e.g., molding using thermoset-based composite compounds comprising resin, chopped fibers, and/or fillers—e.g., using epoxy or vinyl ester); injection-compression molding (ICM) (e.g., where the compound is injected into a partially open mold, which then closes, compressing the material to fill the entire cavity to, e.g., reduce shear, promote fiber orientation, increase tensile strength, promote structural integrity, and/or reduce fiber breakage for difficult-to-flow carbon-filled materials); micro-injection molding (e.g., to form relatively small or intricate carbon-composite parts—e.g., by using small-scale injection molding machines to process carbon fiber reinforced thermoplastics—e.g., carbon fiber reinforced polymer—CFRP—with polymethyl methacrylate—PMMA—also referred to as CFRP/PMMA); and multi-material molding and/or overmolding processes (e.g., overmolding with carbon compounds to localize carbon-filled regions for strength, conductivity, heating, or combinations thereof).

In some embodiments, reactive molding processes such as reaction injection molding (RIM) may be used with carbon-based composites (e.g., where reactive liquid components are mixed proximate to injection and cure within a mold). In some embodiments, gas- or liquid-assisted injection molding processes (e.g., gas injection molding or liquid injection molding) may be used, for example to form hollow or partially hollow structures and/or to influence flow, packing, or internal geometry of carbon-reinforced molded components.

The foregoing processes are intended to serve as non-limiting examples, and other injection molding techniques and variants—whether presently known or later developed—may be used. The carbon-based materials and carbon-composite materials described herein for forming parts, components, assemblies, and/or composite parts—including, without limitation, heating elements, heater-associated structures, and components that comprise or support a heater—are intended to serve as non-limiting examples. It should be understood that other carbon-based materials, carbon-containing materials, and/or composite materials, whether presently known or later developed, may be used.

In some embodiments, carbon-based materials may be used as a portion of, or functional region within, a part or composite part that additionally comprises one or more other materials, including, without limitation, glass, ceramic, metal, thermoplastic materials, elastomeric materials, or combinations thereof. Such multi-material components may be configured to provide structural support, electrical functionality, thermal functionality, heating functionality, or combinations thereof. Additionally, the methods and processes described herein for forming carbon-based or carbon-composite parts may be used alone or in combination with, in conjunction with, and/or in sequence with other methods described herein for forming parts, components, and/or composite parts comprising glass, ceramic, metal, thermoplastic materials, elastomeric materials, or combinations thereof, to produce integrated components and assemblies for use in vaporizing devices and related systems.

In some embodiments, a heater element and/or one or more heater electrical contacts, terminals, leads, traces, or other electrical features may be formed directly onto a part or component, such as a chamber or chamber wall comprising fused silica or other silica-based glass. In such embodiments, the fused-silica part may serve as a substrate for a high-resolution additive manufacturing or direct-write deposition process configured to deposit conductive and/or resistive material onto the substrate to form two-dimensional (2D) and/or three-dimensional (3D) heater structures and associated electrical interconnect features. By way of example and not limitation, such deposition processes may include nanoparticle-based jetting or aerosol-based deposition processes (sometimes referred to as nanoparticle jetting, aerosol jet printing, or related direct-write printing techniques—for brevity, these processes may be referred to collectively herein as using the term nanoparticle-based jetting or NPJ unless the context clearly indicates otherwise) in which a liquid suspension comprising metallic or other functional particles (e.g., from 1-100 nm) may be deposited onto the fused-silica substrate to form patterned features.

In some embodiments, such printed heater structures and/or electrical features may be formed on a surface of the fused-silica component that is not exposed to fluid flow within the device, such that the heater cannot contact or interact with precursor liquid, aerosol, vapor, or other fluids, while thermal energy is transferred to the chamber through solid-state conduction across the fused-silica wall. In an embodiment, NPJ may offer higher precision, lower surface roughness, and may be capable of building more complex geometries directly onto a part and/or component used as a substrate than powder-bed metal printing processes described herein.

In some embodiments, nanoparticle-based jetting, aerosol jet printing, and/or related direct-write additive manufacturing methods may deposit material layer-by-layer (e.g., 1-10 μm layers) onto a substrate using inks or suspensions that comprise one or more functional materials, including, without limitation, metals, metal alloys, conductive materials, resistive materials, semiconductive materials, ceramic materials, glass materials, carbon-based materials, cermets, conductive polymers, or combinations thereof, dispersed in one or more carrier liquids and/or binder systems. In an embodiment, dual material jetting may be used (e.g., where two aerosol/droplet/particle dispersal systems are utilized: one for the metal nanoparticles that will form the part or component, and the other one for a soluble support material.) Deposited materials may be formulated to provide target electrical properties for heater formation, including, without limitation, a selected sheet resistance, bulk resistivity, power density, temperature coefficient of resistance, stability under thermal cycling, or combinations thereof. By way of example and not limitation, conductive and/or resistive inks may include metal-containing inks (e.g., silver-, copper-, gold-, nickel-, platinum-, or other metal-containing inks); carbon-based inks or suspensions (e.g., graphite, graphene, reduced graphene oxide, carbon black, carbon nanotube dispersions, laser-induced graphene precursors, or combinations thereof); and ceramic or semiconductive inks (e.g., silicon carbide, titanium nitride, tungsten carbide, molybdenum silicide, tungsten silicide, doped silicon-containing inks, conductive ceramic composites, or combinations thereof).

In some embodiments, cermet inks or composite inks may be used, including inks comprising ceramic particles with conductive or resistive phases, to provide desired electrical and thermal behavior. In some embodiments, the deposition system may utilize one or more nozzles, jets, or printheads, optionally in combination with one or more additional deposition systems for a removable or sacrificial support material, thereby enabling formation of complex geometries, overhangs, or freestanding features. In some embodiments, the substrate and/or deposited material may be heated (e.g., 300° C. or greater) during printing and/or may be subjected to one or more post-deposition processing steps, including, without limitation, drying, solvent removal, thermal curing, photonic curing, laser sintering, furnace sintering, reduction/oxidation treatments, carbothermal conversion, pyrolysis, or combinations thereof, to remove carrier materials (if present), to densify or sinter deposited particles, and/or to achieve desired electrical, thermal, mechanical, and/or adhesion characteristics.

In some embodiments, one or more interfacial layers, adhesion layers, diffusion barriers, passivation layers, or encapsulation layers may be formed between and/or over the deposited heater features and the fused-silica substrate to improve bonding, reduce delamination, control interdiffusion, provide electrical isolation where desired, and/or enhance environmental and/or chemical resistance.

The foregoing parameters, materials, and process configurations are intended to serve as non-limiting examples, and other direct-write deposition techniques and process variants—whether presently known or later developed—may be used.

In some embodiments, where a heater element, heater system, and/or associated electrical contacts are formed with a three-dimensional geometry, one or more removable or sacrificial support materials may be utilized during formation to support overhangs, voids, internal features, or complex architectures. Such support materials may be configured to occupy gaps or cavities during deposition or molding and may be removed after formation of a green or intermediate part. In some embodiments, the support material may be removed by a post-processing step, including, without limitation, chemical dissolution, solvent treatment, thermal decomposition, or combinations thereof. By way of example and not limitation, a support material may be configured to dissolve in an aqueous or acidic solution (e.g., citric acid). Following removal of the support material, the green part may undergo one or more additional post-formation processing steps while still being held together by a binder or carrier phase. In some embodiments, the formed heater element and/or electrical features may subsequently be subjected to a densification or consolidation process, including, without limitation, thermal sintering, furnace processing, laser processing, photonic curing, or combinations thereof, to fuse deposited particles or material phases and to form a final solidified heater component or structure having desired electrical, thermal, and mechanical properties.

In some embodiments, direct-write additive manufacturing processes, including nanoparticle jetting, aerosol jet printing, and related deposition techniques, may be selected for forming heater elements and/or heater-associated electrical features where relatively fine feature sizes or high spatial resolution are desired. Such processes may be suitable for forming patterned heater traces, contacts, interconnects, or three-dimensional heater structures on a substrate, including fused-silica or other glass or ceramic components. In some embodiments, such direct-write processes may be capable of forming features having characteristic dimensions on the order of micrometers or smaller. Resolution and feature fidelity may be influenced by one or more process parameters, including, without limitation, nozzle geometry, particle size distribution, carrier fluid properties, deposition rate, substrate temperature, gas flow conditions, or combinations thereof.

In some embodiments, resolution-enhancement techniques may be employed to further reduce feature size or improve pattern definition. In some embodiments, resolution-enhancement techniques for direct-write deposition processes (e.g., NPJ) may include aerodynamic focusing, hydrodynamic focusing, or combinations thereof. In aerodynamic focusing implementations, a particle-laden flow may be conveyed through one or more constricted regions, such as orifices or nozzles, optionally preceded and/or followed by contraction and expansion regions, to concentrate particles toward a flow axis and to reduce the effective cross-sectional area of the particle stream.

In some embodiments, hydrodynamic focusing may be employed, for example by surrounding a particle-containing flow with one or more sheath flows, such as gas or fluid flows, that constrain and narrow the particle stream. The degree of focusing may be adjusted by controlling one or more flow parameters, including, without limitation, relative flow rates, pressure differentials, nozzle geometry, or combinations thereof. Such focusing techniques may be used alone or in combination to improve feature resolution, line width control, or deposition precision in forming heater elements and/or associated electrical structures.

The foregoing focusing techniques are intended to serve as non-limiting examples, and other particle-focusing, beam-shaping, or flow-control approaches—whether presently known or later developed—may be employed to achieve desired deposition characteristics.

In some embodiments, a composite part may be formed that comprises a chamber component formed using a powder injection molding (PIM) process and a heater element formed using a direct-write additive manufacturing process. In certain embodiments, the chamber component may comprise fused silica or another silica-based glass, and the fused-silica chamber may serve as a structural support and/or substrate for formation of the heater element. In some embodiments, the heater element and/or associated electrical features may be formed at least in part by depositing one or more conductive or resistive materials onto the fused-silica chamber using a nanoparticle-based jetting process or a related direct-write deposition technique. By way of example and not limitation, such deposited materials may include silver-, platinum-, or other metal-containing materials, as well as other conductive, resistive, or functional materials described herein. The deposited heater element may be formed as a two-dimensional or three-dimensional structure, including patterned traces, films, or volumetric features, and may be positioned on, within, or adjacent to the chamber component.

It should be understood that the additive manufacturing processes described herein for forming heater elements and/or heater electrical contacts using nanoparticle jetting and related techniques are intended to serve as non-limiting examples. Such processes may be referred to by different nomenclature or terminology and may include other direct-write, aerosol-based, ink-based, or particle-based deposition processes that are functionally equivalent to those described herein. Furthermore, it should be understood that nanoparticle jetting and related additive manufacturing processes may be used alone or in combination with, in conjunction with, and/or in sequence with other manufacturing processes described herein, including, without limitation, PIM, MIM, CIM, traditional injection molding, overmolding, and post-processing techniques. Such processes may be used to form a part, component, or element of a composite part comprising one or more materials, including, without limitation, glass, metal, ceramic, carbon-based materials, thermoplastic materials, elastomeric materials, or combinations thereof.

In some embodiments, a heater element and/or one or more heater electrical contacts, terminals, leads, or interconnect features may be formed directly onto a part or component comprising fused silica or another glass material, wherein the glass part serves as a substrate for a high-resolution additive manufacturing or direct-write deposition process. By way of example and not limitation, such processes may include electrohydrodynamic (EHD) printing and related electrically assisted deposition techniques. In some embodiments, EHD printing may be used to deposit conductive, resistive, or functional inks onto a glass substrate to form heater structures and/or associated electrical features. Such inks may include, by way of example and not limitation, metal-based inks (e.g., inks comprising silver nanoparticles, silver nanowires, or other conductive metal materials), carbon-based inks, ceramic or cermet inks, semiconductive inks, or combinations thereof. In some embodiments, an electric field applied between a deposition nozzle and a reference electrode associated with the substrate or a support structure may be used to generate a stable, focused jet of ink, enabling formation of features having dimensions smaller than the nozzle diameter. In some embodiments, EHD printing or related direct-write processes may be used to form a selected heater geometry, including, without limitation, annular patterns, serpentine patterns, grid patterns, box-type patterns, or other two-dimensional or three-dimensional geometries suitable for forming a resistive heating path. Such patterns may be configured to generate heat through resistive (Joule) heating when energized.

In some embodiments, the substrate surface may undergo one or more preparation steps prior to deposition, including, without limitation, cleaning, surface-energy modification, application of adhesion-promoting layers, or combinations thereof, to improve feature definition, line-width control, and/or adhesion of deposited material. Following deposition, the printed heater structure and/or electrical features may be subjected to one or more post-deposition processing steps, including, without limitation, thermal sintering, photonic curing, laser processing, furnace processing, or combinations thereof, to remove carrier materials (if present), to densify deposited material, and/or to achieve desired electrical and/or mechanical properties.

In some embodiments, the glass substrate may be particularly suitable for such post-processing due to its ability to withstand elevated temperatures and prolonged heating cycles. In some embodiments, the heater structure may optionally be covered, encapsulated, or over-coated with one or more insulating, dielectric, protective, or stabilizing layers, including, without limitation, polymeric materials (e.g., polydimethylsiloxane—PDMS), elastomeric materials, ceramic materials, or glass materials, to provide mechanical protection, electrical isolation, environmental resistance, or combinations thereof.

In some embodiments, a fused-silica part or component may serve as the substrate for EHD printing or related direct-write deposition processes such that the resulting composite part includes a heater formed on or within the substrate. In such embodiments, the fused-silica part may function as the deposition substrate during heater formation, subsequently function as a structural support for the heater, and may further function as at least a portion of a chamber or other functional component of a vaporizing device.

It should be understood that materials other than fused silica may also be used as substrates for EHD printing and related processes. By way of example and not limitation, suitable substrates may include other glass materials (e.g., quartz glass, borosilicate glass), ceramic materials, glass-ceramic materials, metal-glass composite materials, or other materials described herein.

The foregoing materials, processes, and configurations are intended to serve as non-limiting examples, and other substrates, materials, and equivalent deposition techniques—whether presently known or later developed—may be used alone or in combination for forming heater elements and/or associated electrical features.

In some embodiments, a heater element and/or associated heater electrical contacts may be formed using metal-organic decomposition (MOD) or related solution-based precursor deposition processes, wherein a glass material, such as fused silica or another silica-based glass, serves as a substrate and/or support for heater formation. MOD processes may be used to form thin-film, patterned, and/or layered heater structures comprising one or more functional materials, including, without limitation, metals, metal oxides, ceramic materials, semiconductive materials, or combinations thereof. In some embodiments, MOD processes may involve depositing a liquid precursor composition onto a substrate, wherein the precursor composition comprises one or more metal-organic, organometallic, and/or metal-containing compounds dissolved and/or dispersed in one or more carrier liquids and/or solvents, optionally together with stabilizers, binders, and/or additives. The precursor composition may be applied to the substrate using one or more deposition and/or coating techniques, including, without limitation, spin coating, dip coating, inkjet printing, spray coating, meniscus coating, or combinations thereof.

In some embodiments, inkjet printing or other digitally controlled deposition techniques may be used to deposit MOD precursor solutions and/or inks in a patterned manner. Such MOD-based inkjet printing may enable formation of fine-line conductive or resistive features by selectively depositing liquid precursor compositions that are subsequently converted into solid heater structures through thermal, photonic, and/or chemical processing. Because MOD inks may comprise dissolved precursor compounds rather than solid nanoparticles, such techniques may enable relatively uniform, particle-free films and/or traces on substrates including glass materials, such as fused silica.

In some embodiments, following deposition of the MOD precursor composition, the substrate and deposited material may undergo one or more post-deposition processing steps to decompose the precursor compounds and to form a solid heater structure and/or electrical features. Such post-processing may include, without limitation, heating, baking, annealing, furnace sintering, laser processing, photonic curing, or combinations thereof, whereby organic components of the precursor are removed and a metal, metal oxide, or other functional film remains. In some embodiments, MOD precursor compositions may comprise one or more metal-containing compounds selected to provide desired electrical, thermal, chemical, and/or mechanical properties for heater formation. By way of example and not limitation, such precursor compositions may include silver-based compounds, copper-based compounds, gold-based compounds, nickel-based compounds, platinum-based compounds or combinations thereof.

It should be understood that other metals, metal oxides, alloys, and/or combinations of materials may be used in MOD precursor solutions and/or inks, and that material selection may be based on one or more properties including, without limitation, electrical resistivity, stability, cost, oxidation behavior, processing compatibility, or combinations thereof.

The foregoing description of metal-organic decomposition and related solution-based deposition techniques is intended to serve as a non-limiting example. It should be understood that MOD and functionally equivalent precursor-based processes—whether presently known or later developed—may be used alone or in combination with, in conjunction with, and/or in sequence with other manufacturing processes described herein, including direct-write printing, powder-based molding, traditional injection molding, overmolding, and post-processing techniques, to form heater elements and composite parts comprising glass, ceramic, metal, carbon-based materials, polymers, elastomers, or combinations thereof.

In some embodiments, a composite part may be formed that comprises a chamber component formed using a metal-organic decomposition (MOD) solution and/or MOD ink deposition process and a heater element formed using a MOD solution and/or MOD ink deposition process, wherein the chamber component also serves as a structural support and/or substrate for formation of the heater element. In certain embodiments, the chamber component may comprise fused silica or another silica-based glass, and the heater element and/or associated electrical features may be formed at least in part by depositing one or more conductive or resistive materials onto the chamber component using a MOD-based deposition process. By way of example and not limitation, MOD precursor solutions or inks used to form the heater element may comprise silver-based, platinum-based, or other metal-containing compounds, as well as other functional materials described herein. In some embodiments, the heater element may be formed as a thin film, patterned region, trace, multi-layer structure, or other geometry on or within the chamber component.

It should be understood that materials other than glass may also be used as the substrate for MOD-based deposition. For example, ceramic materials, glass-ceramic materials, or ceramic-metal composite materials such as those described herein may be used as the chamber component and/or heater substrate instead of fused silica. It should also be understood that the methods and processes described herein for forming parts and/or components using MOD solutions and/or MOD inks are intended to serve as non-limiting examples. Such processes may be referred to by different nomenclature or terminology while remaining functionally equivalent to the methods and processes described herein.

Additionally, MOD-based deposition processes and related, similar, or equivalent processes, whether presently known or later developed, may be used alone or in combination with, in conjunction with, and/or in sequence with other manufacturing processes described herein for forming parts, components, or elements of composite parts comprising one or more materials, including, without limitation, glass, ceramic, metal, carbon-based materials, thermoplastic materials, elastomeric materials, or combinations thereof.

In some embodiments, heater elements and/or associated heater electrical connections may be formed on a glass substrate, such as fused silica or another silica-based glass, using photolithography and thin-film deposition techniques. Such methods may be used to form high-precision, patterned heater structures and electrical features, including thin-film resistive heaters, interconnects, and contact regions.

In some embodiments, a thin film comprising one or more functional materials may be deposited onto the glass substrate using a deposition technique including, without limitation, physical vapor deposition (PVD), chemical vapor deposition (CVD), atomic layer deposition (ALD), sputtering, evaporation, or combinations thereof. The deposited film may comprise one or more conductive or resistive materials, including, without limitation, metals, metal alloys, metal nitrides, metal oxides, semiconductive materials, or combinations thereof. Following deposition, photolithographic patterning may be used to define a desired heater geometry, after which excess material may be removed using etching, lift-off, or other subtractive processes.

In some embodiments, one or more adhesion layers, diffusion barrier layers, or intermediate layers may be formed between the glass substrate and the heater film to improve adhesion, structural stability, thermal stress resistance, and/or long-term reliability. By way of example and not limitation, adhesion or intermediate layers may comprise chromium-based materials, titanium-based materials, nitrides, oxides, or combinations thereof. In some embodiments, the heater structure may comprise a multilayer stack, for example including alternating conductive, resistive, adhesion, and/or barrier layers, configured to enhance mechanical robustness, electrical performance, and resistance to thermal cycling. One non-limiting example of a multilayer stack that may be constructed comprises the following layers of Cr/CrN/Pt/CrN/Cr. In some embodiments, the heater formed using photolithography and thin-film deposition may be formed as a two-dimensional or three-dimensional patterned structure on or within the glass substrate and may be used alone or in combination with other heater-formation methods described herein.

The foregoing photolithographic and thin-film processes are intended to serve as non-limiting examples, and it should be understood that other microfabrication, thin-film patterning, and material-deposition techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using physical vapor deposition (PVD), sputtering, or related vacuum-based thin-film deposition techniques. Such processes may be used to form thin-film heater structures, patterned resistive regions, interconnects, or multilayer stacks on or within a glass component that serves as a substrate and/or support for the heater. In some embodiments, PVD processes may involve vaporizing a source material and depositing the vaporized material onto a glass substrate to form a solid thin film. By way of example and not limitation, PVD techniques may include evaporation, electron-beam (e-beam) evaporation, sputtering, or combinations thereof. Deposited materials may include, without limitation, metals, metal alloys, metal nitrides, metal oxides, semiconductive materials, carbon-based materials, or combinations thereof.

In some embodiments, deposited material may be formed on a planar glass surface and/or within pre-formed features, recesses, and/or channels in the glass substrate. In some embodiments, evaporation-based PVD techniques may be used, including thermal evaporation and e-beam evaporation. Such techniques may be suitable for depositing materials having relatively high melting points and may enable formation of multilayer structures by sequential deposition of different materials without breaking vacuum.

In some embodiments, reactive evaporation techniques may be employed, in which deposition occurs in the presence of one or more reactive gases (e.g., O₂, N₂, and/or hydrocarbons) to form oxide, nitride, carbide, or other compound films. In some embodiments, sputtering-based PVD techniques may be used, in which energetic species in a plasma dislodge atoms from a target material that subsequently condense on the glass substrate to form a thin film.

In some embodiments, one or more adhesion layers, diffusion barrier layers, stress-relief layers, or intermediate layers may be deposited between the glass substrate and a heater layer to improve adhesion, durability, thermal cycling resistance, and/or long-term stability. In some embodiments, the heater structure may comprise a multilayer stack configured to provide desired electrical resistivity, thermal performance, and/or mechanical properties (e.g., robustness, reliability). In some embodiments, PVD techniques may be used alone or in combination with chemical vapor deposition (CVD) and/or plasma-assisted CVD processes to form heater elements and/or heater-associated structures. By way of example and not limitation, CVD and/or plasma-enhanced CVD (PECVD) processes may be used to deposit carbon-based materials, ceramic materials, and/or composite materials that function as resistive heater elements, structural heater components, and/or functional layers. Such processes may enable formation of amorphous carbon films, diamond-like carbon (DLC), graphitic materials, carbon nanotube structures, graphene-based materials, or combinations thereof on a glass substrate. In some embodiments, hybrid or advanced deposition processes may be employed, including combinations of PVD and CVD (e.g., plasma-assisted or resonance-based CVD techniques) to form multilayer or composite heater structures. In some embodiments, laser-assisted or localized CVD techniques may be used to deposit heater structures or carbon-based microstructures with spatial precision on a glass substrate.

The foregoing PVD, sputtering, and CVD-based processes are intended to serve as non-limiting examples. It should be understood that other vacuum-based, plasma-based, and/or hybrid thin-film deposition techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

The descriptions herein of physical vapor deposition (PVD), chemical vapor deposition (CVD), laser-assisted chemical vapor deposition (LCVD), electron-cyclotron-resonance chemical vapor deposition (ECRCVD), and related deposition techniques—including evaporation, sputtering, and combinations thereof—for forming heater elements and/or heater electrical connections are intended to serve as non-limiting examples. It should be understood that other related, similar, or functionally equivalent vacuum-based, plasma-based, or hybrid deposition processes—whether presently known or later developed—may be utilized, alone or in combination, for forming heater elements and associated electrical features.

In some embodiments, a fused-silica part or component may be used as the substrate for such deposition processes, such that the resulting composite part comprises a heater formed by one or more PVD, CVD, LCVD, ECRCVD, sputtering, and/or evaporation processes. In such embodiments, the fused-silica part may function as the deposition substrate during heater formation, subsequently function as a structural support for the heater, and may further function as at least a portion of a chamber and/or other functional component of a vaporizing device. It should be understood that materials other than glass may also be used as substrates for such deposition processes. By way of example and not limitation, suitable substrates may include other glass materials (e.g., quartz glass, borosilicate glass), ceramic materials, glass-ceramic materials, metal-glass composite materials, and/or other substrate materials described herein.

The foregoing processes and materials may be used alone or in combination with, in conjunction with, and/or in sequence with other manufacturing methods described herein to form parts, components, or composite parts comprising glass, ceramic, metal, carbon-based materials, polymers, elastomers, or combinations thereof.

In some embodiments, heater elements and/or associated heater electrical connections may be formed using laser-induced processing techniques, wherein a glass material, such as fused silica or another silica-based glass, serves as a substrate and/or support for the heater. By way of example and not limitation, such techniques may include laser-induced graphene (LIG) processes and related laser-based conversion or patterning methods that form conductive or resistive carbon-based structures. In some embodiments, a laser-induced graphene process may involve irradiating a precursor material, such as a polymeric or carbon-containing film (e.g., polyimide-PI-tape—e.g., Kapton), with laser energy to convert the precursor material into a porous or graphitic carbon structure that functions as a heater element. The resulting carbonaceous structure may be formed as a patterned region, trace, or network suitable for resistive heating. In some embodiments, such laser-formed structures may be generated on a precursor film and subsequently transferred to, bonded to, or otherwise integrated with a glass or ceramic component that serves as the heater substrate.

In some embodiments, electrical contacts or interconnect features may be added to electrically couple the laser-formed heater structure. In an embodiment, a LIG process may directly write carbonaceous (graphene) conductive structures onto a precursor film. This precursor film may then be transferred or used directly on the part and/or component serving as the substrate. The transfer process to the glass part and/or component process may involve the LIG-patterned tape being attached to the glass, and then another laser (e.g., a UV laser) operation is used to remove the underlying PI, leaving the graphene pattern bonded to the glass. In some embodiments, laser-induced heater structures may be formed directly on a glass or ceramic substrate. By way of example and not limitation, laser-induced backward transfer (LIBT) or related laser-assisted transfer or reduction processes may be used, in which laser energy is applied to convert or transfer a carbon-based material, such as graphene oxide and/or another carbon precursor, and to induce interfacial reactions with the substrate. Such processes may result in formation of a composite or nanocomposite layer comprising carbonaceous material and substrate-derived constituents that functions as a heater element. In some embodiments, selective laser patterning, laser welding, or laser modification processes may be used to form or define heater structures from a deposited film or layer. For example, a metal or other functional thin film may be deposited on a glass or ceramic substrate, and laser energy may be used to selectively pattern the film, modify its microstructure, or adjust its electrical resistance to define a resistive heater geometry while simultaneously promoting bonding or adhesion to the substrate.

The foregoing descriptions of laser-induced graphene processes, laser-assisted transfer processes, and selective laser patterning or modification processes for forming heater elements and/or heater electrical connections are intended to serve as non-limiting examples. It should be understood that other laser-based, photothermal, photochemical, or photon—assisted processes-whether presently known or later developed—may be used alone or in combination for forming heater elements and associated electrical features. In some embodiments, a fused-silica part or component may serve as the substrate for such laser-based processes, such that the resulting composite part comprises a heater formed on or within the substrate, and the fused-silica part functions as both the heater support structure and at least a portion of a chamber or other functional component. It should be understood that materials other than glass may also be used as substrates, including, without limitation, ceramic materials, glass-ceramic materials, metal-glass composite materials, or other substrate materials described herein.

The foregoing laser-based processes and substrate materials may be used alone or in combination with, in conjunction with, and/or in sequence with other manufacturing processes, whether presently known or later developed, and/or described herein to form parts, components, or composite parts comprising glass, ceramic, metal, carbon-based materials, polymers, elastomers, or combinations thereof.

In some embodiments, heater elements and/or associated heater electrical connections may be formed using electrochemical deposition processes, wherein a glass material, such as fused silica or another silica-based glass, serves as a substrate and/or support for heater formation. Such electrochemical deposition processes may include, by way of example and not limitation, electrodeposition, electroplating, and localized and/or selective electrochemical deposition techniques. In some embodiments, electrochemical deposition may involve depositing a metal or other conductive or resistive material from an electrolyte solution onto a substrate region that has been rendered electrically conductive or otherwise activated. By way of example and not limitation, the glass substrate may be pretreated, coated, patterned, or seeded with one or more conductive, catalytic, and/or nucleation layers to enable electrochemical deposition on selected regions of the glass. In some embodiments, electrochemical deposition may be used to form patterned heater structures, traces, and/or electrical contacts on the glass substrate.

In some embodiments, electrochemical deposition processes may be combined with one or more pattern-defining techniques to control heater geometry. Such techniques may include, by way of example and not limitation, photoresist patterning, masking, stencil patterning, additive manufacturing of masks, templates, or combinations thereof. These approaches may be used to define heater geometries including, without limitation, serpentine patterns, grid patterns, annular patterns, box-type patterns, or combinations thereof, suitable for resistive heating applications. In some embodiments, electrochemical deposition processes may be used alone or in combination with, in conjunction with, and/or in sequence with other heater-formation and manufacturing processes described herein, including direct-write printing, solution-based deposition, vacuum-based deposition, laser-based processing, powder-based molding, traditional injection molding, and overmolding processes.

The foregoing electrochemical deposition techniques are intended to serve as non-limiting examples, and it should be understood that other electrochemical, electroless, or hybrid deposition processes—whether presently known or later developed—may be used to form heater elements and composite parts comprising glass, ceramic, metal, carbon-based materials, polymers, elastomers, or combinations thereof.

In some embodiments, heater elements and/or associated heater electrical connections may be formed using electroless deposition processes, also referred to as chemical bath deposition, wherein metal ions are reduced and deposited on a substrate without application of an external electrical power source. In such embodiments, a glass substrate, such as fused silica or another silica-based glass, may first be activated, seeded, or otherwise treated (e.g., using Palladium) to provide catalytic sites that enable electroless deposition. By way of example and not limitation, one or more seed layers or catalytic materials may be applied to selected regions of the glass substrate to facilitate formation of dense, conductive films suitable for use as heater elements or electrical features.

In some embodiments, pulsed or time-varying electrochemical deposition techniques may be used, including pulsed electrodeposition (PED) or related methods, to deposit specialized materials or to form structures having controlled morphology, composition, or aspect ratio. By way of example and not limitation, pulsed deposition techniques may be used to deposit thermoelectric or resistive materials, such as bismuth-based or antimony-based compounds (e.g., antimony telluride Sb2Te3 or bismuth telluride Bi2Te3), and to form micro- or nano-scale pillar arrays, channels, or patterned regions that function as heater elements or heater-associated structures. In some embodiments, pulsed or alternating deposition and dissolution conditions (e.g., −280 mV for deposition period and +500 mV for dissolution period) may be used to improve uniformity, density, or feature resolution, particularly in recessed or high-aspect-ratio features formed in or on the glass substrate.

In some embodiments, electrochemical additive manufacturing techniques, sometimes referred to as localized electrochemical deposition, micro-scale electrochemical printing, or micro-3D printing, may be used to form heater elements and/or electrical features on a glass substrate without immersing the entire substrate in an electrolyte bath. Such techniques may employ a localized deposition tool and/or nozzle that delivers an electrolyte and electric field to a selected region of the substrate, enabling site-specific formation of metal and/or metal-based heater structures. In some embodiments, reversible metal electrodeposition (RME) or related dynamically controlled electrochemical processes may be used, in which metal is selectively plated onto and removed from a surface to alter optical, electrical, or thermal properties of a glass-based component. By way of example and not limitation, a transparent conductive oxide (TCO) (e.g., indium tin oxide—ITO) layer formed on a glass substrate may be used in conjunction with reversible electrodeposition to form a thin, electrically resistive, and heat-generating layer that functions as a heater when energized. Such processes may enable dynamic and/or reconfigurable heater behavior in some implementations.

In some embodiments, electrochemical discharge machining (ECDM) or related spark-assisted electrochemical processes may be used to create conductive micro-patterns or modified surface regions on a glass substrate. Such micro-patterns or modified regions may themselves function as heater elements or may serve as seed layers, conductive pathways, or precursors for subsequent heater formation.

The foregoing electroless, pulsed, localized, reversible, and discharge-assisted electrochemical processes are intended to serve as non-limiting examples. It should be understood that other electrochemical, electro-thermal, or hybrid deposition and patterning techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, glass substrates used for heater formation, such as fused-silica or other silica-based glass components, may undergo one or more surface activation, pretreatment, or modification steps prior to deposition, as glass surfaces are not inherently catalytic or conductive. Such pretreatment may be used to facilitate subsequent heater-formation processes, including electrochemical deposition, electroless deposition, vacuum-based deposition, solution-based deposition, or combinations thereof. In some embodiments, surface activation may include application of one or more catalytic or seed layers to selected regions of the glass substrate. By way of example and not limitation, surface activation may involve chemical sensitization and activation processes, including use of tin-based compounds (e.g., stannous chloride—SnCl2), palladium-based compounds (e.g., palladium (II) chloride—PdCl2), or other catalytic materials, to enable electroless or electrochemical deposition on glass surfaces. In some embodiments, surface activation may additionally or alternatively include plasma treatment, laser treatment, chemical etching, surface functionalization, or other modification techniques.

In some embodiments, one or more adhesion layers, intermediate layers, or interfacial layers may be formed between the glass substrate and a heater layer to improve adhesion, mechanical stability, thermal stress resistance, and/or long-term reliability. By way of example and not limitation, such layers may comprise chromium-based materials, titanium-based materials, nitrides, oxides, or combinations thereof. In some embodiments, multilayer structures may be formed, including stacks comprising alternating adhesion, barrier, and heater layers, to enhance resistance to delamination, cracking, and/or degradation under thermal cycling (e.g., Cr/CrN/Pt/CrN/Cr).

The electrochemical deposition methods and related processes described herein for forming heater elements and/or heater electrical connections on a glass substrate—including electroless deposition, electrodeposition, pulsed electrochemical deposition, localized electrochemical deposition, reversible metal electrodeposition, and discharge-assisted processes—are intended to serve as non-limiting examples. It should be understood that other related, similar, or functionally equivalent electrochemical or electro-thermal processes—whether presently known or later developed—may be used alone or in combination for forming heater elements and associated electrical features.

In some embodiments, a fused-silica part or component may serve as the substrate for such electrochemical and related deposition processes, such that the resulting composite part comprises a heater formed on or within the substrate. In such embodiments, the fused-silica part may function as the deposition substrate during heater formation, subsequently function as a structural support for the heater, and may further function as at least a portion of a chamber or other functional component of a vaporizing device. It should be understood that materials other than glass may also be used as substrates for such processes. By way of example and not limitation, suitable substrates may include other glass materials (e.g., quartz glass, borosilicate glass), ceramic materials, glass-ceramic materials, metal-glass composite materials, or other substrate materials described herein.

The foregoing processes and materials may be used alone or in combination with, in conjunction with, and/or in sequence with other manufacturing methods, whether presently known or later developed, and/or described herein to form parts, components, or composite parts comprising glass, ceramic, metal, carbon-based materials, polymers, elastomers, or combinations thereof.

In some embodiments, heater elements and/or associated heater electrical connections may be formed using ultrasonic spray pyrolysis (USP) or related aerosol-based thermal decomposition processes, wherein a glass material, such as fused silica or another silica-based glass, serves as a substrate and/or support for heater formation. USP processes may be used to deposit thin-film, patterned, or continuous heater structures on a glass substrate by converting a precursor solution into an aerosol and thermally decomposing the precursor to form a solid functional film on the substrate. In some embodiments, a precursor composition may comprise one or more metal-containing, organometallic, or other functional precursor compounds dissolved or dispersed in one or more carrier liquids. Such precursor compositions (e.g., containing tin chloride or acetate) may be atomized into fine droplets using ultrasonic energy and transported toward a heated region or heated substrate using a carrier gas. As the droplets are heated, solvent components may evaporate and precursor compounds may thermally decompose, resulting in deposition of a solid film or layer on the glass substrate. USP processes may enable control over one or more film characteristics, including, without limitation, thickness, uniformity, composition, morphology, optical properties, electrical resistivity, or combinations thereof.

In some embodiments, USP-formed heater structures may comprise metals, metal oxides, ceramic materials, semiconductive materials, carbon-based materials, or combinations thereof, selected to provide desired electrical and/or thermal behavior. By way of example and not limitation, USP may be used to form conductive or resistive oxide films, transparent conductive films (e.g., tin (IV) oxide/stannic oxide—SnO₂), or composite heater layers on a glass substrate. In some embodiments, additional processing steps may be performed following deposition, including, without limitation, annealing, sintering, laser processing, photonic curing, patterning, or combinations thereof, to tailor electrical performance and/or to form electrical contacts, interconnects, (e.g., using silver or tin oxide) and/or patterned heater geometries.

The foregoing descriptions of ultrasonic spray pyrolysis and related aerosol-based thermal deposition processes for forming heater elements and/or heater electrical connections are intended to serve as non-limiting examples. It should be understood that other spray-based, aerosol-based, or solution-based deposition techniques—whether presently known or later developed—may be used alone or in combination with, in conjunction with, and/or in sequence with other manufacturing processes described herein to form heater elements and composite parts.

In some embodiments, a fused-silica part or component may serve as the substrate for such USP-based processes, such that the resulting composite part comprises a heater formed on or within the substrate. In such embodiments, the fused-silica part may function as the deposition substrate during heater formation, subsequently function as a structural support for the heater, and may further function as at least a portion of a chamber or other functional component. It should be understood that materials other than glass may also be used as substrates, including, without limitation, quartz glass, borosilicate glass, ceramic materials, glass-ceramic materials, metal-glass composite materials, or other substrate materials described herein.

In some embodiments, heater elements and/or associated heater electrical connections may be formed using molding-based processes in which conductive material is embedded within micro- or nano-scale channels formed in or on a mold or template that is subsequently transferred to a glass substrate, such as fused silica or another silica-based glass. By way of example and not limitation, such processes may include micro-transfer molding, microchannel injection molding, or related molding techniques configured to form conductive features that function as heater elements.

In some embodiments, a mold or template (e.g., a mold or template of polydimethylsiloxane—PDMS—, having a PDMS surface, and/or a PDMS channel) comprising microchannels may be formed using an elastomeric or polymeric material, and one or more conductive compositions (e.g., silver paint and/or conductive PDMS) may be introduced into the microchannels. Such conductive compositions may include, without limitation, metals, metal-polymer composites, metal-solvent compositions, conductive polymers, carbon-based materials, or combinations thereof. In some embodiments, following introduction of the conductive composition, one or more heating, curing, or processing steps may be performed to remove carrier materials, solvents, or polymeric constituents, thereby leaving a conductive structure that forms a heater element and/or electrical feature. In some embodiments, following formation of conductive features within the mold or template, the mold may be bonded, aligned, or brought into contact with a glass substrate, and one or more transfer processes may be performed to transfer the conductive heater features to the glass substrate.

In some embodiments, surface preparation of the glass substrate may be performed prior to transfer, including, without limitation, application of self-assembled monolayers, surface functionalization, coating with one or more polymer layers (e.g., OmniCoat), photoresists, or combinations thereof, to promote selective adhesion, release, or pattern fidelity. In some embodiments, transfer of the conductive features may involve removal of a sacrificial mold or sacrificial layer by mechanical separation, peeling, chemical dissolution, plasma processing, thermal decomposition, or combinations thereof, leaving the conductive heater features bonded to the glass substrate. Such transfer processes may enable formation of heater elements and/or electrical interconnects with fine feature sizes and high pattern resolution on the glass substrate. In some embodiments, sacrificial molds, sacrificial layers, or release layers used in such micro-transfer molding and transfer processes may comprise polymeric, elastomeric, or photo-patternable materials selected for ease of patterning, compatibility with conductive materials, and removability. By way of example and not limitation, suitable materials may include elastomeric polymers, thermoplastic polymers, photoresists (e.g., SU-8 negative photoresist, AZ 1518), polyimides, bilayer lift-off materials (e.g., Polydimethylglutarimide—PMGI), or other sacrificial materials described herein or otherwise known. In some embodiments, sacrificial layers may be removed using dry processes, wet processes, or combinations thereof.

The foregoing micro-transfer molding, microchannel injection, and sacrificial-mold transfer processes are intended to serve as non-limiting examples. It should be understood that other molding-based, templated, or transfer-based fabrication techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

The micro-transfer molding, microchannel injection, and related molding-based fabrication methods described herein for forming heater elements and/or heater electrical connections on a glass substrate are intended to serve as non-limiting examples. It should be understood that other related, similar, or functionally equivalent molding-based, templated, or transfer-based methods—whether presently known or later developed—may be used alone or in combination for forming heater elements and associated electrical features.

In some embodiments, a fused-silica part or component may serve as the substrate for such micro-transfer molding or microchannel-based processes, such that the resulting composite part comprises a heater formed on or within the fused-silica substrate. In such embodiments, the fused-silica part may function as the deposition or transfer substrate during heater formation, subsequently function as a structural support for the heater, and may further function as at least a portion of a chamber or other functional component of a vaporizing device. It should be understood that materials other than glass may also be used as substrates for such processes. By way of example and not limitation, suitable substrates may include other glass materials (e.g., quartz glass, borosilicate glass), ceramic materials, glass-ceramic materials, metal-glass composite materials, or other substrate materials described herein.

The foregoing molding-based and transfer-based processes and substrate materials may be used alone or in combination with, in conjunction with, and/or in sequence with other manufacturing methods whether presently known or later developed, and/or described herein to form parts, components, or composite parts comprising glass, ceramic, metal, carbon-based materials, polymers, elastomers, or combinations thereof.

In some embodiments, heater elements and/or associated heater electrical contacts may be formed directly onto a part or component, such as a chamber, comprising fused silica or another glass material, using integrated-circuit and microfabrication techniques. In such embodiments, the glass part may serve as a substrate for heater formation using processes derived from semiconductor manufacturing, including, without limitation, thin-film deposition, photolithography, etching, and related patterning techniques. In some embodiments, heater fabrication may utilize processes derived from complementary metal-oxide-semiconductor (CMOS) fabrication, post-CMOS processing, micro-electro-mechanical systems (MEMS) fabrication, or combinations thereof. In some embodiments, post-CMOS approaches may involve forming heater structures on top of a pre-fabricated electronic substrate or wafer to enable monolithic or hybrid integration with electronic circuitry. In some embodiments, MEMS-based approaches may be used, particularly where substrates such as fused silica, glass, quartz, or ceramic are employed, to provide greater flexibility in material selection, processing temperatures, and heater architecture.

In some embodiments, integrated-circuit-based heater formation methods may be used to form heater elements and/or heater electrical contacts directly on a fused-silica or other glass substrate. Such methods may include deposition of one or more resistive materials to form heater structures, patterning of the resistive materials to define a desired heater geometry, and formation of electrical interconnects, contacts, or terminals. The resulting heater structures may be configured as thin-film heaters, patterned resistive traces, or multi-layer structures formed on or within the glass substrate.

In some embodiments, an integrated-circuit-based heater formation process using a glass substrate may include one or more of the following steps, provided by way of example and not limitation. A glass substrate, such as fused silica, quartz, or borosilicate glass, may be prepared with one or more passivation, insulation, or dielectric layers, including, without limitation, silicon dioxide, silicon nitride, or combinations thereof, to provide electrical insulation, thermal stability, or surface conditioning. One or more heater materials may then be deposited using a thin-film deposition technique, including, without limitation, sputtering, evaporation, or related processes. Suitable heater materials may include resistive metals, alloys, semiconductive materials, or combinations thereof.

In some embodiments, one or more adhesion layers, barrier layers, or intermediate layers may be formed between the glass substrate and the heater material to improve adhesion, reduce thermal stress, or enhance long-term reliability. In some embodiments, multilayer heater stacks may be formed, comprising combinations of adhesion layers, resistive heater layers, and protective layers. The deposited heater material may be patterned using photolithography, etching, lift-off, or related microfabrication techniques to define a desired heater geometry, including serpentine, annular, grid, or other patterns suitable for resistive heating. In some embodiments, one or more passivation, encapsulation, or insulation layers may be formed over the heater structure to provide electrical isolation, environmental protection, or compatibility with subsequent processing steps. In some embodiments, selective removal of underlying material using dry or wet etching techniques, including reactive ion etching, may be employed to modify thermal isolation, mechanical compliance, or heat transfer characteristics of the heater structure.

The foregoing integrated-circuit and MEMS-based heater formation methods are intended to serve as non-limiting examples, and it should be understood that other semiconductor-derived, microfabrication, or MEMS processes—whether presently known or later developed—may be used alone or in combination with, in conjunction with, and/or in sequence with other manufacturing processes described herein.

In some embodiments, heater elements formed using integrated-circuit fabrication techniques may enable monolithic or near-monolithic integration, in which a heating element is fabricated on the same substrate or assembly as control, sensing, power management, and/or signal-processing circuitry. By way of example and not limitation, such circuitry may include controllers, sensors, drivers, feedback circuits, or combinations thereof, thereby enabling compact, integrated heater systems with precise control and monitoring capabilities. The integrated-circuit-based heater formation methods described herein—including processes derived from CMOS fabrication, post-CMOS processing, MEMS fabrication, and related microfabrication techniques, optionally in combination with reactive ion etching or other micromachining processes—are intended to serve as non-limiting examples. It should be understood that other related, similar, or functionally equivalent semiconductor-derived or microfabrication processes—whether presently known or later developed—may be used alone or in combination for forming heater elements and/or associated heater electrical connections.

In some embodiments, a fused-silica part or component may serve as the substrate for such integrated-circuit-based heater formation processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for integrated-circuit-based heater formation. By way of example and not limitation, suitable substrates may include other glass materials (e.g., quartz glass, borosilicate glass), ceramic materials, glass-ceramic materials, metal-glass composite materials, or other substrate materials described herein.

The foregoing integrated-circuit and microfabrication-based heater formation methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical contacts may be formed directly onto a part or component, such as a chamber, comprising fused silica or another glass material, using post-integrated-circuit fabrication processes (post-IC fabrication). In such embodiments, a glass substrate may serve as the heater substrate, while post-IC fabrication techniques derived from integrated-circuit manufacturing are used to form heater structures and associated electrical features. In some embodiments, post-IC fabrication processes may include taking a substrate that includes pre-fabricated electronic circuitry, such as control, sensing, or driver circuitry formed using an integrated-circuit process, and performing additional fabrication steps to form heater elements and/or micromechanical structures. Such additional fabrication steps may include, without limitation, subtractive processing, additive processing, or combinations thereof, including etching, patterning, or modification of dielectric and conductive layers formed during back-end-of-line (BEOL) or related fabrication stages.

In some embodiments, post-IC fabrication processes are conventionally performed on silicon substrates to facilitate integration with electronic circuitry. However, in some embodiments, post-IC fabrication techniques and associated processing steps may be adapted for use with fused-silica or other glass substrates, while still enabling monolithic or near-monolithic integration of heater elements with control, sensing, and/or signal-processing circuitry. Such integration may provide benefits including reduced electrical noise, reduced parasitics, improved thermal control, and reduced power consumption.

The post-IC fabrication-based heater formation methods described herein-including post-CMOS, post-BEOL, and related microfabrication approaches employing subtractive and/or additive processing—are intended to serve as non-limiting examples. It should be understood that other related, similar, or functionally equivalent post-integrated-circuit fabrication methods—whether presently known or later developed—may be used alone or in combination for forming heater elements and/or associated heater electrical connections.

In some embodiments, a fused-silica part or component may serve as the substrate for such post-IC fabrication processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for post-IC fabrication processes. By way of example and not limitation, suitable substrates may include other glass materials (e.g., quartz glass, borosilicate glass), ceramic materials, glass-ceramic materials, metal-glass composite materials, or other substrate materials described herein.

The foregoing post-IC fabrication methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical contacts may be formed directly onto a part or component, such as a chamber, comprising fused silica or another glass material, using micro-electro-mechanical systems (MEMS) fabrication techniques. In such embodiments, the glass substrate may serve as a structural support for MEMS-based heater formation, and MEMS fabrication may provide increased flexibility in material selection (e.g., platinum, titanium, and/or titanium nitride), processing temperature, and heater architecture relative to standard integrated-circuit fabrication approaches. In some embodiments, MEMS-based heater fabrication on a glass substrate may include deposition of one or more conductive or resistive materials, followed by patterning to define a heater geometry. By way of example and not limitation, suitable heater materials may include metals, metal alloys, nitrides, carbon-based materials, or combinations thereof.

In some embodiments, one or more insulating, dielectric, or membrane structures (e.g., made of silicon nitride or silicon dioxide) may be formed to modify thermal isolation, heat transfer efficiency, or mechanical support of the heater. For example, thin membrane structures comprising dielectric materials may be formed to reduce thermal conduction to the surrounding substrate and to enable higher operating temperatures or lower power consumption.

In some embodiments, fused silica may be a desirable substrate for MEMS-based heater formation due to properties including optical transparency, thermal stability, electrical insulation, and compatibility with high-temperature processing. In some embodiments, MEMS-based heater structures formed on fused-silica substrates may be configured to operate at elevated temperatures (e.g., ≥500° C.) and may function as resistive (Joule) heaters, infrared emitters, or combinations thereof.

The MEMS-based heater and/or infrared-emitter formation methods described herein are intended to serve as non-limiting examples. It should be understood that other related, similar, or functionally equivalent MEMS, microfabrication, or micromachining techniques—whether presently known or later developed—may be used alone or in combination for forming heater elements and/or associated heater electrical connections.

In some embodiments, a fused-silica part or component may serve as the substrate for such MEMS-based fabrication processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for MEMS-based heater formation. By way of example and not limitation, suitable substrates may include other glass materials (e.g., quartz glass, borosilicate glass), ceramic materials, glass-ceramic materials, metal-glass composite materials, or other substrate materials described herein.

The foregoing MEMS-based heater and/or infrared-emitter formation methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using etching-based patterning processes. Such processes may generally include forming a patterned mask on a surface of the glass substrate, selectively removing material from unmasked regions using one or more etching techniques, and removing the mask to define a desired heater geometry on or within the glass substrate. In some embodiments, patterning of the glass substrate and/or heater material may be achieved using photolithographic techniques, including application of a photoresist or other masking material, exposure using a patterned mask, and development to form a protective pattern. Following patterning, one or more etching processes may be used to selectively remove unprotected material. Such etching processes may include, by way of example and not limitation, wet chemical etching, dry etching, plasma-based etching, laser-assisted etching, or combinations thereof.

In some embodiments, a heater material may first be deposited on a glass substrate prior to etching. Such heater materials may include, by way of example and not limitation, metals (e.g., Pt, Ag, Au, NiCr, Ti), metal alloys, semiconductive materials, carbon-based materials (e.g., CNTs, Graphene), or combinations thereof. Following deposition, a patterned mask may be formed on the heater material and etching or lift-off techniques may be used to define a heater geometry, such as serpentine patterns, annular patterns, grid patterns, or other resistive heater configurations.

In some embodiments, etching processes may be used to remove portions of the glass substrate adjacent to or surrounding heater structures, for example to create recesses, channels, suspended regions, or other geometries that modify thermal isolation, mechanical compliance, or heat transfer characteristics of the heater. Such glass-etching processes may be performed using one or more wet or dry etchants selected to selectively remove glass material relative to the heater material and masking layers. In some embodiments, etching-based heater formation processes may employ one or more hard masks or soft masks to protect heater features during etching. By way of example and not limitation, suitable hard mask materials may include metal-based masks (e.g., chromium/gold alloy—Cr/Au), silicon-based masks, nitride-based masks, oxide-based masks, or combinations thereof, while soft masks may include photoresists or other patternable polymeric materials. In some embodiments, multiple masking and etching steps may be used to form complex or multi-layer heater structures.

The foregoing etching-based heater formation processes are intended to serve as non-limiting examples. It should be understood that other etching chemistries, patterning techniques, and material removal processes—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, etching-based heater formation processes may be combined with laser-based modification techniques, including laser-assisted etching (LAE) and selective laser etching (SLE), to form heater elements and/or associated heater electrical connections within or on a glass substrate. Such processes may be used to create two-dimensional and/or three-dimensional heater structures embedded within a glass component, such as fused silica or another transparent glass material. In some embodiments, a laser may be used to selectively modify regions of a glass substrate, for example by locally altering the glass structure, composition, density, and/or bonding state, such that the modified regions exhibit different chemical or physical properties than unmodified regions. The laser-modified regions may then be selectively removed or shaped using one or more wet or dry etching processes, resulting in formation of channels, recesses, cavities, and/or patterned structures within the glass substrate. In some embodiments, such structures may be configured to function as resistive heater pathways, heating elements, and/or portions of a heater system.

In some embodiments, laser-based modification may be performed using ultra-short pulsed lasers (e.g., with femtosecond range pulse duration), high-intensity focused beams, or other laser systems capable of inducing localized changes within the glass through nonlinear absorption or related mechanisms. The laser focus may be positioned at or beneath a surface of the glass substrate and moved in a controlled manner to define a desired heater geometry, including, without limitation, serpentine paths, volumetric traces, or three-dimensional networks. Subsequent etching may preferentially remove the laser-modified regions at a higher rate than unmodified glass, thereby transferring the laser-defined pattern into the glass substrate. In some embodiments, the resulting etched structures may be left as voids, channels, or recessed features that define resistive heater geometries, and/or may be subsequently filled, coated, or combined with conductive or resistive materials using one or more deposition processes described herein. In some embodiments, the combination of laser modification and selective etching may be used to form embedded heater structures, thermally isolated regions, or complex three-dimensional heater architectures within a glass component.

The foregoing laser-assisted etching and selective laser etching processes are intended to serve as non-limiting examples. It should be understood that other laser-based modification techniques, etching chemistries, and hybrid laser-etching processes—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, etching-based microfabrication techniques may include quasi-anisotropic wet etching processes that are configured to form high-quality three-dimensional microstructures, such as trenches, cavities, recesses, and/or inclined surfaces, in a glass substrate. Such processes may be used to engineer surface and subsurface geometries on a glass part or component, such as fused silica or another silica-based glass, to facilitate formation, placement, and/or performance of heater elements and associated structures. In some embodiments, quasi-anisotropic wet etching may involve use of one or more mask layers formed on the glass substrate, wherein the etching behavior of the glass and the interface between the glass and the mask are controlled to produce non-isotropic etch profiles. By way of example and not limitation, the mask layer may comprise one or more metal-based (e.g., Cr), oxide-based, nitride-based, and/or composite materials (e.g., chromium oxynitride—CrOₓN_{y}), and may be patterned using photolithography or other pattern-definition techniques prior to etching.

In some embodiments, the quasi-anisotropic etching behavior may arise from a competitive or interfacial etching mechanism in which material removal occurs both at exposed glass regions and at interfaces beneath the mask. This competition may result in formation of inclined, substantially planar, or otherwise well-defined sidewalls rather than purely isotropic, rounded profiles. Such etching behavior may be achieved using one or more wet chemical etchants, dry etchants, or combinations thereof, selected to provide differential etch rates between the glass matrix and masked interface regions.

In some embodiments, the resulting etched features may comprise micro-trenches, cavities, or three-dimensional structures having controlled sidewall angles, depths, and surface quality. Such structures may be used directly as resistive heater geometries and/or may serve as receptacles, supports, or alignment features for subsequently deposited heater materials.

In some embodiments, inclined or otherwise well-defined sidewall geometries formed by quasi-anisotropic etching may improve conformity, continuity, and/or uniformity of subsequently deposited conductive or resistive materials used to form heater elements. For example, thin-film, printed, electrochemical, and/or solution-based heater materials may be deposited onto such etched surfaces to form heater structures with improved electrical continuity, thermal uniformity, and/or mechanical robustness. In some embodiments, quasi-anisotropic wet etching may provide a cost-effective and reproducible approach to shaping heater regions directly in a transparent glass substrate, enabling formation of compact, high-precision heater components and/or heater support structures.

The foregoing quasi-anisotropic wet etching processes are intended to serve as non-limiting examples, and it should be understood that other etching strategies, mask materials, etchant chemistries, and profile-engineering techniques—whether presently known or later developed—may be used alone or in combination with, in conjunction with, and/or in sequence with other manufacturing processes described herein to form heater elements and composite parts.

The wet-etching, advanced wet-etching, and related etching-based fabrication methods described herein for forming heater elements and/or associated heater electrical connections—including, without limitation, methods combined with laser-assisted etching and two-step selective laser etching (SLE)—are intended to serve as non-limiting examples. It should be understood that other related, similar, or functionally equivalent etching-based, laser-etching-based, or hybrid patterning methods—whether presently known or later developed—may be used alone or in combination for forming heater elements and associated electrical features.

In some embodiments, a fused-silica part or component may serve as the substrate for such wet-etching, advanced wet-etching, and/or laser-assisted etching processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for such etching-based heater-formation processes. By way of example and not limitation, suitable substrates may include other glass materials (e.g., quartz glass, borosilicate glass), ceramic materials, glass-ceramic materials, metal-glass composite materials, or other substrate materials described herein.

The foregoing etching-based and laser-assisted heater-formation methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using dry-etching-based patterning and material-removal processes. Such dry etching methods may be used to pattern deposited heater materials and/or to structure the underlying glass substrate to modify thermal, mechanical, or geometric characteristics of the heater region. In some embodiments, dry-etching processes may include, by way of example and not limitation, reactive ion etching (RIE), inductively coupled plasma reactive ion etching (ICP-RIE), ion beam etching (IBE or ion milling), deep reactive ion etching (DRIE), or combinations thereof. Such processes may be configured to provide anisotropic or directional etching, high feature resolution, and controlled sidewall profiles.

In some embodiments, dry etching may be used to pattern thin-film heater materials comprising metals, metal alloys, semiconductive materials, carbon-based materials, or combinations thereof, deposited on a glass substrate. In some embodiments, dry etching may be used to remove or shape portions of the glass substrate adjacent to or beneath heater structures to form recesses, channels, suspended regions, or other geometries that influence heat transfer, thermal isolation, or mechanical compliance. In some embodiments, dry-etching processes may employ one or more plasma chemistries, physical sputtering components, or combinations thereof to selectively remove glass or heater materials. By way of example and not limitation, etching processes may utilize halogen-based plasmas, inert gas plasmas, or mixed chemistries selected to achieve desired selectivity, anisotropy, etch rate, and surface quality. In some embodiments, passivation layers or cyclic etching techniques may be employed to achieve deep, high-aspect-ratio features or well-controlled sidewall profiles.

The foregoing dry-etching-based heater formation processes are intended to serve as non-limiting examples. It should be understood that other dry-etching, plasma-based, ion-based, or hybrid material-removal techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, heater elements and/or associated heater electrical connections may be formed using laser-based dry-etching, laser ablation, or hybrid laser-material-removal processes, wherein a glass substrate, such as fused silica or another silica-based glass, serves as a substrate and/or support for heater formation. Such processes may be used to pattern heater materials, to modify the glass substrate, or combinations thereof, and may enable formation of high-resolution, precisely defined heater geometries. In some embodiments, laser-based patterning may include direct laser writing or laser ablation techniques in which focused laser energy is used to selectively remove, modify, or define regions of a deposited heater material or a glass substrate. By way of example and not limitation, laser-based processes may be applied to a glass substrate having a deposited conductive or resistive layer, such that selective ablation leaves behind a patterned heater structure.

In some embodiments, laser-based patterning may be performed through the glass substrate, from a backside or interior surface, or from an exterior surface, to enable precise pattern definition while minimizing damage to surrounding regions. In some embodiments, laser-induced back-side ablation or related laser-assisted lift-off processes may be used, in which laser energy is directed through a transparent substrate to selectively remove or pattern a heater material located at an interface or on an opposing surface.

In some embodiments, ultrafast or short-pulse laser techniques may be used to reduce heat-affected zones, limit micro-cracking, or improve feature fidelity when forming heater structures on or within a glass substrate. In some embodiments, laser ablation may be performed in the presence of a surrounding medium, such as a liquid or gas, to reduce thermal loading, improve debris removal, or enhance pattern quality.

In some embodiments, hybrid fabrication approaches may be employed in which mechanical material-removal methods are combined with laser-based processing to define heater geometries or prepare substrates for heater formation. By way of example and not limitation, mechanical scribing, abrasive processing, or other mechanical techniques may be used to define preliminary features, followed by laser polishing, laser etching, or laser modification to refine geometry or surface quality.

In some embodiments, abrasive or blasting techniques may be used to modify glass surfaces where high precision is not required or where large-area texturing is desirable. In some embodiments, integrated fabrication approaches may be used in which multilayer or composite substrates are employed to facilitate heater formation. By way of example and not limitation, substrates comprising layered structures, such as substrates having buried insulating layers, may be processed using laser-based and/or etching-based techniques to form suspended, recessed, or thermally isolated heater structures.

The foregoing laser-based, hybrid mechanical-laser, and integrated fabrication processes are intended to serve as non-limiting examples, and it should be understood that other laser-assisted, photothermal, photochemical, or hybrid material-removal techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, dry-etching-based heater formation processes may utilize one or more masking layers to define heater geometries during patterning or material-removal steps. Such masking layers may include photoresists, hard masks, or combinations thereof, and may be selected based on compatibility with the heater material, the glass substrate, and the chosen etching process.

In some embodiments, one or more adhesion-promoting or interfacial layers may be formed between a heater material and a glass substrate to improve bonding, durability, and pattern fidelity during dry etching. By way of example and not limitation, such layers may comprise metal-based, nitride-based, oxide-based, or composite materials, and may themselves be patterned or removed as part of the etching process.

In some embodiments, protective measures may be employed during dry etching to reduce thermal loading, charging effects, or mechanical stress on a glass substrate. Such measures may include substrate cooling, thermal management techniques (e.g., helium backside cooling), temporary protective coatings, or process parameter control, to reduce the risk of cracking, warping, or other damage to the glass during high-energy etching operations.

The dry-etching, advanced dry-etching, and hybrid dry-etching processes described herein—including processes combined with laser-based patterning, mechanical material-removal techniques, or other fabrication methods—are intended to serve as non-limiting examples for forming heater elements and/or associated heater electrical connections. It should be understood that other related, similar, or functionally equivalent dry-etching, plasma-based, ion-based, or hybrid material-removal techniques—whether presently known or later developed—may be used alone or in combination for forming heater elements and associated electrical features.

In some embodiments, a fused-silica part or component may serve as the substrate for such dry-etching-based heater-formation processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for such dry-etching-based processes. By way of example and not limitation, suitable substrates may include other glass materials (e.g., quartz glass, borosilicate glass), ceramic materials, glass-ceramic materials, metal-glass composite materials, or other substrate materials described herein.

The foregoing dry-etching-based heater-formation processes and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In further embodiments, and by way of additional example, heater elements and/or associated heater electrical connections may be formed using ultrasonic spray pyrolysis (USP) or related ultrasonic atomization and thermal decomposition processes, wherein a glass material, such as fused silica or another silica-based glass, serves as a substrate and/or support for heater formation. In such processes, a precursor composition may be atomized into fine droplets using ultrasonic energy and delivered toward a heated substrate or heated region proximate the substrate, where the droplets undergo solvent evaporation and thermal decomposition to form a functional film on the substrate. USP processes may be used to form thin-film, patterned, and/or substantially continuous heater layers, including transparent, semi-transparent, and/or non-transparent heater films. In some embodiments, USP-formed heater layers may comprise one or more metals, metal oxides, mixed oxides, doped oxides, ceramic materials, semiconductive materials, carbon-based materials, nanowire networks, or combinations thereof, selected to provide desired electrical resistivity, transparency (if desired), thermal stability, emissivity, chemical durability, or combinations thereof. By way of example and not limitation, USP may be used to form transparent conductive oxide (TCO) films, resistive oxide films, and/or composite oxide films, including tin-oxide-based films (e.g., SnO₂), doped tin-oxide films (e.g., antimony-doped tin oxide (ATO)), indium-tin-oxide-based films (ITO), fluorine-doped tin oxide films (FTO), zinc-oxide-based films (including aluminum-doped (AZO), gallium-doped (GZO), indium-doped (IZO), or co-doped ZnO), or combinations thereof. Additional examples of oxide-based or ceramic heater materials that may be formed using USP include, without limitation, nickel-oxide-based films (including p-type or lithium-doped nickel oxide), tungsten-oxide-based films (e.g., WO₃), zirconium-oxide-based films (e.g., ZrO₂), yttria-stabilized zirconia (YSZ), indium-zinc-oxide-based films (In₂O₃—ZnO), aluminum-doped tin oxide (SnO₂:Al), cadmium-oxide-based films (CdO), lead-oxide-based films (PbO), or other doped, mixed, or complex metal oxides, or combinations thereof. The specific composition, doping level, and phase of such films may be selected to tune electrical, thermal, optical, and/or emissive properties of the heater.

In some embodiments, USP may also be used to form heater layers comprising carbon-based materials and/or composite conductive networks, including, without limitation, carbon nanotube (CNT) films, graphene-based films, reduced graphene oxide films, metal-nanowire networks (e.g., silver nanowires), or combinations thereof, including embodiments in which such materials form transparent, semi-transparent, and/or non-transparent heater layers. In some embodiments, USP process parameters may be selected to control one or more film characteristics, including, without limitation, droplet size distribution, deposition rate, thickness, uniformity, porosity, microstructure, composition, optical properties, electrical resistivity, thermal emissivity, or combinations thereof. Precursor compositions may include one or more metal salts, organometallic compounds, or other functional precursors dissolved or dispersed in one or more carrier liquids and/or solvents, optionally together with stabilizers, binders, or additives. By way of example and not limitation, carrier liquids may include aqueous and/or organic solvents, and solvent selection may be used to influence deposition behavior and/or film morphology. In some embodiments, USP-formed films may undergo one or more post-deposition processing steps, including, without limitation, annealing, sintering, curing, laser processing, photonic curing, patterning, contact formation, or combinations thereof, to achieve desired electrical, thermal, and/or mechanical properties and/or to form heater electrical contacts and/or interconnect features.

The foregoing USP-based processes and materials are intended to serve as non-limiting examples. It should be understood that other ultrasonic atomization, spray-based, aerosol-based, and/or solution-based thermal deposition processes—whether presently known or later developed—may be used alone or in combination with, in conjunction with, and/or in sequence with other manufacturing processes described herein to form heater elements and/or composite parts.

In some embodiments, a fused-silica part or component may serve as the substrate for such USP-based processes, such that the fused-silica part functions as the deposition substrate during heater formation, subsequently functions as a structural support for the heater, and may further function as at least a portion of a chamber or other functional component. It should be understood that materials other than glass may also be used as substrates, including, without limitation, other glass materials, ceramic materials, glass-ceramic materials, metal-glass composite materials, and/or other substrate materials described herein.

In some embodiments, heater elements and/or associated heater electrical connections may be formed using thick-film fabrication technologies, wherein a glass material, such as fused silica or another silica-based glass, serves as a substrate and/or support for heater formation. Thick-film processes may be used to form heater structures by depositing functional pastes and/or inks onto the glass substrate, followed by drying and/or thermal processing to produce electrically functional and/or mechanically robust heater layers. In some embodiments, thick-film fabrication may include depositing one or more functional materials onto the glass substrate using screen printing, stencil printing, dispensing, and/or related patterned deposition techniques. Such functional materials may include, by way of example and not limitation, conductive materials, resistive materials, dielectric materials, or combinations thereof, formulated as pastes and/or inks comprising one or more metals, metal alloys, metal oxides, ceramic particles, glass frits, organic binders, solvents, or combinations thereof.

In some embodiments, thick-film heater structures may be formed using one or more sequential deposition steps. For example, a dielectric or insulating layer may be deposited first, followed by deposition of a resistive heater layer, and subsequently deposition of conductive traces, pads, and/or electrical contact features. In some embodiments, multilayer thick-film structures may be formed to tailor electrical resistance, thermal performance, mechanical adhesion, and/or environmental durability of the heater. In some embodiments, following deposition, the printed layers may undergo one or more drying, curing, and/or thermal processing steps to remove carrier materials and/or to sinter, fuse, or otherwise consolidate the functional material. Such processing may result in formation of a solid, adherent heater structure bonded to the glass substrate and capable of functioning as a resistive heater and/or heater electrical interface.

The foregoing thick-film fabrication methods and materials are intended to serve as non-limiting examples. It should be understood that other thick-film, printed-electronics, or paste-based deposition techniques—whether presently known or later developed—may be used alone or in combination with, in conjunction with, and/or in sequence with other manufacturing processes described herein to form heater elements and/or composite parts comprising glass, ceramic, metal, carbon-based materials, polymers, elastomers, or combinations thereof.

In some embodiments, thick-film heater elements and/or associated heater electrical connections may be formed using one or more functional pastes or inks. Such functional pastes may include, by way of example and not limitation, conductive pastes, resistive pastes, carbon-based pastes, hybrid pastes, or combinations thereof, formulated for deposition on a glass substrate such as fused silica. The selection of a particular paste formulation may be based on one or more desired properties, including, without limitation, electrical resistivity, thermal stability, adhesion to glass, firing and/or curing compatibility, durability under thermal cycling, cost, or combinations thereof.

In some embodiments, conductive pastes may include metal-based pastes comprising one or more noble or non-noble metals or metal alloys, optionally combined with glass frits, ceramic particles, organic binders, and carrier liquids. By way of example and not limitation, such conductive pastes may include silver-based pastes, silver-alloy-based pastes (including silver-palladium systems), or other metal-based conductive pastes. In some embodiments, alloyed or composite conductive pastes may be selected to provide higher resistivity, improved adhesion to glass substrates, enhanced chemical stability, and/or improved compatibility with subsequent processing steps.

In some embodiments, resistive and/or carbon-based pastes may be used to form heater elements on a glass substrate. Such pastes may include, by way of example and not limitation, graphite-based pastes, carbon-black-based pastes, acetylene-black-based pastes, nanocarbon pastes (including pastes comprising carbon nanotubes, graphene, reduced graphene oxide, or combinations thereof), carbon-polymer composite pastes, and hybrid carbon-metal pastes. In some embodiments, carbon-based or composite pastes may be formulated to provide stable resistance, tunable sheet resistance, and/or enhanced thermal uniformity when deposited as heater structures. In some embodiments, resistive pastes may be configured to form heater geometries including, without limitation, serpentine patterns, grid patterns, annular patterns, interdigitated electrode (IDE) patterns, or combinations thereof. Interdigitated heater structures may be used, for example, to generate localized or distributed heating with improved uniformity and efficiency. In some embodiments, carbon-based or composite pastes may be selected to provide relatively high sheet resistance suitable for forming localized heating regions and/or tiled heater arrays.

In some embodiments, advanced or hybrid resistive pastes may be formulated to exhibit temperature-dependent electrical behavior, including positive temperature coefficient (PTC) characteristics, such that electrical resistance increases with temperature. Such self-regulating heater materials may be used to limit maximum operating temperature and reduce the need for external control circuitry in certain implementations. In some embodiments, hybrid pastes comprising mixtures of carbon-based materials and metal-based materials may be used to tailor conductivity, resistance, cost, and/or processing behavior. For example, carbon-metal hybrid pastes may be used to achieve intermediate resistivity values and/or to balance electrical performance and/or material cost. In some embodiments, post-deposition processing steps, including trimming, selective material removal, laser trimming, and/or other adjustment techniques, may be used to fine-tune the electrical resistance and/or power output of a formed heater.

The foregoing functional paste and/or ink formulations are intended to serve as non-limiting examples. It should be understood that other conductive, resistive, composite, and/or printed-electronics paste formulations—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

The thick-film fabrication technologies, systems, and methods described herein for forming heater elements and/or associated heater electrical connections on a glass substrate—including, without limitation, screen-printing and related paste-based deposition techniques—are intended to serve as non-limiting examples. It should be understood that other related, similar, or functionally equivalent thick-film, printed-electronics, or paste-based fabrication methods—whether presently known or later developed—may be used alone or in combination for forming heater elements and associated electrical features.

In some embodiments, a fused-silica part or component may serve as the substrate for such thick-film fabrication processes, such that the resulting composite part comprises a heater formed on and/or within the fused-silica substrate. In such embodiments, the fused-silica part may function as the deposition substrate during heater formation, subsequently function as a structural support for the heater, and may further function as at least a portion of a chamber and/or other functional component of a vaporizing device. It should be understood that materials other than glass may also be used as substrates for thick-film heater fabrication. By way of example and not limitation, suitable substrates may include other glass materials (e.g., quartz glass, borosilicate glass), ceramic materials, glass-ceramic materials, metal-glass composite materials, and/or other substrate materials described herein.

The foregoing thick-film fabrication methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical connections may be formed using roll-coating-based fabrication methods, wherein a glass material, such as fused silica or another silica-based glass, serves as a substrate and/or support for heater formation. Roll-coating processes may be used to deposit substantially uniform conductive or resistive layers onto a glass substrate and may be particularly suitable for forming large-area heater films or scalable heater structures. In some embodiments, roll-coating fabrication may include surface preparation and/or conditioning of the glass substrate to promote adhesion and/or uniformity of a deposited coating, followed by application of one or more conductive, resistive, and/or functional coatings using roll-coating techniques. By way of example and not limitation, such techniques may include reverse-roll coating, gravure coating, slot-die coating, and/or related roll-based deposition methods. One or more process parameters, including coating thickness, composition, and/or uniformity, may be controlled to achieve a desired electrical resistance and/or heating performance.

In some embodiments, heater geometries may be defined before or after roll coating using patterning techniques including, without limitation, printing, masking, laser patterning, or combinations thereof. In some embodiments, following deposition, the coated glass substrate may undergo one or more curing, drying, sintering, and/or consolidation steps to activate electrical functionality and/or to form a mechanically stable heater layer. Such processing may include, without limitation, thermal curing, infrared heating, photonic curing, or combinations thereof. In some embodiments, electrical contact regions, bus structures, and/or interconnect features may be formed and/or attached to the heater layer, either integrally during deposition or as a subsequent processing step, to enable electrical coupling and/or power delivery to the heater. Roll-coating-based heater fabrication methods may provide advantages including high uniformity, reproducibility, and/or scalability. In some embodiments, such methods may be implemented in continuous or semi-continuous manufacturing systems, including roll-to-roll (R2R) processes, to enable high-throughput production of heater elements on glass substrates. Roll-coating techniques may also provide flexibility in material selection, allowing use of a wide range of conductive inks, resistive coatings, composite formulations, or combinations thereof, thereby enabling tailoring of heater resistivity, thermal output, transparency, and/or other performance characteristics.

The foregoing roll-coating and roll-to-roll fabrication methods are intended to serve as non-limiting examples. It should be understood that other roll-based, continuous-coating, and/or large-area deposition techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

The roll-coating fabrication methods, systems, and processes described herein for forming heater elements and/or associated heater electrical connections on a glass substrate—including, without limitation, roll-to-roll (R2R) systems and roll-based processes integrated with screen-printing, patterning, and/or laser-based methods—are intended to serve as non-limiting examples. It should be understood that other related, similar, or functionally equivalent roll-based, continuous-coating, or large-area fabrication methods—whether presently known or later developed—may be used alone or in combination for forming heater elements and associated electrical features.

In some embodiments, a fused-silica part or component may serve as the substrate for such roll-coating and R2R fabrication processes, such that the resulting composite part comprises a heater formed on or within the fused-silica substrate. In such embodiments, the fused-silica part may function as the deposition substrate during heater formation, subsequently function as a structural support for the heater, and may further function as at least a portion of a chamber or other functional component of a vaporizing device. It should be understood that materials other than glass may also be used as substrates for roll-coating-based heater fabrication. By way of example and not limitation, suitable substrates may include other glass materials (e.g., quartz glass, borosilicate glass), ceramic materials, glass-ceramic materials, metal-glass composite materials, and/or other substrate materials described herein.

The foregoing roll-coating and R2R fabrication methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using thick-film fabrication techniques, including screen-printing, tape-casting, or combinations thereof. Such processes may be used to deposit functional resistive, conductive, and/or dielectric materials in patterned form directly on a glass substrate to create durable and energy-efficient heater structures. In some embodiments, screen-printing-based heater fabrication may include preparation of a glass substrate to promote adhesion and pattern fidelity, followed by patterned deposition of one or more functional layers. By way of example and not limitation, a dielectric or insulating layer may be deposited first to provide electrical insulation, surface planarization, or thermal management. A resistive heater layer may then be deposited in a selected geometry, such as serpentine, annular, grid, or other heater patterns suitable for distributing heat across the substrate. In some embodiments, one or more conductive layers may additionally be deposited to form electrical contact pads, terminals, or interconnect features. The functional materials used in such screen-printing processes may include, by way of example and not limitation, resistive pastes and/or inks comprising metal oxides, metal-based materials, ceramic particles, carbon-based materials, composite materials, or combinations thereof, as well as conductive pastes and/or inks comprising metals or metal alloys. In some embodiments, one or more protective, overglaze, and/or encapsulating layers may be deposited over the heater structure to provide mechanical protection, environmental resistance, oxidation resistance, or combinations thereof.

In some embodiments, following deposition of one or more functional layers, the printed materials may undergo one or more drying (e.g., in the temperature range from 100° C.-150° C.), curing, firing, and/or sintering (e.g., in the temperature range from 500° C.-850° C.) processes to remove carrier materials and/or to consolidate the functional particles into a solid, adherent heater structure bonded to the glass substrate. Such processing may be performed using furnaces, kilns, ovens, and/or other thermal processing systems, and may be selected to achieve desired electrical resistance, power density, thermal response, adhesion, and/or durability. In some embodiments, the electrical resistivity, power output, thermal uniformity, and/or heating response of a screen-printed heater may be tuned by adjusting one or more parameters, including, without limitation, paste composition, layer thickness, printed geometry, firing conditions, or combinations thereof. Screen-printed thick-film heaters formed in this manner may provide high power density, rapid thermal response, and/or efficient thermal coupling to the glass substrate.

The foregoing screen-printing and thick-film heater fabrication processes are intended to serve as non-limiting examples. It should be understood that other patterned thick-film deposition, printed-electronics, or paste-based fabrication techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, heater elements and/or associated heater electrical connections may be formed on a glass substrate using tape-casting-based thick-film fabrication techniques. In such embodiments, a castable slurry may be prepared that includes one or more glass powders, ceramic powders, or combinations thereof, together with one or more binders, solvents, plasticizers, dispersants, and/or additives, to form a stable slurry suitable for casting. By way of example and not limitation, such powders may include silica-based materials, borosilicate materials, alumina-based materials, zirconia-based materials (including stabilized zirconia), or combinations thereof.

In some embodiments, the slurry may be cast onto a temporary carrier or support using a controlled-thickness casting process, such as doctor-blade casting and/or related techniques, to form a flexible green tape. The green tape may be dried or otherwise processed to remove carrier liquids, resulting in a self-supporting cast layer. In some embodiments, heater structures may be patterned on and/or within the green tape prior to lamination, for example by depositing conductive or resistive materials using screen printing, direct-write printing, aerosol-based deposition, and/or other patterning methods described herein, to define a desired heater geometry. In some embodiments, the patterned green tape may be laminated, bonded, or otherwise joined to a glass substrate, such as fused silica or another silica-based glass, or to an intermediate ceramic or glass-ceramic layer associated with the glass substrate. The laminated assembly may then undergo one or more thermal processing steps, including, without limitation, debinding, sintering, firing, or combinations thereof, to densify the tape-cast layer, remove organic components, and/or form a mechanically robust heater structure bonded to the glass substrate.

The tape-casting-based thick-film heater fabrication methods described herein are intended to serve as non-limiting examples. It should be understood that tape-casting may be used alone or in combination with other thick-film, printed-electronics, and/or deposition-based heater fabrication methods, whether presently known or later developed, and/or described herein, including screen printing, direct-write printing, aerosol-based deposition, or combinations thereof.

In some embodiments, a fused-silica part or component may serve as the substrate for such tape-casting-based heater formation, such that the resulting composite part comprises a heater formed on and/or within the fused-silica substrate. In such embodiments, the fused-silica part may function as the substrate during heater formation, subsequently function as a structural support for the heater, and/or may further function as at least a portion of a chamber and/or other functional component of a vaporizing device. It should be understood that materials other than glass may also be used as substrates for tape-casting-based heater fabrication. By way of example and not limitation, suitable substrates may include other glass materials (e.g., quartz glass, borosilicate glass), ceramic materials, glass-ceramic materials, metal-glass composite materials, and/or other substrate materials described herein.

The foregoing tape-casting-based heater fabrication methods and substrate materials may be used alone or in combination with, in conjunction with, and/or in sequence with other manufacturing processes described herein to form parts, components, and/or composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using direct-write or maskless fabrication techniques. Such techniques may involve localized deposition, modification, sintering, and/or conversion of conductive, resistive, dielectric, and/or composite materials directly on the glass substrate without the use of lithographic masks. Direct-write processes may be particularly suitable for rapid prototyping, customized heater geometries, and flexible manufacturing workflows.

In some embodiments, direct-write fabrication may include deposition-based techniques, including, by way of example and not limitation, direct ink writing (DIW), micro-dispensing, micro-pen writing, or related extrusion-based methods, in which functional materials such as conductive or resistive pastes, inks, and/or suspensions are delivered through a nozzle to form heater structures and/or thick-film resistors directly on the glass substrate. In some embodiments, such deposition-based direct-write processes may be combined with localized thermal processing, such as laser-assisted sintering and/or curing, to consolidate deposited material in situ and form electrically functional heater structures. In some embodiments, direct-write fabrication may include laser-based patterning or modification techniques, including laser direct writing, laser scribing, selective laser sintering (SLS), selective laser melting (SLM), laser-induced material conversion, or combinations thereof. Such laser-based methods may be used to ablate, sinter, melt, modify, or convert deposited and/or precursor materials to form conductive or resistive heater patterns on or within a glass substrate. In some embodiments, laser-induced graphene or related laser-driven carbonization processes may be used to form carbonaceous heater structures adapted for use on glass substrates. In some embodiments, one or more of SLS and SLM, where a focused laser beam may sinter and/or melt conductive powders directly on the glass part and/or glass components serving as the substrate, may be used to form a heater. Laser-induced graphene (LIG) conversion may be used to form conductive carbonaceous structures that are adapted for glass substrates to act as heating elements. In an embodiment, laser scribing may be used to create conductive patterns (such as any of the heating patterns described herein) by ablating materials off of glass to form a heater.

In some embodiments, ultrafast or short-pulse laser direct-write techniques may be used to locally modify material properties of a glass substrate and/or deposited layers, enabling formation of two-dimensional or three-dimensional microstructures that function as heater elements or as supports for subsequent heater formation. Such techniques may be combined with additional deposition or coating processes described herein to form integrated heater structures. In an embodiment, femtosecond laser direct writing (Fs-DLW) may be used for modifying the properties of the glass to create microstructures (e.g., 2D and/or 3D) which, when combined with subsequent metal deposition methods and/or processes, may be used to form heaters on a glass part and/or glass component serving as the substrate.

In some embodiments, nanoscale or microscale direct-write techniques may be used, including probe-based or tip-based deposition methods, to deposit functional materials with high spatial resolution on a glass substrate. Such techniques may be used to form localized heater features, fine-scale resistive elements, or experimental or specialized heater geometries. In an embodiment, dip-pen nanolithography (DPN) may be used to form a heater where, for example, an atomic force microscope (AFM) tip is used to directly deposit materials such as metal and/or metal alloys and/or carbon-based materials such as carbon nanotubes (CNTs), and/or graphene. This helps allow for extremely high-resolution, nano-scale, and/or micro-scale heating patterns to be formed on a glass part and/or glass component serving as the substrate for the AFM formed heater.

The foregoing direct-write and maskless heater fabrication methods are intended to serve as non-limiting examples. It should be understood that other digitally controlled, maskless, additive, subtractive, or hybrid direct-write fabrication techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

The direct-write and maskless fabrication methods described herein for forming heater elements and/or associated heater electrical connections on a glass substrate—including, without limitation, direct ink writing (DIW), laser-assisted DIW, laser direct writing (DLW), selective laser sintering (SLS), selective laser melting (SLM), laser-induced graphene (LIG) conversion, femtosecond laser direct writing (Fs-DLW), dip-pen nanolithography (DPN), probe-based deposition (e.g., AFM formed), and related digitally controlled fabrication techniques—are intended to serve as non-limiting examples. It should be understood that other related, similar, or functionally equivalent maskless, digitally driven, additive, subtractive, or hybrid direct-write methods—whether presently known or later developed—may be used alone or in combination for forming heater elements and associated electrical features.

In some embodiments, a fused-silica part or component may serve as the substrate for such direct-write fabrication processes, such that the resulting composite part comprises a heater formed on or within the fused-silica substrate. In such embodiments, the fused-silica part may function as the fabrication substrate during heater formation, subsequently function as a structural support for the heater, and may further function as at least a portion of a chamber or other functional component of a vaporizing device. It should be understood that materials other than glass may also be used as substrates for direct-write heater fabrication. By way of example and not limitation, suitable substrates may include other glass materials (e.g., quartz glass, borosilicate glass), ceramic materials, glass-ceramic materials, metal-glass composite materials, or other substrate materials described herein.

The foregoing direct-write fabrication methods and substrate materials may be used alone or in combination with, in conjunction with, and/or in sequence with other manufacturing processes described herein to form parts, components, or composite parts comprising glass, ceramic, metal, carbon-based materials, polymers, elastomers, or combinations thereof.

In some embodiments, heater elements and/or associated heater electrical connections may be formed on a glass substrate, such as fused silica or another silica-based glass, using surface micromachining fabrication techniques. In such embodiments, conductive or resistive thin-film materials may be deposited and patterned to define heater geometries on or within the glass substrate, optionally in combination with one or more sacrificial layers to form insulated, recessed, partially released, or free-standing heater structures. Surface micromachining on glass substrates may include substrate preparation or conditioning steps to promote adhesion, cleanliness, surface reactivity, and/or pattern fidelity. Such preparation may include, by way of example and not limitation, cleaning, chemical treatment, plasma treatment, surface functionalization, or combinations thereof. In some embodiments, the glass substrate may be selected for properties including electrical insulation, thermal stability, optical transparency (if desired), and/or relatively low thermal expansion, which may be advantageous for certain high-temperature heater implementations and thermal cycling conditions.

In some embodiments, one or more functional layers may be formed on the glass substrate and/or prior layers to enable surface-micromachined heater formation. Such functional layers may include, by way of example and not limitation, one or more adhesion-promoting layers, dielectric or insulating layers, diffusion barrier layers, resistive heater layers, conductive interconnect layers, passivation or encapsulation layers, or combinations thereof. Heater materials may include, by way of example and not limitation, metals, metal alloys, metal nitrides, semiconductive materials, carbon-based materials, conductive ceramics, cermets, or combinations thereof, deposited using thin-film deposition techniques such as sputtering, evaporation, chemical vapor deposition, atomic layer deposition, solution-based deposition, or other deposition methods described herein.

In some embodiments, one or more sacrificial layers may be formed between the glass substrate and a heater layer to provide spacing, thermal isolation, and/or mechanical release capability. Sacrificial layers may comprise, by way of example and not limitation, oxide-based materials, glass-based materials, silicate-based materials, polymeric materials, spin-on materials, or combinations thereof. In some embodiments, sacrificial layers may be patterned prior to heater deposition and subsequently removed, in whole or in part, using one or more selective material-removal processes (e.g., wet etching, dry etching, plasma processing, laser-assisted removal, or combinations thereof) to form suspended, cantilevered, recessed, or otherwise thermally isolated heater structures. In some embodiments, the sacrificial layer may be fully removed to form a free-standing heater structure, while in other embodiments the sacrificial layer may be partially or fully retained to support the heater and/or to tailor thermal coupling to the substrate.

In some embodiments, the heater layer and/or other functional layers may be patterned using photolithography, masking, lift-off, etching, laser patterning, or combinations thereof to define a desired heater geometry, including, without limitation, serpentine, annular, grid, box-type, interdigitated, or other heater patterns described herein. By way of example and not limitation, sacrificial layers may include deposited oxides or glass layers (including silicate-based layers), spin-on materials, or polymeric layers, and selective removal may include wet etching (including fluoride-based etchants), dry etching, plasma processing, or combinations thereof.

In some embodiments, if electrical contact regions are not integral to the initially patterned heater structure, one or more additional conductive layers may be deposited, printed, plated, or otherwise formed and patterned to provide electrical contacts, terminals, bus structures, or interconnect features for supplying power to the heater.

In some embodiments, surface micromachining techniques may be used to form heater structures comprising carbon-based or carbonaceous materials on glass substrates. Such carbon-based heater structures may be formed by depositing carbon-containing films or precursors and patterning the films using photolithography, etching, laser patterning, or combinations thereof, and/or by forming carbonaceous heater regions through laser-induced conversion, carbonization, or related processes described herein. In some embodiments, laser patterning may be used to define heater features directly without the use of lithographic masks.

The foregoing surface-micromachining heater formation methods are intended to serve as non-limiting examples. It should be understood that other related, similar, or functionally equivalent micromachining, microfabrication, thin-film structuring, and sacrificial-layer release techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof. It should also be understood that materials other than glass may be used as substrates for such micromachining processes, including, without limitation, other glass materials (e.g., quartz glass, borosilicate glass), ceramic materials, glass-ceramic materials, metal-glass composite materials, or other substrate materials described herein.

In some embodiments, heater elements and/or associated heater electrical connections may comprise carbon-based or carbonaceous materials formed on, within, or in association with a glass part or component serving as a substrate (e.g., fused silica or other silica-based glass). Methods and processes for forming carbon-based heater structures on glass substrates may include, by way of example and not limitation, direct laser writing and/or laser ablation of carbonaceous materials; deposition of carbon-based films followed by patterning; printing and/or coating of carbon-containing inks, pastes, and/or composites followed by patterning; and laser-induced conversion and/or carbonization processes that form conductive carbon structures on a glass substrate. In some embodiments, direct laser writing and/or laser ablation may be used to ablate, structure, and/or pattern carbonaceous materials (e.g., glassy carbon, pyrolytic carbon, graphite-containing layers, and/or carbonaceous composites) to define heater geometries and resistive pathways. In some embodiments, carbon-based heater layers may be formed by depositing a carbon-containing film using physical vapor deposition (PVD), chemical vapor deposition (CVD), plasma-enhanced CVD, and/or other deposition methods described herein, followed by lithographic patterning, etching, lift-off, laser patterning, or combinations thereof to define heater shapes. In some embodiments, conductive or resistive carbon-containing pastes, inks, and/or composites (including, without limitation, carbon nanotube (CNT) formulations, graphene-based formulations, graphite formulations, or combinations thereof) may be printed, coated, dispensed, and/or spin-coated onto a glass substrate and subsequently patterned to form heater structures.

In some embodiments, laser-induced conversion and/or laser-induced carbonization processes may be used to form carbon-based heater structures on a glass substrate by converting a precursor material into a conductive carbonaceous structure. In such embodiments, a precursor material may be applied to, coated onto, laminated onto, and/or otherwise associated with the glass substrate prior to laser processing. Precursor materials may include, by way of example and not limitation, polyimides (including polyimide films or coatings), poly(ether imide) (PEI), phenolic resins, epoxy-based materials (including photoresists such as SU-8), polymethyl methacrylate (PMMA), and bio-derived or natural materials including cellulose- or lignin-containing materials (e.g., paper, wood, textiles), as well as other polymeric, resinous, or carbon-containing precursors, or combinations thereof. In some embodiments, precursor materials may optionally include one or more absorbers, fillers, catalysts, dopants, and/or additives selected to influence conversion behavior, conductivity, porosity, adhesion, and/or other properties of the resulting carbonaceous heater structure.

In some embodiments, laser processing may be performed by scanning or otherwise directing laser energy to selected regions of a precursor material to induce localized conversion, carbonization, graphitization, and/or formation of graphene-like carbon structures, thereby defining a heater pattern. Laser processing may utilize one or more laser sources, wavelengths, pulse durations, beam shapes, scan strategies, and/or energy densities selected to achieve a desired microstructure and electrical resistivity in the carbonaceous heater. The heater geometry may be digitally defined (e.g., using a computer-controlled positioning system and/or pattern file) to form heater patterns including, without limitation, serpentine, annular, grid, or other resistive pathways suitable for heating.

In some embodiments, if electrical contact regions are not integral to the carbon-based heater pattern, one or more additional conductive materials may be deposited, printed, plated, and/or otherwise formed to provide electrical contacts, terminals, and/or interconnect features for supplying power to the heater. Such contact materials may include, by way of example and not limitation, metals, metal alloys, conductive composites, conductive pastes, or combinations thereof.

The foregoing carbon-heater formation methods are intended to serve as non-limiting examples, and it should be understood that other related, similar, or functionally equivalent carbon-forming, laser-conversion, deposition, printing, and patterning techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, heater elements and/or associated heater electrical connections may be formed using bulk micromachining methods and processes to create three-dimensional (3D) structures that are subsequently combined with deposited, printed, plated, or otherwise formed heater materials. In such embodiments, bulk micromachining may be used to form cavities, grooves, channels, recesses, membranes, bridges, or other 3D features that improve thermal isolation, define flow pathways, provide mechanical support, and/or enable suspended or partially suspended heater architectures. Bulk micromachining may be performed on a glass substrate (e.g., fused silica or another silica-based glass) and/or on an intermediate or companion substrate (e.g., silicon or another machinable substrate) that is subsequently bonded, joined, transferred, or otherwise integrated with the glass substrate. Bulk micromachining methods may include, by way of example and not limitation, wet chemical etching, dry etching, plasma etching, ultrasonic machining (USM), laser micromachining, mechanical or abrasive material removal, molding and bonding processes, and hybrid techniques that combine two or more such processes and/or other processes described herein. In some embodiments, bulk micromachining may differ from surface-level patterning in that it may be used to form deeper, higher-aspect-ratio, or volumetric features that extend into the substrate and provide 3D heater integration and thermal-management structures. In some embodiments, bulk micromachining may be performed on a silicon or silicon-containing substrate to form cavities, V-grooves, membranes, diaphragms, bridges, or other 3D features that provide thermal isolation for heater elements. In certain implementations, anisotropic wet etching of silicon may be used to form crystallographically defined 3D structures. By way of example and not limitation, anisotropic etchants may include alkaline etchants such as potassium hydroxide (KOH), tetramethylammonium hydroxide (TMAH), ethylenediamine pyrocatechol (EDP), or combinations thereof, which may etch silicon at different rates along different crystallographic orientations, thereby enabling formation of angled sidewalls, grooves, and cavities.

In some embodiments, such 3D silicon features may be used to support or suspend heater materials, define flow channels, reduce heat loss to bulk substrate material (thereby improving thermal efficiency), and/or form membranes and/or form diaphragm features (which may be formed by backside etching and act as a thermal isolation layer for the heater). In some embodiments, following formation of 3D micromachined silicon structures, heater materials (e.g., metals, metal alloys, carbon-based materials, conductive ceramics, cermets, or combinations thereof) may be deposited, patterned, printed, plated, or otherwise formed on the micromachined substrate using methods described herein. In some embodiments, the micromachined silicon structures may then be bonded to a glass substrate (e.g., fused silica) to form a composite part in which the glass provides electrical insulation, optical transparency (if desired), chemical resistance, and/or barrier functionality, while the micromachined silicon provides 3D thermal-isolation structures.

In some embodiments, glass-to-silicon bonding or glass-to-substrate bonding may be used to integrate bulk-micromachined structures with a glass component. By way of example and not limitation, bonding techniques may include anodic bonding, fusion bonding, direct bonding, adhesive bonding, intermediate layer bonding, or combinations thereof. In some embodiments, bonding may be used to seal or enclose cavities, form hermetic or semi-hermetic regions, provide structural reinforcement, and/or define thermally isolating voids and/or chambers adjacent to heater structures.

In some embodiments, optional post-bond processing may be performed, including partial or complete removal of portions of a companion substrate (e.g., silicon—e.g., using backside processing and/or etching) from regions beneath or adjacent a heater structure, to leave a membrane, bridge, or suspended region associated with the glass substrate. In some embodiments, such post-bond processing may enable heater structures to be supported by or thermally isolated relative to the glass component while maintaining a desired mechanical robustness and packaging configuration. In some embodiments, bulk micromachining may additionally or alternatively be performed directly on the glass substrate using one or more wet, dry, plasma, laser-based, ultrasonic, or mechanical material-removal processes. By way of example and not limitation, dry etching or plasma etching processes may be used to form deep or high-aspect-ratio features in glass, and laser-based ablation or laser micromachining processes may be used to form channels, grooves, cavities, or other heater-receiving geometries in glass. In some embodiments, ultrasonic machining or abrasive methods may be used to form features in glass where suitable precision or surface finish can be achieved.

In some embodiments, after formation of bulk-micromachined features in or on glass (or in a bonded composite), heater materials may be deposited, plated, printed, filled, coated, or otherwise introduced into such features to form heater structures. Such heater materials may include, by way of example and not limitation, metals, metal alloys, carbon-based resistive materials, conductive ceramics, cermets, composite materials, or combinations thereof, formed using deposition and patterning methods described herein.

In some embodiments, post-machining cleaning, debris removal, surface conditioning, and/or passivation steps may be performed to improve adhesion, electrical performance, and long-term stability of the heater structure.

The foregoing bulk micromachining methods, substrate-integration approaches, and heater-formation sequences are intended to serve as non-limiting examples. It should be understood that other related, similar, or functionally equivalent bulk micromachining, bonding, substrate-integration, and hybrid fabrication techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, bulk micromachining methods for forming heater-related structures on a glass substrate may include ultrasonic machining (USM) and related vibration-assisted abrasive machining techniques. In such methods, a vibrating tool may be used in conjunction with an abrasive slurry to remove material from a glass substrate and form grooves, cavities, recesses, channels, or other three-dimensional features suitable for heater placement, heater support, thermal isolation, or combinations thereof. By way of example and not limitation, a shaped tool (including metal or carbide tools) may be vibrated at ultrasonic frequencies and used with abrasive slurries comprising ceramic or carbide abrasive particles to erode glass material in selected regions. By way of example and not limitation, tools may be vibrated in a range of about 20-40 kHz, tool materials may include tungsten carbide, and abrasive slurries may include boron carbide, alumina, or combinations thereof.

In some embodiments, following formation of USM-defined features, the substrate may undergo cleaning or debris removal, and heater materials may be subsequently deposited, printed, plated, filled, coated, or otherwise introduced into or onto the formed features using deposition and patterning methods described herein.

In some embodiments, bulk micromachining methods for forming heater-related structures on a glass substrate may include laser micromachining, laser ablation, and related laser-based material removal processes. Such processes may be used to form channels, grooves, cavities, recesses, or textured regions in glass with spatial precision and may enable formation of heater-receiving geometries, alignment features, thermally isolating structures, or heat-spreading structures. By way of example and not limitation, laser micromachining may utilize ultrafast or short-pulse laser sources to reduce heat-affected zones and improve feature fidelity, and laser ablation may utilize laser sources selected to provide desired ablation behavior on glass. By way of example and not limitation, ultrafast pulses may be on the order of hundreds of femtoseconds (e.g., ~400 fs), and laser sources may include infrared, ultraviolet, or other wavelengths, including CO₂ or excimer lasers.

In some embodiments, post-machining processing may include debris removal, surface conditioning, or passivation steps. Heater materials may then be subsequently formed in association with the laser-machined features using one or more deposition, printing, plating, filling, coating, or patterning processes described herein.

In some embodiments, bulk micromachining methods for forming heater-related structures on a glass substrate may include mechanical and abrasive material removal processes, including powder blasting, abrasive jet machining (AJM), ultrasonic drilling, or combinations thereof. Such processes may be used to rapidly remove glass material to form deeper or larger-area features, including cavities, grooves, channels, or complex three-dimensional shapes, which may facilitate heater architectures in which heat spreading, thermal isolation, mechanical robustness, manufacturability, or combinations thereof are desired. By way of example and not limitation, abrasive jet processes may direct abrasive particles through a mask, stencil, or patterned template to erode glass material in selected regions. By way of example and not limitation, abrasive media may include alumina or other ceramic abrasives. Following formation of such features, heater materials may be deposited, printed, plated, filled, coated, or otherwise introduced to form heater structures using methods and processes described herein.

The foregoing ultrasonic machining, laser micromachining, and mechanical/abrasive bulk micromachining processes are intended to serve as non-limiting examples. It should be understood that other related, similar, or functionally equivalent mechanical, abrasive, vibration-assisted, laser-based, or hybrid bulk micromachining techniques—whether presently known or later developed—may be used alone or in combination with, in conjunction with, and/or in sequence with other manufacturing processes described herein to form heater elements and composite parts comprising glass, ceramic, metal, carbon-based materials, polymers, elastomers, or combinations thereof.

In some embodiments, bulk micromachining methods and processes may be used in conjunction with subsequent deposition and/or patterning steps to form heater elements and/or associated heater electrical connections on a glass substrate, such as fused silica or another silica-based glass. In some embodiments, bulk micromachining may include silicon molding and/or micromachining of a silicon substrate to form three-dimensional features that are subsequently integrated with a glass substrate, for example by anodic bonding, fusion bonding, or other bonding techniques described herein, thereby enabling complex 3D geometries and thermally isolating features. After formation and/or bonding of the bulk structure, heater materials may be formed on or in association with the glass substrate and/or composite structure using one or more deposition and patterning approaches described herein. In some embodiments, heater materials formed on the glass substrate may include metals, metal alloys, metal nitrides, semiconductive materials, carbon-based resistive materials, conductive ceramics, cermets, or combinations thereof. By way of example and not limitation, metals may include gold, silver, platinum, titanium, tungsten, nickel, chromium, nichrome-type alloys, and/or other alloys, and carbon-based materials may include carbon nanotubes (CNTs), graphene-based materials, glassy carbon, pyrolytic carbon, or combinations thereof.

In some embodiments, multiple process flows may be employed, including “deposit-then-pattern,” “pattern-then-deposit,” and/or hybrid approaches in which partial patterning, deposition, and subsequent trimming, modification, or etching are performed.

In some embodiments, hybrid bulk micromachining processes may be used to form heater-receiving structures in glass prior to heater deposition. Such hybrid processes may include, by way of example and not limitation, electrochemical discharge machining (ECDM), laser-induced etching, laser-induced backside wet etching (LIBWE), selective laser etching (SLE), and laser-induced deep etching (LIDE). In some embodiments, ECDM may combine electrical and chemical processes in which a direct current (DC) voltage is applied between an electrode and the glass in an electrolyte environment to produce localized discharges and localized material removal, and may be selected to reduce heat-affected zones or thermal shock relative to certain direct laser machining processes. In some embodiments, LIBWE may combine laser energy and wet chemistry to machine glass with reduced cracking or reduced substrate damage, and may be used to form channels or cavities for subsequent heater formation. In some embodiments, SLE and/or LIDE may comprise a two-step process in which an ultrashort-pulse laser modifies internal regions of glass followed by chemical etching to remove modified regions. By way of example and not limitation, LIDE-type processes may be performed using specialized laser platforms (e.g., laser systems commercially available from LPKF Laser & Electronics SE) or other suitable systems. The resulting bulk-micromachined features may then be combined with deposited or formed heater films to produce heater structures.

In some embodiments, suitable techniques for depositing heater materials on glass substrates or in glass-formed features may include vacuum deposition, solution-based deposition, electrochemical deposition, laser-assisted deposition, and combinations thereof. By way of example and not limitation, metal deposition methods may include physical vapor deposition (PVD) processes such as magnetron sputtering and evaporation (including electron-beam (e-beam) evaporation), electroless plating, electroplating, laser-induced forward transfer (LIFT), fiber-laser-assisted deposition, and laser reductive sintering. In some embodiments, magnetron sputtering may utilize direct current (DC) and/or radio frequency (RF) power for depositing metal thin films (e.g., chromium, nickel, gold, platinum) on a glass substrate, including embodiments in which an adhesion layer (e.g., chromium- or titanium-based) is deposited prior to depositing a heater layer (e.g., gold-, silver-, platinum-, nickel-based, or alloy-based). In some embodiments, e-beam evaporation may be used to form high-purity thin metallic layers and may be suitable for creating high-purity, precise, and thin metallic layers for high-performance, low-power heaters. In some embodiments, electroless plating (wet chemical deposition) may be used to deposit metals such as copper or nickel on glass surfaces, including embodiments in which catalytic activation is performed using a seed or catalyst. By way of example and not limitation, palladium-based activation may be used.

In some embodiments, electroplating may be used to increase thickness of a seed layer (e.g., a sputtered seed layer) to reduce resistivity of a heater trace or interconnect. In some embodiments, deposition processes may be configured to metallize through-glass vias (TGVs), which may comprise micro-scale vertical conductive channels through a glass substrate that are subsequently lined, coated, or filled with conductive material. In some embodiments, LIFT and/or fiber-laser-assisted deposition may be used in which a donor layer, shim, or foil is positioned relative to the glass and laser energy transfers molten or softened material to the glass surface to form a patterned conductive or resistive structure. In some embodiments, laser reductive sintering may involve applying metal-oxide-containing nanoparticle materials (e.g., nickel-oxide and/or copper-oxide based nanoparticle layers) and using laser energy to locally reduce and/or sinter the material to form a metallic heater pattern.

In some embodiments, carbon-based heater material deposition methods may include, by way of example and not limitation, chemical vapor deposition (CVD), laser-assisted CVD (L-CVD), printing methods (including screen printing and inkjet printing), hydrothermal synthesis, and combinations thereof. In some embodiments, CVD may be used to deposit carbon films including graphene-based films, graphitic films, amorphous carbon films, and/or diamond-like carbon (DLC) films on a glass substrate or on intermediate layers formed on a glass substrate. By way of example and not limitation, carbon film deposition may be performed at reduced and/or moderate temperatures suitable for selected glass substrates (e.g., temperatures on the order of about 300° C. to about 550° C. in certain implementations), though higher or lower temperatures may be used depending on the process and substrate. In some embodiments, laser-assisted CVD may be used to form localized carbon microstructures or patterned carbon features via hydrocarbon decomposition proximate the glass substrate, including embodiments that form two-dimensional or three-dimensional carbon microstructures.

In some embodiments, printing methods such as screen printing, inkjet printing, aerosol-based printing, or other printed-electronics methods described herein may be used to deposit CNT-based, graphene-based, graphite-based, or other carbon-based inks and pastes to form heater structures on glass substrates.

The foregoing deposition and formation methods may be used alone or in combination with, in conjunction with, and/or in sequence with bulk micromachining methods described herein to construct heaters on glass substrates or composite glass-based assemblies. In some embodiments, the selection among the foregoing process flows may be driven by manufacturing considerations including throughput, yield, equipment availability, line integration, and process control, or combinations thereof.

In some embodiments, a carbon material-based heater may be formed on a glass part and/or glass component serving as a substrate using hydrothermal synthesis and related hydrothermal carbonization and/or hydrothermal deposition processes. In such embodiments, a carbon precursor and the glass substrate may be exposed to elevated temperature and pressure in a sealed vessel (e.g., an autoclave) for a selected duration, resulting in formation and deposition of a carbon-rich coating on the glass substrate. The deposited carbonaceous coating may be electrically conductive or may be rendered electrically conductive by one or more post-processing steps, and may function as a resistive heater and/or as a heater-associated resistive layer. In some embodiments, hydrothermal synthesis may be used to deposit carbon-based materials on glass substrates for surface modification and heater formation, including, by way of example and not limitation, deposition of carbonaceous films, hydrochar layers, graphene-oxide-derived coatings, reduced-graphene-oxide-derived coatings, or combinations thereof. By way of example and not limitation, a precursor composition may comprise a carbon source such as glucose, sucrose, starch, cellulose-derived materials, lignin-derived materials, or combinations thereof, optionally together with one or more additives, catalysts, dopants, or functional precursors selected to influence microstructure, adhesion, porosity, resistivity, thermal stability, or combinations thereof.

In some embodiments, a process flow may include dissolving or dispersing a carbon precursor in a carrier liquid (e.g., water or an aqueous solution), immersing or otherwise contacting a glass substrate with the precursor composition, and performing hydrothermal treatment in a sealed vessel. By way of example and not limitation, hydrothermal treatment may be performed at temperatures on the order of about 180° C. to about 200° C. for durations on the order of about 1 hour to about 24 hours, though higher or lower temperatures and longer or shorter durations may be used depending on the precursor, desired coating characteristics, and vessel configuration. In some embodiments, pressure may be autogenous (i.e., self-generated in the sealed vessel) and may be on the order of about 1 MPa to about 2 MPa for certain temperature ranges, though higher or lower pressures may be used depending on temperature, fill fraction, and process configuration. In some embodiments, hydrothermal carbonization under subcritical water conditions may form a carbon-rich coating on the glass substrate.

In some embodiments, the precursor composition may be adjusted to a selected pH to influence hydrothermal reaction kinetics, deposition rate, particle nucleation, adhesion, porosity, and/or electrical properties of the resulting carbonaceous layer. By way of example and not limitation, the precursor composition may be acidic (e.g., pH about 1 to about 5), near-neutral (e.g., pH about 6 to about 8), or basic (e.g., pH about 9 to about 14), and pH adjustment may be achieved using acids, bases, buffers, or combinations thereof (e.g., HCl, H₂SO₄, acetic acid, NaOH, KOH, ammonium hydroxide, carbonate buffers, phosphate buffers, or combinations thereof). In some embodiments, pH may be selected to favor formation of a desired carbon microstructure, surface chemistry, or coating adhesion on glass.

In some embodiments, one or more catalysts, promoters, or reaction modifiers may be included to influence carbonization, reduction, graphitization, doping, microstructure formation, coating uniformity, or combinations thereof. By way of example and not limitation, catalysts or promoters may include metal ions or metal salts (e.g., iron, nickel, cobalt, copper, manganese, or molybdenum salts), acidic catalysts (e.g., mineral acids), basic catalysts (e.g., alkaline hydroxides), reducing agents (e.g., ascorbic acid, hydrazine, sodium borohydride), and/or structure-directing agents or surfactants, or combinations thereof. In some embodiments, catalytic species may be selected to promote formation of graphene-like domains, reduced-graphene-oxide-like coatings, or conductive carbon networks suitable for resistive heating.

In some embodiments, after hydrothermal processing, the coated glass substrate may be removed, washed, and dried. By way of example and not limitation, washing may be performed using water, alcohols (e.g., ethanol), or combinations thereof to remove residual precursor species and/or loosely bound byproducts. In some embodiments, conductivity and heater performance may be enhanced by one or more additional processing steps including, without limitation, thermal annealing, laser processing, chemical reduction, plasma treatment, photonic curing, or combinations thereof, thereby increasing conductivity, tailoring resistivity, modifying porosity, improving adhesion, and/or tuning heating performance. In some embodiments, hydrothermal synthesis may provide advantages including low cost, reduced reliance on vacuum equipment, and the ability to coat complex or non-planar glass substrate surfaces.

The foregoing hydrothermal synthesis processes are intended to serve as non-limiting examples, and it should be understood that other hydrothermal, solvothermal, carbonization, reduction, coating, or deposition processes—whether presently known or later developed—may be used alone or in combination with, in conjunction with, and/or in sequence with other manufacturing processes described herein to form carbon-based heater structures on glass substrates. It should be understood that other related, similar, or functionally equivalent hydrothermal synthesis processes—whether presently known or later developed—may be used alone or in combination to form heater elements and composite parts.

The bulk micromachining, micromachining, and related fabrication methods described herein for forming heater elements and/or associated heater electrical connections on glass substrates—alone or in combination with subsequent deposition, patterning, filling, coating, plating, trimming, bonding, and/or post-processing steps—are intended to serve as non-limiting examples. It should be understood that other related, similar, or functionally equivalent micromachining, deposition, and hybrid fabrication methods—whether presently known or later developed—may be used alone or in combination to form heater elements and composite parts. By way of example and not limitation, such methods may include bulk micromachining methods and related processes such as wet etching, dry etching, plasma etching, laser ablation or laser micromachining, electron-beam-based processing, ultrasonic machining (USM), abrasive jet machining (AJM), electrochemical discharge machining (ECDM), laser-induced backside wet etching (LIBWE), selective laser etching (SLE), laser-induced deep etching (LIDE), and combinations thereof, and may further include heater material formation processes such as physical vapor deposition (PVD), chemical vapor deposition (CVD), laser-assisted CVD (L-CVD), magnetron sputtering, evaporation (including e-beam evaporation), laser-induced forward transfer (LIFT), electroplating, electroless plating, printing processes (including screen printing and inkjet printing), hydrothermal synthesis, and combinations thereof.

In some embodiments, such methods may be implemented using “deposit-then-pattern,” “pattern-then-deposit,” and/or hybrid process flows, including embodiments in which deposited layers are subsequently modified, trimmed, etched, reduced, densified, or otherwise processed to achieve desired electrical and/or thermal characteristics.

In some embodiments, a fused-silica part or component may serve as the substrate for such micromachining and heater-formation process chains, such that the resulting composite part comprises a heater formed on and/or within the fused-silica substrate. In such embodiments, the fused-silica part may function as the fabrication substrate during heater formation, subsequently function as a structural support for the heater, and may further function as at least a portion of a chamber and/or other functional component of a vaporizing device.

It should be understood that materials other than glass may also be used as substrates for such processes. By way of example and not limitation, suitable substrates may include other glass materials (e.g., quartz glass, borosilicate glass), ceramic materials, glass-ceramic materials, metal-glass composite materials, and/or other substrate materials described herein.

The foregoing micromachining and heater-formation methods and substrate materials may be used alone or in combination with, in conjunction with, and/or in sequence with other manufacturing processes described herein to form parts, components, and/or composite parts comprising glass, ceramic, metal, carbon-based materials, polymers, elastomers, or combinations thereof.

In some embodiments, heater elements and/or associated heater electrical connections formed on a glass substrate (e.g., fused silica or another silica-based glass) may be configured with selected structural and geometric characteristics to achieve desired heater performance attributes. Such attributes may include, by way of example and not limitation, reduced power consumption, reduced thermal mass, rapid thermal response, temperature uniformity across the heater pattern, enhanced thermal isolation from surrounding device components, stable operation over a selected temperature range, or combinations thereof. In such embodiments, heater performance may be influenced not only by heater material selection, but also by the physical configuration, pattern geometry, and spatial distribution of the heater.

In some embodiments, heater performance may be improved by reducing thermal mass beneath and/or adjacent to the heater, thereby increasing thermal resistance and reducing thermal capacitance. By way of example and not limitation, removal or reduction of substrate material beneath a heater region (e.g., by etching, micromachining, cavity formation, membrane formation, or combinations thereof) may reduce heat loss to the surrounding structure, reduce power required to reach a target temperature, and improve heater response time (i.e., the time required for the heater to reach an operating temperature).

In some embodiments, the thickness of a heater element may be selected to adjust electrical resistance and thermal behavior. By way of example and not limitation, reducing heater thickness may increase electrical resistance, which may reduce current draw for a given applied voltage and thereby reduce power consumption and/or peak heater temperature, depending on operating conditions. In some embodiments, the electrical resistance of a heater may be determined at least in part by the physical dimensions of the heater, including path length, trace length, trace width, thickness, cross-sectional area, and overall pattern geometry. By way of example and not limitation, heater resistance may be expressed as:

$$R = pl / A$$

where R is the resistance at the same temperature at which p is specified, p is the resistivity of the material in (e.g., in Ohms/m), l is the length of the resistor (e.g., in meters), and A is the cross-sectional area (width×thickness) (e.g., in square meters). Accordingly, heater resistance and power dissipation may be tuned by adjusting one or more of these geometric and/or material parameters.

In some embodiments, altering resistance alone may be insufficient to optimize heater performance, as heater pattern geometry may significantly affect thermal uniformity. Certain heater patterns may confine heat to a central region, resulting in higher temperatures at the center of the heater pattern and lower temperatures toward outer regions. Such temperature gradients may be undesirable for certain applications. In some embodiments, thermal uniformity across a heater pattern may be improved by constructing the heater with a spatially varying resistance profile. By way of example and not limitation, a heater may be configured such that resistance is higher in a central region of the heater pattern and decreases progressively toward outer regions of the heater pattern. In such embodiments, the resistance transition may occur gradually, in stepped increments, or in a continuously varying manner.

In some embodiments, a spatially varying resistance profile may be achieved by varying the width of the heater trace along its path length, such that narrower trace widths (and therefore higher resistance per unit length) are present in central regions of the heater pattern and wider trace widths (lower resistance per unit length) are present toward outer regions. In some embodiments, a spatially varying resistance profile may additionally or alternatively be achieved by varying the spacing, pitch, or density of heater traces, such that trace density is lower in central regions of the heater pattern and increases progressively toward outer regions. Stated another way, in some embodiments, the effective heater surface area per unit region may be lowest in a central region of the heater pattern and may increase with radial distance, lateral distance, or path distance from the center. Such configurations may result in more uniform temperature distribution when the heater is energized, as regions with greater heat dissipation capability may be supplied with proportionally lower resistance. In some embodiments, the heater pattern may be radial, annular, spiral, serpentine, or combinations thereof, and the resistance gradient may be defined relative to a geometric center, axis, axes, and/or flow path.

The foregoing structural and geometric heater configurations are intended to serve as non-limiting examples. It should be understood that other heater geometries, resistance gradients, density distributions, dimensional variations, and structural configurations—whether presently known or later developed—may be used alone or in combination to tailor heater performance for a given application.

In some embodiments, thermal uniformity across a heater pattern may be improved by configuring the heater with a spatially varying resistance distribution such that heat generation is more evenly balanced across the heater area when energized. By way of example and not limitation, a heater may be designed such that electrical resistance is higher in a central region of the heater pattern and decreases progressively toward outer regions of the pattern. In such embodiments, the resistance transition may occur in discrete steps, graduated increments, or as a substantially continuous gradient.

In some embodiments, a spatially varying resistance distribution may be achieved by varying one or more geometric parameters of the heater pattern along its path length or across its area. By way of example and not limitation, the width of a heater trace in a central region may be selected to be narrower than the width of the heater trace in outer regions, thereby increasing resistance per unit length in the central region relative to the outer regions.

In some embodiments, a spatially varying resistance distribution may additionally or alternatively be achieved by varying the spacing, pitch, or density of heater traces, such that trace density is lower in a central region of the heater pattern and increases progressively toward outer regions. Stated another way, in some embodiments, the effective heater surface area per unit region may be lowest in a central portion of the heater pattern and may increase with increasing distance from the center of the heater pattern. In such configurations, heater density may be lowest at or near the center of the heater pattern and highest at or near the outermost regions of the heater pattern, with the change in density occurring gradually or in controlled increments. Such spatial distributions may reduce localized hot spots and improve temperature uniformity across the heater during operation.

In some embodiments, thermal uniformity and high-temperature performance of a heater may be improved through selection and modification of the overall heater pattern geometry. By way of example and not limitation, serpentine, spiral, meandering, annular, or double-spiral heater patterns may provide improved thermal distribution relative to grid-type heater patterns for certain applications.

In some embodiments, spiral or serpentine heater patterns may be modified to include a reduced-density region or void in a central portion of the heater pattern to further improve temperature uniformity. By way of example and not limitation, a spiral heater pattern may include a central void having a circular, ovoid, elliptical, polygonal, or otherwise non-circular shape, and the heater trace may be arranged around the void with a selected pitch or spacing profile.

In some embodiments, double-spiral patterns, counter-wound spiral patterns, nested spiral patterns, or combinations thereof may be used to improve symmetry of current flow and heat distribution. In some embodiments, hybrid heater patterns may be formed by combining features of multiple pattern types, such as serpentine-spiral combinations or double-spiral square patterns, to tailor temperature uniformity, edge heating behavior, and peak temperature performance.

The foregoing heater patterning techniques and geometric configurations are intended to serve as non-limiting examples. It should be understood that other heater geometries, resistance gradients, density distributions, void shapes, and pattern variations—whether presently known or later developed—may be used alone or in combination to tailor thermal uniformity, efficiency, and performance of heaters formed on glass substrates.

In some embodiments, heater elements may be constructed using two or more different conductive or resistive materials arranged within a single heater pattern to form parallel, series, or hybrid heater structures with spatially controlled current distribution. In such embodiments, differences in electrical conductivity and resistivity among the selected materials may be used to tailor current flow and heat generation across different regions of the heater pattern, thereby improving temperature uniformity and overall thermal performance. By way of example and not limitation, heater structures may comprise combinations of metals and/or metal alloys including aluminum (Al), copper (Cu), gold (Au), silver (Ag), nickel-chromium alloys (NiCr or nichrome), platinum (Pt), titanium (Ti), tungsten (W), or combinations thereof. In some embodiments, a more resistive material (e.g., a nickel-chromium alloy or other high-resistivity material) may be used in a central region of the heater pattern to reduce current density and heat generation in that region, while a less resistive material (e.g., platinum, gold, silver, copper, or alloys thereof) may be used in outer regions of the heater pattern to increase current flow and compensate for edge heat loss.

In some embodiments, the material-based resistance profile may be selected such that current flow in outer regions of the heater pattern is greater than current flow in a central region. By way of example and not limitation, current flow in an outer region of the heater pattern may be on the order of about two times the current flow in a central region of the heater pattern, though other ratios may be selected depending on heater geometry, material properties, and desired thermal performance. In some embodiments, material-based resistance variation may be used alone or in combination with geometric resistance variation (e.g., trace width, trace spacing, density gradients) to further optimize temperature uniformity and heating efficiency. In some embodiments, heater patterns comprising multiple materials may be formed as layered structures, segmented traces, interleaved traces, and/or regionally distinct zones within a single heater layout. Transitions between different materials may be abrupt, stepped, and/or graded, and may be selected to control current distribution, minimize localized hot spots, reduce electromigration, and/or improve long-term reliability.

It should be understood that the material-based heater construction methods and structural configurations described herein for metal-based heaters may likewise be applied to carbon-based or carbonaceous heater structures formed on glass substrates. By way of example and not limitation, carbon-based heater regions having different resistivities (e.g., graphene-based regions, carbon-nanotube-based regions, amorphous carbon regions, or combinations thereof) may be combined within a single heater pattern to achieve spatially varying resistance profiles analogous to those described for metal-based heaters.

The foregoing material-differentiated heater structures and methods are intended to serve as non-limiting examples. It should be understood that other combinations of conductive, resistive, or semiconductive materials—whether presently known or later developed—may be used alone or in combination with, in conjunction with, and/or in sequence with other heater-formation methods and structural configurations described herein to form heater elements and composite parts comprising glass, ceramic, metal, carbon-based materials, polymers, elastomers, or combinations thereof.

In some embodiments, a heater assembly (e.g., heater 140) may comprise a single heater or a plurality of heaters and associated heater electrical connections formed on a glass substrate, such as fused silica, thereby forming a composite part. In such embodiments, the fused-silica part functions as the substrate and/or support structure for heater formation and, once the heater is formed, continues to function as the heater support structure. In some embodiments, the same fused-silica part additionally functions as at least a portion of a chamber (e.g., chamber 130), such that the composite part integrates heater support and chamber functionality into a single glass structure.

In some embodiments, a region of the fused-silica part that serves as the heater support structure is in direct physical contact with the heater on at least one surface and is thermally coupled to the heater by such direct contact. In such embodiments, the heater may contact the fused-silica substrate along one or more surfaces and may be configured such that thermal energy generated by the heater is transferred primarily into the fused-silica substrate. The fused-silica region in thermal contact with the heater may thereby be directly heated and function as a heat-transfer medium.

In some embodiments, heat conducted through the fused-silica substrate flows from the heater-contacting surface to an opposing surface of the fused-silica part that forms an internal surface of the chamber. In such embodiments, the opposing surface of the fused-silica part is heated by conduction through the glass and is configured to be in contact with a liquid precursor (e.g., liquid precursor 103), such that the liquid precursor is heated by the fused-silica surface to form an aerosol and/or vapor (e.g., aerosol 106 and/or vapor 105).

In certain embodiments, an interior surface of a fused-silica chamber body defining a vaporization chamber region may be intentionally structured to increase surface area relative to a smooth surface. Such surface structuring may be provided on one or more portions of the fused-silica chamber body that are configured to contact a liquid precursor and/or an aerosol formed therefrom, including portions of the fused-silica chamber body that oppose or are thermally coupled to a heater structure. Increasing the surface area of the interior surface may enhance heat transfer from the fused-silica chamber body to the liquid precursor, promote more uniform vaporization, increase residence time of the liquid precursor or aerosol within a heated region, and/or improve vaporization efficiency.

The surface structuring may comprise a plurality of micro-scale or meso-scale features including, by way of example, ridges, grooves, pits, channels, protrusions, depressions, or combinations thereof, which may be arranged in regular, semi-regular, or irregular patterns. The surface features may be homogeneous across an interior surface region or heterogeneous across different regions of the fused-silica chamber body, and may be selected to influence liquid wetting behavior, capillary action, nucleation behavior, and/or thermal coupling between the fused-silica chamber body and the liquid precursor.

In some embodiments, the fused-silica part may include a thin fused-silica region that functions as a membrane structure. In such embodiments, a first surface of the fused-silica membrane serves as the substrate surface on which the heater is formed, deposited, or attached, and a second, opposing surface of the fused-silica membrane serves as an internal surface of the chamber. The heater may be formed on the first surface of the membrane, and the second surface of the membrane may be heated by thermal conduction through the fused-silica membrane.

In some embodiments, the fused-silica membrane may have a thickness selected to balance thermal response, mechanical robustness, and/or isolation performance. By way of example and not limitation, the fused-silica membrane may have a thickness on the order of about 0.01 mm to about 1.0 mm, including embodiments in which the thickness is on the order of about 0.1 mm to about 0.3 mm. In such embodiments, the membrane thickness may be selected such that the fused-silica region heats rapidly and uniformly while maintaining structural integrity and providing a barrier between the heater and the liquid precursor.

In some embodiments, the heater is configured and optimized to uniformly and rapidly heat the fused-silica membrane region, and the fused-silica membrane functions as the heated surface that transfers thermal energy to the liquid precursor for aerosol formation. In such embodiments, the heater does not directly contact the liquid precursor. In some embodiments, the fused-silica membrane has a thickness on the order of about 0.2 mm. In some embodiments, the fused-silica membrane structure functions both as a heat-transfer element and as a physical barrier that prevents direct contact between the heater and the liquid precursor. In such embodiments, the heater is isolated from the liquid precursor by the fused-silica membrane while remaining thermally coupled to the membrane. The chamber-facing surface of the fused-silica membrane may thereby function as the effective heating surface for the liquid precursor, while the heater remains physically separated from the precursor material.

In some embodiments, the chamber may be constructed such that at least a portion of the chamber wall comprises the fused-silica membrane region. In such embodiments, the fused-silica membrane serves simultaneously as (i) the heater substrate, (ii) the heater support structure, (iii) a chamber wall, and (iv) a thermal transfer interface for heating the liquid precursor. This integrated configuration may reduce thermal mass, improve heating efficiency, enhance temperature uniformity, and/or prevent direct interaction between the heater material and the liquid precursor.

The foregoing composite fused-silica heater-membrane-chamber configurations are intended to serve as non-limiting examples. It should be understood that other thicknesses, membrane geometries, heater placements, and composite glass configurations—whether presently known or later developed—may be used alone or in combination to achieve thermal coupling, heater isolation, and chamber integration as described herein.

In some embodiments, a heater assembly formed on a glass substrate, such as fused silica, may comprise a composite part in which the fused-silica part functions as a substrate and/or support structure for heater formation and, once formed, continues to function as a heater support structure. In such embodiments, the composite part may additionally function as at least a portion of a chamber (e.g., chamber 130). Unlike embodiments in which the heater is in direct thermal contact with the fused-silica substrate over a substantial area, in some embodiments the heater may be configured such that only limited regions of the heater are in direct contact with the fused-silica part, for example at electrical connection and/or support locations, while a functional heating region of the heater is suspended and not in direct contact with the fused-silica substrate.

In some embodiments, the suspended heater may be mechanically supported by the fused-silica part at one or more contact regions associated with electrical connection features (e.g., electrical contacts 806) that deliver power to the heater. In such embodiments, the functional region of the heater that generates thermal energy is spaced apart from the fused-silica substrate and is suspended relative to the substrate. The fused-silica part may thereby function as a structural support for the heater while remaining out of direct contact with the primary heat-generating region of the heater.

In some embodiments, the composite fused-silica part may include a thin fused-silica region that functions as a membrane structure. By way of example and not limitation, the fused-silica membrane may have a thickness on the order of about 0.01 mm to about 0.3 mm. In such embodiments, a first surface of the fused-silica membrane may serve as the substrate surface for heater support and/or electrical contact features, while a second, opposing surface of the fused-silica membrane may serve as at least a portion of an internal surface of the chamber. In some embodiments, the fused-silica membrane has a thickness on the order of about 0.2 mm.

In some embodiments, a suspended heater may be configured to transfer thermal energy to the fused-silica membrane indirectly, for example by thermal radiation, convection, and/or limited conductive coupling at support points. In such embodiments, the suspended heater may emit thermal energy that is at least partially radiative, including infrared (IR) radiation and/or ultraviolet (UV) radiation. The suspended heater may be further configured such that the emitted thermal energy is directional, focused, or preferentially oriented toward the fused-silica membrane region of the composite part. In some embodiments, the fused-silica membrane may absorb thermal radiation and/or heat emitted by the suspended heater, causing the membrane to heat and function as the effective heating surface for a liquid precursor (e.g., liquid precursor 103) contained within the chamber. In such embodiments, the chamber-facing surface of the fused-silica membrane is heated by absorption of emitted thermal energy, and the liquid precursor is heated by contact with the fused-silica membrane to form an aerosol (e.g., aerosol 106) and/or a vapor (e.g., vapor 105). In such embodiments, the suspended heater remains physically isolated from the liquid precursor and does not directly contact the liquid precursor. The fused-silica membrane thereby functions as a thermal interface and a physical barrier between the heater and the liquid precursor, while the heater functions as a non-contact thermal energy source. In some embodiments, the suspended heater architecture may be selected to reduce contamination risk, improve heater longevity, enable higher operating temperatures, tailor thermal radiation profiles, or combinations thereof.

The foregoing suspended-heater and indirect-heating configurations are intended to serve as non-limiting examples. It should be understood that other suspended heater geometries, support arrangements, emission characteristics, membrane thicknesses, and composite glass configurations—whether presently known or later developed—may be used alone or in combination to achieve indirect heating, heater isolation, and chamber integration as described herein.

In some embodiments, a fused-silica structure that functions as a heater support and/or chamber wall may comprise a thin fused-silica membrane configured to be heated indirectly by absorption of thermal energy and/or emitted radiation. By way of example and not limitation, the fused-silica membrane may have a thickness on the order of about 0.01 mm to about 0.3 mm. In such embodiments, a first surface of the fused-silica membrane may serve as a substrate surface for heater support structures and/or heater electrical connection features (e.g., electrical contacts 806), while a second, opposing surface of the membrane may serve as an internal surface of a chamber (e.g., chamber 130).

In some embodiments, the fused-silica membrane may be heated indirectly by absorption of thermal energy and/or radiative energy emitted by a heater that is suspended relative to the membrane. By way of example and not limitation, the emitted energy may include infrared (IR) radiation and/or ultraviolet (UV) radiation. In such embodiments, the fused-silica membrane itself functions as the effective heating structure, such that thermal energy absorbed by the membrane is conducted through the membrane and transferred to a liquid precursor (e.g., liquid precursor 103) in contact with the chamber-facing surface of the membrane. The liquid precursor may thereby be heated directly by the fused-silica membrane to form an aerosol (e.g., aerosol 106) and/or a vapor (e.g., vapor 105).

In some embodiments, the fused-silica part may be selectively configured to absorb radiative energy in one or more wavelength ranges, including, by way of example and not limitation, IR and/or UV wavelengths. Such selective absorption may be achieved by material selection, doping, surface treatment, coatings, texturing, or other methods described herein, such that at least a region of the fused-silica membrane preferentially absorbs emitted thermal and/or non-thermal (e.g., UV) radiation. In such embodiments, the fused-silica membrane remains physically isolated from the heater, while the heater remains physically isolated from the liquid precursor, and the fused-silica membrane functions as both a thermal interface and a physical barrier between the heater and the liquid precursor.

In some embodiments, heater elements formed on (and/or attached to) or in association with a glass substrate, such as fused silica, may comprise resistive heater elements configured to generate heat by Joule heating when electrically energized. In some embodiments, such resistive heater elements may additionally function as temperature sensing elements and/or temperature detectors. By way of example and not limitation, electrical resistance of a resistive heater element may vary as a function of temperature, and such resistance variation may be used to infer heater temperature, substrate temperature, membrane temperature, or combinations thereof.

In some embodiments, a heater element may therefore function as both a heat source and a temperature sensor, thereby reducing component count and enabling closed-loop control of heating performance. In such embodiments, temperature sensing may be performed using the same conductive or resistive structure used for heating, or using a portion thereof, and may be used alone or in combination with additional temperature sensing elements described herein.

The foregoing dual-use heater and heater-sensor configurations are intended to serve as non-limiting examples, and it should be understood that other heater-integrated sensing architectures—whether presently known or later developed—may be used in conjunction with the heater structures described herein. In some embodiments, a resistive heater element formed on (and/or attached to) or in association with a glass substrate (e.g., fused silica) may additionally function as a temperature sensor and/or temperature detector. In such embodiments, the heater element may be constructed from a material having a temperature-dependent electrical resistivity, such that the electrical resistance of the heater varies predictably as a function of temperature. This temperature-dependent resistance may be monitored either during operation, non-operation, or both, and used to determine the temperature of the heater, the glass substrate, a fused-silica membrane, or combinations thereof.

In some embodiments, the heater operates according to the principle of Joule (resistance) heating, wherein electrical current passing through the heater generates thermal energy and the electrical resistance of the heater increases as the temperature of the heater increases. In such embodiments, the same resistive element that generates heat may be electrically interrogated to measure resistance in real time. The measured resistance may be correlated to temperature using a known or calibrated resistance-versus-temperature relationship, thereby allowing the heater to function as a resistance temperature detector (RTD).

In some embodiments, the heater-RTD element may be electrically coupled to a controller (e.g., controller 480 or another control system described herein), which may be configured to monitor heater resistance, infer temperature, and adjust electrical power supplied to the heater in a closed-loop manner. Such configurations may reduce component count, simplify system architecture, and improve temperature control accuracy by eliminating the need for a separate, discrete temperature sensor. In some embodiments, materials suitable for forming a heater that also functions as an RTD may include, by way of example and not limitation, metals, metal alloys, metal nitrides, conductive ceramics, or combinations thereof having a positive temperature coefficient of resistance (TCR). By way of example and not limitation: platinum, which may be used based on its high, stable, and nearly linear TCR, chemical inertness, and/or high melting point (approximately 1768° C.), making it well suited for high-temperature heater-RTD applications on glass; titanium, which may be used based on its good adhesion to glass substrates and temperature-dependent resistivity, and may exhibit a TCR on the order of approximately 4.2×10⁻³ K⁻¹ in certain thin-film implementations; nickel and nickel-based alloys (including nickel-iron alloys), which may be used in heater-RTD structures where higher sensitivity is desired, optionally in combination with other heater materials; silver, which may be used based on its high electrical and/or thermal conductivity and/or compatibility with glass substrates in certain heater-RTD configurations; nickel-chromium alloys, which may be used based on their relatively high resistivity, temperature-dependent resistance, and/or suitability for generating significant heat while providing temperature sensing capability; titanium nitride, which may be used as a conductive ceramic heater-RTD material offering high-temperature stability (e.g., on the order of about 700° C. in certain implementations) and, in some embodiments, improved resistance stability or linearity relative to pure metal thin films; refractory metals, such as molybdenum (Mo), tungsten (W), and tantalum (Ta) may be used in heater-RTD structures for very high-temperature applications, as such materials exhibit substantial increases in resistance with increasing temperature and high melting points. In some embodiments, combinations of the foregoing materials, including alloys, multilayer stacks, graded compositions, or composite structures, may be used to tailor resistivity, TCR, adhesion, stability, and heater-sensor performance.

The foregoing heater-RTD configurations are intended to serve as non-limiting examples, and it should be understood that other temperature-dependent resistive materials and heater-integrated sensing architectures—whether presently known or later developed—may be used alone or in combination with the heater structures described herein.

In some embodiments, a heater element formed on (and/or attached to) or in association with a glass substrate (e.g., fused silica) may function as a temperature sensor and/or temperature detector, as described herein, and may be used alone or in combination with one or more additional temperature sensors integrated with the heater assembly. In such embodiments, temperature sensing may be performed using (i) the heater itself acting as a resistance temperature detector (RTD), (ii) one or more discrete temperature sensors formed on (and/or attached to) the same glass substrate as the heater, or (iii) combinations thereof, thereby enabling real-time temperature monitoring, redundancy, and closed-loop control.

In some embodiments, an additional temperature sensor and/or temperature detector may be formed on (and/or attached to) the same glass part or glass component that serves as the substrate for the heater and may be used to measure the temperature of the heater, the temperature of the glass substrate, the temperature of a fused-silica membrane, and/or the temperature of a chamber surface being heated. Such temperature sensors may be used in isolation from the heater-RTD function or in combination therewith to provide calibration, redundancy, safety monitoring, or spatially resolved temperature measurement.

In some embodiments, temperature sensors suitable for integration with glass-based heater assemblies may include, by way of example and not limitation, resistance temperature detectors (RTDs), thermistors (including negative temperature coefficient (NTC) thermistors), thermocouples, and semiconductor-based integrated circuit (IC) temperature sensors. Such sensors may be formed using thin-film deposition, printing, micromachining, or other fabrication processes described herein and may be selected for compatibility with glass substrates, heater operating temperatures, and microfabrication workflows.

In some embodiments, RTDs may be used as integrated temperature sensors due to their stability, repeatability, and suitability for thin-film fabrication on glass. RTDs may be formed from metals or metal alloys including, by way of example and not limitation, platinum, nickel, nickel-iron alloys, copper-based alloys, or combinations thereof. In some embodiments, RTDs may be fabricated using the same material and patterning processes as the heater, enabling a combined heater-RTD structure (e.g., in a serpentine or meander-type geometry) that performs both heating and temperature sensing functions. In some embodiments, such RTD structures may be incorporated into bridge circuits (e.g., Wheatstone bridge configurations) to improve measurement accuracy and noise rejection. By way of example and not limitation: platinum RTDs, including Pt100 and Pt1000 configurations, which may be used based on their exceptional stability, linearity, and/or ability to withstand high operating temperatures (e.g., up to approximately 850° C.), making them well suited for glass-based heater and heater-sensor assemblies; Nickel RTDs, which may be used as a lower-cost alternative with good linearity over a more limited temperature range (e.g., approximately −80° C. to 260° C.), suitable for applications not requiring higher temperatures; copper RTDs, which may be used for lower-temperature applications (e.g., approximately −200° C. to 260° C.), with consideration given to oxidation behavior at elevated temperatures; silver-based structures, including thin-film silver layers or silver nanoparticle formulations, which may be used in advanced deposition and/or printing processes (e.g., electrohydrodynamic printing or related methods described herein) to form low-cost RTDs and/or combined heater-RTD assemblies with relatively high temperature coefficients of resistance.

In some embodiments, additional sensor types may be used, including NTC thermistors for high sensitivity over narrower temperature ranges, thermocouples for wide-range or differential temperature measurement, and/or semiconductor-based IC temperature sensors for integration with control electronics. Such sensors may be placed proximate to, adjacent to, or spatially offset from the heater to provide localized temperature feedback, gradient measurement, and/or safety monitoring.

The foregoing heater-integrated and glass-integrated temperature sensing configurations are intended to serve as non-limiting examples. It should be understood that other temperature sensing materials, sensor architectures, integration schemes, and redundant or multi-sensor configurations—whether presently known or later developed—may be used alone or in combination with the heater structures described herein to monitor and control temperature in glass-based heater and chamber assemblies.

In some embodiments, integrated temperature sensors and/or temperature detectors used in conjunction with glass-based heater assemblies may comprise negative temperature coefficient (NTC) thermistors. NTC thermistors may be selected for their high sensitivity, rapid thermal response, and suitability for integration with heater structures formed on (or attached to) a glass substrate (e.g., fused silica). In such embodiments, NTC thermistors may be used alone or in combination with heater-RTD structures to provide real-time temperature monitoring, redundancy, calibration, or safety control.

In some embodiments, NTC thermistors integrated with glass-based heaters may comprise glass-encapsulated or surface-mount device (SMD) NTC thermistors. By way of example and not limitation, such NTC thermistors may be configured for operation at elevated temperatures, including temperatures on the order of up to about 300° C., and may exhibit rapid thermal response and resistance to moisture, corrosion, and chemical exposure. Glass encapsulation may provide hermetic sealing and long-term stability in harsh thermal environments associated with heater operation. By way of example and not limitation, suitable NTC thermistor package types may include small glass-bead configurations (e.g., diode-style glass bead packages such as DO-35-type packages) that provide compact size and fast thermal response, as well as cylindrical metal-electrode leadless face (MELF) packages (e.g., SOD27- or SOD80-type packages) that are hermetically sealed in glass and suitable for surface-mount integration. Such package types may be particularly well suited for integration with heater assemblies formed on (or attached to) glass substrates where size constraints, thermal robustness, and environmental resistance are desired.

In some embodiments, NTC thermistors may be integrated with a heater assembly by being formed on, attached to, embedded within, or positioned proximate to the glass substrate that serves as the heater support structure. By way of example and not limitation, glass-bead NTC thermistors may be bonded or mounted directly onto a glass substrate in close thermal proximity to the heater or fused-silica membrane, enabling rapid and accurate measurement of heater or substrate temperature.

In some embodiments, surface-mount NTC thermistor chips may be used to form compact, integrated heater-sensor assemblies on glass substrates, including embodiments in which the heater and sensor are fabricated or assembled on the same glass part. In some embodiments, NTC thermistors may be selected and positioned to measure the temperature of a heater element, the temperature of the glass substrate, the temperature of a fused-silica membrane, and/or the temperature of a chamber surface that is heated by the heater assembly. Such configurations may be used to provide localized temperature feedback, gradient detection, or spatially resolved sensing across a heater assembly.

In some embodiments, thin-film or silicon-based NTC thermistors may be used as integrated temperature sensors in glass-based heater assemblies. Such NTC devices may be fabricated as glass-sealed or glass-encapsulated components to withstand elevated temperatures and thermal cycling associated with heater operation. Glass encapsulation may provide resistance to corrosion and moisture ingress while enabling accurate, fast, and stable temperature measurement over extended operating lifetimes. In some embodiments, NTC thermistors may be used in combination with resistive heater-RTD elements, thermocouples, or other temperature sensors described herein to provide redundant temperature sensing, cross-calibration, or fault detection.

The foregoing NTC thermistor-based sensor configurations are intended to serve as non-limiting examples, and it should be understood that other thermistor materials, package types, encapsulation strategies, and integration schemes—whether presently known or later developed—may be used alone or in combination with the heater structures described herein to monitor and control temperature in glass-based heater and chamber assemblies.

In some embodiments, thermocouples may be used as integrated temperature sensors and/or temperature detectors in conjunction with heater assemblies formed on (or attached to) a glass substrate, such as fused silica. Thermocouples may be selected for their fast thermal response, wide operating temperature range, and suitability for localized temperature measurement. In such embodiments, thin-film thermocouples (TFTCs) may be formed directly on the glass substrate using microfabrication, MEMS-based fabrication, thin-film deposition, or other fabrication techniques described herein, thereby enabling high-precision, spatially localized temperature monitoring of heater structures, glass substrates, fused-silica membranes, or chamber surfaces.

In some embodiments, thermocouples may be integrated with a heater assembly by forming two dissimilar conductive or semiconductive materials in thermal contact at a junction region, with the junction positioned proximate to or on a heater element, heater support structure, or glass membrane. Such thermocouple junctions may be patterned using thin-film deposition and lithographic patterning, laser patterning, or other techniques described herein, and may be electrically routed to measurement circuitry to detect a thermoelectric voltage indicative of temperature. In some embodiments, thermocouple material pairs suitable for thin-film integration on glass substrates may include, by way of example and not limitation: platinum-chromium thermocouples, which may be used as thin-film thermocouples on glass substrates to monitor heater temperature and/or glass substrate temperature, particularly in compact or microscale heater assemblies; chromel-alumel (Type K) thermocouples, which may be formed as thin-film structures using standard Type K material combinations, suitable for integration on glass substrates for wide-range temperature monitoring; chromium-chromium nitride (Cr—CrN) or CrN—Pt thermocouples, which may be selected based on their high thermal stress resistance, stability, and/or compatibility with high-temperature heater operation on glass substrates; indium-tin oxide-indium oxide (ITO-In₂O₃) thermocouples, which may be formed as transparent or semi-transparent thin-film thermocouples encapsulated in glass and/or microcrystalline glass layers, and which may be suitable for high-temperature operation (e.g., up to on the order of about 1100° C. in certain implementations); gold-palladium (Au—Pd) thermocouples, which may be used to form high-density, micro-scale thermocouple arrays on glass substrates for localized or distributed temperature sensing; nickel-nickel chromium (Ni—NiCr) thermocouples, which may be selected based on their high sensitivity and low thermal mass, making them well suited for integrated heater-thermocouple systems on glass substrates.

In some embodiments, thermocouples may be positioned to measure the temperature of a heater element directly, the temperature of a glass substrate or fused-silica membrane heated by the heater, or the temperature of a chamber surface proximate to a liquid precursor. In some embodiments, thermocouples may be used alone or in combination with heater-RTD elements, NTC thermistors, or other temperature sensors described herein to provide redundant temperature sensing, cross-calibration, spatial temperature mapping, or safety monitoring.

The foregoing thermocouple-based temperature sensing configurations are intended to serve as non-limiting examples. It should be understood that other thermocouple material systems, thin-film thermocouple geometries, encapsulation strategies, and integration schemes—whether presently known or later developed—may be used alone or in combination with the heater structures described herein to monitor and control temperature in glass-based heater and chamber assemblies.

In some embodiments, the integration characteristics of a temperature sensor and/or temperature detector formed on, attached to, or in proximity to a glass substrate (e.g., fused silica) may influence sensor selection, material stack design, and/or fabrication approach. In such embodiments, certain sensor architectures may utilize multilayer material stacks to improve adhesion, mechanical stability, electrical performance, and/or long-term reliability on glass substrates. By way of example and not limitation, multilayer structures comprising combinations of chromium, chromium nitride, and platinum (e.g., Cr—CrN—Pt) may be used to improve adhesion to glass, reduce thermal stress, and stabilize electrical properties of temperature sensing elements formed on (or attached to) glass substrates.

In some embodiments, temperature sensor selection may be based on desired response time and/or thermal coupling characteristics. By way of example and not limitation, thin-film thermocouples and/or thin-film RTD structures may be preferentially selected in embodiments requiring fast response and high spatial resolution, as such thin-film sensors typically have low thermal mass and may provide rapid, high-accuracy temperature measurement when integrated on glass substrates.

In some embodiments, optical characteristics of the temperature sensor and/or temperature detector may be a consideration in sensor selection and/or integration. By way of example and not limitation, transparent and/or semi-transparent temperature sensors may be formed using materials such as indium tin oxide (ITO) and/or related transparent conductive oxides. Such transparent sensor structures may be advantageous in embodiments where optical access, visual inspection, and/or optical functionality is desired, and may be readily miniaturized and/or localized for on-chip or glass-integrated heater assemblies.

In some embodiments, environmental sensitivity and long-term stability may influence the selection and/or integration of temperature sensors in glass-based heater assemblies. By way of example and not limitation, while certain thermocouple types (e.g., Type K thermocouples) may be widely used, such thermocouples may exhibit drift under prolonged high-temperature exposure and/or in reducing and/or chemically aggressive atmospheres. In such embodiments, platinum-based temperature sensors, specialized thin-film thermocouples, and/or other stable material systems may be selected to provide improved long-term accuracy and reliability.

In some embodiments, temperature sensing elements may be deposited directly onto the glass substrate using thin-film deposition techniques including, by way of example and not limitation, sputter deposition, electron-beam evaporation, and/or other deposition processes described herein. Such sensors may be patterned using lithographic, etching, and/or laser-based methods and electrically coupled to a controller (e.g., controller 480 or another control system described herein) to provide real-time temperature feedback. In such embodiments, the temperature sensor may be integrated into a feedback loop for controlling heater power, monitoring operating conditions, detecting fault states, or combinations thereof.

The foregoing sensor integration criteria, multilayer material configurations, and environmental-stability considerations are intended to serve as non-limiting examples. It should be understood that other sensor materials, multilayer stacks, deposition methods, encapsulation strategies, and integration approaches—whether presently known or later developed—may be used alone or in combination with the heater and sensor structures described herein to achieve desired performance, robustness, and/or control in glass-based heater assemblies.

In some embodiments, thermo-resistive sensors may be used as integrated temperature sensors and/or temperature detectors in conjunction with heater assemblies formed on (or attached to) a glass substrate, such as fused silica. Thermo-resistive sensors utilize the temperature-dependent electrical resistivity of a material to detect temperature changes and may be particularly well suited for integration with glass-based heaters due to their compatibility with thin-film fabrication and micro-patterning processes. In some embodiments, thermo-resistive sensor elements may be formed on (or attached to) the same glass part or glass component that serves as the substrate for the heater, thereby forming a combined heater and temperature sensor assembly. By way of example and not limitation, thermo-resistive sensor materials may include titanium (Ti), platinum (Pt), polysilicon (poly-Si), graphene, or combinations thereof. Such materials may be deposited as thin films using sputtering, evaporation, or other thin-film deposition processes described herein, and may be patterned using photolithography, etching, lift-off, laser patterning, or other pattern-forming techniques described herein.

In some embodiments, thermo-resistive sensor elements may be co-located with, embedded within, or positioned adjacent to heater elements on the glass substrate to provide accurate, localized temperature measurement. Such co-location may reduce thermal lag, improve measurement accuracy, and enable real-time monitoring of heater temperature, substrate temperature, fused-silica membrane temperature, or combinations thereof. In some embodiments, thermo-resistive sensors may be constructed as embedded structures fabricated on the same glass substrate as the heater to form a compact, integrated heater-sensor assembly suitable for closed-loop temperature control.

The methods and processes described herein for constructing and/or forming heaters and integrated temperature sensors on glass substrates—including thermo-resistive sensors, RTDs, thermistors, thermocouples, and combinations thereof—are intended to serve as non-limiting examples. It should be understood that such heater-sensor assemblies may be formed using any of the heater-formation methods described herein, including thin-film deposition, thick-film deposition, printing, micromachining, MEMS-based fabrication, laser-based processing, electrochemical deposition, or combinations thereof, and may incorporate metal-based, carbon-based, semiconductive, ceramic, or composite materials.

In some embodiments, a fused-silica part or component may serve as the substrate for forming both the heater and the temperature sensor, such that the resulting composite part functions as (i) the heater substrate, (ii) the heater support structure, (iii) the temperature sensor support structure, and (iv) at least a portion of a chamber (e.g., chamber 130). In such embodiments, the heater and temperature sensor may be formed on the same glass substrate or on different regions of the same glass substrate, and may be electrically coupled to a controller (e.g., controller 480 or another control system described herein) for temperature monitoring and control.

It should be understood that materials other than glass may also be used as substrates for such heater-sensor assemblies. By way of example and not limitation, suitable substrates may include other glass materials (e.g., quartz glass, borosilicate glass), ceramic materials, glass-ceramic materials, metal-glass composite materials, or other substrate materials described herein.

The foregoing heater and temperature sensor integration methods and composite substrate configurations may be used alone or in combination with, in conjunction with, and/or in sequence with other manufacturing processes described herein to form heater assemblies, temperature sensing assemblies, and chamber structures as described herein.

In some embodiments, a glass part serving as the substrate and/or support for a heater may comprise a fused-silica part formed using a powder injection molding (PIM) process, including micro-powder injection molding (μPIM). In such embodiments, the fused-silica part may function as the substrate and/or support structure for formation of a heater and, once the heater is formed, may continue to function as the heater support structure. In some embodiments, the same fused-silica part may additionally function as at least a portion of a chamber (e.g., chamber 130), thereby forming a composite part that integrates heater support and chamber functionality into a single glass structure.

In some embodiments, the PIM or μPIM process may utilize a composite feedstock (sometimes referred to as a “glassomer”) comprising silica nanoparticles combined with a polymeric binder system. The feedstock may be injection molded to form a green part having a desired three-dimensional geometry, followed by debinding and sintering processes to remove the binder and densify the silica, thereby forming a solid fused-silica component. Such PIM- or μPIM-formed fused-silica components may be fabricated with high dimensional precision and complex geometries suitable for integrated heater-chamber architectures described herein.

In some embodiments, the fused-silica part formed by PIM and/or μPIM contains substantially no metallic impurities and exhibits optical and material properties suitable for heater-chamber applications. By way of example and not limitation, such a fused-silica part may exhibit color (E′) centers below 260 nm, ultraviolet (UV) transmission at a wavelength of about 200 nm of approximately 84%, and ultraviolet-visible (UV-VIS) transmission in the wavelength range of about 300-1000 nm of greater than about 92%. In some embodiments, the fused-silica part contains a minimal concentration of hydroxyl (OH) groups, resulting in infrared (IR) transmission in the wavelength range of about 1000-3400 nm of greater than about 90%. In some embodiments, the PIM- or μPIM-formed fused-silica part may further exhibit mechanical and surface properties suitable for use as a heater support and chamber structure. By way of example and not limitation, such properties may include a bending strength of approximately 115 MPa, a Vickers hardness of approximately 980 HV, a coefficient of thermal expansion of approximately 0.52×10⁻⁶ K⁻¹, a static contact angle with water of approximately 36°, and a surface energy of approximately 60 mN/m. Such properties may provide thermal stability, mechanical robustness, chemical resistance, and/or surface characteristics suitable for heater integration and interaction with liquid precursors.

In some embodiments, the fused-silica part formed using PIM and/or μPIM may be used to form specific structural components of the device, including, by way of example and not limitation, a chamber body (e.g., chamber 1430) and a chamber top (e.g., chamber top 1432). In such embodiments, heater elements and associated electrical connections may be subsequently formed on, within, or in association with the PIM- or μPIM-formed fused-silica components using any of the heater-formation processes described herein.

The foregoing PIM- and μPIM-based fused-silica heater-chamber structures are intended to serve as non-limiting examples. It should be understood that other glass-forming, molding, sintering, and densification processes—whether presently known or later developed—may be used alone or in combination to form fused-silica or silica-based composite parts that function as heater substrates, heater support structures, chamber components, or combinations thereof, as described herein.

Multiple methods utilizing artificial intelligent (AI) and/or machine learning (ML) methods and/or processes that may be utilized to optimize and/or expedite the design and/or manufacturing of glass components, heaters, and/or emitters, that may be used to construct a vaporizing device such as vaporizing device 100 (and/or other vaporizing device and/or vaporizer described herein). These include, but are not limited to: Reservoirs (such as reservoir 110 and/or other reservoir described herein); Dispensers (such as dispenser 120 and/or other dispenser described herein); Heaters (such as heater 140 and/or other heater described herein); Dispenser components (such as dispenser disk 1110 and/or other dispenser disk or dispenser component described herein); Chambers (such as chamber 130 and/or other chamber described herein); chamber assemblies (such as chamber assembly 830 and/or other chamber assemblies described herein); chamber components (such as chamber top 1432 and/or chamber bottom 1712 and/or other chamber tops and/or chamber bottoms described herein); Cartridge components and/or elements of a cartridge (such as cartridge 508 and/or other cartridges described herein); Sensors (such as sensor 2265 and/or other sensors described herein); and/or sensor components (e.g., where at least a part of the sensor construction comprises encapsulation and/or containment of a sensor)

Artificial intelligent (AI) and/or machine learning (ML) methods and/or processes may be utilized to optimize and/or expedite the design and/or manufacturing of components and/or parts and/or elements of emitters. These include, but are not limited to, for example: elements that are constructed to shield an emitter, to encase an emitter, as a substrate or partial substrate of an emitter, and/or as a functional component of an emitter. These functional components of an emitter include, but are not limited to, for example: an emitter support structures, emitter reflectors, emitter focusing elements, and/or as components of an emitter assembly—for example lenses that may be used to construct an ultraviolet (UV) emitter (such as UV emitter 2162 and/or other UV emitter described herein) and/or used to construct an infrared (IR) emitter (such as IR emitter 2164 and/or other emitter described herein. Artificial intelligent (AI) and/or machine learning (ML) methods and/or processes may be utilized to optimize and/or expedite the design and/or manufacturing of optical and/or thermal reflecting components (such as reflector 2166 and/or other reflector described herein). Artificial intelligent (AI) and/or machine learning (ML) methods and/or processes may be utilized to optimize and/or expedite the design and/or manufacturing of optical and/or thermal energy focusing elements such as lenses (e.g., lens 2168 and/or other lens described herein). Artificial intelligent (AI) and/or machine learning (ML) methods and/or processes may be utilized to optimize and/or expedite the design and/or manufacturing of components and/or parts that are part of an optical assembly (such as optical assembly 2268 and/or other optical system described herein). Artificial intelligent (AI) and/or machine learning (ML) methods and/or processes may be utilized to optimize and/or expedite the design and/or manufacturing of the components of a sampling chamber (e.g., sampling chamber 4120 and/or other sampling chamber described herein) such as an upper window for a sampling chamber (e.g., upper window 4124 and/or other sampling window described herein), and/or lower optical elements of a sampling chamber (e.g., lower optical elements 4126 and/or other optical elements described herein).

In some embodiments, artificial intelligence (AI) and/or machine learning (ML) methods and/or processes may be utilized as design-assistance and manufacturing-assistance tools to select, optimize, and/or validate physical design parameters, material selections, and structural configurations of components used in emitter assemblies. In such embodiments, AI and/or ML methods may be employed to analyze and correlate material properties, geometric parameters, optical characteristics, thermal characteristics, and manufacturing constraints to generate or refine physical component designs that are subsequently fabricated using the processes described herein.

In some embodiments, AI and/or ML-assisted design methods may be used to optimize components that shield, encase, support, or structurally integrate an emitter, including, by way of example and not limitation, emitter support structures, housings, substrates, partial substrates, and composite parts. Such methods may be used to select or refine parameters including wall thickness, curvature, surface finish, material composition, and thermal or optical isolation features based on desired performance metrics such as durability, thermal stability, manufacturability, and integration with heater or sensor structures described herein.

In some embodiments, AI and/or ML-assisted methods may be used to select and/or optimize optical and thermal components associated with emitters, including reflectors, focusing elements, and optical interfaces. By way of example and not limitation, such methods may be used to determine reflector geometry, reflector material composition, surface roughness, coating selection, or angular orientation to improve optical efficiency or thermal management for ultraviolet (UV) emitters (e.g., UV emitter 2162 or other UV emitters described herein) and/or infrared (IR) emitters (e.g., IR emitter 2164 or other IR emitters described herein).

In some embodiments, AI and/or ML-assisted methods may be used to optimize lenses or other focusing elements (e.g., lens 2168 or other lenses described herein) by selecting curvature profiles, thickness distributions, refractive materials, and surface treatments to achieve desired focusing or beam-shaping characteristics.

In some embodiments, AI and/or ML-assisted methods may be used to optimize optical assemblies (e.g., optical assembly 2268 or other optical systems described herein) by evaluating interactions among multiple optical components, including emitters, reflectors, lenses, windows, and apertures. Such methods may be used to identify physical configurations that improve optical coupling efficiency, spatial uniformity, alignment tolerance, or thermal robustness, and may output specific component geometries or material selections that are then implemented in fabricated assemblies.

In some embodiments, AI and/or ML-assisted design methods may be applied to components of sampling chambers (e.g., sampling chamber 4120 or other sampling chambers described herein), including upper windows (e.g., upper window 4124 or other sampling windows described herein) and lower optical elements (e.g., lower optical elements 4126 or other optical elements described herein). By way of example and not limitation, such methods may be used to select window thickness, glass composition, surface coatings, optical transmission characteristics, and mechanical tolerances based on desired optical transparency, thermal behavior, chemical resistance, and manufacturability.

In some embodiments, AI-assisted optimization is used to select reflector geometry and coating thickness for an infrared emitter to maximize radiative coupling to a fused-silica membrane.

In some embodiments, AI and/or ML-assisted methods may be used to accelerate or guide manufacturing by selecting process parameters, tolerances, or material combinations that are compatible with manufacturing methods described herein, including injection molding, powder injection molding, micro-fabrication, thin-film deposition, printing, etching, bonding, or combinations thereof. In such embodiments, AI and/or ML methods may be used to reduce design iteration cycles while producing concrete physical design outputs that are implemented as fabricated components.

The foregoing AI- and ML-assisted design and manufacturing methods are intended to serve as non-limiting examples. It should be understood that such methods are used to inform or select physical structures, materials, and configurations, and that other computational, statistical, or data-driven design approaches—whether presently known or later developed—may likewise be used to support the selection and fabrication of emitter components, optical components, thermal components, and chamber components as described herein. It should be understood that the description of AI and machine learning methods and processes for the formation of glass parts and/or glass components, and/or heaters, and/or emitters are intended to serve as non-limiting examples and that such processes may be combined and/or used in conjunction, and/or used in sequence with other processes, whether presently known, or later developed, such as those described herein.

It should be understood that the methods and processes described herein may have equivalent processes and/or related processes that may vary in terms of version, nomenclature and/or terminology, or retail product name and these should be understood to be functionally equivalent to the methods and processes described herein. The design and formation of glass components (such as those described herein, e.g., heaters such as heater 140 and/or other heater described herein) which may be formed on glass substrates may utilizeAI and machine learning methods and processes. These include, but are not limited to, for example: AI-powered multiphysics simulation and substrate-specific generative design (where these tools optimize thermal uniformity and structural integrity by accounting for the unique thermal expansion and transparency properties of glass). This may include, for example, the use of AI-powered multiphysics simulation where the AI simulation analyzes the interaction between electrical currents (Joule heating), thermal dissipation, and mechanical stress on the glass.

The artificial intelligence (AI) and machine learning (ML) methods and processes described herein for assisting in the design and manufacture of glass parts, glass components, heaters, and emitters are intended to serve as non-limiting examples. It should be understood that such AI- and ML-assisted methods may be used alone or in combination with, in conjunction with, and/or in sequence with other design, simulation, and manufacturing processes described herein. It should further be understood that equivalent or related computational tools, models, workflows, or software implementations—regardless of version, nomenclature, terminology, or commercial product name—may be used to perform functionally equivalent design-assistance and optimization tasks.

In some embodiments, AI- and ML-assisted methods may be used to guide the design and formation of glass-based components, including heaters (e.g., heater 140 and/or other heaters described herein), heater support structures, emitter components, and chamber components formed on or from glass substrates. By way of example and not limitation, such methods may include AI-assisted multiphysics simulation and substrate-specific generative design approaches that account for material properties of glass, including thermal expansion behavior, optical transparency, thermal conductivity, electrical insulation, and mechanical strength.

In some embodiments, AI-assisted multiphysics simulation may analyze coupled electrical, thermal, and mechanical phenomena, including Joule heating, thermal dissipation, and thermally induced stress in glass-based heater structures, to inform selection of heater geometry, material composition, thickness, and placement prior to fabrication. Examples of multiphysics simulation tools include Altair HyperWorks programs (such as Altair HyperWorks 2026). This software suite features physics-based AI models and geometric deep learning that generate thermal predictions faster than traditional finite-element analysis (FEA). Its unified solvers are specifically designed to handle the complex thermal-structural interactions critical for heaters used on a glass substrate. Another AI simulation application is the Siemens Calibre 3D Thermal & Simcenter Flotherm suite, which is integrated into die-to-system workflows. These tools use AI to convert micro-layout designs into high-fidelity thermal models thereby facilitating the direct visualization through simulation of heater generated hotspots on the glass before fabrication which allows for heater design optimization prior to fabrication of the heater. Another application is the COMSOL Multiphysics solver (for example COMSOL Multiphysics v5.3+). While this is a traditional solver, it can be used alongside AI surrogate models, like a Back-Propagation Neural Network (BPNN) to predict form errors and thermal stress in 3D glass bodies with high precision (approx. 0.2% tolerance). BPPN is a data-driven, computationally efficient, approximation of a complex, high-fidelity simulation model that uses a multi-layer feedforward neural network trained via the error back-propagation algorithm to learn and predict the behavior of nonlinear, time-consuming systems in real-time (such as, for example, the thermal dynamics, material properties, and other related variables that are critical for fabricating an optimized heater on a glass substrate).

In some embodiments, AI- and ML-assisted multiphysics simulation tools may be used to accelerate or refine heater and emitter design by providing predictive modeling that supplements or replaces conventional finite-element analysis (FEA) workflows. By way of example and not limitation, AI-enabled simulation environments may be used to convert heater layouts or micro-scale geometries into high-fidelity thermal and structural models, enabling visualization and prediction of temperature distributions, hot-spot formation, and stress concentrations in glass substrates before fabrication. By way of example and not limitation, such AI-assisted simulation tools may include commercially available multiphysics and thermal-analysis platforms incorporating AI or data-driven modeling techniques, including Altair HyperWorks (e.g., HyperWorks 2026 or later), Siemens Calibre 3D Thermal and/or Simcenter Flotherm, and COMSOL Multiphysics (e.g., version 5.3 or later) used alone or in combination with AI-based surrogate models.

In some embodiments, traditional physics-based solvers may be augmented with machine-learning surrogate models, such as back-propagation neural networks (BPNNs), to approximate complex nonlinear thermal-structural behavior of glass-based heater assemblies with reduced computational cost. By way of example and not limitation, such surrogate models may be trained to predict thermal stress, deformation, or temperature distribution in three-dimensional glass bodies with accuracy on the order of approximately 0.2% relative to high-fidelity simulation results.

In some embodiments, AI- and ML-assisted design methods may be used to iteratively optimize heater geometry, material selection, resistance distribution, membrane thickness, optical coupling, or manufacturability constraints, and to output specific physical design parameters that are subsequently implemented using the fabrication methods described herein.

The foregoing AI- and ML-assisted design and simulation techniques are intended to support selection and optimization of physical structures and materials, and do not limit the invention to any particular software tool, model architecture, or computational implementation.

AI methods and processes may be used for glass-specific part and/or component design and optimization as glass substrates (since glass substrates may present specific challenges like thermal shock and adhesion issues that AI tools may address). This includes, but is not limited to The Strength Lab AI (Kuraray) which is an AI-based application specifically for calculating the static load-bearing capacity and serviceability of glass structures and which provides design parameter related data to ensure the glass substrate can withstand the intense local heat of a heater. Another example of a method and processes is the Raads Optimizer (Rapidus). This tool uses machine learning to search for and derive optimal parameters for power-performance-area (PPA) (which is useful for maximizing heater efficiency). VitroSphere® Digital Glass Simulator can be utilized for transparent heaters (such as those described herein). This allows for visualization through simulation and comparison of the color, transparency, and reflectance of glass coatings under different thermal and lighting conditions.

AI methods and processes may be used for glass-specific part and/or component design and optimization as glass substrates (since glass substrates may present specific challenges like thermal shock and adhesion issues that AI tools may address). This includes, but is not limited to The Strength Lab AI (Kuraray) which is an AI-based application specifically for calculating the static load-bearing capacity and serviceability of glass structures and which provides design parameter related data to ensure the glass substrate can withstand the intense local heat of a heater. Another example of a method and processes is the Raads Optimizer (Rapidus). This tool uses machine learning to search for and derive optimal parameters for power-performance-area (PPA) (which is useful for maximizing heater efficiency). VitroSphere® Digital Glass Simulator can be utilized for transparent heaters (such as those described herein). This allows for visualization through simulation and comparison of the color, transparency, and reflectance of glass coatings under different thermal and lighting conditions.

AI and machine learning based manufacturing and process control tools may be utilized for the optimized design and fabrication of glass components include, but is not limited to vGlassFORM.ai which provides AI-driven solutions (such as for example LINEexpert, FORMexpert) that optimize the glass forming process and quality control thereby helping ensure a substrate's surface is defect-free for heater deposition using various methods (such as those described in further detail herein). ML Predictive Models that may be utilized such as No-code AI platforms (such as for example Intelecy) which may be used to monitor and adjust heating zones in real-time during the glass fabrication process to thereby help maintain uniform viscosity and prevent defects.

In some embodiments, artificial intelligence (AI) and/or machine learning (ML) methods and processes may be used for glass-specific part and component design and optimization, recognizing that glass substrates present unique design challenges including thermal shock sensitivity, adhesion behavior, optical transparency requirements, and localized stress induced by heater operation. In such embodiments, AI- and ML-assisted tools may be used to evaluate and select physical design parameters, material properties, and structural configurations to ensure that glass substrates can withstand localized heating while maintaining optical and mechanical performance. By way of example and not limitation, AI-based glass-analysis tools may be used to evaluate static and dynamic load-bearing capacity, thermal stress distribution, and serviceability of glass components used as heater substrates or chamber walls.

In some embodiments, AI-assisted glass-strength analysis tools (e.g., The Strength Lab AI by Kuraray or functionally equivalent tools) may be used to generate design parameter data indicating allowable heater power density, membrane thickness, support geometry, or stress margins for glass substrates exposed to intense localized heating. In some embodiments, AI- and ML-assisted optimization tools may be used to identify optimal tradeoffs among power, thermal performance, and geometric constraints of heater assemblies formed on glass. By way of example and not limitation, machine-learning-based optimizers (e.g., Raads Optimizer by Rapidus or functionally equivalent tools) may be used to explore design spaces and derive optimized parameter sets for power-performance-area (PPA), enabling efficient heater designs that balance electrical efficiency, thermal uniformity, and spatial constraints.

In some embodiments, AI-assisted glass-optical simulation tools may be used to evaluate transparent or semi-transparent heater structures and coatings formed on glass substrates. By way of example and not limitation, digital glass simulation platforms (e.g., VitroSphere® Digital Glass Simulator or functionally equivalent tools) may be used to visualize and compare optical properties such as color, transparency, reflectance, and transmission of glass substrates and coatings under different thermal, electrical, and lighting conditions. Such tools may be used to guide selection of glass composition, coating thickness, dopants, or surface treatments for transparent heater and emitter assemblies described herein.

AI and machine learning based manufacturing and process control tools may be utilized for the optimized design and fabrication of glass components include, but is not limited to vGlassFORM.ai which provides AI-driven solutions (such as for example LINEexpert, FORMexpert) that optimize the glass forming process and quality control thereby helping ensure a substrate's surface is defect-free for heater deposition using various methods (such as those described in further detail herein). ML Predictive Models that may be utilized such as No-code AI platforms (such as for example Intelecy) which may be used to monitor and adjust heating zones in real-time during the glass fabrication process to thereby help maintain uniform viscosity and prevent defects.

In some embodiments, AI- and ML-based manufacturing and process-control tools may be used to optimize fabrication of glass components used in heater and emitter assemblies. In such embodiments, AI-driven manufacturing tools may be applied to glass forming, molding, sintering, surface finishing, and quality-control processes to improve substrate uniformity, surface quality, and process yield prior to heater deposition or sensor integration. By way of example and not limitation, AI-assisted glass forming and inspection platforms (e.g., vGlassFORM.ai or functionally equivalent tools, including modules such as LINEexpert and FORMexpert) may be used to optimize glass forming parameters, detect surface defects, and ensure that glass substrates meet surface roughness, flatness, and defect-density requirements for subsequent heater deposition using thin-film, thick-film, printing, or micromachining processes described herein.

In some embodiments, ML-based predictive models may be used to monitor and adjust glass fabrication conditions in real time. By way of example and not limitation, no-code or low-code ML platforms (e.g., Intelecy or functionally equivalent tools) may be used to analyze process data and dynamically adjust heating zones, forming temperatures, or cooling profiles during glass fabrication to maintain uniform viscosity, reduce internal stress, and prevent defects that could compromise heater adhesion or performance.

The foregoing AI- and ML-assisted glass-specific design, simulation, and manufacturing-control methods are intended to serve as non-limiting examples. It should be understood that other AI-based, data-driven, or computationally assisted tools—whether presently known or later developed—may be used alone or in combination to support selection of glass materials, structural designs, optical properties, and manufacturing parameters for heater- and emitter-integrated glass components as described herein.

The AI and machine learning programs such as those described herein can be used in conjunction with Solidworks, AutoCAD, Fusion 360, and/or a similar CAD tool to define the heater pattern such as any of the heater patterns described herein. Where the heater design and parameters can then be utilized to generate AI predictions (such as, for example, utilizing the CAD based design and material selection of the heater utilizing a glass substrate with the Altair HyperWorks method and processes for real-time AI feedback on thermal distribution and potential glass deformation and/or failure).

AI and machine learning can be utilized to perform adhesion and/or layering analysis of the heater to be used in conjunction with a glass substrate (e.g., where the AI and/or machine learning can be used to verify multilayer structures—such as for example Cr—Pt—Cr—using MEMS-specific simulation to ensure stable thermal expansion matching with the glass substrate). The heater and/or heater design may also undergo AI and/or machine learning optimization using, for example, the Raads Optimizer to fine-tune electrical power consumption of the heater versus the thermal response of the heater (e.g., the time required for the heater to reach the desired operating temperature).

It should be understood that the description of AI methods and processes and/or machine learning methods and processes that can be utilized for the optimization of part and/or components utilizing, for example, analysis and simulation are meant to serve as non-limiting examples and that such methods and processes may be used in combination, and/or in sequence, and that other related methods and processes may also be utilized.

In some embodiments, artificial intelligence (AI) and/or machine learning (ML) methods and processes described herein may be used in conjunction with computer-aided design (CAD) tools to define, refine, and optimize physical heater patterns and associated structures formed on glass substrates. By way of example and not limitation, heater geometries (including any of the heater patterns described herein) may be initially defined using CAD environments such as SolidWorks, AutoCAD, Fusion 360, or functionally equivalent design tools, and the resulting geometric and material definitions may be used as inputs for AI-assisted analysis and optimization.

In some embodiments, CAD-defined heater designs may be evaluated using AI-assisted multiphysics simulation to predict thermal distribution, electrical behavior, and mechanical response of heater structures formed on glass substrates. By way of example and not limitation, CAD-based heater layouts and material selections may be analyzed using AI-enabled simulation platforms (e.g., Altair HyperWorks or functionally equivalent tools) to provide real-time or near-real-time feedback regarding temperature uniformity, power density, thermal gradients, and potential glass deformation, stress concentration, or failure prior to fabrication.

In some embodiments, AI- and ML-assisted analysis may be applied to evaluate adhesion, thermal expansion compatibility, and long-term stability of multilayer heater structures formed on glass substrates. By way of example and not limitation, AI-assisted or MEMS-specific simulation may be used to verify multilayer material stacks (e.g., chromium-platinum-chromium (Cr—Pt—Cr) or other adhesion and heater layer combinations) to ensure stable thermal expansion matching, adhesion reliability, and resistance stability when integrated with a glass substrate and subjected to repeated heating cycles.

In some embodiments, AI- and ML-assisted optimization tools may be used to refine heater electrical and thermal performance parameters. By way of example and not limitation, machine-learning-based optimizers (e.g., Raads Optimizer or functionally equivalent tools) may be used to balance electrical power consumption, resistance distribution, heater geometry, and thermal response time (e.g., time required for the heater to reach a desired operating temperature), thereby generating optimized physical design parameters that are subsequently implemented in fabricated heater structures.

The foregoing CAD-integrated AI- and ML-assisted design, analysis, and optimization workflows are intended to serve as non-limiting examples. It should be understood that such methods may be used alone or in combination, in conjunction with, and/or in sequence with other design, simulation, and manufacturing processes described herein, and that other related computational, simulation, or optimization tools—whether presently known or later developed—may likewise be used to support the design and fabrication of heater structures on glass substrates as described herein.

In some embodiments which utilize an IR emitter (such as IR emitter 2164 and/or other emitter described herein) and/or a UV emitter (such as UV emitter 2162 and/or other UV emitter described herein), there are AI and machine learning methods and processes that may be utilized for the optimization of the emitter design. These include, but are not limited to: AI-powered design for small-scale infrared (IR) and ultraviolet (UV) emitters (particularly metasurfaces and photonic devices). Advanced machine learning models may be used to optimize complex geometries thereby accelerating development when compared to traditional simulations. These may utilize methods and processes such as, for example, deep neural networks (DNNs), convolutional neural networks (CNNs), and specialized frameworks like NanoPhotoNet for designing high-performance, tunable photonic and/or microphototonic and/or nanophotonic structures. AI tools and/or methods and/or processes for IR and/or UV emitter design include, but is not limited to NanoPhotoNet. This is an advanced AI tool combining CNN and Long Short-Term Memory (LSTM) models specifically for designing surface and multi-layer metasurfaces (MLMs) that offers high prediction accuracy for photonic and/or microphototonic and/or nanophotonic devices.

In some embodiments, artificial intelligence (AI) and/or machine learning (ML) methods and processes may be utilized to optimize the physical design, material selection, and structural configuration of infrared (IR) and/or ultraviolet (UV) emitters (e.g., IR emitter 2164, UV emitter 2162, or other emitters described herein). In such embodiments, AI- and ML-assisted design methods may be used to select and refine emitter geometries, layer stacks, surface features, and material compositions to achieve desired emission characteristics, including spectral output, directionality, intensity, efficiency, and/or tunability.

In some embodiments, AI- and ML-assisted design methods may be applied to small-scale, micro-scale, or nano-scale IR and/or UV emitter structures, including photonic, microphotonic, and/or nanophotonic devices. By way of example and not limitation, such methods may be used to optimize metasurface-based emitters, multilayer metasurfaces, photonic crystal structures, or other sub-wavelength patterned structures used to shape or control emitted radiation. In such embodiments, AI- and ML-assisted optimization may accelerate development relative to traditional parameter sweeps or brute-force simulation by efficiently exploring large design spaces and identifying geometries that satisfy multiple optical, thermal, and manufacturing constraints.

In some embodiments, AI- and ML-assisted emitter design may utilize data-driven models trained to correlate geometric parameters, material properties, and layer configurations with resulting optical behavior. By way of example and not limitation, deep-learning-based models, including convolutional neural networks (CNNs), recurrent neural networks, or hybrid architectures (e.g., CNN- and LSTM-based frameworks), may be used to predict spectral response, angular emission profiles, or tunability of IR and/or UV emitter structures. Such models may output specific physical design parameters—such as feature dimensions, periodicities, layer thicknesses, refractive-index selections, or material compositions—that are subsequently implemented using fabrication methods described herein.

A metasurface is an engineered, ultra-thin, two-dimensional structures composed of subwavelength-scale elements (also called meta-atoms) that manipulate electromagnetic waves (including light and radio waves). A metasurface, by controlling the phase, amplitude, and polarization of waves at an interface, enable flat, lightweight, and efficient optical components like lenses (also called metalenses). Deep Neural Networks (DNNs) may be used for inverse design to predict optical scattering in multi-layered nanoparticles and optimize materials and layer thicknesses for desired resonances. CNN Ensembles may be applied to generate optimal surface patterns for metasurfaces based on desired spectral transmittance, crucial for directing IR/UV light.

In some embodiments, emitter assemblies described herein may incorporate metasurfaces as optical and/or photonic components for controlling emitted electromagnetic radiation, including infrared (IR) and ultraviolet (UV) radiation. In such embodiments, a metasurface may comprise an engineered, substantially planar structure formed from an array of subwavelength-scale elements (sometimes referred to as meta-atoms) arranged on or within a surface. By appropriate selection of meta-atom geometry, spacing, orientation, and material composition, the metasurface may be configured to locally manipulate phase, amplitude, polarization, and/or directionality of electromagnetic waves at an interface. In some embodiments, metasurfaces may be used to form flat, lightweight optical components, including lenses (sometimes referred to as metalenses), beam-shaping elements, spectral filters, reflectors, or focusing elements, suitable for integration with IR and/or UV emitters described herein. Such metasurface-based components may provide reduced thickness, reduced mass, and enhanced optical efficiency relative to conventional bulk optical components, and may be particularly advantageous for compact emitter assemblies formed on or in association with glass substrates.

In some embodiments, artificial intelligence (AI) and/or machine learning (ML) methods may be used to assist in the inverse design and optimization of metasurface structures for emitter applications. By way of example and not limitation, deep neural networks (DNNs) may be trained to predict optical scattering behavior, resonance characteristics, or spectral response of multi-layered nanoparticle or meta-atom structures, and to identify material selections, layer thicknesses, feature dimensions, and geometrical arrangements that achieve desired emission or transmission characteristics. In some embodiments, convolutional neural network (CNN)-based models, including CNN ensembles, may be used to generate or refine metasurface surface patterns based on target optical properties, such as desired spectral transmittance, reflectance, angular emission profile, or polarization behavior. Such AI-assisted design methods may be used to tailor metasurface structures to direct, focus, collimate, or spectrally shape IR and/or UV radiation emitted by an emitter, including embodiments in which metasurfaces are optimized for wavelength-selective emission, directional coupling, or interaction with other optical components described herein. In some embodiments, AI-designed metasurface or metalens structures may be fabricated using thin-film deposition, lithography, etching, nanoimprint lithography, or other micro- and nanofabrication techniques described herein, and may be integrated with glass-based substrates, fused-silica membranes, emitter assemblies, or optical assemblies described herein.

The foregoing metasurface and AI-assisted metasurface design methods are intended to serve as non-limiting examples, and it should be understood that other subwavelength photonic structures, inverse-designed optical elements, and AI-assisted photonic design approaches—whether presently known or later developed—may be used to implement optical control structures in emitter systems as described herein.

Another method and process may involve the use of reinforcement learning to optimize photonic structures by learning from electromagnetic simulation, improving photon harvesting and device efficiency. The use of computational electromagnetic software integration may involve the coupling ML algorithms with tools like Surface Optics Corporation's SOC-210/100 to allow the rapid construction of optical datasets to design IR diffusers and emitters. Simulation software (such as for example MuSES™/CoTherm™) may be utilized to simulate, predict, and optimize EO/IR (electro-optical/infrared) signatures of devices.

In some embodiments, artificial intelligence (AI) and/or machine learning (ML) methods may include reinforcement learning (RL) techniques used to optimize photonic and optical structures associated with infrared (IR) and/or ultraviolet (UV) emitters described herein. In such embodiments, reinforcement learning may be used as a design-space exploration and optimization method in which an agent iteratively modifies physical design parameters of an optical or photonic structure based on feedback derived from electromagnetic simulation results, thereby improving photon harvesting efficiency, radiative efficiency, directionality, spectral response, or combinations thereof. In some embodiments, reinforcement-learning-assisted optimization may be performed in conjunction with computational electromagnetic simulation tools, wherein simulated electromagnetic responses (e.g., absorption, emission, scattering, reflectance, or transmittance) are used as reward signals to guide the optimization process. By way of example and not limitation, RL-based methods may be used to iteratively adjust metasurface geometries, multilayer stack configurations, surface textures, diffuser profiles, or emitter geometries to converge toward structures exhibiting improved optical or thermal performance.

In some embodiments, machine-learning algorithms may be coupled with optical and radiometric simulation platforms to rapidly generate and evaluate optical datasets used in the design of IR diffusers, emitters, and related optical components. By way of example and not limitation, computational electromagnetic and optical modeling tools (e.g., Surface Optics Corporation's SOC-210/100 system or functionally equivalent tools) may be used in combination with ML-based optimization methods to construct datasets characterizing optical response as a function of geometry, material selection, surface finish, or coating configuration, thereby enabling accelerated design of optical components with tailored emissivity, diffusivity, or angular emission profiles. In some embodiments, simulation software configured to model electro-optical and infrared (EO/IR) signatures (e.g., MuSES™ and/or CoTherm™ or functionally equivalent tools) may be used in conjunction with AI- and ML-assisted optimization methods to simulate, predict, and optimize EO/IR signatures of devices incorporating emitters, heaters, metasurfaces, or optical assemblies described herein. In such embodiments, AI-assisted optimization may be used to adjust physical design parameters of emitter and optical components to achieve desired EO/IR signature characteristics, thermal behavior, or system-level performance prior to fabrication. In some embodiments, reinforcement-learning-assisted photonic optimization may be used in combination with other AI-assisted design approaches described herein, including CAD-based geometry definition, multiphysics simulation, glass-specific material and stress analysis, and metasurface inverse design, to generate optimized physical structures that are subsequently fabricated using micro- and nanofabrication methods described herein.

The foregoing reinforcement-learning-assisted and EM-simulation-coupled optimization methods are intended to serve as non-limiting examples. It should be understood that other reinforcement-learning frameworks, data-driven optimization techniques, and simulation-integrated AI methods—whether presently known or later developed—may be used alone or in combination to support the design, optimization, and fabrication of photonic, optical, and emitter structures as described herein.

AI-powered tools, and/or methods, and/processes for designing small IR and UV emitters may focus on optimizing optical layouts, material composition, and spectral performance include, but are not limited to Photopia's PODT for lens/reflector design, nextnano++ which has algorithms for LED nanostructure optimization (such as, for example nitride-based UV LEDs for higher efficiency), and generative frameworks like MEMOS (which is an AI-driven molecular generation framework using Markov chains and multi-objective optimization to create narrow-band emitters). Photopia Parametric Optical Design Tools (PODT) may be used and for designing optical systems (reflectors/lenses) for UV applications. UV-Vis-IR Spectral Software applications may be used for analyzing, fitting, and decomposing UV-Vis-IR emission spectra thereby allowing for precise spectral engineering.

In some embodiments, artificial intelligence (AI) and/or machine learning (ML) tools, methods, and processes may be used to assist in the design and optimization of small-scale infrared (IR) and ultraviolet (UV) emitters, including optimization of optical layouts, material composition, and spectral performance. In such embodiments, AI- and ML-assisted design methods may be used to select or refine physical parameters of emitter assemblies, including optical component geometry, emitter material systems, layer thicknesses, and spectral output characteristics, to achieve desired emission efficiency, wavelength selectivity, and beam shaping. In some embodiments, AI-assisted optical design tools may be used to optimize reflector and lens configurations associated with IR and/or UV emitters. By way of example and not limitation, parametric optical design tools (e.g., Photopia Parametric Optical Design Tools (PODT) or functionally equivalent tools) may be used to define and refine reflector geometries, lens profiles, and optical layouts for UV or IR applications, enabling efficient coupling, focusing, or collimation of emitted radiation.

In some embodiments, AI- and ML-assisted semiconductor and nanostructure simulation tools may be used to optimize emitter material systems at the micro- or nano-scale. By way of example and not limitation, simulation platforms incorporating algorithms for nanostructure optimization (e.g., nextnano++ or functionally equivalent tools) may be used to design and optimize semiconductor emitter structures, including nitride-based UV light-emitting devices, quantum well structures, or layered heterostructures, to improve emission efficiency, wavelength control, and thermal performance.

In some embodiments, AI-driven generative design frameworks may be used to explore material and structural design spaces for narrow-band or spectrally tailored emitters. By way of example and not limitation, generative frameworks (e.g., MEMOS or functionally equivalent tools), which may utilize probabilistic models, Markov-chain-based exploration, and multi-objective optimization, may be used to identify emitter material compositions or structural configurations that produce desired spectral bandwidth, peak wavelength, or emission purity.

In some embodiments, spectral analysis and modeling tools may be used in conjunction with AI-assisted design methods to analyze, fit, decompose, and engineer UV-Vis-IR emission spectra of emitters and emitter assemblies. By way of example and not limitation, UV-Vis-IR spectral analysis software may be used to evaluate emission profiles and guide selection of emitter materials, optical coatings, or filtering structures to achieve precise spectral characteristics required for the applications described herein.

The foregoing AI- and ML-assisted design tools and spectral-engineering methods for small IR and UV emitters are intended to serve as non-limiting examples. It should be understood that other AI-based, data-driven, or computationally assisted design approaches—whether presently known or later developed—may be used alone or in combination to support the selection, optimization, and fabrication of IR and UV emitter structures, optical components, and spectral-control elements as described herein.

AI and machine learning tools, and/or methods, and/or processes can be utilized for hardware control and design support, such as, for example VS Code used with GitHub Copilot may be used for generating Arduino code to control and power small IR/UV emitters and optimize the emitter control and/or emitter control program architecture.

It should be understood that the description of AI methods and processes and/or machine learning methods and processes that may be utilized for the optimization of IR emitter and/or UV emitters meant to serve as non-limiting examples and that such methods and processes may be used in combination, and/or in sequence, and that other related methods and processes may also be utilized.

In some embodiments, artificial intelligence (AI) and/or machine learning (ML) tools, methods, and processes may be utilized to support hardware control, system integration, and design validation of infrared (IR) and/or ultraviolet (UV) emitters described herein. In such embodiments, AI-assisted development tools may be used to generate, refine, or validate control logic, firmware, or interface code that governs electrical power delivery, timing, modulation, and operational sequencing of emitter hardware.

In some embodiments, AI-assisted code-generation or development-assistance tools may be used in conjunction with embedded control platforms to support control of small-scale IR and/or UV emitters. By way of example and not limitation, integrated development environments (IDEs) and AI-assisted programming tools (e.g., Visual Studio Code used with GitHub Copilot or functionally equivalent tools) may be used to assist in generating or organizing firmware or control routines for microcontroller-based systems (e.g., Arduino-class controllers or other embedded control platforms) that drive emitter operation. Such control routines may include logic for power regulation, duty-cycle control, pulse timing, thermal management, and coordination with temperature sensing elements described herein. In some embodiments, AI-assisted development tools may be used to optimize control-program structure, modularity, and integration with hardware interfaces, thereby supporting reliable and repeatable operation of emitter assemblies under varying operating conditions. In such embodiments, AI-assisted tools may be used to reduce development time, improve code consistency, or support integration of control logic with sensor feedback, safety thresholds, or system-level coordination, without altering the underlying physical structure or operating principles of the emitter hardware.

The foregoing AI-assisted hardware-control and development-support methods are intended to serve as non-limiting examples. It should be understood that such methods may be used alone or in combination, in conjunction with, and/or in sequence with other design, simulation, manufacturing, and control processes described herein, and that other AI-assisted development tools, embedded platforms, or control architectures—whether presently known or later developed—may likewise be used to support control and operation of IR and UV emitters as described herein.

In some embodiments using PIM methods and processes (such as those described herein including but not limited to PIM, μPIM, MIM, CIM and combinations thereof such as can be utilized in multi-shot PIM processes), the utilization of AI and ML tools for PIM optimization include, but are not limited to: Artificial Neural Networks (ANN), multivariate regression, and transfer learning to predict quality, minimize defects, and stabilize process parameters. Examples of such platforms include, but are not limited to, Moldex3D (AI optimization/Design of Experiments (DOE) wizards), Autodesk Fusion 360, and specialized machine-based AI like LS Mtron's AI Molding Assistant. These tools help enhance efficiency by analyzing sensor data to manage part weight, shrinkage, and curing in real-time. ANNs can be used to simulate complex, non-linear relationships in PIM, such as powder-binder separation, viscosity changes, and shrinkage, allowing for precise control of molding parameters. The utilization of multivariate regression and ML algorithms may analyze historical production data to optimize process inputs like injection pressure, temperature, and speed to improve product consistency. Transfer Learning (TL) helps in training models with limited data, which may be useful for specialized, low-volume PIM applications where extensive data sets may not exist. Explainable AI (XAI) may be combined with ANNs to provide transparent, actionable insights into how specific process changes affect final part quality. Additionally, there are software and simulation tools that may be used in isolation or in combination with AI and ML methods and processes such as: Moldex3D (which offers AI Optimization and DOE wizards to automatically predict optimal gate locations, warpage, and cycle times); Autodesk Fusion 360 (which utilizes generative design to optimize part geometry for better moldability, which helps with for the high-shrinkage nature of PIM); and SolidWorks with AI (which provides design suggestions and early simulation validation to reduce prototyping cycles and part redesign cycles). TensorFlow which is a flexible open-source library used to build custom machine learning models for specific PIM may also be utilized. Machinery-based AI systems such as, for example, LS Mtron which employs AI “molding assistants” to learn from skilled technicians to stabilize the molding process and “smart weight control” to adjust processing conditions in real-time to maintain part weight may be used. Another machinery-based AI system is Wittmann Battenfeld which uses HiQ Flow (an intelligent software application) and CMS (Content Management System) technology to identify viscosity changes and adjust. Another example is Arburg (Allrounder) which integrates AI for process monitoring and optimization.

Additionally, AI and ML can be used for PIM optimization by methods and processes such as predictive maintenance where the analyzing of sensor data is used to predict machine wear before failures occur. AI and ML can also be used for real-time quality control where, for example, AI-powered vision systems detect defects in parts in real time. AI and ML can also be used for increased PIM process stability whereby optimizing parameters (such as for example molding speed, injection and/or molding temperature) is used to reduce the defect rate associated with powder-based materials.

It should be understood that the description of AI methods and processes and/or ML methods and processes that can be utilized for the optimization of PIM methods and processes utilizing for example analysis and simulation are meant to serve as non-limiting examples and that such methods and processes may be used in combination, and/or in sequence, and that other related methods and processes may also be utilized.

In some embodiments, artificial intelligence (AI) and/or machine learning (ML) methods and processes may be utilized to optimize powder injection molding (PIM) processes, including micro-powder injection molding (μPIM), metal injection molding (MIM), ceramic injection molding (CIM), and multi-shot PIM processes, as described herein. In such embodiments, AI- and ML-assisted optimization may be applied to material preparation, molding, debinding, and sintering stages to improve part quality, dimensional accuracy, surface finish, and process stability for glass-based, ceramic-based, and composite parts used as heater substrates, heater support structures, and chamber components.

In some embodiments, AI- and ML-assisted models may be used to predict and control non-linear process behaviors inherent to PIM, including powder-binder separation, viscosity variation, flow instability, shrinkage, warpage, and defect formation. By way of example and not limitation, artificial neural networks (ANNs) may be trained to model complex relationships among feedstock composition, injection parameters, temperature profiles, and resulting part properties, thereby enabling precise control of molding conditions. In some embodiments, multivariate regression and other ML algorithms may be used to analyze historical production data to optimize process inputs such as injection pressure, injection speed, mold temperature, and cooling profiles to improve consistency and reduce defect rates. In some embodiments, transfer learning (TL) techniques may be used to accelerate model training where limited process data are available, including specialized or low-volume PIM applications. In such embodiments, models trained on related molding processes or materials may be adapted to new PIM configurations to provide effective optimization with reduced data requirements. In some embodiments, explainable AI (XAI) techniques may be combined with ANNs or other ML models to provide transparent, actionable insights into how specific process parameter adjustments affect final part quality, shrinkage behavior, or defect formation.

In some embodiments, AI- and ML-assisted PIM optimization may be implemented using software platforms and simulation tools that integrate design, process simulation, and data-driven optimization. By way of example and not limitation, such tools may include Moldex3D (including AI optimization and Design-of-Experiments (DOE) wizards for predicting gate location, warpage, and cycle time), Autodesk Fusion 360 (including generative design features to optimize part geometry for moldability and shrinkage behavior), and SolidWorks with AI-assisted design and early simulation validation.

In some embodiments, open-source ML frameworks (e.g., TensorFlow or functionally equivalent libraries) may be used to build custom ML models tailored to specific PIM materials, geometries, or process windows. In some embodiments, AI-enabled molding equipment and machine-integrated AI systems may be used to provide real-time process monitoring and control. By way of example and not limitation, injection molding systems incorporating AI-based “molding assistants” (e.g., LS Mtron systems employing smart weight control) may analyze sensor data to dynamically adjust processing conditions and maintain target part weight and dimensional stability. In some embodiments, molding platforms such as Wittmann Battenfeld systems (e.g., using HiQ Flow and related control technologies) and Arburg Allrounder systems may employ AI-assisted monitoring to detect viscosity changes, compensate for material variability, and stabilize molding conditions.

In some embodiments, AI- and ML-assisted methods may further be used for predictive maintenance, real-time quality control, and defect detection in PIM processes. By way of example and not limitation, sensor-driven ML models may be used to predict equipment wear or failure before it occurs, and AI-based vision systems may be used to detect surface defects, dimensional deviations, or other quality issues in molded parts in real time. In some embodiments, AI-assisted optimization of molding speed, injection temperature, and thermal profiles may reduce defect rates associated with powder-based materials and improve yield for parts used in heater-integrated glass and composite assemblies.

The foregoing AI- and ML-assisted PIM optimization methods and process-control techniques are intended to serve as non-limiting examples. It should be understood that such methods may be used alone or in combination, in conjunction with, and/or in sequence with other design, simulation, manufacturing, and control processes described herein, and that other related AI-based or data-driven PIM optimization approaches—whether presently known or later developed—may likewise be used to fabricate parts suitable for heater, emitter, and chamber assemblies as described herein.

FIG. 53 illustrates a block diagram of a computer system. Electronics that modulate or control parts of a vaporizing unit may be or include a computer and/or a computer system (e.g., computer system 5300). Computer software may implement one or more of the control functions and/or display functions described herein. Computer system 5300 includes communication interface 5320, processing system 5330, storage system 5340, and user interface 5360. Processing system 5330 is operatively coupled to storage system 5340. Storage system 5340 stores software 5350 and data 5370. Processing system 5330 is operatively coupled to communication interface 5320 and user interface 5360. Computer system 5300 may comprise a programmed general-purpose computer. Computer system 5300 may include a microprocessor. Computer system 5300 may comprise programmable or special purpose circuitry. Computer system 5300 may be distributed among multiple devices, processors, storage, and/or interfaces that together comprise elements 5320-5370.

Communication interface 5320 may comprise a network interface, modem, port, bus, link, transceiver, or other communication device. Communication interface 5320 may be distributed among multiple communication devices. Processing system 5330 may comprise a microprocessor, microcontroller, logic circuit, or other processing device. Processing system 5330 may be distributed among multiple processing devices. User interface 5360 may comprise a keyboard, mouse, voice recognition interface, microphone and speakers, graphical display, touch screen, or other type of user interface device. User interface 5360 may be distributed among multiple interface devices. Storage system 5340 may comprise a disk, tape, integrated circuit, RAM, ROM, EEPROM, flash memory, network storage, server, or other memory function. Storage system 5340 may include computer readable medium. Storage system 5340 may be distributed among multiple memory devices.

Processing system 5330 retrieves and executes software 5350 from storage system 5340. Processing system 5330 may retrieve and store data 5370. Processing system 5330 may also retrieve and store data via communication interface 5320. Processing system 5330 may create or modify software 5350 or data 5370 to achieve a tangible result. Processing system 5330 may control communication interface 5320 or user interface 5360 to achieve a tangible result. Processing system may retrieve and execute remotely stored software via communication interface 5320.

Software 5350 and remotely stored software may comprise an operating system, utilities, drivers, networking software, and other software typically executed by a computer system. Software 5350 may comprise an application program, applet, firmware, or other form of machine-readable processing instructions typically executed by a computer system. When executed by processing system 5330, software 5350 or remotely stored software may direct computer system 5300 to operate.

As used herein, “or” and “and/or” as used in a list of items (for example, a list of items prefaced by a phrase such as “at least one of”, “one or more of”, or “including, but not limited to”) indicates an inclusive list such that, for example, a list of at least one of A, B, and/or C means A or B or C, or AB or AC or BC, or ABC (i.e., A and B and C). Also, as used herein, the phrase “based on” shall not be construed as a reference to a limited set. Thus, as used herein, the phrase “based on” may be construed in the same manner as the phrase “based at least in part on.”

The included descriptions, block diagrams, and figures depict specific implementations to instruct those skilled in the art in making and using certain embodiments considered at present to be among the best options. For purposes of illustration, and brevity, some conventional features may have been simplified or omitted. Variations from these implementations that remain within the scope of the vaporizing device described herein may be readily appreciated by those skilled in the art. Features described in connection with any embodiment may be combined in various permutations to create further arrangements, and it should be understood that not all illustrated or described features are required in every embodiment. The present disclosure is not limited to the particular implementations shown or described, but instead encompasses alternatives, modifications, and equivalents as may fall within the scope of the claims and their legal equivalents. The block diagrams and figures are provided for explanatory purposes and should not be construed as limiting, but rather as illustrative of possible arrangements and configurations.

1. A vaporizing device comprising:
a reservoir configured to contain a liquid precursor;
a dispenser configured to deliver the liquid precursor from the reservoir; and
a chamber assembly configured to receive the liquid precursor and to generate a vapor and/or aerosol from the liquid precursor,
wherein the chamber assembly comprises a fused-silica chamber body defining a vaporization chamber region configured to contain the liquid precursor;
a heater structure electrically coupled to at least one electrical contact and configured to provide thermal energy for vaporizing the liquid precursor;
wherein, during operation, thermal energy provided by the heater structure is transferred through at least a portion of the fused-silica chamber body to heat the liquid precursor within the vaporization chamber region to generate the vapor and/or aerosol; and
wherein the heater structure is physically isolated from direct contact with the liquid precursor by the chamber.

2. The vaporizing device of claim 1, wherein the fused-silica chamber body further defines a heater-facing region separated from the vaporization chamber region by a fused-silica wall, and wherein the heater structure is thermally coupled to the heater-facing region to transfer the thermal energy through the fused-silica wall.

3. The vaporizing device of claim 2, wherein the heater structure is coupled to the fused-silica chamber body such that a heat-generating portion of the heater structure is in direct physical contact with a first surface of the fused-silica wall.

4. The vaporizing device of claim 2, wherein the fused-silica wall comprises a membrane having a thickness in a range of 0.01 mm to 0.3 mm.

5. The vaporizing device of claim 1, wherein the chamber assembly further comprises a fused-silica flow director positioned to define at least a portion of an airflow path and an aerosol flow path associated with the vaporization chamber region.

6. The vaporizing device of claim 1, wherein the fused-silica chamber body is formed from a silica nanoparticle and polymer-binder feedstock densified by debinding and sintering.

7. The vaporizing device of claim 6, wherein the fused-silica chamber body exhibits one or more of: ultraviolet transmission at 200 nm of about 84% or greater, ultraviolet-visible transmission at wavelengths of 300-1000 nm of greater than about 92%, and infrared transmission at wavelengths of 1000-3400 nm of greater than about 90%.

8. The vaporizing device of claim 1, wherein the heater structure comprises a platinum comprising substance deposited directly on the fused-silica chamber body by nanojet particle printing to form a resistive heater trace.

9. A method of manufacturing a vaporizing device, the method comprising:
forming a fused-silica chamber body by:
providing a silica-containing feedstock comprising silica and a binder;
shaping the silica-containing feedstock to form a green part that defines a vaporization chamber region configured to contain a liquid precursor and further defines a heater-facing region separated from the vaporization chamber region by a fused-silica wall; and
debinding and sintering the green part to densify the green part into the fused-silica chamber body;
providing a reservoir configured to contain the liquid precursor and a dispenser configured to deliver the liquid precursor from the reservoir to the vaporization chamber region of the fused-silica chamber body; and
providing a heater structure electrically coupled to at least one electrical contact, and thermally coupling the heater structure relative to the fused-silica chamber body such that, during operation of the vaporizing device, thermal energy provided by the heater structure is transferred through at least a portion of the fused-silica chamber body to heat the liquid precursor in the vaporization chamber region to generate a vapor and/or aerosol, wherein the heater structure is physically isolated from direct contact with the liquid precursor by the fused-silica chamber body.

10. The method of claim 9, wherein shaping the silica-containing feedstock comprises injection molding the silica-containing feedstock to form the green part.

11. The method of claim 9, wherein providing the heater structure comprises forming a resistive heater trace directly on a surface of the fused-silica chamber body after debinding and sintering.

12. The method of claim 11, wherein forming the resistive heater trace comprises depositing a platinum comprising substance directly on the fused-silica chamber body by nanojet particle printing.

13. The method of claim 11, wherein forming the resistive heater trace comprises directly writing a silver-palladium material onto the fused-silica chamber body.

14. The method of claim 11, wherein forming the resistive heater trace comprises:
directly bonding a copper foil to the fused-silica chamber body;
patterning the copper foil by photolithography; and
metallizing the patterned copper foil with nichrome to form the heater structure.

15. The method of claim 9, wherein providing the heater structure comprises placing a metal comprising trace into or onto the green part prior to debinding and sintering such that the metal comprising trace becomes at least partially embedded within the fused-silica chamber body after sintering.

16. The method of claim 15, wherein the metal comprising trace comprises one or more of nichrome, platinum, tungsten, titanium, stainless steel, Inconel, Kanthal, or Kovar, and wherein embedding the metal or metal-alloy trace comprises at least one of partial embedment, full embedment, and encapsulation within the fused-silica chamber body.

17. A method of manufacturing a fused-silica chamber body for a vaporizing device, the method comprising:
forming a fused-silica chamber body that defines a vaporization chamber region configured to contain a liquid precursor; and
intentionally forming surface structures on at least a portion of an interior surface of the fused-silica chamber body that defines the vaporization chamber region, wherein the surface structures increase a surface area of the interior surface relative to a smooth interior surface, and the surface structures are configured to enhance heat transfer from the fused-silica chamber body to the liquid precursor during vaporization.

18. The method of claim 17, wherein intentionally forming the surface structures comprises forming the surface structures during shaping of a green part by providing at least one mold surface having a negative pattern corresponding to the surface structures, such that the surface structures are formed upon densification of the fused-silica chamber body.

19. The method of claim 17, wherein intentionally forming the surface structures comprises forming the surface structures after densification of the fused-silica chamber body using a laser-based surface modification process.

20. The method of claim 19, wherein the laser-based surface modification process comprises at least one of of laser ablation, selective laser etching, and laser texturing applied to the interior surface of the fused-silica chamber body.

21. The method of claim 17, wherein the surface structures comprise a plurality of micro-scale features including at least one of ridges, grooves, pits, channels, protrusions, depressions, and combinations thereof.

22. The method of claim 17, wherein the surface structures are formed on a portion of the interior surface of the fused-silica chamber body that is an opposing surface from a heater and is heated by conduction through fused-silica chamber body.

23. The method of claim 17, wherein the surface structures are configured to influence at least one of liquid wetting behavior, capillary action, nucleation behavior, and residence time of the liquid precursor within the vaporization chamber region.

24. The method of claim 17, wherein the surface structures are heterogeneous across different interior surface regions of the fused-silica chamber body.

25. A method of manufacturing a fused-silica chamber component for a vaporizing device, the method comprising:
forming a fused-silica chamber component configured to define at least a portion of a vaporization chamber for containing a liquid precursor; and
controlling at least one material characteristic of the fused-silica chamber component such that the fused-silica chamber component exhibits a predetermined thermal and optical response when exposed to energy from a heater, wherein the predetermined thermal and optical response is selected to influence heat transfer to the liquid precursor within the vaporization chamber during operation of the vaporizing device.

26. The method of claim 25, wherein controlling the at least one material characteristic comprises controlling at least one of a hydroxyl content, bulk density, porosity, and impurity content of the fused-silica chamber component by at least one of annealing, dehydration, rehydration, irradiation, and localized thermal treatment.

27. The method of claim 25, wherein controlling the at least one material characteristic comprises performing a post-formation treatment selected from thermal annealing, dehydration, rehydration, irradiation, and localized heating to modify the predetermined thermal and optical response.

28. The method of claim 25, wherein controlling the at least one material characteristic comprises selectively controlling the material characteristic in a first region of the fused-silica chamber component differently than in a second region of the fused-silica chamber component.

29. The method of claim 28, wherein the first region is positioned to receive greater energy from the heater during operation of the vaporizing device than the second region.

30. The method of claim 25, wherein the predetermined thermal and optical response is selected to control a rate of heat transfer through the fused-silica chamber component to the liquid precursor while maintaining physical isolation between the heater and the liquid precursor.
